SEQUENCE LISTING (298 sequences)

SEQ ID NO: 1 - DNA, 138186 bp, Homo sapiens
ccggctgctcctggccagccccaggtcctgctacaaactgttccaggagcagcagaatgagggccacggggaggccctgctgttcgaagggatcaagagtaagtcggccctgccttgttctcctgtctgtgcaccttcctgcttcccatagtccgctgttgcctggagggaatcatccaggcaatagggtagcatctgagcacctactgtgcgccaggcactgtgccaagtgctagggagactgcatgaacagggcagaacagcttgctgccctgtgggctcacaggccagggggaagtgagtcaaaagaacagctccaacacaggggctttgaggggtgtctgagtggatggagctcagggaaggcttcttggaggaggcagaggccaagcagtagcatgcaagtaggggttggctgggcaaacggggcagggaaatgagaggaagagagataccacaggcagagggacgggggtggggcggctcagaggcaggagaaagcacgatgtgtgtgaggacctcggggaggttcggtatagctggagcacagatgaaatattactctctcagcagagctcacagacatgggccaggccccgggctgagatgcctctgtggctgagagctccacctcagatctgagtatgttgtgtggcatcaggagagggctgacctgtttcttcctctctcgatgggatctctttggagataagataatttagcgttaatgcaaggcaaaatgttccagtgaacaagtttcatggttcaactttataataattataagtaaacctgttaaatttttctggacattcttttcttttgaaacgaagttttcctctattgcccaggctggagtgcaatggcgcgatctcgactctctgcagcctctgcatcccgggttcaagtgattctcctgccccagccttccgagtagctgggattacaggtgtgcaccaccacacctggctaatgttttgtatttttagtagagatggggttttgccatgctggccaggctggtctcgaactcctgacctggtgatccacccacctcggcctcccaaagtgctggggttacaggcatgagccaccacgcctggcttaaaacaaggacatttcttattgacagcaactaaatggtacttgtagcatttttatcacacagtagattccatccattcactatacttttctgagctgtctgtcctgcatgcaagtagatatttttaatgttgtctgttttctgtgctgttcctgtaagtgtgctattaaaatacactaaactaggctgggcgcgatggttcatgcctgtaatcctagcactttgggaggacgaggcgggtggatcacgagttcaggagttcaaggccagctaggccaagatggtgaaaccccgtctctactaaaaatacaaaaattagccgggcgtggtggcgggtgcctgtaatcccagctacttgggaggctgaggcaggagaatcactcgaacccgggaggtggaggttgcagtgagccaagaatgtgccactgcactctagcctgggtgacagagcaagactcagtctcaaaaaaaaaaaaaaaaacaagaaaatattaaactaggccaagtgtggtggctcacacctgtaatcctagcactttgggaggctgaggcgggtggatcacctgaggtcaagagtttgagaccagcctggccaacgtgatgaaaccccgactttactaaaagtacaaaaattagctgggcgcagtggtgcgcacctgtaatcccagctactggggaggctgaggcaggagaatcgcttgaactcgggaggtggaggttgcagtgagtcaagatcgcactactgcactccagcctgggcgacagagcaaggctctgtctcaaaacaaaaaaaaaattacactataaaaatatattttaggccgggcgcggtggctcacgcctgtaatcccagcactttgggaggccgaggcgggcggatcacgaggtcaggagatcgagaccatcctgggtaacacggtgaaaccccgtctctactaaaaatacaaaaaattagccgggcgaggtggcgggcgcctgtagtcccagctactccggaggctgaggcaggagaatggcgtgaactccagggggcggagcctgcagtgagccgagattgcgccactgcactccagcctggacgacagcgagactccgtctcaaaaaaaaaaaaaaataataataaaaataaaaatatattttaaaaagaatttaaatgaggtgagaacaacatttttaatgagaacttatactgctaaaatattgtattaaagatatttgacttgcagatgctcacagcaaacctgtatggtaagaattattactgactccattttatagatgggaacactgagtccccccccggcactggctgggaagagggaaatcgacctctaagttcatttgccttttttttctttttctccatgacagaaaaaaaacagcagaaaataaagaacattctgtcaaacaagacattgagagaacataattcatttgtggaggtaggagcctgggtgcctacaccccagcagacctgacgccctgtccccggctcagccactttcccagtgattagaggcacacagaggctcagggtctcaggatgcgctggaagacagagacacagaagcaagggcagaagcaaagactgggagaggctgagggagcagagggaatgggaggccccagggtcccccgagagcactggccagaggcccctctgtgcagtgaggcctggcagccaccttcactgccttcctgacactgtcccaggtcctaccctccggcagggggcctcagccccacactgtcccccacccccacccccgactgccatcagtcccccactcactgcccctgccccttccccaagagatgcatcgactggaaccgcgagctgctgaagcgggagctgggcctggccgagagtgacatcattgacatcccgcagctcttcaagctcaaagagttctctaaggcggaagcttttttccccaacatggtgaggaggtggcggctttaaaaccccagggtgtggcatggaggtagctcagcccgagaggccagtggggcacccgggcggtcccagagggcttggctcctctctgtaaccgtttgtagctttgtcctgagtggtacaaggtcagacgtgaccaggtccatgcacgttggtgtctttccacaaggtcaggcttctactgatgctatttccatcataaaatccacaagccacacggagttccccaggggcagtcctcaggtgggcagagccctgggcacacaggctcaagccactccacaagtcagtcagtcctgcaaaccatacatagtagtgtacttaatcaacacagaaatgttacagatgaaacattcttaccaaacaaagcaatatttaacatcaagagagaaggggataggaaaaggggtcagtgaaccagtccaaggagagtgatgtggacaaggagagggtcctgggctgatctaaatggacatcaacgtcttgcaaggaagagtgtaattttggcagagccttcaacagcgggtgccaggtgctaatcactagtgacagcaagacagtgtctgttaagacagtcatcttgaggccgggtgcggtggctcacgcctgtaatcctagcaccttagtaggccagagcgggtggatcacttgaggtcaggagttcgacaccagcctggctaacatggtgacacccccatctctactaaaaatacgaaaattagacaggtgtcctggcaggagcctgtaatcccaactacttgagaggcggaagcaggagaatcacttgaacctgggagacggaggttgcagtgagccaagatcatgctattgcactccagcctgggtaacagagtgagactttgtctcgggaaaaaaaaaaaaaaagacagtcatcttgagctagtgaagacctgctctttttatagccagagtcctctggtgaggactgatagtaatagagtatgcctgcttatgtccctatctggttgggtgcagtctctgttgattaggcaaacatctggttcctgttagcatggtgccttttgaaatgtaagatggagtctttttctaagatggagtcacttatgccaagggtgctctatacaggcttgcatggccctgtaccacttccagagcaccttctggtatctcacaacaattccagaagtcagagtctatcgtcgcttctgccagggctctggcttcaaaccccatgccgtaactaccatgctgccttcccacgtagcaccttccctggggctccggggtgatgcaggggatggagggatggatagggaatcaaccaacaaacacgacaccctcaagtcaccttatgcaccataacagggacacacgtgggggcaccacctcagactggagggtccgggaaggcctctgtgaggaggtggggctggcactgcctaggctgagtgggattcaccttctggaggctgcacttgtgggtggtcccacctttgtcttgagcgttcaccgtggcccctaagtgctgtcttgatatcatccattgtgtttttgccattccttggccccattcctccctctcttcagagcatacccgagaccgaggcagagacttcacccggtcctactggggaaccccagccacccccttcttctggagctgggggttacagttcagggaggagccagcaggccctaccaccgtggttttcaaactgggttcccactcagcctaggcagtgccagccccacctggggctccggggtggtgcctcaaatccagtggttcagattttctgtttctgcattgacattctgcaaaagattgtgtgtagaataaagggttccttggccaaaaggaattaaagtattgaccccaagcgttttgtttccctccagtttggccaagccaggcttcccagtgcgggaatgaaagtggacgcccgcggctatggtagtcagcaacgctgagggctgactgtgtgccttcactgttcaaggtccccagagggagtctgagcatgagaccagactctctcccaggagctggctgtgggaggcggggaagagggagtgatgaacagtacgaggcacttagcacgcatgggctgtgtctaggcggtggcccccttgaggactcatgacccatggaaaatggctgtgcatctactgtgtgccagcacagtgctgtgcctacatgttcttacctaattgtcattgcaacggagatatgtgttgggctcattttgctgatgaggctcagaggggtgatatgacttgcctaaggccacacagctattgaatagcagagttaggattcaaacccacataggcctacagccaaaatcccaccttcccacctcaccaggccacctgccaatctaatggaggaagcagagtcatttacatacattatttacatatggaaagtgccataacagaggcagtcatttatctgtctagtcaacagatgtttattgagtgcctacgacgtgcaaggcgcagtgctgggagttatgggaacacagagcaggagtgactgccagagctcagggattcatgggcagtttcacagaggggctgccatctgagctgggccctgagtaatagaaagagtttaccagaaggtgacaggtaggggaggagaacgtagtgttaagagcatgggcagcatcagaaagaacgaaatcagccaggaggggtggctcatacctgtaatcccagcactttgggaggcttaggtgggaggattgcttgagtccaggagttcaagaccagcctgagcaacatggagaaactctgtctctacaaaaaacacaaaaattagccaggcgtggtggcatctgctgaggcaggatgattgcttgagcccaggaggtggacactgcagtgagctgagatggcaccactgaactctagcctgggtgaagagtaagaccctgtctcaaaaaaaaaaaaaaaaaaaaaaattaaataatgtcctttgcagcaacctgatggagctggaggcattatcctaagtgaactaaaacagaaaatcaaatactgcatgttctcacgtataggtagaagctaaacagtggatacacatagacacagagatggaaataataggcactgaggacccccaaaatggagagaatgagagcgaggtgagggctggaaaattacctatcgggtacgatgttcattgtttgggtaatggatacactagaagcccagtgcccaccagtaatcaatatacccatgtaataaatatgcatatgtacccccaaatctaaatttttaaatttaaaataaataagagtatggaacttggagtctaatagctgtagtccaagtatagctgggtggccttaggcaaacaattttccacgtctgggtctcagttttctcatttgtaaagtggggctattatttttattttgttttaatttttgagacagagtctcgctctgtcacccaggctggagtgtattggaatgatctcggctcactgaaacctccacttcctgggttcaagcaattctcctgcctcagcctcccaagtagctgggattacaggcacacctggctcattcttgtatttttagtagagacggggtttccccatgttggccaagctggtctcgagctcctgacctcaggtgatccactcgcctaggcctcccaaagtgctgggattacaggcatgagccaccacacccagcaatttttatttttgaggtagagtctcgctctgtcgcccaagctgccaggctggagtgcagtggcacaatcacagctcactgcagccttgacctcctgggctcaagtgatcctcctccctcagcctccaaagtagctgggaccacaggcacgcaccaccatgccaagctaatttttaaaaatactttttttagagatggggtctcaccatgttgcccaggctggtctcaaactcttgggctcaagcgatcctcctgcctcagcctcccaaagtgctgggactacaggtctgagccaccacccctggaggggctattatttccaaaggtcagagaagggtggggccgctcagattgcgctgcaggctgcccgctgctgcctgtgacctgaaccctcacttccctgcaggtgaacatgctggtgctagggaagcacctgggcatccccaagcccttcgggcccgtcatcaacggccgctgctgcctggaggagaaggtgtgttccctgctggagccactgggcctccagtgcaccttcatcaacgacttcttcacctaccacatcaggcatggggaggtgcactgcggcaccaacgtgcgcagaaagcccttctccttcaagtggtggaacatggtgccctgagcccatcttccctggcgtcctctccctcctggccagatgtcgctgggtcctctgcagtgtggcaagcaagagctcttgtgaatattgtggctccctgggggcggccagccctcccagcagtggcttgctttcttctcctgtgatgtcccagtttcccactctgaagatcccaacatggtcctagcactgcacactcagttctgctctaagaagctgcaataaagtttttttaagtcactttgtacatgaggtcaagatgttgttggtatcattcattcattcactcatttgtcatggttgaattgactatcacaaaacaaactgaaaagtgttaacaggctgcactgaaggccacgttattgtgtgtgtcttttgctcccagacatgtatttgggctataaaattttgcatgatcctagttcgttctgagtttcccacgggacctttccaagaagaggaggaggagggagcaggggaggggtaagccccgctgagaatctgggcatatccctctttaaactcacctacaactgggcattcacctacgtactgatagcgatggatttttgtggaatgaagtaattcatctcctcggtgttcttttttatattgccttttatggcttcgacataaagactcagattcctctgtagaaaataaaacttgatggcttgagatcattaaaattgagaccagatattggctcaaaagggtccaagatattcagagaacacccagggatcctgttattttcatgtaggtcatggagaatatatgatggcggaaaagatgaatatcaaaagcctctgccttcacacttcctgatttcaaaacatactacaagctacagtcatcaaaacagtgtggcatgctcataaagacaaatagacctatggaatagaatagaaagcctggaagtaaaccctcgagtataacatttctccaaagatgatatacaaatggccaacaagcacatgaagagatgcttaccatcactaaccatcagagaaatgcaaatcaaagccacagtgacctcacacccattagaatggttactataaaaaaaaagtgttggtgaggatgttgagaaattggaacccttgtgcactattggtgggattgtaaaatgaaatgatacaactgctatggaaaaaagtatagaggttcctaaaaataattagaaatacaactgatatatgatcctgcaatcccacttctgggtaaatatctgaaagcaagatctcctttttttttttttaagagggggtgttttaccatgttgcccaggctgatctcaaactcttaggctcaagcaatctgtccaccctggctatggaatattattcagccttaaaaaggaaggaaggaaggccaggcacggtggctcacacctgtaaccccagcatttggggaggccaaagtgggcaaatcgcttgagcccaccaatttgagaccagcctggacaacacagcaaagccttatctctacaaaaataaataaataaataaataaaataaaaaaaaaaagagttgggcatggtggtgcacacctatagtcctacctacttgggagacagacgtgggaggatcacctgagcctagggaggtcaaagctgcagtgagccatgattgtgccactgcactccagcctgggtgacagagtgagtgacccagtctcaaaaataaggaaggaaatcttgtcacatgttacaacatgaatatgctttgagcacgttacgctatgggaaataagccagttacaaaaagagaaatcctgtatgattccacttacatgagttacctagaaaaattcacaggaacagaaagtagaggctgggccaggtgactcacacctgtaatcccagcactttgggaatctgaggcaagtggatcacttgaggtcaggagtttgagaccagctttgtcaagatagtgaaaccccatctctactaaaaatatgaaaaattagccaggtgtggggtgcacatgcctgtaatctcagctactcaggaggctgaggcacatgaatcacttgagcctgggaggtggaggttgcagtgagccaagatcgccccactacactccagcctgggcaacagagcaagactctgtctcaaaaaaaaaaaaaaagtagaatggtggttgccaggtactggaggagcaagaagaagggagttgttgaatgggtgtagagtttcagatttgcaagatgtaaaagctggagatctgtttcacaacaatgtaaatatacttaacactgttgaactgtacacttaaaaatggttaagatgggccaggtacagtggctcacgcctgtaatcccagcactttgggaggccaaggcaggcagatcaccagaggttaggagtttgagaccagcctggccaacatggtgaaaccccgtctctactaaaagtacaaaaattagctgggcgtggtggcgtttgcctgtagtcccagctactcgggaggctgaggcacgagaatcgcttgaacccaggaggcggaggttgcagtgagccaatattgtaccactgcactccagcctgggcatagagtgagactctgtctctaaataaataaataaaaactgtatttttttttgaaaagcctctgccctgccccactaaggagaagtggatccataaaacctgggtcaaaatacactgctctgaagacaatcggctgctcccccagccccaaatgtactgaagcaaaggatgtgagtgtttctgtggaccagaaggggaccagggacagaggaagctggtatgagttgagccccaaacctggcagatagggctgcctcgagcagcgaacaggacttagcagataaaactgaagattttgctggattcctagggctggggaaggactcagagacaagctggtggataaggcacccctggcatcaggggacatgcagatgcgcagatgttaccccagccacgtatgggttgcaggtgggaggtgtctctggagaagtcagggaagcccacgggagagaaagtgctaccatccctctagagcacagagccatcccctgatcatgcccatcaaacaaaaacttccctgttcctttcgccttgctcccacctctcccttccccagagaccacataggagtttcctgaagctgctgttacaaatcatcacgaactaaaaggcttaaaacaatagagatggaccctctctcagttccagagaccaggagatcaaaatcagtctcactgggctgaaattcaggtatcagcagggccatcccagctccaaaggctttaggaggggagtttctcttctagcttctgccagctttcctcagctagtggctgcctcatgccaatctctgcctccctggtcacatggctttctcttctgtgtgtgtcaaatctccctctgcctcccccttataaggacacttgtgatgatatttggagcccatcggatagtccaggacaatctccccatcccaagatcttcattcacctctgcaaacagactctttctttgtttctatatgagacaacctacaggttccgaagattaggacctgatctctcttgggtgccattattccacctactgtaggttggaaatcaccacgtgccagctgcagccagcagaataggaaagaaataagccaggcacctcctttcctttccgcagctctaagccttgcacctgcatcaagccctcataggaaagggtgaacattcccctttacaaatctgagtcctgaattgagagtgttttatgtctggttcctggaaacagattcttagatggagatttgcctgcaggaggtttatggggggtgccgggggagggtgtttccggaagcgcacctgggagggagtgtggggctcagagggggacactgaactgggatgcagttgcctcaaggcttcaggcaatgcacggggtatcttgggggctggggaagggcctcagagttgtcctgcattcagacaaggcaacctggcctttgtccccccacattggatgtggctgtccccagatggggacacaaccaggtactaggccgctcctaggcacagaaggcaattccagaagagagacttgcggcactcgcagcagctgggggcgtgagtgcctccccctaaaggggggcgcggtggcacaccacagcgcccaccacagtgacctcaagtgaccatgggacttctgatgagcaaacctgagttgagcatgatgagcaaacctgagttgccgagagagaacttctgcatggaataagcatgtgaggagtgcgggagtcaatacaaagttactttatgatcatgtaacccaagcaggtccagccaatgccagttggagagctcgagcccaaaaacaagagcaaaatgtggtagaaggtgactttatttaccaaaactagcaatgggggagtggttggattcacatcaaaagcaaccgcttcgcctttctgggttgaaggcaagagttttaaaagggaaactctggctgggcgcggtggctcacacctgtaatcccagcactttgagaggccgaggtgggcggatcacctgaggtcaggagtttgagaccagcctgaccaacatggtgaaaccccatctctactaaaaatacaaaaattagctgggcgtggtggtggacgcctgtaatcccagctacttgggaggttgaggcaggagaatcgcttgaacctggaagacagaggttgcggtgagccgagatggtgccattgcactccatcctaggcaacagagcgagactctgtctcaaaaaaaaaaaaaaaaaaaaaaaaaggaaatttggtacaggaggtgtgcaggagttgtgaggagtacaaggtctgtgtcttgtttccatggctaactcgggtctcagtccccctaaagcacgggctgacgtcatttcagcaatgtgctgagttgttggctagctgcctggaggtaatctcttgaattctgcagctgggtctccaggctcggtctgtctcaagattagcccctggaacttcttttatcatcatcatcatcatcatttagagacagggtttcgttatgttgcccaggctggtctcaaactcctgggctcaaggaatccttccgtctcagcctcccaaagctctgggattacaggcgtgagccatcacacctggcctggaacttgtaagcaagcatataattagatactagcatacagttagataaatgtgaaggggctttatggtgggaaagggagggacatggagtctattttagggttaagggaaaaggcttctgcagtttgctttaaggttacttcttgagactgaagagaaagggaaaaaaagttgtaaaatgcatttgaagttaagctgctcagttacaatcactaacccctcggttcagtggagacacccctggaagcccattgggttattatctttattttattcatttatttttttttgagatagaatcttgctctgtcggccaggctggagtacagtggcattatctcggctcgctgcaaactccatctccccagctcaagcgattctcctgcctcagcctcctgagtagctgggattacaggcgtgagccaccacacctggctaatttttgtatttttagtagacgggtttcaccatgttgaccaggctgatctcaaactccggacctcaggtgatccacctgccttggcctcccaaagtgctgggattacaggcctgagccaccgtgcccggctgggttattatcttcttagggggaggacaaggaggtgatttagtcatttgctccacaataacttgttgagtacctactatgtctggagctgttttgcaggtgctggggattcagtggtgaataagaagcccctggaggcgagcaggacgtgctctgggtctgagtcactttcatctctgtccacgaggctgggtgaggagccttcctcactgtgctctgtagagccctggcacaaggcagggctgccccagggtggggaacgtcagagcttccaggctgccttcctccagaccccagagcctggactgggcctcagcgacccctccccagtcaacccgtcttctccctccagctgcctctggccgcttgtgcgtgagggtgggtgagccctttgggatgagtctcatcagagcctctgcacgctgagtgcttcctgcctgcttaattttgccactttcaatccaaccagaggggcattttgggtcttgctgaccaaccccctgcctccaagagcaactaaaacagagacatccttgagagttgtgttgagtgcttaaaacctccagggagggaattttttactgcaacttgcaaatttagccagcctggctgaccgaacaggcttcactcagtacctcatctccacctcctatgctgggtacacctgggtgcatattagagcaaaggctgaaaacaaatgtttatattacagtacaaccctatgtaaaatacacagctgtacaaaggggtaaggctgctttttacgtactgatacaaagaacttctctccagtataactatgaagtgaaagaggcaaggtatggaatactgggtggcacatactaccgtttatataagaagacagtagtaggaggagagaagaaaagagcaaaagcgccccggacatagtaggtgttcagcaattctagtggagcaaatgactaaatgacctccttgtccttcctcaaaaaagataacccaatgggcttccaggggcatctccactgaactgaaaagtttgtaattgtaaccaagcagcttaactttgagcacattttacaacttttctctttagtctcgagatgtaacctcgaaggaacctgcagaagcctttttcccttaaccttaaaatagactccacgtccttccctttctcaccataaagccccttcaaatttatctaactgtatgctagtattggaggaggaagagaagaagaaaaggatacacacacatatttacttggtcatgcataacatttatttggaaagacatataagaaacgggtaacactgtcactacctccacctgcaggtgggtaaggcacagggcaggagggagactctgaacttggaatcatgtgactgtggtacctattcaggagtaagcatgacccagcctgggcaacataacaagaccccatctctgcggaaaaatgtaaaaccattagctgggcatggtggtgcacatctgtagtcccagctgctcaggaggctgaggtgggaagaccacttgagcctgggaggtcaaggctgtgaaccatgatcacgccacttcactccagcctgggtaacggagtgagaccctgtctcaaaaacaacaacaaaaaaaaactcaacccaagcttaagacatgaaatgaacacaattttaaagtcagttatgtaagttccttgtgccagagaagggttcctatttctttgctctgtgggctccgctgagatgagtagcagctgatgaccctggcttgatgtattcattccactaacacttgctgtgcccccacccccaccgacacagctgtaagcaaagagctcaccttaatcactgggggttgggatgcaggttcctggaccacaccctagaccttctgggcccaggaatttgcaatgttaacaagcacccttgataatttttgaaaccaccagagggttaataaccacctagtctaggcaggcgctgtggctcacgcctgtaatcccagcactttggcaggtcgagataggaggatttctgggatcaagaagttcgagactagcctgggcaacatggcaaaacccggtctctacaaaaaatacaaaaatcagctggacatggtggtgcacacctgtagtcccagctacttgggaggctgagatggatcactggagccaggtaggttgaggctgcagtgagctatgattgcgccactgcactctagcatgggtagagaccctgtctcaaaaacaaaaccaaaccaccagtccagcactttgccgagctccttcgtcaatttccaggagacacacaccctagaactgagaccccagagcctgggcatgctgccacacattgccatcctgactgctaccatcaactcctcccaactgccctctgcaggtatttgccccgacagcttccagctgagtcctccagcaacatggccaagttgatcactccaaggcaccgacttcccagagcccctcctcttcccagctgaaggccacagatgcctaagcaaccggcctcagactcccctggcctgcagctctgcaggcacgaggtgcctgataaattggtgatgaaggggttctgatgccacctgctccccagactatcagccaccaggaagctcttagagggaaaatcagtgacacctgggcagctgctgacccctccccttcttaacaagggggtggcctgcacaggcctggactgtataacagggaagggcagggtgagccctggggcgtctgaggctgctgtgctgagtgagggctgcggtgcaggcctgaggatggtcagcgtggagggccgagccatgtccttccagagtatcatccacctgtccctggacagccctgtccatgccgtttgtgtgttgggcacagaaatctgcttggatctcagcgggtgagatgctgggagctctgccagaggtggcaggcagacaggcaggcaggcctgggacccagtccccttgatctgggagttgggggttacttctctagcctcactatcctgccccatcttgggaagccttgggtctctagtggggggcctcccagttccaaccacgcagaattctgacttaaatcctgcctctgccctgtagcagctgccatggactcttagtgaggcaagggccttggcctctctgttcccctatctgtgaaaccatggggacgctggcctcggggggctgtgaggagcaggccagggagactgctagatgctggagcctgcaggtggaggtgactcagcagggtcacagtacaacttcctgagtcgcttgccctgatctttttctttatggggatcctttgtggctccccccttcttgggaattgggtgcttattactaagatgtagctgtggtaacttctgcagtgtcggtagcgggatggggtttgggctggagcccgtcggagagcaaacacaggggtcctttgggagggggtgggtaggaataaggaccccagaccactctgcctcaacaccctaaggagaatgaggattcgggagccgtcccctcccccatgccagtcatctcctaggctgagaaggtgtttgtgccctgacgcgtgtctcttaccgggcaaaccaggtgtgccccccagaagtgccagtgcttcaccatccatggctctgggagggtcttgatcgatgtggccaacacggtgatttctgagaaggaggacgccaccatctggtggcccctgtctgatcccacgtacgccacagtgaagatgacatcgcccagcccttccgtggatgcggataaggtaagcctcaggggaagaggtgaggggcatctcccggggtgggacctagcacagccactggggcttcctcctggctgcagacgtgactcgagcctgggaaacacgttgttttgcacgtctgatctcatccagtgtctgcaacagaccagtggtgtgggcactccatgaccccattttacaaagaaacagaggcacctagcgaaggtgccctgccaagtcagcaaccagcaggactgggatttattttttattttcatttatttattattatttttttttttgagtctcacgctcattgcccagactggggtgcaatggcacaatctcagctcactgcaacctccacttcccgggttcaagcaattctcctgcctcagcttcccgagtagctgggactacaggcacccaccaccatgcccggctaattttgtatttttagtatgagacagggtttcactatgttggccaggctggtctcaaactcctgacttcaagtgatctacctgcctccacctcccaaagtgctgggattacaggcatgagccaccacacctggcctaccatcactttacatatgaggaaactaaggcacagagtgctgtgtctaaacctaagtagcctacctagagtgggatagacccaggatttgagcttgagcccaagggtgtattctcccctgggtaagctgtctccctaatggggtgcctatgttggggaggttctcctgtggtagaagcaggtggctcattcagggcaggagtgttcaaccttggttgcaggtgagaaccactggggagctaataacatcaatacccaggccacaccccctctaccaattaaacctgaggtaccaatggaacctcagggctaggatcctggccgctggtttaaagctctccaggtgcacccagtgcggggctgggggtgagaaccatgatggagcagttcaggactgggagagctctccctccctccccccacaccctacaggacctactggagatgtctgctgcagaggggtaggtacacacacccacctgcgctgtgtgcccagggcaggcaactccctgagaggcaagtagtggacttaggtaggaactgagtgtctctggccaggtgtggtggctcatgcctgtaatcccagcactttggaaggctgagatgggcagatcacctgaggtcgggagtttgagaccagcctggccaacatggtgaaacgctgtctctactaaaaatacaaaaattagccaggtgtggtggcaggtgcctgtaatctcaggttctcaggaggctgaggctggagaatcgcttgaacccaggaggtggaggttgtagtaagctgagattgtcccactgcattacagcctgggcaacaagaacaaaactccatcgcaaaaaaaggtatctcagataagaatggaggccacggtgggtgccagtggaactccagactacctgagaaccattctctgcccagggctcggcctccaggaccctcaggagtggccaacaaagaaccttgaacttagaggactaaagcttctatttaaggatggggtggatctgtcacatgctctggccaatggttgggtctctggttcatgaccaagaccttgtggtcagggtcagtggctggagggcaggtctctttctaaaagcataaagtagaggctggtgtgggacacagtcccacagttgggactgagtcccaacgctgcttcttcacctgggtgtccttcttagtgagcagcttaagccaccagaggcctgtttccccaccgtgcaccttatggagtaggacatgggaccccaggagagtgggtttagcagggaggatgtatagtgtggtttcaagcttgggctctagagccaggcagcctgtttcttaaatccctttgggataagtcccttgatcaccccgccatcagggatacagctctcacgtggacaggtggtttcaagcctggctctcgacaaggttagggttgggggtcatggcaggttctaagtccttaggggactgactcagccctaagcgcagggctgtggccccataccagctcataggtgagacttcagaagccataacacaagaccaagatcccacgcctagactcggcacatggcctggggctctgttcctggcacctcccgtccaacactgcctatggtttcgggatgctgtctccacaggtctcggtcacatactatgggcccaacgaggatgcccccgtgggcacagctgtgctgtacctcactggcattggtgagtgttgctccaactgggagcctggggcccaactcaccgctggggttggggaaggggtgggattgtaggaggagccaaaaaagattctccaggtaacaagatgcctcctgtgggccccaggaactcctgaacaaactcctaaatggattcatttgagatacccactcacacactccctcctcgacgctcagtcacttctccatcttcgtgcactgccaacctaattctgagaatagaaacagccagaacttccgtgtcgctgccatctacccacctacgcctgtctagtgcctaccttcttcctttgttactaattgacgcatctggtccaaagttagtctttcttgtctcactagatcctttcttattcaagaacattcctttgtcaattcttaccaatgtaagaagccgccacccttccccgccctctagatcacccccatcagctcaggaacaagctctataacatctactttttttttcttttttttctgagatgagtcttactgtcactcaggctggagtacagtggcatgatctcggctcactgtaacctctgcctcccaggttcaagtgattctcctacctcagcctccagattagctgggactataggtgtgtgccaccatgcctggctaatttttatatttttagtagagacaggttttcaccatgttggccaggctggtctcgaactcctgacctcgcgatccacctgcctcggcctccccaagtgctgggattacaagcgtgagccactgtgcctggccatatcatctctcttaaacctgattctagggtgtttgtttttgtttgagatggagtcttgctctgttgcccaggctggagtgcagtggcgcgatcttggctcactgcccattccacctcccaggttcacaccattctcctgcctcagcctcccgagtagctgggactataggtacccgccaccatgcccggctaatttttttttatttttagtgggctaattttttttatttttagtgggctaattttttttatttttagtgggctattttttttgtatttttagtgggctaatttttttgtatttttagtggagacgggatttcactgtgttggccaggctggtctcaatctcctgacctcgtgatccgcccacctcagcctcccagagtgttgggattacaggcgtgagccactgtgctgggcctaggttgtcttttaaagtctattctcccacctctcttcctgaggagccatctgtgtcctcaatttctctagaatcttctcaaattagacacctaccaccaacggagttcttttagaactctaacatctacaacactaagtttttggtttgtgtgggttcttttgtgtttttgttttgttttgttttgtcttgttttttgtttttgagacagtctcactctgtagcctaagctgaactggagtgaagagacacgatcatggctcattgcagcctcaaacgatcctctcacctcagcctctccagtagcttggaccataggtgttataccaccatacttggttaattttttatacagacataggtatccctatgttgcccaggctcctcccacctcaatctccagagtggctgggactacaggcacgcaccaccatgcccagctgactttatttttttattttattttttcccccatagagagggttttaccatattgcccagcctggtctcaaactcctggcctcaagtgatcctcccgcctcagcctcccaaagtgctggagttacaggcatgagccacgtacctgctggtcaatcccctcttaacacacttgaacgcttcagggatgttcaacttatttttcctcctgcctgttccttctcagaaccctttggagctcagaggagctcttctcagtcctttgtcccgctgcttccagtcagtgaagtgtctcaggctcaggaggcaggtcacgtgactctaatgtcacctatgggcaggctgctcccacaaacccgacttggatattgcctacccagcatgatcgcttcggtgtctgacagatgtctgaaatgcaaatggattctctctactcctgaaaacctgtttttctagtagtccctccatcacagtaggcggtagctccatccttctagtgtaaaccttggcatcacctgattcttcttaccccacagcagtctgaatcttgtgttacctgacgtttcgccagaatccagcaactcgcactcccagtgtgttcactccggctcgagcccccatcctctcacctgggtcacagcccagacctcccagtggggttcatgctggcactcttgcccttctgactaagacctctagccttgatccagcagccagagtggtacatctttaagtggaatattggaataacgccttccaactgcttccacgttgcttggattaaagccaaagtcgctgcccacgaaactacacgagtaaccctgcactgcctctgtctttaccgcttgtgaatcttccccctgggtcatcctgctgcttctgctgtgggtcctgttggccactctaacccttggccttgctgccttgggcttcctatttcccctaatggctcttaccctagatgttaacccagattttcttgcctcctttaggtctcttttcaaatgtaaacttgggctcccttgatcatctaaaactgaaataccctcgctccattccttctcccatatccctcagtgcttattgctatcaaacatgatgtacctgcttgccccacccctggtgtacacatatgtgctcatgtaagctctaaggagatgaggtctccgtcttgcacgctgctagatccctaggacctggggcagcccagttcgcagtgggcatctggtccctgagcatctgctggtcaggtgctgatgatgtaacagcaaacaagtcctgcgttcgtggccctgatattccagttgggaatcagcatgtcaaataatgagctgtgaacaaaagaccacactggagcgacgtggttgtcccttgtgtggtggaagggatgggaggtggtatgctaaggaggcgggacagtccctatgacagtacctgggcaaaagcctagatccttaagtgtgtttttttgtttgtttttgttttttgagatggagcattactctgtcacccaggctggagtggagtggtgcgatctctgctcactgcaatctccacctcctgggttcaagtgattctcctgccttagcctcctgagtagctggaactacaagcacctgccaccacaccgggctaatttttgtatttttcatagagacaaggttttgccatgttgctcagtctggtcttgaactcctgacctcaggtgatctgcctgcctcagcctcccaaagtgctggggttacaggcatgagccaccatgcccagctaatccttaagttttaaaggggcttagaattgtcatgtattgaattttttttggggggggggacagaatcttgctctgtcacccaggctagagtgcagtggtctgatctcagctcactgcaacctccaccttcccagctcaagtgacactcctgccttggcttcccaagaggctgggactacaggtaccctccaccatgcccagttaatttttttttttttttttttttaagacggagtctcgctgtcgcccaggctggagtgcagtggcgcaatctcggctcactgcaggctccgccccctggggttcacgccattctcctgcctcagcctcccgagaagctgggactacaggcgcccgccacctcgcccggctaatttttttgtatttttagtagagacggggtttcaccgtgttagccaggatggtctcgatctcctgacctcgtgatccgcccgcctcggcctcccaaagtgctgggattacaggcgtgagccatcgcgcccggccgcccagttaatttttgtatctttagtagagatgcgatttcaccatgttgcccaggctagtctccaactcctgaccttaagtgatccatccacctcagtctcccagtgttgggattataggagtgagccactgtgcccggccatattaagcctttcctatgtcttggagcataaagctttccagaagactagagaggtagactttgcaagtaagaatcacttgggtagaggctgaaaggcatgagatggcatgagaggaccatgatgggcttgttttgtgagttcctgggaggtttggggtagacatttgactacttgggcctctccaggcttgctgatatgaagctgtcacctttgagaatggtttctgcttctaagctgatagcatgccagaaaggctagatgccctgatgccagccttgggcagccccacaggagataacctataactttgaggttccatctggcaggtcaaggtggctgggacacccttttcttctgtttcagaggtctctctagaggtagacatctaccgcaatgggcaagttgagatgtcaagtgacaaacaggctaaggtgagtctgccagcaaaagggggcagggaaggggccctataagccaaatctgcccacaggctcacttgatctgaccttcctcgtgtctagcccaattgctgtgacattgctgaaggattagatacgtggaggggaggggtaaaccaaactgtcacggtacaagtcagagctgattaaattccttttcttttgtggggtatttttttgtttttttttgtttgtttgtttttgatgttgtttttgatggagtttccctctgttacccaggctggagtgcagtggcatgatcttagctcactgtaatctccacctcccaggttcaagtaattctcctgcctcagcctcctgagcagctggggttacaagcgtgtgccaccacacctggctaatttttttttgagacggagtctcgctctgttgcccaggctggagtgcagtggcacgatctcagctcactgcaagctccatctcccaggttcacgccattctcctgcctcagcctgccgagtagctgggactctaggtgcctgccaccatgcctggctagttttttttgtatttttagtagagacgaggtttcactgtgttagccaggatggtctcgaaatcctgatctccagtggtccacctgcctcggcctcccgaagtactgggatcagaactgattaaatttctagctcactaaaaaaaaaaccagaatgtctggcaactctaggctcatgtcctaccctggttgtggagtctcctagatgagaggattagccgctgctgccaggtggcacgtctcttttccaatttgcctcggtccctgattctctgactctgaaatatgaggtaagtaactggtaaccccgaacctagcttctttcccttcctcttagcctccttacctgacatgaccttcctgtgcctacagattcttgacctcaccagtcctgttccatgggtccctgtaccctggagaaaggcttggctgggcccctctgctatgaggtgcatccgagaaacagaagatttatttggctccttcctgagccaatgttcccatctcatttgcagaaaaaatggatctggggtcccagcggttggggtgccatcctgcttgtgaattgcaaccctgctgatgtgggccagcaacttgaggacaagaaaaccaagaaagtgatcttttcagagggtaggacctcagactgtctctgcctttccttcttggtctctttgctgccctgcttctcagcaaatggattccagactaattttctccaccccacccccgacaccctcttccccagtccccatgcctgggctgatcaaaccttttgtcctgagttgtagatgtataattgggtaagagaagtcacatagccccatgcaaagagcatgggtggttacttgtttcctagctgtgaacttgagcacactaacttccctgatcttgtttccctatttgtaaaatggggatgatgcagttggcctcccaactatatcagttggttgacaagactaaatgaagacaataggggtatatgcgctgctttctaaaaagcctctcatagtctgggccaggaaccttggactgtcttgggtaaaattcgccttggatcctgacttgcggttgggaccagggttctgggtcttagcagtagaatggaatgtcttgtttcctactgagactggaaacaagactggaaacaaggtgaaccttcactgaactgatcgaggtaggccctgttctgtttgtgggggaccatgggataaatcccatcctccctcaaaaggaggccctgaggtttgcagcttgcctgtagccacctagaacaagcagtgaaatggtaattcttcgggcctgggccctagcaaaaggcagggggtccttggtgctctgttcaaactcccggcccctctctactgctcttccctccacccccagagtgctggcctccagacattccttaacctttgctttgtcttttgcccagaaataacgaatctgtcccagatgactctgaatgtccaaggccccagctgtatcttaaagaaatatcggctagtcctccatacctccaaggaagagtcgaagaaggcgagagtctactggccccaaagtgagtgttcttgtgccagctccagctttgcctgctctcgacgtgccaggcaagttgtgcccacacctcctcccagcaaggtccccagcagaagcctgctggagacctagagctgcagatgagaggctgttgtggctgtacttgtgtttccaggattctctggctgccaccttccccataggctaaatctgtacacatgggtgagttattgcacctctaagccactttctccacttgtaaaatgggggtagctgtgccttccctgcaggctagaagagaagagagacatatccactgaaacagtagctattgccttacacagagtagatcacatctcccagtgactcctctcaggagaatccatcttcactctaaaccaatgatccactatgttaaatttccagaaatctgaggccaaaacctctagagcggcagccacggtagcacctgcatcccagccaccacgccatccaccacccatcttcagccctcctctcctgggaggcaggtagcatactctattctatagatggagggctggttaggaggtacacatgcccaactccagcaaaacagccttgcacatcttttgacttccctgaactggctcaggacttggcgtacctctaaatctctcattgagagctagctctgcttctggacggacatgccagcatgctttctttgggttttgttttgtttttcccctttgagtcaaggtctagctctgtcacccaggctggagtgcagtagtgtgatcacagctcactgtagactagactcagcttcctggactcaagcagtcctcctacctcacactcccaaggagctggtatgacaggtgtgtgccacaactggctaatttgcttttcttgtagagacggggtctcactttgcccagactggtttcaaactcccggatgcaaacaatcctcctgccttggcttcccaaagtgctgggattacaggtgtgagctactgcacccggcccaacctgccaccttgtcttgtaaaccatgcttagcttcagctacgcaacgcagggagctctgtggtctatactgtgcctcttctcagagggcaccatctttgttgccagcattggagagtgtgcccctgccacttcctggtctacactctggggccttggctcagtctcctactccatctcttctgcagaccatagatctcagctggatttcaaagtagcctgggattagccagaaaaggtagcccagcttggacgtggccatcttacacatgagctagagtgagccgaagaaacccaggggtctaggtctggttcaggccacaagggctactctggccctgggaggctaccagtgctgaagtaggtggattaggccaggcaggccttggagtccgccggttcatgtagcttgctaaggatgccatacttcatcatgtggatcatagcgaactaccggtttctttattgaaaaagcttattcaggctgggcgtggtggctcatgcctctaatcccaacattttgggaggctgaggcagatggatcacctgaggtcaggagttcgagaacagcctggccaacatggcgaaaccctgtctctactaaaaatacaaaaattggcatggtggcgggcatgcccgccagctactcaggaggctgaggcaggagaattgcttgaacccgaaaggcagaggttgcagtgagccgagatcatgccactgtactccagcctgagtgagactcaaaaaaataatttttttaaaaaaacttattcaacaatctaggggctgagcacggggcttatgcctataatcccaacacttcgggaggccaaggcaggcggatcacctgaggtcaggagttcgagaccagcccggccaacatggcaaaaccacatctctactaaaaaatacaaaagctagctgggctttgtggcatatacctataatcccaactactcaggagaccaaggcaggagtgaacctgggaggcagaggctgcagtgagccgacgttgcaccactgcactccagcctaggtgacagagtgggactctgtctcaaaaaaaaaaacttaaaaatcagggtagggcaacacagcatgttatgttttaacaagccttccaggtgactctgaaacatgctaaagcttgaaccacaaaaagatacagcaaaagagtctgaaaagtttacagaggaatagaaagccagaatacagggttctagaaacaggctgggtgtgttggctcacacctgtaatcccagcactttgggaggccaaggcaggaggcttacttgggcacaggagttcaagaccagccttggcaacacagtgagaccttgactctgagataagattatttttataaagaagcctggccaggcgtggtggttcatgccttaatcccagcactttgagtagaccaagactggtggatcacttttgaggtcaggagtttgagaccagcctggccaacatggttaaaaccatctgctaaaaataccaaaattagctaggtgtggtggctttagcttgtaatcctagctactcaggagactgaggcgggaggatcatgtgaacccgggaggcagaggctgcagtgagccgacattgcaccactgcactccagtctgggcaaagtaaggcagtggccaaccctggcaaatgctgtgggatagactaagatgcccaagcccatagtaaagtcacaatcctcagaatggcagtcatcagtgaccctgataataacagtgaaaagccaggttgaaatggggaggcacagtaaatctaggccacagaaagaattctctctccgtaaagggagatgtgtggtggtaattacaggggccagcacgcagtcgagcgtgtctgaagctggtagtacacgggcagatgtatagatggaactgatccaacaggggtggggaaatggatcctagaggaagatctgagaagtttgcagaggaatagaaagccagaagacaaggttctaaacaggctgggcgtggtggctcacacctgtaatcccagcactttgggaggccaaggcaggaggatcacctttaggactatggaatacaggtgagtctgtggacaggaatgagacgatagtgtttgagtagtgttggtggcttgctctgaggtctggtcgtagcctgaaatgaggccttttggtgtgatggttttctccagcatctcaggtgcaagagtgagctttaaagacctggtgtgaccagaatggaggttttccaggaaagcaaactagaaaaaggtgtgggagtggacagtgtgtataagagaggatgtagtgatgggtttttgggctctgagaagggtcaaagggaagtgtgaggatggagggtggggatcggtaggaggatctgggactgaggttggggactcgctggggtgggagcataggtgagcgaaacagatcggaaggcattgtctgccttggaggtggcatctagtctgggttatgatcattgtaatggatgtctaaggtggtatagaacccaggttcattgaaataaggtcgtcgaagagagatcaaaatgtctagatgttctagtctattgtcagataccagtgacacaacagcagtggagggcaagtatgctagaacaatccacgaaggatggagaggatgacatcgtcgtccccaaaagaaaggggtagctggcattatctgatggccagcacttcacaggaactgggattcttgaggaatagagaaatggccgagaagtgccagtgaagaaccaagaagggtacccaccttcctgtaagtccagcagtacatggcaggtaggaaaaagctcagctcaaatcatcagtatttgctctgtgccctgaggatccagctctggaagaataaaccatgttacctgctctcagagcctgctacgacagatggacagacagtcgaggacccagcagaggctggagggagccctttaatatgcccccagggtgggtagggagagtttgaggtagctaaggcctcctgggcagctctgtgaggactgagggcagggagggccttccaggtagaggcagctattgtgtgtacttgggtcgcagggcttctggcctcccccatgcttctgtttaatggggacaacaaatgcctgcttcaaagggtcctgaggatgtgagcccatgagcctgaaacacctaccacagctcctagcaaagatagcccacagtgaaatgttagctatgcttcacaacaaactatctgtgagaggggcccccagaaggtcaaccacaggagagccagccagtaggggattgtggcaaacagactgtgaccctctcgccctcactgcctggtggtgaatcacccttgggtggaatggccacagggagcccaggtccccagaacaggagcaggccctaggtgtgtggcacctcttgggctgcatgccgtgggcctgctgatgctatcgcaggtcaagagggctgtgtctgcactgggaagttgcaggggttcctgggggaagactgccttgtctggtcttgccccatgaggcctggctcagggctggtgaagcatctaggtagatgagaagcaggaactagcacaggagtggtcccggtgggcccagttccctcacagccagcagcaggactgaggctgggcctgtaaccagcatccccagggcctccaaggaggggctgctgcagaactgcagagtccatcgggagggctgctggggctctaacccagagcaagaggccgaggacccagggcagtgcctaaccaggggcagccacggccgcagctgcagccatctgctggcacgttggaggagctggagatggaggcagctggcagtgccgtgcagaaggtctgaggatgctacagttcctggatctcttggggttctagtggccaaggtaaatctagcttaggatcccctgaaataagtcacctggaatcttgagcaggaacagccatcaggcctacagctgccacatcgggcacagatagaggacaggccaggaaagaggaagttcgagtgacccaggtgggagaagtcagggtcatttctgacctagaaaatgaatggacttgggctgggcacagtggctcacgactgtaatcctagcactttgggaggctgaggcagatggattgcctgagctcaggagttggagactggcctgggcaatgtggtaaaaccccatctctactaaaaatacaaaaaactagccgggcatggtggtgcacacctatagtcctagctactcaggaagctgaggtacaagaattgcttgaacccaggagatggaggttgaagtgagccgagatagtgccgctacactctagcctgctcaacagagcaggactccacctcaaaaaagaaaaggaggggggggggccaggcgtggtagctcacacctgtaatcccagcactttgggaggtccgaggtaggcagatcacgaggtcaggagatcaagaccatcctgtctaacgagacggtgaaatcccgtctctactaaaaatacaaaaaattagccaggcgtgtggtggtaggtgcctgcagttccagctactcaggaagctgaggcagaatggccagaatccaggaggcaaagcttacagtgagctgagatcacgccactacactccagcctgggcgacagagcaagactccctctcaaaaacacctttaggatctaattagcaaacggacaaccaccacgtgtggtcaacttccttctgatctcttctgtgcatggttttgtatttaatgacctaaaactaggagacaggcttaacatgtataatcataagaacacttggtttcttcagaaaacttgatggaggcataatccatccaataaatggttctcactgacctttctagcatcagtaagtgatttttttcagatgaggctgctgagcccagcctgggacagtttctcacctttaggactctgatattatcgcaggagttggattcatgggccaaaatgtagaaccacctaccctgaggcttcacaccagtcaggagccttgaaggcatcatcacctgagctccaactcctggcatgtaataggtcttcaaggaatactggtgaataactggccattgcttgtgtatgaacatctggttgtctaccaagacctgaatgctagaaacggggatggctgagccatttcagctccagccctcctggaactcacagccttgcatctgatatgaggaatgagctggtaccttgaccatcaaatgtgaccggcaccaggttacttcagtggctggtccatcccttctttctctcctagaagacaactccagtacctttgagttggtgctggggcccgaccagcacgcctataccttggccctcctcgggaaccacttgaaggagactttctacgttgaagctatagcattcccatctgccgaattctcaggcctcatctcctactctgtgtccctggtggaggagtctcaagacccggtatgtccccataatagatgggtcctcagactaggatgctccggtgggggaaaagccatctcccacagttgggcagagcttgaggtttgctgggggagagctgcagaaggcaagtggggcccagctgggggccggactgaacggccggaaccctggggtaagaggggagcgagtaaatgtggaagcaggttgctaacaggaccttgtcttgttgcagtcaattccagagactgtgctgtacaaagacacggtggtgttccgggtggctccctgtgtcttcattccctgtacccaggtgcctctggaggtttacctgtgcaggtgagagaccatcaggctgactgtgccaggcggttctcataactggcaccctcttctttctatatgcagggcagggtgggtgaagatgactaggacctctcaccaggagagttgaaacccttctgtctgagctgtctggacctgccccaagacagtccaatacatgcctgaatattcccaaagatgggcatggaacagtgaatgagacagtccccccattatgtgagggccaaacggcatggttttaaacagtaccaagtgctctaaagcagggtgaagatggagaggtcaggatgagaacctgtcccagggacgatgaagctcctacggagccagagaacaggtgtgagcccaggaaggggcggtgtggggatgggtgaaaagagcagagccctgtgggccctgggtgttacggtgaggtagctggggccatacctactctaaatacagtggtgaaagctttctgtcacctggatgcctgcaggaagatggtactgctcgcccactgccacttaggggccctggttcctttcagtcttgttatgctttcccctggggtggctgcctcctctctggaggctgagtgcacacatcctaggtccaggcccgggccccaggagggagaaagagccaagatttggacactgcaacctatggttgctgctagtggtctggaagtctcctgaaccacttctcacatgccaaaatcctgaacacgcacggggccacgtccggcttcagggaatccaggagcagtctctagctatgtagccacatgcctagggagaaaaggagataggatcctgaaggcagaaccagtgggaagccaagggttctgtctgcatgatcactctggccacatggaaagtcaggtacagataaaaggtggaagaccagtctagacacagcatggctcaagccagggtggcaggagcagcctttagttgggattggtccgcaggtaggacacccccgccccactcgctccacaccggccgcctccagattactaccaccacgttgccctttattgcaaattccttaggtgaaggcttttttgtttttttaaggtaggaggcaaaggataatgctgatggaatgctctagcagggatgggaaacactaataggaaaaggtggccagtgtggtggctcacacctataatcccagcactttgggaggccgaggcaggaggatcacctgagggtcggaagttcgagaccagcctggccaacatggtaaaaccccgtctccactaaaaatacaaaaattagccagatgtggtagtgcatgcctgtagtcccagctactcagtgaagctgaggcaggagaatcacttgaacccaggagacagaggttgcagtgagctgaaatagccccactgcactgcagcctgggaaacaagagcgaaactgtctcaaaaacaaaaaataaaattgctgggtgtggtggctcatgcctgtaatcccagcactttgggaggctgaggcgggcggatcacctgaggtcaggagttcaagaccagcctggccaacatggtaaaaccccgtctctactaaaaatacaaaaaacaattagccaggcatggtggtgcaccccagtaatcccagctactcgggaggctgaggcaggagaatctcttgaacccagaaggcggaggttgcagtgagccaagattgcaccactgtactccagcctgggtgacagataagattccatctcaaaaaaaaaaaaagacttctacccctcttccaggctccgtgggtgtagaagccagacagcttttccagggcagggctcctggggagtgtggtcctcagaggaatagcaggcttcaggatgagaaggtaaaatctcagaaagtctgatgggattctgctgatggcagatacaaaagacataaagcagagagatgtggtatctcgagtatttgaagacgggtttctcactcacaggaggcatctacttgttcttcaaagaaacccaagtcttccatacagtgtgatattcaggcatggtttgaccccatatagctgcatatgacctgcaagactgagccgacacacccttcccccagtaagcgtcagactgttctagaccttgtcaggctggtagctccctgtggctttgcatagacccaagaaataggttctttggagcagtagcatagatactatgaatgtgctatgccagtagttacattgctgtattctattagtagcaacatgagctttggacctgaagccggactacagtcccaatttcaatatctcccaatattagggccttgctgacctccaacttttgaggacctgtttgttccgtttgtttaagataatttattattttttctttttgagatggagtctcgctccgttgcccagactggagtgtagtggtgtgatcttggctcactgcagcctccacctccagggttccagcaattctcctgcctcagcctcccgagaagctgggattacaggcatgtactgccacgcccagctaatttctgtatttctagtagagatggggtttcaccatgttggccaggatggtctcaaactcccagtcttaggtgatccgcccgcctcagcctcccaaagtgctgggattacaggcgtgcgccactgcgtccggccagatgagtggtcttaacatcagcctcacacactgctgtttcccttcaaggaagggatggccactgtagatctgtgagcctgatgctgtgcacaacggcttgaagaccccagggctcaagacccacccaacgccacacatataaaaatgacaaccatgcatggtggcaggcgtatagtcccagctactgtggggggccgaggcaggagactcacttgaacccaggaggtggaggttgcggtgagtcagatcatgccactgcactccagcctgggtgacagaacgaaaggaagggtacttgcagaatgtgaccgaagggtataaacagagcaggccttggctaccagggaaggggccgccactggcacttcccaacctggctctgccatgggcaaagctgagtagcgtcagacaagatgggctctgagcttctggcttgtgccgaggtcagggatggttgctctgtcgacctcacgggcagggatgtaacctctcctggtgagaaggatgtgttcttcctctcttggcacaaggaggtcataaccagtaagggaccttcgaaagccttcccagaactggcttctctcccatggcagggagctgcagctgcagggttttgtggacacagtgacgaagctgagtgagaagagcaacagccagggtggcatctgtctatgaggaccccaaccgcctgggcaggtggctccaggtaacaccccacctgggaacccacctgtcggggaggggtggggagactcagcatgtgccacctaagaggaacttcacaggcttctggttaaccttaaagaccgaagccttgataggggcggccctgttcttaggacttcagtggaggctcagatgaggatttgcctgagtcatggccactaaggaatagttagagtccagcctccttcccattccagaatggacacgtgttcaagaccacagaaccctaacccccaggccccggaaggctctgatacctttggctaaggctgtgagagctgggccactgccctggggtcccgcctgactctggcacagcaccaagtctagagccccggtcagccttcggttctagagctctgtcctctgcagatgagtgatcatcacatgctaggcacgccatcctgagcaccagagataaactggaacatatgctgtcccatgttagcaaggatagaacttttaagtgctatgaaatttagacaatgagatgatacagtgattcattagaccaaatgaggcagtttaagaatagttgggaaaatctgcaaatgaaacttaaggaaacaaggagctggccatgcagagatttggggcaggggtggccaggattaaaaggagttcctggccgggtgcagtggctcaagcctgtaatcccaacacattgggaggctgatcacttgaggtcaggagttttaaaacagcctggaaaacatggcaaaatactgtctctactaaaaaaatacaaaaatcagccgggcatggtggcgcgcgcctgtagtcccacctactctggtcactgaggcagaagaatcgcttgaacccaggaggcggaggttgcagtgcacctagatcacgccactacactccagcctggatgacagagcgagactgtctcaaaagaaaaaaaaaaatctggggttgtgcttggaggtcttgaagaaggctgatgcagacagatcacagtgaacaaaggtgaaaggcagggctacctcctggttaaggtaccttttaagctaaggacaaacaagagacactcaaagcatgaatcgggaatgaaaggttatagttcaggttttcaaaagacccctctggctaagatgtagggaacagatcttaagagtaggcaagaatagaagcgaaactggaaggcatcacagtggcatagggtggagacacggtggcttcctgagtggcaccagcgcagagctgactcagaatgtaagccagtaaggcttgttaatggattctttacgaaagaagaaaggaagaatctggatgctcaagtctttttcgcccagactggagtgcagtggcgcgatctcagctccactgcagcctctgcctcctcctgagtagctgggattacaggcatgagccaccatgcctggctaactttttggttttgttttaagtagactgtctcaccatgtttcccaggctggtcttgaattcctaggctcaagtgatccacccaccttggccacccaaagtgctgggattgcaggcgtgagccaccacacctggccatggatgctcaagtcttaaacctgaagagtaggggagagagggatcggagagccttcaagaaggggtgatatctgagctgggtgttgagggttgagcaggagttggcaggaaggaagggggttcttaccgtaccttttccgtaaatggggtccggggagatgtgtgactggcaaacaatctgtcttcctctccattccaggatgagatggccttctgctacacccaggctccccacaagacaacgtccttgatcctcgacacacctcaggccgccgatctcgatgagttccccatgaagtactcactggtgtggaacttggtttggctaatctgagctcagtccaatctctcaggcctggggcctgcctagaaataatggggcaccaagtggggagagggcccaggtggcctctgaggggggaggggacgtggaagtctacctgagagcctggatttagggataagactggggcctaaagccatcccctactaacaccccttccctggctcggtctctcccccagagccctggtattggctacatgatccaggacactgaggaccataaagtggccagcatggattccattgggaacctgatggtgtccccacctgtcaaggtccaagggaaagagtacccgctgggcagagtcctcattggcagcagcttttaccccaggtgagccacaaagccagacgcctccaaatgaaaggaagggaccatggtcgttcccctggccccgcctgcttcccatagcacctcagcaggtcacacacactggaccatttcttaaactgaagacatttgagcttttgattcacgtgggagactaaagatgagaataaaccatttattctttgattccagggtttaaactgaaacaagtgaaatttggtccaccaggatgtcatttccaagagatatgtggttggatttcttggtggccataaatccaaaatgatacttgtgcccgggcttgtctgtctagaaacactaggctctgttctgagtggggtcagagtaagggattcgtaaccaacacatccgctatggaccggcctctttcacacaacggtcagaggccagctccctggaggcagcatgacaccaagtggcgggtgaccagccctgggccacactggctcaagagctgttctttccatcttccttctagcgcagagggccgggccatgagtaagaccctccgagacttcctctatgcccagcaggtccaagcgccggtggagctctactcagattggctaatgactggccacgtggatgagttcatgtgcttcatccccacagatgacaagaatgagggcaaaaaggtctgctttggggtctggagaagggacatctgacccttgccttctgttggggaatcttggaagattctggagagaaaactggctttttcttgtttttttttttttttgtttgttttttgagagtcttgctctgtcacccaggctggagtgcagtggcgtgatctccgctcactgcaaccactgcctcccggactcaagcaattctcctgcctcagcctcctgagtagctggaattacagaaacatgccaccacacctggctcatttttgtatttttagtagagatggaatttcaccatgttggccaggctggtctcgaacttctgacctcagaggatctgcctgcctcggcctccaaagtgctgggattacagatatgagccaccatgtccagctgagaaagctggcttctgacccaagttctgtttcccagggcttcctgctgctcctggccagccccagtgcctgctataaactgttccgagagaaacagaaggaaggctatggcgacgctcttctgtttgatgagcttagagcagatcagctcctgtctaatggtaagggaactccctttccacagaacagaactggggtcttcctttttccaggggtcctttctacatagccattctgtcacgcttggcgtaaaggatgccagggaagcacagaagctgttggaattgccatattagaacgtcttatttctgggctgctctagtggtactacaacacaagtagaccagatgttctgggatggcctggaggctgtttggatgtatttgaagggggactcacttagtacataggtggccccaagtggggggaaaacgggtgttaacaatgctagtgcctggatttattcagggcatgttggattaagtatctagggactgggactttgtgggtctcctggttacattaaggaaacacacaggtggacaagcagaggtggtgtggctggtgccattgcacttctgatctaaaggctgtgggagtgggctgggcatggtggctcacacctgtaaccccagcactttgggaggctgaggcgggcagatcacctgaggccaaaagttcgaggccagcctggccaacatgacgaaagcccatctctactaaagatacgaaaattagccgggcatggtggtgcatgcctgtaatctcagctactcgggaggctgaggcaggggaatcgctttaacctgggaggtggaggttgcggtgagctaagatcgtgccattgcactccagcctgggccacagagcaagactccatctcaaaaaataataaaggctgtaggaacccagaaaggggctgggggtattaggtttttctagaccctcaatactcaaagtgttatctgagggccagcgcacctgggagcttgttaaaaatgtagaatttccaccctgctccacacctcctggatactcagcctttggggttggggcccgggaactcctggtcatagaagcaccatggaaggtgacatctgctgagcatgaaccacatgacaaagactatcacctcagagctggcaaataaattgggcatccctgtcccaaagatcaggcaattgaggaacaaaggtaatgtaacctggagagggtcacaggcagaaagtgccaggttgtattggcataaggggagtaggggctgaagtcatcctaacaagctctaggctgtgtccctcagcctggcacaggctattccccctcatgctggggacagagtggccagtggcagtaagtcctgcctgggagttctggtgtagaccctggtcagtccccagaaggaagatattggacctgagggtgtgatccctggagataggccagtcctctcgccatggtcactggcccaggaatgcacccaggtggctgggcctggcccgagtgtgcccagctctgggcagtgctgccattccctgaccagcaggcctgctgcccgcttcttcctacaggaagggaagccaaaaccatcgaccaacttctggctgatgaaagcctgaagaagcagaatgaatacgtggaggtaggaccagtgtgaagggggccatccccaagaaagagctggtgccgcaggtcttgcaggaaggtttccacccacccctcctgaggggtgaagtgttgggcggcggggggcagctgcctgccaccctttcttccaggtcttgatacaggcccaggtctggggctagagctggccatatgccaatgtagggagactagaggagtaaggagttaggtctctggagtcaaacacagcacgatgtacctttatgcttggaagagggctggaagtgggtaacacagctttctatggtgtcagatggctgaggacccagggtgggacaggggcagggaggagcgccatggcatgtcgggaccgttgacagatattacttgcagatactgtcagagggagtttactttgctatgactatgcagctggatcttttcccccaagctgggaaagccctgattatccaggttcctagctgagagccaatgatggcccaagcattttgcgagatacctcactacaaaccctgcagatagccctataaaactacaaaccctgcagatagccctataaagtaaaacacctcttacatatgagggtagtgaggcacacagtaaaaccgctagcccaggacaatcatttgggaaaatgagtctgaactcccaagttcatgtgttgctcattatactcaagctgcctggggtccatttcccggaaaatgacatagctccgcagcctccttgaagaagccggctcctcacttccgagaagctgagtatcagactcaaatagacgagggactactcaatgctttctggatgaagtggcccatcacagcagtcccgaggatggtgttcagggtcaccaaacttcagagatcttagaagtgaatcattggctataagaagcagagtctccccaacttgtagaaggagaagcttaggcccagagaagggtaatttcttggctgaggttgcatggtcagcaaaactgcttctctcactgggtccttaacattcccaggaatgttcccaaggaatgttctatgccccgcacagtgcatgggtaccctgttttgcaagaacagcccccctggcatagcagggtgggtgccagccaggcatggggctgagacagcatctcccagcccctggcgacagcttaggtgtgttgggtatgtgtctgaagcctatttcaagacctagggagacaggtgtgttgggttatgtctgaagcctatttcaagacctagggagatgcctgggtattgggctcagctggtctgggttgagaagtgccagacgctgtctagccatgggatcctggactaaagactaggccattcctgagcccctacttccccatgtgaaaagggaactgcctatttcgtaaggctggtatgaagtgtgaggctcctggcacacagcaagtgatggggatggtagtggtgtcaggccatcacctaccttcagtatggaaggaaactggttttaattcctgatgagctctccttgctcccccgcccccccccccacccacccacccacccacagaagtgcattcacctgaaccgtgacatcctgaagacggagctgggcctggtggaacaggacatcatcgagattccccagctgttctgcttggagaagctgactaacatcccctctgaccagcagcccaagaggtcctttgcgaggccatacttccctgacctggtgaggggcgactgcgcatccctgggtgggggagggcctgtccaggcaacactggctgccacctcactgtgctggactgcagatatggtggacagcagataacggtacctatgaggaaatgggagggagaccccttctcccccatctcggttagggacgccccacccagagagcaagtgtacagggcctgaaggcttggaggttccccaggcagttactatgggccaggccctgggccaggtgctttaggagcctcagtgagctgcgcccccagtctaaaagggtgaacctgtgaggcccacttcggatggggtgctatgcaacccagagtcgaggttgccgcgcatctgccagcagcgaggccttgagcaacctacctcagggtgggtcttcctgtccgctatctccagggtccagggcagcagtgtctgatacatagaggtacatcagcccttaaaataacattctaggccaggcgcagtggctcatgcctgtaatcccaacactttgggaggccgaggcaggtggatcacctgaggtcaggagtttgagaccagcctgaccaacatgaagaaaccctgtctctaaaaatacaaaattagttgggtgtggtagcacatgcctgtaatcccagctactcaggaggcagagacaggagaattgcttgaaccccggagacagaggttgcattgagcctagatcactccattgcactccagcctgggcaacaagactgaaactccgtctctaatatttattctgcttggctggtcgtggtggctcacctgtagttctagtacgttgggaggctgaggtgggaagatcacttgaactcaggagttggagagcagctagggcaacatagtgagaccctgcaactttaaaaaaaagaaaaaaaaaatgctggggccagggtgcagtggctcatgcccgtaatctcagcactttgggaggctgaggtgggtggatcacttgaagtctgaagttcgagatcagccctgcaaacatggttgaaactctctagtaagaatacaaaaaactagctgggtgtggtggtgcatgcctataatcccagctaatcagaggctgaagcaggaggatcccttgaacccaggaggcagaggttgcagtgagccaagattgcaccactggactccagcctgggcaacagcaagactgtctcccaaaaaaacaaacaaaacaaaacaaaaaatgctgggtgtggtgccacatgcctgtagtctcagccactcaggaggctgaggcaggacaatttcttgagccccggaggtggaggctacaatgagccactgcactctagcctgggtaacaaaccaagaccttgtctgataaaccaaaccaaaaaaaaaaaaaaacattctggggctgggcgtggtgtcttacacctgtaatcccagcactttgggaggcccaggcaggcagatcacttgaggtcaggactgcgagaccagccttacatggagaaactgtctttaccaaaaatacaaaattagccaggtgtagtggtgcatgcctgtcatcccagctactcaggaggctgaggcaggagaatcgcttgaacctgggaggtggaggttgcagtgagcggagatcaccctgttgcactccagcctgggcaacaagagcaaaactgttttgtttttttgtttgtttgtttttgttttttaaattctgttcctacttattctaaaccagaagttatagtcaagagtggggctgtgagtacaagaggtcctggcttcaccaagcctatgccgactgtggctcacatctgaactttctcatgtaacaactgaccccttatataggtgtgtaaaatgaactgaggcatttgagtgccccaattctctaaacacctgctgacctcttccctgggtcctagggacacaggccctgcatgctccaattgtacatgggtgtcttctaacttgatcagctcagtgtggtccggcaggggtgagtaacggtaagaagctgctttgaggaggagttgagatacaaaagatgcgcagcagtcaactgacaaagcgggggtggggagagtgtttcagtggaggcagcagccatgtgttgtatccaggtgacaagaggccagaataatcgaaacgtagaaactagagaagttgacaatcccagaccttggccaggcaggattttatctggctgttgagaaacagccattgtagggctaagcaaaagtgagctgggtttcactgacctggaggaggcggctgcctgcctgctacgcctggtctgaccgcagagaggcaggtgggcggctggctttcaggcctctgatccctgtccaggcctcacccaccctgtctttctaacagttgcggatgattgtgatgggcaagaacctggggatccccaagccttttgggccccaaatcaaggggacctgctgcctggaagaaaagatttgctgcttgctggagcccctgggcttcaagtgcaccttcatcaatgactttgactgttacctgacagaggtcggagacatctgtgcctgtgccaacatccgccgggtgccctttgccttcaaatggtggaagatggtaccttagacccaggccctggagctgccagctctgccccagcgtggatggcccactgtcaccatgcaacagcatgattctttgcccagtagaggaggctggagagtccaggcaacagaaccctttcttccctgtctgccccgaccgaccctcggacccagtaggatggcaaatgccgccagcttgaacccctatggggaaaagatgcaaaagtgttcagccaagtgacgtttactaaatagccaataaagggctggtgggtgtgaatgcatcttggcagtgacctccttgtttggggaggggataagtgacaactgaggacaaggctgagctgagatacctatggccatgctggcctgcttgtgtggggggagagacttggctacatcagttgctgtccttcccctcatctctaaattatgtcgtggcaggaagtggttggacttatccaaatggacttagattatccaaatggatttaagattatccaaatgctgctctggtttaagcaactgggacaagctgggtctagagtccagggcccaggctagaggaaggtcgagggcctcccccttgggactggtaggacctggagggggcaggcccacggtgggggtggtgccatgcacggcaggcagctggcctcagcaagtggaggctctggtctccttgggtctgtaggtgtggcctctttgagaaggcacagcaggggtggacctgggctgaccctcagcctgaaatgtcccctccagggcccaaagccacatattcccatctgaccacccctgtgttaatggtacagggatgctgttaagctttaactggcgctgtggctcccaccctgctcctcctggatgatgatgactctaggacactctaatcctcagggtagaacctgagaagggagccctgtgtccatgtcccacagggagttgaaggcagagctgggcctcaaactagcccccttcctaacacctggggctctgtgggcagcaggcaggacctggccagcctctgccagctgctggggcagtggaggagggtcatcctaaggaagcgaggcagaagccagggttggggcagcagggctggtctctggatcagatgtgggtttttatccaagagctgtgccctggtgtgccagctaccccaggacatcttacgacatctcgttaacctgcccatggtggtgcagagtttatggactacactagagacctcttgttgtattcatggctctgacccctataccagcctgggactgacacagaccaggccttcaaatatggggagggatggatgagctcatctgcattttcagatagtctagaaaagccaaaagaaatagaggactctggaccccaagggcttggggctccatctctagggaaaaaggggagaggaaagccctagggccagaagggggacaaaaggttcactcttccacccccatgggcttttcccagggaacttgcccacctctaccaagggctgccttagggtggatgaattggtccctcctctgaccctaactagaccctcacccagagcttttcaggtcagccctgggcccctcccgccccacctgcctaagggtcctgcaggaaatcttggcagcttgacacccttctctcctgttacctcccaggcagcaccatcctgatagcacctggagaagcacccccccagccctggctgttagcagacacctgcagcagagagctgggtgtacttggcttgcacagtgttataaacgtctctaagttaggcactgacaatttactcaaagtctggatttccagctcctgctgccaagtctttagacctgaccacactgggcccgaggctgaagactcactggccacaccctctagacaaagatgtgctccaacaggccccagtccccatccctccccactgtgttcccctgcaaaggtcagtggtcatttggcgccatgcttgcactactgctgtagggaaggagaggaaatgctccctgtactggccaaaggcaagaaaacaaggtaagtgggctctgtgcctcagtttcctcaccagcgcaagtgggtaagagttgtgcctgtctcgaggttgttctgaggactggagttatttacataaagccctagaaagacacgtggcacctctcattcctgaaggctgggagaccacatctctgtagaagtaaacaaaaccctccattgcctgcatagcagacacggggccaggcgcagtggctcatgcctgcaatcccagcactttgggaggctgaggcaggtggatcatttgaggccagggcttcaaggccagccaggccaacatggggaaaccccgtctctactaaaaatgcaaaaattagtcggggcattgtggcatgcacctgtaatcccagctacttgggaggctgagtggctgagttgagagaatcacttgaacccaggaggcagaggctccaagatcatgccaccgcactccagcctgggcaacagagtgagacttcgtctcaaaaaaaaaaagaacaaaaatcacaggaaatgctggcggggtggggggtgggtgggagagtgctggggacccagtgtgggggcagctgagggttttggagattccagccctcccatgtgcctcccaacctgcaacaggccatcttttagttctctagaggcaccgagtcctctcccctccaggctgcttcagtgcccagaatgcttttagcagggggcgacccccatttcccttccaaagccttgaaggggctgttcctgtctccccttccctcctccctgcatccctgcctactgagtcctcccagtctggagagtgggctccattgctattgtctggtgtgaacaccagctaagctggatcctgagaccctccagcttgaccatcccgcgtggcgcttccgcaggtccccgcccttcaatgtggggctggggcaggtgttcggggcaaagcagggctgggtaggaaccggcaagtccccttccccattcgccatccttccagcccttttcactcttccctgggagcttaaggagccgcttagtgtggaggacattggccagaaaggctgctggcttgacggggcaggacaatagcaggaggcagcagctttgcaggtgagaaaaccccagagccaaaggccgggcacggtggctcatgcctgtaatcctagcacttcgggaggctgaggtagtgggaggaatcacctgagttcaagagttcaagaccagtctggtcaacatggtgaaacctcatctctactaaaaatacaaagaaattagccgggtgtggtggcctgtgcctgtaatcttagctattcaggaggctgaggcaggagaattacttgaacctgggaggaggaggttgcggggagccaagattgtgacactgcactccagcctgggggacattaaaaaaaaaaaacctccagagccgcccgtggggagcctgccttctctgcccccccgacttcaggaggcttctcccatcccccagccacaggcctggcaggccccggctgctctgtattggccacctacactgcccctggaagggcaggtgaaggtctcctggatgttctcgaagctctcaagacagcccctccagggtggccacaggtcacatgggctccctgtcctcagccaggggcaggctgggggagcaggggaggccatctttgttactaggatctttgtggttccaggcacaggtcttcctacccgccccactgtgtccctcagccaaagccattttctctctgcaccccacttccctctataacacaggaataaaaaacaaacagccttcccttcaagactgcctgtgtggccgggcgtggtggctcacgcctgtaatcctagcactttgggaggctgaagcgggcagatcacttgaggtcagtttgagaccagcctggccaacatggtgaaaccccgtctctactaaaaatacaaaaattagcagggcgtggtggcacttgcctgtaatcccagctactcaggaggccgaggcagaattgcttgaacccaggaggcagaggttgcagtaagcagagatcacaccactgcactccagcctgggcgacagagcaaagctccatctcaaaaatacaagaccgagcgcggtggctcatgcctgtaatcccagcactttgggaggcggccaaggtgggaggatcacgaggtcaggagttcgggaccagcctggacaacatggtgaaaccccatctctactaaaaatacaaaaattagccaggcatgtggtggacacctgtaatcccagctactcaggaggctgaggcaggagaatcgcttgaacccaggaggcagaggttgcagtgagctgcgattatgccactgcactccagcctgggtgaaagaaactcagtctccaaaaagactgtcggagtggactgcaggagtcaggggcgagacacacgacactcaatttgcagcatgtgcccaatacacaacagccagtgtgtcagcagggacgctgcccccagcagtggcttccctgcccacgggggctcttccagggcaggagcatctgatgggaagctccaagctgccaaggggggagatggggaaacaccgtgttttacatttggactgtcctgcaacagtgcacatgctccttctgcagctaacaggccatgggagaccgtttcctcctctcccaaactgggccaatgcctgccaggaggggctggtctggacactattcagccagtcaacacaaggtggcctgcactcgaggttccagggatcccaggcatctttgcggctgcagggagccggtgtcctgtgcaagggtctggtctaggactctgcccggtatagactcagcagcagcctagaagggagagtgtccgtgatctctgaacctacgaccagcctcctggtgccctctggtgggcagttggccacaatgcctgcacagagcagcactggcctgaagccacagccggggcctgaccagagccccctgctgaagtctggggagtgggtgcacatgcagtcaccgcgctggatgcctcccatgacttatttttttcctctcaaagccccagtgaaaatgcaaagaactccacttctgaattggacaactgaggtactgactctgtcccactcccctagcatttcatggggcagagttgggggatccactcacttcaaccagtgcagtttaaacctggaagctcccctggggccacatgtctcctggcaccaccttctgtgggtgccagggcttaggaggtacacatataaggagttaagaaaaacagagctccgttccaaccgaaaaagaaatgcaaaatccaagacagtagacaatgttgttgtttatttaaaatgtttactccaagaaatatatatataaaaaaaataataagacaattacagcactaaaccaggcaccttcgaccaaatcacaacctcctctttgattccccttcacgctaagcctctttcaaattctttttcctgagctggaagaccagtcagatgcccgcagggtcagcgccaagcacattcccaaccgggcaactgtgtacctttctctaggagtgcacgacacccttcccccacaactccttgttttaaaggatttaacccattaggaagcccatttttcaatctaagccagaaggagctgcgggacaaggcagtcttcactttgaaggtccctttcctgctccagtccctgggctagggttctagaagaggctggctgccacgtttacatgaggccaccgaagatctaagtccagctaagcccagggaggctcctgcaaaggctgggacctcgggtgctgcgtcctcaaccctctcggtgaccacggctcaaaggagagacctcaagggtgccaggagcacaggtgcctgggctgcattccaggaaagagacctgtccagggaaacggatcaggctgtcgcatggaagcttacgtcagagatggtggttttggggtgatttggacaaattaggttagtttagcaaagctctgaagtagcagaagcttctcccctggactactgattgaacacagaacaagagatgcgcgtggcgtcagactaagtcttagagagatgcaggccagtctcctcccacagggccttgggactggcaggacagacactgctacatgccctccaagggcaggagtcacggtaaggagcgactggggtggaaaatagggaaaaaagcaacaacaactacatcatttttggcattttaacatggagacagtgacaagtggtaacaaagcaaaagaaaaaaaaaacttgaagagaccaatatttaactttcccatccacccaagtctcacacttaagttctagtcccatctcccccataagcaccactgaactaaatatctattttaaagcacccaaaccagtccagaccctctggaaaccaagagccccagccacagctgtcgcctctcttgggtccaggcgagaggagggttccgggaaaggcacctcataactcactcagcgcagcacacacggcggcgagctcgggcacttgacgaggacgcaggtggcagtcacagcatccgtgctgacacgcaaggaaggggactcttcggtaatcccaactatttggtaccagagccaagcaaacgtgactaaagggagctgggtcagcagaacggtaccccgagtctcagcaacaggacggcccgcgcgaggcaggatccaggcgggggggagaaaaagagaccaaagcacaaggcgatcgaggctggcacagaaagggctgatccttcttgcaaggactggagaatgcacttgactgctggctggtccatctcttaattggcgagtgcgcgtgacaaggctcagccctggctccacagggagccaccaagctgactcaactgatacaaatgttcccacctctgccccacccccaagtccccatggttccacaatcacctgattttcatttggacctctttaacagctaaagtagatataaatggctaaacacagatccccaatcccccaccaggggggacacggccgattctataatgtcgcagccagaaggctgtgggcgtacaggcagccaaggggagaaacagaaccgacaccggcctaggcccatctgcaagaaaaagcggagaaggagtgacccggatgcttccgaagcacgcgagcgtgattttggatggaggcgggccggtgactgcctagctgctgccggttcctgtaagggacattttttctgagtaaatggcgattcctcttccatgtggcatctgcttggatcacgatgctaattgtaactggaaaggggtgttttggggagtgtattcaggagaggaagaaagaaaaaacttaaaaaaaaaaaaaacctagattgctcaaagtttctgcctcttttgtaggaatggtaaatcaactatgagcaagtattttaattcaacattaagggaaaaaaaaggactttggaaagcatacagaaaaaaaggtagttaacgttggatcatgtgtaaaacggaacctcagggagtctaaacaaaaatgcaccttcggtcaacttttgcttttttaaattcctcgtttgacttcccgtcccagtgcacatggaaatgacagctgccgcgagaggtgtggagtcggaggagtctccgggagcatcagagggttcgggggttgtattctggcagtttcttgatcttctctttctcagtctcactttcatctcttgctatcaccaaggagtgtgagtagcccatggcgacctggggggacaaatcagcgttgggtgtgcctgaggcgcctggactaatcaatgcgttgaagagactctggaaactgggctgctaaagcgggtcagcatggagaaaaacagagtgcccttgaaaactgcaaaaagcccctctgcccaagacagctagtttccatgtgactgccaccaacgctctgccaatcagagccttccaggctgccctgggagacccagctggaaggaagcccactgggccacctcttatcagcagggacaggtggggacatggctccagctccacttccatcccccccctctctggctcacaatcctgcctgggtgaggtgcaccacccctctctgtgtcttggcagacagggccagcaggctggctgactgagccgcaggggcctcaccccgccatctgactcctgcagccacgcagcctctactctgtggacctgcggacctgcctccagcccagtggatctgagtcctgggtgtgatggagacgcgagcgatgtgctcgcccgagagtggatctgctgcggccagttggtgccatctgtcatcaagggtgaggacagccacccagcctggccagcaaccctgtgcactctctcctgcagaatgattgttacctctcaaacaaatcttagcgtgagacaccaggaaagccagctgagatggtaaacaagacaacccaaacagactgcgatgatcaaaatcatgaggagtgacataccactgggtacggacacgtccccgagctggcacagctgcccccactcacctgctctgagaaaatgccatccagagtctttacctcctgggctgcagtggaagacttgggcttgtggtccccgtagccctggcgaagcaaacaagatgttcgcaatcgaggatccatgtggctcagtccacaagtggggaatcacggcaacatttcctggcccccactaaccagaagccagtgatgatgccctctggcccatgacaagcccggccacccttgcacacaagggccaggtggaatcatccaagtttatccacaaaaggtgccaccagcaggcgactagcgcttaacctaaggaagaccaaggtgcccaactctagcctgcaggacttctgtgtgcacaagtcccttctggggagtatggcactggtgacaagagatgacaccacgagtgcaggaagaatggcaactgcggcccttcaggaccaaagcgaccaagaacacgggctgaccaaatgcccttgatgcctccaccatccagagtggaataatcaccatccaaaacaaaacaaaataaaagggcttaagcgtgacagggagactattagcaatggcaccagagaaccagtttccctcccagaggtagaaggaactggatgaattggcgcagctaagggggagtcttgtgcaaaggtgtggagctgggcaattgaaagactgaaggccctggctcaggtgaaacagagggtcccacagggcgggagaggaggaccctccctccccagcccaggcctgcccacatgtccctggtttcatctcctgccaggccccacctcgggccttcccacacagtagatgttccctccaaggtgccaggccaacttctcacccttgagaagctccccaaaaagtctcccttgctcccctctagtttcaaaatttatatttagaaggtcaaagtctatttctgataggccccagaaaacatccttcctcctctaagaactatctgtagaaactgggccaggctctgtctctttcctgtcaatgtttcaaatcgggccaccagagcatctgagccagactccaagggtgtgcagagccccgagaaaaaggtgcattcaccatccatcccagccacagctcaagggaccaaggaacgcccttccttcccctcctctccatcaaccacaagagtaccttgcaaccacaagagtgcaggagagggagacagactgtgcttctaacaagaaataagggactaaaactaagaccaccaagagttaagcggagaatcaaaccatgactagtgtaggcagatcaggatgcactccacagccaagctagtcttcctaacaaaaactcaaagacccgccttggccaggtgcagtggctcacgcctgtaatcccagcactttgggaggttgaggcgggtggatcacctaaggtcaggagttcaagacagcctggccaacatggtgaaaccccatctctaccaaaaatacaaaaattagctgggcgtggtggcaaacgcctagagtcccagctactcaggaggctgaagcaggagaactgagaatcatttgaacctgggagacagagggtgcagtgagccaagatcgcgccactgcactccagcctgggtgacagagaaactccatctcaaaaaaaaaaaaaaaaaagactcacctagcaccaggatctaagaatgaaagacatttgtttgcggaaggccacgtgtgtgaaattgagggtcatgagttctaacctcatcactcaagtaactggtattaacaacagaaacacaggtttaaactcaatttggaaaaatgaagaatgtcctcaaatcacccacaactgtgagtttcccactgacttaggcctccaggggagagggaacaaacaggcccttttcctaccataacccaactgtggtttacaaaatgtgaggggaaaccggatctgaaaagtcccaattttcagagtttacaaatgtgcagagatgactcagaattatctgactagcacagaattgtccttgaaaactcatgggactcaatcgtgttgcaaaccttaatacaataaggggggaatcccaaatgtttttcttctgtgtgttttgggagacaggtggagagaacccaaaggccatgagccaccctgactggcttccacttcccctgacccgcacaggtgacagcttaccagttccccaaaggtcggtgacggaccccagctgatggtgctctcatcggcggccacaatgatgctgctcttcctgcaaacaggcaggctgtcactgcagggccagcagccccagacctgcacccacgcagctatggctcaagggcatgagtgtgagctgccacttttcccttggcgtactcattccaagtagcaaacacaataacagggccaacaggtttctcctcaatcctaagattgttccgtgcaggccactcaacgcttcaacaaaacaacaaagcccttagacaggcctaggggccaaaggcaggggaccttgctgtgcatcctgcacagctctctctcagtgggaggtcgctttgggaagaggagaccagatcaggataaagtgaaagcctgttccagagggagcagccttcatgcataatgatttgggcagggctagagccttcaacagattaaagccacgccgacagaggcccctcatactgttccacccacacctgccagctgataaatccaactcctcagcaagaagtgctagctaactcaacaggtgtcctgaaatgaactacaaaccactgctgccaagacaatgtcgtcttcccagtgtcacagcaactcaagtcctgctacgtttccaactacgtataattttcaacctgcagcgtaggaatacatcaagctctgcttgtttatttctttgaacagaaaccttcaaaatgactttcttcccacaagacagggaacagccatctgttctagcagcaaatgggccctctcccctcctgtacccccggactctgggattcagtgtgtcagatggcctgctgaggacagcccaacaggcagcagaaacagagccccatcagggaggggcaccccatgggtgtgtctgacacccccatgaaaggaagagacctcatacccacaggagatgctgccacctacccacaagccaggctccggattctccagccgcagaggtcctgcactgcttttgggtacatggtagattcacgggaggtgttggtggccccccagaaaaacagaccacctaagggaagacaaaacatgttcccagcgtgaccagacatcgagagctgagtctcatcttcagtattatcagggtgaaaagaggacgggatggcaaacaagtgttctgtctaaaagataactggagccaggcgtggtggcgtgcctgtgcagtcctagctactcaggacgctgtggtggtaggactgcttgagcccaggagttcgacaccggcctggacaacacaacgagttcctgtctcaaaaaaataaagaacactgggaggtaaagagaattggggttcgtggtctagggacaggacaatggctacacggttccgcaccagagcactgataagccagggggcagaaatcactaacccacttcactgacagcaaaggagcaggtgtaaccagcatagatctgggaagccccacgcccagggaagtcaaacagcttcaccaggcgggggaccatctcatccttctgctctgcgtggcccagccggccatagccaccaaagccccaggagaagactcgcttctgggagtccaggaccagctgcaaggaaagaaaacacagggttggaacaaacagacttccaacaggcaacaagaggggtcatcgtttctgtgcagacaacctggtgcaaatgctaagggcaaaggaacagcaacattcaagatcccctaccagccgggcacggtggttcacatctaatcccaacactttgggaggccaaggtgggtggatcacttgaggtcaggagtttgagaccagcctggccaacatggtgaaaccctgtctccaaaaaccaaagaaatatcctttgcctgcctccagcagaaagatcctctacctcccgcctccagcagtgggggaggaggcaacaggagcaagtgtagcaaaatggcatgcattcaataagcccagtttgctattttctctgccagggactccattttccaatccttttttgttctgtttatttatttaagttacaagtcttaaccctttccttaatcagaagcaacagggctatgtctcctgagagttgggcaatcatttgattcccactacaacagagattcggccagatgcagtggctcatgcctgtaatcctagcacgttgggaggctgaggcaggtggattgcctgaactcaggaattcaagaccagcctgggcaacatggtgaaacccatctctactaaaatacaaaaaaattagctgggcacagtggtgtgcacctgtaatcccagctactcaggaggctgagacaggagaatctcttgaacctgggaggcggaggctgcagtgagccgagatagcgtcactgcactccagcctgggtgacggaatgagactccatctcaaaaaaaaaaaacaaaacgaaacaaaaaaaaaaacacaacaaaaaaaaaacagattcaattgcagaaagaacagaaaaggcctacctgttcctggatttttcgtttcttttccccccctcgagagggtctcgtgctctgttacctaggctggaatgcaatggcacgatcacggctcaccacaacctccacctcctgggctcaagcgattctcctacctcagcctcccaagtcgctaggacttgggtgtgcaccaccatgcccagctgatttttgtggtttttttgtagagatgggggtctcaccatgttgctcaggctggtctcaaatgatctgcccaccttggcctcccaaagtcctctgattacaaacatgaaccactgcgcccggcctggatttttctttagacttccctcacccacaggtacagaggtaacctgtacctggtcactgatgaaatgaactcagagacacttcaagtgtttaagatttatcttcttcagtctcgttttcccatcttctgacatgccaattcagttctttgatgtttcatgtctaaaccatgggaatctacaacttactaaaaaacttggcctataaggccctaaacaagagccaactttatttcccctgactacatcagacaaaacaaatcagtttttggacttgcacaaactgaaatctcctaccctagtcctagcccaattccctgggcattcttcatcggcaagaagattccaagggaaggaggtggtgagctgagaccactcagtggggaggaccaacttgatctctggaatcctagcccaggctttttcaacaaagcatagaacaaagagactcctaggcattctcagacagaagaaccacaggaaggccattaaaattaaaagatacactaacagccgggcgcggtggctcacacctataatcccagcactttgggaggccgaggcaggtggatcacgaggtcaggagtttgagaccagcctggccaacatggtgaaaccccatctctactaaaaatacaaaattagccaggaatggtggcaggtgcctctaatcccagctactcaggaggctgaggcaggagaatagcttgaaacaggaagacagaggttgcagtgagttgagatcccaccactgcattccagcctgggtgaaaaagtgaaactccgcctcaaataaaaaaaaaaaagatacacaaacaaaagattgcactgcagtttatctaaagtgacctttaaagaaacaacctaggccaggcgtggtggctcacacctgtaatcccagcactttgagaggccgaggtgggcagatcacctgaggtcaggagtttgagaccagcctgaccaacatggagaaaccctgtctctactgaaaatacaaaactagccggggcatggtggcgcatgcctgtaatcccagctactcgggaggctgaggcaggagaattgcttgaacctgggaggtggaagctgtggtgagccgagatcacgccattgcactccagcctgggcaacaagagtgaaactgtctccaaaaaaaaaagggggggggggcgggggggacaacctactgattaaaaacgactcacatccccagtatggggcaccatctactgacctggaaagatgtctgtgatgttatgttagataaaagccaaaagcagaaagtgcttaccttaaggtgcaggtgagggcggcaaaacatctacgtgtttaagatgtgtctatttaaatcacgggagaagttaacataggaggcagtgacagggaaccctgccctgggaccaaggaccctttggccaaggtgcaaagccctcttgaagaagcaagcagatgtctacctgggatcagttcctagccaaagccaagcgtcaggaaacttgagcataaacaccccttccatcctggtgcgactctcaggaagtgagaaaagccgagcctcaccgtgtggttagcgccacaggccacgtctcgtacaaccacgtttggtacaggcagaatctgtccatctttcgtcttctcaatgaagatggccactcgccggggaactagttcacagtcgtactctatccgctgtgcccgggcgatgaacttcccatctgagttgtgtcctgtagagaccacagagccggccatcagcagcagcacaagcacaagggacgtgtcagtgtgctcacacggactctgtagtgagccccggcagcaccccaatctggcccttctgggccttagaccagcacacgttggtcaacaaaggcagcatttccaatcttaggcacagcacagtgagtgggtcagtgaaatcaattttgtgagctaagaccagttattttttaaaaacgaatagaacagaatgacaaagaatactctacacataataatggcaccatgttacaacaattccaggtaaggtattatacgttcagattgggttgcaaaagaaaacttatttcttacaatgggttgcagtcaaaaaagttgaagctgctgatcaaggaatggtctatcaagtaagatctctaccccactggagggaccacaaggagcccctaaaagaccaagaatagacagaaaagctccatacacaatcccaggcctctgtttttatgaattaccagtaacctaaacgtatggttacgggtggctaaagcctgcaattcccacactccgaatgacccagggactggttcgcaaagacccagctcagcacaccacacaccagaagcccggctgctccagtcctgagaacacgccagacacccaagctcctgcagccacctgcagcagcagggctgctaagtagtttatagttttaaactgctcctgttcccacactgtgatcatcagtttggttgggcacggtgggccacgcctggaatcccagcacgttgggaggccgaagtgggtggatcacctgaagtgaggtgtttgagaccagcctggccaacacagtgaaggcctgtctctactttaaaaaacaaaaacaaacaaacaaagattagctgggcgtggtggtgggtgcctatagtccagctacttgggaaggctgaggcagaagaatcgcttgaacctgggaggtggaggttgcagtgagcagagatcatgccactgcactccagcctgggcgacagaacaagtttctgtctccaaaaaaaaacaaacaaaaaaacttgttgttatcagtttgtaaactagcccccggcttgtggctaatccccctccatacggcacgctggtgtgcacctcagcccttattggtatgtgtgtttttgagcactgtgctatttaaatacagtcagccctccatggccacaggttcaaccaacagtggtccaaaaatatctggggggaggaggaaacaaggaaaaaaaaaagataatacaaacaatacaagtaagaccatacagtagaactacttacataacatttacatcacattaggtactgaagtaatctagagatgattttaagtgtacaggttacatgcaaatactatgccattttatataaggtacttgagcatcttaagatcttggtatccacagggggtactggaagcaatcccccaggttaccaaggagcaactgcaccctggaatcacaactacgctacacacaataaaactcctgggcttgtttacagggcgccttataacactcatctcataagcaggttctatttttttttttttttttttgagacagagtctcgctctgtcgcccaggctggagtgcggtggcatgatctctgctcactatcactgtcttatgacagcagttctctactgttgacataatcccttccagtggaacatctgtccgtttaaaagtctgagggtcttggccgggcgcggtggctcgcgcctgtaatcccagcactttgggaggctgaggtcggcggatcacgaggtcaagagattgagaccatcctggccaacatggtgaaaccccgtctctaccaaaaatacaaaaattagccaggtgtggtggcgcacgcctgtagtcccagctactcaggaggctgaggcaggagaatcgcttgaacccgggaggcggagggtgcagtgacccgagatcgcgccactgcactccagcctggtgacagagcaagactccgtatcaaaaaaaacaataaaagtctgagggtccccactaagaaattcccccaccttctaggctacgatgaatgtaagagcatcacagtaaatagaatgcatttccggatatgtcgctacttttctcacaaaaatggtatttttaaacacttgcactcttccggacaaggtttcagcaaggcagtcaacaaatgattagagtccttttatttgctatcgacacagtggatactgaacagacacaactcccagacaggagaggaggcacatttggtgactgctttttccacctcctttaaagagctgcacacatctgctttctccagaagtacaggacagaagctactccagaaaacatcgaacagcgggcttccctgtccctctagaggggtgacagctctttaaaataaagttaaatggcatggctgggcacggtggctcatgcctgtaatcccaacactttgggaggccgaggcgggtagatcacttgagatcaagcgtttgagaccagcctggtcaacatggtgaaaccccgtctctactaaaaatacaaaaaaaagttagctgggtgtggcagcgggcgcctgtagtcccaactacttgggagaccgaggcaggagaattgcttgaaccaaggaggtggaggttgcagtgaactgagatcacaccactgcactccatcccgggtgacagagggagactccgtctttcttatcttggcgttgcccagcccagttcagtgcactgcaaaaaagggggcacaaggcatgagtgtgtgtggatgagacacggccatagtcggatttaggttcattctaaaagtgatctatctggatttggacaacgaaacaaacacctgccttaaagcaagtaatacgctgagaataagcgattctgtagctacaaatcaagccgatttccaaactacctgcaagttgagtgtaactgagcacctgcgaatttgtacaaagtgcttacatggtgcctggcacacacagtcactgctccatgaaagtgagccgtttttatcaccaacagcatgtcatgcttcctgacggaaaatcgacttgccggggtgcagaggggaggccaaggcagcaggagcgcgcacgtggcaggaagcggaccgctgctgggcaccgcagcagggctgtggccatggaaaccgctctccaactgtctcgggctccaccacggcaaccaacgcgaaatgtgaaatgtgcgtaaggggctgttctctcttattcacttctgacttgaagtatatttagtttcacaaagtcactgttccccgaggctaaggccagcgggctcggcgctatttttaccttttccatctgccaggcgctgcggctgcaggagcgcgcgcggccagcagagggcgcccgcgccacacctcgcggaggcctccccagaggggctggagtggaggcagagccacaaccgggaagcgcacttcagggaaccgcacttagggtccgatgggaaggagaatggagaccatcaggtcggaagacactccccccactaactgagaactgatgcctgaattctccttttccaccaatgagatcgaagaaacaagtttctggacaactagattctggctagggatgacgcacggggagggggtccaccagggctcctcacgtggcaacccgaaataatcgcccaggccagggtttccagaacaacgttcattttccgtaattttctcattttcaataaaggcataatctttaaatgtgaaattgaatgaaggtggtctgatttttttttaactttgaaatccctttatataaatgaattcccaaatcagaaaaaaagaaatcttttgtaggactccagtcccaacttttccattgaggcagtgttgcaatactccataatcctgtgaatgaggacgcgctgttctgctgaacgtgagatccacttaacggacaaaggctattatctgagatcaattacccacatttctaacacgtgtgtgcagccccacactgatctctagttctgaatatatacagttagattacagagcttttaaaaaatgtacttccatacccagctgaccatattcagggcacccaaaggaatagaggtttcctttgcagtccattatcatactgaattcagccccacaggccattttggtaattggctggccgttgtacattatctgaaaagacaagaaaggagactttcattttttttaaagactgataaaaagcctctacctctctgcatgttggtgggaaacaattactaggttacaaacggaagtttaataaactcagtaattctgaaggcaaaagctgaaggcatttctagaacacaaagcttagaagatatgtaaagaagcaccctcagacccccaccctcccagcacagagcagttcaaagcctagccactgtctctttaagatcaataaaaccaagtccctcccttccttcatcacctagaccactaattaggcacttagcattcttctgcctttagtagtagtttgtttttaaggtataaatctcacccctccaactcaagtttcttagaaaaaaaaagactgcctatctcctgggcgcggtggctcacacccagcactttgggaggccgaggcaggcagatcaggaagtcaagagatggagaccatcctggccaacatggtgaaaccccatctctactaaaaatacaaaaattagccaggcgtggtggagcatgcctgtagtcccagctactcgggaggctgaggcaggagaatcgcttgaatccgggaggcagaggttgcagtgagctgagatcgcgccactgcactctagcctggcaacagagcgagactctgtctcccctccaaaaaaaaaagactgcctatctcgtatttgtattctaagcatctggctggtgactttatacaaggtcaaaacaaagtatttgggggaagtacaattacatccatataacatcactcactttctttggaacagaacaggcttacgacaaggcatttctaacagatttctccatttggaaacaaaatgttttcaggatggttttcaacccgaccacaaactaagcctgttttaaaaactatagcaaggctgtgtgcagtggctcacacctgtaatcccagtactttgggaggccgaggtgggtggatcacctgaggtcaggagttccagaccagcctgaccaacatggagaaaccccgtctctactaaaaatacaaaattagccaggtgtggtggcacatgcctgtaatcccagctactccagaggctgaggccggggaatcacttgaacccgggaggcggaggttgcagtgagccgagattgcgccattgcactccagcctgggcaaaaagagtgaaactccgttctcaaaaaaaaacaaaaaacaaaaaaacaaacaaaaaaactctacagcatgtaactaaacatccagaccctgtttttacaaggggtaaattaactcaaacggagaccccaccttagaaaatcaaacacaaaagtaaagagaaacaaaaagccatggagccggagctgaggaggggtcacctgcgcggggctgggaacagcgtctgtctggttgccaaggcccagctgccccatcttgttttccccaaacgcaaacacggagcccgtttctggaagaaaggaaaaatatcacaaaagggaagataatggtgaatgttttgaactagatttagaatcaaaggcatcaaaataataaaaacagctcatttgccaggcagaaggcaagtgagactgcccaaaagctggcagtgcagacgcttcacagcaaagccatttcacatcagaaactgggtgtgcagagaaacagagggcagcgtctcctactcccagatgggcctcctatggccactggggaggctcccaatgccctcaagaagccactccatgccaaggttctcagggcctctttctgatcctgaccaagagtcacaaggggaactccaccaccccacgccccatccccaaggcagaccacctggcctcttgccaaactgagaggagacaccagcagccacctccttacccgtcaaggccaaggtgtggttccgcccacatgctgcagacacaatcacttcgtggctaagaccctcgatgagtctaggggcttctactctcttggtgtcaccatgtcccagctgccccttctcatttcgacctgcagatcacatgagagaaagtagaaaagagagagggtggtccaggcggcaccaccaggagaaggcgagtacaaacacactctcaaatgatgcccatctgtctctggaaggtaccctccaaattcccaacagccaagatccagagcaaagaacgccccggccctctgcccgctggaatggcgcctgctgcagctccccggacctccttccctggggcagcagcgggaccacccgtgcacacctcccacgtctctgctacaaagggaaatgagaggctcagtgtggtagggacaccatgcacaggcgggcatgctcgcagaaacacgccgttcccacttagagtgcctgcaagacaaccaccccgtccctaccctctgagatgtattttaagacagcaccccattttgacacctggctcaccagagtttaatcactttggtgctctgggcatccactgaggaccatttggtgtctgcccaatatttctcttcctttttctaccctgtaaatggtgctcacataacagtgccaatcccacccctagggatcgcccctcaaggactctcagccacaggaaccctggtgacaaagcacagatccaccctcaacacaacacgcccagccccacctccaggactgctgcaggtgcgaccaaggccctgtatctgtgaattccagcggaaggcaggcctgagggccaacccctacccccaagtcctctgcagaaccaaattcaactccaaacagacgtggaagttgggtgggccaaaaggagggctgggagcccctacaccgcatctaggtttcaacacaaactaccaagttccaaaacaaaaattcaaccggccactctcggatccctcccgataagagaaaaaccacacatgtaacctgacgtggggaaactgacggagatcttacagtggtgagaagtcagggcaattctagggggttttgcaaccttctccagcaatgaacttttcacccttaggttgtgataaaggcagacagcagagccattaagatgagttccagctgtcctggagaaggcttgcaggagcagcctctgactacagaaggaattgcgacgaagggaaaccagcctctgactcgctctaattaaagaacggcgggctgaagggccagcactggcactcgagcaggagaggcagatacaccagcttccaatgggagctgcccaagttcatgtgaaaggcatgtgaatacagagcaacaagtgcaagtctcagtggactgagatgcggcaggacagggtgagcgggccacagatggagaccccacatgagcaatgcgtcagccaccctcccgtggtactctactcacaccagacgccgccccctgccttctagagtggcgagcagtgggcctgtgacaccttccaaccctgtcctcaccaactgcactgtctgctcggggatcacacgtcttgatggcgggacatacattgtccctgcccacagggtcagaactgagggcgctttcagagccaccacgcaagtgaagctcagcgagagatcagaactgaggtattttaagtttggaacactgacataaaaggctgtgttcagtgttggaacacaaagtaggaggggtgctctgggggaagggacacacatctatgccaaccgggagaaaacaaaaactgtggcaatgtcagcatgtcatcaagagactataaagtataaatttgggccagacacactttagcttttttcaacagaattacaaaattagccatgtgcagggaagacaacagatgttaatatatttggactttggtacagcagctcatgaaatcacaaaaaacggttcaaacagcccaaaataaaaatgcagtcatatggactaaaagctagccagaggaccagcgacaaagggtggggacaaacgccaatatgccccgctggaggcagaggccgggagtcaccaaaagggctggggataaaatgagccttagcccataccctatgattggaatgatctggaagaggacacgggcaggaatgggccggccggctgcagaggacagtgccgtggacagaggctaacagaagaactggaacccatcccgagtgcccaggtgaggaaaaacagaagggaaagccgaacaactccaaaaaagcaaactgaagtatctggggaaatatcctaagaagcagacaacacggacagtgagctgccaagcctgcagaccagacttgggcagacctcagacacgagggccatggcggcagggacgcagcatcctatgacatgaggcgggaggtagaaaagccagtggcatttcaagtggcagcaacagaggtctcatgtcatatcgtgcctcaaagaggaaggaaactgtctgctggaaggacagcctgcctaacacactcacacacctcagtatcagaaaagatcaagcttcgggcagaagattcaggaaaatgttccttgtgtaaacacaaggaatcaaagaagtaggggctgcgtatgggcaaaaaatgtcaggggggaaggggatctgcatgtagcgtgtagacaagagacgagctgggaattaggaaaaaagacatgggctgtgaacgaaggagcccagccttataagacgcgagtctcttttccaggcaaacagaagaacgtgctgtgtggggacagctggtgacagtggtccccagtgcccagcacccgcacggtactcaccccagctccacagcttcccttccgtggtgatgaggaggctgtgtgcagcacacgagcccgagaccactgtccgcacccggacccccgccaggcacccatatctgtggggcccccacaaattctgaccgagattgcggtaagcagctgcagagagaatgagaatgcagatcagacacctggggtggtggggtgacctccaaaatgtcactggccaccaagcagccacttcccgagggtaccagggacaggtgttcctcgggtgccaccctgccttggctgttgggaggctgcacaaggatcgggttttcacttcgaatctctgcgatgcctctgaaggcccaaaaatcaaaatacccagaagctggcacaggcctggcgtcacctgccacctttacacccattcggccccagccccctctctgggtcccacctctcacagggctcagccccacgtgttctgccattgagcacgcccacccgcaagtgcccgggacctggtgcgaggtctgtccaggaggcaggagtgctggctttccacagccgtcagctgaggaagaggctgacccaggaaaccccgctcaccctgacagtaacctacccctcctcctcactccctgccgcctgcccctcctttcccaggctctcctgccctccatctccggccttcaccctgggccagaaggctctttctgaggggtgacccgagtgtcctgtcttcatgttcccagcagctccatcaggccccttgaggaggggcactgctcacacagtatcaccccacctcctgctcccttctcacccgtccagtgtgacagccacttcatgactcccctgacacccacccatatattcgcttcccctagaatgtccttcccacctcctacttcttcctgaaagctcaagtcaagcaccagttcgcctccttggggaagccctccagggcaacatccactgagaaatctccttcccccagggctcccctgccccagctctgctcagccctgctcagcccaccacagctctcttcctgagccccccagccctcccactccatgagaagccacccagggctaaagctgtaggctccctccagcctagaccctcacaaatgcctggcacgcagcgagcactcaatgggaaagaaaaccacagcatcttcctcacaaaccccccttcacaccctattagaggatggggcagggccaatttcttacttttctttttttttttttttttttttttttgagacagtttcactgttgcccaggctggagagcagtggcacaatctcggttcactgcaacctctgcctcccaggttcaattgattctcctgcctcagcctcacgagtaactgggattacaggcgtgtgccatcacacccagctaatttttgtatatttagtagagagggtttcaccatattggccaggctggtctttaactcctgagctcaagtgatccactcgactcagccttccaaactgctgggattacaggcgtgagccaccatgcccagcaatcttaatttttgaaattgagatgctcaagagtatttccaggattgtggtgattatcctgaaatgctagccactgccaaatcgagtgtgtaagactgatccaatgtaggaactgataaaaaggctacaatgtctctatcaagcgcctggctgcctagaaagtatctgtgaagtacgttccagccccaccctccgccctcagcagagggcaccacatgctccctcattcaggtgtgggggcaagtgggcaagactcctggccgcaggcgggcaggggccagccgatcccgcatggcacctgaagcagcacacctgcagacacctcccctgaaaggaggaagaggaacatcaacaatttcctggggaaagagcaaaccaaaaataaaagcctcatggtctatattaaaacttaagaaaaactcaaggaggtggcacctaaattaagattcaggaactgtattaaacaaaactcggaagggataaagagaaacccaaggtctctttgccatgaagacaaaatgatggcatgattgacgagtatcatcacgaccctgtgccgcaacacaggaggccacgggacgccaggcaagggtgcggtgccacacttgaacttgcttggccaaggggagtctcaggtggtcagatgctcctggacttaccaaagcatctttccctgcagtgcccaggatgccactggctcctgaggagccgggttgggtttcttccggcctcccaaggaagggctggagggactggagggaccgggcaggggtgggggagggggagcaagtcaaattaaacgccctgcagcagtcccaggctctgcggtcagactgagaagtcaattcccacggcctccggatccctggggtctggtcccaatcacagagctactgtgtggcttgctgtggtgctatcttgcaaaaaccaagacatccaggctgctggttttcaccagatctacagcaacatacatgcgcgggaggcaacagagttaactagagagtgggactccaaccctggccctgccactcgcttcctttggtatttactgcccttccctgggcttctgtatcttcaatgtcaactgggctgctcagttgaagaacggctttgagaaatgatgcaacacgggcacaggactggcaacaaggcgccatcagcacctgggcttacgttactgtagaccaggaggtgcttccctgggacaaaagccaccatgtggacgtggccccctctggcttgggcctgaaggctgggcattttccaaacaacgcgctgctgctacctgcaacttaaacccatttctaattcagctggcccccaggtgttttcatggaacaaggtgatttccaacgcccctgttttaaggtgccaagacgagccagcgtgcaaatatttgttcatggggcaaagcaatgctggaaagcactttgggagtctttccagatgaaatcaagaagccataaaagttggctacatgccagccttccttctcctggatgggccttttcccttaagacaccagttttccaaaggtaactggggacaaaacattacttcttaaggacctctctgctttcccccgctccagactgttctgtcaaaccagttcctgcaacaatttggcagcttgcaaagaaacgtggactcttctgcaatgcctgaaattttgacacctgacatttgacaaatgtctaggacattctgacaccatctcacagacctggtctcttcattttaatgaaaacaagtgaggtgagagggaagatggaaaaggtggcaatgttcatttgaggatactacttgtattttcctgattaatcttaacggaattagtgagtcacttcaaaattgtgcctttaaaagactaagattagggttcaaatccagctcatcactacagtggctgtgtggcctcaggcaagtcacttggcctctgtgaaaatgcatttgtaaatgaagggaatacctaccaggcaggtggtcaacagaacctagcacttaagaagcactcaatgggtttttgaggcaccattctcataccttgctgtttaggcacttcttttcgaccaatcaagtcccagttggttgccccaaaaatcaaaagctgccctttgcactttgacccttcaagtttctgcagagacagagaaaggaaaaaagaattagtgtgtaagtctgcacctagctttccaaggctgtccaatgacagcacgaaacgaaagaaaatcattcagttagcccttatgtcacctgtgacctccacacgaacagagtctccccacactcccctccctcatcggcaagtggcaatgcgggcaaccccaaacctgcccacagccgctcacttgctaagcccaggctcatttttatcctttgacttccctttaaaatagcttttgcaaaacactaaaaaaaaaacccaaatacatgcctccttcgcaaactgatgtacagaggtatttgcaggaagcctgccggacactcaggggcgttaaatccagctcatcctagggccaagtctctatttcacatggcaagcacggcctgcgacctcaaaccttaggagcctcacatcacttctgctgcccactctgccgagagcctttccatggggactcaggaagaaaacagtagagaacaaggttcgatttctccactgaagggagaccaggcagaacacagctttggtgggtatgcaggggtctgaatcaggcggcctttgatggcaccctcatgccgctgtccatgagcccgggagccaatggtgagtgaaacaggacctcccaggggcccggctctcaaggaacaagctgtcacagcagccagcatacttcagtgttcatcctcagtctctcaacacaaagtcatcagggccaccaactctcatactgtcaacgaaaatctacgccatttaaaaaggccattgttcaattctgggtggcactcataatattctcagcactttgcttccttaaatgtcaaaatatactttttcaagtaggttgttagtggaagactcaattctgaactcctcactcagtccacactggcaagggaagcattcactgctatcactttccgctcttacacatctttcctggacgtgaaaaggaaaggggtttccttcagtttacagaattgttcttggaaggcttcaggaaaaaagtctggcaaggcgcaatggctcacgcctgtaatcccagcactttggaaggccgaggcgggcagattgcttgagcttggagaccaggctgggcaacatggcaaaaccttgtctctacagaaaatagaaaaatgagcctgtggtcccagttacttgggaggctgaggtgggaggattgcttgagctgaggagctggagactgcagtgagccaagatcacacctgctctccagcttaggtgacatagccaggccttgtctcaaaaaaaaaaaaaagggggccaggcacagtggctcacgcctgtaatcccagcactttgggaggctgaggcgggtgaatcacgaggtcaggagttcaagaccagcctggccaatatggtaaaaccccgtctctactaaaaatacaaaaaaattagccaggcgtggtggcatccgcctgtcgtcccagctactccagaggctgaggtagaagaatcccttgaacccgggaggcggaggttgcagtaagctgagattgcaccattgcactcccagtgttgctgcccaggctggagtgcagtggcgtgatctcggcttgctgcaacctctgcctcccgggttcaaacgattctcttgcctcagcctcccaagtagctgggattacagacactcagctaattttgtgtgtttttagtagagacagggtttcactatgttggccaggctggtctcaaattcctgaccgcaggtgatccacccaccttggcctcccaaagtgccgataaaatgccaataaaataacgccgatgaaagttcccaaccatgccaataaaaatgtatttgttggccaggcgcggtggctcacacctgtaatcccagcactttgggacgctgaggcaagcagatcacgaggtcaggagatagagaccatcctggctagcacggtgaaaccccatctctactaaaaatacaaaaaaaattagccgggcatggtgaccggcacctgtagtcccagctactcgggaggctgaggcaggagattggtgtgaacccaggaggcggagcttgcagtgagccaagatcgcaccactgcactccagcctgggcgactgagcaagactccatctcaaaaaaaaaaaaaaaaaaaaaaaaaaatatatatatatatatatatatgtgggctgggtgtggtggctcacgcctgtcatctcagcactttgggaggctgaagcaggcggatcacctgaggtcaggagttcaagaccaaccatggtgacaaagccagccctgtctcaaaaaaaaaaaaaaaaaaaaaagaaagaaagaaaaagaaaaaagggcagctccaggcccaatcattctaacctctacagtgtgatcaccccatgggtatgctttggcagtacggctcacgcatttctaagattacacatcttcatgacggatgatttccacttcaataggaacctttacacgacccaaacctgattagggcgtcccccaagatataggttccgtcacgcttgcccactccaccacattatgtaacaggaaaaagatggtcaatctacaggaatgcatcctgcagtcctcatgaaaaggggaagtgaggccagccgcggtagctcatggcccgtcatcccagcactttgggaggccaaagtgggtggatcacctgcggtcaggagtttgagaccagcctggccaacatggtgaaaccctgtctctactaaaaatacaaaaaattagccgggtgtctgtaatcccagctacttgggaagctgaggcaagagaatcgcttgaacccaggaggcagaggttgcagcgagccgagatcacaccattgcactccagcctgggcaacaagagcgaaactctgtctcaaaaagagaaaaaaaaagttggggggagggaagtgaaacaacacggaaagggagaacaactttggttcatttaaattatttagaaaatgaccttaatcagagggtggcccagcccctgcagcacccacaactcaggttacttgaattggagcctagcttcccctggttatctgcccttctttgtttaactggcaggcctggctggaatatgctacaggtctatattcaatggcttctgttgaagtccctgtggaaggagaggcctctgggtcctctgcccaagcctaccaagttggcatggagggggcagtagagacccaggaagggtgctaaggcactggagaccaagctcccaggccagagggcaagcctagaaaagagccctggaatgccagcaactgcagaccaggcaggcggaggttcatgggcacctgtgctcagtatgaaccattgaagtcaaaccaccctacactgagatgcaaccactgcagcaaaacttcacagtgctgaggccacaccagaagcctcagctccatcaggccagagggcatggttcaggggcaagttcagacagccagagcttaaccgcagtggccttggccttggggagggagtttcctgggtgacctggacatttggtcaagggctcatgaagactgatccatcaagctagctaagcatttataggcaaacccaaccacgccaataaaaatgtatttgtgggccgggcatggtggctcacgcctgtagtcccggctactcgggaggctgagacaggagaagggcatgaacccgggaggcggggcttgcagtgagccgagatcgcgccactgcactccagactgggcgaaagagcgagactccatcttaaaaaaagaaaaagaaaaagaaaaagaaaaaaatatatatatacactcacacacacatatatatacacacacacacacatatacatacgtgtgtatacatatacatatatacgtgtgtatgtgtgaaaaaccccggtaaactgagtctactccagtgacggtggtcagattcctatgaaggacattaactgttattcaagtttttacgtcatggatcctatttcctcacacattagatggaggttagtgtatttcgttattatttacataattgtttgctctaagctgctttcttttatttctctataacttctttcctctgccttatgtggaattaacatttaaatagagtaacagagaactcccagcaccccttctcacttaaggggtgctcctcttcctcagagaccagaaacagccaatcgtgggagagactcccgcgcttgcgggctccacccggggcggcggggcagggcgggggtgccagtgggtgtgtgggtgtctgaagctcagtgtgccctcccaggcggaatccagccttccctgatgggcctacggattgtttttttggacgaactcagtgtctgcgaccctgcttgtgtataaaggccacgcagcagacagcctggcaaacagtctgcccaatgagatgagtgattttcatgtcatttcacctggctgcctccagcaacttggtcacataacctgggcagagacacacagaaatggacagaaaaggcactgagcttcttcaatcaacaaaatgggatttctagtctaaagcaatttttgaattatgatccaaatgcaaggtgcgcgtttacggggcccagagtcaaccttttaacataggtccatgtagaagaccgctgctccggggaggtaagacccccgggaacaatgccggcatcgaccaattacctaagggccatcaactgaaacagacttccgggttggctttcagttttatttatttgctcctttcagattcaacacatctgtctcagggtccacaaaaccttggcaacccaagactggaaaaactacaaagacctgggcagcttgcaacactcacctgttttgtaggatctggccaaggctgctgcctttacttgctttaggaggttatgaagtgcgcaaagaattaggactgaatctaccctagtgtgacactgccatcaatatttggagttcctggcatgcaacttcccaaatccttggaatctccaaagcaatgtctttttgtatgctaatgactgacactggcagcccccaggcagcttccggatggggcagtgggagcctagggactttcagccccatcctccaacctcaggagggagatgactgaaggttaaagtgatgatcaatggcttaatctaccatgcctacataatgaagcctccgttaaaaacctgtaaggaccaggtcacagagcttgtggagagctgaacatgtaccaggtgggtggtctgcagagggcacggaaacacagtgccccttctgccacatctagccttacaggtctctttatccatagcctttgtaatatcctttataataaactggtgtttccctgagttctgtgagccattccaataaattaatcgaccccaaagagggggtcatgagaaccccaactagaggctagttggtcagaagctaccagggactggacttgcaactggtgtctggggtggaaggacagtcttggggactgagccctcaagatgaggaaatctacctccaggtggatagtgtcaagagatgaactggaggacacccagccggtgtgtgctgcagaactgattgcttgcttgatagcagggggagacctccctttacgtctagtcacagaagtcttgtgttgggaggcggggcgtggtggctcacgcctgtaatcgcagcactttgggaggcgggcaaatcacgaggtcaggagttcaagacagcctggccaacatggtgaaaccccatctctactgaaaatacaaaaattaccgagcacagtgacaggtgcctgtcatctcagctactcaggaggctgaggcaggagagttgcttgaacccaggaggtggaggctgcagtgagctgagatcacaccactgcactccagcctgggagacagagcaagactccatctggggtggggggtgcggaagaagtctggtgttggttgttgagtgtggccgtgagagcggaggaaaaaagaatttgaattttttcttaacacctaggcaatgacaacgctcatctgccataagaatgttctataaaatgcacatcttttactcaaggcaattctgcccctcaacaatgtaagtatttggctcatcttctacaagcccgacacctgcagctttggggtcactgaaggcaatatggttttggacatttcctgggcggctgctttcacacagacctcctcctagcaaccctgagcggggcaaggcatgcaaaatgctcagtaaaaaaggttctttctgcaacaaggactgctgtctgcctgtggcagcacacagggtccctaggactgctcaacagagaaacagagaccagaaacctggggccagggagactgggcaggaggccaacccaggacaaggggcagagggctgccctaggcctatggaaaggcaatggggctgcatggacccagccccgaacatggaccaaactcagtagatgctaacaaaacttaaacgtggggcactttgggaggccaaggtgggtggaccacctgagatcaggagttcgagaccagcctggccaacgtggtgaaaccccgtctctactaaaaatacaaaaaattagccaggtgtggtggtgggcgtctataatcccagctactcgggaggctgaggcagaagaattgcttgaacccgggaggcggagattgcagtgagctgagatcgcaacattgcactccaacctgggcaacaacagctaaactccagctcaaaaaaaaaaaaaaaaaagcaaaacttaaatgtagggtgtgcactttccatgaggcataaaggggcatcatatgctgaaccctcagcctcccaggtgctctgattctagaacagcaccgacagcccaaaggatgggcatcatgggcccctgttggttttaagtggatagagaaaggaagatgtagcttttagagtcctgcttatacacatatgtaaaataataacgtatttatgtgtataaacaggaacttaaaagctgcaatggactgctgtttactcacattaagacttacaaacatgcaacccaacacagggctcgcgcctgtcatcccagcactttggaaggaggctgaggcaggcagatcacttgaggccagcagtttgagaccagcctggccaacatggtaaaacccagcctctacaaaaagtacaaaaattattcgggtgtggtggaacacacttgtaatcccagctgctcgagaggctgatcagcacacaaaaatcacttgaacctgagaggcggaggttgcagtgagctgagatcgtgccactgcactccagcctggccatagagggagactctgcctcaaaaaaaaaagactaacaaatgtgccatttccattgacaaagcagcttcaagcagcacagctggagacagaggtgggccagggagagccagtgtccctcacacactccctgtctctacctccttgggtcaatctcagcatggggtaaggatcttttgctctgatggcaaaattcagcgttccaacagtctggagctgtacagctgataactgcagtcttggatgtctaaacacaatcttgcttttggaaactcactcaaaataggatacaggagacgcggaagctcacctggcctttctttttagtttcatcctaacatactgtgttcggagggcaaatgtctggagtctggcacagcagactagacgtcaaaggaaaacagttcctgtgttccagtttctcaatactttggccattgtctagtctagcctgatccaagaccccgggcaagaccttttgacagcttttgacgggctctcctccactgcctaacatgttaaccctttcacccagaaggcacttttacaaagcatattcccatgtgcaatttgcagggacatcaggagttacagcatttggagatccagttccatccatgactttggacaaggccctcgaattctgtgccccagtttccctatctataaaacggacgtagaaaatgtgttattagacactgcctgcgcttctctggaggaaagcactctgctgttaacccttaaacacccttaggagatgggcacttatggaaggaaaaaaacctctccgggtgtcaggctctacaccccaggtggaagttcttgctctctgggggttatctgagaatctggtgaaaacttagaccctcttctgaaaaacatatcccacaccacaccaaacttaaagaaagttctgtgggggtggggagatgctgtggcggcagatgccgggttcagatctccggctctgcaggctttttcgggaacgttaacttgagtcagccacgaccttaattaagatttgagaaaacagaagcccgcccaggaccctaggagatgcttcttcacttgggggggctacaacagagccctcgcgagcatcctgcagcttcggaccaccggcggcaaacaaagcccgagcaccgctcagccggggggcttccccgacctcgggggagggctctgcggagcatgcgcggcggccgtcaggccccgccccccccgggcgccggagccgaggcggcgggaacctcaaagccccggcgcaaacggccgctccccgcagagcgccggccgccccctccccgcggcgcccgggcgcagcggcggccacggacgtgtggggcccgctggccgccccctcttccaggccgggcgaacttaccgaggtcccctttcccggggcggggggggaggggcgcagagggagctgtgggggcggggccatgaccccctcgtgcgggcttcggccgcccctcccccgccgcgggcccgggcgcgcgccccaaccgccaaccgcccgcgcggtgcccggggtcgggtaggccgcgggccgcgcgccccgtaccgagcccttttgttgcgcggaggcggaggcaatgattcagcccgcggcctgcgccggcccggccgccgggagggagcgtgacgcgaggcggcccccggctggaacgcgcgccgtgccgcgtcgctgagcccgccggccccggccctgcgcccacccgtctaccctgaccctcactcacgacgcgctccttggtgtgctcgggttcggtgatgaccacggccgcgccgcccgccttgcctgctgtcgccggccgcgccgcgcgcttgcccccgccgggggccccgtcgagctccaggccgtcctcgtcgccgctgctgccgccgccgctgctgctactgcagcgctcgggccgctcgcgcttcctgcccgccgggccgccgcgtttcctgggcccggcgcgggcagtgccgttgcccgagctcggctcctcccaggccgccgccgccgccttcttcctgggcatggtcgcggctggagggagacacggggcagcggcgcacaatggacgggttataaactgcgcggggggaggggagcggagacgagccacccggcctccacttcctcctctgccctccccaaagtggcggccgcagggtgggcggagagggggcgagttgggagaggaaatcgcgcccctccctggccccggcgcggctccttcggggaatcccgcagggcagccgggagccccagaggcaatcccctggagggagaattgagacccccggcctatccgtaagttaggtttgcccacaaagcatcacagttgcaacctcgccccccaaaagtaaagggaaagtaaaaccagcctccagtcccctagattttcattaaagaaggcttcgggacacttccaggattcccccttggcacctgggtggtaagggagcccctgctccccggctaccccacctgctgcttttgtctccgcagtctccccccaaacccactcatggcatttaatgcaacgctctcccccaccccgcatcagccctggacccccgttcggccccagctcaggggtgccgacctcgggctctagttagccgaatccctacggcggactgcccccggcgacgggggaagagcccgaagaaagctggaccccagccccaaacacctgctcgcacagacacgaaaaataaaaactttaatggtgcccaactctctcccagcccccttgccggccgtgcggcccggccggtctccgattcgactgcaaagtgtccagggccgccgccagctccccggcgtccctgcgctctcccctgtctgcttttttttttttttttaattgattttgaacaatgggatctctgtctgtctccgattaaaccacgtggatccgccttccttcctctttttattccttcaatcacccagcccccctcccccaggtttttttttaaccttttctctttaaaaaaaggaaaaaaaaaaaaactttcccagaccccacaaactgatcactgtcgattttcagaccctacctggttggagtgatgagaaaccggagagaaaaaaggaagagaagcaactaaaagacggatcggagggcttttttttttccggcccagacgagggctccagcccactcaccagatacacttaaaatgtaaatacgagcttccagaacaaatgctacaacacaaaacagaaacacatgtgcggccgcgcggcaagcgagcgcgcggcggggcgggaggcgcggggcgcggggcgcgcgcgccccctgccggccggcggacccgttgccggcgcccccgccccgcccggcctggccctgccctgcccacccgagcctgcgccgcgcgccgcgcgcctcgccgcccgcctcggctccgctgctcctgcgcctttcgcgggcccgcgagcgcgctttgggccttccacgcagtgcggcctgcgcgtcagggacttctttgcggcttaggaggatgttggattgtttttcctgggcacgtctagacaggtcacatgaggacactcgctggaaaatagttacttcgctcacgcagcagccaacaagggacgtgccctaattgagtgattggaatgaaagatgaatacaatttgaataattttttcctgtgcagagagaagctgagttttatttgcctgtggatgtgtcctcagtatgtaacaaggtgctgtgacacggaagaatcacataaaggtttgctgtattagtgaattaattcataattaatttgagggccgtggaggcactggaagctggctttgaggggaactttttcattttttgccaaatatttactgagcccccggtacatgcaagacccacagtgcccggggctgcagagccagtgaacaaggtttccaccccagtggaacgcacagcctaacggaaagacagatcagtaaacaagtaattacaacagtggtaagctttacaaagtgatgcctgtgtaggaacattatggcgaggggatttatcctagtccagggccagggaaggcattcaggtggaaagttatgctgaacaacttaaaggatgaataagacccgatgaaagggggcaggaaaagtattccaggccaggtggagtgaacgggacgctccacatttcgagatcttgagagacacctcctgggagggaagctgtctggtggggctggggtgagaagagccaagaggctgggttctgaggaggtaggcaggggtgcgagggcctgcatagaccctagtgaaccgcagtgaggcttgatctcgttcgcgtgtcctgggacgggtgaaaaaagccttgcttgcttcctaccggtctccaccctccacctctccaccccacttccattacgatctcaccgtcacttgctctcctctcaaagcttttctcctgcttcttttttcctgaggcgtaccgcacaaggaagttccttcttcaggcaacttcttgaaaacgcataaagttctaggatttttgtgattcattcattcattgttagtgcaagaaacaggactgggaagcatcaagtgtcctgtaaaggaagacagagaaaccaagaggcccaaatctaaggtatttgatcaaagtcaaaagtctgtgtgtcaagagagctgagagtgcttatgtaaaagaactttggaaatgagaaatcaactggtacgtttcagagattttcagaaaagtcaagatggaatagaagcaccctttgaaagcctattcttaatagacctgcatttaaaaagattttttagaggttaaactttgacgctttgatataaagcataagtagaaccaaccagaaaagaatttcgcctaaatatgccatcaagtccccttcaggaaatggcatgctgatgcttgtcagccgaggcgggtggctgggtgtttatcctctaaacaccctgtgtggccaattaggaacaccactgacagtacctttagatttcagtctgcaagtcttttccttttttctcctgcccctttataatgctttttgccagcttaaaagactcatgcctcagacacactgatgcaatgagacgctaatatcatattgcatcatctgatcctaggtgtggtgctcctgaaactggtttttcttgaggttatgctgcagtagaaaagcactttgggtataacaccctggaactggccctacttgtcagaagacaaaagtaatttttgcaactccatgcctcaattccacaccactattctcccagggaaagcctgcgtgactctcccggctggaattgggtgtgcaacagacattcatcagttaggcgtgtcatgctgccacttatgtaacaaatgttacatagtgaggtgcacctacaggcaagctgaaaatgacacttcctccttcaaactgtgcttggaatttcacctcgcttctaattgagcaaattctccagggacaggatggtttggtgcaaaaccgggagaggggaagggaaagaaggtggctgagatttctctgacactttgaggcacaggtgtctggcactgtgctgagcattttacacccagaattttggaaatgtggctgcaagtgccagcctgccgtcactctttaacctcatcttcagcaaaatcatattgcaagttagattcagctacgcttaagttcttttccaggggtgaggtgtgattttttctttcttttttttttttttttttttatttttttagatagaatcttgctcctccagcacccaggctgaagggtgatggtatgatcccagcttactgcagcctctaccttccttgctcaagcgatcctctcgcttcagcctcccaagtagctgagaccacaggcatggacagctacacttggctaaattttttttcttttttaatgttttgtagagacaaggtctctctctgttgcccaggctggtctcgagtggtcctcccacctcagcctcccaaagttgcgggattataggggtgagccactgtgcacagcctcagaagtataattcatttttttttttcttttgaggtggggtctcgcactgtcacccgggctggagtgcagtggtggcaacctccacctcccaggttcaagcagtctcctgcctcagcctcccaagtagctgggattacaggcgcataccaccacgcctagctaattttgtatttttagtagagacggggtttcaccatgttggccaggctggtcttgaacttctgacctcgtgatttgcccgccttcgcctcccaaagtgctaggattacaggcgtgagccactgtgcccagcctcagaagtgtaattctattcaacttggctacagaaagctacacctgtacttgaaagattaattttctgatccagtgtctataaaaatgaaaccagtgatcctgggagtgatgcgctaaccaatggaaacgattctttctctttttttttttttggaaactgggtctcactctgtcacctaggctggactgtagtggcgccatcttggctcactacagcctcgacctcctggggtcaaacagttctcctgcctcagccaccctagtagctgagactgtagacgtgcacctccacgcccagctaatttttaaaatttttttgtggagacaaggtctcactatgttccccaggctggtctcaaactcctgacctcaagcaatccttttgccttggcctcccacagtgctaggattataggcatgtgtcactgtgcctggcttctttttactcttttcaatgtgactaccacaaaatttaatattacatattaagttttttgtagctcatatgttattcctgttggacatcacagccttcgaaagcatagctggaaaaccagtaatttcctccagaccccactctttctgcatctgttctctagtttctcctctctgtaaaatggcaagatagagtttgggctaaatttctcttgaggttacttctggatttcgtattccctgattctgaggacagtagtcagcggggaatccctgtcatagtgtttggagagatgttttctgggagatgcagatccggtcgtcctatttctgccaatgagtcatgaaattttcaaacgcagagtctttaaatattgtagttggacctttaagttctctgtctgtgaggcatgcctgggcttggcttgtggcttcttcatctttgtttttctagcaagcacccagagcagcccggcgtgtagtaagctgtcaatatatgtttgttcatctaaataatatccagcggaagaactgaagcccagggagatgctgaggcctcctgaggccacacagctggcagataggatagccaggaagtgtacaggcatctgcatcagtaggaggattgtcagaaacacagaatctggccaggcgtggtggtacacgcctgtaatcccagcactttgggaggctgaggcaggacgattgcttgagcccaggagttggagaccagcctggacaacatggtgagaccccatctctacaaaaattagaaaaaaattagccagccgcggccaggcgcagtggctcacgcctgtaatcccagcactttgggaggccgaggcgggcagatcacttgaggtcaggagttcgaaaccagcctggccaacatggtgaaactcccgtctctgctaaaatatacaaaaattagccgggcgtggtggcaggcaacttaatcccagttacttgggaggcagaggcaggagaatcgtttgaacccgggaggcggaggttgcagtgagccaagatcgagccattgcactcaaacctgggggataagagtgagacttctctcaaataaaagaaaagaaaagaaaaaaattagtcaggtgtggtgacgcaaacctgtagtcccagctactttggaggctgaggtgggaaaatcgccagagcctgggaagtccaggctgctgtgagccatgatcatgccattgcactccagcttaggtgacagagtgagaccctgtctcaaaaaaataaaaataaacactgaatctcaggttcagcccccagacctactgaatcagaatgtgttttttttttttttttttttttttgagttggagtttccctcttgttgcccaggctggagtgcagtagcgcaatttgggctcactgcaacctccacctcccagttcaagcgattctcctgcctcatcctcacaaatagctgggattacaggcacctgccaccacacccagctaattttttgtatttttagtagagacggggttttgccatgttggccaggctggtctcgaactcctgacctcaggtgatccacccacctcgacctcccaaagtgctggaattacaggcgtgagccatcacacccggcccagaatgtgcatttttaacaggtgatttttatgcatcttaaagtatgagaggtgcagccaggcatggtagctcacacctataatcccagcactttgggaggctgaggcgggcagatcacctgaggtcaggagttcgagaccagcctgaccaacatggagaaaccccgtctctactaaaaattagccgggcgtggtgagcggagattgcgccattgcactccagcctgggcaacaagagcgaaactccatctcaaaaaaaaaaaaagtatgagaagtgctactgaaatcataccacttttccataccctgtggaagccattcaaaaggtggtttctcatactttaagatgcatctagctgggcgcagtggctcacgcctgtaatcccaacattttgggaggccgaggagggtggatcacgaggtcaagagatcgagaccatcctggctaacacggtgaaaccccgtctctactaaaaatacaaaaaattagccaggcatggtggcgggtgcctgtagtcccagctactcgggaggctgaggcaggagaatggcatgaacccgggaggtggagcttgcagtgagcagagatcgcgccgctgcactccagcctgggcgacagagcaagactccgtctcaaaaaaaaaaaaaaaaaaaaagatgcatctagtccagggtgaggaggtccaggatgcagaataccaagactcaccaagctggctgatgtggttaggctttgtgtccccacccaaatgtcatgtttttatttatttattaatttatttattatttatttttttattttttgagacggagccttgctctgttgcccaggctggagtgcagtggcgcgatcttggctcactgcaggctacgtcccctgggttcacgccattctcctgcctcagcctcccgagtacctgggactacaggcgcccaccacttcgcgtggctgattttttgtatttttagtagagacggggtttcaccgtgttagccaggatggtctcgatctcctgacctcgtgatcagcccacctcagcctcccaaagtgctgggattacaggcgtgagccactgcgcccagctatttatttatttatttttattttattttatttttttgagatggagtctcactctgttgcccaggctggagtgcagtgatcttggctcactgcagcctctgcctcctggttcaagcaattctcctgtctcagcctcccaagtagctaggattacaggcacacaccagcacacctggctaatttttgtgtttttagtagagatggggtttcaccatgttggccaggctggtctcaaattcctgacctcaagtgagccaccacgcccggcctcctgctgccttttgaagaaggtgcctgcttgcccttctgccatgattgtaagtttcctgaagcctccccagccatgctgaactgtgagtcaattaaacctcccttgtttataaattacccagtcttgggtagtatttttatagcagtgtgaaatcggactaatacactggcctaatgaagacttaaggaaattcaacagatatttactgaccctctacactgccccgggcctggcagctggtgcacccacttctcttcctgagggttggaggagctcacgcttttgcagcccctgttgcctgcatctgaaggagtaagcaaccacttcacagttttgccatcagctgggcctgctcttcctcctttagtacaggagaaatttgaaatgaaaatgagcacaccttgggagttaaatctaatttttcaggaaaaacaggatcgaaatcactttcatcaatgtctgcctgttagtttgtaaccaccggcgctcccaatctgcaggagtgtttgcattcatgttgtgttcctggcttgagatagagccacaatttgtaaagctggtctgtaatcaatagctctccagtcggccgggcgcggtggctcacgcctgtaatcccagcacttcaggaggtcaagatgggtggatcatgaggtcgggagactgagaccatcctggccaacatggtgaaaccccatctctactaaaatacaaaaaattagctgggcgtggtggcacgtgcctgtagtcccagctactcaggaggctgaggcaggggaatcgcttgaactcgggaggcagagattgcagtgagccaagagtaccactgcattccagcctgggtgacagagcgagactgagtctcaaaaaaataaataaataaaggctctccagtcattttctaagactatccctcacctaagcttgcaaataaaagctaacttctgcagagattccatcttcccctgccagtgggcaatatggatgtatagtcatgagattagaaaaagagaggctggccaggcacgatggctcacgcctataatcccagcactttggtaggctgaggcaggcagatcacctgaggtcaggagttagagaccagcctgaccaacatggggaaaccccgtctctactaaaactatagaaattaaccaggcgtggtggcaggcacctgtaatcccagctactccggaggctgaggcaagagtatcgcttgaacctgggaggtggaggttgcagtgagccaagatcatgccactgcactccagcctgggtgacagagtgagactctgtctcaaaaagaaaaagagacagaggcacaaacaaagtgcaggtcctacagctgttcatccagcatcgattgcgaaatgaagcctagcgggtgggcgacttttgggtgaggtcaagaaccatgagagttggaatggacgagaaaaaccaaggctttgggcccagctgcagaactgtgtcatttgccgggaaggttaatgacaaggccagaaggagtgccgcctgtttaatgtatcaggtggccctggtggctgggaatcattgcatttcaggccacgtcatgtcatgcaaaagcataataaccttttgaaaaatgaagaaatcgatcccgtggggagtccctgcagtgccaaatatctggactgtctgattttcacattcactaagtggcctgagtcagctagatgaagcagaggagttcttaaatagaaccaagatgctctctctggtgtgcactgagctcttaccttgcgccagacattgggccaggcactccccgtaaaaagctggtttcatcttcataacatccatgcaacacggatacttttgtgggtccccgtattagtttgctagggctgccataacaaagtaccacagacagggtggcttaaaatcagaaccttattttctcacagctctggaggctgtaagtctaagaccaaggggtcagcagggttggtttcttctgtggcctctctccatagcttgtaaatgccaccttctctcttgtcttcacgtgatcttccctctgagtgtgtctgtgtcctcatcttttcttacaaggataccggtcacattgcattagggccagtgtaatgacctctttttaactttattacctcttttgagaccctatttccaaatacagtacagccacattctgagatactggtggtttgcacttcagcatatggactcggggggacgtattcatcccctaacagtccattttatagatctggaagccaagacataagttaagaaacttgttcacggtctcacaggtggaagtggtgaagtcagaatctgaaaacccattctttctttttcttttcttttctttttttttttttagagatggtgtctcactctgtctgtcaggctggactgcagcctcagtctcctgggctcaagcaattctccagcctcaacctccggagtaggtgggactatatgcgtgtgctaccgtgcccggctaattttttcatttttagtaagagatgagggcttgctgtgttgcccaggctgatcttgaactcctgaacttaagtgatcctcccacctcggcctcccaaagtactggaattacaagcatgagccaccttgtctattttctttttgttgttgttaatttgtgtgtgtgtgtgtgtgtgagatgggagtctcactctgtcgctgaggctggagtgcaatggcgtgatctcagctcaccacaacctccgcctctcgggttcaagcgattctcctgcctcagcctcccgagcagcagggaccacaggcatgcgccaccacgctaggctaattttgtatttttagtagagatgggggtctctccatgttggtcaggctggtcttgaactcccaacctcaggtgatccgcccaccttggcctcccaaagtgcttggattacaggcgtaagccaccatgcctggcccacctcatctattttcagaggctgagatttattgccgctaacttcagggttccacccaagccattcctacacttattccactgtccccactggcctctccttaaacaccccctcctgttaggactcctgcttgctccttatcttgctatctctacagaggtcttggttctgaggctggaaacagaagggcctctggagtgaataacacatggttctgtgggctttgagtgtcacgcagaggcatcatcttaaaagacaatctcggccaggcgaggtggctcatacctgtaatcccagcactttgggaggccgaggtgggtggataaccttaggtcaggaattcgagaccagcctggccaacatggtgaaaccccgtctctactaaaaatacaaaaattagctgggtgtggtggtgcatgcctgtaatctcagctactggggaggctgaggcaggagagtcgcttgaacctgggaggtggaggttgcagtgagctgagaacgcaccactgcattccagcctgggcgacagagtgagactccatctcaaaaataataaataaataaataaataaataaataaataaataaataaataaataaaataagtgtttggatcatgaacacttatgtggttcataaaagtgattgagttttcatgttcatgtgttgaatgtgcctccctcaaaccttgttaagtcatcagcacattacccatttgatgtgaacttagaaaaaaataaaagagggccagataacagtggctcacacctgtaatcccagcactttgggaggccaaggtgggtggatcacttaaggtcaggagtttgagaccagcctggccaacatgatgaaactccgtctctactaaataaacaaaaattagctgggcatggtggtacatgcctgtaatcccagctactcaggaggctgaggcaggagaatcacttgaatccaggaggtggaagttacagtgagctgagttgtcaccgctgcaatccagcctggatgacagagtgagactctgtctcaacaaaaaaaaaaaaaaaaagaaaatgtttttatttaaagaaagacatttactcaggtgttgcatagctctagcaaaaatgaggaagatggttccacaaaccaccttggcttgaggaataggatttgatgcttctggctcctcccaactctgatgttctccagtctacgatggaccatggcgtctgactgtctagaaaaatccatgatgaaggaaagttgggtagtgtacaagaaagcaagcctgcttgaaggcatgcattgaattacacaggttgggtcccaatccacagaaagccttttgcctttgaaagtgttaccaggcggagcactggggctcacgcctgtaatcccaatactttgggagaccaaggtgggaggattgcttgagtctgggagtttgagaccagcctgggcagcgtagggagatcctgtctctacataaaatttaaaaattagctgggcaggctgggcgcggtagctcacgcctgtaatcccagcactttgggaggccgaggtgggcggatcacctgaggtcaggagtttgagaccagcctggccaacatggtgaaaccccgtctctactaaaaatacaaaaattagctgggcatggtggcaggtgcctgtaatcccagctactcaggaggctgaggcaggagaattgcttgaacctgggaggcggaggttgcagtgagccgagatcacaccattgcactccagcctgggctacagagcaagactcagtctcaaaaaaaaaaaaaaaaaaaaaaaaaaaaaaaaaaaaaaaattagctgggcataatggtgtgcatctgcagccccagctactaaagagattgaggcagggggctcactggagcccagaaggtggaatgagttatgctcgcgccactgcactccagcctgagcggcagaatgagaccctgtctcaaaaaaatttaaaaaaagtagaaaaagtgttgccaagtgtgcgacctcgtcatcagacagtggcaggattatggggctcaggaagcaggaagtcagcaccaaaggaggatgtacctcgctggtgggagcctgatcttggcctatatgtaggaaagagtcttttttttgagatggagtctcgctctgtcgcccaagctggagtgcagtggcgtgatctcggtccactgcaacctccaccttccagattcaagcagttctttgcctcagcctcccgagtaggtgggactacaggtgcccaccaccacacctggctaatttttgtatttttagtagagatggggtttcactatcttggccagactggtcttgaactcctgacctcgtgatccaccggcctcggccttccaaagtgctgggattacaggtgtgagccactgcatggggccaagacagtcatttctgtgtccactagttgccctgcaaagtatcatttttagctggaatccaatccttcctttgaggaatgagaaaactaagacccagggaagctgagctgtctccaagtctgaatcgaatggaggggaaccatgtgtccacgccctcgaggctgtggcttagtccctgccactctgacaacgaaaccactcattatttttcatcttctcggcggtttaaatcactgttattatgcacgcatttttcaaaagagtgcattccttaccaaacctcattaaatttctcgagacttgagctggttccccttccttgcttcagagggaaggagggaatttggctgacacagaagcattttcgtcccataccatcaccacctgatgctgtctgtccaaaacagggtgttcgggatgtctgggcaacctgtctgatacagagggggtttcaagatgactcacagagcagggatgggcacaggtgaccccacagtctcaagcagggcccttctggggcagctgaaaagtgtggactagagcaagagatagctctggaactgtttgggttcaattcccagctctagctggttgtgggggctcatgcctgtaatcccagcactttgggaagccgaagcaggacaatcacttcaggtcaggaatttgagaccatcctggtcaacatggtgaaaccctgtctctactaaaaaataccaaaactagctgggcatggtggcttgtgcctgtagtcccagctactcgggaggctgaagctggagaatcgcttcaacctaggaggcagagactgcagtgagctgagatggcgccattgcaccccagcctgggcgacagagactctgtctcaaaaaaaaaaaaaaaaaaatcggccgggctcagtagctcacgcctgtaatcaagcactttgggaagctgaggtgggtggatcacgaggtcaggagttcaagaccacctaggccaagatgatgaaaccccgtctctactaaaaatacaaaaattaactgggcatggttgcggatgcctgtaatcccagctactccagaggctgaggcagagaattgcttgaacctgggaggcggaggttgcagtgaaccaagatcgcaccactgcactaaagcctgggcgacagagcgagactccgtctcagaaaaaaaaatcttgttttagaccagaaaaagcagctaaaaataatacatgaggaaggtcccggctcacatcagtaagatgctttcaagtttacaaagcacattcatcttccctcttgggtctcatgaccagttggtgaggacatgggtcacagattattatgcccattttatagtatgggaaactgagactcagaaaggtcaagggtcttaccttttaacttttctctctctctttattagacttgaagctttgagagggagggctcagacttaccttgtttcctgctgtgtccacaggctcaagcacagcttccagaacatagtatttgttcagcaaatattctgcagatgagtgtagtaatgaagctgttctcataagttaataagaaatcatggcagaaagaatgttataattaagcattaatcaggcttcactttgacccacttccttataaccaaaagtcacctagcattagatattgactatttgtatccccgttattcctatagataggaatttttttttttttttggatggagtctctgttgcccaggctggagtgcagtggcatgatctcagctcactgcaacctctgccttccgggttctagcaaccctcgtgcctcagcctcctgagtagttgggattatacgcacatgccaccacacctggctaatttttctattttcagtagagatgggagttttgccatgttgctcaggctggtgtcgaacttctgacctcaggtgatccgcccacctcggcatcccaaagtgctgggattagaggcatgggccaccacacctgacctctatagatagcatttctgacattagaatcataaggattttgtttaaatattgtttacagccagggggacacagtgggtcattcttgtaatcccaaaacctgggaaggccaaggcaggagcatctcttgaaaacgggagtttgagaccaccctaggcaacacagcgagaccctgtctgtacacaaaatttaaaaatacaaaatgaggtcaggcgcggtgggtcacacctgtaatcccagcactttgggaggccgaggcaggcggatcatgaaggtcaggagatcgagaccatcctggctaacatggtgaaaccccgtctctactaaaaatacaaaaaaaaaattagccaggcgtggtggcaggtgcctgtagtcccagctactcgggaggctgaggcaggagaatggcgtcaacctgggaggcggagcttgcagtaagccaagatcacaccactgcactccagcctgggcgacagagacttcgtctctaaataaataaataaataaataggccgggcgctgtggctcatgcctgtaatcccagcactttgggaggccaaggtgggcggatcacaaggtcaggagttcgagaccagactgaccaacatgctgaatccctgtctctactaaaaatacaacaattagccgggggtggtcatgggcacctgtaattccagctactcaggaggctgaggcaggagaatcacttgaccccgggaggtggaggttgcaatgagccaagatagtgccactgcactccagcctggacgacagagcaagactctgtctcaaaaaaaaaaaaaaaaaaaagagaaaaggctgggctcggtggctcatgcctgtaatcctagcactttaggagggtgaggcgggtcgatcgaggtcaggagatcgagactatcctggctaacacagtgaaaccctgtctctacgaaaaacacaaaaaattagctgggcgtggtggcgggcgcctacagtcccagctactcgggaggcagaggcaggaaattcacttgaatcgaggaggcagaagttgcagtgagcagagattttaccactgcactgcactccagcctgggcaacagagcaagactcgctctcaaaaaaaaaattagccgggcgtggtggcgggtgcctgtagtcccagctacttggaaggctgaggcaggagaatcacttgaacccgggaggcgggggtttcagtgagctgagattgcgccactgcactccagcctgggtgacagaaggcttcgtctcaaaaataaataggccaggcacagtggcttgccagcattttgggaggccgaggcaggtggatcacctgaggtcgggagtgagcgaccagcctgaccaacatggagaaaccgcgtctctattaaaaatacaaaattaccctggcgtggtggcgcatgcctgtaatcccagctactcgggaggctgaggcaggagaattgcttaaactcgggaggcggaggctgcgatgagccgagaacacggtgagccgagattgcgtcgagccgagattgcaccattgtactccagcctgggcaacaagatcgaaactccatctcaaaaacgaaaggtcgggcgaggtggctcacgcctgtaatcccagcactttgagagactgaggcgggtggatcacaaggtcaggagttcgagaccagcctggccaaatgctgaaaccccgtctctcctaaaaatacaaaaattagcctggcacggtggcggatgcctgtaatcccagctactcgggaggctgaggcaggagaatcgcttgaacccagaaggcggaggttgcagtgagccaagatcaggccctgcactccagcctgggtgacagagcgagactctgtctcaaaaaaaaaaaaaaaaaaaaaaaaaaaaaccctagctccaaactcctcaaggagatggatttgagatttcctcccatctcctccttcagcagccctatgattgaacctctttgtctgctgcaacctggtgtctcagtgttttaacttgccacgcactggacgaaggacccgttatggctacagtgatccccaagatgataaaactaacctgtagcacagtttgggtgaacatccctggcacttcttttcttggaacaagatctagcaaataccaacaaatgataggagggaatttgtgataaatgctctgagaacttcaggaaaaggagaggccaaattcaaccttcgagttaagaatggtttttacatttgaacctcagttaagcaaaatgttatctcccaaccattcaaatttcattctgctcatcagtggacagatgatacaaaaatcctactcaattactactattattttagaattcgttataaaacaataaagcatttgtgccaggtgtggtggctcatgtttataaccccaacactttgggaggccgaggagggtggatcacttgagcccaggagttcaagaccagcctggccaacgtggtgaaaccctgtctttactagaaatacaaaaattggccaggtggttgtgcgcacctatagtcccagttacttgggaggctaaggtgggaagatcacacttgaacccaagaagcggaggttccaatgagcagagatcgcacaattgcactccagcctgggcagcatggcaaaaccccatctctaaaaaaatacgaaaaaatgccaggcgtggtggctcacgcctgtaatcccagcactttgggaggccgagacgggtggatcacaaggtcaggagatcgagaccatcctggctaacacagtgaaaccccgtctctactaaaaatatgaaaaaattagccgggtgtggtggcgggcgcctgtagtcccagctacttgggaggctgaggcagaagaatgtcgtgaacccgggaggcggaggttgcagtgagctgagatcgcaccactgcactccagcctgggcgactgagcgagactccatctcaaaaaaaaaagaaaaaattagaaaaagcaaaaaacaataaagcacttgtgaaaaatttgttttctctcattatatgagtacccacatacagccatgtccttgggcttgactcttggctcacaaaggctaaaatatttcctttctaggcctttacagaaaaagcctgccaagccactctttttttttttttttttttttttttaaggtagggtctcactctgtcacccagcctgtagtgcagtggcgtgatcagggctcacggcagtcttgaaatcctgtgctcaagagatcctcgtgccacagcctcctgggtagctgagaccacaggcatgcaccaccatgccccacaaatttttatttatttatttaagagatggagtctcactctatcgcccaggctagagtgcagtgccgcgatctcagctcactgcaacctctgcctcccgggttcgagggattctcctgcctcaggaatagctgggattacaggcacgcgccaccatgcccagcaaatttttgtatttttagtagagacagggttttgcatgttgaccagactggtctcaaactcctgacctcaagtgatctgcctgctttggcctcccgaagtgctgggattacaggcatgagccactaagcctggctgcccagctaatttttaaatttttttatagagacaggatctcactgtattgcccagtctgtgttttgtttcttgatctgggcgctggttacatggggtattaaatttgtgaaaatttattctgctgtacacgtatgatatgtgggctttatctatctatctatctatctatctatctatctatctatctacctacctatctatccatccatccatatattatacctcagtgaaaagtttaacacaggccaggttcagtggtgtgtgcctgtaatcctagcattttgggaggcttaggtgggtggattgcttgaagccaagagttcgagaccagcctgggcaacatggcaaaaccccatctctactgaaaatacaaaaattagccaggcatggtggtgcatgcctgtaattgcagctactcaggaggctgaggtgggagaatcccttgaacccaggaggcggacgttgcaatgagctgagatcacaccgctacactccaggctgggcgacagagtgagactctatctaaaaaaaaaaaaaaaaaaaaaaaaaaagaggctgggtgcggtggctcatgcctgtattcccggcactttgggaggctgaggcaggcagatcacctgagatcgggagttcaagaccagcctgaccaacatggagaaaccccgtctctactaaaaatacaaaattagccgggtgtggtggtgcatacctgtaatctcagctactcgggaagctgaggcaggagaatcacttgaacctgggaggcggaggttgctgtgaactgagatggcgccattgcactccagcctgggcaacaagagcaaaaatacatttaaaaaaaaaaaagagaatctgccttctgctggctgggcgcggtggctcatacctgtaatcccagcactttgggaggctgaggtcggcggatcacctgaggtcaggagttcaagaccagcctggccaacatggtgaaaccccgtctctactaaaaatacaaaaattagctgggcatggtggcaggtgcctgtaatcccagctacttgggaggctgaggcaggagaatcgcttgaacccgggaggcggaggttgcagtgagccgagattgtgccattgcattccagcctgggggacaagagcaagacttcgtctttttttttttttttttttagacagagtttttgctcttgttgcccaggctggagtgcaatggcgcaatctcggctcactgcaacctccgcctcccgggttcaagcgattctcctgcctcagcctcccaagtagctgggactacaggcatgcaccaccatgcctggctaattttttgtatgtagtagagatggggttccaccatgttggtcaggctcgtctcgaactcctgacctcaggtgatccaccccccttggcctcccaaagtgctgggattacaagcgtgagctaccgcgcccggccgagacttcgtctgttttttttgtttgtttttttttttttactttaagttttagggtacatgtgcacaacgtgcaggtttgttacatatgtatacatgtgccatgatggtgtgctgcacccattaactcatcatttagcattaggtatatctcctaatgctatccctcccccttctccccaagagacttcatcttaaaaaaaaaaaaaagaatctgccctctgcccttaaggggctttcattccagtgggcagtgtctattacttcagaccctccacaagacctttcaccatgttcctaccacccagccatccaccttaggatccaggcactcctgaatgttaactttccccacaccaaccaaacatacaccccagaaagaatgccatcccacggcaaggcttcatgtctagaacctatgctcaccatctgtcagactcctattcacccttcaaagccctttccaaggcttcccagaagccttccctgacttaccaataatgaggatagggatgatgatatagagcagggattattgttacaaacctcagttcacagaatggaaaactgaggcccagagaggtaaagtatctagtccaaggttgaactactttttttttttttttttttaagaacagaggtaatgtagggtttgaatgcaggtcctcctgatatcagagtcagcgatctcaaccacacacactactgcttccataacagaagaatattttcacacatctgtgttccaagttttgaatctggccgggcacagtggctcatgtctgtaatcccagcgctttgggaggctggggctggcaggtcaactgaggtcaggagttcgagagcagcctggacaacatggtgaaacgcggtccctgctaaaaatacaacaattagcctggagtggtggcttgtgcctgtattcccagctattcgggaggctgaggtaggagaatcacttgaatccgagaggaagagattgcagtgagctgagatcacgccgctgcactctagcctgggcaactgagcaagactccatctcagaaagaaaaaaaaaagttttgattccctatcacatgcttcataaattacaatgtcatgaaatcttcataacagccaagtctgggtaatgggtataataccttggggcaggtattattattgttatcatagcttttttttttttttttgaggtggagtttcactcttgtctcccaggctggaggctggagtgcaatggcgtaatctcggctcacggcaacctctgcctcccgggttcacactattctcctgcctcagcctcccaagttgctgggattacaggcgtgggtcaccatgcctggctaatttttatttttccgagacagtctcgctctgtcgcccaggctggagtgcaatggtgcgatctcagctcactgcaacctccacctcccaggttcaagagattctcctgcctcagcctccccagtagctgggaccacaggtgtgcgccaccacgcccagctactttttgtatttttagtagagatggggtttcaccatgttgaccaggctggtcttgaactcctgacctcaggtgatccacccgcctcggcctcccaaagtgctgggctgataggtgtgagccactctgcccggcctgtttttaccattgctattttatacgtgctcagagagatgacctaagttcccagaagtgacacacgggaaagcggcagagctggattcaacccaggcttgtggaatcccagagcctatgcccttcccttcgctgtgtcacatcttcctctaaggacccagtgaaacccaagttctctgggtgtgattcactccctggagtcctccgccatccagagggtgggttccggagttgcctccttctctgcatcccaattggattcctcagagccaccgccttcctcctgcccagctcagtgcagggtgctccggcgcctggcatctgaaggatgtgcaggcagtggcgtgatagtgagtgggaggaggagcctctgatcatccaccaagttcaaacctgcttttcctggcatgaccctcagctaggcagcccggactctccagatgccagcctggccatgccaggggccaaggaggatgcttcaggcaaaatccccacatgcaagatgctggcttcccagggctcctccagggtggcaggtgacaggcatgtacgctagggaggggacatcggagctcttcagccaagcaactctgttcggagaaaaaagaaaaaccttcaagtcctcgggagtgcctcaaagcagaaacctcaacctgaaatacagacctcattcaacctggccgtgaatccttgccacaccttgcattagagaaaggctcctttccaaaccatttcatgtgtgtgttaaaaaccatttctgggcggggcgcggtggctcacgccggatcgcctgaggtcgggagttccagaccagcctggtcagcatggtgaaaccccgtctctactaaaaatacaaaaattagctgggcgtggtggcaggtgcctataatcccagctactcaggaagctgaggcaggagagtcgcttgaaccctggaggtggagattgcagtgagccgagatcgcgccactgcactccagcctgggtgacaacagagtgagactccatctcaaaaaaaaaaaaaaaaaaaagaaagaaagaaagagaaagaaggccaggcgcagtggctcatgcctgtaatccgagcactttgggaggctgaggcgggtggatcacgaggtcgggagattgagaccatcctggctaacacggtgaaaccccgtctccactaaaaatacaaaaaattctccaggcatggtggcgggcgcctgtagtcccagctaccccggaggctgaggcaggagaatggcgtgagcctgggagatggagcttgcagcaagccaagatcgtgccactgcactccagcctgggcgacagagtgagactccatctcaaaaaaaaaaaaaaaatgaaagaaagaaaagtctgaatcgatgactaaacaaatcacaggacttttcagtagttagtattttttttttcaggctagattccccaaagtagaatttctggggtaaagggcgtgactttttaaattttatttatttatttattttaagatggcgtcttgccctgtcgcccagcctggagttcagtggcaccatctcggctcactgcaacctccacctcccaagttcaagcgattctcctgcctcagcctccggagtagctgggattacaggcgcacaccaccacgctcggctaattttttgtatctttggtagagatggggtttcaccatattggccaggctggtctcgaactcctgacctcgtgatcagcccacctcggcctcccaaagtggtgggattacaggtgtgagccactacgctcggccacggacatgactatttttaagactcttgatgcaaattgcacacccaaagagcaggtggtgcttcctacctgtctaaagcagtgcacagcaggaccctctcaggtcctgacatcagtgttgcatttaaaattcctaacacctgtccaggtgcggtggttcatgcttttaattccagcactttgggaggccgaggcagcagatcacttgaggtcacgagttcgagagcagtctggccaacatggtgagagcccatctctactaaaaatacaaaaattagccaggcgtgggccgggggcagtggctcacgcctgtaatcacagcactttgggaggccgaggtgggcggatcacgaggtcaggagatcgagaccatcctggctaacacggtgaaaccctgactctactaaaaataccaaaaattagctgggtgtggtggcgggtgcctgtagtcccagctactcgggaggctgaggcaggagaatggcgtgaacccgggaggcggaggttgcagtgagccaagatcgcgccactgcactctagcctgggcaacagagcgacactctgtctcaaaaaaaaaaaaaaaattagccaggcgtggtagcgggcgcctacaactccaactacccaggaggctaaggtgggagaatcacttgaacccagaaggcagaggttgcaatgagccgagattgcaccactgcactccagcctgggctacagagtgaggctctaaataaataaataaataaataaaatttctaacacaaaccaccctgtagataagtacactcagcatatctttattgaacgcatgaaaggaagaagggtttgttgtgatttttcttttgagacagcgtctccttctgtcacccaggctggagtacagtgttgcaatcatggcttactgcagccttgacctcctggcctcctggctcagtagttggaatcacaggcacacgccaccacacctaatttttacacatttttgtagagacgaggtttcaccttgttgcccaggttggtcttgaactcctgggctcaagcaattctcgcaccttggcttcccaaagtgctaggaatacagatgtcagccccatgccaggcccccttttgcatatcttaactttaactttgtttgtttgtttgttttgagatggagtttcattctgtcacccaggctggagtacagtggtgtgatctaggctcactggcaacctctgcctcctgggttcaagccagtctcctctctcagcctccgagtagctgggattacgggtacgtggcaccacacctggctaatttttgtattcttagtagagatagggtttcaccatgttggccaggctggtctcaaactcctgacctcaggtgatctacccacctcggcctttcaaagtgctgggattacaggcgtgagccacagcgcccgacaaacttctttatatatgcatgccaacaaagagtcagaccctgtaaaatatttgaagagatttattctgagccaaatatgagtgaccatggcccgtgacaaaagccctcaggaggtcctgagatgtgtgcccaaggtggctggagtgcaagttgtttttatacatttttgagagacatgagacaccaattaaatacacttaagaactacattggcttggtctagaaagttaggacaactcgaagcagggcggggttgcttccaggctataggtgaatttaaacactttctggttgacaattggttgaatttgtccaaagacctgggattcatagaaagggaatgttcaggataagataaatactgtgagcccaggcacagtggcccaatcccagcactttgggaggccaaggcaggcagatcacctgaggtcaggagtttgagaccagcctggccaacatggagaaaccctgtctctataaaaatacaaaattagccgggtgtggtgttacatgcctgtaatcccagctactcgggaggctgaggcaggagaatcgcttgaactcgggaggtggaggttgcggtgagccgagatgatgccattgcactccagcctgggcagcaagagcaaacctccatctcaggaaaaaaaaaaaaaaagataaatattgtggacaccaaagttcttttgaagtcttatagtggctgcttttagagacaataaatggcaaatgtttcctattcagatcttagttaatctctataggattgtgaggttctggaagaaaaagatctagctatgttaatagagattctttacagatgcaaattttccctagcaaggaacagctttgtagggacatttcaaaatatgacaaagaaacatgttttggggtaaaatattttgatgttcttccttgtctcataatgttatgccagagtcagtcaggttggaaagtcagtcacaatacctagggttaaataaaacccatctgaagagaatttatgatttgtagggcatggctccccagaccccttagataggaatttgggcaagataaaaatcagagtttaggccgggcgcggtggctcacgcctgtaatcccagcactttgggaggccgaggcaagcagatcacgaggtcaggagatcgagaccatcctggctaacatggtgaaaccccgtctctactaaaaatacaaaaaattagccgggcgtggtggcgggcacctgtaatcccagctactcgggaggctgaagcaggagaatggtgtgaacccaggaggtggagcttgcagtgagctgagattgtgccactgcactccagcctgggcgacagagccagacaacgtctcaaaaaaaacaaaaacaaaaaatcagagtttagtcctcatgcctcacatatgtgcccaggaagtgggtactcctgaaatccccgtttcacagatgaggaaactatggtggagtatgagaggcttggccagggacagtataagaacaggcacaggccaggtgcggtggctcacgcctgtcatcccagcactttgggaagccaaggtgggtggatcacccgaggtcaggagttcaagaccagcttggccaacatggtgaaaccctgtctctactaaaaatacaaaaattagctggggatggtggtgtgcacctgtaatcccagctacttgggaggctgaggcaggagaatcgcttgaacctgggaggtggaggttgcagtgagctgagatcacaacactgcactcaaaaatgggcaacaagagaaaactccatctcaaaaaaaaaaaaaaaagagaacaggcacaggtagagatgattaaatagcagtgagcgctcggaatcttgaggaagagagaaggaaggtgggtagggcgtgtacccatcttagattctttggctgggaccctattcattagactaacaaaagacagattggcaagagaaaaataaacagaagttgattatgacacttgtacatgggagtactcagaggtaagtgactcaagagggtggttagaactggggtttatgtagcaacttaacaaaagaagaatacattttagtgaagtgaaaagacgaagggaaagcactagggcagcaaatcgtgagagggtcaatatatgggggatgaatggaagatgggagctaggagtggagtcggttaagtctactcctctgggccccaggaagtttagggtctggaggtgtctctgggatcaacttttgtccttcctggtggttttttttgcggggtgggcacatttataaatttatgtcttgctttttggcagctacgggaagggcagagagcttttcttcttcttttttttttttttttttttgagacggaatcttgctcttgttgcccaggctggagtgcaatggtgcaatctcagctcactgcaacctccacctctcgggttcaagcagttcgcctgcctcagcctcccgagtagctgggattacagacctgtgccaccacgcccggcacatatttgtatttttagtagagatgggttttcaccatgttggccaggcgggtctctaactcctgacttcctgatccacccgcctcggcctcccaaagtgctgggattacaggcgtgagccaccacacctggcctgtgcctgttcttatactgtccctggccaagcctctcatacatcatgagccactgcgcctggcctgcttttctttctttttctttctttctttctttttttttttttttttgagatgagttttgctcttgttgcccacgctggagtgcaatggtgctatctcggctcactgcaaccttctcctccagggttcaagcgattctcctacctcagcctctcgagtagctgggattacaggcacgtgccaccacgcccggctaattttgtatttttagtagagacgggattactccatgttggtcaggctggtctcaaactcctgacctcaggtgatccacccgccttggtctcccaaagtgctgggattacaggtgggagccaccgaccctggcagagagagcttttcttctatctgcttcttctcagttgctttcagctcaacaggatcctcattgcaaagtggcatgttttgggctattgtatctgtcaaccttcagaggaatctgagaggcggggcccagaacaggtgggtgggattcgggagggaaagtggatttgctcaggtacaggggtagggagcgctgtcccgtcttcaagatgtcatcccctgccttgctggaatcttccccacactgttcctgactcaggggcccagtccagtcttttttttttttttctttgggacagagtcttgctctgtcacttagcctggagtgcagtgtcatgatctccacttactgcaacctctgcctccaaggttcaggcaattctcatgcctcagcctcccaagcagctgggactacaggtgtgcaccaccacgcccagctaattgttgtatttttaagtagagatggagtttcgccatgttggccaggctggtctcgaacttctgaccttagatgatctgcctgccttggcctcccaaagtgctgggattataggcatgggccactgcacctggccctggctcccatttctgagctacattgagctactgaacttctgtgccttattttccccttctgtaaaatgggaataacaaattcttgacctcagtcttcttctaagtattaaataatttttttttttatttttaaatttttgccaggtgcagtggctcacgcctgtaatcctaacactttgggaggcagaggcaggtggatcacctgaagacgcaagatcgagatcagcctggccaacatggtgaaatcccgtctctactaaaaatacaaaaattagctgggtgtggtggtgcacacctgtaatcccagctacttgggaggctgaggcaggataattgcttgaacccgggaggtggaggttgcactgagctgagatcccgccactgcactccagcctgggcaatagagtgagactccatctcaaataataataataataataatagtaaataataataataatttttcaagaatagagacggggtttcttcatgttgcccaggctagtctcgaactcctgagctcaagcaatccacccgcctcagcctcccaaactgatgagactacaggcatcagccaccatgcctggctttaagtattaagtaatatctgtaatgcacttctcaggcagcctgcctggcacacaagaacccattcatgtgtccctttgtaaattccataaccagctcctccaacctgtgagaaaacttgccaaccgtactctcaaagcagatatgttgggttttcctggcatcttgtgagcacactttattgtaaaaaaacaaaaacagaatgcctctgctatgttacatactgatatgacatttcttcttcttctttttttttttttttgagacagagggactcacactctgttgcccaggctggagtgcagtggtacaatctccgctcactacaatctctgcctcctaggttcaagtgattctcctgcctcagcctctcgagtagctggtattacaggcgtgcatcaccacgcccggctaattttttgtatttttagtagagacagggtctcaccaggttgtccatcctggtctcgaactcctgacttcaggtgatccacccgcctcagcctcccaagggctgggattacaggcatgagccaccatgcccggccttgtttcttcattcttttaaatgttgaggcatgatttactcataaaatgcgtgcacacattttaagtgtacagttcatgattcatttttttttttttttgacacagggtctctctctgctgcccaggctggagtgcagtggcgtgatctccgctcaccacagccttcacctcccaggttcaagcgattcttctgcctcagcctccccagtagctggaactacaggcatgcccccaccatgctcagctaatttctgtatttttaatagagatggggtttcaccatgttggccactctggtctcgaactcctgaccgcaaatgacctgcccgcctcagcctcccacagtgctgggatctcaggcataagccaccacgctctgccatgactcttgagaaatatgagcattcatctaactgtcatatgtggagcatgtccaggacccaagggtgtttcctccagctcctttgctatctctcttctcccaccctcttcccctgggcaacctctgttctgatttctatcactatggctcagttttgcctgtcctaaaactttatttatttatttatttattttgaggcagagtctcactctgtcacctaggctggagtgcagtggcactatctcagctcactgcaacctccgcctcccaggttcaagcaattctcctgcctcagcctcctgagcagctgggattacaggtacgcgtcacaatgcctagctattttttgtatcttttggtagagaccgggtttcaccatgttggccatgctggtctctaactcctgagctcaagtgacccacccaccttggcctctcaaaatgctgggattacaggcatgagccactgtgcctgcccttatttatttttttgagataggatctcactgtctcactatctgcccaggctggagtgcagtggcatgacctcgacttactgcaacctctgcctcccgggttcaagccgttctcatgcctcagcctccaggatagttgggattacaggcatgtgccaccacgcccagctaatttttgtatttttagtagatacggggtttctccctgttggccagcctggtctcggactcctgacctcaggtgatccgcccgccttggtctctcaaagtgctgggattacagacgtgagccaccgcactaggctgaatccactcctttttattgatgagaagtttttcacagtgtacaggacagggaaggaagctggagccctctcctgtaacaagaggcaggttaaatagggaaaaacaacacaagttgattaagatgtttaccttatgtatacgtgggggaagcccagagaaaaggggaaatctccaagaagtggctttgctttgttggcttaaatactatcttcaactaacatgaagaagggggtgggggtgggggtggggggggccgggcgcggtggctcaggcccctagtccctgcactttgggagatggaggcgagcagatcacctgatgtcaggggttcaagaccagcttggccaacatggtgaaactccgtcactactaaaaatacaaaaattagccaggcatggtggcgggcacctgtaatcccagttacttgggaggctgaggcaggagaattgcttgaacccaggaggcagagacagtgagccgagatcaagccactgcactccagcctggcgacagagacggactcctcaaaaaaaaaaaaaaaaaaaaaaaaagaggcatggcgcagtggctcacgcctgtaatcctagcactttgggaggccgaggcgggtggatcacctgaggtcaggagcctggccaacatggcgaaactctgtctctactaaaaatacaaaaattagccgggtgtggtggtgggcgcctataatcccagctactcggaaggctgaggcaggagaattgcttgaacctgggaggtggggcggaggttgcagtgagtcgagatcacgccactgcactctagcttgggagacagagcaggattccttctcaaaaaaaaaaaaaaaaagaaagaaaaaaaagaaagaaaggtgtgtggaagtggagggcagctatggagcgatgaccagaaaaagctcagcaaacaagggtttgttatgcagattgcaactgatgctttctccattgataagagtttctagtaatttagagtcattcttctcttcctgatatggagagggagatactctttcaaatggaggtttcctttagagatgcaaattttccttacaaaagagtaactcctactctgtttttagagctcctcttgtgtctgcagtttctcaaaataatcagctctaaataatccttatgccaatgaggcatattttggggtggcatattctggtctcccgcagtcttattttggggtggcgtatttctggcctcccgcaagttttccacgctgtacagataaaccacgatttgtttatccattctcctgttgatggacatccggattctttccagtttggggctcttatgcacacagcagtgatgaatattcaggtaaaagtcctgtgtagccacatggtatcaattctcatataaatatctaggagtgagattggtgagtcttacggtaagtgtgtgtattggaaattgacaaactatttccaaagaggttgtactatattgcatactcaccagcaaattatgaatgttctatttgctcctaatcctctacaacacttgatactgtaaatctgttttttgttttttgtttttcagtcagaatctcccactgtcacctaggctggagtacagtggcacagtcttggctcactgcagcttcaaccttcagggctcaagtgatcctcccaccacagcctccagagcagctgggactacaggtgtgcaccactatgcttggctaattttgtttttttttaatttttaaattttttgtagagacagagtctcactgtgttgcctaggctggtcttgaactcctgggctcaagcaatcctccggccttggcctgccaaagggctgaggttacaggtgtgagtcatggtgttttggcaaaatgttttaaattataaccattctagtagaagtgattttgattttaatttgatcattgtgatttaatttgcatttccttgataactaatgatatagaacatcttttcgtgtacttatggcatactcatctactttgttttgtgaaatgtctgttcaagtgtattgcccatttaaaaaaatggggctgggtgtggtggctcatgcctataatcccagcactttgggatgccaagaagggaggatcacttgagaccaggagttccagaccagcctaggcaacatagtgagacctagtctctgcaaaacatttaaaaattagccaggcatggtggtggtcgtctgtagtctcagctactcaagaggctgagttcataggattgttttagcccaggaactcaaggctgcagtgacctatgattgcaccactgtagtctagcctgggcaacagagcaagaccctcatttctttttttctttttttcggacatggagtctcactctgtcacatgatcatagctcactgtggccttgacctcctgggctcaagcaaacctcccaccacagcctccctagaagctgggatttcaggcatgtgccaccacacccagctaatttttgtattttttataaagatgtgactttggcatgttgcccacactggtctcaaactcctgggctcaagcaatcctcaccttcccaaagtgctgggattatacgtgtgagccactgtgcctggtggagacactatttttttaaaaagagaattcggccaggcatggtggctcacacctgtaatcccagcactttgggaggccgagatgggcagatcacaaggtcaggagttcaagcccagaccagcctgaccatgatggtgaaaccctgtctctactaaaaatacaaaaactagccaggcatggtggcgcatgcctgtagttccagctacttgggaggctgaggcagaagaactgctggaacccaagaggcagaggttgcagtgagccgacatcgtgccactgcactccagcctgggcaacagagggaaactccgtctcaaaaaaaaaaaaaaaaattctgtttttgtgtaaggtgtgaaataagagtccaggttaattattttactttattattattattattattattattattttgagacggagtctagctctgtcgcccaggctggagtgcagtggcacaatctcagctcactgcaagctccgcctcccgggttcacaccattctcctgcctcagcctcccgagtagctgggactacaggcgcttgccaccacgcctggctaatttttatatcttttgtagagacagggtttccccacaatggccaagctggtgttgaactcctgacctcaggtgattcacctgcctcggcctctcaaagtgctgggattacaggcgtgagccaccgcgcccggccaaggcattttttttttctttgagacagagtctctctctgttgcccaggctggagtgcagtggcatgatctccacgtcccgggatcaagcaattcttttgcctcagcacccccatgtagctgggactacaggcatacatcactacacctggctaatttttgtattttcactagagacgggggtttcacggggttggccaggctgatcttgaactcctgacctcaagggatccactggccttggcctcccgaagtgctgggattacaggcctgagccacagcacttggcccgtttaaggcattctaagtcacagcatgagataggagattggcacaagatacaggtcataaagaccttactgataaaacaggtttgcagtaaagaagccagctaaaacccaccaaaaccaagatggcgataagaatgacctctggtcgtcctcactgctacactcccaccagtgacctgacagtttacaaatgccatggcaacgacaggcagttactgtataaagtctaaaaaggagaaacatgaataatccacctcttgtttagcacataattaataaataaccatcaaaatgggcaaccagcaaccctcagggctgctttgcctgtggagtacctattctttgttcctttacttttctaataaatttgctttcattttactgtacggactcgccctgaattctttcttgggagagatccaggaacttggggtctgcatcaggacccctttctggtaacaagaactttggtcaaatattattctgaggccgggcgtggtggctcatgcctgtaatcctagcactttgggaggctgaggcaggtggatcacctgaggtcagaagttcaagaccagcctggtgaacatggtgaaacctcatctctactaaatatacaaaaattagccaggcatggtggcgggcgcctgtaatcccagctactcaggaggctgaggcaggagaatggcgtgaacctgggaggcagagcttgcagtgagccgagatcatgccaccgcactccagcctgggcgacagagcgagactgcgtcttaaaaaaaaaaaaaattttttttaaattagccaactctggtcatgtgtgcctgtggtcactacagtctctgggattgtaggacacaccaacacgccctgttaatttttttttttttttttgtagagatggggtctggcgatgttgcccaggccagtcttgaactcctggcctcaactgatcctcctgctgtcatggccacctgaagtgttgcgattacagatgtgagccaccatgtctgctggcacaaattttattatatgttaggatctataacaatatcccttcattcctgatattaggaatttgtgtttttactttttaatttttttatatttatttatttatttatttttgaggcgaagtctcgctcttgtcccccaggctggagtgcaatggcgcaatctcggctcactgcaacccccgcctcctgggttcaagccattctcctgcctcagtttcccaagcagctgggactacatgtgcatgccgccatgcccagctaatttttgtattttcagtacagacgggatttcaccatattggccaggctggtctcgaactcctgacttgtgatccacccgcctcagcctcctaaagtgctgggattacaggcgtgtgccaccatgccgggcctacttttaattttttttatttttgttttttgagacagagtgttgctctgtcacccaggctgtagtgcaatggtgcaattttgccccactgcaacctccacctcccaggttcaagcgattcactagcgtcagtctctgagtagctggaattataggcatgtgtcaccacgcctggctaattcacttttgtattcttgattagtcttgcttgaggtttatcaattttgtgaatcttttcaaataaccaacttttgtgggttggttggtttgtttgttttgagacagagtctcactctgtcacccaggctggaatgtagtggcaggacctcagctcactgcaacctctgcctcttaggttcaagtggttctcctgcctcagcctcccaagtagctgggattacaagcatgagccacctcacctggcccaacttttgtttttgataatttttttctattttcttcttttttctaattcattgatttctgatctttattctttctttctttctttttttttttttgagatggagtgtcgctctgttgcccaggctggagtgtagtggcgtgatctcggctcactgcaacctccacctcccgggttccagcgattctcccgcctcagcctcccgagtagctgggactacaggtgcgcatcacggagccccgctaatttttgtattttttagtagagagggagtttcaccatattggccgggctggtcttgaactccgcccacctcggcctcccaaagagctaggattacaggcatgagccaccgcgcccagccttattgtttcttttcttctacttactttgggtttaattttctgttgttctcttaggttctttatataaccatctccaatataaccattctttgctattataaccattgcaagctatatattttcttctacttactttgggtttaattttctattgttctcttagattcttaatataaccatctccaatgtaaccattctttgctattataaccattgaaagctatacattttccaggctgggtggggcggctcatgcctctaattccagcactttgggagcctgcggtgagaggattacttgagtttaagagttcagggctgggcgtggtggctcttgcctgtaatcccaatactttgggaggccgaggcaagcggatcacctgaggtcaggagttcaagaccagcctggccaacatggtgaaacccgtctctactaaaaatagaaaaaattagctgggcatggtggcatgtgcctgtaatcccagctacttgggaggctgaggcagaagaatcgcttgaacctgggaggcggaggttgcagtgagccgagatcgcaccattgcactccagcctgggcaaaaagagcaaagatctgtctccaaaaaaataaaagaaacagttcaaaaccaggctgtccaacatagtggggccccatctctacaaacacacaaaaaaattaatacagtagctggacatggtggcacatgcctgcagtcccaactactcaggaggctgaggtgggagggctactggagcctaggatgttgaggcagcagaggcctgtgattgtgtaattgcagcactctagcttgagtgacagagcaagagagaatctgcgattacaggtgtgagtcactatgcccagcctgtttcacttataccctgcagaagatgctatctggaggcctggcgtcatcttcccccatgcatgttcagccagcccttagtcaaggacttttagtggacattcctcctctcccctgccagacctcggggcctccttctgcacagactcctcctctctggcaccatgtcccaccatttctagccatttccactgccccaaatgctaactccaccttctcagctcagcaggacactaagttctgcctggactccagctcaccgtgcagtgattacaaaactgtccccaggaagagggtagggagaggggcagagggtgaagtctcaccttgtgagtttccctccactcgggggtcataggcttgtgctgcctgtggttcagtgcctgaagactggcattcacggcttttgtccagtttagtttaatggtttcttaagatgagagggcttgtggggtaccagttacagcatggctgtaagtgaaggtcaccctcctcactaagatgatgtttcttttttttttttttcttttttgacagagtcttgctcttgtcgcccaagctggagtgcagtggcgtgatctcggctcactgcaacctccgcctcatgggttcaagctattctcctgtctcagcctcctgagtatctgggattacaggcacacgccaccatgcctggctaattttttgtattattgtagagacgaagtttcaccatgttgtccaggctagtctcgaattcctgatctcaggtgatctgcctgccgctgcctcccaaagtgctgggattatcagtgtgagacaccgtgtctggcaactgatgtttcttgaaagtctgttgtaaacttttttgtttttgagacaaggtctcactccctcaggctggagtgcagtggcacaatctcggctcactgcaacctctgcttccgcttcccccgttcaagcgattctcttgcctcagcctcctgagtagctgggaccagaagtagtgatggggtttcaccatgttggccaggctggtctcaaactcctgacctcaaatcatctgcccacttcggcctcccaaagtgctgggattacaggtgtgagatatcacgccctgctgtctcttgtaaatattaaaataatacagaggatcactgaagggaaagtagaaaaatacagaaaaggttgactgggcacggtggctcacacctgtaatcccagcactttgggaggctgaggcaggtggatcacgaggtcaagatatcgagaccatcctggccaatatggtgaaaccccatctctactaaaaaatacaaaaactagctgggcgtggtggtgtgtgcctgtagtcccagctgctcagtaggctgaggcaggagaatcgcttgaactcaggaggtggaggtggcagtgagccaagattgccctactgcactccagcctgggtgacagagtgagactccgtctcaaaaaaaaaaaaaaaaaaaattacagaaaaggaggttgagggagaagaaaggttgtccattgacgcttcactttgtaaattattttttccatttatagcagcactttctaggagccttcaaacctaagtgttgtatttcaccacaaggggctctagtgagctgaagctgataaaagatcctgaagttggaatggccaggatctcagcagatactaatggaagtttttctgatcaatgaacaacaggaccaactgtgttcagacctgtggacccattcgttcctctcccgggcactggttttccaggcctcattcgcagagtgcaactgactcccttttcagccttgaaacccgctgactctgccctcaggaaccgcagttgtgtttctctgctgctctgcatttccttgcagggcctgagcatggactcagcgtgggcatgttttgctttggtggccttgatttttcttgttttttaggacggggtcttgctctgtcgcccaggctggaatgcagtggtgtgatctcggctcactgcaacctccacgtcctgggttcaagtgattctcctgcttctgtctcccgagtagctgggataacaggcatgcaccaacacaccgggctaatttttgtattttttagtagagacagggtttctttttcttttttcttttttctttttttttttttgagacagagtttcgttcctgttgcccaggctggagtgcagtggcatgatcttggctcactacaaccttcacctcctgggttcaagcgattctcctgcctcagcctcccgagtagctgggattacaggcatgcaccaccatgcccagctaatctttgtatttttagtagagacagggtttcaccatgttggccaggttggtctcgaactgctgacctcatgtgatcagcccgcctcagccttccaaagtgctgggattacaggcatgagccaccgtgcctggccttgtgctttttctttttctttcttttttttggggtgggggaggggatggagttttgctcttgttgcccaggcttgagtgcaatggcaggatttcagctcactgcaacctccgcctcctgggttcaagcaattctcctgcctcagctcccaagtagctgggactataggcgcgtaccaccacgcccggctaatttctgtattttttagtagagatggggtttcaccatattggccaggctggtcttgaactcctgaccttgtgatccgcctgcctcggactcccaaaatgctgggattacaggcgtgagccactgcacccggcgaaaaacccactttatttattttatttatttattttttgaggcggagtttcgctcttgttgcccaggctggagtgcaatggcacgatctcggctcaccgcaaactctgcctcccaggttcaagcgattctcttgcctcaacctccctagtagctgggattacaggcatgtgccaccacgcccggctaattttgtatttttagtagagatggggtttcttcatgttggtcaggctggtctcgaactcctgatctcagatgatccgcccgcctcgacctcccaaagtgctgggattacaggcatgagccaccgtgcccagccaaaaacccactttaactactgtgaatcagactgtgtattcagagcagcctgaaatctatgctcctgggtggccatcctgaagctctgagttggaataaactctgtacttaatcacagtttccgaattttgttatatatggttgacagcactattttttttttcttttttgagatggagtctcgatctgtcgtccaggctagagtgcaatgagactatcttcctcactgcaacctccgcctcccgggttcaggcaggtggatcacttgaggccaggaattcgataccagcctggccaatatggcaaaaccctgtctctactaaaaatacagaaattagccaggcatggtggcaggcacctgtaatcccagctacgtgggaggcagaggcaggagaatcgcttgaacccagaaggcagaggttgcagtgagccaagattgtgcctctgcactccagcctgggcgacagagcaagactccgtctcaaaaaaaaaaaagaaaaaaacaaaaaacaaccatgatgatgtgtgctactaaaggggaaaagttgcattggaaacttgttaaaaatggcaaagcaagactttattcaagtctattacagtggtggagagagattgaactcaactatgaatacagcacagacagctggggatttatagccatagcggtggaaaattttttttctaactagccttcataggttctatggctggggccttgtatatggggctgacaaaagacagattaacagagaaaaacaaacagatggttttgttaacatgagcattacacatacacgtgggaaaacccagagataagtaactcaggagggcaatcagaacggggaggccaggcgtggtggctcatacctgtaattccaaagctttgggaggccgaagagggtggatcactttgccccaggagtttgagacgagcctggggaacatggtgaaatcctgtctctacaaaaaatacaaaaattagccaggcatggtggcaccaccatgcctgtagtcccagctactcaggctgaggtgggaggatcacttgagcccaggaggtggaggttgcagtgagccaagatcatgctactgcatccagcctcggggacagagtgagtccctgtctgaaaaaagaaaaaaaaagaaaaagaaaaaaaaaaaaagaactggggcttatatagcagcttaacaaaagagtaatacttttttttgtttgtttgtttgtttgagacggagtttcactcttattgctcaggttggagtgcaatggtgtggtctcagctcactgcaacgtctgcctcccgggctcaagtgattctcctgcctcagcttccccagtagttgggattacaggcacctgccaccatgtccagctgatttttgtatttttagtaaagacggggtttcaccatgttggccaggctggtcttgaactcctgacctcaggggatctgcccacctcaactttccaaagtgctgggattacaggcatgagccaccactcctggtcaagagtaatacatttttattttatttatttatttttttgagacagagtctcgctctgtcacagtgcagtggcgcaatcttggctcactgcaacctctgcctcccaggttcaagcgagtcttctgcctcagcctcctgagtggctgggactacaggcgcacaccaccacgcccggctaatttttgtacttttagtagagatggggtttcaccatattggccaggctggtcttgaactcctgacctcgtgatccgcccgcctcagcctcccaaagtgctgggattacaggcgtgagccaccatgcccggcgagtaatacatttttaaagaagtatttttagacaagatgaagggaaagaactttgagtttctagtgcagcaaatcatgagagggtcatatatgggggaatgaatggaagatgagggctagttggtcgagttggttatgtagactcctccagtgccattccaggcggataagaatctacagctgtctctgggattaacttcagtcctttctagtggtcttgaagtggataccttagtaaacttatttatctatttatttatttagagacggagtcttcttgctctgtcacctagcctggaatgcagtggtgcgatctcagctcactgcaacctctgtccctcaggttcaagcgattctcctgctgcagcctcctgagtagccggtactactggtgcacgccaccatgcctggcaaatttttttagttttagtagagacggggtttcaccatgttggtcaggctggtctcgaactcctgacctaaggtgatccacccggcttggcctcccaaagtgctaggattacaggcgtgagccaccgtgcctggccacctttgtaaatttacatcttgctttttgtcaactaggggaagggcagagagcttttcttgtatctgcttcttcttaattggcttcagctcaacatgatccttatgccaaagttgcatgttttggcgtgacatattttgccactctacctagccaaggggcagagtgagggaggtgaataattttattttaacagtgcccctgtcaggaggggaagcaagggctcacctgatttattcatgatgtttattcactcccagagcccagatctgggagatagacctggcactttttttatttttttgagacagagtttcgcttttgttgtcttggctggggtgcaatggctcgatctcagctcaccacaacctctgccttctgggttcaagcgattctcctgcctcagcctcccgagtagctgggattacaagcatgggccaccatgcccagttaatttttttgtatttttagtagagacggggtttctccatgttcatcatgctagtctcgaactcccgacctcaggtgatccgcccgcctcggactcccaaagtgctgggattacaggtgtgagccaccgggcccgtccagacctggcacatttttttgcaaattagggaaagggtggtgatatggtttggctgtgtccccactcaaatctcatcttgaattgtagttcccataatccccacatgttgtgggagggaccaggtggaggtaattgaatcatgggggtggtttcccccatgctgttctcgtgataatgagtgagtctcaggaggtctgatggttttgtaagtgtctagcatttctcctgctggcattccttctctctcctgccgccttgtgtttttttgagacagagtctcggtctgtcacccaggctggagtgcaatggcatgatctcggctcactgcaacctccgcctcccgggtttaggcaattatcctgcctcagcctcccgagtagctgaaattacaggcgcccgccaccacgcctggctaatttttgtatttttggtagagacgtggtttcaccatgttgaccccaggctggtctcttggccaggctcgtcttgaactcctgacctcatgatccgcccacctcagcctcccaaagtgctgggattacaggtgtgagccaccgcgctcagccttttgttttgttttgagagggagtcttgctctgtcactcaggctggagtgcagtggcttgatctcagctcactgcaacctctgcctcccgggttcaagcgattctcctgcctcagctcccaagtagctgggattacaggcgctcacccccacgcccgactaatttttgtatttttcagtagagactgggtttcacatattggccaggttggtcttgaacccctgacctcgtgatccgcctgcctcagcctcccaaaatgctgggagatctgtatttttttttttgagacggaatttcgctctcattgcccaggctggagtgcaaatggcacgatctcggctcaccgcaatttccgcctcccaggttcaagcgattctcctgcctcagcctcctgagtagctgggattagaggcatgcgccaccacgcctggctaattttgtatttttagtagagacagggtttcaccatgttggccaggctggtctcaaactccctacctcaagtgatccaccctcctcagcatcccaaagtgctgggattacaagtgtgagccactgcgcccagcctctcctgccgccctgtgaagaagcacgtgtctgcttcctcttccgccgtgattgtaagtttcctgcggcctttccagacatgtggaactgagtcagttgaacctcttttctttataaattacccagtcttgagtatttcttcatagcagcatgagaacagactaatacaggtggccccatttgtaaattattttgatgggagggggctgggacctggaggcgggaggaggggcaggtgaggggcaaaatgaaaaggaaagcactttttcagagttagggcaaatgtctcagaattaattgaaccttgttttccttttttttttttttttgagatgaaatctcactctgtcacccaggctggagtgcagtggtggaatcttggctcactgcaacctctgcctccctggctcaagtgatcctcccacctcagcctcccaagtaggtgggaccacagatgtgtgccaccatgccaggctaattcttttttttttgagacagagttttgctctgtcgccaggctggagtgtagtggcatgatcttggctcactgccacctccgcctcccgggttcaagcaattctgttgcctcagcctcctgagtagttaggactacaggcgagtgccaccactcccagctaatttttgtatttttagtagagatggggtttcaccatattgtccaggattgtctccatctcttgacctcaagatctgctcgcctcgcctcccaaagtgttgggattacaggcgtgagccactgcacgcagcctaattctttttttgtagagacagagtttcaccatattgcccagtctgatcttgaactcctgaactcaagcaatcctgtcttggcctcccaaagtgctaggattacaggcatgagccactgtgcccagttgaccttattttccataggcacatgctccagcatgacgttttccaaaagccacttgctggaagtacagatattcctctgatggctttaggcactgggaatacagcagtgaccaattccaataaagatcctgccctcccagggcttccattctaatgtggggaagcagtcattgaacaaaacagagaatgaacggtggggtctgggagggaagacctccattgcagagaaaggttgcaactgcaggtgtggatgtgggcagagaagatttcactgggaaagaagcattcaggaggccagcaggtgcaaaggctctggggcaggagtgtgcctattgtgttgaggctacacaggcaagggagctggtgtgactggagtggagtgaggagagaagtgatggggaggagatgaagagggagaggtaaggggtgcagggtgcaggagcttttacctgtggaatgcactgaatggaggggacatgacttgtcttatttattattgattgattgatcgagacagagtctcgctgtgtagcccagctggagtgcaatggcacaatctcggctcactgcaacctccatctcctgggttcaagcgattctcctgccttagcctcccaagtagctgggactacaggtgcctgccaccatgcccggctaattttttttttttttttttgagacagagtctcactccatcgccagactggagtgcaatggtgcaatctcagctcactgcaacctctgcctcccgggttcaagtgattcttctgcctcagcctcccgagtagctgggactacaggcacctgccaccacgcccggctaattttttgtatttttagtagaaacggggtttcaccatgttggccaggatggtctcgatctcttgacttcgtgatctacccgcctcggcctcccaaagtgctgggattacaggcgtaagccaccgtgctcggcccatctggctaattttttttttttttttttttttttttgagacggagtctcactctgtcacccaggctggagtgcagtggcgtgatctcagctcactgcaaactctgcctcccgggttcatgtcattctcctgcctcagcctcccgagtagctgggactacaggcgcctgccaccacgcccggctaatttttttctattttcagtagagacggggtttcactgtgttagccaggatggtctcgaactcctgaccttgtgatcctcccgcctcggcctcccaaagtgctaggattacaggcgtgagccaccacgcccggcctccatctggctaatttttgtatttttagtagagatggggttttgctgtgttggccacactggtctcaaactcctgacttgtgatctgcctgccttggcctcccaaagtgctgggatttcaggcgtgagccgccgtgcgtggccgacttatcttattttttaatggaatgccgtgcttgctatgtcgagaaggaacgatggtatgctgtgcttgccccctgctggtagcagggaggtgggttggcgaccactgtgaaaatccaagggagaggtgagcacggtttgctcaggatgttggcaggaaggcaaggtggtcaaacatggttgcatttgagatctattttgaaggaggagccattaggattcactggttgttgggtgtggatttaccctaagctgctggaagcctggagtcatggccattaatggagagaagaagatggatggaccaatggtgtggggagcaggtgggagtgtgcagttgggagctatgtccaggacacatggacacaagatgctgtcagcatcctggtggaggtgctgcataagcagttggctctctgaatctggagagatctggcctggagatagaaatacgagagtctggccgggcgtggtggctcatgtctgtaatcccagcactttgggaggccagggcaggcagatcacaaggccaagagatcgagaccatcctggccaacatggtgaagccccatctctactaaaaatacaaaaagtagccaggcgcggtggtgcgtgcctgtaataccagttacttgggaggctgagacaggagaatcgcttgaaccggggaggcagaggttgcagtgagccaagatcacaccactgcactccatccagcctggccatgaagcgagactccgtctcaaaaaaaaaaaaagaaaagaaaagaaaaaaagaaatatgggagtctatccacctcagggaggcagaccacataaagccttgaagtgcatgggatcctcagagaggtagaatccctggcactggaaggcctcctgcagctcctccaatccaaggctcacatttcacaggggggaaaaaaagtattaatagaagcccagagaggggaggttatttattgctctagatcaggagtccccaacccctgggttacagagcattacctgtctgtggcctgttaggaacctggccgcacagcaggaggtgagcggttggctctagcgaagctgagctcgtcctcctatcagatcaacggcagcattagattctcacaggagcgtgaaccctattgtgaactgcacatgtgagggatctaggttgctcactccttatgagaatctaatgataaatgtcaagcgcttgaatcgtccagaagccatcctttcttcctcccccgactcagtctgtggaaaaattatcctccacgaaaccggttcctggtgccaaaaacactggggaccgccgctatatgtttcgtccctgcaaaattcgtatgttgaaacgtaccccacaatgtgacggtattagaaggtgtggctttgggagatgattatgtcacagccctcatgaatgagatcagtgcccttataagagaactttgctgctcccaagagcttgctcacccttctgccatgtgaggacacacagaggaagcgccatctatcaaccagaagaggggcccttggcagacaccgaacctaccaatgccttgatcttggacttttcagctgccggaacagtgagaaataaatttctgttgtctatggtattttgttatagcagagtcgattataactgagctgattaagatgctggtcccaggtcacgtatctgggtgatgacaaagttaggaataagacgttgttggcaagaccagcacccattcccacacccagtttgttattgcttttctttttttttttctttttgagacaaggtctagctcttacgcccagactggagtgtagtggcaagatcttggctcactgcaacctctgccttccaggctcaagctgtccccaccgcaaactcctgagtagttgggactacaggcgtgcaccaccacactaggctgatttttgctttttttttttttgaaacgaagtctcacgctgtcacccaggctcgagatcagtggcgcaatcttggctcactgcaacctccacctcctgggttcaagcgattctcctgcctcagcctcccgagtagctggccttacaggcgcaagctgccatgcccagctaattttttgtatttttggtagagatggggtttcaccgtgttgcccagatgggtctcaaactcctgagctcaggcaatctgcccgtcttggcctccttggcctcgcaaagtgctgggattacaggcatgagccaccccacctggcctttctttcttttttttttggagatggagtttcactcttgttgcccaggctggagtgcagtggtgtgatcttggctcgctgcaacctccacctcccaggttcaagtgattcttctgtctcagcctcccaagtagctgggattataggcgcatgccaccatgccttgctaacttttgtatttttagtagagacggggtttcgccatgttggctaggctggtctcgaactcctgacctcaggtgatccacccacctcggcctcccaaagtgctgggattacaggcatgagccaccacgcccggcctaggctaggggtttttcagatagtttggtgggcagggagccagggtagggaatgtgctgattggttgggttgaagatgaactcacagggaatgaaagctgttctcttgtgctgagtcacttcctgggtggggaccacagactagttggagggtccaggtggggccagctggttgtcagaaatgtaaaaacttgaaaagacatttgaaaagatcaatggggctggccgcggaggctcacgcctgtaatcccagcactttgggaggccgaggcgggtggatcacctgaggttgggagtttgagaacagcctgaccaacatggagaaaccccatctctagtaaaattataaaattagccgggcatggtggcacatgcctatagccccagctactcaggaggctgaggcaggagaattgcttgaacccagcaggtggaggttgcagcaagccgagatcgcaccactacactccagcctgggaaacaagagtgaaactccgtctcaaaaaaaaaaaaaagaagaaaaggtcaatggtaggttctaccatagtgatgttctctgcaagagtaattggggaagttgcaaaccttaggacctctgaaataatggctgagaattatttagaattctggcacctctcagcctcctaactcggtggcttttttttttttttttttttttgaaacagggtcttgctctgtcgcccaggctggagtgcagtggcctgatcttggcttgctgcaacctctgcctcctgggttcaagcaattctcctgcctcaggctcctgagtagctgggactacaggggcccaccaccatgcctggctaatttttgtattttttagtagagacagggtttcgccatgttgcccaggctggtctcgaactcctgacctcaggtgatctacctgcctcggcctccctaagtgctgggattacaggtatgggccactgtgcccggccaggaggttgtttagccgcatccctggcttcatactagatgccgaagcacctacctcttccagttacaaaaataaaaaatatttcctggacattgacagatgttccctgggggccaaatcaccatccctctcccagttaagaatcactgagttactggaaagaattgttttcagctgtggtggtcagagctggggtgctggcatggggcctgtataggggaaggtggccagaaccagatgtgtagctttgattgtaacactcaagccgactttacagccatgtgtgttttatatctccatggggcctcagagactgacttcttcaccctaccgcatttgtaaactgtcctggggatgggggaggattctgaggagagcatttccaggctcgcttgcgtacagtgaaaagtgatgacagtaagtgatgtcttggttaatgaagaaaggtctcattctatggagggaaagagaagggtgaatctgggattggatcctgtcccaggtctacatgactgtgtgacctcaggcaagtgacttggtttctctgggttaggaggatcaaatgtacccagagatgggaaggtgcctagtagagtgtatggcctgcaattggcctgcctagtaaatgcaaattcgtcattgctaccctggaccatgattctgggcacaattgcagcaaaagtttcctaatagcctcatgatgttgagctttctggaaaaacaaaaccaaatgtgaagatcatctgtccacccagtggtcaggtggtgtttgtttccagaaagtacaaaaatcaaaaggttagaagggagtctgagaggtcatttaatagctttttgctttgtgctgaactggctcaaatgttcttagaaaatttgatgtttctcctggggttgatttaaagaaaaacacaaacgtacagatgtacacacacatgttggcttttgcagaaaggaggtttaactactaaattctgtgggttttattttttatttttttggagatggagtctcgcacagtcacccaggctggagtacagtggcgcaatctctgctcactgcaacctgcaacctccgcctcccgggttcaagcgatcctcagcctcccgagtagctgggattacaggcacccgccaccacgctcagctatatttttgtattcttggtagagacggggtttcactatgttggccaggctggtcttgaactcctgaccttgtgatccgcccaccttggcctccaatgtgctgggattataggcgtgagccaccacatccagctgttttgttttgagacagggtcttgctctgtcaccaggctggagtgcagtggcgcaatctccgctcactgcaacctttgtctcctgggttcaagtggttttcctgcctcagctttctgagtagctgggattacaggactgcaccaccatgcctggctaaattttgtacagacagggttttgccacgttggccaggctggtcttgaactcctggtctcaagtgagccgcccaccttggtttccctaagtgctgggattacaggcatgcaccacttcgcccggcctaaattgtgtgttcttgatttctagtgctgaaaacacctttgtaaactatgcagtggccgggcgctgtggctcacgcctgtaatcccagcactttgggaggctgaggcaggcggatcacctgaggtcaggagtttgagaccagcctcaacatggagaaaccccgtctctactaagtacaaaattagccgggcgaggtggtgcatgcctgtaatctcagcttctcaggaggctgaggcaggagaattgcttgaacctgggaggcagaggctgtggtgagccgagatcgtgccattgcactccagcctgggcaacaagagcgaaactccgtcccaaaacaaaacaaaacaaaacaaaacaaaacaaaacaaaacaaaacaaaaactctgcagtaagagaactgacatggctgactccatcttgcttctagcctcagaggttgcctgcctttgctcatttctggccgtgggccaagctaactttgggagaaatttaccttttagtttaaatgataacagcccttcccccaaaactgttcacataaaactaatgaaaagccaccaaattaggagaatgagaggggcctgaattaataataattcccagccgttattccagaggttctaagatttgcaacttccctaattactcttgcagagaacatcactatggtagaacctaagattggtcttttgagatgtcttttcaagtttttgcatttcttttttttttgagacagagtctcgctctgtcacccaggctggagtgcaatctttgctctctacaacctccacctcctgagttcaggtgattctcctgcctcagcctcccgactacctggggttacaggcatccactaccatgcccagtgaatttttttgttttgagacagagttttactttgctgcccaggctgagtgcattggcaagaactcggctcactgcaacctccacctcccaggttcaagcaattctcgtgcctcagcctccttagtagctggattacaggcacctaccaccacgcccagctgatttttagttctttttagtacagacagggtttcaccaccttgcccaggctggtctcaaactcctgagctcaggcaatctgcccgtcttggcctcccagagtgctaggattacaggcatgagctgctgcgcctggccttttttgtttttgtttttgttttttgaggtggagtctctctctgttgcccaggctggagtgccatggcatgatctcggctcactgtaacctctgtctcccaagttcaagtgattctcctgcctcagcctcccaagtagctgggactacaggcgtccatcatcatacttggctaattttgtatttgtaatagagacgaggtttcaccatgttggccaggctggtgtccaactcctgatctcaggtgatccatccgcctccacctcccagtgttgggattacaggtgtgagtcactgtgcccagcccatgcgaatattcttaattcatggcaattgttttacttgcctgctttccagctaggtaaggcctggggacatgtggaattggcaatgccctagctatgctgaaaacagtcaaatcttatcagaacataacttaccaggttttacattacagttaaaattgccaaagagtcaccattgtaacatgcaatcaagactactggaaatatggctgggcatggtggctcacgcctctaatcccagcagtttgggaggctgaggcaggtggatcgcctgaggttaggagttcgaaaccagcttggccaacatggtgaaaccccgtctctgctaaaaatataaggattagctgggcatgttggtacacgcctataatcccagctactggggaggctgaggcaggagaattgcttgaacccgggaggtggaagtttctgtaagctgatatcataccactgcattccagcctgggtgacagagcgagacttctgcaaatagatttacatgcaaggtgtataagaacagtaaaatgtgttgtggtttttttttttttttgtaaaaggttataagaaggcatggaaatgtaaattttgcctagggttaaatgattgttttgagttagatagaaaaagctgaaggttcaaagaagtggtagaagaattggcaaaattaatttgcagaagaggttctctgtgtgaacatattgactaaattcaaaagggttatacaaagtttttgcttctttaaaatttctgagtcatcgttttggcaaaataaagaacttacggtaatctggaattccaaaatcaaacttcagtttcaaaattgtctttcctaatgcctggctttttggatggatcagagggccactgaaaacatccagaaaggaggtaaacaggattattcaacatgtttaggtacatgagattgccaaaatgatgctcaatcttctttttttttttttaatcttccccaatttaaatcttttaatttaaaagtaaactttactgtcaaaaatgcaaacttggggagggcagaaagatcacacacaaggctgccacttcacacctggagggttgcacggcgaccaggcagaggcactcctcacttcccagacagtgcagcggccaggcagtcaatcttctttaggttatatttttgtgaatagtactaatatatattccaaaatggtatgggatttctaaaattccaatgtctaagtatatgctatcaattataattatggctattatgctaagttattgtaaaccatagaagtaaccaaatttgccaggcgctgtggctcacgcctataatcccagcactttgggaggccgaggtgggtggatcacgaggtcaggagtttgagaccagcctggccagcatagtgaaaccccatctctactaaaaatacaaaaaattagccgggcatggtggtgagtgcctgtaatcccagctacttgggaggctgaggcaggagaatcacttgaacccaagaggcagaggttgcagtgagctgagattgtaccactgcactccagcctgggcaatagagcgagactgtttcaaaaaaaaaaaaaaagacaatgaaaggtggattgggtgaattaggcagcacacccacacataaagtcataatttttctattagctcccttccctaactcttttccttcccctctgctcactctgatccagccacacctgcccccttgctgttccttggtctgtctcaccttctgtgttcagagcctttgccctctctgttccttttgcctggaaggcacttccccctgaaattccttggcttatcagagccctcatttacatttcacttctgtgggttttcttttttcttttttttgagatggggttttgctctgtcacccaggctggtgtgcagtggcaccatcacagctcacttcagccttgatgtccggggcttaagggattctcccacctcagcttttcaagtagctgggatcacaggtgtgtgctatcatgcctggctaattttttaatttttttttgtagagtgggggtctttctatgttgctcagtctggtctcaaactccttggctcaagcgctcctccctccttggcctcccaaagagttgggattacaggcatgagccactgcatctggctcttgggttttcttgatatcatgatcagggtggcctgtgacaactaccctggccaatgaagcctaaattgttttggtcccagagacttgaactgaatcaggctacctttcattcaatgcagatcacctcctccaggaagccctctcagactgcccaggctaggtcaggtgtttctccccagccctctgctgataaccctttcaaaatggttcatttcctctgaggggataagagaggggtgatgactcatccatttcagcatccccagtgccaggcaaggcccagaggaggtgctcaagaacctgctctaggccagaagcaaagggaggaaaggaaggctccttttgctggtcttttccctgctgccagcagagggcgcctccgcaccacgattctgcccaggtgggtccagcctccagtggggccacagccaacctccttgtcctcaggaggcttccggacagaggggagacctcctttgtt

SEQ ID NO: 2 - DNA, 102605 bp, Homo sapiens
ctcccttttatgagctgagagaggcagaccttagggcctcctccaatagttaatatacattttttatatttttaaaaattaacctatcatagttgtacatatttgaggggaagcatgtgatattttgatacatgtatacaacgtgtaatgatgaaatcagggtgactgagatatccatcacttcaaacatttatcttttctttgtgttggaaacattataattctcttttagctattttgaaatataccataaatcatggtaaactataatttccctactgtactattgaatactagaactcattccctctatttaactgtgtgtttttacctgttaaccaagttctcttcatcctcccctcccttcttcccttcccagcttctggtaaccaccattctactcttaatctccatgaagttcacttttttagatttcacataagagagagaaacatgtgatatttgtctttctgttcctggcttatttcacttaaataatgaccttcagttccattcatgttgctgcaaatgacaggattctgttctttttaatggctgaataatattccattgtgtatatcaaatatttcatcttaacataaagtaagctgaagtaaagataactaccctcaatcagagtctagaaacatggcgactgagatttgggggtaaggagagcagtggagggtggaaaggtgttgaggtaccctgtgctttgcccacagctggggctacacaggctgccttctctccttcctccttagggtctagcacagtcctacctggccagatgcaaggtcacattgctagcagacaccccccttcctccctcttttcttcctcttcttcacccctctcattcttcaccctagtagccactgtgggtgcccaagtcctgcctgggtcccttgtctccacctcaggtgagctggacctgctgtggaggtgagctggacctgctgtggaggtgagctttcccgctctttggtaggaaggagaaagcactgagcaaggagctgactgatgggcttagttgcgaacatgcatgctggtctcaggctagtctttctttgtcttcctttgcctgtccctgtgagccaagagccttcaccacaggtacttggggtcagctgcaggagatttcctggaactctgaacttctgggtttcagtttctctacctgtcatatgagaaggaacctgtttgagtctctctcacagcaggctggtgtctgcacggaggctctgaggagctcatggtcatgaaatctgagtgccccaaacccacagacggagacagaggcaccgcttcctggaaggcacagtgagagctgttaaaatgctaaacgaccaggtcaagcctccatatccctcgagaggcgtttatgcattttactggaacactctggcatgaagcgttccctgaaacaattaaaaagataatgtactcagcctgtgctctgtctgtctttactctttgtgctttttcatgacgttatccattcccagaactcagagagccccctctcctctttcagttgacatttgcttggctgactgactctcttactcgctgtttcctttcctttggatgattgacttttagcatcatttcaatgtctataactaaatcagcaaggcttctaggtccagcactataattctaaatttcactgctactacaaacatatcatgtctgccgactggaccaagtgattataagtcccaattaaaccctaggttttgcttttaagccagtttcaagtcaggcatttattcacagttgtctgtaatatcaggcactgtgctaggcaaatgcggcagaaagtggctgagaaatggtgctcattctcccagaattcagaaggttttggtgagacagacagataatagttaatgaatttaatgatgacaatgcagtgatgatcagtgacgagccgatgacttgataatgacaatccatgtgataaatacaatagcaatggtatcataacgtgacgggacagtgaagaggagagagtagcctaggatagggctgcacagatgaggtgatgtttgcaccaggccttagaggctaaggaatctcagcagggcaagaagaacttccagaaaggggagcatccgttcattcatggaacaaatatctatggggagtttgcagtgttgcctaaacaaaaatcaggaaacctgacgtgtgtgtttttgaaaaaaaatatttattacagaagttttttgttcttttttttttttttttttttttttttttgagacggagttttgctcttgttgcccaggatggagtgcactggtggaatctcagctcactgtaacctctgcctcctgggttcaagtgattctcctgcctcagcctcctgagtggctgggattacaggcacccaccaccacgcctggctaattttgtatttttagtagagacggggtttctccacctaggtcaggctggtcttgaattcctgacctcaggtgatccgcccgcctcggcctctcaaagtgctgggattacaggcttaagccactgcgcctggccagaaaattttaaacatacaaaagtagaaaggctagtaagataaagccccatatatacatcatccagttttaatcatggttcttgtggtctccatgcactcacccactacaattagcttctgctgtttatttcgaagcaagcctctggcatcatataatttcattcttaatgtttcactaacaggatggtttaagttgcggaaatgtcagtagcattagttggacctggaggcaagatttgttgggacagaaagaaggaagaaaagtagtgctaggactgccagtttctccccaacatccattcatgcccacctttgtatggtcacaactcctgtatcatttgggtggaaatatacctagcctgccttatagcaagttatggtcatgtgactgagttctggctaacatgatataagtgaaaattgttgagaaggacttctaggaagggcttcctaaacggggtatcaaaagtctagagaagacttctactcttgttattttttatttttgcaaaggtggatctgatggctggagccccagcagccaccgtggacctggcagtaaccctgaaaatggaaaccaagtactgaggatgatggaaaagaaagtgcctgataacttcatggaaacaccgcatcatctttgggctgcctcatccggaattttgtgtgatggaagagatcattgtgtgtttaagccactattatttgggttttctaatatatacagctaatgctaaccctaacagaagataaaatgagcctttttagataagtatgtgtcctgcactggacagagagtttctaagaaacagatagaagattctcaaaattcctagccaattgtcaaggagaaaatgaaataaccagttaatagctctctcatctcagttatttagaactggccaggatcaaggtgtcaccatttaactggtagcagctaccagtgctagtaccagcaaaggtgacgtagcatcctagaaaagtaaaagcacttttttttttgagacagagtctcgctctgtcgcccaggctggagtgcagtggcacgaacttggctcattgcaagatctgcctcctgggttcacaccattctcctgcctcagcttcccaagtaactgagactacaggcacccgccactacacctggctaattttttctatttttagtagagacggggtttcactgtgttagccgggatggtctcgatctcctgaccttgtgatccgcccgccttggcctcccagagtgctgggattacaggcgttagccaccgcgcccagccaagagtgaaagcatttttaaattttgcctctccagcttcttctactaaccaaatttcacatggtcatttactaattagactcaaaggaaaccagcagctgcctcaccagaagctaataaaatataatgcaactgttcccactgattctggactggtttgtcaatccattgaccaggtgagtctgaaccagaggtggttcccgccgcctcaaattgaaaagttatagatcaacttaatgagagctcctgtctccagttttaggtgccggctggaggaaatgaaagcttaatttgtgaggagggcaaacagccacccagtgagcatataggtggtgagaagttgccggggctcagcccaacaggggagggaacctcggcctgaatgcagggttttcatgatgcaggtcttcaccagagtgctgtccttccacttagagctcttcagacagctggttttattttgacttaagccttctgcggtgggtgattttatgtgtcagctttgctggtccatggtgcccagatatttgggcaaacttccacctggatgttgcttgtgagggtatttttttagatgagactgacatttcaatcagcagactttgagaaaagcagacacctgccataatgtgggtgggcctcaaccaatcagatgaagggcttaaagggaaagactggggtcccctgaagaggtaggaattctgcctccagactgcctttggactcaagactgcaacgtcgactcttgctggaatttccagtctgccacccctccctacagtttatgaacttaccgggccccacaagcatataagccagttctttaaaataaatctctctctatacatgtacactctatcagctccatttctctgaaaagctgtgactaatacacctttgcataagaaagaaaactaaaataatattttattgacctgattgggctctagtaggaacaggaacagacctgagaggacaggtggctgtcagtgcccacagccagtgtacagcttctgcatacagaaactcttaaaaatgcatgagtttggcacagaactctgggagcagccaattgctctgtgaccctgagcaagtcacttcccttatctaagcctcagtcttctcatctatacgatgaagataatatctgttttataaagaaatatgttcttgtgggaattggaagatataaagtttttgacacagtgcttggcacatggaaaggcttactaattcctaataattgctctgtagggatttatacttaaatgaagtttgcttcaatgatgagtgagaactgataggggctcctgtaaaaagatccaaggaggttaagtttggccaagagttctgagataaggaagaggttggtcaaaaatgaagtggaagagaatgagaaagaaaaggaagaagaggaggaagacagaatgatggagtgaaagatacaaacacagacccagccggaggggggcattccacctgcaccacctgcagtgcagcaggggatgaaaatgtttaggtcatcgaatcattgattctgacctggaagagatgttaagaaattatgcagtgtagcctcttcatgcaagttaagtattattttattatttccattttgtaaaaagacaaaagatgcacaggaatttaaatgtgtttggagttatcctaaaagcaatggaaaactatagaggagttttaagcagggctataacatgatccaaataacattttaggaaggtctgcctgcttgcattgggaacagcaagagagaaaacaggaaagccagttaggggcccatggtaaatattggaatagtgatgatctgagttagagaagtatagtgaggagatcagagtcgttttagaggcgtaataagcagatattgtccaatgatgacccagctgagaaaatgacaactgtattcattatggggccttgctgaccctgggagacttccagctatcaacaggaagtaaaggactcacccaggagcacacctttcaaatgcaaaccaatcaattcagagctcccgctcccaaccgcctcctatgtggagctgtcacactctgggacactatctcttgccttaatcacctcagacaaccagggacagcccctatgccccacagccctgaaattattcaaactagccaattctaaacctgcctgccctgccctgccctgccccacccattccttctctgtgttgtgctgtaactcctgtttctaggaaactgtgaacataaacttctttcttcatgacaatcatttctgtgcctgtgtctctcaccatagcagcttaaaacaaagcccacatgccctcatgacactaatgaatttgtagaggccctgcatcagtcaggagtgtattcaacttaagaaaatggagcatgtgaccagaagcctgaggaggtaggcactgtgtttggttcagaggcgtggtgaggtcagggctggcctctgggccatcctcttggagtttttccagtggtcaaaggtggctgctgcagatgctggcaggcaggggtgaagcaggtgaggaatttagaacaatgctggagggaggcagcactcttgaaggctgtgaattcctaagcagtagcttggcaacttcacggggagcttgggcttatgtgccgaaggtggggaagagccatttgacatgagaaagtcaagagcaggaggctgacctggtttcgggcgtcattcttacacatggtcaagtcacttagcataatggcaggaatgggggcaggtaaggaagagggtggaggaagaggatgactgtgagtcaggtgcctttgggaagaagggtggtgatcagaagatccacagttgacaatgacaaagagggcttagagggtggcagtcctcaagagcatgcaccacagtggtacaaggacaggagagcagtgaggggaggcccagtgaggttctgggcacaggtcaccaggacaaagtcattagtgtgctcttggatgggagggtggggacagacagtccatgcaggaacttggagaggaagcacaaggcctctcagaatgcagctgtggatttgagtcttagggtccaggttggggtgtcatcttacaatgatacatttagatattctgaaattttaggggttccttttcccagcggcaggcatgtgctgatgtcttagtccattcgggctgctatgacaaaataccatagactgggtggcttataaacaacagaaaaaaaattattcctcactgttctggaggctgggatgtccccaagatcaaggcatcagcagatttggtgtctggggaggacaggttgcctggttcattgatggcatttcctcactgtgtcctcgcatgatagaaggagctctctagggcctcttttataagggcactaaacccattcacaagggctccaccctgatgacctcttaatcatctctccaaggccccacctcctaataccatcaccttggagttcgaatttcaacgtaacattcttgggggtacataagcattcagaccacagcatctggtcttctccttgtctgtgtataaggaagggatggcttcatcccttttatctctggcctcccagctctcagcagttgtgcctgctgaggctgagcatgtgaggaggactgtattgcagagcctttacttgcttcagtttaccttgctgggctgccttctctctcagtgcctgcttgaaacaaaaaaagggtggctgggctttctgagctgcaaactgaaagtgaaaaaaacaaaacaaaacacttcttgttttttctgctttgctaagagactcttggccaaaaaacctcccccctttctctgggctctctgtaaatcacagccaatggttcttatttctgagccttggaaatgcgtgttggagatgaatggagctgctgtcatccctgcatgaaagatggcagcccataactctgcttcaaggtgtgtcggacattgcacgaggcaggaaagtcattgacctggacaagcatcagagcccccactgccacctttgtcctttctgggccctccttttcccactcagttggctgggaagccacaaggggccaaagggaggccaagtgaaatctgaaggtccttgggggattgcagagcgaggtgggagatttatagcaggcgtgggattatagctggtccatgtggggcctgagacacagcagagggggtggaggaacctcttctccagggcagctggatccttctaggggccaatggatgcctcagtgccctggcagaggaggcggagtgggcacccatttggtcactgtgggagttttcttgtgaatggcttcttaggaggtggggaggaagaagtgtttccaggcctggcggccgcatgcagacatacaccgttttctggggtttcggccttgtgcatccagggaaagcacatcatgggacagctaacagctggagttctaaggatccggggaagccaaatcagggactgggattctcccataggcttacaagctgagtcaccactttcctcattagccttttgggcctccctttctccatcaacagccagaacccatcctgctggggacggatgggatggatgggcctgatcgtgggcctcactggcagaggtcactgggacctgctgagaaggagggtcgggttccttctgatgcggtgcagggctggggcagaattcagtgcattattcggtgttcttgaagaggacaatggcaggaaataacaagtactggtgaggctgtggagaaactggaacctttgcacattgctggtagaaatgaaaaatggtgcagccactgtggaaaacagcatggtgttcctcaaaataattagacatagggccgggcgtgctggctcacacctggaatcccagcactttgggacgccaaggagggtggatcacgtgaggtcaggagtttgagaccaggctgaccaacatggcgaaaccccgtctctactaaaaatatgaaaattagccaggcatggtggtaagcctgtaatcccagctgctcaggaggctgaggtaggagaatcgcttgaacccacgaggcggaggttgcagtgagctgagatcgcgccattgcactccagcctgggagacagagcgagactccgtctcaaaaaaaacacaaaaagtagacatagaactgccatatgattcggctattccacatcagggtatatatgcaaaaaattcaaagcagggacacagagagatatttgtacacccatcatagcagcattatgtgcaatagctatgcagggaagcaacacaagtatctattgattgatgaatggataaacaacatgatatgtccatacaacaaaatattattcagccccaaaaggaagaaaatgttgacacatgctacaacatgcaacttgaggacattgttaaataagccagtcacaaatattgtgtgattccacttttatgacatacttagagcagtcaaattcatagatacaggaagtggaatggtgtttgctagtgactaaggggaaaggggaggtattgtttaatggggacaaagtttctgactgggaagatgaaaaagttctggaaataaattatggtgatggttgcataacaatgtgaatgtactcaatgctactgaactgtacacttaaaaatggttacagtgctgttttgttatggatattttaccagaatttagaaaaagataaggtctttaaataataattatttagcctcagactaagacacataaaaaagtggagttttgagaggaattacatagcatgaatgattgcattttaacaattgtacaacaatcaagaatattgataatatttatatgacacctaatcacaaaatttaaggtattaatacattctattcagtttgcctgaggttggcacctgactgaggaagtttgcagagcatcaagaattttaatgtcgctgttatgctatttaaggaaacacagtgtattttttcatctttttatctatatatgccattgtttaaaaacatacgataagtgtttatgttaatttgttgttaggtgaatttatctctttcttattattagcaaaaccgtaaaacaacatagcaggaagtttggaaaataaaaaaaagctctcacaattctgccaccctattacaactgatagatgatcgatttatttaggatagagaaaatctggggtttttcatgcattttttatttagtattaaaatgtcttgagacatgaacagtgacacagttaggtctttaaatattcaagtccatccaatcctcagattctcttgcatgtggtcagtgctattctgttattttattattctcttgtatgaagtgccacttaaaactatttttgccagttgaacgttctgttgccagtgaagtcataaaattgtgattgcttttgtagttttctcatctcaggctccatgtttctttagatgtgcaggctcattagtataggagcctagcctgtatcagagcccaaagttcacaaaggcacaatcataacgcagcaggttcacacatgagggggacagctccaaatgccttctgcatcctgtgttctgagaactttctggatgaaggacattacttactcattcccactcaactataaacaaaaacatggagttaatggtccatcatattgacttgaactgtctggaacgtaacacaccccatttctggcaaaaggctcctgggaagtttcactcctaatgacagaggctgttaaaacctgatcgttggatgagataccaagcacaaaacccaggctcctcatttaggctgggagatacctttgttcccctgcagtcccctgctagggcgtggggccccttaagggcagtaccctcctcagtgtctgaagctttccatttgtgtcaaggagacttttaacgaccctagccaaggatgttaaatcattggtcttctgggtgagaacttggattgttagtggtaatttccccctattaatcatacctttacctttgtttctaggtagagccttgcttcctgaaaaggggttaaatttctctcttctttctgcttcccttcctccagtacctcttcaatcatttctattgtctaaacgaaagtccgagcagttagtgagctacaaggagtagcattttatcttatttttaaaatttcaatggcttttggggtacaagtggtttttgtttacatgggtgaattatatagtggtgagttctgagatcttagcgcaccactcacccgagtagtgtacattgtacctactatgaagtttttaatctcacattctcctcccgccctcccctttctgagtctctaaaggccattgtatcacatatccctccgtatgtctttgcttattcattgcctagcccccacttataagtgagaacatgcggtttttggttttccattcctgagttacttcacttagaataatggccctcagctccattcaagttgctgtaagggacattgttttgttcctttctatggctgagtagtattccatggtgtatccaaggaatagcattttataactgtcctactcaaacaggtaggtggtggccctcattgtgtaagccccacccataacataggtcagatcaagatgcttcaggctgtgaaagtgctgaaacatccaatatcaaccaaattcatctgggagaaacactatagttgtttgttttgttttgttttgttttgtttatagacagagtctcactctgtcgcccaggctggagtgcagtggcttgatctcggctcactgcagcctccacctcctgggtttaagtgattctcctgcctcagcctcctgagaggctgggattacaggcatatgccaccacgcctggctatttttttttttttatgagccagagtttcactctgttgcccaggctgaagtgcatggtgcaatctcagctcactgcaatcttcgcctcctgggttcaagcgattctcctgcctcagcctcccgagtagctgggattacaggcatgccccaccatgctcagctaatttttctatttttagcagagatgggatttcgcaatgttggccaggctggtcttggactcctgacctcaaatgatctgcccatcttggcctcccaaagttctgagattacaggtgtgagccaccaagcccagcctgtatttttagtagagacagggtttcaccatattggccaggctgatctcaaactcctgacctcaagtggtctgcctgcctcaacctcccaaagtgctgggattacaggcatgaaccactgtgtctggccagattatcaaagctttatcaacatatatgattttaactgaaaagaccaattatatatttcacgccatataggcataagaaccatcctcagcttttagaaagctattcaagttttgtgaggattatgagggatggtaggattcagtccagtcctggatctagcacttcttcaaagcatgcacagacttggtcagaccccttccccgtgtgaatggaaagcaattcagaatgcccaaggtcatggtgaggttgatgggtgaaatgaagacgacacagggtctggaatacagacactgagccctacatcaaagcatgtataacttgcctcatgctttatgatgtttttctggatgctttttctcaaaaaggatcactttggttttgtttttgatgactgcttagggaggatgtctggcccagtcagaagttggaagtgaaaaatttttgctaactggtttgacctagtgtcattcattgaacaaaaactattatatgctttctcttcactgtgatagatgctaaaaacaaaaaaaggtagagaagatatgttcttgatgacttataatctggaggaagacagagtcgtgccatgaaaaagtgccacattgatggcatgtcctgcagagagtggggaagggaatgacaagctctggaccctgaaagcaggaaagccctcgcagatgtgttgtcctgagagtgtgccctaaagaaggagagaaaatatcaggtggaaaaggtgggaaaggatattctaggcagaaggaccagcttatataaatgcacatagtgatgttaggtcagggtacatgcaaagaagtgtgagtagaattggctggacatggtgggttatacctctaatctcagcactttggaaggctgagacaggaagatttcttgaggccaggcgttcaagaccagcctgggcaacatcgcagggccccatctctattttttaaaaagttgtgttaggaacaggggctgggaaagtggacgttggtggaagcaagaagagccttgttatttaggaggggtttcatacttgctaataaacacattactatggcttatagacaacagaaacaaataaatgacttcaggggcttggcaataaaggattggcccactcagtgaggtaacaaaacttggtagcactggtgcagaacatccagttgaattctcctaggcttctccctaggcagcagttttcctaccttgagttctgctaagcattaacattaaaaagaaagaggaagaaaaataagatgtttggttgagaaagaagacaagtgcattcatagagatcttaactaaactggagaagtgagaaggccaggaggtagagggagcttgttccagatggcagaaatggtgcctattaattaatcatcaccaagtcaattaaacatttggatgaacacaatgcgggaatatttgagaatctcagctgaaagggttaattaaagctaacctcagctgcaagagttggctttgttctaggtaaagaattatagttagagaaagtgatagtatacttttcaccttccagtgtgactgatttctatttgggggaagccaacaaagagaagtaacatcatcaggccaatctaccactttgtttctcaaatataaacctctctgttcatgaaattcataaagaagaattacaatgagcaaacaaacatatgagcagatgctcaatctcactttcaaccaaagccatgcgaatggcaatatcaggaaagaatcgctttatgcccattaactttgctaaaaacatggtaatagtaagagttggcaagattggttgtggccagtattagagagtattcattcaacaaagtcatgttgaccaaattctgtgtatcagacacttgaaaggcactgatatgcagaataatagaaacccttactcccctttacccagtaatactctaaagaaacaattctaaagaaataatcttcacttctgctctactccaatgaaaaacttgcactaaatgtatacacagatgaagagagtcattgcaacgttgctaattataaataattgtggaaagcaaagttacataattgtccaatgatatagaaatgtttattaaattattacgatagtttatccattatatttgtcagtgcagaataggttatggttgcaataacaaataattccagaaattgcagtcacctaacacaccattgatgacagtggctgctaccatcatggtggctgcagcagggaggtgtggatggagctgcacactccatggagctccccaggtgctgctgcagctgcccaaaccacgactgcagacccaggcctcctgctctgtgagcaggcaaaagccctgccctcctgagcagggctataactgcccaaactgcagctgtgcatcagagcctccctgtgctcttgcgggagggctgggagcgggcaggatctgccttcccgggtgcagctgccctcccaggtgcaggacccgggtgtctctgcagcctgaacccttgggtgccccaggaaggacccccacacttctcctgcagagcagagagaagccaagcagcaggagcagacaccctggagcctggtcacggtggggggtggccgcccgatggcccccaggctgcttccagtgcctgctctaatctcagagcaggggttagggccaaggcccaggggccatgaatggtagtggaaggcagattgtttactgggcaggatggggcaggtccccagtaagttctcactttcaggccaggaagggtctgaaggctggggacctggttgccagtcccgctgaccagagtgggaactcgtggtacctcttccggtctgcccatggctgcccatagaccagttggcacccacttcctcccctctgaggtccataaaagccctgggctcagccagagcagggcagaggacaggagaggatgaagacattggagagaagactggatggccagcagcagagaggagtaccctctctgctgatagctggagatgacagaacaaccatttgcagagaggagctaccctctctgctgagagctgcagagacgacctgctggcagagagaagccaccttctccaaggcctcctctctgctgagaactgaacacttgagagattacctgcctaccgagaggagctgcccactgaggatctcctctgagctgttgtaacactcagtaaagctcatcttggtcttgttcacccttcatttgtctgtgtacctcttcctggacacaggactcagacaaagccgccatggccacagaggtttccggccagaaaattgacacccccaagatcctgaaacaccatgaccgtatctcttactcatgtaatgtccagtgtaagctgatcaactaacaagagaatctctccttaatgaggtgaatcagggattcaggccactccattctgtgatgccagaatttcaatatacggtttttaggaaggggaagagaggaaatatgaaatctcacacccactcttaactactctgactagaagggacatatcacttctgctcacagcccattgggcaaaactagtcatatggtcttaaatctagctgttctttatatcttttgttcattttctgtctggattctttgcttttgttgttgagttttgagaggtttttttttcttttattccagatactaatcctttgttgtatgtatgatttgccagtattttctcccactctgtagcttgtcttttttatcaaaaaaggtctttttcagggcaaaagttttaaattctgacaaagtccaaattatcaatttttccttttatgaattgtgctttcagtatcgagtgtaagcagtctttgtgtagccctagatctcagagtttctcttagtagtttttctaaaagttttatagttttaagtttgacatttaactctatgactattttgagttaatttttgtataaggtatgagatttaggttgaagttcatttgtttgcctatggatgtccagttgctccagcatcatttgttgagaaaggtatctttccttcactgaattgcttttgcatcttgtcaaaactagttgagcatatttctgtggtcctatatctgagttctctattccgttccattgatgcttgtgtctacccctttgacaatacctcatagttgtaaaatagagtaaatgaatttctcacacttcattcattttcaaaattgttttagctattgtagttcttttgcatttccatatacattttagaataatcttgtctatgcctacaaaacattattgctgggattttgatagaaaatctgtatataaacttggggagaatggacatctttactatgttgagtcttctgatccatgaacatgatatgtctccccatttattacatcatctttgattactttcatcagtattgcgtagttttcagtaacaagttctacacatgttttattagatttacacctaaatatttcatttttggaacaattgaaaatggtattatatttttaatttcagtgtatgtgggttcattgctacaatatagaattataattaatatttgtatgtttatatcttgtaactttgctaacatctcttattgtaaaagttccttgggattttctacaaaaacaatgatatcatctacaaataaggaatgttttatttcttcctttttttttttttttttaacaatatggtgtttgcttgacttactgcacttgctagaacttctaacagtatattgaatatgggtggtgggagtgtacatccttgcctcattctcaaccttaaaggaaaagcatttagtctttcactgttaggcatgctgttagctatagggtttgttgttcgtttgtttgtacattttttttaatcaagttgaaattctatttctattttcctgagagtatcatgaaaggatattgaattttgtcaaatgctttttctgtatcaattgatataataacatgcagtattttaatgctattctgacactaataacccagaattagtgtaaacttcataggtttatggcacagtcccaacaagactgctctcactttagatgccaccatgagttctgggtttctcaggccatccacacgtctgactaattggtagtggcacttcctacctcttccagtttaataagtcactagaacaacaactcgcagaactcaagaaagtgctacacttatgaataaagttttgttataaaagatacatattgggaccagcaagaagaagacatccagaaggcaaggtcttggagggttatgaatacagagtttctgtgttcacttcctagaaaatcaagatgtcttatcctcttggcacatcaatatggtcactaactaggatgctcaatcaagctttagtgtccagagtttttaattggagtttcattatgtcagcatgattgatggaattatttgccacacgattgaactcaaactccagcttctctgtcctccttgaacattgggaggttgggatgatgtcacatggctcaaagttccaaacctctaaacacatgtttgtctttctggcatggccagcccccaacctgaaactttctagtgagcattttttttaatgctcaccctgagttacctcatttggataaactcaggtatggtcccgcaatgaataacaaaggcattcttatcatcagggaaatttctggtgataagaagggtgtagaagatccctcccaggaaccaaggacaaagaccagacaaattatttatgatacattctggtattttcttttttgccagatactatggttatgttaatattgattgattttcaattactgaaatatctttgcattcctagaataaagcctacttggtcatggtgtatagattaaaaaatacatattactgaattctatttgctaatattttgttaaggatttttgcttctatattcatgagagatattgtgtatataattttcttttttcaaaactaggatattgattttataaaattaattaggaagtgttctctccttttctattttctggaaaaattgtgtagaattggtgttaattttctataatgtgtttaatagaacctctagtgaaataatctgtgcctggagatttcttctttggaaggttttaaattatgaattcaattttcataataggtatagataattcaaattatcaatttcatattgaataagttgtggtagtttgtattttttgaagaattggtcaatttcactcagttgtcaaatttatgtatgtagagttagttgttcatagtatttattatcctcttgatgtctgtagggtttgcagtgaaatcccgtttcattcctgatatcggcaatttgtgtcatctctcttctttctttgtcaatcttggtagagttctgccaattttgttgatcttttttaaaaaaagaaccatctgtttcatttattttcccatcattgttcggtttttaatttctgttcttatctctattatttctcatctcctactggctttgggtttattttgctattctctttctaggtttttcagatgggagcttagattattgatttgagacagactttcttttctaaagtatacatttaatgccataaatttccccctcagtgcagctgtagctgtgtctcacaacttctggtgtatggtattttaatttttattcagttcaatgcattttaaacaattttcctggaaacctcctttttgaactatggattgctcaaaagtatgttgtttcatttccaagtgcttggagattttcctgttatctctccattattgatttttagtttgattccattgtggtaggaagacatgctctatattattttaattcttttaaattcgttgaaacttgttttatggctcaggatacagtccattttggtatatgtttcatgggcatttgagaagaatgtataatctgaagcagttgggtagtgtattagtcagagttccccagagggacagaaccaataggatatatatgaaagggagtttattaggggaatttggctcacatgataagaaagacgaagtcccaggataggccatcttcaagctggaggagtagagaagctggtaagtatggcaccctggaaagacagctagtgtggttcagtccaagtccaaaagcctcagaaccagggaaaccaacagttgcagctccagtctgaggccaaaggcctgagagcccctgggagactactgggaagctgctggttcaggccccagagtccaaaaaccaaagatcctggagtctgatgtcccaggactacaggagaaaaaagaatccttctctggaagggagagagagaagaagcaagagcaagctgaatatctccctccttctgcctggcatttttctggctgcacccgcagtggattagatggtgtttatccacatagaggacgggttttcctctctcagtccactgactcacatgtcagtctcctctggaaacaccctcacagttacacccagaaacaaggcttcactagccctataggtatccctcagttcggtcaaggtgacagctagtattaatcatcacagatggagtgttctagaaatgtcagttagatcctattgattgatggtatggttgagttctatatacttgctaattttctgtcaaattgtcctattaattgttgaaagaggggtgttgaagtctttaattataattgtagatttgtctttttctcttttcagttctatcatattttacagcttcattgtttggtgcatttacatttagggttgccatatcctcttggtgaactgacctttttatcatcatagaatgtccctctctgtctctggtaattatctttgctctgtagtctgttttatctgatattaatgttgtcagtcctgctttttgttttttggggtcaatgtttgtgtagtatatctttttctattattttactttcaacctgcttatattattgtattagaagtgaatgtctttaggcaagctgtatttaggtcatggtttctaatttgccaatctctgtcttataattggtgtatttagatcatttgtgtttaaagtaattattgatatgttaggacttaagtctgttgttttatgtttttgttttctgtttgttctctctgcttttcttttccctgtttgctctttcctgccttattgtgggtaacaaacatttttaaaaattttattttggtttatctatcgtgtttttgaatatatttctttgtatagtttttaatggttgctctaagtattacattttctatatatgacttattgtagtctatatatagtcttacagtcatattttgccaatttgtgtgaagcaaaaaaaatcttacctgcctttacatcccttgcatctgccatttagaacatacttgtctcaagtattcctctatatacattaagagtcacaccaaacaatgttatagttttagtttcaacgtcaaacattatttagaaatctcaagaggagaagaaagtttattgtatttacccattttttttttttgcttactgtcttctttcatccttcctgatgtttcaaacttgcttcttttattgttttctttctacgtagagaacaacctttggccactcttttagggtaggtctgctggtgacaaatcctcttagtttcccttcatctgacaatgtcttcatttccccttaatcctgaagacttgtttgtttgctcgcttgtttttatgggtataagattctgatttggccaggcgcagtggctcatacctgtaatcccagcactttgggaggccgaggtgggtggatcgcctgaggtcaggagttcgagaccaacctggccgacaaggtgaaaccccatctctactaaaaataaaaaaaattagctgggcacctgtaatcccagctacttgggaagctgagacaggagaatcacctgaacccaggaggcggaggttgcagtgagctgagaccacgccattgcactccagcctgggtaacagaacaagactctgtctcaaaaaaaaaaaaaagaaaaaaaaaaagattctgatttgacagttcttttctttcagcatttgaaaaatatcgtgccacttctttttggcctccttgttttctgattataaatttgttgtcatttgttttataatctttgttttttaatcttttgttttcaaaatatttagttttcagaagtttaattatgatgtgttttggtgtggatttcattatttttatctcatttggagtttaatcagcttcttgagtctgtgtatttatgtctcttgccaaatttgggaattttcagccattatttttctgagtatgttttcagtcctgccctctttctcttttctttccagaactctgatgacataaatcttagatattttgttataatcccacaagtctctgatcctctattcattttttctcagtcagttttctctcttgtaaagattaggagctttgtattgttctaacatccaggtcactgattctttctctgctctttccattattctttgaacccattcactgagcttttcatttcagttattgtgtttttcagttttaaattttccgattatatcctctatggctgaggcttcctattttttatttgtttcaagtatgttcataattgcttgctgaagctcttagaagtttttaaattatgataaaatacattctaaccattttagaagtgtgttgtgtagtttccaagtacactttttaaagtgtacagttagtggcattaaatacattctcactttcatgtactattgaagcacttttatgatgactactttaacatctttgttggggaattctaacacatctgtcatcccagtgttgacatctactgattgtctttttttattcagtttgagatcttcctggctcttagtatgacaggtgattttcaatgagaatctatatagcttcatctgatgttatgatactctggatctcatctaaacctcctacattacctggatttctctgacactcaattctgcctcagtattgcccgctggagtagagaagttcaggttcccatttggcctctgttgacacccaagaggaggtgtttcaagactgccatgtagggtgaacatctagtctccccatgtggttaccactgatgctgtgggagaagaagggatttcacaccagccagtggggattcaagtcttagctccttacttggccttctctggtactacccctgtgggagttttggggcaccttgtgatagcctggccagggtgaagtctagactccccactcggtctttggtggtgtgagtgagggagggtaagaccatggatgttttttctatagtgtttggctgaggttgagtgattattaactaagtgtttcctgtcttgcgaggctgccgtttcctggctctttggctagagagaacaggcttttgttggaacttctttttgtccgtgttcattggcatttctggatttctggcttcttcagcaccaattatggaatacatgaggcaaacaaactaattaacagaaaactaaaacaatcaaaacaaacctagggattttatcaccatgttatttgttaggtcctaaggtccctaactcatctgccttcctctctccaccttttgaagtcttcttaggtttgtcttatttgtgtttactgtcttgggcttttagttgtacttagcagaaagaataagaatgatggaggtctacttcatctttctgagatgtctgcttacttttaactttctgctctgcctagcttcagattttgaggaatttttttagaggaagccaggcagtgggataagcccacttctctgccctttcattctcatccaaataattggtccttcaagtgtaaatgaaaaattcccaaaactctgccgaccctctgtcccctgaagcagcctttgcctatgcagagcccagattctcagttcataactggttcccagaatcagcaaatgccacaagggttaatgtagctgcacaaagtcagctcacttctacatgggtcctccctccttagaatctcggaccctctagtccccttcacttcagtgactctttgatgcatggaaaataatttttaaaatattttatccagctttctaagttacttttggcaagagcattaatcagccccaagatactcatccttactgaaactggaagtctgcttctcagaattcatgtgacagtattgtacgtgagtggctttatgtcacaagacccctttccattggctaacgtattccaagtagcaaagggatagtgttacagggtgtggttaaaagtgtgggctccgaaatcaaagggacttggttttgaatgctggctctgctacctaccagctgtgggtcattttttagacttcctaagccttggttttctcatcttttaaagtggggatgttaaaatactcatctgaaagggttgctgtaagaataaaatgagataattcaggtaaaggacttttttttttttgagatagagtcttgccctgtcgccagggtggggtgcagtggcacgatctcggctcactgcaacctctgcctcctgggttcgagcagttctcctgcctcagcctcccaagtagctgggactacaggctcacactgccatgcccagctaattttttgtattttaatagagacgggctttcaccgtgttctccaggctgttctcaaactcctgaactcaggcagtccgcccgcctcagcctcccaaagtgctaggattacaggcgtgagccaccgtgccctgcaagggacttattttgataactcatacatagtacgtgaagacaaggtgttagctattgtttaatattaatgttctaaataattgacttatatccagtcaacatgattttatttaacccacaaatacatgagttgattaactgtttatttactagtgactcatatttgtgattttatttcaacaacaaaaaatgtagatatcaagcccccctctcttcttatcctagaactgggagatagtctgctttacagtcagcataaacagatacagaagttgataatttgaagtagaaaaaatattacttgctattatatgaaacaaatatatactatgtggaaaggtttaggtacttcaaaagaaattaagtagaactgagaagagagaaggaactctggattagagtaaatccgtgaagctgctggtgggattgcagtggagaactatttgggagaagaagggaatgtgtatcttatctggaagttcttttagttctctggattgtatttgggacatatatagctctgttcatagaaaaaaaagatgaatgagaaaggggtaggttactgattgggaaagaaatgcaatgttaaccaaaaaaaaaaaccagagtctctcagtttctgttttgcttctttctcccctatcaatgagcatgattttgaaaatggggaagaatagaatgatgattaagagtaaatgaaatcccagaataggcaatactccacaaaggggacattaacttaggtatctgggtctaggattaaccaaatgaactgcaagaacttgtactttcaaactcaatatttggaaacttaaagataaaaaaaaaaaaagaaagaaaaaaaggctacgaggaagcaggagagtataatggttaggagattggtcttggtgttagaccggcctgggttctagtcccagctctgccacttattagctacatcacagtggaagaggaaactggctgggtgtggtggctcatgcctgtaatcccagcactttgggaggccaaggcaggcaaatcacttgaggtcgggactttgagaccagcctgaccaacatggcaaaaccccttctacacaaaaaataaaaaataaaaatacaaaaaattagctgggcatggtcatgtgcacctgtaatcctagctgtttcaggagtttgaggcacgaaaattccttgagcctgagaggaagaagttgtagtgagctgagatcgggccacagtactccagcctgggcaacagagagagacaccaactcaaagaaaaaaaaaaaaaaggaaaaagaagaaagacgaaaatctctcctagctttatgacttctccatttctaaaatggagaaaatctatgaatctataacaatcatatactaatcactgagagaaggagagagaagaaagtcctccattcacactatttgttgcagcaaataatcaatttcttatctgaaggtcgtgtaagaataataatcgttaatcttgcccttccaatgggaaatatactttatggtagccaaataacttcagttgataaaggaaagctctgcttgacagaagaatgcaggtaataaatgcagaaggaatgatagaattaggaaggtcatggacttgaattttctcattgttaattagaaattaaaattcctatttgttatcaaatagtatttaaaaaggaaaagtcagaacaggtgtcttaattcgtttgtattgctataaaggaatacctgagccaggataatgtgtgtgtgtgtgtatatatatatatatatatatatatatatatatatatatatatatgtaaagaggtttatttggccctcagttctgcagactgtactagaagcatgacaggagcatctgcttctggtgaggactcagggagcttccactcatggcagaaggtgaagaggagccagagtgtgcagagatcacatggccagacaggaagaaagacagaggggaggaaggtgccaggctatttccaacaaccagctgtcgcagaaactaatgagaactcactcgccttgaagggagggcattaatctattcccgagggatccgcccccatgacccaaacacctcccattaggccccacctccaacattggggatcaaatttcaacatgagatttggaggggacaaatacccaaaccatagcaatgggatagataaatttccttgacattgatccccttctaaactccaaactgtgctttaaaaacagtatttttagttttaagggatgttgataaatcaaggcatccagaagaggtaaacaaaatggtcacagaaagtgaagccaggctggagaaaagaagactctggagaaaatcaaaccctacaaggagccctcatgcagtgcacagaataaattcactatttggtagcttcagaaggtggaataagggtgggatgaaagacatttcagggagtccaaagtgaaacgcttcagttagcgttggagaagagagaactggagttggagggaggcaaggtgctgaagtgagttgccaacaccaattcctctggactgtgtccctgaggtgatgatgcagggcctgtgggaagtgggccaggggcctgtcattctggttctgtgggtcttgaccaaccagcccctagagtgctggggctcagaacacctcacctggctgtttgtgccttgcccagtaggttgcaggcgggcagcctgctgggctctttgccgagttgagtggtttgtctccatctggctgctgtgaaatcacatgggcctgttggctgcgattgtttgcgggctgcctccctggatggtggggttctgtgctctggctcctgggctctgactgctttccagggagcactgtttcgcatggggtactcaggaaacttcccaatcagatggaaagaataaacacagacttcagctgactagctctgcactttcttcggggttctgagaaaccaaaggcaaacacacgtggtgtgcagtggtgtgccctgtaggggaagcctgtgagtggcgcgcacagcgcaggttccctctgcggggtgcaggagcagaggactggtgctggtgggcctttctctgcgtgtccagaactgtcggcttgtgcacgctaggcctggcaatatgtgtgtgcatgagtgtgggcatgcatctgtgtgtgtgcacatcaacacacaggttgtgcttttagtatgacattctgtgttttcatctaagtgcttgagggcccctgacttgccatggttttccaaataaagaaacttaaataaacacagtggggccccagaggctgggatgggaccatgcttctgtagaatttccatgtgccctgagctatgctgttactctaattactcctcattttaattccattttgaggcttatcagccctatgctcttctactttgggactgggccaaggaggcagggggtaaactgagtccaggcgatcccggagcctccagggccagccctgggagctcgcaggcctttgctggggcagcaggaactctgctttgcctatgacatcctgtgctttggtctgggagatttctgtatgagtcattttcagctcagaacaccctagctgtggttaattacctgaggttttactggactccttctccaagcgttcattgttgtccgggccgcctcatcatgcccccacacgtgtcctcctctggggaggtttggaaaagagcctttagcccaagttactgtgacctttggtacctgtaggacacatttttatccctcttcctgattctaatcttactgagccaccaaaacctttttgtttgttttaataaacttctaattttagaatagttttagatttacagaaaagttacaaagtctccatgtacctccttacagttaaccctattaacatccttcatcagtagagtactaatgagcccagattgatacattattattaactaaagtctattttcagattcccttagtttttacctcgggtccttaccatgttccagtcttcatctagaatacctcgctatgtggagttgtcgcatctcctgggctcctttagctataactgtgaccagaaagatccctctcatcctccttgtctccctctacctttcttttatgattgtggtaaaaaaaaaaaaaaaaaaaacacataaaatcaagatccatttttaaggtctgttgctgaaatggccaaaatggccccaaaaaaaatattgccagttgctgtgaggtttcatgagcaactgagggtatttgaacccttctttctagagcaagaactctgaccgccatcgcttttgtgtacccagcgttatttagaactgaaatctgccccagagccggaggaaaggaggcacaaaccatctcagccgtgcaatgttcctctgttgaaaatgtctctccatttttttgtgctaatccaaatgtgtatttcatttaacgttcaatttgatcaacctgttagagagggactgtggcacccagaattcttccttctagtcttgattcctacaaaagtgtacaagaatagtttgtactgcaccatcttgtgcagctcagtggcttgaatcaggttggcttttcaatcaaattgtaaggtcctagacaccaaggacctgctttctaatttcttttatactctttgcaatagttttttgttttatagatagggcagatagggagcaaagatagagtgacttggctgcccagaagatgtactgaagtcaaacacgaggatgatgagtaacacgcacctgcagttcaccaggcctgaagctgggggaagcgaagaggtactggggttcccgggcaaaatttaagggggcaccaaagaacttagtaatcgagataaataatatcttaattcaatatgttttaaaaataaaattatttttgtacaaataatttaacaaatccatgatgagccagacatggtagctcttgcctgtattcccagaactttgggagatggaggtgggaagatcacttgagcctaagagtttgagactagcctgggcaacatggagaaaccccatctccacaaaaaatacaaaaactagccaggcgtggtggcatgtgcctgtagtcccagctacttggggggctgaggtgggaggatcacttgagccagggaggttaaggctgcagtaaacgctgatgacacctatgtactccagcctgggtgagagagcagcaagaccctgtttaaaaaaaaataatccatgatgaacacagcaccaaaatttcaaataaagactgcatgtttttgtatgttttgtaactctgtgttgttatataatggacggtcatttccaatcagttcgaggtctcacacccgtgaaggcacatcttccctcaccaggtgatgtacaaagattaacaatagcatgcaaacagatggggtggttctgagctttagatagagctatgtcctttgattgtagggctttcattaactttttatccttggttcaaaatctgcaaggatcttctgataggggtaaatagggatgcatgtctttccttttccttggctcctctgtgattttcatggcaatgcaatctacaaagagctccaacatataccatttcatttaatcccccaggaaaaacaaaatcctatgagtagatagtgtcattttcactttagagaaaaagaaaccggacctcagattaagttactaacccaacaatactgagctggcccatagtggagctgggattccatgaacgttacctgacctagatcctcgacttgggccgcctgtgcagattgcctttgtagacacaaccaggtgctctgcctctctctgctcagctctgtgcgctcatgcccatctctgccatttcccctaccaagggtatgtgtgtacttatgtaaacatatgtgtaaacagaagtgtgtgtgctgtgtgatcttgtgtgtacatgtgtgtctgtatgcatgtattcagagtatgaaaagatgtaaaatatgagaacacaggtgcctgtggcatcagagtgtgtgtttgcttgcatgagtgtatatgtacgtgtgtttttgcatacgtgtgtgtacaacggtgtgcctatgtgagcccatgtgtaacacacgtttgtgtgagcatgtgcatacacatgtatgtgtttgagtacaagaagacatgatgcagagacacaaacagcccaaaggagggctgaggctgctgcagcctgacagagtttacatctgactgccttcagctcctgtacggtgctgtcccactctccatcgcgtttggagagccggcatcagttctgggagctcacggaggattttactccctcctccttcactgggaggagccacggccactgccctccctgcctcccttctcaggttcggggagaaggctcagaatcttggcacatgacatagaatttgctaaccccaaggctgtaagaacaaaactaacgtgtcatttggggaaacctcagtttgccctctccaaagagaaagcctgaaagacccctgcaaatgttcagcctggctctgggctgttgtccatacagtaatgggatttttcttgggatacatcaggaattgttccatgtaaggtaaaactttctctgaaatgccctctcctccccaaaccccagcccaacataataacctgatgagtccttaaacggaggaccacacactggcagctttcagcaattttcctggctaaatattgttctagccagtgttagttttgacaggattagtcatggatcctaatataagagtcccaggatccctgttggttggaaagcctgttaaaatattgttttatttccctgcagctcgtaagctcatggagccctgcgaggcattttcacatatagtgcttcttggccaatgtgtttcagaacatagcagctgacggggtgagaggcagctgcctttcctgagtgaatctttgccagagagtgtttgaagaaatatctttaggtagacaaaaggctgccacataacgtgagcaggctcaggggacactccttgggtcagaagttggtgctgcgggcttggtcaaggtgtggcagccactcagccctgaccgtgctgtctgtgcctatggagtctttgatagactggagctgggcagaccagaaggtaagcacagccacagtgaaggaaagctgtgagaagccagctggtgggagcttctgggagtatggtcatgtactttaagacagtgccatgaaatatgggccacgtggttattctgaaggcttgatccacgcttcaaacatgacagttgactcttccttcagccagtagctattgtctctgtttcatttcgcttttaccgtattatcttagttcattctgctttgctataaaggaatacctgaagctgggaaatttatacagaagagaggtttctttggctcatggttctgcaggctgtacaagcatggcaccagcatctgctcagcttctggtgaggtgtcaggaagcttcccatcatggtggaaggcaagggaatgtcacatagtgagagaaggagcaagaaagagagggaggaggtgtcaggatcttctaaacaactagatcttgcgagagcccatacagtgataactcattaagtactatgaggatagcaccaagacagtaatgaggggtctacttccatgacctaaacacctcccactaggcccacctttaacattagaggtcacatttcgcatgagatttggagaggacaaaacatccaaaccatatcacttgttatgaagactgtagggtggagttggtaggtggttggacagcgtgcgggatctatgaccattttgggtaatatcccaggttatggtctccaggttttactgaatttgctggaaaaaattatgcctttcataaactaatattagtgaatacctacctcacgctctgtttttttcttttaagagatggggtcttactatgttgcccaggctgaagtatagtggctgctcagaggcatgatcatctcacactacagccttgaactcctgggctcaagcgatcccccacctcagcctcccaagtagctgggactataggctcctgccaccaagcccgggtcctctctattttcttgtagcatgttatgtgtctatttctaacatgttaagctgattaaaaagaccacaaaacaatgaggccaaaattctgtaagttttgtgtcattaatattttttctaaataaaacccactcaagtcttgttattttctgagttttcatttccagcctctcttatcctctaagcctttcctcatgtcatctcaaaaatctcttcttccaatgctactctgactgtatcattgcttggttgctgattgcctatcataattagccagatttgtcagcatgaatgaatgctcatgtcagtgtcagaacaggcaatacacatttgttaaagggacagatgtgtgaatgggcgctgatgttctgcatgggtaagtccttccgcgtggctcacccctgtttctttcccacactgctgcaacaagcctgcctacagtttcctaccctgggatgcctgcactagcatgcacactggagggcaagcctttactgactggaatgtctgcacctgactatctgtgctagtgggatcaatgatggattcaccacccggctaagctttccctgagttacctggttgacgatgttcactaatcccatagcccccagggcttgagagtatcgttcacagcagaggagtttgcatttctttatgtatgtagtaacatattatcttttatatgcactttacctgcttcttccttagaaggtagactcctcagggccagaaatacagtcctctgtttcttttatccctcctcacagcctctgccagtgctctgcagctcaaaggtccctgataagcagagtgacttcagcattgtaatgaaccagagcacagagagaggctgtgcaagcaaagggtaggagcagccctagaagaaggcacacattcattcctcgggttgcagcctgtttacagagggagagaatctctgctgcagttacccagcatccaggggtccatgctctgccagcgtcactcagccacgtgagatggggtgattggaccaaaggagatacatggtgttttatttagtgatggtggggccatttctgtttttatttgtttttaactggggtatgtgtgtcaggaccacacagcagcagggagaagcttccacctgcttggaacaaaaatgggaaggctgcatttccaggctgcatttatcttatgtgtagtgtaagcagcatcgctgactgggaaagaaaaaagggtaaagagcattatagatgcctgataattcagtccttaagagatggctcactcaattgcttggttttgtattttcatttcttttcctgactgaaaatggatctggagcctgagagcacctgatgttgggcgaggcctctgggtacgaggtggaagttcacatttctggattatgtgtagtttcagaatgccttctatctcggtgtcaggatagatgttaagatgcaggaattctcataaatcttctcgttaaaaagaagaaaacaacaaaacttctcacagaacataaaaaccatgtcaggtggccgggcgtggtggctcatgcctgtaaactcagcactttggaagtccaaggtgggtggatcacgaggtcaggtatttgagaccagcctgggcaacatgtgaaatcccgtccctactaaaaatacaaaaattagcggggagttgtggcacactcctgtaatcccagctactcaggaggctgaggcaggagaatcgcttgaacccaggaggcagaggttgcagtgagccaagatcatgccattgcactccagtctgggcgacagagcaagactgtctcaaaaaaaaccccaaaaaaacaaaaaaaacccatgtcaggttgctcccctgagcaaggccaagctcagttttcacctggtggtcccatggggagcttcctgtggcttagtgtttgcgtctgccatttgctatccctccccagcacaccttcctgtggatggaacttgccagaacttcctcagcaaccctgaagaggaaagctggaggccccaacagacgcagaagtgggctgcactgctgtgcttccatggggcagtcagggctcagggccccagcagcaggccaaaccccagcccagctcccttgcaaacctcctctgtcatgtaccctgggagtcaggtccaaccccactatgtcacaactgaggaaacagaggccccgagaagttcagggagagctggggtcaagatgctagatcctgcctctgggtgtggtggcttttgttcttgtcatccggtgggcactgggcctgccccgcacagctccttcaccccggagaggtgacagcagactacattaggccctgccaggcccaaagactccagcctgttaatctttaaccagagctctggacaaaggtagcccttctgacctcctgagagtttctgaatagctcggaggcttctgtgacagagccacacgttagcaatgacatatatttagtgcagggaggcatgttgagtacagttctaaattctgttgtgaattgtgcccagggaacaagcacagagaacattttcaccatggatatgtatgtacttgtaagaagcagctgggtggttccttcagcaatctgctgagctgtggcgattacatcacacactggtgcaaaggccttgaaccattaatgtgctgcctctgcgagggtgaccaggattccagcaatgaacagagaaggtgcttgtccccactgctcactgggtgccttcagattcttaacttttgtctttttcttttttctttcacttcttacctgtatctataaaacaggactctgtttgctttgaaaagagccagaatgacctcaggggtcagtgactcatgctgttggctctgtgaacacaatcgagtgccccttacgtaagaagctcctgctatctgagggaagggaggtccgagccattattccttggttataaacactccatgtggttttgtttggtggttttaaaaaaggtgtgtccacagggttggtgttctagaatcgtgggcagaaagaagtctagctcctttcatccaaggttctaaagggttctctgagctgtaactcagctctaactggacaaagaggcaacaattcccctcatttcctgtgcgctgtcaccacaggaggctacacttaaggaggtcaactcaagttgtttggaccaagcttccgcagttgttcccattatcctgtttgaatccattcactcttacactggccatgcaaatagacactccccaaggaaagaaggaccttagaaaataagtgatctcagttttcatctgactttcttctggggtgtggggctggtcatgggtctatattccctgctgtggtcagggccctgtgggacatgtggctgtgtcccagccctctagcacaatctgccgtcactcctgggcttttgtatgcctgctcccatttgctcttatctcctcaacaaccacgtcaggtagataatacataccatcagtcccagtttacagatgaaaaaagtgaggcacagggagcttcagtaacttgatcaagactagaattcagagaaatagccaaaccatgactcatgatcctcttgctccaaagtgcgttgtctcccccacagcccactatatttgttgtttatttttgaaaatggtcatgaactcagctaagacgctggggcagtggagcggagggagagagcctgctcttcacagagggcttatggggtgagaggaagggaagctaagtacagggcaggccggggccatctaaggtggcctctgaccatcctggagaggcatggggctagagaatgaagaatgaggcagaaatgagcgtttttgaactggtttaccgagcaagaactagaatggaaggggacatattacaaatgacaaatgcctgatccaaagcccatgagatgctattgatgagggccacggacccttactctgtgcagacacagaggcttggatgcacacacttgcatacacacacacacacacacacgcactgttttgttttgctctgctttatttttgccactgtggaataataagaagtacagtcacgcattgcttaatgatggggatgcagtctgagaaatgcatcaggtgatttcattgttgtttgaacgtcatagagagtacttacacaaacctagacggtataacctactacatacctatactatatgggataacctattgctcctgtaccaaatactgtaggcaatcgtaacacagtggtatttgtgaatctaaacatatctaaacacagaaaaggtaccataaaaatgtggttagaaaagatgaaaaatggggctgggcgtggtggctcacgcctgtaatcccagcacttgggaggccaaggtgggcggatcacttgtggtcagcagtttgagaccagcctggccaacatggtgcaaccccatctctactaaaagtagaaaaattagctgggtgtggtggtgtgtgtctgtaatcccagctagtcgggaggctgaggcaggagaatcatttgaacctgggaggtggaggttgcagtgagccgagattgtgccactgcaccactgcactccagcctgggccacagagcgagactctgtctgaaaaaaaaaaaaattaaaaaaaagatgaaaaaaggtacacggtctagggtagttaccgtgaatggagcctgtgggactggaagttgccctgagtgagccagtgagtgagcggtgaatgaatggaaaggcctgggatgttacattactgtacactaaatttattttagctacactaaatttattaaaaaataaagtaattgcactatgacattatgacaaccatggcatgcatcgctaagggataggtatttttcagattcattgtaatcttttgagatcaccatcatatgtatggcccatccttggctaaaatgccattatttagcatatgactgtacacatattggtctctgccctcagttcctgacacagagctcttaaaatccttggagtttcttgagagataggagtgctagtagcatcttttgttctaatcgggcaactctggctgggctcctagatagcctcgggatgggagttggtggccaggggaaccaaccatgtgattataaagttggaactttcacccccacccctaacctcaggggagggaagaggggctgaaggttgagctgaacatcaatggccaatgatttaatcaatcatgcctacataatgaagcctctataaaaccccaaagtacagggttcagggaacttccaggcagctgaactcatggaggtttctagagactcgcacacaaggagaggacatgaaggtctgagcgccttccacatgcctcgccctgtgcctctcttcatctgtatcctacataatatcctttataatacaccagtaaacacagctacgtgactctctgagttctgtgagctgctctagcaaattaattaaacccaaggacagggtcttaggaacccagatttataaccagtcagaaaccacaagtaaaataacctggggcttgtgattggcatcagaagtggtggaggtcttgtgggactgagccctcaacccgtgggatcagatgctatcttcaggcaggtagtgacagaaatgaattgaattcaaggacgtccagctagtgtctactggaaaatctgtagaattgcttgcttgcgtggtggggggacatacccatacattggtgacagaggtcacagaagtaccctgtgttatgagagaatagtaggagaaactgagtttattttttctttctctcacagaaactgaaaggcatttatcctcacattagagtatagcatgctgaattgtctgtctatagctgcaattccacccaagacttatgctaacttttaagatttttgtctcatatcaaaactgagaagactctcaaaagaaacatcactcaagcaaaaaacttttaaagcttttcaaaataatcgcaactcatcctgcacttcataattctatcaccattagagtgaattaattgtgtgattatatgtttgccttccatagactgtgagcttcataaaagttggaaccaagcctgtcattcatttattcaatagagacctaccgagtgcctacatgtgtcagataccatttcacttgtagggccgcaagagtgaatgaaacacgagattccacagcagatggtctcaatttctttgtgtcactgaccccctggaatcccagcctacagtaggcactcaatgaatacttattggataagagatgaacacatttccagcttattcttcccaccccaaatctttccttaataagaggtctgggttttcacacagccctgctggaaagccccctttggccaaacactgtagtctctgcagacagctctcagcctgtggcctgtggttaggcccactctgtctgatactctaagcactggctgaagacagtgacagagaaaggagaaacaatgccccattccagcaggaggagggaggaaggatgagcaaagagggctgacccatttttcttggctaaccgtgaagctcccaactgtgtcctggggctctggcagggaccctggcgacagccctgacccctgctctgtgctgcattattcagcaagactgtgacgttatcactgtgaggtgggtgagtcatcaacaaagctgctatccagaatctcatgagctcagcctgaggggctgatgccagcctgttcaccgactctggaagacaaaaggctatgttccctgctgggctccccttccctgctcctgggaccctgggcaggtccctctctataggggtgatggtaaaggaacctgagctttaataagggagaaatgtgtgtccagtatgggagctgccgctgtctgaacaaatatggaatcataatcaagtccaatcttggtttttaaatttggaaatgggtataataagatttatcccaagacgttgttgaaaggttatttgtactgcatctggcacttcatacatgattggtgttatttcccaggcatctcaattgagatcctacacagtttcatgctcatgataactgcaaatcataaatcataatcttattcctatctcttcctgtacatcatggctgggggacagaggaataacccactccaaacccctatatgcttcctctttggggagaggaaggcacagtgtgtcctatttggtcctgtaggtgttgggttagctccactgcaaaccccacatttgaacacagccagcctgtctgcagcctggcagagtttcctgtcttcctcactgcctatgccacttctcaccctttctactcctactctttctccatgttcctcactcttatctgaactccatgaatttcctttcctgcctttagaaatttctcctacttggctgggcgcggtggctcacgcctgtaatcccagcactttgggaggccgagatgggcagatcacaaggtcagaagatcgagaccatcctggctaatatggtgaaaccccgtctctactaaaaatacaaaaaaattagccaggtgtggtggcaggcacctgtagtcccagctactcgggaggctgaggcaggagaatggggtgaacccaggaggcggagcttgcagtgagccgagatcgcgccactgcactccagcctgggcaactgagtgagactccatctcaaaaaaaaaaaaaaagaaaagaaatttctcctactctgtgcatattcctcttgggcacctgacttcttccttcttgacttagaggaagagatgctcctctgtaaaatctcacatgaaccttgctgcccttccaggtcccctcgttttctgctaagagacttgtactgaccatagtgcttcctaaggtgtaggccacagccactgtatcaaggaccatctgggtttcttgttagcaggcagattcccaggttttgttctcatttgctcaaatagaatgggggtctgggattctgggttacatttgaaaaattctcttttttaaaaaagtgcagtggctcacgcttgtaatcccagcacttttggaggaggacatggtgatgtatgcctgtagtcccagctgctcagaaggctaaggtgggagaattgcttaagcccaggaagtcaaggctgcagtgagccatgttcacacgactgcactccagctagggtgacagagtgagactctgtctaaaataaaatatgtatgtgtgtgtatatatatatatgtgtgtgtgtgtgtgtgtgtgtatgtattcttaaaataaatttttacggagtctcgctctgtcgcccaggctgcagtgcagtggcacaatctcggctcactgcaagctccgcctcccaggttcacgccattctcctgcctcagcctcctgagtagctgggactacaggcgcccaccaccactcctggctaatttttttttttgtagttttagtagagacagggtttcaccatgttagccaggatggtctcgatctcctgacctcatgatccacccatcttggcctccctaagtgctgggattacaggcatgagccactgcgcccggcctttaatatactcttaaaataaaattttaaattacgtaagtggcacagcactgcaaccaaagcctgtacacattgtcacaaatctctcaccaccagtctctatccacttctccccaggtatccgaagtcaacagacatatttatctgtccacatccttgtgattcctcagacaagtctacattcacacagagagtaaaaatcatattgtggatttttacagaattgggatatgttgtattaattactctgtcagttgcctttcttttctaccaatacatcagggacatccctccaggacaatagatatggagctacttcattctctttaatagtcgtataatattttgtagtatagaaggacacagttgatcaaaccatccctccagttatgagtattgaggctgtttctaatttgcatctgctttgttatttgttatcataaacaatgctgtttgtgtatatactttatgggcttttatttctgtagaatagagtcataaaaacaggatagttctgtaaaaggatatatgtcattttaaaacagatattgttgcattactttcccaaattggaacaatttctatttcccctagcaatacacaccattgcctatttcttgcctttatgaaaacattcagcattttattcttttctttctttttttaaggtttgtcaatcacatgcaaagaagatattttcacttgttgctttattttatattttcctcattctcagtgaaggcatgtattcctatgtttactaaacttttggatttattctgtgaaaagcctattctatctttttactattttcttactgagcttatctttctcttgtgaatttgtagaagttctttgaatattatgcatatgaatccttttcctattatgagtgccgaagatattttctttctttttatttatttattttttttgaggcagagtctaactctgtcatccaggctgaagtgcagtggtgcaatctcggatcactgcaacctccgcctctcacgttcaaacaattctcatgcctcagcctcccgagtagctgggattacaggtgtgcaccaccacgcctgactaacttttatatatttttttttaatagagacgacgttttcccatgttggccaggctggtctcaaactccctacctcaggtgatccacccaactcagcctccccaaatgctgggattacaggtgtaagccactgtgccgggcccagatctttttctattatcttaatttacatattttttaaaaagtcatataaaaacttatttgtatttagacaaatatgactggtcttttctatctggcttagaaagatcttccataccataagatttgacagaagttcttcttagttaaaaacaaacatgtattacttgtagtttatttctagtatttaagtcttgaatcctttggaatttatttctgtgtattatgtgaggtggaagtttagctacttttttcttcctgatgaagagctaattatgccagcaccatttattattaaagcaattcttttctctctaaatcaaaatatcgccttggttgttgatatctcttaaatctatttctagtttccaatatcttttgcccgtgcattggactatccttgtgcctttagcaaacttccctacatgatagtaactttacagtgattttattatcggacaaacaaggagacaatctgcgcctctgcaggctgctgtggtgagtctcacttatggaaggtgtgatttggggcaaggtggattaatttctgcactgagagatgcagtttctttatctggaaaatttaaggcaaaagctctggctctctcccagggtggctgtaggatgccgtgagcatccctttccttctctggtgagtaccagtactcaccctgcgcttggcctgccccattgtcaggagctgctttccccaggtgggaaaaagcagtgagccatgttcacaccactgcactccagcaagggcgaaatagcgagaccctgtctgaaatatgtatataattggtatctatatatagagatacatatatatccttaaatatatatagatacctatatatattcttaatatatatataaatatataatatatattcttaaaataaattatatatatatatatatatatttttttttagatggagtctcactatgttgcccaggcacaatctcggctcactgcaacatctgcctcctggattcaagcagttctcctgcttcagcctcctgagtagctggggttataggcatgggccaccataccctgctaatttttgtattttgagtagagatggggttttgccacattggccaggttggtctcgaacccctcacctcaggtgatctgccctccttggcctcccaaagtgctgggattacaggcatgagccaccacgcccgaccaaattacatatatatatatttatatttatatatatttatatacatttatatatttatatataaatattatataatattttaatattataaaatatattaataatatatattatataatatatattattaatatttataatatatattatataatatatattattaatatttataatatatattatattatatatattatatattatatattatattatatatattatatattatatattatattatataatatataatatatatattatataatatatattatatatattatattatatatatatattcttaaaataaattttaaaattactcaagtggcacagcactgcaacctaagcctgtgtacattgtcaccaatctttcatcaccagtctccatcccctctctccaggtatccaaagtcaacagacttctatctatctatccttttaaacaggccccaggagaggcctacctatttctgtgcaggctccttctcagcccttccctcccctctttgggcctcttctgcatcttcaatgatcatctctaagctgatgacaccatgatcatccctgttaccggaaaaaggtcctgatccaaaccctaagagagggttcctggacctcacacaagaaagaattcaggtcaagttcacagagtaaagtgaaaaggagcttattaagaaagcaaagaaaagaatggctactccataggcagagcagccccaagggctgctggttggctatttttatggttatttattgattatatgctaaacaaggagtggattattcatgaattttctgggaaaggggtgggcaattcctggaactgagggttcctcccctttttagaggatgcagggtaacttctagacattgccatggcatttgtaaactgttgtggcagtggcaggagtgtcttttagcatgctactacattataattagcatataatgagcagtgaggtcactttcaccaccatcttggttttggtgggttttgcccagcttctttactgcaggctgtttgatcagcaaggtctttctggcctgtatcttgtcccaacctcctacgtcatcctgtgacttagaactcctaaccgcctgggaatgcagcccagtaggtctcagcttcattttacccattccctattcaagatggagttgctttggttcaaatgcctgtcacatccccgaccctgactcctcacataagttcgttcttaactttttttttttctcccagacagcgcctagctctgtcacccaggctggtgtgcagtggtgcaatcatagctcactgtaacctcaacctcctgggctcaagcaatcctctggcctcagcctcccaagtagctgggacaataggcatgtaccactatgctcagttaattgttgttttgttttgtttgtagagataatggtctcactttgttgcccaggctggtctcgaactcctggcttcaagtgatcctcccacttcagtcacccaattctaacttattattattttttaactattattttagtttacagagtttttccttagttatttatgttcttccttcttccaaatagaatttgaagtgtctcagacttggcttccaggctgcctgctgagtaccccgaccagagcctcttgcagtccaagttcacttcatgaaaagctcacacttcccagacactcacctcttccagtattattcaccagcctggtacaagcagcctgctggtcactcagagtagatgcctcatgcccccccccccccagccaactgggcacagtgtcctgttgaatctccatccacagcctctgtctgttaagcatctctctaaacccacggctctgccttcagctggggccctcagcaacctccaccacatgactgcagccagcttctcactgaggaccccgactatgccacacctctttgctggcaacctacagctgcttccacaccctcttgccagaaacctacagctgctttcatggccaatcccaccataccacatccctgagcaataatattctagaggtccctactgcctataaacaccactcaaacttcttagaacggcataggaacctctccagtttctggctgcacaaccattttttggtttgttttctatttgtgagactattttgctcaaatgtgtttacaagtgatttaaaaaaaaaaagagaaacgccattgaaggaagtttataaacataatgggaaaatgcaaaggtgataaacatgttcctctccaggtaggcactgcagctaatgagcaccactccaggggtgtggaggcctgaggtgggaatcacagtgatcttgctcaaggctggtctcagcaaggccctccaggagaagagcttgcctggagcataagctcttctctttcctgctacaaaggtgcaggttcaaagggctcttttgtttgaacaattaggtgagcaggaaggcaattaacaggccactcaaagtaagtgaaaggcaaaggaactgaagctgcagtcctattaaagaataacagataacaggtgaagattagcaggggcaagttcctattaataacaccacctattaatagcagcagtctctgaccgagtgtattgtccccaggttctgtgctaaacatgcaaaaagcattgtctcatttaatcatcaccacaggccaagcaggtgggacatgcgctcggaattgctgtgggtgtgaaatcactcaccctgctctcacactggagcttggggctcagccattctagtgccagtgtgtgtcccatgatttcagactgcctttctgcaaaagctgagaagacagcttcagtccgtacggtgataaagcgtatgtggagaagagaatcttttttctaatttgcaaggttgctcccagcatacagagctgggactttccactcttatacaaatcagcccatccttctcatctgcttttcaaaattgtacctcctgggctctcccaggaataagaaaccagctttttatggagtcatgcaattcttcaagactttttcctcagcaatacaaagaccaggcagccaaagcttggaaatgaccaagtcactgtttgtatgaactcagttacatttttaaatactttaattgatgcatagcgattgtatatattcatggagtacatagtgaggtttccatacctataatgtatagtgatcagatcagggtaattagcatatccataatctcaaacatttacttctttgttttggaaacattcaatatcctagctattcgagactatagaatatattactgttaactacagtcactctacattggcatagaactctagaacttattcctctcatctagttgtaattttgtatcttttaacaaatctctccctatctctctcagttacatttttaaggcaaacccttcattctgagtatgtgtctgagaatggcagtagagtagttctcttttcctctgttatgtttagattcttgaggtgtgcatttactttagaatgcatgacaactcttagtcactgcaaagataataagttgtagtcatgtagcaggacgagctgcagacaaaactcctcagacactgggttaaagaaggaaggagctttatttggtctggagcttcggcagacttgcatctcaaaagccgagctgcccgagtgagcaattcctgtccaagggcttacaactctaagagggtctgcatgagagggctgtgatcaattgagcaagcagggggtacgtgactgggggctgcatgcaccggtaattagaatggaacagaacaggacaggggttttcacagtgcttttctatacaatgcctggaatctatagataacacaagtagttaggtcagaggttgatttttaactaccagggtgtgtgccaggctatctgtctgtggatttcatttctgccttttagcttttacttcttctttctttggagaaacgcccagaaactgggcgtaagacactatgaggagtggtctcctcccttagtcatacctacattcttactttaataaaactgcactttcatgggaaaagcattttttttctggttttcatattaactggcttgggctgaagttatgcttaggaaagcttggacagtcggttgttgcaaccagacccaaggaggccttgtctgcctgggctgcatgaatgaggaactggggacaggtattgagactggagaggtgggaatcagatattccaaagcctaacctccttagtgaagcctacagatcgcctgttcctacaggcttcatagccagaatgcctttcttggcagatcaattgtccttctttggaatcattttaaaagctctccggctacttcatcctctccagttatcactggatcttttaaaggactctgaaatgcacactgagtagcagtcagcctcatttcacttacaaaaatgggttcctgagattttgctgtttatggatattttgtaaatagaatccgtttaaaggcactagaggaaatttctatttaaatgaatcctcctgggaatccctttgcattgaaaatgtgaattgatctgttccataacatggatctgtcagattttctcagggtggccttgcagtgcggcaccccagggaagaattacagtagagtaatggagcgactccaggctggcggcctctgcttgtgttcccgccatctgtagcaaaggatgcctcaacctgggcagcaggattgggatgtgaaacataaaatgtgctgtgacatcaaatatacaattctgacagcctcctactcatttaaaagatttcttgttaggtttttaagtcctttgggaggatccttctatcctcttacacaaggaatgctactcttgatgcaattaatctgaaagaggatttaaagacaatttctatgccagggcttccgctgtgtgaagccaacattaggttcaagtgtgcgataacattcgacatggcttacatggtaagtgtatgtttccaagagggactattaaactgaagtggattaaagacagctcaattttttataaccatttcctcacttgagtatttttatacttccctgccttcaccagaaggaagccacaaatctcctcaacagttgttaagccattgtgaacaaattctcaagctgcatttttatatcatccccctccccaggttcaaatctgacaactggggatgctgctgtggactcgggtattagccagggctcagtcacgtgtgagtgagagatgagctcctccaggaggggaaagcgggagcaggccttgctgctccccaagccccacacccctaacccctataccccacacagaacaacacacacaacaggcgcatacatcccaacacacacagacacacacaccccaccacactcacaccccccaacacacacagcaacacacacccaccacaccacacacagacatgcacactcacaggtacacactcccaacacacacacactgatgagacagccaggtgggaagggctccctggcaggccctctgactggcctgtgcactggtaggagtgcacgctggggtggagcatggggaagttcacgtctttgagggggaggagcctggcccctccttttcctgggtggaaactgggattcaatctgcggggtgggaagcacactagcagggactctggctttgcccagggccccgtttcccttttgcccaatacattccactttttctcacccttcaaagtgtctgcaagcctaatctctcatggccgtgtgacaagaacccagctcttagctgaactaaggaaaaagtcctacaacactgacacatacaccaacacaaacacacccagcacacagaccaacacacacacacacacacacacacacacaggcatccctgccacacatacactcaccccgaagcaaacgcacacaccccacacatgcctcccatcacacactcatacacaccctccccaagcactgtcagaaggcccacccaggatacctggagcattcccttggctgggggccatgagttgagatggactaagtgcaagtccccatcctgagagtgcaagccaaccctgagaggtcatttgcagagtcaagaatgactccagttgggtttcgtggtgcatgtgtgtaatctcagcatttcaagaggctgaggtgggaggacagcttgaggccaggagtttgagaccagcctggtcaacatagtgagaccctgtctttaacactttttttttttttttttttttagttttaatattctggtgacctggaagcttaattactaaatatctttttcttttgtcaattgcattgtcattacaatgtgtcaaaataataaattatatagttcaaactttgacagatttaaataaaagacaaaattaaaatttaattcaaaatattttccttaaggaaagattcaatcttctaaaaaatcattagtaaaggtatttatgaatgatcctatgttagaatgagacacatttcagcattagttaggtaaagagtaccaaacaccagccatacaaagggatggaaacgagtgaaaggagttgcaaattcccttcaattctttcaactctctctgagctatatacaaaaacattacatgattacataacaatttaacagcaaacattatttgtaatgctctattagcatacaggataagatccaattgtgtaaaggaaaaaagaatcccaccctacctctctcccagtcattcccttaaatgatcttttaggcatctgggaggtttatattcctgggaaacaatgtatcaagcgggatggtggaagcacagctctgtgcagggtggtagcaaaaaagaatcccaccctctacaggcacatctcaggcagatccattttaggaaaagtacttctggaaattggggatttggaagtagattcctttaaagtgcttaggtgcctgtgtaggccttgggaagtcttccatttcctccaggagtctgcacactgctgttcaaagattgctctaggaagttttccatttgagataggtaaggattagtcagaaaatacgatacaaactacaaggttgttaatgtagacattactccaccttgacctgatgtgccacttaaagccacacaaataatagttatctgtttagcacatactgtacatggctttgcagattctatctgtgtctgtctgtgtatgtgcaaatctcatattgacatagtctaatgctgagttcaaactgaattcagaacctgagtttgtgatgaactgatggggatcctgagccagtgaaatttgcagattaaaactaatgacctcgttaatatccacaggccaaggaggcctgaggacaatatgttcttacttacaaaagctgtataaaaagttgttatttccatgttatagatagaaaacagaagcacagagaagtcaggtcatttgcccaagatcacaaagcaagtgagtagtagaatagacatttaaacaaattggacttttaatgttatggaaggcaaccttagaagacggtctcagtgggcaagtctgagactcaccactgggggattattttgccccgatttcactgcaccatctgctcgtgcaggtatgcaaaggaaggtcacacacatcagggagttctgaatttcaattttatatctgaggaaagatagcgttgcaaagcagctgatttaagaccatctgatgacaaccaaatcaagaataacttaataattagtcattacaaagtactaactgcttactcattttggaagtgatataatgtaatggctaatgataaggaaactggaatcattgcttgggttcaaatctcaaatctactgttaataagctctgtgacctttgatgagttacttaacttttctgtttttcagttttcttattttgaaaataggcaaaatgatagcatccagctcatgaaattattacagaaattatataaaatagcacagataaagtgtttggaaaagcatgtggctaacacatagaaagcactcaataaatgcaagttactgttaggaaaatattagaagaaacttttaaaaattatttagtttttaacaattagggtaaaatatgtgtaatgtaaaatttaccacattaaccatttttaagtctgcagttcagtggcagactccctattcctaacatcactctggctcttttccgtatctataaatttgactaagtatctcatataaatggaattatacatcatttgtccttttgtgactagcttatttcatttagcataatgtcttcaaggttcatccatgttgtagcacgtgtcagaatttccttcctttttaaggctaaataatagtccatcatatggatataccacattttgcttatccattcatctgtcaatgcacacttgggttgcttataacttctggttattgtgaaataatgctgctatgaaaatgaatctacaaatatctttttatgtccctgctttgaattcttctgggtgtacatccaagatgtgaaattgctggattacatggtagttctatttgtaattctctgaggaactgtcgtagtgtttcccataatgactatacttcgttacattcccagcagcagtacacaaggattccaatttctccacaccctagccaatacttgttatttatttttaaatgttttaaaaataaccacacatcctaatagatgcatggtgatacgttgctatggtttttgatttgcgtttccctaatgattagtgatgttgaacagcttttcctgtgttattgtatttctttttgttgtttgaatgtgtttaatttccacaaatgtgtgaattttccggtttttacttctgttattgatttctaacttcatcttgttgtgatcagagaagattctttgtatgaaatatttttaaatctactgagacttaatttatgaccttgcatatggtatattgtggacaatttcccatatgcacttgaaaaaaaggtatatgctgttgctgggtagagtgtcctgtagatcaggggtccccaacccctgggccgtggagccgtgccacagcctgttaggaaccaggctgcacagtaggaggtgagcagaggatgagcgaacattactgcctgagctccacctcctgttagatcagcgatgacggcatgagattctcatagaagcgcgaactctgttgtgaactgcacgtgtgagggacctaggttgagcgctcctcatgggaatctaactaatgcctgatgttgatctgaggtggaacagtttcatcccaaaaccatcccccatccctggtctgtggaaaaattgtcttgcatgaaattggtccctggtgccaaaaaggctggggaccactgttgtagatggctgttagacctgattggattattgtattgttcaagacctctgtttccttgcttatcttctgtctggttgttctatccattattgaggtgggatattaaagtccccaactattattatagaactgtctatctctcccttcagtctgtccatttttgctttatatgttttgaaagtttgttattaggcacataaatgttgataattgttatatactcttgctgtattggaacttttattaatatataatgcctgtattgtcttttgtacccttttgtgacattaagtttgacttaagactttatttgacttaaattctagtttagttaccctattctctttggtcactatttgcatggaatatctttaaccttcgacctatttgtgtctttggatctaaagtggatctcttataaacatcatatagttggatcctgtgttttctatttattctgccaatttctgtcttttgattggagaatttaatcctttacatttgaagtaattactgaaaaggaaggacatacttctgtcattttgctatttgcttcagagatttttgttctgcattactgtcttttgtgtttagttgacttttttgtagtgaaagattttaattcccttctcatttccatttgtgtatattctatagctattttctttgtggttaccatggggattacatttaacatcctaaagttataacactctaatgtgaatttataccagcttaacttcaacatgtgaaaactcagttcctatacagttctagccccactcctgttcagttattgatgtcataaaattatgtctttatgcattgtatgcccccaaacaagttaataattatttcttatgcattagtctcttaaatcatgcagaaaacaaaaagtggagttacaacccaaaagttacaatgatactagcttttgcaattgtccatgtatttacctttaccagagatctttactttttcatatggtttcaagttactgtctaccatcttaccatttcaacctaaaggattgtcttcactgcagagcaggtctagtggtagcaaactcgctcagcttttgtttttctgggaatatcttaatttctccctcatttttgaaagacagttttggcagctataggatacttggttgacagtttttttccctaaacactttgaatatatcaacccactcactgccttctggcctcaaagttttctgataagaaatatactggtaatattattggagaaaatatgacgaaggctgtctttctctcagctttatagatactaataatgtatcttattgtttggtacataacagaacattttctatagtattatgatataagttgtagtataattttgagaccaattatttagagtttaaagaaaaaggaattgaatattttaagagtagacattatgagctctttaaaattcaaaaaatgttacagattgacaagctgtcattgaaattaaaagcatcatactggttttaatttctaaggtaaatatcaatcactataacccacataaaaaaaccttgagttttcttaagagcaaagagttcttcagattaaaaattaagaaaactgctatgaattatgcccagtcaacataggtctatgtcttgctttgacctcataaggagccattgttagagaattccaaacacttatataagttcttgactgggcctaggtttttgatccttttagctcagcaagctggtgtttgatgacctgagggactttgaccacagttagcttgtttgcccttgattttttttctattttgttatttttccttttcttctctccatattttttcttattcttttaaaatttgtttctttattttttagttgtattttcttatctttttctttgttctttcttcctttttctcatatgatggcctttccatgggtgtgtggagcctgagagtcattctctacctgatgaccactggtccctgccttttgtgggagaggactttgaggagccgcaggatcctctctcccttcactttacatacagtatgaagatcctgagctccgtagagccctatgagatggtgcaggagatgagccaggtgactcaagcagctgcacatgggagcgacgcaaccagcacaatttgctgtgtgtacagggcatgccctgctgagagggattttgtagagaaggaatacaggtgtgcaaattgttgtggcagagttgtcttcatggggtccaatttatgagggtatctggcacctccatgtccttcaaaaatcatgtgtccaaagtaaatgctgagcttaaattctaaaggacaccagaggccacctgggagacaggaaaggaagtccacctggtcctagctgcaggctggccctctgccccgacctggggagcttgagactggactatttctcgaggcacctctccaactcatgttcttctctcttttttcttctgtgtttgtgggggaacagagatggttttcataaattacttgacttcatttcttccaaatcttgtaatgaaattgatgctccaggaagacacaccattattctgctgttttgcatccttcctgcccagaaatggggctgtgggtactccagtttgaaaagcatgtagtagtacagcacttggagttaatcagaaaaagtaaagaaaaaaatgacttaagagaattatcatgatccccatcaaaagcagctaattattcaaagtagcaactgaaggatttttataaagggatattaaaagtggttctgaacagatacgtctgtatttgtcaggcttctccagagaaacagacccagtaggagatatgtatatatatgaaagaacagatttactatggaaattggctcacacagttatagagcctgagaagtcccacggtatgcaagctggagaaccaggaaagccagtagtgtaattcagtccaagttcaaatgcctaagaacgaggggagctgatggtgtagctctaactggaggctgaaggcctgaggggagtttgagggacaaccaggggctccaatgtctgaataccatagaagatggacatcccagcttcagaagagaaagaattcacccttcctccaccttcttgttccatatggaccctcattggattggatgatgccttcccacatggagagagagagatcttctttgctctggctgattcaaatgctgtctcttctggaaaccctttacagacacacctagaaataatgtttcaccagctctttggacatcccttatcccagtcaagttgacacatacaattaaacatcataagctctgagccttactgcagggcagaaatgcagaaattgtgtgcattacctttctacacaaactttcttaatactttcagaaaaactaaggagaactttaggccccattggcctgtgtcaattgtggctgagaagtctgcaacaggataatgaagtcttgcgaaccaggctgtgttggagtcagagaattggtatgggtgtggtcaccgaaatcagctaaggaggcccctaatctgtgctgtcggctctcctgactacctaagtgcaggagttgggtctgtaaaccacagtgactgagacagatctcaattgatttcgaggcttattttgccaaggttgaggaggcaccagagaaaaagaaacataaatcacagtagaatctgtatcctatgctttttccagatagagttttgggaacctcagtgtttaaaggggaaagagcaatcaggaggggaagaaaaaggaaaaataaaaggagggagggtaggcaatgagacaagtggttacaattcttgtgaggctctgtgaatctacattttacacctgaaaagaaagcggaggagtcaattaagcattagtctggcactcagcaaatctacattttacataagagaaagtcagcctgcgaaattacagctgtcttggaacaaaaggaagggagtttttgcatgactcagtttccaagcttaacttttccctttggcatagtgagtttggagtcccgagattttattttcctttcacaggcctttccactgtggtgttttcttctgttttttgtttgtttgtttgtttgttttttgctttttgggtttttttggggggtggggtggggtgtgggacagagtctcattatgtcccctgggctagagtgcaatggtacgatgtcagctcactgcaacctctgcctcccaggttcaagcgattctcctgcctcagcctcctgagtagctgagattataggcacatgccactacacctggctgatttttgtatttttagtagagatgaggtttcaccatgttggccaatctggtcttgaactcctgacctcgtgatccacccacctcagcctcccaaagtgctgggattacaggtgtgagccaccacgcccgaccttttcttctgtttatgcagtggcatggagcagtccctctaagagggctgacccaggtatgagtcattcagtcagcctgagggtccaagggctgctccatggtgaggcagacatccagaagggtccagagggagaatctatggcaagagacagcagtctagagggatggaagtggtggcagaaaagctggcttttaaaaggcaagtttttattctaggctgactttctcttatgtaaaatgtagatttgctgagtgccagtgaatttataattttagaaacccatcagggagtttctagatgagtttctaagaagtctaagaaatgtccaggaaggcccttagccacctcgtggaaattgggagagaagaaatgtgtgcagagaaaagagggatttttgatgcagagaaaaagaacaggtgtgtcccggctgctggctctgagtaacccgtctaatctcactgtacagaacgtacctgcactttatactaacaatgagtgccattcagcgtgccatttatgatgttcacagtggccttccttggtgtggtccctgaagccctgcaaagcagggactgtgcggtctgaaccaaacaggggcccctgggaatagggtagcgtgttctgatacctgagctggtagtagagtcagagcaagaacaaaagccccagcgagcaatctgggttcaacccctgtcaccttagctcacgtgcctgcattgtgaagttcacggtaatagcttgactgcattctcgccatggttctgggtcaataaatcagtcagtaagcactgggtgagtaagtagtgcagagcaaagtctgagcttggtgccacaagtggataaaaaagaaatagatgactcaacctctgcttatagggaggctctgatctagctgagatagcacagaaatatttggagaatgactctagtgcagaactgaaggtgcagaatgactctgaaacgttgctgcacagcagggtccaagaaaggagagggcagtgccagctgggtatgccaggaaggcttttgggagaaaaatactggccagggtctgggagaatcagcaaacatgcctgagggtagaaaaccagtgtcccaggacagggaccctgtgcagccctggggtgggctgggtgggaccgagccggcagtgcctgcagggatgatgggcaccagagcacagctctcagcctatgtgtcccggagctctgggcgctcccaggtgtcctcactgcaccgtggtagctcctgtctcatggagccacctgtcctagcacaacagctccaatcactgctattagaacagatccaaggggcaggctgggagggtgttaggttcaaaaaggagcactatgtagaagcaagaaaagagatgaaagttttgctcctatctgcatctggccagagagcagactttgatttgcaacaccgtgtggtctctgcaggattacgaaagggaagagggggtgggcggaaggctctcctccccagtgcatcattttcagttttgtcttttactttcaaagaaagctgtctttctgacactgcattctgccctttctgacccatgtcccatatttaaaggcttcacatagactatataatccaagttatccctctgtggagaaagtggctatgagaattagagagacaaagggtgtgcttgtgggaatgggatgtaacgtcagagcaggttcaaccttacagctgtgcagtccagttagtcaaatattaatgagtcaatttaattaaagattaggtcctctgttgcactagccatcctgcaaagtcacatgtggcgagtgttttcatactggatagcaccacagaaagttctgttgggcatcattgccacttggaccaagggatcaactgctttctgggtgggagaactgaggcacagggaaccacggcttggactccaaacttagtgctctgatcagtgtgttgtccaaagcttccagcagacaaggattcagaccacacaattcaggagcaataagatggctggagtgaacaacaagtttcccttgactttagaagaaaaagatctctaaatcctggagatgattacatgcttttcctgagggctgaggaaagaggagaagcagttggtttgttttcaattagccaccctcctcctttttctaagaagaggaaagtcactgccaggtcacagggctcggagccagggtcagcagaggggctggtcggagcacctgagccaagtgggctgagactctgatcctcgtgagtgtcacctgccaccaaatgctctctcctgggctctgccatttggttttttatgtctgcactgtgctgacccttccatctcccaagcacccaatgttcaccgcccctccttggcatgtgtgccccctccacccaacacacgccctctagcgcagggcgggatgggggccgcctgcagctgggccctgaacttcaaagttgggagaacctgagtcactcatcccagcaaggtgggcttccaagaaaccccactcccacactacccctgtcttcccataggttgtccctgggtcctgttagaatctcagagagacatgggactacgagttatccaaattcaggaatagtcagaacaagtgagtgaaacacacctttgcctgcctgtgaagggccagcttctgcacgggcaccagagacacaaagataaatgctcccaatgacctgatttactaaggaaggagagagacaggaactcactgcttaagggctacgtttattcattcctctatccagcaaattcttcaggactccagctgtgtgcccagcattatgcaagagctgggactttaattttcagtaagacctgctttttcctttaaggagtttgaatctaagaaggaagcaggcagcactggagcaattaccccacagtgccacgatccttgtgagcataggagctacaggaaactcgaggagagcatccaacccagtttgggaagttcaggtgtgcaggagacacaatggaggctcgaagggggtcgactctgcctggggagggtgcaaggaaagcttctgagaaaggcagtgtgggggcagctggagctgaatcttggagtatgaagaggggactgcacacctaaggcaaggaacacaaccttcaggaacggagtttgggtggatgccgaggtagagggttgggcttggagggatgggaaggtgtaattgtgataggcctggtgtgctttgctgaggattttaatttgatttgggagacactgagaggtggaaagcatgagagtaactcaatcagatcattctgattcttccatgtggaaggcagccctgtaaggcaggggagggtctggctgagagagacaggcaggaaattgtggcaggaacccaggtgagaggggctgtgcggggatttgaggaggcatggacagagcgttctccaggagcctgctccctgcgctgagcgactgactgtatccggtgtgtgtgtgttgggggtggggtgtgtctaaggtgatgctgggattcttacactgcagctgttgtatcaccagcagcaaggatgatggcgcaggagacactcaaggtcattgcgagggggcacaaacacctggagaaagtagctcatctttgagagcaccatgtgctgcagtatcattcagtaggaccttttttttttttccgagagaggatctctctgtcacccaggctggaacacagtggtaccatcgtagctcactgcagcctcaaacccctgggctcaagcattcctgctacttccagcctcctaagtagctaggactgtgtcagccaggctgtgcttgaatagtgagattcaggcatgggccacaacacccagctaatttttaaattgttttgtaaagatagggccttgctgtgttggcttaggctcaatataacctttctatgggacatttatttgtttagtaaactttctctgcctctctctctctggttttgcttttaaccccagaggcctaagactgagttgctgatcttcctgtttttggcccgatcacactcctgaaaagactcttttaactctcatttcctgctccagccccgtcctcccataggcagcttgctgcaacctgctgtggctgatccactgggtgggcccgagcaatggctgcatttctagtagggggagttctccttgccacaggagatcacatacacactccctaggctgagctcaggaatgcaaactcaagtcagcctaacagggtgaggctgtcccataggaagcaacatttagaaaagagtcaggccagactggattccaaccctgctgggtgcagatggctggtcggcaatgccccacagctgtcttggccttccatgtggactgctgaggcttcacatttccccttagtaacacagctggggcattgcaagggggtggggtgggggagctgaactgcagaggactcaccttctgtgggagaagatggaagggaggggagataaaaccgcagctgactatattctaagcacagtccagatgtttaaatccttattgacaacttaaaaacaaaccaggggtgggccgggcgcggtggctcacgcctgtaatcccagcactttgggaggccgaggcaggcagatcacgaggtcaggagatcgagaccatcctggctaacacggtgaaacctcgtctctactaaaaatacaaaaaattagccaggcgcggtggcgggcgcctgtagtcccagctacttgggaggctgaggtaggagaatggcgtgaacccgggaggcggagcttgcagtgagccgagatagcgccactgcactccaacctgggcgatagagtgcgacaatgtctcaaaaacaaacaaaacaaaacaaaaaaaaaacaggggtttagattttgggataaaaccaaaccaaactcctaaatgttccatagaggtggtaaagtggtaagaggatagttttgaaacctacaattgctttttggtttatgtgtctgattgaatgttttttcttgataaaacttaactgagtacttagtatatgccaggcactgtgttaagaatgtgacctcattttgggaggctgaggtgggaggatcgcttgagcccaggagttcaagactagcctgggctacatagcgagaccccattactaaaaaaaatttttaaaattagccaggtgtggtggcacatgcctgtagtcatagctacttgggaggctgaggagagaggattgcttgagcttgggaagtcgaggttgaagtaagccgtgattgcaccactgcactccagcctgggtttaggtttttatcagattgagagactgagctaagagagtaatgatacttatttcttgcctgctttactggggtgtagggggaggtgacgatagtaggaaacagtgcctgggcctcctcaaatatttcctagagatgggataacagccacgtatcctgagcaaatccaggcaggctctgtgtcggtgctgcagatgcagggacaggtcaagtattgcagggatggtggggggcagggggtggtggcccctgaggtggcctgtaggggtgacatccctgagtggagcaggctgatgtgccagcacccccattaaaggccacttttagggcaggtgctagggaggctgctggaggaaaaaatgactgggggctaaggaagcagggcacagagtggagttgctggcagaaggccacaaagggttttgttcagcttctctgccagatgcatttattttcagagatggcctgctggagccttctcttttctatatgcatcctctcgagacacagactaaagccacaatgctcacctctgctgtaggggagtttgcagggcaggcctagaaagggtcagctagaggcaacctcttttcattctatcctgataatcacttgcaaattccaataggcaattagaaaaagcaccaagattgcaagagtgctaattttccagcatttccttggtaaaagctccctgtgattttatggggaaggggcgggacaagcagtggctgcacggatcccacccagccgctgcaccaggctgtgccaggagccagagggaagcactgtatgcaagtaaaacgcactcctgtttcaaaatgttttccagcgagctgtcctgggatctctggtgtgaatgcaccctaagcacagactgacgcgcgctcccttacccttctgaccctgcttcctgcctctgcttatcacccgccctgggttcagagtttgagatgcccaggctctgtgactcttcacttccaacggctccctgcagcccatgccggccaccactttagcactggtgaatgctaaagtgaatgaaaaggagatgggactccaactttgtagtaaaaaccacttactctcttattcatgtgcaccctctctaacccaaactatttttgatgaagtacttcaccaagatgtgtgtttttagttggtgggggagggggtagaacaggagaggatgaagagtagaggagagcaggactcttcctcctccacagaaggaaacttgtgaaaacatgtgggaccccaggctactgctcagtagagtcctcgaggtgtttatatttgcccagtgctggactcatgacagattattttgcctgcagggtcttaacaacattttgtaggtggtcttgtaaaggaaagcaaatatttaaggcttttctccttccctctccctaattgtttatgtggggagagaggtaccagttgctcctgataagagcaggccacagccccaggcagctgcacagcgcacagccatgtgagcagctctggcctgctgtggtgagcactgcgttgacttcactgccccctgggaggaggccgccagttaagtggggaaaatgcatctgaaaatgttgaagtggattgcttccactgtcagggcatttgggggaaacatctatgaaattggtatagcccagatgtctttatatgcacatgcttagcaaatcaggatttaacagatggcatgaatatatatactttgcatatctaaagatgcttatatgattaaatgtaagtgattttgaatacgtgtaccatacacatcttgcaaaagaaaagccgaccaattatatggtccatgttatggtttacatatgtggccatcattataaattatgtctatcaagcacttacagggagttgaattagttactgtacaaagcacacagccctctttaggaatttatgatctggggaaaacagtgttgcctgcaagggaattaaagactgtatcatctgtaataacaatcgagattagtatgtggttttacaaggtacaaagtactctcaaaacatatcatatgatcttcacaaaggcctgagaaggttaagtgtctagggaaaggtcatgcagttattcagagctaggcgggttcattaccaagttttggtcagttctttcctgcccctagtgctgacatccgcaggtccagtccagccctgggactgggtgggtgtgaggggccttgactgggaatctggatgcagaggccatgctgtgtttatgtgataggctcgctgtgatttctgtggtgtggagagtggtgagcgtggggtcggatattcaagagagctgcagcgctgatgggcaaggctatgtggcagccatgggggctaccttgaggccaagtttccttgggggatggggccagggatttgcaatagccagagtccccccaaggatgtgatttctgcagggaaagcactgcttggatgactcgttgtccggagttgtgcccaccaggtgttggagaacatgccagagggctgggtggacagtgtcagcggagagactggagaaagcagctggtgctgagcaggtgcaatgggctgggctcaatgccaggaagctgacatcacttcatctccccttctttcatcaaaccttttagcaccctcttccacaggtgaggacagagagctcagacaggctgaaaatgtgttcaagcttacatgatctggtaagtcagagccagcctccgagccaccggcttcctctgaagcctgagttcctacccattctgctggctgtctcccgagtactgtgggcacatgaggccagagatctcagaattcagctgcactggaatcccctggagggctggctgaaatgcaggttgcctgctcccactgagttgcttactccctagggtgcagtgggccggagaatctgcatttctaactagtgttcaggtgctgctgctgctgctgctgctggtggtgggtatccattttagggaccactgcttgaggctgggagactggctggggcaggggacactgaggtctcattctgattcccctgggacctgagtgagctcccctgagcctgctggtgaattcccattctggctgttcatgtctcgaggtgcatggggtggggagacgcctcttttcagaagtgcatgttgcccagccacaggagctacgtctttttgtttatgtgtttgtttttgaggcagggtctcactctgtctcccagactggaatgcagtggcacaattacgtctcactggagcctcaacttccagagctcaagccatccccccacctcatcctctcaagtagctgggactataggcgcaaaccaccatgcccagctaatttttaaattttttttagagaggaggactcactttgttgctcaggctggtctagaactcctgggctcaagtgatcctcctacctcggcctcctgaagtaatgggactacaggtgtgagccacttcgcccagccaggaactatgacctaagcttccccttgttaacctgtgccaggcacacagtgactgctcagtgaatagttagcatctcgctggcttgcctaacaccctcagaggcctcagacccctcagtcatgaacccctgctgccgtcctgcatggatgctgcccttgttgtggggccaggatgtctccattcttgtccacggagctccaccatttaggaaacaagtctctttctggggttttagaactccgtctatattcaataaaattcacatgatcattcagctaggactgcccccccgggcctgcctccttgctgagttctgggccccatttctcccagtgggagcagggctcggtcagcatcagcagcagttcctgagtgagggaatcacaagcgttgctgctctgtggggtgtagcctcaccccatgggtctggagcaggccaccagtgccagtcccaggtttctgtgcccaggaagacactttctacaacatcagctctgtgggtgaatttggaggagaaaagcatgtttttaaaatttctgccaaagcagatagacattttatagattagaagtacaatttgcatgattttttaaagataggaatttagacgtgaaggaaatgtgcttttgaatggggccagtctccttggtgtaacactatcgctcttctgagcctgtagggtcatttctgtggaaaaatttgaaagtcaatgacgaagagtaagcaaagcaatggagctgcaagcagtgaccatcttactatcttgatattgagactttatgtaaatatcagctgcagattttatggaagagaaagaagtcgacagggagcaaaagttgtgtgtgagggatagtggtcctggagctactgtgtgggaagacaatggatctgtcctggacaattgctgtcactagcctgcagccatcaacatcaagaagtcaacacttgttcacagcctcagtattcgtaagggtctgtgttgccaaaggaggtcacaatgatccctctatcccaactgcccttttggtggcatcactttgccagttggtctgtgacttgctttggccaataagttacagcagaaattctcccttaagttatagcttctattctctctctgtcttgggagccagctgccttgtttagaagctcagaccaagctgcttgttggtgaggtcgctcagacaaaggtcagagtgcaggaggcttaaggcactgggcgagagccagcatcacgcctagacgaccgcctgtggccagctcagggccagctcagtcacccaatgatccctgtggagcagagatggatcattctgcagagctttgcccaaattcctgagcctcagaatcaacagaaagaacacagtggtgttttaaaccactacgctttgggatggtttgttacgcagcaatagacagctggcacaggccattggcacaaccactttgttgtgtattgtataggcacagtggtacatttaaaaatgcttattatcttccttaaggtaataggtgaagagtctttaatgagaataatccagtaaataagttgattaaaaataataatgtcaaagctgggtgtggtggttcatgcctgtaattccagcactttgggaggcctaggaaagaggttttcttgagcccaggagtttgaaaccagtctgggcaactgaaaccccatctctacaaaaataaaataaaataaaataaaagattagctggtcatcgtggcatgcacatgtagtcccagctacatgggaggctgaggtgggaggatttcttgaacccaggagtttgaggttgcaagtgagctatgatcctgtcactgcattccagtctgggtgacagagcaagactttgtctctaaaataataataataataataatgccactattagccagaatattagccttattattagccttattggtcaattaaggctactttgaagataattccgcttaataaaatataccatacaataaccataagacaagagcagatgggtgagtcttgaagcctgggtgctttaggagcaactggaggaaaatgctgcatgagaagacactgcaggagaaactctgacagttcttgcgtcctgggataaaggagggaggcttttgtcagagctgaccgcacatgggatacatttgaacattttctctttccctttcagtgaagcagagcctgcagcccctggccagtgcatgtggatcttttctgcttaatgttttgtttacttcactgctggttttcctgggaacactagtgtgtgttttaaattacctctctttcccctttagaccggaattagcctcttttccctccaaggcaagattctgtgtgccagtgtttcagggaaaaactctcaaactgtttttcctctgctctcacaccacaaccatcaacacagaagtcttctgtgcccaaatgcagggggcttgttttccaccaacaagcagtggacggacagcagctgggtgtcctccaattcaattctgacactatctggagatagcatcaagtcccccaggttgagggctgagtccccaagactgcccctgacactgccagacaccagtcatgagcctctggaacatctgacagagcagcttcaacttggggctcccacagccgcctctttcggttcaattaatttgctggagcagctcacaggactcagggaaaacgctgacaggtttattataaaggatattacgtaggacacagatgaagagatgcataggctaagatatgggggaagggacacacagcttccatgccctctctgggaacctccatttgttcagctatcaggaagctctctgaaccccgtcctcttagatttttaaggaggcttcattacacaggcatgattaaaccatgtagaaatgtgactggaccaaaagcacatgatcgaaatccagcaaagcctgtctgctcagacttttcttatctctctgtgcaggattccttccttcctctagggcatggggcaggaccctctctggaataagggtttttgacccaccgtcagattcgagtcttgccttgggcaggtgaaagacaggaggaggtcagagagagagattctgtttcatgaggcctgcgcctgagggctaaagcaccccaacactgtaacgaaagaccgtgacaaaggctatggggttatggccaggaactgttgataagagatatatatatataaaatcataatcataatatcacacccggggtgcgtctcatgttcccatttagcagcttctttttcctttcttttttttccccgtttcttttcttttcttcttttctttctttctttctctccctttctttctttttttgttttttttttgaaacagggtcttactctgttgcccaggctggattgcagtggcacaatctcagctcactgcaaactccacctcccaggttcaagcaattctcaggcctcagctacctgagtagctgggattacagacatgagccaccacgcccagcagcggcttctttcttgatgaactgtttctactatttttcttttcttgttttttttttttttttgaagcggagtctcactctgtcgcccaggctggagtacagtggcatgtaggctcactgaagcctctgcctccagggttcaagcaattctcctgcctcagtctcccgagtagctgggattataggcaggcaccatcaaactcagctccaattttttgtatttttaatagagacggggtttcaccatgttggccaggttggtttcgaactactgacctcaagtgatccacccaccatggcctcccaaatttctgggattacaggtgtgaactaccacagctggcctgtttctacaatatttctttttctttttgtatataactcactattatttttaaaatggtatcaatataagtaacccttgggaaaggagcggggtacgattcctcctctaactgagcagcagtcgttggaagagtttatgctcacacctcctcttgtcttgctcggctgtctgctctgcagaacaatgcagactctgactggactcttagaaacagcaagtttagtctgcctgctcatgtcccaccttgcagagctccagctgccggggtgtcctggctgtgttcctcctatttaaccaagcttagcccgacagtggcatcccagcgaggcagggtggctgttccttcgctcctcctgctcctagtgacattatggctcaaatgaatctttaatttgcttttcattctccattcccctccatctttctctcctgctctttcctctgacctccccagatagccattttttcctaattcttcacacttattttaacccataggtatttgtagagcacctgcaatgggtgaggtgctatgtttggccttggggacacagaggtgacctagatctgctcccagccccagggaatgtgccatctagtgaggacaaataaaccaacagaaaagaaatattcaaatgaataaaataattgcaaatggtggtaagtgtcatgaaggaaataaacgaggagcaagctgtgtcattttaaccgaggcctgaggtagctaatgaattagtcactgaaggagggctgggatgggtcagaggaagccacggggcacagtctggacattttcagctttcatcctttgtctgtgcacattgctgactgtcttctgctccctaattcaggcttggccagacttgtccatatcctaaatcttagaccctcatggcaaactggtgggccacaaggctggcctctaaaatctaatcacttgaagctggtcccaggagactcccatggagaataaggttgattaaaatttatttgcttgaaatatttttttattgctatactttttttaacaaaagaaatacatttgtgtagaaggctgggcatgatggctcatgcctgtaatcccagcactttgggaagccaaggtgggtggatcacttgaggtcaagagttcgagactagcctggccaacatggcgagacccccccccgccacactaaaaatacaaaaattaaccaggcctggtggcgcatgcccataatcccagctactcaggaggctgaggcaggagaatcgcttggacccaggacatggaggttgcagtgagccaagatcgcataattgcactccagcctgggtgatggagtgagactctgtctaacaaaaaacaaacaaacaaacaaacaaaatttgtgtagaaaaaaattatagcaaaaggaagacatcaaaatatctataatcctaccactctgatataattatttttacacttctggttatcttcttccagaacttttcttatgcatgcatatgtgtgcataaataaaatggacaaaactgtgtgcctattcacttaatagtgtatcttggtcatctttccattacctgccacatcgtttgttcacagcaatatcactttttctaccctagttttaattgatcttactgctagacatttgggttatttgctattcaaaacaacattttaattaaatgtctctgtagctgaacctttatgcacacttctaatattgattattgagtcaaagcagttgcccacagttatgaatttgaacatggatcttggctaattctttaaatacacatgagctctccacaacctccactgctatctggggcagacagggacacttgcagggacacgggctgtgtcctccccgcatgtgtgagatggctatgtgtccactcatcatttctgcagttggattgctgacaataatgagttttttctagatcaaggcatctggaccaagagagaagaaaatatttcagggactgagcattaatggccatagtgcattaactgagcataacggttcatttggagagaaaaatactgaaggaaacctgggtggtcagaaaactctaaagccaccatatttgtggttttagtttttaaactctccctctccaaaatcccaaagcattttacctctgctgagtctattttaatggagaggaaaagtgagaagtctaaactttctcctaattgatttttggctgctgtgtctatgagagacatggaaacactgttctttgcagatttatttcttcttatattagggcaaagttgggtctatttatttctgtttccttggtggtttgataattatgatcagtgagagtattgtgagtggagggtaggggagtacgttacagaaatcattagccatcattagctacataatcatccccaataatctggtatattgtggctcaaagagaaagacgaactccaagcaccaaagaaaagaatgtcactcaaaggtcaaatggcccaggtgagcctggaatggaaagagccatcgtttatgttgctagtctactaaagctccccaggattgggaattcatataatgaagggaagaatgaaatagtccaacatgaaaacaacattgctgggaagtccttttaattcaagctaggccattgtagcaggttgtcagagaccctcaaggtcacacaactgtacttgaactgagaacttgcttccactaactggggggtgcatgtgagcaactcagcttgctccgactctgtctcgggccaggtctgcactggagctggtaggcggatcaggagaaagacatttctcaacagctgcctctctcagcctccctcctcctccttattattcctagaaatgacaacaaatgttgcctgttttgcaaaagggctgcccagctgcttaatttgcaaataagaaaggataaatggattctttctcattttggaactggagaaggggaaagcaggagtttagtattttcaacaggagaccagaccctgtggaggccaccctaggaatggtgaggctccacggtgcctgatgggccttctgattctttattgctcagtaacaaaccacctaaaacttagtggcttaagaacacaacattcagtttgcttgcagatctccaatttgggcagagttcagcgaggacagcttctttgtctctgctccatggatagaggctgaggggtgactagtcctggggctgcagtcatctctgggctcacccgttcaacatgactgggttgttgctgggggatcccacttgggccatcaactagaaccattataggggcccctccctgtggctgctgggctacttcacaacatgatggctggattccaggagacaggaaacagcagccaccagcttcttcaggaagcatccccttctgccgtactcaagtgactaaggagcctcagagagctaggactcaggagggtcacacgtagacccccccactcttagtggaagggctgtaagagataccgggccttgttttatagtggtcacagtggtttatctttcagttgtagaatcacagcatttacttcttagaagtcattgaggccattttcaatgaacctccacactttgcaggaaccttgtctgcagcacgctagcataagttagttgtggtctgccctggactgggagatcgtgtgatcatcacagagccatcctacagcaaggaggacccggaggcatcaggcgcataacaagaacatgagaaaggcccttcctttaagcccttgagcccctggctaggtccctggcaggactactgggatcagcctccaccttttctgtgtctttcagaatggttcagatgcagaggaggagctgttagaagtgtagtcccccagaacccgtgggccatgagagccagaacagccagtctttgcacatgagccagtagtccatctaagtggtactgccttaggagtttactcaactctttaaacttactgccgtcattatcaacaaaaccatcatcttcaacttcattacacttgacggtatctctgcacttcttagcacctaccacttgacacttatgcttcctgtgtatgcccacataggtgtgtatgtgactctgaaatctgtcctccttactagaaagtaagcttcatgaggaccaagtctttgagtgctttcctcattactgttaccctggtgcctgcaacagtgactgcactctgtaggtgtctaataaaaataaatagttttaagggaataaatgaatgatcaccatcaccattgtcataatcacctcatagtgactttttgtttatcccaaccaaatgtctgtctcttgattcttatactttctcttaatccttgtttttctgctaaaaagacataaattgctaaaatgtttgataagcagttggggggtctgctttcttttttatttgctaatcaaacaagttatgagatctttccttggttttggctttgattggaagaattgttgaattagctgttccctctaagtttacttttagttccaaaatattaacatataaaccatagataaatgcagctacagctacctatgccaaaaatttcctgcacaaattctgatgacttcatgagtttgtgttagttataagaggtctaagaatgaggaaaacggtgtcatttggtaggccttcagtttagaatcacgacatagcagggatgtgactttcttaaaaccaatatcctagcattgtgcttcaccttaaaatgaatccatcactaagcttaaatgatgaggaaaatggaagaaaagagaaattctatttcttatgaatttatttttatttttattttgtgagacagagtcttgctctgttgcccaggctggagtgcagtgacaggatctcagctcactgcaacctccaccttctgagttcaagcaattctcctgcctcagtctcccgagtagctgggattacaggcatctgcctaatttttgtgttgttagtagagacggggtttcgccatgttggtcaggttggtcttgaactcctgactcccgtgatccacctgtcttggccttccaatgtgctgggattacaggtgtgagccaccatacccggccttatttcttatgaatgtagcacttaggaaaggaaggaatctggcctgggactcttacttctttgacttctctgggttctcatcaatcaccaaaaatggtcgactctgtctcagaagcctcctgccttccctttctcgtccaagcgtccatcacacagcaccacacctgagaggtgatacagtctctagtccctttgccgctggaggaaaactgaagacctaccaaataatacgggctcttaggaggcctggaagctgtggttggtcagtcttatgctcctctcaaggccctgttcaatttgcctgcttcctgaagctgacccttattcccaggcatggtgacatcacatccacccagtccctttagctccgattttccacactgtttttttcgcatcctaagtccattatcttttattcttagtcattttcttatactcatgactagtatctctccatctaggattcaagctgcaggtctgagaggaataaaaaaatagcaaaagaaattatcaacagagtaaacagacaacttacagaataagagaaaatatttgcaaaccattcatctggcaaaggcctaatttctagaacctataaagaactcaaacaaatttacaaaaaaaaaaaaaaagacaaataacctcatgaaaaagtaggcaaaggacatgaacagaacttttcaaaagaagacatacatatggaaaaaactcaataccacttgtcactagaaaaatgcaaatcaaaaacacaatgagataccatctcacaccagtcagaatggctactattaacacgtcaaaaaataaaagatgctggcaaggttgcggagaaaagggaacacttatacactgttggtgggagtgtaaattagttcaaccatggtgaaaaccagcatgggaattcctcaaagagctaagaacagaactaccatttaacccagcaatcccattcctgggtatatactcaaaagaatagaaatcattctaccatgaagacacatgcacgtgaatgttcattgcagcactgttcacaatagtaaagacatggaatcaacctaaatgcccatcaatgacagattggataaagaaaatgtagtacatagacacatggaaaactatgcagccataaaaaagaatgagatcatgtctcttgtgggaacatggatagagctggaggccattatccttagaaaagcaatacaggaacagaaaaccaaagacctcatgttctcccttataagtggaatctacctgaggatggagagtgggaggagggagaggatcggaaaaaaagactattgggtactagtcttagtgcctgggtgatgaaataatctgtacaaaaaacctctgtgacatgagttgacctttataacaaacctgcacatgtattcatgaacctaaaatataagtttaaatattgtttttaataaaacctctttaatacccacaatattcagcacttgcttctggtcaccaaatgtgtgtggtttttcccacaccaagcaagtctccaattctctgtggactccagctgggtatcctaccattcaattcaatgctgacgctgtctgtacgtagaattaatgcagaccctataggttatgggctcagttctgcaaggctgcccacccccattaattcagacaccagccacaagtccagttgacagctgggcttctgatgaaccagctataatttggaagatccccctcacctccttcccaggttcaataatttgctagcacagctcatagaaaacaatttacttactaaatcacaagtttattataagactacaactcaggaacagccagatagatgagctgcatagggcaaggtattggggaggggtgcggtgctttcatgcattctcctgggtgtgctaccctcccggtatgtggatgtgtttaccacctggaagctctgtgaacctcattcttttgggtctttagggaaattttattgattgcatcattggccatggtgattagctcaatctccagcccctctcccctccccaaaaggtaggggtggggatgaaattgcatctctctacacggttgggtcttctggcaactgatcccccatcctttgggcttttcaaaaatcacctcgtgaacagaaacagtgtaattggaagggacttgttatgaataacaaaaggtgttcctttcacctttattgctcttatctcgtaggaaattccaaaagttttagaagctctacaccaggaactgggatgaagaccaaatatatttctcattataagtcacaatatcacaaggcattttaaaacatatcgtattagtagggaatatgaggtagagtaagtccaataggttatgagatgatcacctttggatggagagtttactactcacagttccaagaggaaggatcatgccatgaatggggtgggggcaccgaggaggattggtcgggaggcagaaggagcgagggaaaaacaagggcaagaatctttagtgtggtttccatggtaagtaatgggtgatgcagtgtaattaggcttaagaatggctagtttgaataatttccgtggactctggggcataggggctggccctaattgtctgatacctggctccaaggtgattaagacaggtggatatgatccagtgtccccaataaagaaggcagtgtgggtgtgggctctggattggttggtttgttatgaaaggtgtgctcacagacaagttgtttattatccctaaaaattgagtaacctgacaggggcagtcccgccatggtcagcaagaccccaggtatcacggcatcagaatacagaaaataagacatgggtaatacagctggtgactaggaaacacattttatgtttttatctctagtgtctggtcttagcagtctacataaatattatggaataattctaagtcagtgtttctcaaaatggggcctacagagcatttatatcaagctcatttgatgagcttgttaaacacatagatccctgggcccctgccatagacatgacatctcagcacctctggagatgctgggtcctggaaatcggtatattggcaagttctctgtgtgaaacctgtgtccactctgccttgagaactactgtagtgtcttatcgatctcttctccatgctggcccatcagtcggctctgagttcagaggaaggcttagttaaactcccaagaacttgagcaactttcccaaatggaaagcaccagtctctcatctccacatccctggctcagtttgagagaattacttctggaactgtcaggggcttcctagagcactgagacagaaacaactttcctgtctcaattaagtcaggtgagggagtgggtgatggggaaagagaactctactctgggctgcatttggagctgtagaaaaccaagatatgaaaataacttaatggtaagttatgccctaacagctactcattgggctccaaaaggccaagaagcttttttatttttttgttcaattatgtttggagaaatgttatttgagagaaatatcagttagaacctacagtcccaaaagcagagctctggtgacccacctgggctttgtcaaaagctgggggcaaggtgagcagccaaacagtcacggaaattagggctgaagggcagcaggggtcatagggggtccacacaaactgctatgacatgggtatacagctgggtccaataagcagtccagataggagcactggagtaaggaattggttacctggagtaatttccttggaagagtttgttctatttgttttggcaatctttgcaaggctgaattgcctacctccaaggttgaacttactaatatctcctttaaaggttcagaagggacttcgatggaggaattctgtggtctgagctctgttcttttctgcacaattctctggccctcctgaagcttctgtgagttacccactaacctttgataagtccttgtaacttgattagctctagtgggttctgctgtctgcgacaaagaacccagcctgctacccatccaatgagcaggctactgggattattaagcagactccaaaccgtgtgagacccatccacatgcctctttcatcatgactttgaacacagctcctgctctctccatgccttgatttttccccttcactgccctcaaggagggacctactctagttttaaagagtcctacccagtgctctggactggaagttgctaagaaagttcaaagttttgaatgctgagtagtgaagacaacagggctcagacctttatgttccttgtaatcttcccctcaaagcaatcttcctaattgctttgaattcctgtcctttgttgtgctggcctgcctggctgtatctaattttctagaggcctaggtcactctgctgcccagacccaccattcaagtgcaaatgatggactggaggtgtcaaagacatctgggtctacaagaataaagttagaaaacaatggagaaaaagactctccgtcaccacaaccccacagcagtcccactggggaccctcagtaacacaccatatgccagccctaccagctctctgtagtcttaacctcaaattttaatattaaaatcagcagctcaacttatttaaaacttgagaagtctgtgctttttctagttctgttaaaagcaaatgagcattttccttttagtcttgtttagacagtggtataaatggatctgtcagtcagatgacacaaaacacacagcctgtttctctctagatgatgataatgatggtgagaatgataatgaggattgatggccatggagctgtctcatcttgtctcctcctccctagggttgtaggggtttgcagaggaacatttcttcttagtgagggaggagcttggtggggtaggtattagggacacaggatttgagttcttcaaggagggctgcttgttctctttggaagactacctaggaaaagctgatattggtgatgccagcacagaaatctctactccattcacattctcagggattcgggtgaacccaccacttgcatcagggctgccaaggaggatccagggccggtgacacagaaaaccaggttctgatttgggcaccatgtccaggcctaggagtcctgaactgcacatcaccctagttgcagttttcttccattgtaaggtgtttcttctccatcctgccccacgatggcacttgccaaaatcacaggaaaagatgatatcgaaatgctaaccaataataggaatgttacatattttaagcctttttaggaatgtggtttaatgttgtcccgttaaaaactgaaactaagaggtgatggatgactcaaggtgatggggatggccaggcaggagacctctatctctgttaggaagtgctcccagcaccatggtgctaaccctgatggctgaccaagtcaccttctccctgaatctgccctgcctgcctgtgtccttgaacttgtctcccctcagaacttctccagctcgtatagcctgttactcgtccctggtctttggccagcactgccttgcatgatggctcccttttacctgggaccctcagaaaggcctctgagggacatctgactgctgttttgccaaaacagtgccccctgtcagcaggaagcagttaagattggtcttcatctccattttaatggcagttagatgtacctcttcagaggggggagttgatagctacaggaggcagccaaatgcctaggcagataggggcaggtccccagtgaaacttcaccttcaagccagaaaaacagcctgaaggctgaaatactggactgctggtcccagatgaaaccggtaacccagagtgagaacttctgttcctgtttccccagccttttctgatagattctttctgaacaataccttttaaccattcaaatgttgccttttccaatactacctatggcctgcctctcccctattctaagcccataaaagccccatactcagtcactttaggggggactttcccaccttcaggttgggggaccacccccatgtcccctctccactgaaagccgtttcatcactcaataaaactcccttccttgttcactttttgggtgtcagcatatcctcattcttcttagtcatggggcaactcaggaactggtgcacaagccagacttggcccaggcaggttgagtgggagggctgtctcctgcagcaggtagcgtggccaagcaaggccttggcagagagtcaccggccggaggtccccagcttgcaaagtgactgagaagaaaatcctgcatcaatacttcatgtgagtattctctctgtccttcaattaaaccatcaaccatgcgaaggacatggaatactttgtccctcaggaaatgtttgctgttgctggtgatcaggctctcagagtgatctggaaggtcacatagtgcctaccttaagaggttgtcctactttccaaaatatgttctctatcacaatgcctggtcctgacctggagtgctcatcaggtgaaagaggtaagggaggggagagtcatctcaacacagccccagccccatggccaggatgttctgcagagttctctgggacccttcacattgttatctgcagggccatagtaactatgagaggcaggtcctggctatttacttttttcctgggctctaaggaaaactcccagagatttgctttcttggagttaagggctgtaactccactggatccctttcctgttgccagtgcatccccgcaggacctgcctcaatctgtgccccaggaaaaatcattgttctggctctttcccccttttttgacaaactgttatctctaaagctgaagggcaaagttgaagaaaagcagtgtgcagtattgtatttacaaaggataaacaaagtgaccacgaaacagaataagcctacctcatctgtcaggcattaaaagtgcagtttcaaagagggagaaggaaatgagtactctgaacccaatttgacctactcttccctaagaatcagagaatgccatccatgctcatttaattgattgtggtatcataagaatgtgtgagtatggagggtacattttatcccattttgaaaaaaaaaaaaaatttgccgttcttaagaaaattttttagaccctggatacagtctttgtttgctcacttgtttgtttttgtagaaatggtgtctcactacattgcccagtctggtctcgaactcctggcctcaagcatagtctttgaatggggaaattgtcttaattagaaaacatcatttgttcatttatttatttattattatgcaactactttattcagaaaacagaactagttctgtgaatgatataaaactgagtaggaatttctccctttaaaacattaaatttgattgggggaaacagaccacatgcatcaatgtcaacattagaaattataaataaaatgctggttgggtgcagtgtctcacagctgtaatcccagcactttgggaggccgaggcaggtggatcaactgaggtcaggagttcgagactagcctggccaacatggtgaaaccccgtctctactaaaaatacaaaaattagccgggcatggtggtgggcaccggtaatctcagctactctggagcctgaagcaggagaattgcttgaacccaggaggtggaggttgcagtgagccgataccacgtcatcgcactccggcctgggtgataagagcaaaagtccgtcttaaaaaatattacaaataaaatactgtgcaagttctgtggaaaagtgccttggagctgggcacaagaggaaaggtaaggtgtcagcagacagagcttggtgtcccagcaaggctgtgagcaaaggcacaagggtgggaaagctgcggtctgggtggtgaaaaggctgagtggagtgcaggatgtggggaggagtgggagacgagctcagagatgtgggtcaggaatgggtccctagatgactgagaataggctgagaaattattattttacagtataggcaggaaccactgaaacatgctgatcaaaagtcatccaatcaatcagcaactctcttctaggaagattaatctgatagtggtatgtagggtggattggagtgggtcacagttaaggatgagatctactgcaatattttaggcaaggtggcatgagggcctgaagtagggactaaaaggatgcagaagcatggtcaaaatagaacacatttttgaaaaaataactttttattattataggggtaatatgtgtgtatgggtgtgtgtatgtgtgtgtgtgtgtgtgtatgtgtgtgacttgtaagaagtgtttttggtctggtgcggtggtgtgtgcctataatcccagcactttgagaggctagggcaggaggatcacttgaggccaggagtttgagaccagcctggacaacacagtgagactgagtctctaaaataaaaaactttaaagaaagaaatgttttttaaaagttttaagttacaatataaaaaaatgacaaaaataatatattcccaccacccacatatcacacttttcatatattaggtgcatatcaccctggctctttttctgtgtgtgtatgtgcacacacatataatgtatacacttatttatttaaccaaaataagataatattgtatacattatatatgtgtgtatatatgtacatatacacattacctatctgtattttttttaccaagatgagatattattgtacatactggatggtaatttttttcaccaatgatctctactcctctattttagtaaactttgaatttatatagtaaccagaccatattcaatttttttcagttaaccaaaaaatttcactagtatgtgatatctaactagttcaatccaggactatggatgccaacaggtttttatgtcccttaagattattttattttagaaaagtcgctttttaaattacaatgctttgttgaagggactaagccagctacctgcaggatatcccattttctggatatttctggtgactttctcttgtatttcctgaaacttgtatctagttggaacaaattggatctggtcataaaacacattagacccgtatgacccatgcctgaattagactgatgagaaagcctgatctattttttagttctattttccctttgtgactacaatgttttgtgcgatagtcctggaacgtacagttcaactactcacatgatgattttaatatcaactgataaaatctagagcttatgaaatgatctttaaaaacaattctggcatttatactacatttattcgttggcatttttaagtaaagtaaaattttatcgcatcagctgggactacttaaatatcctcaaacacaattcctaccagaagacaggataaatgcttaattagagtaaagagttattttaatcgctacttcaaatggtgataaatgggttccctgactttccattttttctaaatatcattatgaatttaacagattttcattgattccatgtgttttaatccatcataatcattatacttttgatatttatgttgtcatgactttgaaaagtgggcccttttctaagctatctcttaggttcttttcacatgaccctattcatatttgaaagtttccttgctttctaatacaatgaagcatctcatgctcattttagacctgtgtcagagagaaatgaaccatttctttaaggaccgctgattccttcaggggaaatgatgttaaagaccatgttctggggaagaagggaggcattttcttttcaagtcactttatgatgatataattttcatactatgaaatacatctatttaaaaaaaaaaaattttaccaccaccaaaataaagacacagaacatttctgtcacccctaaaacatccctcctgccacttcacagttaatcttctccctacccttaccctcaagcaaccactgatctgttttctgtcactgtagattagttttgaatgttccagaatttaatataaatggaatgatatcatagctactcttgtgtgtgtagctttttttctcgtagcaaaatttttctctttgttggaggtcagggaataattttttcaggaaaaaaaaaacctcagaaaaagaacttacagaaaggttgcaaatataatccaaaaaacattttaattctgaaccattttacatgagtttgtcaacataatgcccaacgacactgaatactgtagtgtgcatttcctataatacaaccatgaaaatcaattaaccctataatcttgagaccccatttaaatttcagcgatgtctcagtagcaaaatcatacgaattcagaattatgtgttccgttgaacacatctctatagtctccttaattctggaagagttcctcaggctttgattataatattttaagattataggttatttatgtatacagtagcccttaatatggatttgtctggcatttcctcatgtttggattcagattgtgcaactctggcagaatatcacagaagcaatgctgtgttcttcttgttgtatcatatcaggtagcacaggatttctacttgtctcattactgatgaaatttatgttggtcatttgattaattatctctgttaagtttctccactgtgaaattatttttaacagaatgacaattaaaatacaacatatcaaaatctgtgggacgcagttagagcttattgctttagatgcttgtatttgaaaataagaagttctaagctgggcgtggtggctcgtacctgtaatcccagcattttgggaggccaggataaatcacttaagcttgggagtctgagatcacttctggcagcaaagtgataccctgtctctacaaaaaataacaataataaaaattaaaattaaaaaataaaaagcaaagagttctaaatcaataagtttaagaagcaagaaaggggctccaatcatacccaaagtaagtagaagaaagtaataagaaatcaataaaatagaaaaaagacaaaataatcaatgaaaccaaatcttggttattggaaatgatttaaaattgataaacttggccagatgtggtgggtcaaatctgtaatcccagctctttgggaaactgaggcaggaagattacttgacccaagagttcaagaccaggatgggcaacacagtgagacccccatctctacaaaaaacaaaacaaaacaaaacgaaaaaacaaaattacccgggcatggtggcacacacctatagttccagctattcaggagactaaagtgggaggattgcttgagaccaggaagttaagactgtagtgagctgagctcataaccacacacttcagcctgtgtgcagaatgaggccctatctcaaaaagtgaaaataaaaaattgataaacttctagttagactgattaagggaaaaaagagaagacattaaaagtatcaagaatgaaaaagggaacatcataactgatccaacagatagatgttaaaaggatagtaagaatattatgtacaacttcatgacaataaatttaaaaacttaggtaaaataaattccttgaaagacacatattacccaaattgacaaaagaagaaatagagattcttaacaaccatatgtaaattaaagacatttaattgagaattaaattcccataaggaaaactccagacccagatggtttagtgttgaattttatcaaacatttaagaaagaataccaagcctacacaaatttcttttctagaaacagagaaggaaagaacattgccagctcagcatcatcttgatatcaaaacttgacaaggacattacaagaatagaatactataagccatttcctctcacgaggaaaggtaaaaatccttaccaacatattcgtaccacgttatatgaaaaaccacttcaatagatacagaaactgcatctgaaaagactcaagcttttggaagtttcttctgaatgcctaacaagtctctcctccttttctggtaggagcctggtgtgagtgcctggagttctctgccctgctcatggatttctttcatacttgctctgatgagtattcactaacaagctcaaggagacccatatgcagattggcaggctctttctgccgtagttccccatatcttcttactctgccccctcaactaagaaccggcccaatgtcttcatattctgatctcttaattcagcagagctgtcatctctgcttggatcactcccataagctgtgggtagaaagtgccctcaggctggggagactctggatcctgcctctctcagggacccatggtccttttgcctactgtccaatgtctgaaaatagttgcttcatatattttgctcagattcctatttgtttactccaacatggatttccgaattgagatgcttggcaaagaattttgaaggtagaatcacagtaacagctgagtagggagtacttggtaattggttctttgagaatacataaaggaagagagatatcaaagagagtgccaggcatttgagttggatgcctgatacagaatgctgggcggtggctgggggacacacaggaaatactcaaaaagttgaagatgcagagctctgacttgaggggaatatggtggccagaagaggtctacttgagtggaaaccacagctgtgggaggagaagctgttgtagtggatgaaatttgcaaggagacaggagtgagagaggaaaaggaaaaagagagctaaggacaggatcttgtaaagaactttggtgtattatgagtaatcgccaccaaagaaggcagagaacagaatataatcagggaatttatttcaaaatagctagaagagaagatgtgaaatgttcccaacacaaagaaatgatagatgtttgaggcgatggatttcctaaatactctgacttaattattacacattctacgcatgtaccaaaatatcacatgtaccccaaaaacacgtatatatattatgtattagtagaaaaaaaattttttaattgcatctggcaatgaaaaggtcattggtgaccgccaaagaagactgccagtaaaacaatgggggtgtgaccttgactgcaatggttaatgaggagtgggtgttgaggaagtggaggcagggaaagagcaggtgaaaggaagaagagagatctcagggcagctggagggtggtgagtaggtgtgcttggtttagggcagactgaaacgtggctgttagcagagggagtcatcttccctgaagctctgctataaatctaacttgctgatggtgtgggtgtttgggtcgtagaaattccatttccatctattcatgtctgtatttatttactgcttgcctggttccaaaagggatttcaataggctcggcctccagtctgtcagggactcactcgactcagcctctctcttgtcatccacgctgcagaggataatgcaggtcagtccatgaatcgccagcacctaagtatgatgtaggctgttgaagcacagagcaaggggaatcgtgaacagaacactcagactctgggatccattaggctccgctgctcctgcagaacggtggcccaccagcttcacatcaggtccaccctttggtccccgaggggggctgctgtgtcctggctgcccactgcccctcctgctgctttggctaagacgggagtccccgacacactggctccatggcttgaggtgatggattttaccccatgagaggggtaaagagccgcaacgcaatgaactccacccccatggggttcttttaccccagagacttccggatccccacgcaaagtgcctttccttcctgggcctgctgagacagtgttagttcagtttatttatttatttatttatttatttatttattattatactttaagttttagggtacatgtgcacaatgtgcaggttagttacatatgtatacatttgccatgctggtgcgctgcacccactaactcgtcatctagcattaggtatatctcccaatgctatctctcccccctccccccaccccacaacagtccccagagtgtgatgttccccttcctgtgtccatgtattctcattgttcaattcccacctatgagtgagaatatgcggtgtttggttttttgttcttgcgatagtttactgagaatgatgatttccagtttcatccatgtcgctacaaaggacatgaactcatcattttttatggctgcatagtattccatggtgtatatgtgccacattttcttaatccagtctatcattgttggacatttggattggttccaagtctttgctattgtgaataatgccgcaataaacatatgtgtgcatgtgtctttatagcagcatgatttatagtcctttgggtatatacccagtaatgggatggctgggtcaaatggcatttctagttctagatccctgaggaatcgccacactgacttccacaatggttgaactagtttacagtcccaccaacagtgtaaaagtgttcttatttctccacatcctctccagcacccgttgtttcctgactttttaatgattgccattctaactggtgtgagatttttttttctttctttctttctttctttctttctttattattattatactttaagttttagggtacatgtgcacaatgtgcaggttagtttcatatgtatacatttgccatgctggtgtgctgcacccactaactcgtcatctagcattaggtatatcccccaatgctatccctcccccctccccccacctcaaatgtatctgagatacagataccatcgtatctcattgtggttttgatttgcatttctctgatggccagtgatggtgagcattttttcatgtatcttttggctgcataaatgtcttctttcgagaagtgtctgttcatgtccttcgcccactttttgatggggttgtttgtttttttcttgtaaatttgtttgagttaattgtagattctggatattagccctttgtcagatgagtatgttgcgaaaattttctcccaaatggccatactgcccaaggcaatttacagattcaatgccatccccatcaagctaccaatgactttcttcacagaattggaaaaaactactttaaagttcatatggaaccaaaaaagagcctgcatcaccaagtcaatcctaagccaaaagaacaaagctggaggcatcacactacctgacttcaaactgtactacaaggctacagtaaccaaaacagcatggtactggtaccaaaacagagatatagatcgatggaacagaacagagccctcagaaataacgctgcttatctacaactatctgatttttgacaaacctgagaaaaacaagcaacggggaaaggattccctatttaataaatggtgctgggaaaactggctagccatatgtaaaaagctgaaactggatcccttccttacaccttatacaaaaatcaattcaagatggattaaagacttaaacattagacctaaaaccataaaaaccctagaagaaaacctaggcattgccattcaggacataggcatgggcaaggacttcatgtctaaaacaccaaaagcaatggcaaccaaagccaaaattgacaaatgggatctaattaaactaaagagtttctgcacagcaaaagaaactaccatcagagtgaacaggcaacctacgaaatggttagttcagcttttaaaaacttttctcaggccgggcacggtggctcacacctgtaataccagcactttgggaggccaaggcggggggatcacaaggtcaggagatagagaccatcctggctaacacggtgaaaccccatctctactaaaattacaaaaatttagccgggtgtggtggcaggtgcctgtggtcccagctgcttgggaggctgaggcaggagaatggcgtcaacccaggaggtggagcttgcagcgagctgagatggcgccactgcactccagcctgggcgacagagcgagactccatttcaaaaaaaaaaaaccaaacaaaaaaaacttttctctgaaaaatgcaagcagttgttaacagctcattcacttttgtggagtcaaatgtccctcccagcctgttcccagttttcacgtgtgtccacagaagcccagagaggtcagacgatgcatccaaagtcacatggctgagccaaggtggatgaaggactggcatcaaggcctccagcttccccctgaattttaaggtcttgtaaagggtctgtaacttgcagggagacaggtttcttgtacgtcacccagtactccaagtatccagtataacccaaattaatccctacagacttatgaggcacgtagaaggattctgtacatttgaggagctcaaatggttgattttcaagtccaaggacaccacagggctgggaactctgaccttgcttctggtgccactggatgtttcagtttgcagagatgacaccagggcagcaccccagggctgtccgcgagtgtcgcagaatgaatacgtctgtatttcagaaacattccttgcacgcttcgtgtatttcagagttctcagtcagcaccagctaattatttcccatagctttctgttagtgggtgaagattggtgcccctcatcccacacactgggaacagcaacagttcacaccaggggagtgtctgttccagacggaagagaaaaccaggagtacagcttgttgtggggctccagctgcagatcctgggccattcaactgacacagcagggccagcttttctccatgtcgggaattctttcaaggcccatctcagaatgatgttttggccaaaaaaattgtctggaagaggacagccacttttgtttttacagtgtgatcctatttatgtaaaacttaataagttcaaatagtattatatattgcagacttcatactatacaaaaaaaaaatctcacaggagattgaatttctaaatgttgaaacgaaaaccttaactttaggggaaagtataggagaatattatcaccttgaaactgataaatactaaaatgtaaaacttcagcagaagaaaataaataaaaaagaaccaaccacagtccagaagaagatattcacaacgcacatgactgaaaaaatgatttttatattctcatatattaaaaaacagccactttttagaagtaccatttgatccagcagtctcactactgggtgtctatctagaagaaaagaagtcattatacaaaaaagatacttgcacacccatgtttatagcaacacaattcacaattgcaaaaatatggaaccagctcaaatgtcctttaatcaacgagtggataaagaaactgtggtgtatgtatatatatatatatatatatgagggaataccactcagccataaataggaatgaattaatggcatttgcagcaacctggatgtaattggagactattattctaagtgaagtaactcaggaatggaaaaccaaacatcgtatgttctcactcataagtgggaactaagctatgaggatgcaaaggaataagaatgatacaatggactttggggacttgggggaaagggcgggagggggtgagggatcaaagactacaaattgggttcagtgtatactgctcaggtgatgggtgcaccaaaatctcacaaattaccattaaagaacttactcatgtaaccagataccacctgttccccaaaagcctatggaaataaaaaattaaaaaataataacaacttttaaaaaaataaaaataaacaactttatcctgtcaaaataaaattaaattaaattttaaaacagccacttttaattaaaatgaggtccctcagcgggtcagcccaaccgctccccctgcctgccccatgctgtggaaagtacataaatgtgatctatttccttctttgaacagtctggaaataatagaatctgttatgggctgaaaggtgttccccgaaaatgctgatgctgaagcccacacactcaacgtgactctatttggaggcggggcctatgaggaggagataaaagtttaagtgaggtcaggaggcaccttgaccttggacttccagcctttagaacttcaagaaaatgaatgtctgtggtttaagccacctagcccgtggtatttctttatgatagcccaagctaatatggagaatgtttatttaaaatcccttattttgaaaacgaggaaattaaggccctcagatgtgatttggtggaagtcaacattgcttctgagtgacaaagccaaaaccagaaccggatttagaagccaggccattcctcaccacaccacaatgcatgttttgtttttgtttttgtttttgtttttttttgagacagtctctctctgttgcccaggctggagtgcaatggcgcaatcttggctcactgcaacctccacctcccgggtttagattctcctgcctcagcctcctgagtagctgggattacaggtgcctgccactatacctggctaaatttttgtatttttagtaaagacggggtttcaccatgttagtcaggctggtcttgaactcctgacctcaggtgatctgtccacctcggcttcccaaagtgctgggattacaggcgtaagccaccatgcccagcccacaatgcatgttttaaacctaagctatctgcacccaacctcaatagacaatgctactcaatttacttgcatgagtttctgctatcttcctgagcatgtcacaggatgagacaacacagagtcgaagcattaatcaaaaagcgattttgatccagagcttttcaggcttgcaaactcaaatgtttcacggacttaggcaggtaaatgtgtgaagtggctgggtaaaaatcaataaggagtggtgagggttgtggcaaactggagcaagcatgctctgtagagcacttacattccaattttttaatcattaaagccaaacacatctggcttgtaggtcatccatctggcacctctatctgggtaggcaaggctaggctgcaaatataaagaaatcctgaagtctcagtggcttatcacaataaaagtgtattgctcacttatgtcacatacttatgtggttggagattggggcaggctctgctatacacagttgttcaaagatctggctccttccatcttggggaaccaccagtcccaacacacggccttcaaggctgtagcagaaggaggtgagacagagaatgggaggaagctggttgacgtgccaggcttggaagtggcatctgttgttttggccctcatgccaccatccaaaaccaggcctacggccccacctagaaggaggggagctggaaggatcccttggtttgcaagcccatgaagagcctgaaacagtttgtgggcagacagcatcatcttggcctcacctgttcacaggtgctgttccatgccccaatgcacctgagtctcacagctcactcttggaggcaggctgcattcataacctcactttactgatgacaggaaccgaggaccacaggtgtcaggccacctccccggatcacagagccactaagaggaagagccaggattccttccctgtaacctctcacccaaccctctcttcagcccagttcccagagccactcaccatgtgggaagggacagagggaggtttctggctgtggctattccatcaagaaggggtatggtgtggtggcaatgccgttcctccagctcctagtacaaagcacattttctggctgaaagtcttcaaatgggtcaaagccatctttcatcatggctccttctctgtaaacagaagacacctagatgtggagggaagagatgggagctggggctgaagactgccctgtggcttccaggaaagtctgtggattctgttgagggccgtgattaagaaaaaccagatccgcgtctaccagtgtcgccggctgttctgggcagtccgggtcagagggctcagggttgcccctccagatgtggctccaccaggccggcaaaagacacggcgaagggaagggctggggaagcaggaatacctgagatgaggggtgcagccaagattacagcattgggttgtaggactttggaaatggggaagctactctcagtggtatcaggctggagaatggcaaaaaggcaaacaaataacttattttgctttatatttttatttatttatttttgctttgttcctttcatctgggaatctcaggaactcacctggaatgaacttctcgtcaaacatggcatttgaaagccacaaggagctcagagctcagccagcctagcagctcagctgggaggggaacgagtagtgagaagggtgggccagcgcctgacgcagctttgccaccagactctctcttttccagagtgaccctcctggtcagcagcctcggctcccagggatggactcccaacattgtgccatctggactctttttgttgagaggaaccaagtctcattcaggccacctcagctcatgggttgagactggtattttaagaacacatatgactcaaagagccccagaaaagaggaacaaccgggccttttataaacactggggctgtggtaacaggtaggcctctcaggctggcctggacagttctttgagctgctcctgcaggccctgctgtctgtgctgcctttaaccacctccttatctccacttcccatggctggggccctgcacagctgaccctggccgccccatttggcagaagcaggtgcgaagtttgccttagtgaggaacggaggccgtggcatgagccgtggttgccgggtccaacacgtggagagaagcactattttactggaatccctgacaaccctgaagtagctttgtgcaggaaggatgaggtgaggtgagaggggtcactcatctcaacccagggttcttaatttgtggggcatgagggaacctgggacttccttcgagttgtgtaaaaatgttctctgtatgggcatgagcacacgttttctgggaagaatatctgtaataatacttcatcacattctcgaagggctcttgacctacacgtggctctgctcccgcaaagcatgagagggggctctgcgatccaactgcctcagcctcccaaaatgctgagattacaggtgtaagccactgcccctggcctgcctcctgagattttaaaatgcatgtttatgggtttgcttgtttgttttctgatttgtaaagcagtccatgcttatgtgataacagaagaaataacgtaatagaaggtgacatgaaaaagcaaaatacacaattgttatttctactctgcaaaagtgggtattcaccaagtgtctgctatgcttcctggtggctgaggatacagcagaagaagagaacagacccgaatctctttccttgtggagactgctgtctgggtggggaggctgggtttccgtaacacaaaaacagataacagccgcaaagatgaatgacccttggagtcttttcggcggtggtaagtggtagggaggggcaggatggcgggcggcctcaccaccaggcagcatcagcaggcacaggcctcacagatctctgggagaggctggctgggcagaggaggagaggaagggcaagtgccaaggccctgagacaggagtttgggggcgagtgcgagtggcttgcagaggtcaagaagaagcttccagatgttcaccgatggagcccgacaaatgagggtgagaaggcacagcccccacaagcccatcaacttagtgggctcggaagtcattttgtggtccatctgtccccatagggtgaaccagtctgggatcctccatcacccagaacacaggcagattcaggggtgagagggaaagaatgtgctttttgtgcaagacttggaaaatatggaagagagaaaacaaggaactgagggtcttcaggtgcacgggctcactctcctcagcttcagccagagggacaggcagaggagtcattatccagcaccgctggccaccagcccgaccgtgagcccatcttctttctgctttcaaagcagctgcatcatgtggcttctccccgacctcccgagctgttgttaagtacaactcttcatgtgatctcaaagagatgcagtcattgctccacggtgtcatcgaaaatactccagggcagcgtaggtgggtggggcggactcatttacacaaagacccgaggcctctggggggccatcctctggccagctctcctgtgtctgatggggctgagtctgggcgtggggtggggatttgccttggcctagggcttttacggggtgaaaaaccctctgcttttacttagggttggtgagatcattatctaacagcatggccatgggagagagccttttccagcttcctgaagtgataaaagaccactctcctgatgagaaacgagctggaatgagagtgctgcttggctctcactacaaactacagttccagtcagcatataatgagctacacaaatgtatttgggactagaagtgagcgcagaaagcaagcattctggcagcctaggatgtgagttgttttgacttttaaaaaatcatctttgaggttgaaaatacaagtgttttttttcctccttaacataaatatgtgctcattctaaagaaccccaggcatccaggcagcacataccgtttcccgaaatgcaccaagaggctgctgcaagtggatacgaacattttgctcctaacacagtcctccctcacatttctctctggaaaaaaaccaaaaaaccaaaaccagctgctggtagaagctacttcttaaaaggacacaaggcaggttcaaaaagaatcatggatttttttttctaccccagtctcccacccagccacaaagaacaaacaataaaacccaaccgaaaaacagggttgagagacgtttgctttgactttctgtatgctttctggcattaagcactcacttgcgggctgacagtttgcagcatttataaagcatcttagctttctcatgggactggtatgagatcttgccacccacccatggaagctgtagccctcttcactgctgcggccaccagggtgtgggtggagggtcggccccaccacacaactgtaactaggcccacaggttgggtgtggagagctgtgcattagaagggatgggtccatctggggcctctgcaggtggcaggaagagactgtaacgtcacccattagtagccctaataacattatgaggcttagtccactgaatccaaaacttttccttggtccatggacccatgtcacactttaatgcaatcttacagaaaaatgcaaaaacccaaactgctagaccaagtatttctatctgcatcccagctttcttacactgtcattgcagggaatacttgggaagaagaatgttctcaatgggtgcgagcttgactcagcgtcagcccctcctaggctgccactcttttctgttcagatcaagtgatcagtgctctggcatattggcggggtctgcagtgatgtgggtggtcctgtatattgagaggcctttggtaacctctcactggagcagggtcagctggtcctggaaacacacttgacacgctggaacctgcggtttgagctaccatgcctcatgggtcttatttggtattcagaatatgtcctggagagcagggaacttaggagtgtaacagtgtcatttggcagggaccagagactaagcgttatcttctaaggtgagctcttcctcggggccccttccacacagcctccaggtggccactcccagcttgctgagtgtctgcagagcccctgctattgatgtgtgtatttagatctcttagtatcctcccacctaagtaaatgaggggtctcagcttagcctacactgtgcttccctgcatgtacatgcatgcacacgctcaacacagcacatacacacactcaatacccagcacacacatgcatatacacccacaggctgagtggccagtgctgatggggaggagtgctgatagagaaagatttgggggccagtaccctgggctgagagcttacatgtggccctgggattgtggccagtgtcttggagaaagagactacaggtagcgtaaagtgggttgttttcaggaaggtctgtgttacactctgagagtatgccacgactctttaaggctcagatgagaaagagtgacagagttgggaaaaggggcatcctcctcacttttgcacaggacacagtgccaccctgggctgggagactagaagggaagtttgtgtcattcagtgccatgggggttcttcagtttcaggagatgtcccccaccccccggcagggtgctaaccatggagggcaaccactgatgcctccagcagcttctggacagaagatcctgtaaggagccagagaagaaggagaggggcctggtgctgtgcatgtgtgaggttgttcaggctccttcaatggccggtgctgtgacatctacatgtctctctctgtgtgtctgtcaacctacctattgactgtctatctacctacctatcctatcatatctatctctatctttcatctatttatcatctatctaccaatctcatctatgcatttaaatatgtatgtatgtatgtatctatctatctatcgatcggtcgatcgatcatttattttttatcttgattacaccagataagctgaggattttgcaggtaagcacgtggaagctaaaggccagcaagacttggttaggaatatcaatgcgtcctctctcacggctaccaaccagccagtgagggatttgcagtgtgacaaaacaggcctaagccctgactggctgagggagccagtgccttacaggttagtcaaccaaatggggatagtggaaaaaacaatgcacaaaaggtttctgaaaagcagaaatcagggtgccctggagtagtcatggcagtaaattagcggcagtcagtggcatggtgcccacagctgggcttttcccggcctctttttcacatgccacaggggaccgtttgctacaagggagcctcagttggcaccactccactgtttatatttggtcatttattcccaatcctcatgagtcaaccagagagctctgccagtggtgatgattctgccgcgctgttttatctggagcagtgccatggactctgtgctgatgtataatccctgaaggaaaacaggaaaagatagccgtacacaggcaaaatatgtacatatttcactggcgcagccacaaagccagaataagtcaactagttcagctgaaacaaaagtcaacccaaacactgaaccacacaagcccaggaaattttgtttaaaaaaagaaagatatgaagaaggaggaggaagatgcgacatgctctggggagccctgtttcagactctgttctggtgatcctcacgcaggtgaaatcactttccacagtgggcttgggggcttcgggtgctaactcttccccactgtctcactgacaatggtgggcgccctgggctgattcctcactatctatcccaacactctcctttccttcacccagagcctggagagctaaaccctatgtttcccaggcccaaggctccagatgtgattagtatctgccaagcaaattccctcctggaagggttgatttcagagcagagttaagccaaacaagaggcgggacacaagacttccagttttgcaggtgtgggactgttgcagaaagatcactgttccatgcagtgagcagctacaggaacagtgcttcgattccttggaggcagctttccctgcgcagctctgcagactgcagtgctagtcgcggcttcctgattcagcaggcagcctcctcagagcagcaggagctgtggggactgtggggactgtggtgactttggtgactttggccaccagtcctgcaatgtggctttggatgtaattcctagaagcttagcctcaaatctgtttcctctgctctcccaatgattctgtaaactatttcacaccctcaatatttcttctccgcttaaactagcgagagtgtattgtattctgtgcaactcaatgctgatgaatcagagtataaaatggtttagagcggggtttggtggctcacacctgtaatttcagcactttgggaggccgaggtgggaggatcacttgagcccaggagtttgagaacagcctggtcagcacagtgaaaaccccatctctacaaaaaatttaaaaattacccaggcgtggcggtgcatgactgtggtcccaactaccagggaggctgaggtgggaggatcacttgagcccaggaggttaaggctgcagcaactatgaatgggccactgcactccaacctcatgacagaatgagaccctccctgcccctaaaaaataaataaaccagattggccatgctcacttcacagtgaataggatggcatggaggcccaaggcaatcttggtaagttgctaagttgaagcctaatgtgaataataaaggagtttgccaacttttaactttcccaatttcagaaattctcactaatcccccaacatttatcccctttgagttccaggaggaattcttccccacattttaaactatgctgaaagtatgaaacacactgagctggatatgtctgtttgagatgaaatatcctgggggaccagtagggtctggacatcgtatacatggagacagataaccactgtcgcttatataggttctctatggtcagcaaatatccctagggggaattgtctcacagccattccctatgtgttgtatttgggtcagaaagcagttctgaggttgctgttctctccatgatctggccagttctcaccttatccagactgtggtaggcagaataatgctccccaaagatatctgtgcccaaatctctagaacctgtgactatgttatgttacatggcaaaggggaattaaggttgcagatggaattaaggttgctaataaactgaccttaaggtagggagattatcttagactatccaggtaggaccaatgtccttgttcaagaacaagggttcttaaaagtagatgaggaaggcagaagggagatgtgatacagaagaatgatcagagagatgcagcattgctggctttgaagatagaggaatgtgttcagaactaaggaaggggacagcctttagaaactggaagagggcagccaggcacggtggctcatgcctgtaatcccagcactttgggaggccgaggcaggtggatcacctgaggtcaggagttcaagaccagcttggccaacatggcaaaaccccatctctactaaaagtataaaaattagcagggcatggtggcaggcacctgtagtccctgctactcaggaggctgaggcagaagaatagcttgaacccaggaggcagaggttgcagcaagacagagatcacagcactgcactccagcctgggtgacagagcaagagtctgtctcaaaaaaaaaaaaaaaaagaaaaaaaagaaaaaaaagaaactggaagagagaaagaagaattctcccctagagcctccaaaaggaatgcagcctgatcaaaactttgactattacccaatgagaactgtgtcagacttctgacctccagagctgtaagataataaatttgtattgttgaggccaccaggtttgaggaatgtgttgcagcagcagtagacaactaatacacaaaccttaagcctttcattcatgtcactccatcaaactccaagcgcgttcatggctaaggaagctgctttggggttgtggctgctgcaggggaagggtttgcaaataacttttcattctctaggaagactggccaatggaaaaaccatgcttcccttccctaaggatgaatagaaatctttagtaacttcatttggatagaaacaatatgtaaatgatatgtaaaagcaaatttctcaaaatttatgagggctgtattgcataattctatacaaacagtctggtgtgtgggatcctatttccctgaaaagatgaaaagataagctatcctatggtgaaaaattgaaggctgtatgaattgcaagggggggaaattatagttgaaatgctattatgaatctttttgaccagacctgccgaatataatattaaaatttaaacacactgtctcaaacattgctcaagaacttcacgaaaccccttcatgtggtcatgccctgttctcatggctgagtgcgcgctctgatgaatgttcccagaggacagggacaaagtgagtgtctcagctctctctgcatgatccttttaggaactctt

SEQ ID NO: 3 - DNA, 399 bp, Homo sapiens
ggccccttgtctctgcttaaccaagtcaaggcaccaaagctgtgccccctttctttccaggtcttaccaattctccctccccatcccaccctgtgtcattgcaggggccattctaaggctcccagcagctccccagaaggggaggggtgagagtttttctttaacctcaaacatcaaacattagccctaagtcccctttygtcttctgacccctacccaccatttccttccatttaactgttcccaccaatggttcccaggaaagtcagctcaagcccagggctgccagagccaaggggaagtggggaggtagtggggaatggctgaggctgctcaaagtggcctggagctactgggcagcctcagaaaccctggagacccaattcccaaggaaaatgg

SEQ ID NO: 4 - DNA, 399 bp, Homo sapiens
gggactacaggcgcccgccaccacgcccggctaattttttgtatttttagtagagacggggtttcaccgtgttagccaggatggtctcgatctcctgacctcgtgatccgcctgcctcggcctcccaaagtgctgggattacaggcgtgagccaccacgcctggccacccatcgtgcttttcaacatttgtaagcaggcrgggaataaggtaagcttgtggactccgaggctcgtgtgcgcaggcgcacatgcatgcaggtacccacatagacctgtgctgacttgaacacctgcactcactgattcacacgcgcatcctcttgaacacatgctcacacagccctcattcacatgcctcttcccttgccacgcacacatactcatactggcatccctcc

SEQ ID NO: 5 - DNA, 399 bp, Homo sapiens
gagttccactcccagagagaggggtgaggggatgagatggtgtgagtagcagacttgggtgccagtgagcaaacaaggaagaggaggcaagaggtgggaggctggcaggaggtggacaggaaggcaggctgcctggagatgggccactcccttgtgagtgtcctcgtgctttccttacagatgctctactcatttggagyatggtatttgctctgcacatcctcataggtcagtgtatctgcacatgtggtatctctctactctgtgataatgcttggtgaccatgtggctgaggatacctgtgtgaagaacaagaaactaggggttgcccatagagcacttgggtgtttggtttgatgagcacagtgtttaaaacaaacatgaaattgaatacctgta

SEQ ID NO: 6 - DNA, 399 bp, Homo sapiens
gggtcctggaggctctgatttttctgggtattgagggacccaaactcaaccagattccaaatgccagacgattgtgagtagatacagctggtgagagggtgctctggagacgcctgcagaaaagagaggaaactggcccagcctcctagagacacttctgagtacggctcggtcctgagcctgacggcagtccaggctgyagctgcctttgccaggacatgtgataaaggcccgcagatccttgatcaaggtgtcagccactttgtcggagctcctggaaagggcttctctttccttcatggacattctccaggttggtagtggttctggcgggggaattttctgtgcctctggtcactcatgtgtctatcccccctgagtttgtatgccagttctttt

SEQ ID NO: 7 - DNA, 399 bp, Homo sapiens
cctcacatagctccctggcaggtgtagctatgggtaattgtacttccagacctagcagggctatgatagaaggagggacgccctctggtcagggaggacaaatgagctataataatgttaatagctaacgtgaattgagaggttactgtgtgccaggcatatattatttctttgttgatacatctatgcattagcatttkgataaagaaaaagttaactactgccagggagtagaactttcctcaaaataagaggaagcaaatagcactgtatcccactctgtggcccgtgagcattagctggaaggtcacatacagtttctaggagtggaggatagaagcaaagagaaaaggcaggtccaggaacacctgtccatggatgtctgtggggagggaacct

SEQ ID NO: 8 - DNA, 399 bp, Homo sapiens
agctgccctggttctctccttccctttgctgccccttctcagggttgttcctctcaaaatatgtttcttgatgcatgaatgacattgcatttaatttaagaggcaattctctgataagaaagtcctgccttttccccacttcctgccccaacctgctcccagacctcctggggttatagcctggctatctggatttctcyctgcctactaatttgcttgtcatcaaagatccttcccactgaaagccccccttgatttttttcctggtacctgcttctggggcctccctcaatgacctgccctgccctgaagttctgtccagctgccagctctcatccacccccaaaccagtcccatgctaaactcttccttttgcctttctagaggcactctccatcc

SEQ ID NO: 9 - DNA, 399 bp, Homo sapiens
ctgcctcagcttcctgagtagctgggactacaggtgtgcatcaccacactcagctaatttttgtgatttttattagagacagggtttcaccatgttggccaggctggtcttatactcctgaacttaagtgatccacctgtcttggcctcccaaagtgctgggattataggcatgagccaccatgcctagacttctttcarttcttttatgttttacggattttctacagtgaatatatatcataatcggaaaaagtaaaatttagtatattgagtatatgcatttataaaacaaaatgatcatggactacattgtagcaagtgtactggccagtgggctgacagtggctgcttaaacgactccttactctgagctccagttttcttaaccagaaaatca

SEQ ID NO: 10 - DNA, 399 bp, Homo sapiens
gcagatattctggggagatcaataggcagaaagcatcagtgaatactagaaacaggtagcaaagcgttgcttcaagcttgaactcaaaagtggaactgggaaacctagcaaggaactaaataattgattcattcagcctatactgattagtgtctattgtaatagttctacactttaccctgtataggaattatttggartgcatgttaaaatgtagtacagattcttagttctttttcccccctcttcccttttacttggtacgcctaaaaaattggcatgttcagcaagcatatcagatgtttctgatgctggtgtttctcaggatcatgctttgacaaaatatctagtccactgtgtgctggccagtgtatcaacacaggggaagtgggggaaatg

SEQ ID NO: 11 - DNA, 399 bp, Homo sapiens
tgttatatattttaaattttagattccaattttctggtgtaactttttaatctgttttgttgaatatcttaaatatggttattttaaagtctgtgattacttatcacattgggggctgttgtttttaactgtgttaatatgtacataccataaaattgaccatcttaaccatttttaagtgtacaattcagtagttttarcacattcacatcattgtgcaaccagtcttcagaactttttcctcttgcaaaactgaaattctatactcattaaataacaactccccattacccatcacctctcagctcctggcaaccaccatcctactttctgaatttgactactctaggtaactcatataagtggatttatacagtacaggcatgcactgtataatga

SEQ ID NO: 12 - DNA, 399 bp, Homo sapiens
tcctgcctcagcctcctgagtagctgggactataggcgtgcaccaccatacccagcttatttttgtatttttagtagagatggggtttcaccgtgttggccaggatggtcttgatctcttgaccttgtgttccacccaccttggcctcccaaagtgctgggattacaggcgtgagccaccgtgcccagcctgtgtacagyatttcttataacaatgagttacttttatgttaaggatttttttttttttttttgagacgggtcccttccttccttccttcttctctttcttctcttactttcttttctttcttctttctttccacagggtcttgctttgttgcccaggctggtgtgcagtggcatgatcaccgctcattgctgccctgatatccctggc

SEQ ID NO: 13 - DNA, 399 bp, Homo sapiens
ctgggttcaagcaattctcctgcctcagcctcctgagtagttgggattacagttacgcgccaccacgcctggctaatttttgtatttttagtagagactgggtttcaccatgttggccaggctggtctcgaactcctgacctcaggtaatccacccatctcggcttcccaaagtgctggaattacaggcaagaaccaccrcacacagacccctcagcctttcttagaggccaggatgtcagttccaggatgtgcgagaaacttatagagaaataatgtggaaaattgtagacaaaaacgtaggaaagagtttggtgctcattgcttacagattagggtaccatacatgattgttttcttgactgagtcttatctgcgtacctcaggtatttggaatttg

SEQ ID NO: 14 - DNA, 399 bp, Homo sapiens
taagaagattagaaaaaaaattttgttttccctatttgagattctctctgttagagcttagggtcagtatctataaaatatatttcaactgctgagcatgctagcttctgtttaaatcagtagaaaatatgttgatctttcaagacataaatttactcaagccaactgtaaggtatagcgcagggacatagtgattggaracagttcacttcacccgcctgaaactaagaatcaactcttcagtgtatggatcactggtatgtaataatcgactattatcggtctgtctattggtctctttttaaatcagtttggaacctcctggagttattttcttgctctactgacatcaatcccatgtggcagaggagttgtgtataatcgctttggtttaatcaa

SEQ ID NO: 15 - DNA, 399 bp, Homo sapiens
tgttttaggttagtcactttaattgtattgagtaattagaaggtacacacagccaagggagctttgttctgataattgctcgagaaaacccattccctatctgccgttgctttgtgttaagacacttctccctctagtggcaatagtaagcactttggcttggcagtaggcaaggtgtaattgcaatatgacaaactatrcttaagggactgtcttgtaaatactttcgtttggggtttgcattatttcattatatatgtgtggttggttgttgttggttttttttactctataaaacttgctacctctttttgccctcctaaagtgctttgggctttgggtaaaaaaaaaattgcctgagatgtttattaataaaaaaaatcacaatgcattctgggt

SEQ ID NO: 16 - DNA, 399 bp, Homo sapiens
gccatcatgatttgcagcgtgttagtctttacatattagacttagtggcttactgtaaaagcaagtaatatgttataggctatgtaaatgaattcaaatatcttctaaagatacacaaaatatttttttcttgatactaataattaggcatttatttgaagtactaatatgcaaaagctggttaccaggtacccacctgrgtacagaattggtaggaaagagcctaaagttagtgtgaaatatttaggttaggtatgaggtgatcttttctcataggactttttttcacaatatttataactaatgtagattatatgtatcataataggtataactctctaggctttcagtgctaagatactgcatttacagaaacttaagtctctaatattatgcctc

SEQ ID NO: 17 - DNA, 399 bp, Homo sapiens
taatcattatatcccctttccccccatagttctcaatgccagagcctttccttaaagcctttctcaaagccaaatggaatccttagatatcttttatcatttgcatctttcttgtcataaatactttgttcatctagtccttgcaaccccagtactaaagagtgtcctatgtctggaatgtctttctctacttactatayccttccttttggttaaagcagatttggatgcaaactagaaatacttgtcatttcaccataaagttcagtcagtccactatgtatttcccaacctatacataatacagttagtaaagtcagcatacttagtattacaatgatagttgatgatcaagccagttggtgtctgcaagtgtctatttttccctcctggcccagg

SEQ ID NO: 18 - DNA, 399 bp, Homo sapiens
ttggccaggctggtctcgatttcctgacctcaggtgatctgcctgcctcagcctcccaaagtgctgggattacaggcatgagccaccgtgcctggcctccccattgaattatcttggcatctttcttgaaagtcagttggctgtatgtatttctggactcactattcctttccattgatctacacttgtgtccttacacsaaagccacactatcttgattactattacatatcttgaaatttactagtctgagtcttccatcttttttcaaagggttttgtggttttttagggttttgtttgttttgttttgttttgtttgagacagttttactctgtaatccaggctggagtgcagtggcacgatctcggctcactgcagcctccacctcccgggttc

SEQ ID NO: 19 - DNA, 399 bp, Homo sapiens
tgttatattcctagtaccaaggacagtgtttggcacattatagaggttcagtaaatacttattgaatgaatcaattaataaaaaagacttcatgggaaatacggaatattttatgttatggaaaaaggtaaattgagcatatgagtgttattttagctttatgtccaaaaaggtaccacagagtctcagaatattcattrgtttcttttcatgaggaacttcttatttgacaattaaaaaccaagttgttggccgggcacggtggctcatgcctgtaatcccagtactttgggaggctgaagtgggcagatcatttgatgtcaggagttcaagaccagcctgtccaacatgatgaaaccctgtctctactaaaaatataaaacttagccaggcgtggtg

SEQ ID NO: 20 - DNA, 399 bp, Homo sapiens
aagctagcctgtttctcatttgtaggttaatcacgtacatttgaactatactcaccatccatatttattgccatgaatttctgctattcttccctgccttctcttacatttgcttttaactaacatttttgtcccctttttgatctttagaaaaattaaagtgtgggatcttgtggctgctttggacccccgtgctcctkcagggacactctgtctacggacccttgtggtaagagccttgctgtttagagagcattggagagcaggtgggggaagaaattaaacgttgatgtgctgtggaatatggatttgaatttaatagttacaacctcacaaaacctacaactaagtggtaaggcaaccagtacatgacaataaaatatgtttatataattcctt

SEQ ID NO: 21 - DNA, 399 bp, Homo sapiens
catgttcgctacacgtttctgcatctctctttgcagtgttccgctgaggacagtgattcacgcccagctgggctgtcctcagcttctctttctctcacagaggacacggttcgtcgttcctcagccaggtcgcacaggctgtgtgcccttagacaagtaacttcccagaccctgaatctcttgatgagtaacgtgagggrcagcactcacctcacggaaccctgtgaaggctgtgtggagatactgcatggaaaattcctagtgcttagcacagtggcgaatacataatatgccctcaggaaaaactggtcatgagtattaatattgcaatctccatatacctaccccctcctttgcccaaaattttctcttccttagacttccgtgttactttgccat

SEQ ID NO: 22 - DNA, 399 bp, Homo sapiens
agctagtttctaagccaggatttaagcctagttctgtccaattaagagcccatgctttagtcctcaacaacatagtgctgggagttgagaacacttaaatccaactttcttttcttcttactgtttttctttccccagaaaggcctgagtgtggactgatgggcagacaggaggacctcacttgagccactgggcccagstctagaacagcagatctttttcttactcttcttcctatccaccactgctgccctggcaaaatactctccattattaatttttaagtataaataatcccaggggttgagctggcttttgcttgtgcattctatgaagtaaagtagggacatggtttttgtggcaataaataggaatagtttccatttttctagctaagta

SEQ ID NO: 23 - DNA, 399 bp, Homo sapiens
ccagcaaaggtggcagacactgataataggggagagtcaaaggttaaacagcagagattagatgaacacaaagacttgttaggaagtgttaacatcttccctgcaaatatacacaaaaagcagaaccaggagggaagcagcccagcagaaccattcccccaggctggggcagtgggaccggaaaatgaatcccagggctkggccacaacagcaaggacaggatcagagggaactttaggtgcatagcttgcacctgctttccttgaactactcctaccaccaggcaagaggaatggaggcagagcaggtggaggctcagcttggttttgagtctcttgtaatagatttagtttattggtcgaggttaaccaacttcttagaagctcccgataggctcaa

SEQ ID NO: 24 - DNA, 399 bp, Homo sapiens
tgaagttaagaaacttcatcctgatcacggaaagcggtgaggaaacacagagaggctttaaacagggaagtaacagtcagattgagttttaggaaaaaatcacattggcagcttgccaggcagagaggagagaaaaagattccatggggaaagaacagcccgtgcaaaaggctggaagaacacaaggaccagtgacagcragtgatctggtgtgactcaagcatgcaatgcatggcgaggagcaagaagacagaagcctgggagggaaatgtgtacagatggtcaaggggctgaaattccaggctcaggagtttggatttaattcttcgggtactagacagaggcaagaacctcatgggactcagtgtgaaggtaggacacagaccaaaggtcaagttt

SEQ ID NO: 25 - DNA, 399 bp, Homo sapiens
ctcggtgtgcatgagggaccttgcccagcctctttcccagcctcctggctgccttaggccctcggctgccagagctgtttccccagggaagcagcctccttacagactctgctcctcggtggctctctgatgatgccactgtgcaaacctgggctcccagggacttggctcaggtggcccaccccgtctcccagattccytcccggcagtagccaccatcactgttaggaagcattgttaaggtacccgctggacactcgacacactcattttaactcagtcctggcaactcctatggtggagtgattccctgttgtgcaggtgaggaagtgggggctgggagaggtgagctgacttgccccgattaaatgaccaggcagtgacagagccagggttcaa

SEQ ID NO: 26 - DNA, 399 bp, Homo sapiens
ttgagtattaagtctttccaaactccatatttcttcatatttcactaggaagattataaacttatctgaaatggcagaaattcattttgctttcaatttctcattctgctgtatactgccgaaaaggggtacataatgagaagtgagagcagcagcctggcctgctgcccagctggaagcaggaagttcacctgataagracttgatgcttcaaattctaaaaactggaaagggagctagaagtgggggaaggaagatctggaaacatgcccaggggtagtaatgaagaaagtgaattcagcctgagggtgggaccttctgcccagcctctgtcaacttgatgcctcgttatcttctccatcttccctaaccccagggcagtaaattaaggagcaggtg

SEQ ID NO: 27 - DNA, 399 bp, Homo sapiens
cctccatctctatcaagaattgcttcctcagatgacatcatcatttatttacatataattccatgaaagtctactggcacagttagaaattcaaacaattagtatacctgcagtcttgacttgtcatgacataaagtagtagtctttcttcatttcatgccgtcatcagctcagctacccaacaattgtccaaagcagtrgagagagcaaattaaagtgaatctactccttggcatttgccagataagccacaaattaaatatcctcttaaaacaaaaaaggatttcaagtctcagaagagaaatcagtgctggttgataaatatttccactttaagttatatttatttcataaaatcttttatttggcattgtgtaaatggtcagcaatctttccctc

SEQ ID NO: 28 - DNA, 399 bp, Homo sapiens
ggatagcaaaaactggccaggtgaaaagagaggattgagtgattccaacagaagaaatggcaggagacctgggaaaggcccagatgaagagagaatgtggcttcttaagggaactgagacaagttcagtggtattagcaatttctgtggtgtttggttaaatttttcaattccaggaaataaaagattaacacataaatrttgtagaaaatttgttttcctgaaaacattagataataatgtatcatatgtattgacaaaagttcacatcaagttttcatacataatgtttactactggattatggatagttttcctacataattatgtcaagtaaaaaagcattactgaaatgacataaattttttctttaaaatattgtctgattttgatgcatttt

SEQ ID NO: 29 - DNA, 399 bp, Homo sapiens
ttatattctatatattacatattaatgtatatgtacatacatataatttattttaaattgatctcttcctaaaagcttaatagtctggctatgaagcacaagatgacacatttaatttccaatagggttcctgtttactgcgccacagatgcagaggcattgatggttttaaaatcactcttgtccatcaggctggaaamtaaagtaccaatgcaaccccaaatgtcatacatacattcttcttatgggcaagggcatttcaaacttctaaaatatccaatcaattaatttattcatatattatgtatttattgggcatatatttaaattcgaagagaaaattattgctctctaagaagcaataatctacctttgttaaagaaacaaggctcacattaa

SEQ ID NO: 30 - DNA, 399 bp, Homo sapiens
aaacttattgaaaagacaaaaatagagctgatcaactcactaacttagctcttgacacccatctgtttgtttccattgactgcctgactgtacttagtgttttattctagccccgtttatcctgatccattataattcttaagttcttatacctgtagcattttaccaggttttccaaattatttaaaaacataaatttrggttttccaaaatgagccagattttcccagtcccacagggagctttcccagaacttggtcaaaactcagtgatgatccccactatacaccccatgtaaatcagtagttaaaataagggccaggaaggcttcaacacaacacacctctttaattcaagtcagatctataaaaacggagacttgacagacctcagatttag

SEQ ID NO: 31 - DNA, 399 bp, Homo sapiens
ttaacacaaattcacaaatcaacctattttattcattgcactcatgtcttcgggctctccactgcagagtcttaaaggaattgttttggaatggacacaaagattactaacctctgtggaaaagtaccctgactttacagcgttcctacttcaaaaacaaactctgtctggatggcaagtcattgggagacttgagtgaytaccggggagttttggtgtaaaatggaattttagattaacctttagcacctaaatctgaggtctgtcaagtctccgtttttatagatctgacttgaattaaagaggtgtgttgtgttgaagccttcctggcccttattttaactactgatttacatggggtgtatagtggggatcatcactgagttttgaccaagttct

SEQ ID NO: 32 - DNA, 399 bp, Homo sapiens
tgcccaaaggtaccttcatgaccttaacacaaattcacaaatcaacctattttattcattgcactcatgtcttcgggctctccactgcagagtcttaaaggaattgttttggaatggacacaaagattactaacctctgtggaaaagtaccctgactttacagcgttcctacttcaaaaacaaactctgtctggatggcragtcattgggagacttgagtgattaccggggagttttggtgtaaaatggaattttagattaacctttagcacctaaatctgaggtctgtcaagtctccgtttttatagatctgacttgaattaaagaggtgtgttgtgttgaagccttcctggcccttattttaactactgatttacatggggtgtatagtggggatca

SEQ ID NO: 33 - DNA, 399 bp, Homo sapiens
aggtctttgggaaaaaccctggaaatgaattgctggtaactaacacacctacagtaccaatgcctgtatccagtatgtgttccaaaggactgaaagcaatacaactttacctaattttctcaactcctaacgtatccgtaagtgttgaagggcgtagtctatgttcaaattaggagaggctcttggttagaggtaaactsaagcgctgaaaactaagttttggataattacagttcaagatgtaacactctcatttatacccactctcccttatataacaggtaagcctctgaggttcagagtctgacaatggaacttctacatttattcaggtatttggcagccagcaggtcggaagcaattcaattgcttaaacctgattttactacctaacttggg

SEQ ID NO: 34 - DNA, 399 bp, Homo sapiens
gtcattactaactactcatctgtgacatgtactctttcttgtaaccagggattttagcttcacaaaatttagaaactgccgcattgtttcttggcattgctttcaaatgtgacatcatttaaattttggaatattccattttagcaaatacactagtgggtgccaggttaaagatgactgcccaaaaaggggcagcagcrtctctgtagggaacaaccacagattattctttcaacctataccatcccacgcctttcaccagaggcatactgaattacaatgagctcaataaatacatttcaaaaatgggttatcaaattaccagcctatagcaatggcttccagtcactgaagacctatattgaaaaacaactgtgatatatggaaatgaaaactcca

SEQ ID NO: 35 - DNA, 399 bp, Homo sapiens
tctggataatgtgctgcagcttcttcatcatcacttgctgcttcaccttgtacttttatgttatggatgtgacatatctctttaaaacccatgaaccaacctctgctagcttcaaacgtttcttctgcaacttctttatctctctctcagctttcaccgaatcaaacagagggccttgctctggattaggctgtgccctragggaatgtcgtggctggcttgatcttctacccaaccactaaaactttctccatatcagcaataaggctgtttttgctttcttatcatgtgtgtgttcaacagagtggcacttttaatttccttcaagcacttttcctttgcattcacaacctggccatgtggcacaagaggcctagtttttggcttctctctttttca

SEQ ID NO: 36 - DNA, 399 bp, Homo sapiens
tacaccctacagtggctatggaatcacacaacttctatttattattctcctgccgaaaaactgggtgatctcagtaataacaaaccatttttattaacgaagtgcttatgatcatgtaggatatattccacataatcaaaataaaacttctaaaatatccagtgagaaccacaaaacattatctctaaaatactaccccycaagaaaggttctgaggtattcaaaattaaaacaacctactgaaaaataagacagtcattaactttgaagaggaattgtgtgctcattttgaggaagaggaaaaatttcatgaaattaatgcaaaaaagttactacaagaggaaatccctgggtatcaaaaagtcatattttttaaatcatgtattaaaattaggtact

SEQ ID NO: 37 - DNA, 399 bp, Homo sapiens
tttttccaatttagaccttgaactcggcactattgaataccaaagcttatagaactgaaattcaaacataacagagcttttgaatttaaggcatgtattctaccaaaggatgacactgagctagccttttgggataatataatgccactctttctacaatagctgacggctagaatgctcagtttgttcctgtccgtaawtatcctaaatataattgttaaaattaaaaataaaataaggccttagaaatactattttgaatagtctaagcactcccatagttaatgacacacagaaattacaaagattagaaacagaacaatcattatcattatttatagaaataaatattcaatcgtttgacattcaccaaacctgttttacatgttttatctaaac

SEQ ID NO: 38 - DNA, 399 bp, Homo sapiens
aatcattatcattatttatagaaataaatattcaatcgtttgacattcaccaaacctgttttacatgttttatctaaactgattcttccccccaaaacctgtgcccaggtactactactcacagcctatgggtgagaagactgcattctagagaaattatagaattactttaagactggttttattccaacagagccacwtcacaaaaaggaaaacatagctacaacctatgggacttctaaccatagctggacagaagtctattccagacaatcacatgtcccaaaaggcactgtgatgactgaactttcttttaacttgtattgtacatatctggagaacaaataaacttgaaaagaggtcaaagtgctcaaattatagaaaaatgcaaaataaaac

SEQ ID NO: 39 - DNA, 399 bp, Homo sapiens
caatcgtttgacattcaccaaacctgttttacatgttttatctaaactgattcttccccccaaaacctgtgcccaggtactactactcacagcctatgggtgagaagactgcattctagagaaattatagaattactttaagactggttttattccaacagagccacttcacaaaaaggaaaacatagctacaacctatkggacttctaaccatagctggacagaagtctattccagacaatcacatgtcccaaaaggcactgtgatgactgaactttcttttaacttgtattgtacatatctggagaacaaataaacttgaaaagaggtcaaagtgctcaaattatagaaaaatgcaaaataaaacaaaaagtttagaaaatactgtgatccacattt

SEQ ID NO: 40 - DNA, 399 bp, Homo sapiens
aagaaatcaagagataaatcctgtcacctacaagttaaaatggccacctcacatccagtcatatatcaactattttctttacctaatattaggtacactggaaatctcaaggcaaaatgaagcagttggatacaaattatatgaatcaatatagctcagtcattgcaaaatatctcttgtggaaaaatttcagaacagcyctactaaaaatactaattttcatgatatggccttactaatatggacttctagaaaaggaaattaatacagagggtataaaaagcatgtccgtaacaagaattaatttaaaaataagcttgatgatgtaaagaaggcaaaaacttgatagggatccacgtatagctactgtcttaaagttcataatttaagaaaaacata

SEQ ID NO: 41 - DNA, 399 bp, Homo sapiens
ctttacctaatattaggtacactggaaatctcaaggcaaaatgaagcagttggatacaaattatatgaatcaatatagctcagtcattgcaaaatatctcttgtggaaaaatttcagaacagccctactaaaaatactaattttcatgatatggccttactaatatggacttctagaaaaggaaattaatacagagggtrtaaaaagcatgtccgtaacaagaattaatttaaaaataagcttgatgatgtaaagaaggcaaaaacttgatagggatccacgtatagctactgtcttaaagttcataatttaagaaaaacataaaggcctcagttcccagaatgctaaaaatacagtagccttatatacatatatagccttagtcactccaaaaggctt

SEQ ID NO: 42 - DNA, 399 bp, Homo sapiens
agcagttggatacaaattatatgaatcaatatagctcagtcattgcaaaatatctcttgtggaaaaatttcagaacagccctactaaaaatactaattttcatgatatggccttactaatatggacttctagaaaaggaaattaatacagagggtataaaaagcatgtccgtaacaagaattaatttaaaaataagcttsatgatgtaaagaaggcaaaaacttgatagggatccacgtatagctactgtcttaaagttcataatttaagaaaaacataaaggcctcagttcccagaatgctaaaaatacagtagccttatatacatatatagccttagtcactccaaaaggcttcatgtgcttttgaaactattacataaggtaaattttgattaagt

SEQ ID NO: 43 - DNA, 399 bp, Homo sapiens
agatttcctcccatagtaaggaactcccttttttgcattaatctcatgcctcttacagtttgcccaatgatcacaggtgaataagatttaaggatgagtagctgctgatgaacccaatttgggatctggcaagaggaaatcagagcgtcaaatcaaggaggggtggcagcaaagaggaagcaaaagagaagacaagaggraagagagtttatggagagaggaagccaagttgggaagtggggagaagggcaggctggccaggggatgcgacgcgacagggcagagggagtgggaagaagcgggcaggaggcggcctccacgcagctggcagggcaggcagcgctggagagggaggaggagagggaggctgcaggcaccgcgcagcagccgaggatgaga

SEQ ID NO: 44 - DNA, 399 bp, Homo sapiens
ctgcagttctgattcttttttcttcttaaaaacaaaaggaaaaatttttttaaagaaaatgtcccttattattattattttatttctctcgctacactatccactaaagcacactgcgtctttaaagctctttcataaaatataaattacttaaaaatctaacagacacgctggataataactgatgaaagtactttttkaagtctaacccaaaccacgctttctttttttttttcttttttgtctttgtagcacacataagctacctcagattcaaagctgtcaatactccatgtggagcaggggtagttacccaggagtataaataaactaagaaatacaaagccataggattatcaggacagtaccacatccctgtcattcaacaacttccccttc

SEQ ID NO: 45 - DNA, 399 bp, Homo sapiens
tctttttataacaagagactgcagatatcgctacagaaagaataccggttgtatgtttcctgaattattactaaaaacatttgtttaaatgtctcatatataaaggtgatggccttatctctgacaatgaattagggcctaaggagaaagcaaattggaacactgttaacattaaaaagtcagctagtctttgaaatacyattataatactaccttggaagatacagcaactcaaatcttgttcacccaccagataagaaacaaagtagagggagcctcagctcttagggccaggctgcctggactgaaatcctgactctgctacttgctacctgttgtagcctaggcaatttattatactttcctgagacccagttctctccattctataaaataaaa

SEQ ID NO: 46 - DNA, 399 bp, Homo sapiens
actttcctgagacccagttctctccattctataaaataaaaatgacagcagtttctatctcaagtgaagacaacatacagcacactgctcaaccagtgtgaatcaggatcagcattttaaggcggccccaatggaagacaaacctcttggaacgcagcctttccctggtcaacctagctcacctatggcctgaggttgcrctcacttttacttagtaatcagtgcttagctgcgcatctaccaagtcagttattactacacgcagctcatttctatgcaaaccgtgtccagcctttgggcaaagtttgcatgccctctgctccctgatgttcacaagtgaaaacactaagcccaacacatttaatgtcctccttcccatcattaaagggcaccacgcag

SEQ ID NO: 47 - DNA, 399 bp, Homo sapiens
ctggtcaacctagctcacctatggcctgaggttgcactcacttttacttagtaatcagtgcttagctgcgcatctaccaagtcagttattactacacgcagctcatttctatgcaaaccgtgtccagcctttgggcaaagtttgcatgccctctgctccctgatgttcacaagtgaaaacactaagcccaacacatttamtgtcctccttcccatcattaaagggcaccacgcagctttagcagccaggaaactagcccagcacacatgctgtacagctggcaatagaggcatcttcaacagcatccactcctacatacagtctgataaggaacattttaatggagccaaaacatccatttccttcctctatttctgcatttagcaaacaggagagctg

SEQ ID NO: 48 - DNA, 399 bp, Homo sapiens
gaaagtctatgttgccagccaaagtgttcttcccctatgttcctatttaatgcaacacttttgagaactactgcatccaagtcatttgtaaagggaacaaaaatgaattacgtatgctctcactctcctcaggttcatgatgcccggtagcttctggtatgagctatgctaaagccacacataaacaggagcacaaggcrgggatgttttaacctaaatgagcggaggtagagcgtttcaggaagaagaatacagaagtgaacatgccgaggaacagatagaatccctgtagttaaggttgcgtagaaggcatttcataaggagggaagaatatgaacaaaagtcggtgtgagaatgttctaggactagaaagcactatagtaaggatagacacatgat

SEQ ID NO: 49 - DNA, 399 bp, Homo sapiens
tgttcttcccctatgttcctatttaatgcaacacttttgagaactactgcatccaagtcatttgtaaagggaacaaaaatgaattacgtatgctctcactctcctcaggttcatgatgcccggtagcttctggtatgagctatgctaaagccacacataaacaggagcacaaggcggggatgttttaacctaaatgagcrgaggtagagcgtttcaggaagaagaatacagaagtgaacatgccgaggaacagatagaatccctgtagttaaggttgcgtagaaggcatttcataaggagggaagaatatgaacaaaagtcggtgtgagaatgttctaggactagaaagcactatagtaaggatagacacatgatgtagtacatttggaactggtaaat

SEQ ID NO: 50 - DNA, 399 bp, Homo sapiens
catctggaaataaataaaaagtagccatttgttttgttttaccttgtcttgttctaaactttcaaaggagccatattcaatatttgttgttacctaaaatccatcccttgcttaaaacctaatctatctctcagcttcattagccatgtataagctacagaattgcatttggacttttcctagattccaagaatggtccrtaatcaatctacaactggattataatccaaatagccagaagataatgctatttaattagcttctataaaatatccacgatagtctgtgttcacaaatatgcctcatgaggtcaagtataaaatagtttaaagaatgtctgaaaaggagttttccaaaataggtgactacattagcatagttgtgattcaggggaattaa

SEQ ID NO: 51 - DNA, 399 bp, Homo sapiens
aatagatggctactattctagtttgcgttactccctcgacttgatggaagtacaatcatttattgaactacactagctcaactcataaatacgttaagaagcctgtgactgatgttattgaatttataagctaccagaaacaagtaaactccttactgtagacctcaaagagttgataacatgacacttggcattgtacytcttgggaatctaaaacatactgatggtgagaatctttcaagtattcttctgccctaaatccagaaaacatgactttcaagcatcatccatggtcgaatggtcaaattcacatttataaacttggaatagagagtttggtggaagtactgcataactaaaattgactttttttaaaagccagaactatgtcacagttgg

SEQ ID NO: 52 - DNA, 399 bp, Homo sapiens
gtaggtaaaaatcctgcagcttacacatttttccactgagaaggcaaatccttactcctccagaaactaaaatattagaccccaaacagtgtagggggaagaggggtaggaagttgaaaaaaagaaaaaaatgatgataaagcagggcagaataagccagaggaagcatgcttggtctcagcataattttctttagcatyctaaaatcaacgacatcatgctgcccatgatctctgcttactcttctgtaacccagtcagaggattttcaaaaaggaagaaatctagttgtgcttccaaatgccaaatgaacttacaggaccttccactcctgaaggaaaacagcacagtagcgcaccagaagctagagaatgccttgagtcacgcaaagccggaactg

SEQ ID NO: 53 - DNA, 399 bp, Homo sapiens
ttccaccacttatttgaaaagtgttagacttaggtattatgtatggaaaagcagtctacacatatatatcctaacatataacatacatatcaggaagccataaacatcagctcgccagtggtaaataatacttcgccaacagagtactaatgaagcttcagaaggcctcacattcagagaaatcaagttataatgttggyattaaggctctatttgcccctcaggagttttattttcacattattaacatccagaaataatcgtcaaactttagcatgttactagccctgtatattgaactgaatctagagatgtttttatccaaaggtgtagctttaaaaggaagttatgaaatccaaggagagagaaactctaagaatatgtttgacttgttaagat

SEQ ID NO: 54 - DNA, 399 bp, Homo sapiens
tcttttactttacttctaaagttggtaagttgctgtaaaatcaggagacaggtttgttttcaaattgaagaataaaacttgattcagaatcaagtctttgagatttattagcaaatatgctcattttttgtgatttaaactttgaatgttgaaaagcctccttttcaagaatattctgcaagatagtaaagagtgtactygtaaaccttttgcagattttataatggattaatggaagttctatgaaggcaatatggatatgcgaccctgtaaaagatagatttgttcctcaggtttagcgatcctggagtaaactaaaaagcagggttttgaggtccttaaaatactttgtaaactggttataggacattttgggttttctttttagtatttaggaga

SEQ ID NO: 55 - DNA, 399 bp, Homo sapiens
aataacaactgtatacagacacatatgacccaaatattaattaattttgtctttttgcattatagaatagtaattttttaatcatctttggtaatattgtatatgtcctatattcccaattcagaacaaaacaaaatggaaacatttaaataagccatctgttttgctttaaagacatattaatctcaatatgaatgaayaacacaactaaattacatttaatttatattttaaccctgctgacgatgagcagggggatatagctagaaagctcttgtttgatattctatctaggggaaggtgggacaggattcaagaatctcttaaccttctttctgtgaagaaagctgagttacagggtcaccacataagatcatttgcctgtatcctcacactcct

SEQ ID NO: 56 - DNA, 399 bp, Homo sapiens
atacctatgtaattaatatatatagtgtattaaaagttataataatagcaacagccatattaaagcaccataattggctcaactgcacatctattgttgaacatttaggtttatatcatttggtattataaataaggcctcaacggataactttgtatatgattctatgtccacatttcaaattattttctttaatggawttttctagcagtgtcatatctgaatcaaagggtataaaactttttaaacatttgcaacatattgaagacctggccaaatttacacttctatcggtaatgtgtagatttttttttccagaagactgagcaattctttatgatccagttattggttatccctctagaatccatctctttccccaccagcagccaacaaagg

SEQ ID NO: 57 - DNA, 399 bp, Homo sapiens
ctatgctcctaaaaccctagtttcgaaaattctcattgatttattttctatggcctgagataaaggcattaaagtgatgatacatgatctcagcctttctgaactgactaaaaataatattaataatcataggaatacatttcctttccatgctactttatagtgtacatatatcctgtaatttgatcctcacaaccacrcaatgaggcattgaaggcaggtgctattttccctgttttgcaaatgaggaagctaagacaattacatgagaggttaattgatattcaaggtcactcagttggtaagtggcagagatatgactcaagtcgaagttgtctaacctgaatttctttccattctatccaagtgtttccttaggaatactcagcagcaacagtg

SEQ ID NO: 58 - DNA, 399 bp, Homo sapiens
agagatgatgtcctaggactaggagataggcagtagagatggatttcagtgggtgaattacagatattttaagtgtagaaacaaaagaaatggatgattatttgcaggggtgtaggagatggaggcttcaaggcagactttgagtcccctggcatgagcattgcagggaaagggaatgtcatttactgagaaggttaacrctagaaaaagagcctttgagggaaaggaatattgaagatcacgaattgattttaaacatgttatgtttgaaatatgcaactagatatttcaagtaggttcttgtttacactgattcaaagtttcaaggagttgaacaagctggaaatagaaatgtgggagttactctcttacagatggcattcaaagccatgagagtgg

SEQ ID NO: 59 - DNA, 399 bp, Homo sapiens
gatacagatattttctatttacccccattcccactcacgcatagcctccttcattatcaacatccaccagtaaagtggtatatttgttaccattgaggaatgtaatttgacacaaaattattacccaaagtccataatttacataagggctcactcttgatgttgtacattctgtggatttggacaaatatataatgacmtgtgataccattattgtatcagagtgtggtttcactgccctaaacattctcttggagattacttttattgaggtacaaaagcagtgagataggtagaagggtagtttagacagagagatggaaaaatagatatagacagataaatcaacgatagaaatatgagaagaaagaaagaaagagaaagagaaaggaagaaaga

SEQ ID NO: 60 - DNA, 399 bp, Homo sapiens
agtcaattttctccaaattatctaaagattaaataccatcccaatcaaaatcccagcagatgttttatgaaacttggcaagctgattctaaaatttatatgaaaattaaatgccctatcattaccaaatcaaatttgaaaaagaaaaacaaaatgttaggactcatactacctgattacaaaatttattaaaagcctagmgtaataaatgcagtatattgttggtgtgaagaaaggaatatagataaatggaccaaaatagaattcagaaataaagcacacatgtatggtcaatttatttttaacaaaattatttttaaattttaattatggcagaaatgttggataatcatgcaaagacaatgaacatagacctctacctcacaccattcatcattgc

SEQ ID NO: 61 - DNA, 399 bp, Homo sapiens
tggtaatttgtgttttctcttatttctgatcaatcaggctagcattttttatcacttttattaatcttttcaaagaacagcttttcatttaattgatttttttctattggttttctgttttctatttttttctttctgctctaactttactatttcccttttctgctctcatttcctttctgtttactttaatttcctcmtattattccagctgttaaaggtagaatcttagttcattgattagcatttttttctgttataaacatttaatactgtaaatttttaagcacggcaccacaaattttattatgtcatgtccttattttcattttattcagtccaagataccttgtaatttctcttttgatttattgtttgatccaggggtcatgtctcctt

SEQ ID NO: 62 - DNA, 399 bp, Homo sapiens
tagggaatcctttcccattgcttgtttttgtcaggtttgtcaaagatcagatagttgtagatatgcggcattatttttttccaggtcgatttgtcatgattacatatttaattatttttcaaatatacctttatactaggatttttttcttaagttatctccccagccccatgcactgtcttttttttcccccttggagygctttcttccagacctaaaaggagagtatttgatcatgttaagtaattaatcacttgtttgtaagctacaggaggatgtggacaatgcttatatttgttcacctttatattcgcaaatcctcatgtagtgtttggcatatagcataacccactctcagcacatgtttttggaattaatggataagtagtgtggtttaaa

SEQ ID NO: 63 - DNA, 399 bp, Homo sapiens
aatattagtctttaaaggatttttattatatacacggaaaaaccaagtttccctttctttgcctagcaaatagcttattcaaaggaaataaatgtagatttcaagtacccgaacagaaattaattttcatatcttttgctttcaataatggggacaatgatatttagagttgcattgccaaaatggaagcccctagccayatgtggatactatgcatttgaaatgtggttagactgaattgagatttgctgtgagtgtcaaatacatactggattaaaatactttattatataaatatggtttgtgttttcattacattgtattggattgcattggtttgccaagttaacgtgccaaattcatacaacttaaaagaggtagtaagaacattaataataa

SEQ ID NO: 64 - DNA, 399 bp, Homo sapiens
cagttgttatcaaaatgttttggttttataggcatagtcacaatatttttccattatgaatatattttaaaaacctctaaaagtattttacagagcaaaagcctattctttcaatgaacaaatgaacatgatttattaaaatgtcagggtaattacctggggtatcctttcactagtcaacttaaagttatcatataaasgcttagaaatttaattatggagctatgaacatttcctctgactttgtgtttaaaaatttctttttggtgagcacattatttgagaagagcccatacttatttagggagaaatattcttgatgtgattaatttttttatctctcatcttttcttttacttctcttccctctctcccttccttcttattcttcttccttcc

SEQ ID NO: 65 - DNA, 399 bp, Homo sapiens
taaattctttgatgagtgatgcagctgtcatattattctgattgtattaaacaattttgagcaacagtgagttagtaagatgaggtctccaatgtgtttgtgcctatttcagagatatgtggcaactgttttcatcaacagagattttgtcaagttatttaagctctttggttcagccctctttccgagcaaatatagtratgacggcaaaaataattacacatttccaggcagagtgcttgcagagccactgtcttttatatctatgaaattagtccttataggaagaggaaagtcccagcctcccactcactaacattataggcatgtgagagattcaactcctgcctccttgctatcctactcatctctcttcataccaaattactgaggatgatt

SEQ ID NO: 66 - DNA, 399 bp, Homo sapiens
tcatctgcattccaagtagtttgtgttaaatatattggtaaaattccttaaatagaaacaactgtgatgcaggttccaaagtgtgctgagccagtgatagttccctctctgggtccttataatttctgtaagttacctttattataccattaatatgacacaattatcactttaattagaggcagatgtgactgacaatkatatatgtagtttcccttcctttcatatctagttttaacttgtccccaaataatatgcacacccctctaaaaaaatctgtactcttatttgtcgagaaattcctatcaaaatgctataatagtgtgtaagtttcccaatggcaatgagattaaaacaaataatggaggccagctggactcatggatccgtgtcttctct

SEQ ID NO: 67 - DNA, 399 bp, Homo sapiens
cattgtttggcagggttatacatgactttattcttaaatgttttcatcctctgaaacttaggtcaagaataaaaagcacagagagagtagcagcatgtgggtaagccttaagaaactttaaaatgtaaatagggacaaaggtaatactgcactcataaaatggaatttgtaggcaagagctatcttttcttcaacaaagygagtcagtctatttctcctaacttggaagtatttcctacaataaaattcatataataaattaagtattgaattaataatatatccattatattttaaccttatttacaaataaaatatgacaagaaatttggatttgaaatatcaagcatcagccataatctaccaaccaaattttatttttgcatatcactgtatagt

SEQ ID NO: 68 - DNA, 399 bp, Homo sapiens
caaaatattttaataacactgtaaagtcacgcattgtaaattctcttttgacatatggctacacaataaagttacaatatgatcttatacaataagtaaaaacacataatatgtcagctaatgttacctttatatttgtatgggtgactgaagttatttcaatttattaagatttatcttacaaaacttgttaaggcttytgaaaaagatctaaagaaaattttctgtgggagccaggtggagctggggtcttctatctggatatcagatagaaatttgattttttattcttgattaaattgtctaatatctgtagtttcaatatactactaaggtagaaagtaaaattatttatttactttagtcattgtcaggcaatcaaggatacttatcaaattt

SEQ ID NO: 69 - DNA, 399 bp, Homo sapiens
aggaagaagaaaagaaagaaaatgaaagaaaaatatgtcttcatagtattggcagatgggctttatgttatgtcactcctttaacccttaaccaagccatttacaaccctaccttaccattcacatcctatttgagcagagcttggcggtcagccagagttagaagtatagcgttgtctctagccttttctgagcaggcrtcctgctgtgggtatttgcttggccttctcaattcttcagcatttgtggaagtttttaaaagcctttgtactccatatatctcctttctcaacttcttttccaggctttttgatatgtttattgcctatgctgattattgtccctatattgacctgatatagccaatactgtgcctctaaattctttcagaaaatgcca

SEQ ID NO: 70 - DNA, 399 bp, Homo sapiens
cctgagtagctggtactacaggtgcatgccaccatgcctggctaatttgggtggcggggagatggagttttgtcatattgtacgggctggtctcaaattcctgggctcaagcaatctgccagcctcagccacccagggtgctgggattacatgcatgagccaccacacttggcctctttctattttaatgagtctggctrgacactcattgtttttaaatattcagctttatatttcatttttttaacattatgtttgttttttatttatttcctgtctttgttatttttttcttttttgttgtaatttgcccttatgtttgaatttctaaatagaaatttcttccattgttttaaacataagccttaagggtaacttttatggcagcactgtttgaac

SEQ ID NO: 71 - DNA, 399 bp, Homo sapiens
ttatttcctgtctttgttatttttttcttttttgttgtaatttgcccttatgtttgaatttctaaatagaaatttcttccattgttttaaacataagccttaagggtaacttttatggcagcactgtttgaactaactgcattcttcagatattgctgtttttgttttcaattttcatttagttcaaaatattttccacrttccctttccctagtttttcttgaactatgggttatttgtatttatagcattcaattttaaaatattttgagattttatacttatattattcatttctgatttaatttaaatgtagcctaagaacatacatttatttattcaaaccattttaaatttattgaaaattatttttaaggaccgattttggtctgtcttggt

SEQ ID NO: 72 - DNA, 399 bp, Homo sapiens
ctctgggaagtcttttctgaccccagtccatctgggttggaaagtgcttttatgctcccatagaatatttatttacccaccttggctcttactttctcactgtaattgaacatttgcctgcaggtattcctaacagaccacaagatatgcaaaactagtttttctgttcccttgtcagtctctgtaatcgcatttgttaygtctttaaatcacttaaatcagagtttgcaattatataattactcgtgtaatatcctcatgttccacctcacacactattcattgtgaaaatgagcttattttccttaccaatggtaaaatgaagaattgacacctatagtcattcgaaccacagtttgtgaataaacaaatataatatcagtaaatggatttcaagaa

SEQ ID NO: 73 - DNA, 399 bp, Homo sapiens
aacatggtgaaaacccatctctactaaaaataccaacattagctgggtgtggtggcacatgtctgtagttccagctacttgggaggctgaggcaggagaatcgcttgaacctgggaggtgaaggttgcagtgagccaagatcgtgccactgcactccagcctgggtgacagagtgagactccgtctcaaaaataaaaaartcctgtagaaaccagcttttagacctttaaccagtttatctggaattgtgcaaattagcacaaactgaagcattcacaatgcaattgccacaaatgaggatgattttaaaatacaaaaccatgtattgcaaagtaagaaaataagatgatatatcagcctattaaggacagatctttataaaactgttcaaaagtgtaa

SEQ ID NO: 74 - DNA, 399 bp, Homo sapiens
aggacagatctttataaaactgttcaaaagtgtaaacttcttgatgttgtattgtcatagtcttccaagtagatgcttcacaaccagactgctcctacagttggaaagaactggtaaaaagcaagcaaccaatcaaccaaataaacaaaaacttacatattgtgtgaatgaggctcattatagcttgggtgtgctgtttkacacaaccatgctggccataaaggtttctagtctggtagatctttttttttcttattgagaaggtttgtcttttctgtaaaatataaagcagagcagctcagatggccagtgaagtttctttgaaaggcagccaagtgaaggttggggcatgtccatgcccctgttgggtggctcttttaaatcgttatgctatatata

SEQ ID NO: 75 - DNA, 399 bp, Homo sapiens
aatgcttcttccaaccaattaaccaaccaataaaaaacaggactagaggtagtcaatgaggctagttctttttttccttccacatagacattatgcatgtaaggggagatacagacatgtgaatatttctatcatataagaggggaataggacgcagatgggattttgagatctagaattcaggcaacagaaggaaaccmgctcttacctcggtgcatgttgaggaagaaaatggagaggaagggaactggggagcctgagggatggccaacttcctggaatgtcaacttaatatatttgaatgcagttgagtccacctttatttcttttattatttattattattaacttttattttaagttcaggggtacatgcgcaggtttgttacataggtaaac

SEQ ID NO: 76 - DNA, 399 bp, Homo sapiens
gttaaaaaaaatctgtctgtgcatcagggaagaacctttgcagtgctggcaaaataaacaaactcttggaattttcgaaacgggatttgccctgcatgtattttgagtagaaagtccttagggcattcctgcaaatgtgcatccgcccaaacttgaaagtcgagtcagtctaatctttgtaatgatagtaggacccagayctgctaagagacatcacatccagttttctaaacaatttcatcagcatcatccctgagcctcatttaatcttaaaccgtaggaaggagcccttacaaccagttactggaacacagccaagccctcaaccatgcctgctgcaacaggtcccatgactttggacacgtgctcaggatggatgttgccaagatccgaaagcac

SEQ ID NO: 77 - DNA, 399 bp, Homo sapiens
gaaacgggatttgccctgcatgtattttgagtagaaagtccttagggcattcctgcaaatgtgcatccgcccaaacttgaaagtcgagtcagtctaatctttgtaatgatagtaggacccagacctgctaagagacatcacatccagttttctaaacaatttcatcagcatcatccctgagcctcatttaatcttaaacmgtaggaaggagcccttacaaccagttactggaacacagccaagccctcaaccatgcctgctgcaacaggtcccatgactttggacacgtgctcaggatggatgttgccaagatccgaaagcacaactctagggggtgctgaagtgaggaagcaataggcagggtgggcagataatggacaagctggggctggacaaagg

SEQ ID NO: 78 - DNA, 399 bp, Homo sapiens
atgatgtccccatttccattttgattgaggatccatgaataactgagtgcctttttttaaatgtaaaaatcactggccatgacttaagccatacttttatttcctgggagaaaactacaaggtaaatagactttatatgagttcacattacttcatgaaattttgctgacaaaacacatcagaataggttggacacacawatttttggtaaatgttataaccaagagtttaaaaagaaaatgcataaaagccataataaatcagaaaattccgctttgttatttccaaaaattatgtcaatcatctaatcatctgtcagtttggccacccctttgtagtatgctgttgaaaagcacatgattgtctacagtcttattcctaaagcacccacacattttt

SEQ ID NO: 79 - DNA, 399 bp, Homo sapiens
taatagctctcagggctactttgtcaccaagatccgtagaattgaatgcgattgcagcaaaaggtactatgagtagaaaataaattccttatgtcgaaaagagaaaaatgtgtgggtgctttaggaataagactgtagacaatcatgtgcttttcaacagcatactacaaaggggtggccaaactgacagatgattagaygattgacataatttttggaaataacaaagcggaattttctgatttattatggcttttatgcattttctttttaaactcttggttataacatttaccaaaaatttgtgtgtccaacctattctgatgtgttttgtcagcaaaatttcatgaagtaatgtgaactcatataaagtctatttaccttgtagttttctcccag

SEQ ID NO: 80 - DNA, 399 bp, Homo sapiens
gatattcctaaacttctctcgactcctctatttcagttctgctttatgggaataaatgtggagactgctctccccagacaattacccaaagtgccacaacgcttcttacccatatgcaactcgtaacaagatatcaaatgtcagtaggaagcctagaaactataactcctagaagacagaaaaacctgtcttatttagcyttatcacctcccagctgcccccaacaagacttgcatgtggctttgccatggtgaacactcatttattgcttattgaaccggaatcttattgtaaggttctttattaatctcagaagccatcttcttagtgagtttctcagagaaagctgcctgattcaaaagagtattattgtgaggtcaagagtgttttctttaaata

SEQ ID NO: 81 - DNA, 399 bp, Homo sapiens
atacatgaaaaacctttaaatattaattaatttatatcagcaaccactgcttgcctagaatgccagcagtacgtaaagaaatattggtgtgtcctaatggaggaatggcaggtcaattgccaaaagtggaaatatctttgcctgaagctattttaagtaagatatgtccctccttcacttcccaaaacaggaaaaaattwgataaagatgagccattatgtacagttaacaaaataataaatttcactacaaatgaagcttaaattaaaagtttacttttactggaaaatcattttgacttttggagatgaaaataagagatgaaatgtttgtcctaagtcatacaagattcaagggaaacagaactgctctttgttgtataaacaaagtcaaagataa

SEQ ID NO: 82 - DNA, 399 bp, Homo sapiens
gtagacagggaatgtctctgcaaagagagaaaccatccagagtacagggatgtcagaaagaaagaacacggatgaaagagcccaagaagaggctcaaatatacaacctctgctatgtaagtctcagggaaggacgattcctgttgagttaaggagtaactcataagaaagcaggagaattgcagcgcctccaacaactcygcttcttccaagaagataactgaattattggcagttcttctggaaaataaccccacattggaaggatgagaagcgaccctgaatttttcataaaaactctgccaaacttgggagaaaaaaaaaaaaggaaacactgctttggaaattttattgatttaaaaatacatatgaagagacattaaaaataaggttcatactt

SEQ ID NO: 83 - DNA, 399 bp, Homo sapiens
aaaaatacatatgaagagacattaaaaataaggttcatacttgtcatgaattgaacaaaggtgatcctatgtactttcatggcaatggatttttaaaacatacagaaactatttttagttttatattttagagctagagctgtagtgttctaaaacctaataccaaattttggctaatcttttcatatgtcctttttttmttcagtgcttagaaataaataactttagtgatcataatgtccttaaatgtaaaatagttaagtttaaaaaatttcaaaataccttttcctattgtaaatgaattaacaatagttattagattccccagtgttttttgtcaacacgcttttttctatgggatttagaaaatacaattagtgatatttttcctaatccaga

SEQ ID NO: 84 - DNA, 399 bp, Homo sapiens
aaatgtaaaatagttaagtttaaaaaatttcaaaataccttttcctattgtaaatgaattaacaatagttattagattccccagtgttttttgtcaacacgcttttttctatgggatttagaaaatacaattagtgatatttttcctaatccagaataaattttctttttgctttgtatgcattctagccagatgagtgsgcaattattttgaaggttgacaatctgctccaagtcttagaaagcaggcaagtccccaaagaaagaaggaaaagacttgagatctcagcttagagttacggaaattacatggactttaatgataaagaaacacttacagaaaaaaaaaaataaacctggctctgctatttattgattttgtaatcttgggcaaattgtt

SEQ ID NO: 85 - DNA, 399 bp, Homo sapiens
atgtaaacaccacattggacaacacaggtgtgaaaattctccatcatcgcagaaagttctaatggacagtgctgctcccaacagaaagaatggcaaatacacaggtcctgaagaggcggacaacagaagaagtaacaaggaggtcagtatacctgtaactgggtacaagtgggagagggaaataggagacagaaagtcartgaggggccagagtatgtagaatctctcgcaggtccttcctggacttcaagatattattctgagcaagatgggaagcctttggaatgtgttgagtggaagggtaatgtgctgtactttgcactgtgtcaagggcactctgactgctgttttgagaattaagaggccagagcagaagttaaaaaaaccattgtgatcatc

SEQ ID NO: 86 - DNA, 399 bp, Homo sapiens
aaaaaaattaagtaaatgtaaagaagaacacatttaatgagatatagagctatggcaaaagtagtgaagtctggaaaatcttaactttacaataaataaatccaagatcattgtaagcattgaagagcctctattgcctagtttatgcctgctcacgtctgaaacatcaccctccgccactccattcttcaccttttaawccttagtcatgcagaactacatgtagctctttcttacttcctgcaaaccatgctcatactcacttttcttagccaccccaatccaagatcaatttatttggttagatcctatccttgactcagttcagtgattatttcttacaaagcccttagccccatcaggttagaggtggcgatgggaagaggaatttaactccat

SEQ ID NO: 87 - DNA, 399 bp, Homo sapiens
gaccagcaaagaacctagagaagttcaagcaggtgctgacgttttaatgaaacttaaatttccagagctacaagtctcagagaagttagcaaattgtgttatacaaaaagatataaatataaatcatcacctgtcagttccaagaatacaaatgaacaaagagttgatcagcaaggaattctttccccgctatcctccakcctatctcctaataacccacaaacgttaattctttatactcaaattggttgcctaaataactgttttcaaacagctatttgaaattttactacataatttgtttattatgcaaatgtgaataaccccccagtgatactttttgactagcaacaatatagagagtgcacaactttgcatattgtaaattcacataaacat

SEQ ID NO: 88 - DNA, 399 bp, Homo sapiens
gaatcattggaaatcctgaatccaggtggaaaaaaaaccctccatctctatcaagaattgcttcctcagatgacatcatcatttatttacatataattccatgaaagtctactggcacagttagaaattcaaacaattagtatacctgcagtcttgacttgtcatgacataaagtagtagtctttcttcatttcatgccrtcatcagctcagctacccaacaattgtccaaagcagtagagagagcaaattaaagtgaatctactccttggcatttgccagataagccacaaattaaatatcctcttaaaacaaaaaaggatttcaagtctcagaagagaaatcagtgctggttgataaatatttccactttaagttatatttatttcataaaatcttt

SEQ ID NO: 89 - DNA, 399 bp, Homo sapiens
gaaaaatgtctgcagtttttatgacatatgcttttaatgattcacattacctgtaggcacttcaaaagcactgggattccgattctcttcagtaattagggggtcaaatgatatgccgagtacattagagaacagagcccagtgaaaatgggccatgtgccaaaatcatacccttcaagacagatgggaaccaagcctcrgaatggtctgtaattgtaccatttttgaaagccacactttaatgctatgaggacatgtagaggctatatctgaagaatgtatacaatatttgtacccgaagttaaacaaaacgtaaatctttgtctgtgggttgtccccaacttagagacctcatcagaggtactacccctgtactactatccatcagaggtgctttta

SEQ ID NO: 90 - DNA, 399 bp, Homo sapiens
tcattcatttattcatcccacaaacatctactgagcacctacaaaaaatatatgttctaggcaatgctttaggtactgaggagctttggtaaagaggagagaagttcattgtcctcttgtattttatatcccttagcaggggcagacagttgaaaaaatatagaactaaataactccaaatagggaaggaaaaaaaatcrcaaaaggaaactggtagagagaggctgatacaggagatatgaacttctttagcttgggtcatgcacagaagccacacacacagaagcaggggatattgctgagacacaggagtaaaaagatggccacatacacacacacacacacacacacacacacacacagaagcaggggacactttgctgagactcaggaatgaaa

SEQ ID NO: 91 - DNA, 399 bp, Homo sapiens
tgttgtctgttgtttttgtttacatggcttcatgtcttttaggacatggtacgtaggaaattgcatggtgaagtggtacaagcatcaggctcaagaatgagagtccagtttgacagaccagatgaagaagtgattaagaccatagttctggacttagacaagcctggctttgtgactttggacaaattatttgataactstaagtgtatttatcactaaaaggcagataataatattatgtcatacagatgctcatccattgattcaacaaatattaattgagtgtcttccatgtgccaggtacctttctcctctataaaatggaacagaaaacaaacaaaaaaatatatatgtattttgagacaaagtattgctctgttgcccaggctggagtgcagt

SEQ ID NO: 92 - DNA, 399 bp, Homo sapiens
taatgggtgcagcacaccaacatggcacatgtatacatatgtaacaaacctgcacactgtgcacatgtaccctagaacttaaaatataataaaaaataaataaataaaaataaatttctcataataaagcaaaaaaaagaagtcaaagaaatagttgtggttttttattctgagtgaaatggacagtcaacggagggcartaagcaaattagtgatagaatcagacttgtgttttgaaaagctcatcctggctgctgtgcttagaatagactgtgttgtagaaaatacaaacagggaagaccccatagaaagctgacgccatattctaggtgagaaactatggaaatttggaccaaggtgatagaaggggaggtggtaagaaacagtcacattctgtat

SEQ ID NO: 93 - DNA, 399 bp, Homo sapiens
tctcgaatacattagcaactattaccttctgtctttcatgtagctgtcttacaataatattaagaagaatattacatgtgcctgaattactcatttttttcagctttgatttacatattattcacttaaaactagcaatgtaaaattgcctttaacgtttactgtttcaactttaaagttttttttaatcagcgaaagcraagttggtgaaatataattaaaatttctctaattatgttacctttaggcaatgctgtcttctagattgtaacattctctgttaccgtgctatgaaattatggagtgtacaatgttggagtgtatgcttctaaaatcaatgcattagagatttgtagaaatgctatataactcatgtattaaaagtatttctaacatcta

SEQ ID NO: 94 - DNA, 399 bp, Homo sapiens
aactttcaaagagcaataatcctgtattgaattaaagaccttaggaaagtttgacattttgagagtgtatttttgaattatttggataatattttaagtgtaaaaggatataagaatcaccaaaatagttctattaatttcttccttaaatatttttaaaatacaaaaagttactattgcctgagattaactatggaaasttttagactgaaaggaaaatgattcagaatgttgcaagcaattaaagttataaatgagaatctttaagtcaactataaaacatcccacgtctcaaatagaagaaaaggcttttattaattttttacattgtaattggaatgctcaaggcaggttaaaataaagctgctttattttttttctagaactagcttaatttta

SEQ ID NO: 95 - DNA, 399 bp, Homo sapiens
gaaaatcacatttcgtatcacagccttataactgctatcactattgcaatataacaagcaaagctggtttctaaaaatgaatatttctagtacagtggagttacattttagcttagcaatccttatgttatatagtctagaaatcctgaagtcatcacttaggaaaaatcttaagtgcattctaaactatacatattatmttaaagggagtatggtaatgtagatattattatccatacatttaattcaacaacaagaaaaaaaagctatttacttagcacttctttcactgatagaactggcaatggtatatttggcccttgcaaaagtctaacaaaagctgtttttctgattaataagaaaactaaagtgcaaacaggaagataaacttttaactat

SEQ ID NO: 96 - DNA, 399 bp, Homo sapiens
ttcagtgattgtaagagagttaaaagtgggtcaggaaatgatctaacattatgagttcagttctgatttttactgatagtcataccaaataaccttgttcttgcaggttagaaaactggaaaacaagcccatttgctaaaagacagagaagtttgcctgagatcaaaatcataaactgcaaatattactctagtttaatktctaacctacttacaggcattggccaagttacttaaacctcaaatggtttgtctataaaatggggattacaataatcccttaccctgtgatgatacacagaaaatgaagccttgctctgaatactttttgaagttcttcagcaaacagcaagccattattcagatatgcataaaggctatcatctgtaagaaaatagca

SEQ ID NO: 97 - DNA, 399 bp, Homo sapiens
tttgaagttcttcagcaaacagcaagccattattcagatatgcataaaggctatcatctgtaagaaaatagcatttgagaaaaaaataaaataaaacagggctgtaaccaaatgtgatgactctgttaagattatagagatgatcttgatatatacaacacatttccttcattctatctctattggatgttgtttaaaayaaagtttttgaagaaagacattacacaaaataagtaaaacagagatggggcatcatctagaagagattgaggtagagaaattagggaaaatgtgtgggtttttaaaattctagttagaacaattgtaataggtaaattacttgggaagatttcaagtaaatgacatttaggaaagcagggaaggatctggggtctgtgt

SEQ ID NO: 98 - DNA, 399 bp, Homo sapiens
acaaaaggtatctgtgtgtgccctgttcatcttacaagtgaaggctgtgcaattgtgtcacaaacatgcatgtgtacaattttgtctgcctctcttataatgtttaaaagtccattagaataatcatccatcatccaggaaatttaacgacaagcagatatcatattttaaaaataatcttttcaattgacatctcatamcattaaacttaaaagatcccaccttatgcggggggatgtgggtggggatgcgggtagggggagcgattgcccagagcacatacattagtcaataagaaacagactgctttgatgtgttttgctatggcaagccaagttgctattaattataggttgctttacctttcaacacataatttacttttattaaatgtaaaat

SEQ ID NO: 99 - DNA, 399 bp, Homo sapiens
gagtaatctccgggaagtaaaaatgaaacttgtaaaaatcattccattcaaccctacataattccttttgttcacttgaattcgattgaggtcaacagagttttggttttctgttttccataaaacaaaataccctaatctaaccatgattatacacattaacgtaaaattgaatttcacatagtttgattttattaacygaaaagtattctgaacctggtgagttaatccagtccttatttaaaattctataatatttaaagttcaggcataaatatcagtttgcaaagaaatatactttttttcaagattcatggtgagtacaagcaagatttatatatgaaaacaaccttaaatttcttcctgaacttttccaatagaaccagtaaaagttcaggt

SEQ ID NO: 100 - DNA, 399 bp, Homo sapiens
accatactttacatagaagacatagcccttctattttccaaccacgttgagcatgatccctgctggggaccgaatctccaactctgcaacctcctgcttctacagcttaattatttaggatcaaatagacaactaggtacattaacatgaccctagaagccaaacctgttactctcttcaaatattcaattgaccttccmaagtaaatatttccccctgacctctctaccactcattttctcttaaattggtggctaatgctttaaaaagtctcctgatattttgcaagcagctttaaagtaaacaactcccgactgtataattttagccttattgactggtacactgacagaaaccaaagcaagcaagaggtctaacatacagcattatgttaatcac

SEQ ID NO: 101 - DNA, 399 bp, Homo sapiens
gggaccgaatctccaactctgcaacctcctgcttctacagcttaattatttaggatcaaatagacaactaggtacattaacatgaccctagaagccaaacctgttactctcttcaaatattcaattgaccttcccaagtaaatatttccccctgacctctctaccactcattttctcttaaattggtggctaatgctttraaaagtctcctgatattttgcaagcagctttaaagtaaacaactcccgactgtataattttagccttattgactggtacactgacagaaaccaaagcaagcaagaggtctaacatacagcattatgttaatcacaccaatgtgttttgttcaaagacaagtcagagatctttgcagcaggcttacaaatctgcagcttc

SEQ ID NO: 102 - DNA, 399 bp, Homo sapiens
catatttacttttataacaataaaaatccacaatagctaaaaacacttgaatgctagtcaaatttgggaaagcagaaagaaagtaattcttaagagctgaactatgttacagtgaaatataagaatattaaaaagaagatattgatttgatctgttaactgcatgcactgagataaagccaggaatattcttcttcccartagctagaagttttagttatttctccttcccttccccctctccttccctttccttctccttcttatttttctccttcttatgagggtccacagaagaatctctgagactgcttttgtgcacttgtaacccagccactatgaggaccccgtagaatcgtccaacacatcgttgtgcagactcttcatttctgaacaatgt

SEQ ID NO: 103 - DNA, 399 bp, Homo sapiens
caggctggaaatacagaacatgtaatagtttgtcggacaacttttaacccaatatggacaagatatgggaagaagcacacaagtaagtcactcttcatcttcaatacagattgctctatgtatctctctggagacctcgcaaaagaccaggcaattggctgttttcttatgaggctctgaactactctgtgagataccaycttatatttcctttccattttcccctccctcacttcttattttcatgacttttgttgcaaaggcattatattgtccaatgaaacattaacatctttgatagggaatcacaccaagataatttttattccctgaataaattctagtctgccaatgttcttggtatgagactcatagagtagatttgtgatatcacctccc

SEQ ID NO: 104 - DNA, 399 bp, Homo sapiens
gcaaaagaccaggcaattggctgttttcttatgaggctctgaactactctgtgagataccaccttatatttcctttccattttcccctccctcacttcttattttcatgacttttgttgcaaaggcattatattgtccaatgaaacattaacatctttgatagggaatcacaccaagataatttttattccctgaataawttctagtctgccaatgttcttggtatgagactcatagagtagatttgtgatatcacctccctcattccaaagtatatgtatctagtaacaaaatctcaaatcataataacttgattatctataccacaattaacctcttatgcaactttggtaaaataaaacttcttattttcatatttgctaatagatttctgtcgtt

SEQ ID NO: 105 - DNA, 399 bp, Homo sapiens
aacaaaacaaaataaaagaattcttactttgtaatatgtttccatctcacagtctatatctttaaaaaaagttagcgctaacttatttctattcaatatagagaagcatttgagaattcaattatgactgatgatgttattttaaagccaaattaatccctttggaaaacttgaagaaagataaaaatgattctatcaakttaataacttaaaatgtgcataatttttaattcagcaaatctacgtctaaaattttcccaaagataataactgtgaatgtgtgcaaaatatacctatgtagattttttttgtagaagcaaaaatgaaaatagcttcaatatcctatagtagaggttcaactaattgaagtaggcaaatctggaattcggaataaaattt

SEQ ID NO: 106 - DNA, 399 bp, Homo sapiens
tgtttccatctcacagtctatatctttaaaaaaagttagcgctaacttatttctattcaatatagagaagcatttgagaattcaattatgactgatgatgttattttaaagccaaattaatccctttggaaaacttgaagaaagataaaaatgattctatcaagttaataacttaaaatgtgcataatttttaattcagyaaatctacgtctaaaattttcccaaagataataactgtgaatgtgtgcaaaatatacctatgtagattttttttgtagaagcaaaaatgaaaatagcttcaatatcctatagtagaggttcaactaattgaagtaggcaaatctggaattcggaataaaattttcccattaaaaattgttccattactatttagtgaca

SEQ ID NO: 107 - DNA, 399 bp, Homo sapiens
tgattctatcaagttaataacttaaaatgtgcataatttttaattcagcaaatctacgtctaaaattttcccaaagataataactgtgaatgtgtgcaaaatatacctatgtagattttttttgtagaagcaaaaatgaaaatagcttcaatatcctatagtagaggttcaactaattgaagtaggcaaatctggaattyggaataaaattttcccattaaaaattgttccattactatttagtgacatggaaaacaatattcatagtaagtgaacaaacagctagatatttgctctctttcagctagagttatgttgggtgaaggcagtaaaaatctttgattattaggagatcaaagaattgtatttactattctatggctaagcatggcatcttgt

SEQ ID NO: 108 - DNA, 399 bp, Homo sapiens
tcccttaaggatgaagaatgtcttagtcctctttttagccaaggacctagcttagtgacaggcataaattaagacctaactgtatatttgttaaagtgagtcttttagagtaggttatacatcaaaccccctaagaatacaatctttcataaatggaacacataattattctctgtttatcagatggaatgagtctgacytttggtgttagatctgaatttgaatccatcaattaatgatcatgtaagttattgaggactcatgtctcttacataaaatggggataattctgttttttacatgaaataggaattatctcgtgggtggtaaagatgaattacctaccgaagctcctggctatctgaaaatgtaaaagagaaaaggaaacaagagaagaag

SEQ ID NO: 109 - DNA, 399 bp, Homo sapiens
actacaggcacacaccaccacaactggctaatttttctattttgggtagaaattaggtctcagtatattccccaggctggtcttgaagaactcctgggctcaagcgatccccttgccttggcctcctaaagtgctgggattacacattagttgttttaatagttctttatgtatgcctctgtttttatattgatcagagyctatggcgtacaaagaaagatacgtgtcattttcaaaatggtttgcaaatttagaaacatttataatgatatgatttcccccgcgtaagtgtagaaatcttgagcaaactggtatgtgttagaattttggtgagatcacaacaggaatggcaccccacagcaagaatagcattctatgtttcactcagaagacactcaa

SEQ ID NO: 110 - DNA, 399 bp, Homo sapiens
taagatgaaatactaaagaaagaaagaaagaaaaatatagggcacatacagaactgatcaagaagggattatcaagagacaattactcaactacccatttgcaagtgagcatattctcacccaacactgttttcagttatgattgaatggaagctctaattgaatagttctttgtggtgttcaaagtccaagacagcaarttgttcttttgtatgggttcataagttttcccagaatgaactgtaaaacactcatgatttccctgaactgtggcaaagtgacttacccagtttctggcaaatttattaagcaatacagactccctgcttaatccattggtttaaacaatattcagttaacacaaattagtgaataagcagagacataggtcagctgatc

SEQ ID NO: 111 - DNA, 399 bp, Homo sapiens
cacaaattagtgaataagcagagacataggtcagctgatcgaagaaagatgtaaaagtaaattaaaataaaatttatttgaaaacagcaatgggtcagagctaaagcccagtacaagttagaacaaataaaaacccattaatctgaaaaaccttcttgggtttacaagaaggcttttctgatctcaggctgtatttatcytctagatggaaaaaaaagaggagcaataaatctcttcatatcaaaggcctgttcagcagaaatgaattgaaagtgttgggtcaattagactgaactagatctcccccaggcaaacctactatcgatacatatttagcttccagacacctttaaaggcagcctgggaaaggctggctagcaaagaaaaaaaaagataatt

SEQ ID NO: 112 - DNA, 399 bp, Homo sapiens
agactcagaatgttctaagaggcaaaccaggatttagtctcgtactgttcaaactctactaatcactgtgtaattataagcactcttctagatcaccatttgtagatggcatagtaaagtaaagacatcttcagcttgtgcttcaagccagaacatacactgtcacatttaaaactccagtgtctctgtgatgggcttayttgtattattcctcttcctttggtctaagtgaaaatactttttcttaatttcctgagacaatctgagaaaatgaatctagtgaaaatgctagagtaactcattggatttgagcgctccaaccattgaaatactatggtatcaactggactaagaatcagaggacctctattcaaggcctttctttactaattgtgagtg

SEQ ID NO: 113 - DNA, 399 bp, Homo sapiens
aaacccgcagccctaaatgggaacaagcattcctgttttcatgcccaaatgttgtcttttggcccaccatgtcccccactatcttgtacccatataaactccaaacctcaggctccacgagcagaggaacagcagagcggcagagcagcagggcagcacagcagtgcagcagagaaggagagaaaaggagtatatgaacrttaggaggagttcggctggggatggtcagagaggagactggccacaggatggccgaactccaggggaagatcatcttcccactaaatcccctttccagctccccatccatcccactgagagccacctccaccactcaataaaatccctgcattcaccatcctttaattccgagtgacctgattcttcctgggtactgaa

SEQ ID NO: 114 - DNA, 399 bp, Homo sapiens
agggagaggccagggatgcggcaaaacatcctacactgccatgtgacagcgcccataacaaaaaagtacctaatcccacctgtggagagtgctactgttgaacaagtgtctgaaagtataaatcatataccacattatgcttcgggttgaatctctctaatatatgtaaaataaaacccagtcacttcaccatatatgascccgtcctgtcctctaaattcactcttgttcactctcggtctccctgactcttaactccctccagtctcattcctcactgtaagcaagaaggtcttttctcaagtctgtctggatcttgaccagggcctctgcctggagtgctctttttgcctggctggcttcatcccatccttcaggtttccgctccatggccatggc

SEQ ID NO: 115 - DNA, 399 bp, Homo sapiens
caatttagaatccccttttgctaatctatgaaattcataatgtgagtgggatagaaaactggttatagatgaaatgaaatctgtagctcatttctgctctaaccctcatgggtttaaatgcccctatggaatgatgttttacagatagaaagtatttgacaaacatattgattgttgaattgtacaggagatacttaacraagagactgtgagcatatgaaacacttttctacttcagcactgcccttagccaatttttaaaacaaccctttctttcacttttttggaattttcactcttattctaatagcaaaaacaggtaggtctgcttttttttttcctacaagaaaattgcagttccttgatagcttaagatcctcagctttcaatctccttgtt

SEQ ID NO: 116 - DNA, 399 bp, Homo sapiens
cctgactctaactcacaagtcccacccaactaagctgcttctgaattcctggcccacagaaactatgagctaataactgtttgttgtttttagacatcacgtttttgatcattcattatgcagcagtagataacaagtatagcagggaatgaattcatttatcatttatatattcttcattgtttattaaagcccccccygcaaaaatagatggaacttcagtggactacaagataacgtgagtacacatcattattttaaatatagttttaaaatacaaaaatagattttgagatttgtttgcttataggattatttggaatcttaatggagcatttacttactaaaatttaagaagaatgggaaaaaagaggagaagacttagacaaaaggaactaa

SEQ ID NO: 117 - DNA, 399 bp, Homo sapiens
agtaaccaatttttcattcgtataagaagtaaggattgtgaaaacattttctcttctctagcataatgattaagagcacaaaacataggagtgaggcggaggtggatccattcctgccttctgactcactggctatgtaacttggataagttcttaacctttgtaactcggattcttcttatctctaaaatgtggataayagggtattgtgatgaataaatgagagccagggtcaagcactagctcaacacctggaaaacaataacagctgctgactactataactgaacttcaattaatataatgataatgagaaacaaaacttactcagagattaacgatttgtttcaaagtaaacacagatctgatttacttaaaaaataattttgaaactttgag

SEQ ID NO: 118 - DNA, 399 bp, Homo sapiens
catagggttccagaaaagaagaccaaaaattgtcactaataaaaagaaagttataaactctaagtcttaaggcaaactttaaaacattgaatactgaaatgctctctacatatctctattatttctatatgtaaacacatgaattcctccattaatgattggtcaagtataatataattcagacatcaaatgtagctgcrccaagttttcaaacctatctttgattttaagccaaagaatctaccacccttccaaatcttaaatgggttaaccacatttataggttcacaatcttaaatgggttaacccatttaaccattataagtcaaggtggattccttggcttataacttataagggttcacaatcccagagctcctaagaactcatctagtgcca

SEQ ID NO: 119 - DNA, 399 bp, Homo sapiens
aaaatcaaagccaggagattgagattgagagagaggagagagaaagagagaaagagagtctgaagacaacttttgagctcctgacttaaccattcctgaagacctcaattctgtgagccaatatattcctcttcattatgcagacaatttatgtcagacttgcagactcatgataaaactggaggatgcgtaccagaggwcatctctgtctagttctttatttccctttttgtgtacctttcagatttaacttaagtattacactgtgtgaaaagactttctggactctgtttaccttgagttaggtgaacatcctccccaccgtgtggcaacggtcatatcatattgttactgtttgttaacatctgtatttcctccactatgttttgtgctctgtga

SEQ ID NO: 120 - DNA, 399 bp, Homo sapiens
ttacttctcctttattgtactgctttgcctcccacaaaattcaccaagaagagtttcacttgggcgttgaaaagggtcttgtacatcacacggcttcctgaaaatgataacaatagctactttttattgagagtcactatatgtgatttccctgtgatttagatgttatatccccattttatgaaagattaaattgaggmtcagggacagacccaaatatcagccagctagtaagaggaaatctgtggtcttatcccagattctgaaaacagcacctttctaattatttcttatcatatagtttccttctaatatctggctgtgaaataatacaagtttttatgcaggggacaatttcagaagagggaaaaggaaatgtgtggtgattttaaaacatgg

SEQ ID NO: 121 - DNA, 399 bp, Homo sapiens
tcacttttgatccagaaccaagctatatctaatttcaaatataaatgcttcagatattgattgggatagtgctagctactcttccaaggaaaacaatattaccaaagttagtttgttgcttacatacagtccaaattacttttctaatcagtaggtggctctcctccaaaccctttccaacttggctcatccatcttccmcaggaggcttgtaagattgtcatattcatctgcatcaggccagaggcagaggacagagtgaggaaggctcacccattgaaactgagacacgtgccccactctattctcatccacataacctcactaatggaggttagaaatgtagaccctgctaggcaactacttcccagaaaactctacaccatatggatgcttggga

SEQ ID NO: 122 - DNA, 399 bp, Homo sapiens
acagaaaagcagttccaattgaattagtaaattgcacagactggagcatctttaaattctttctacgtaaaagcagtagaatgtcttgcctctatttttccaagaaaaaaataatcataactagatagtgctattctcagttattagtttgctcatgtataggcaaacttattcatgaataagtggttaagtagaactcwctaaggtgtcagtgcttggtttgaattaacttcttcttttagttgggagggctggactgtcattcaaggtagctcaaaatgaagagtttttcttagaagtacttcagaggaaaaattgagagttaggaatcttactattatccccaaatagaagccacagaaggaggcttcctcagaaacataggctatagattttaat

SEQ ID NO: 123 - DNA, 399 bp, Homo sapiens
actagaattatagaacaataggattttctttctcatctttttttcttgtattttcttactctacctctctctcttttttcttccatttttttccttttcttttctttcttcctttttctttttttccttacatagtaaaggctgaatggatagcattctgctaggcagtttaagggagcattataagaactcttctttgrtcccaagaagtatatcaccagctatctattttttaccctgaaaaaaggggactgcagataccaataacagacttattctatattttcttatttaactttagaataaaatatgtcttagccctttccttttcttttctttttagaagtatctaaaaattgtattacttaaggatacttcctaaaaagactgtaaggaaaa

SEQ ID NO: 124 - DNA, 399 bp, Homo sapiens
tcatttccatcggagctgcttgtatctggtctccattatccctcagccgccttcctaataacctggaaaatggcatggcccttttgtgatgcagattttgatatcacctcttgctgtcaacgcttccaaacaccacgtgacacttgccacttatcttcagtggtttctgctactgagcttactagtgactacatcaaagyttatcacttccaaaatgcttttttttcgtatctgctctcaactccaccagaagttcctagctatatatcatcacaatttttttcttttattcttttttcaaaaagagatatattcagcatatttccaaaataacatattcaaaggaggcactgcagagacaaatcaagagactggagatttttatggcaaatttgaaat

SEQ ID NO: 125 - DNA, 399 bp, Homo sapiens
tttaaaaagaattgaatattctaatgaaaaagccttcatgatctacccaagcctcacagctgttactgatggcaatctgtcctcagggccatggttctgccatcagtgaaaaattatctttaagacatcctccgatatttccttcattttaaggcaacctgatccttcacattaaaaatatataaataagtacaactacyctcaaaaccctacaagtaaataaaccaaatgccttttcatcatgaatgtgccctagactatatgttcattaagattaggaagtgtcatgttcaccattttcttcagaaataacctcaatccttggtatatagtaggagctcaaacatttgttgaatgaataaatatttgttgattcaataattggatcccttataactg

SEQ ID NO: 126 - DNA, 399 bp, Homo sapiens
tatgtagcctcaaaatatgtgttcatattatatatcaatacaaattaaataattatagtataaaaacttttataaaatatatgagcaataaacagaatatacaaacatttaatattaaatgtatggcatttacataaaggcatcacaatggaaacatctatgtgtccccttggttaagataacagagtaaatctagagcyaaagaattccttctgagaaaactcaatcagatcaacaataaaaaagggtcgagaaggaacaaaaaatattacagctgaggccaggcgtggcggctcatgcctgtaatcccagcactttgggaggccgaggagagtggaacacaaggtcaagagattgagaccatcctggccaaggtaagttgaaaatattgtaaactga

SEQ ID NO: 127 - DNA, 399 bp, Homo sapiens
tgatgtattattaagcatgatggactagagatgaaattcaatataatctggattaatgtagtgccacatccaagtggggttagttagaaaactcaagaagtaacttctaatcaattgttgtagtggacttttattgaagtaacataaggagagtcgatactaccaagtatctgtcccagtgttctctgagaattcctgaycaaaacagggttagatttctgccaactatgctttcactatataattcctctataggagttgttaaattatattgtatttctctctgtctttgttgttttttagcatgtggttgtgaagttaaatgtagagtgagtgccttattattaaatgattctttctgaaaaactctaccttggatgactgtacttcattccagac

SEQ ID NO: 128 - DNA, 399 bp, Homo sapiens
gccaactttagctgtagagattttgtaatagaatagtttctgtggaatctatctctttgtacactatatatgttattataaattttaatcacgtaatacatacagaaagttttgaaatgaatgtttaaattctccaaagatatacgttcatgaggagaaaagagttatacacatatacataaacttacaaaccaatttayacaaatgtacaatgtagatgtgttgctgaaatgacatatatactcccatagtattcagatcataattcttcaggaactgtattactcacatatttatagagcaaataaatccaatcctttcatatttatttttaaaatagatatacaaaataatagactctattctgaatgttgtcagatttcaagattttaatatatt

SEQ ID NO: 129 - DNA, 399 bp, Homo sapiens
aaaacataagaaaaaagttggttatagaatgctgtcagtctagtacatttatctaaaacaaatgaatagatttaccattttgacctgactttaattattggcctttgatagataatttctagaaaatcttctgtttggatggacataactatatattttcacactttttctcatttctacaattactttaaaacttatargatctactgaaaaatacttggcaccttcatattaaaaataatgtttctgaccgggcgtggtggctcacccctgtaatcccagcactttgggaggccgaggtgggtgggatcacttgaggtcaggagttttaggccagcctggccaacatggtgaaacccccgtctctactaaaaacacaaaaattagctgtgcatggtg

SEQ ID NO: 130 - DNA, 399 bp, Homo sapiens
tgggatacatgacacaatgtgaatttggcaaactttacttctctggtaaattttattggttctatctataatgacaaagacaattgaggctttccagaaggagaaaaacagaaaaataatgtatcatattatttcaaaagattgatcttcagaacatgttatatttgaactatttgggtaaaaaattattataaacatgytatgcatacattttattctaattattggcctaattcattgactattgaaaagttgaaccattggaatcctgtggtatgtgaatactagaacttgcctaaagattttttagtaattggactttcacactaaagttgtttttgataaaatgtataaaatggcaatcacatttatgtgaattaacagtgagtctttacagca

SEQ ID NO: 131 - DNA, 399 bp, Homo sapiens
cagaatgataagtcaattaacagttaatcatgttcaagcctctccagtaataataaaataaaatatatacacttgccttaccttatatgtgaagcctctccaattttctcatttgcattttgttcattcaacaaatatttattgtttccctcctatgttgcagacaatgtgctatctctaagggtaaccattagaaatayagtatttaccatcctaatgttgactagatgtcagagaagacattaatccagtcataatgcacatggaatataacattgcacttctggtaggtgctgaaagaagaaacatgatgacctaagagaaaaatataacaattaaccttaaaggatttggatgactgcatttgaattcttaaagttagcaaaacaatttgcaacc

SEQ ID NO: 132 - DNA, 399 bp, Homo sapiens
agaacagcacatgtcaattatgtgtgggcaatggagacaggctttctatttcatctgaaaggtctctatgttaattgcagcagaatttgcaaattgctaaaaaaccattgtgatgagatggaaagtttttttggaatttatctatctcaaaaattcatcagaattctcataatcataggaaagctcaagtttccactgtmtttagccagtaagtaccttctatttgagaaaaagtttttttatagagcacttactgtatatggagtcatgctggtgcctcctatcatatagcttacattgtaggtccttctgcaattttagccaagggctttgccacagagccaagtcaaaccctggtcccagagccatttattgtaattatcacaaggatgtaaaagt

SEQ ID NO: 133 - DNA, 399 bp, Homo sapiens
ttttcaggtgcaagttgtttaatctaaaacaaaattcaaatttaagtgtaataattaagtaatgttaaacataatcaatttagagcagaagactgttttgtaaatttgaaaaagtcttcattattatatactttctcacattctacttaacagcatttggaggatctcatcaaaatgaaaaggaataaagcagaatgagrctaaaactcagggctttatgaactctgaaaatctaatgtatacacatttttaagggaatattcaaaatttgtatgaggctagcttactctcggcaaatcagaggtctcatagagtatttgagaaagaaaactgaaatcaggacaatagcagttgtgtaggaacttctacattgagagagaacatgctaactaataagaa

SEQ ID NO: 134 - DNA, 399 bp, Homo sapiens
gagaaggtagaaattggcaggacctgtcatcagtttggatgtaaaggaagtaaggtagaaaaagaaagcaagaaaaacactaaggatttttggaaaacattagataacaatcaagtgttaaatgataatatttgtgagctcctaggatatattatgataaataaaaataaggagaaaggatatcaataagaaatacaatrgtgagtctgaaggttttatgagtttttattggtccttaaaggacagtggaattttatcttgtggtaacagagaaaggcactttaggtaaagataattacataaaaaaacacgtccacgtgggagaacgtatgagtgtaggtgtgcatttgtatgtgtttgtgtgtctgtgtgtgtgacagagaaagagagagactaaga

SEQ ID NO: 135 - DNA, 399 bp, Homo sapiens
ggtgtgcatttgtatgtgtttgtgtgtctgtgtgtgtgacagagaaagagagagactaagaagctttttctgtcgttgcacttcttttcatatttgcaacccttttattataataagggcattgacttgctgaatggctaagtagaaatggtgtttatattgaatatcacgaccaaatatagttaagtaaattattaagygattacaatatatttaagtattctaataaatatttatggaagccttcttttaaattaggcattcttctcattatcaaaatgcagataaaaataaagcacatagtattagtctcagaaagttcacaatactatttattagaagcttgaaaaccttaaagtaaaatgtgacagttcctaaactagggatatgaataaaatg

SEQ ID NO: 136 - DNA, 399 bp, Homo sapiens
acccctaaggaattattttgttggagaaataccattgcctttgagccaattctatctagttctttcttttcatcaaatgggagaaaaatgtgatggtccacataattatgtcagtacatacttcaaagcttacactatatttcaattctatagcttgtgtaattgctttcaatcctaaattgcttaaagccagttaaatkgacaatttttataaatttattttttcaattaaccttttgtaaactttcaaatgtctaaattttcttttagcatgcctgatgatagtaggtcaatgtaagctaattataagttatgttccagaccaaatgtgtaaaacatgtatttgaaaaaatacccatgtacttcaatgataaatggtattaaattgctatcatgtta

SEQ ID NO: 137 - DNA, 399 bp, Homo sapiens
atctagttctttcttttcatcaaatgggagaaaaatgtgatggtccacataattatgtcagtacatacttcaaagcttacactatatttcaattctatagcttgtgtaattgctttcaatcctaaattgcttaaagccagttaaatggacaatttttataaatttattttttcaattaaccttttgtaaactttcaaatrtctaaattttcttttagcatgcctgatgatagtaggtcaatgtaagctaattataagttatgttccagaccaaatgtgtaaaacatgtatttgaaaaaatacccatgtacttcaatgataaatggtattaaattgctatcatgttatatttcatacatgtatgcattgcctcatttattaaaatacaaatctttaattg

SEQ ID NO: 138 - DNA, 399 bp, Homo sapiens
cattgtcattcattttttagtcagtggaaatataatgcataaaataaaaatttaaagctactttatttaaaaaggtataacttttagtgcatatattaaattaaatatagtgtagtttgtctatcaatatttgtatttttcaatgtttcaaccaattttttctttcttcattggcaactatgttaattcagtgtaattayaaagcttttacatattagcttgatctttgtttaataaccaagaaaattaaagaaatttaattttcaacctttaataagacaaagagttaaccaatcttaccgattttaggtaaaaacaaacttttagctataatttaaaacacaatctcctggttgtgtttacattgataaatctcacaatcaagagataattgtgttt

SEQ ID NO: 139 - DNA, 399 bp, Homo sapiens
ttttcatagaaaatattctgactgtattttttgtagaaacagaaagactatattgaacatttatttttcttaatgaaaaaaagagtgtagtggtggcaagcattttaaggcatgacataatgcgtgctgtttttttaaaaataagattgatgatggattatgcaaaggtccttgtcggtttccgcattcaatatctgtcraaaatgtctggattacaaagcactggattttatatattaaggaggatagtcacacatctgcaaatattcaaaatggcaaataactgacaaatgtatttctgtttactaggcaaattatttcttccacggagttgatagttttcgcactaaggagataattgtcttttacttcatcgtttttcatgtcttttgatgttgt

SEQ ID NO: 140 - DNA, 399 bp, Homo sapiens
gtgtgagatacactgactaaaaatgtctttgattctattgcagctaattagaaaatgtttttgaaggaatccacttatttttttccttaccatttgcctaaggacagaagaaatttctgcataaatcaaatgaatgattgtagctgtttcacatgtctgtaagttatgacagtctttacaagcagttggcataaacacaytgaaattttagacagttgatgtcagcaaatgtttcatatgctaggccttaagtatttttaagttaattttaagctttattttatgttatataagtagttatcatggaatttctaataatgtagctcacttaatacatactgtcttatgatataaaggcatattttattttctttttatcaatatatcctattttaaaaa

SEQ ID NO: 141 - DNA, 399 bp, Homo sapiens
aagttaattttaagctttattttatgttatataagtagttatcatggaatttctaataatgtagctcacttaatacatactgtcttatgatataaaggcatattttattttctttttatcaatatatcctattttaaaaacatataaaatatttatatcatgcttaatattggaaattctatggtgttatattctaacakttaaatttactcaaacggtgatttcaaagacaaagtgttactatcattgaaataattcagtggtaaatcccaagcatctgatatcctaaatacttgttttaataacatatttataattatattcttacatgtacatctttattgctaaaatttaaaattatgaattcagagaaatataatttttattacataatcatat

SEQ ID NO: 142 - DNA, 399 bp, Homo sapiens
tattttatgttatataagtagttatcatggaatttctaataatgtagctcacttaatacatactgtcttatgatataaaggcatattttattttctttttatcaatatatcctattttaaaaacatataaaatatttatatcatgcttaatattggaaattctatggtgttatattctaacatttaaatttactcaaackgtgatttcaaagacaaagtgttactatcattgaaataattcagtggtaaatcccaagcatctgatatcctaaatacttgttttaataacatatttataattatattcttacatgtacatctttattgctaaaatttaaaattatgaattcagagaaatataatttttattacataatcatatttctttctcttgtatga

SEQ ID NO: 143 - DNA, 399 bp, Homo sapiens
agctctcctgattctcaggcctttggacccatattaaaactacctgtcagttctccttggttttggactagaactccacagcagcactcctctgaagtacagattgggactcctcagcctccttattcatgtgagcgattacatatatatatataaacacatcctctgggttctgtttctttggagaaccctcctatagyataataagaaaacattaactttccctttgaaatgtgtgctaatgcataccttaatggcagaaatagaaaaccaacatgcaataaacattttcaaattgaaggaaacaaaaaggtttaaaaatattatacttactgagataagtgtgagtttcatattcaactgaatgttacatgcttaatatttttatcataaatatta

SEQ ID NO: 144 - DNA, 399 bp, Homo sapiens
ttattccaatgatttcttatattaaattatataattattacagacctataaccccagttttgcctgataatatacttaaactacattaaagttgatacatttaccaacacaagtttttgcttatgtaaaaggaagaaaaagggaataatttcattgaaataatcttttcgacaaatgtataactgtttcaaggatcacckttctaaacaacaagaaaatgtaattaagacatgttcataaataatttataatcataaagtttcctatatatccttaattttttctaaaacggttaaaatatgtatgcatagttatttgtgattattacgttcctttgcctttttccccttaaattagagcaatggatgtaaggaataaagacttccatgcccaacataa

SEQ ID NO: 145 - DNA, 399 bp, Homo sapiens
actgccagagggttgtcatagcaaatgaaagccatttctgttcaagtccaagtatatctcatcattcaatgacaaacatgttttgcattcagttgggaatactgtttttaaaaagtttgttacttcttatgttttttgttttcattaaagtatctggaacatttttttccactgttaattttatctttagtaataattcmtgacagcttatattcagacaaattaaggttaaacattattatatttaagaacaatgcaaataacatttaaataatttctttaactaaaatattaataaaattaatttaaatgagtacaattataaaaattgaattcttcataaaagagtgcacattttattcatgttattaaattcaatctaatttaagtccagcattg

SEQ ID NO: 146 - DNA, 399 bp, Homo sapiens
gtctgattctaaaaccaacactttctctttgaagaaccttaatatttcctcagtgagtcttctggtgctactggtgataaaggagttttaaagaagtgattaactttgttgggcttcaggaaactgtgtagattaaattattttcttaaaaatattaaatctcatacattcctacaccaagatggggagggcacttttcyactacattgatggtaaacttttccatatgatcagccactgtactatagttggcacattgatgctttacagtcataaagtgatttatacaccataaattgttgcttttaaagtatggtgtgccttagtagtgacaaaacagccatagaaaacgtgtagatgcatgggaatgcctccaagaaaacttgttttagaactggg

SEQ ID NO: 147 - DNA, 399 bp, Homo sapiens
aaacttttccatatgatcagccactgtactatagttggcacattgatgctttacagtcataaagtgatttatacaccataaattgttgcttttaaagtatggtgtgccttagtagtgacaaaacagccatagaaaacgtgtagatgcatgggaatgcctccaagaaaacttgttttagaactggggcaaaggtctgaatkggaccagcgtgccatggtttgctatcaccttcttaggttgtaagtccttgggtgtgattctgttcatatgaaaatgaaagggaaaccaataacacttaaaccccccaaaccttgttcctgtgagacttgctccttttttagaactgtaacggcaaattgtgcttattaaggaaaaaaataagaaacataatacaggaga

SEQ ID NO: 148 - DNA, 399 bp, Homo sapiens
gaatgcctccaagaaaacttgttttagaactggggcaaaggtctgaatgggaccagcgtgccatggtttgctatcaccttcttaggttgtaagtccttgggtgtgattctgttcatatgaaaatgaaagggaaaccaataacacttaaaccccccaaaccttgttcctgtgagacttgctccttttttagaactgtaacrgcaaattgtgcttattaaggaaaaaaataagaaacataatacaggagaaagcaaaatcatataatatagcatagctgaatataatatttgagtcatttcatcttttaatatatgaagtcaaaacagtctttttttcatttgatgtatgtgaaaaggagagaacaaaatgaaggttcattttgaaagaaagtggtagtta

SEQ ID NO: 149 - DNA, 399 bp, Homo sapiens
ccagttctaggctcagagatccagtgttgtagattggggcaaatggttcactgataaatagatgcataaaccataaaatgcacagagcacctgacatattaatgtcatatattggaaatacattttactgagttaatgtaaactctaaaaaacaaagtattccagtgtttcttgctaattccataagcatcaccactgayttgtgttaagtttaagcatgtatgagatatagaagaaaagtgacttttcacccactggatgggtcatcagataatcagatttggtggagtcatctgttgtgatcattatctccgtgtgaacaacaaaaagctagtaaaactgctctaataattttttttaaatgatttctggattgctattctatgttatcttattaaa

SEQ ID NO: 150 - DNA, 399 bp, Homo sapiens
atgtctaaaattagcaagtgacattcacagaatagaataaatattaagtatttattattactaataataaataaatgattgtgtaaatgtacaaatgaataaaaagtagaattctgactgataatgtggaaagcataaaagatttatcaaatcacaatttttcaatgataatgataataattttgttaatactaatttcrtactaacaaaattattaatggatgctaaaactaactttgaggaggtattgtaactttatgtagtatcaaagtattttgtcacaaaatacccatttaaaataaagaaaatataatactattactgtagattaacctagagaattcaaacttaaatataagtaactcttttaacatcactaaagataaaacaaagtcacat

SEQ ID NO: 151 - DNA, 399 bp, Homo sapiens
gaaatatttcaaatgctcatattcttaattttaaaacttcactatattcaggagggttgacttcaagcagagtatattatttgactatcaggtaatgagagtagaaataaatagcagagatacctggataatcataaaatatttagaaattaaacaacatattttaaaataacttaggggtcaaataagcaaatacaagrcaagttagaatccattttgaatcaaatgcacaaattaaaataataactagaggaaaatttattgcactcattgttgatattaaaaaaattaaagtatcaaattcatgatttaagatttctctttaaaaactagcaaaatactagcaaattaaaaccaaatatgcagcacaggaaagagagagatcttcagaaagggcca

SEQ ID NO: 152 - DNA, 399 bp, Homo sapiens
gacttcaagcagagtatattatttgactatcaggtaatgagagtagaaataaatagcagagatacctggataatcataaaatatttagaaattaaacaacatattttaaaataacttaggggtcaaataagcaaatacaaggcaagttagaatccattttgaatcaaatgcacaaattaaaataataactagaggaaaayttattgcactcattgttgatattaaaaaaattaaagtatcaaattcatgatttaagatttctctttaaaaactagcaaaatactagcaaattaaaaccaaatatgcagcacaggaaagagagagatcttcagaaagggccaataaaaaatatgaatctcaagtagaaacttaaatcaaaattttgttttcaactacagg

SEQ ID NO: 153 - DNA, 399 bp, Homo sapiens
ttaaaataacttaggggtcaaataagcaaatacaaggcaagttagaatccattttgaatcaaatgcacaaattaaaataataactagaggaaaatttattgcactcattgttgatattaaaaaaattaaagtatcaaattcatgatttaagatttctctttaaaaactagcaaaatactagcaaattaaaaccaaatatkcagcacaggaaagagagagatcttcagaaagggccaataaaaaatatgaatctcaagtagaaacttaaatcaaaattttgttttcaactacaggaagcaaaactaataaatttaactattttatgaccttgtctaaaaaagtttttaagggcagtataaagatgtggacggagaaagggtcacagtgtgattctcctct

SEQ ID NO: 154 - DNA, 399 bp, Homo sapiens
atgtgaaaaacaggagaaaaaaaaaggatgcataatttcttcacttgctagaatacattatttagggaatatatcaaaggacatgtagaaggctcattaaaatgatagcaactattaccttaaaaatttttactgatattattcataaccaaaaagagaacacagatatcatcaagatcacacaggttcatgttacagcrcagtgtctgactaaaaataccttaaaaacacttcagtgctagaggaaaaaatgttcatttgggcagaaaaatataagaaatgtgagataagctaagctgttcaaataatagtgaatatcagacgtggatacctaaacaataaggaaaagagagagtggagtgcagaaattttgtgaatctgggaaaaggagtagtagat

SEQ ID NO: 155 - DNA, 399 bp, Homo sapiens
ggttcatgttacagcgcagtgtctgactaaaaataccttaaaaacacttcagtgctagaggaaaaaatgttcatttgggcagaaaaatataagaaatgtgagataagctaagctgttcaaataatagtgaatatcagacgtggatacctaaacaataaggaaaagagagagtggagtgcagaaattttgtgaatctgggwaaaggagtagtagatgggcatatgcactcaaatctaattaacggctacaacaatgagggggaaatgatgatatcaatgcatagatggatttcagaattgtgtttgtgtagaatgaatttgttgggatcaagaaatgttaaagagaatattcccggtataaagagctccttcagaaagagatcttattaagaaatatagt

SEQ ID NO: 156 - DNA, 399 bp, Homo sapiens
tgtctgactaaaaataccttaaaaacacttcagtgctagaggaaaaaatgttcatttgggcagaaaaatataagaaatgtgagataagctaagctgttcaaataatagtgaatatcagacgtggatacctaaacaataaggaaaagagagagtggagtgcagaaattttgtgaatctgggaaaaggagtagtagatgggmatatgcactcaaatctaattaacggctacaacaatgagggggaaatgatgatatcaatgcatagatggatttcagaattgtgtttgtgtagaatgaatttgttgggatcaagaaatgttaaagagaatattcccggtataaagagctccttcagaaagagatcttattaagaaatatagtaagatatataaaaaacata

SEQ ID NO: 157 - DNA, 399 bp, Homo sapiens
ttcatttgggcagaaaaatataagaaatgtgagataagctaagctgttcaaataatagtgaatatcagacgtggatacctaaacaataaggaaaagagagagtggagtgcagaaattttgtgaatctgggaaaaggagtagtagatgggcatatgcactcaaatctaattaacggctacaacaatgagggggaaatgatratatcaatgcatagatggatttcagaattgtgtttgtgtagaatgaatttgttgggatcaagaaatgttaaagagaatattcccggtataaagagctccttcagaaagagatcttattaagaaatatagtaagatatataaaaaacataagcaagtaagtaagctttgaggtgggtacgtcgagtattgggccaaatca

SEQ ID NO: 158 - DNA, 399 bp, Homo sapiens
aatgaatttgttgggatcaagaaatgttaaagagaatattcccggtataaagagctccttcagaaagagatcttattaagaaatatagtaagatatataaaaaacataagcaagtaagtaagctttgaggtgggtacgtcgagtattgggccaaatcatgtatgagaagaaaactgttgatacatttcaatgctgagttraagctatttggtacaaagaaacagttgaaaacaaaattaagcacattgtgtgtcatctcaaccacacagttttatgcattggttttcacaaaatagtaaaacaattttaattaaaagtgatttatccttttgttggtatcaactataagaagacatatttttgtcttgatcaatgtagataggttaaaaatacaaatat

SEQ ID NO: 159 - DNA, 399 bp, Homo sapiens
cctgtattttctcactgtataactttatattttaatttaaaattataaaatagatacttttttaaaattaacaatatttacctaccttgtgttttgagtgaataaaacatgagcacacatacgaatacagtcaaacacacacccaattaagtatcaagtagggggtagggccaagatggccgactagtagcagccataaytgggggctccaatgcaaaacatgcaaaacagcatgtgatcctgcatcggcaaccgaagtatccaggtactgtcattaggactgattaggcggttggcgtgacccacggaaaggaagaaagagcagtgtggtgcagcggcacacctcagagccacatggggcaggggattccctacccccagccaagggaggtggtgaaa

SEQ ID NO: 160 - DNA, 399 bp, Homo sapiens
agtatccaggtactgtcattaggactgattaggcggttggcgtgacccacggaaaggaagaaagagcagtgtggtgcagcggcacacctcagagccacatggggcaggggattccctacccccagccaagggaggtggtgaaatgagcatgctacctaacctgggaaaacgtgctttttccatggaactgttcaacccayggattcgaagatcccactcggggggagcccatgtcatgggggtcttgggtcccaaccgcagagccgcacagactctcacttgggtagaattgtcttaagccctacaagttccccaggttgggagtgggggcaaggggagtggccatcaccactgctgcagctacctgctgtctaagtcatctgagatccttgtgggagg

SEQ ID NO: 161 - DNA, 399 bp, Homo sapiens
tcctttcattcttttttctgtaatcttgtttgcatgccttatttcagcaagatagtcttcacattcttacattctttcttctgcttaatcgatttggctattgatacttgtgaatgcttcaaaaagttctcatgctatgtttttcagctccatcgggtcatttatgttgctctctaaatgggctattctagttagcagcytttctaacattttatcaaggttcctaacttctttgcattgggttcgaacatgctcctttacctcagcaaagttcgttatttcctaccttctaaagcctacttctgtcaattcatccatctcatcctctgtccagttctgtgcccttgctggagaggttttgcgatcatttggaggagaagaggcactctctcattttgg

SEQ ID NO: 162 - DNA, 399 bp, Homo sapiens
tttgctgaggtaaaggagcatgttcgaacccaatgcaaagaagttaggaaccttgataaaatgttagaaaagctgctaactagaatagcccatttagagagcaacataaatgacccgatggagctgaaaaacatagcatgagaactttttgaagcattcacaagtatcaatagccaaatcgattaagcagaagaaagaaygtaagaatgtgaagactatcttgctgaaataaggcatgcaaacaagattacagaaaaaagaatgaaaggaatgaacaaaacctctgagaaatatgggattatgtaaaaagactgaacctacaacaggtaagtgtacctgaaagagagagggagaatggaaccaagctggaaaacacacttcaggatattatccaacaga

SEQ ID NO: 163 - DNA, 399 bp, Homo sapiens
ttctactctaggctcaaccatgtgtattaattgtctgtacttttgcttgttaccctcttactatgttttctcctcattttatagtttctgtgaaattaacattgtaaattttatcatcagaaaactcaaactgtctctaacaatacacctaaaaatatgtttatttttatttcttttaagtcaccttatcagctcactgrcagagagcactcttacaggctgccctaccaaatttcatcattggatctcaaaggccatgacttatctttttattccaacacatttttttcactaccattaacatggttctgttttgttttgtttttctccatagttagactaaatttcatgatctataaaaatagttatatggtaccaattatctgaacttctttgtcc

SEQ ID NO: 164 - DNA, 399 bp, Homo sapiens
aacttttggttctgtttcctggtaccaaatacagctactaaatacagtgtcgttggtgttctagctagaaacacactttgtttgacatattttaatcagtaagggaattagaaaatcttatttgttattggacgggctaatgagtgaaaggtagacaaccgtatgttcagaatgtgtcaaaattgctggaaaccattatkcagtgtctaaactactagctgcaatgaaaagatgatgccctgaaactcaagcagaaactgccacaatatttaccttgcttagtgcctatgtgtcttctcacaagtgcagtggaaaaatcatgtcttctcttctgtcttccaaattgtgcccaacgtttctcaatctaacctgaaacttttaccaagggacaatggaaaa

SEQ ID NO: 165 - DNA, 399 bp, Homo sapiens
tcagtaagggaattagaaaatcttatttgttattggacgggctaatgagtgaaaggtagacaaccgtatgttcagaatgtgtcaaaattgctggaaaccattattcagtgtctaaactactagctgcaatgaaaagatgatgccctgaaactcaagcagaaactgccacaatatttaccttgcttagtgcctatgtgtcytctcacaagtgcagtggaaaaatcatgtcttctcttctgtcttccaaattgtgcccaacgtttctcaatctaacctgaaacttttaccaagggacaatggaaaatgtagttcccaggcatctcttctttggtgcaagagagtgtacaagagtagtggagacaagcaataagacacattaattttccgatgaacaacttt

SEQ ID NO: 166 - DNA, 399 bp, Homo sapiens
agtaacctcctagagatgggaaataatctgaaagcctaaaataacctacagtcacagtccagaaagagagaaaccaggtagatcccagaagactttcagaagtgagacagaggaatctgcaatgatcaaggtggctaaaagtcagagggtagagtaatgaagaatagcttttgcacaaagagaggaactgtggtgatccwtatgtggtccctctcgggaatttgggagagtatttaccagcacagacatgtgaacaaaccacccaagaacaggataaaaacaattaaaataatggaacacctaaaataatcagttaaagcacctgacactagtgaaagactgccagccaaattagaacaccgtgtaattcaagagcgattgggaagacgaaatagactg

SEQ ID NO: 167 - DNA, 399 bp, Homo sapiens
ccttgatcattgcagattcctctgtctcacttctgaaagtcttctgggatctacctggtttctctctttctggactgtgactgtaggttattttaggctttcagattatttcccatctctaggaggttactacctttcattaactagagtctaatgtcataaaaattgtgccaacatatattttgtctgggtttttactygtttcgtgcagaaagttaaatccagtctctcttattacatcttggcctgtagtggtactttgcattctttaaagctgttgtgttggggatccaacacgtaaccattgtgttttcatatcttgcatgtggtttaaatgctccatattccttactgaattttaaacataactagtaatttacatgttctaatcaatagctt

SEQ ID NO: 168 - DNA, 399 bp, Homo sapiens
agaccgaattatttcagaaaaaaattaatttagctaaagaacagtaagcaagaaagagaagcagggtgcagggcacacagcatagaatttatgatacagcagccacataactgggaaaggcagacttgcctgcgtcatgctgctgaggtgggtccagcgctgtcccttccccacctgcctttgctcccttccaggtcaayccacattctgaaacagtccctctgtaatttctttcctatctctactatgctatgtatgcaaaacgcaggagccatggactgtctgcgaaagtgattccctcattaccgtcctttcactcttttcatgagagtaatcaaacttttcacctggggcaatcacatgtatcagctggaggtctcactaggccatgaacgcaaa

SEQ ID NO: 169 - DNA, 399 bp, Homo sapiens
tattgctatctcctgggaaaagaggagtggctacagtcactttcaccctgtcaaagaggacactacgtctgagtctctctggctgttgctcactagaatcagagcccattctttcactgcgtgaaagacaaaaaatagatacgaagacaatggctattccactaaagtaatttaaaaattcattctgaaagttaggtttrtgcattttcaaatatatttctcaaatatttctgcacgctattttaaaaagaaaaagttttagattcagattggtatttgtctgatgatatgattcagcaatgctgaggtgtttttacctataatttatcattttactcttaaataaatgggtatggtaagggtattgttggcatcctgctttcaaagatgtggtaacta

SEQ ID NO: 170 - DNA, 399 bp, Homo sapiens
aatttcatgtcctttctaaactcaaaagtgtggttggaggttatttacaaaatgttgatttgctgtaaattagcaaatataacaacacccaaattgaacttaaattgtacttcatattgtttgttattggggaagtttgaaatcactcaggcaaagagcaattgcaccatataatgccataaaattagcaataatatttyaatagtaaaattatatgcaggcaaatgttattcaaccactgaagtttagatcactttatccaaatttacaaatcaaagggatgtattagaataaaaggccctccaaatatgtccacatcctcatccttagaatctattaatatgttaccttacatggaaaaagggactttggagatgtgaataattaagaatcttgaga

SEQ ID NO: 171 - DNA, 399 bp, Homo sapiens
catcgaatgtttttccatttgtttgtgttctctctgatttccttgagcagtggtttgtacttctccttgaaggggtctttcacttcccttgttagctgtattcttaggtattttattctctttgcagcaattgcgaatggatgggagtacattcatggtttggctgtctgcttgcctgttgctggtatataggactgctygtgatttttttcacattgattttatatcctgagctgaagttgcttatcatttcaaggagtttttgggctgagacgatggggttttctaaatataggatcatgtcatctgcaaagagagaaaatttgaccccctctcttcctatttgtatacctttatttctttctcttgcttgattgccctgtccagaactcccaatac

SEQ ID NO: 172 - DNA, 399 bp, Homo sapiens
gtaatactagttatcaagttaagaaaattctcttatcttccatgtttaaacagtacttttcaaaacagcattctggattattgggatccttctatgattagtatttagcccacgattttcataaatttcattaacagattatggtgtggctgtgtccctacccaaattgcaccttgatttatattaatccccacatgtcragaatagggccagatggagataactgaatcataggggtggtttccatcatactgttcttctagtagtgaataagtcgcatgagatctgatagttttataaatgggagtttccctgcacaaacttccttggctgcctccgtgtaagatttgcctttgctcctcccttgccttctgccatgattgcgaggtcaccccagcc

SEQ ID NO: 173 - DNA, 399 bp, Homo sapiens
agtccgttatagaaacttgcaatgttgtaagatatttttcaatttgtctagtttttaaattcattgttagacattttttctaacattttcaaaataactcctcagaaaaaaatccttctctacatttacatctgcatagatagacagactgatagatatacatttataactgacaatactcatagataatgtttttatgrttttggttcttatacatttgttgaggattattttaatgttgttaagtagcacattactttatttgagaaatacctttcaacttcttgaacaatatcaattgcctgcaaggcagagaagcctactagtttctttcagtttccccactcgtttgaaagtgataatgatgcttatctctgtgatccatacatgaccatctga

SEQ ID NO: 174 - DNA, 399 bp, Homo sapiens
gaagtcaaaggacatactaaagttgtcacaatatttccaaacgatatcacggtgccagctatatgaaagacattaaatacaaatttagaataatgtggattcatgggacaaagattttaaagatggaaacaatgaaacattgttgcatttggcactatattttaggaaatgtgctcatattcaatccctacattgaagayagtaaaacattaaataaaaaacagtgaaagtatcactataatcttttcccccataaattattaaatttacttattttcaaataagaatcattcagaaaataatgtatattttaaaaataatgcacacctgtatattcacacactcacacatgtaacttttgctttgggggaaattgtttggaatgagtcatagacaagg

SEQ ID NO: 175 - DNA, 399 bp, Homo sapiens
aagctcttcctttaattctgtaaactgttttcttttctttttgctagtcatttttgctttcttcagctgggaaatagaaaactcaataaattattgaaattggtttcaaagtgcaggcagtaggtgttattctctctggaatatatgatacatttggaattaaatattgagttgcatttcagtgaatggcaatgaaccayggtttaaggaagctgatctgacattattaaataaaacttattgagaaatatacaagctcaaatatcaagtgaggactctggctccaggttaaaagtatatttgtgatttttgaggcccaaacacaggcaataacaaaggctttaactggcaggcctcacagggagagctggcttcctcacaccaggggagctgacatgc

SEQ ID NO: 176 - DNA, 399 bp, Homo sapiens
gagagctgcttcacgtgatgtcatccttctccagggctgccaacatgtaataatgggtcaatacaggtttatacaggcccaggctaactgcctcaaggcaggactgctgcaactgcattgtagttttctcactctgtccaattctactcccagcaatgactataattttctaatatcaaggaactacccaataaactttstggaggcaaatcatctcggagactcagatccaagacaattgttgccaggagtggtttgaggaagcagtctaaagaatggagtttgggaactaggacacctactggctggctgtatcaatggtagatagatcttgaaaagttcaaggcatgttgtcatggtacaatttttttattgggacatcagaggaagggaatacat

SEQ ID NO: 177 - DNA, 399 bp, Homo sapiens
tacatgctaatttttatcagataaatatttctctagaacaatggacaaaaaaatgtgtgctgaggacagagcccagaaagctcagaggcagtggttccccaaatcatgaaaaccatttctgaaatattaatacaagtctaggtgaaacaagcttgaaagcatgccatgccctcaaattaaatccacctgtctccatccawtttaggtataacttttataaccagactttttctatgtttcaataccaaatatttctatttgtaataagagaattaaattttcataactattttacttactaatattgattcactctttgaaaagaatatttttaaacactatgtgtctgagttttactattttctgtcttttcttagtctggttggagcttgagctctg

SEQ ID NO: 178 - DNA, 399 bp, Homo sapiens
tatgcagatacacaaccagatgtggaggtacatatgatgaggtcagtagggtcctgagcacaacagcttctgttgctgtagaggtggggtgtaccccctcccggcacatggagcaacagcttctgttgctgtagaggtggggtgcaccaccctcccagcacatggatgtactcagtgacctggaagctcagccagtatcrtagttcaaaaatttttatagagctttcctattttgcacaccacccttttcctggaggtcagtaagtgaggctgaaagttccaacactctcaccacttggtctttctggtgagcagtcccatcctgaggctatcatggggccctaacctaattcatttcattagcataaacttaggtgtgattaaaagatgctagttaag

SEQ ID NO: 179 - DNA, 399 bp, Homo sapiens
ttaatataaaaggattattaccagtaattctaatgtcagtttttgtgtgtgtattcatatatataggtcctgcaaattttatagacctatatgatttcatgaatttgcttacattgcttaacagtgcaacaataatttttaaaggtagggttacaggccaagtgtaggatttaacacaaaaacaagtacaatcaataaakattcactaataggtataataatgtctgtgcagtatgtgaaaaattttttccctcatactctctcttctataaaatctcacttgctctcagaataaaactctatcagcattgttatcttgatttcacagaagttttattattagcaaccagcaaataacctcagttaagtcaaggccttcgtagacatattcttataaag

SEQ ID NO: 180 - DNA, 399 bp, Homo sapiens
aacaagtacaatcaataaagattcactaataggtataataatgtctgtgcagtatgtgaaaaattttttccctcatactctctcttctataaaatctcacttgctctcagaataaaactctatcagcattgttatcttgatttcacagaagttttattattagcaaccagcaaataacctcagttaagtcaaggccttcrtagacatattcttataaagtaataattgttaaagagtattttaatagtaatttcaaatagtaattcataaagagagaaagtaaggaaagaaaaaagaaagggagaaagacagacaagcaggctggaggggctgaatagagggaggaagaagacaagaagatagattcattaatatttctttttgcaaaatatttttgag

SEQ ID NO: 181 - DNA, 399 bp, Homo sapiens
attatgttatccagaagtctctattttcttctgtcatggcaaccagcaatgtttatgatagttcctatgatactgatgtgaactgtgaagttctacagtgaatatttccccatcctctcagtcagccctacagggtcataactatgagttgtaaattatccattgttgttttaaaccatcaaatatttgagtatgtagcrtcatcaatttccttgtgaatagtataaaaattgctacctagagtcaggatgcatctataagaacaatcataaaatatgagtcactttcagatgagaaatttgttggaaaaaagaaaattattataagaggacacatgatttccactataaggaagcaaaatatgtagtactcagataagatattaaaaaaactgaattt

SEQ ID NO: 182 - DNA, 399 bp, Homo sapiens
tagaaatatttgtaattgtagtttaaacaaattcagagacatttagtaatttactcatagtccagatactgaacaaaactaggctttcatattccaattttgtttcaaccttagtactaactctctgacttataatcttgacttgtaagaataaccatctggggtcattcctttatttgctatttcattctttggtcctrtcaccactactctaacttcagcttattattttctctgtccatttaattctgaggtttcattataattatttccctggtgaacatacgtatgtgcctttcatctttatggtgatatctgccatttctatagttgtctgcatattttttaattgaagttttctggagaactagacctccacacataaagtccttctgaaaa

SEQ ID NO: 183 - DNA, 399 bp, Homo sapiens
atagaagcttgttatttggaccttttcaaatatccatgattcagattttgaagattaaaataacacatcagtatctttatatctatccatatactcacctactatatgtatatacacttatagtaaatactatataaatagtaagtgaatatacacacatgtacatatacacacatatatacacaaatataaaggtttaygtataatccaagtgacatatgtatttttaaatatttttgaatttgtatataaatttatgagatatatttctgctagtttcatattatgttgcatttcaatattaatattgttaatttattttagcgattgtctatagtataaagttatgctaacacagttgtattgaataatattggactcaaattaagctgattttag

SEQ ID NO: 184 - DNA, 399 bp, Homo sapiens
tctatttattacttttttccaaacagaattttcactacacaactgtggctattcctcatatgatttctgaagtaatttgaacattcttttatataaatactaataagtgcataaaatatatttttataaggtcataaaaagagagtattagtcaaagagtacaaagtttcagttagactggaagaaaaagttttaatgaytttttcctctgcatgttgaacacagtaataatgtattatatatttttaagttactaaaattatatatttctaagggtctcaccacaaaaaataagttgttgagatgatgcatatgtaattagcttgactgaatctttctacaatgtgtacatagatcaaaacaccacattttaccctgtaaatatacacgattattttt

SEQ ID NO: 185 - DNA, 399 bp, Homo sapiens
tgtttatttctaagtacatgcttctagcaaatcctcttaaatgaaatgtttgaagttggaaagctgaagtgttgcttaaataacttagttaaaataagtacaattacatctttaaattaatagaatttggcagtccaagtgtttattttgtattatgttaaatataaactgaaacccagaaagtttatgtgattcgtgaygttagacaaaaacttaaatccagagttttcacttctcagagttcttttaaaatgttaataaagtgatatttcaaaatgtaaatgccccagtaatagaataaacctgactacatgtataaattgtgtcttatgttgtcttttgataggttcttgaaaatgtataattttgtacattatctggattattatgcatactgtg

SEQ ID NO: 186 - DNA, 399 bp, Homo sapiens
cttgcctgttaggtccctggaagatctcatttgcaaaactgtcattatttggtttaatttggaagtaacccagtacaaaaagctgtttcttccaggggcatttgtaaaaaaaaagtttatatgtatgtgtgtgtgtgtgcacacacacatatatatgtatatatatatatatatatagagagagagagagagagaggcawttatttaactttgcagcttgctgacgatatcgataacagttggagcaaacagtagactaactaaaaggctaaaaagtaaaatctggaggatgagatgtctatataaactttgaaaaactctgatgtattcctgggaatctatatggccacatgcatgcacaggactgagtacatgcccaaggctctctgtccatgctta

SEQ ID NO: 187 - DNA, 399 bp, Homo sapiens
cttcatttaattccaataaataagagtgggattactaggttatatggtaaacatatgatgaaacacatttttgtattgtaagtatatgactgtgtgttaagtatataattatatgtaaacccatttgttttcttaagtggttgcacaattttgtgtgtccaccagtattatataaaaatcccagatgctctgaatccagrccagcactgtgtatttttacttcttagctgtcgtttttgttgaatccccaactgagaagtgtgtgaagtttcactgtacttgtaaatgcacaaaacacaatcacacataactcaaagttttatcctccttcgaaatgtaaactcatagggagatgactctctacttccctccggaggtcacaaatttaacttttatcag

SEQ ID NO: 188 - DNA, 399 bp, Homo sapiens
tatgctgcttatatcaactaggacaaatttttaacactgtttttcaaacactgtttaccaattcccagtctatatattgcagtaattactgagagaggtttgttgaatttcctaaatataaaggtggattcttatatttcacattttactcttattagtttttatcttatagtattttaagattgtgatgtcttctcttyttggtgagattttatgtaccaaattctactttgatagtaatatagccaattaatttttctacaaatttgtcttagaatggcataggtattttaattactttgctttaaacttatcacatctttatataaaaataggtatatgggtaaaaaattaaagttatacaaagtgacaaagttctagagatgtgttgtataacat

SEQ ID NO: 189 - DNA, 399 bp, Homo sapiens
tgctgcaccacttacctttttcccaaagtaatcattactcttcttgcatagaaataattaaatcaaatggtaaaatttaaacactataattttgaaattatatttacctacaagagttttaaaatactcactattccttaaaatactcactactcttccaataattattccttcatgattgtgtttttccaactcaacaytgtgttaatctatatcaaataactaagttattggctttgatttagaatgtctgtatggctttctcccaaaaaagcactctgtgatttttttttctttttgctttactcaataaattctgatgaatttatataaaagcattgctatttatcctgagaatcagaaagagattgtctatgttaattatgcccttgaatgact

SEQ ID NO: 190 - DNA, 399 bp, Homo sapiens
ccttcatgattgtgtttttccaactcaacattgtgttaatctatatcaaataactaagttattggctttgatttagaatgtctgtatggctttctcccaaaaaagcactctgtgatttttttttctttttgctttactcaataaattctgatgaatttatataaaagcattgctatttatcctgagaatcagaaagagaytgtctatgttaattatgcccttgaatgactaatgcataatatcaaataggtgaagaacaaaaaatgaggaacaataaataaagaagtcatgtgagttttaaaagacttctttaaactactaaaagtaatttgccactcaccacaaaatagcctgatgaacacttctaaaattaatagtgagcaaaaatgtttttaaaag

SEQ ID NO: 191 - DNA, 399 bp, Homo sapiens
ggaaaggagattagcaacagaacccaataatgcctaacaagatattgtgccaaggttactgctttcttgctctttgctagcttgagattccccagggaagtttctctggctcttttttttttttttttttttttctctgtaagatacttagaagtaatctgggcctggaacagaggaaattattctccaagtttttgtcwcacctgtgctttgtgtcctgcagtgcctacaaatgtgggaattttctccagtttgaaagtaaaaattatcaagctcctgcttctcatttcctatgggcaagcacttacattcagcaatgcttattgactaattcttcatccactttttatatttccaaagttgttggcattctttgtctattgttagctcccatctagt

SEQ ID NO: 192 - DNA, 399 bp, Homo sapiens
taccttacataattagagaaattcaaatggaaaagtggtgtattctcaattggtcaaggtgatctgccagaaacaaaagtgaattctttccagcaagagaaaaatatgataatttacaaattatttctgaaatgtaatggtttttttgaagaaagcatgctcttatttatgcaatacacttggtaaagaagaagcctgcrcattataaatctatgtaaaattgggcaaaatatataaacacaggcaactgtgattaggtatttgatcttaatccctgatcctgaatacaggaatgcaaaaacgtgagccacattctttagatcctcccatctgactgggataattccacaactgtggcaaagcaagctggagttcaagcagaatgtgatctttccagtg

SEQ ID NO: 193 - DNA, 399 bp, Homo sapiens
caaacaagtcaaggaatggcttccgtgtttaatcatcatgataattcagacttcagctggcaaccatgaaagtcagcacataaacaccatagttgtccaaacatagaataccttacataattagagaaattcaaatggaaaagtggtgtattctcaattggtcaaggtgatctgccagaaacaaaagtgaattctttccmgcaagagaaaaatatgataatttacaaattatttctgaaatgtaatggtttttttgaagaaagcatgctcttatttatgcaatacacttggtaaagaagaagcctgcacattataaatctatgtaaaattgggcaaaatatataaacacaggcaactgtgattaggtatttgatcttaatccctgatcctgaatacagg

SEQ ID NO: 194 - DNA, 399 bp, Homo sapiens
ttgagaatacaccacttttccatttgaatttctctaattatgtaaggtattctatgtttggacaactatggtgtttatgtgctgactttcatggttgccagctgaagtctgaattatcatgatgattaaacacggaagccattccttgacttgtttgtcacggacttctaacttgtcaggatctaaactgattttttggyttcataggttcataagaacataagaagttcttttcaagtactctaacccttgactgacattaagtaggggcacatcacaaaaaatccaattgggaattgagctgattcaaatcagagattcactctaggtgaaggctagtgtatttttgtgtaaatttgcacctcagctgtatccctttagagactgcatgcacaaacc

SEQ ID NO: 195 - DNA, 399 bp, Homo sapiens
ataaaactgtgaaaatgtctgctcagcatctccacattttctctggctgccttcaaatcactgtgtacagtaatgccaaatgccttaagaatcaatgtggaacagaggctttatgcccagatattagcccctcaatttttgttggacttggtaactgttcagcgccctcaaacagattttttatgtatattctacttggytttctggttgtcctcagtaggttggttggtttgctttaaactaacaaaatatgtagagactgtgtaaacacaccttctgtgtcagtctgttctcatgttactaatgaagacatacgcaagactgggtagtttataaaagaaagtggtttaatggactcagagttccacgtggctgaggaggcctcacaatcatggtgga

SEQ ID NO: 196 - DNA, 399 bp, Homo sapiens
ataaaatactgttaatggaaataaagaaatatggaaaagaatgttaaagttgaaaagataaaacatgcagtggaatcctatattttgtgccatcaatataggtcagtttctaagaaaagtatggtctattccattctgattcctttgtatttatgctctccaatttgtaatatattaactagagaacactggaagacaaytgaattgtttaatttcccctgaagtatacacgccaatactggaatttcaattcctgtttatctgtgtccacatacagtgcttctttcagtttaccacacacaccattgataagcaattcctgccagactttttgtttggattcttcagtgcctctaattaactagagaatatttggggcatttgatatttaactcatat

SEQ ID NO: 197 - DNA, 399 bp, Homo sapiens
actcgggaggctgaggcagaagaatggcttgaacccaggaggcagaggttgcagtgagccaagatcgcaccattgcactccagccaggggacaagagcaaaactccatctcagaaaaaagaaagaaagaaagaaagaaaaactgtaatcacatagttttgggtatctctctctatatttttctctctcctcttcaagtaygtttttaggagaaacaaaaaagaacacacaacgcatagatcctgaggtgacactgtggtgtttttcaggtacaataagtatgcaagcacgtagagcacaatcagcaacaggaggctgtatggtttgatagggcaccatccaaatctcatgtcgaactggaggaggggcctggtgggaggtgactggatcataggggcgg

SEQ ID NO: 198 - DNA, 399 bp, Homo sapiens
ctccagccaggggacaagagcaaaactccatctcagaaaaaagaaagaaagaaagaaagaaaaactgtaatcacatagttttgggtatctctctctatatttttctctctcctcttcaagtatgtttttaggagaaacaaaaaagaacacacaacgcatagatcctgaggtgacactgtggtgtttttcaggtacaatargtatgcaagcacgtagagcacaatcagcaacaggaggctgtatggtttgatagggcaccatccaaatctcatgtcgaactggaggaggggcctggtgggaggtgactggatcataggggcggatttcccccttgctgctcttgtgatagtaaattatcaggagatctgatggtttaaaagtgtgtggcacttccacctt

SEQ ID NO: 199 - DNA, 399 bp, Homo sapiens
agagcaaaactccatctcagaaaaaagaaagaaagaaagaaagaaaaactgtaatcacatagttttgggtatctctctctatatttttctctctcctcttcaagtatgtttttaggagaaacaaaaaagaacacacaacgcatagatcctgaggtgacactgtggtgtttttcaggtacaataagtatgcaagcacgtasagcacaatcagcaacaggaggctgtatggtttgatagggcaccatccaaatctcatgtcgaactggaggaggggcctggtgggaggtgactggatcataggggcggatttcccccttgctgctcttgtgatagtaaattatcaggagatctgatggtttaaaagtgtgtggcacttccaccttcgcactctttctctcc

SEQ ID NO: 200 - DNA, 399 bp, Homo sapiens
tctatgttgaaagggaatgtatattaattttatattgctgaaataaagtaaaaaattaaacgttttcatctcttttcctgatatatgattcaatctgaatcatttattatttttagctcatttttaataatcttcagttcttaaaaattttccatgtgttttaaaatcccaggacaggtgaaatatttaattttttacartaataatttagcaagttagatgtcatagtaaattacatttttttaagaagccaagagcattatgaaacagcattggtagtaaccatagtacttgttagaaacgatgtgaaatgatatgtagcacttgctatgttgcttgacatttttaaatataggtaattaataaaaataaatgagaactctgaaatggtattgactg

SEQ ID NO: 201 - DNA, 399 bp, Homo sapiens
tttcagttattttgaaatatacaatagattattgcatatttaattgttatgtacaataaattgtatatttaatatatttattgtacattttaaaatatacaataaactgtttacaatagacaataaattattgtatatttacaatagacaataaattattgtatttttacaatatacaatagttgccctattgtgccacygaacactagattttattctttctacctctatttttgtacccattaactatgtcctctttgctgtcccctctccactacccttcccaccctctgataagcatcattctactctcctttccttgagttcaatatttttagcttccacatatttaatgagaacatgcaaaattatatctttatgtgcctgatttattttact

SEQ ID NO: 202 - DNA, 399 bp, Homo sapiens
aactgtttacaatagacaataaattattgtatatttacaatagacaataaattattgtatttttacaatatacaatagttgccctattgtgccaccgaacactagattttattctttctacctctatttttgtacccattaactatgtcctctttgctgtcccctctccactacccttcccaccctctgataagcatcaytctactctcctttccttgagttcaatatttttagcttccacatatttaatgagaacatgcaaaattatatctttatgtgcctgatttattttacttaatgtaatatcttccagttctatccatcgtcttaccccggttcaaatagtttttatttttaatcaaaaagacaggcaataacaactgctgacaaggatgtata

SEQ ID NO: 203 - DNA, 399 bp, Homo sapiens
gagtctaaatcatgaattgttaagttttagtattcatattatgtgaatattaatacaacattttgtaactgacacatttgtagtttatcattttctagcattttatttactattttttatgtaccaaagactgcatttgcaacaatttccagagtatacattctttctaatttgaagagaaataaatggaaatgtattascataaaccatctccagatacataaactaagatatgacattcccacctaatcatgattcttacagaaattataataatgaatatctatctatatatactaataatgtatatgtgtgtatatagacatatatatgaagaaacataagccaataaaagtaaaagactatatatatataggcttatgtttcttcaaggcgcac

SEQ ID NO: 204 - DNA, 399 bp, Homo sapiens
ttcaaatgtaaattgtctaagaaacatttgattgactactgtgttcaagactcttaacattatcctggtgcattgcttcaggttcttctgaaagccatgtctgagacaagatcttggagcaggtagttgatttagagatgatcacaggaagcaggggtatgcgtgtggtgagaatgagatgggacaagattaaaagccayaacaaggctgccctattaaattcactgttgtaggctgtgggagttgcttctttctgaatctgagaaaattagagacgaaatttggaagcatccacctgaaatattggtggcttagatttttatttactggctcctgagcccctttatttgaaggtcaccactagatatgttatcttcttcagggggtttaagtgtagtg

SEQ ID NO: 205 - DNA, 399 bp, Homo sapiens
ttagccattctagctgagatcagctgaggactaaggaaatataatgcagacagtagaagtatttaccacacctggaaatataaaaatgagtaagcacaagtaactgaaggaactatttagaagtctggaagaagatactggcttttaaatgaaaacttaacaaaaaaaaggaatcatgtaaaacagagttatgtaagaamaaaaatgctccaagtgttaaagactacatttactaagtaaggagttattggttactgattgccaagtatattagcttcctattgctgctgaaatgaatgaccacaaatatcatgacttaaaacaacacaaagttatatccttacaattctgggagccataagttcaaaatcagttatattgagctaaagtgattatgtc

SEQ ID NO: 206 - DNA, 399 bp, Homo sapiens
tataaggcactttctttgtactatgggggaggagattttcatgctacatatttttcatttaggtgctggaattcttcaatattttaatctgtgtatgcggattgtgaaatggaatagttaacaatcagaatatgtggatattttatctgcatttgatacaattattttaaacatgaaataggataatctccaaatctctyaaatttacatataaattgtgcagtttatgcccaaagaagacacacaacaaatcttgacataggaaatatagctacacactaagctaaatacacacacacacacacacacacacacacacacacattttagatttagatatagtgttttatgatgttataaaaataccaatggtaaaaaaatatataaaacagtacaaat

SEQ ID NO: 207 - DNA, 399 bp, Homo sapiens
ggacatctccatagtctctcaaaagggtagggttacaacacagcaatgctgaggaactaatgctgtttgtggtgaatttttactaaaaaggaaaataaaaggaatctgtgcatatattactttctgttactttaccatcttttcctctaatagacaagaaacagtaactctgcatgatctgctcaatgagagcaatcagygagtgagaaatcccatttttctggtcatttacaattttcatttgggctatggccaggaattttgaaatttccttctcttctacctgatctaaatttatttttcccctcctgcttgcttcccttggtttgtatcatcaaataaattgttaacacataagataacaaataaattgttaacacataatataaagataattaa

SEQ ID NO: 208 - DNA, 399 bp, Homo sapiens
tccaatgccctttatttctttctcttgctttattgctttggccaggacttttagacattcaaagagccaagaatgtagaaaaaatgctaaacatcactaatcattagggaaatacacatcaaaaccacaatgagatataatctcgctccagttaaaatggctttaataaaaaagatgggcaataatggatgatgatgagrctgtgtataaaggataacttttttaaattgttggtgggaatgtaaattagtacatgaagtttcatgtactaatacatagagctaccatatgacacaaataaaggataaattttttacattgttggtgggaatgtaaattagtatgaaggttcatgtactaatacatagagctaccacatgacacagcaattccactact

SEQ ID NO: 209 - DNA, 399 bp, Homo sapiens
acacacacacacacacacacacacacacacacacaaagctctatgacaaggagatcgcagaattatttaatgtgtatttttaccacgtgtatgaaaatgtatcttgggggttttagaataataaggaaaagaatcgtataaggttaaaaagaaagtattttttgacatgggggcaatcacttatgatttagaagtcaatrttctggcaaggacactcacagcccttcttctgtgtttgcagggatggctccttgaagactgaaaacaatgattgctgatagtgtgctgaaacttctttgacactgacttaaggaaggaatcaaagggtcaggtaagtgggaatgttctaataaatctgagaaaccaccacctgattagattacctgagagggcccagaa

SEQ ID NO: 210 - DNA, 399 bp, Homo sapiens
tcactatttaattaagagagaaatgttaaagtaattgaacctgtagtgctttaaatgcaggaggaatattgtatttgtattgttttaatattcaaagtatgtaaaagccatgttattatattagttaaaataccaatagaaaacatttcaaattatgtattcatgcaacaatgttttctgagcagttatatgtgctagamtataaagaactaagtaataaacaatacagatatggtatttgctctattatactactaatgatggcagaaaaagagagaggaaattgctacgatgtatgattaatgctatatcaaacaaagtaatgtacaatttgtgacaaattccaggaatatctaatttattctacacagtgcataaagttttcccagaaaatacctc

SEQ ID NO: 211 - DNA, 399 bp, Homo sapiens
ctgatgggtagaagcacaggagccatactaaataaaagactccaagagggcccaggtgaccgaagttttcaaactgtcctgaggctacaggttatgggaggtgagaggaggtgagcatgtccttagaaatagtagatagtagtctgtggtaaaagcctctgtcagaccactaaaagaatcagacctttagtttctttttsctgtgacttacgtatctcctacatcaagataaacagataaggagtcctcagaggaagcctgtttgcatccccacaaatgcaaatctgctgcacaagaggcagcttttcagggctattcccctctctgcatcctctctaaatagttatatcaaaagatccccaaaaagtatattttagggtggcatattttgttattcct

SEQ ID NO: 212 - DNA, 399 bp, Homo sapiens
ctacgttaacagaaggagggacaaaaatatatttatctcaactgaaacagaaaaagtatttgaccaaattcaacactttttcattataaaaaactcaaactagtgatagaaggaaactacctcaacataaatagagccacatatgaaaaacctacaacagacattatactcagtgaagacagattgacggcttttcctcraagatcaaggcaagaatggtcatttttatcactttttaaattcaacatattagtgaaagttctagcctgaacaattgacctaaaagaaagaaagaaatgagaaggaatccaaattagaaaggaagaagtaaagttatttctgtctgcagacgataggatcttttatatgtagaaaaccttaaagatacacacacactca

SEQ ID NO: 213 - DNA, 399 bp, Homo sapiens
aatccaaattagaaaggaagaagtaaagttatttctgtctgcagacgataggatcttttatatgtagaaaaccttaaagatacacacacactcacacacacatacacacatgcagaaacacagatacatacataaactgttagaactaataaacaattttaccaaggggcagtatccaaagtcaacacacaaaaagcagytgcagtcctacacattaacaatgaataatctgtaaaacaaatgatgaaaacaattccattgacaatagtttttaaaagaaataaaaatgcttaggaattaatctaagcagtaaaagtttatacaatgaaaactctaaaacattgctgaaagaaattataggagacataagaaaatagaaacacatccatgttcatgaat

SEQ ID NO: 214 - DNA, 399 bp, Homo sapiens
gctaacaaaaacaagcaacagagaaatgactcccttttcagtaagtgatggtgggataactggctggccatgtgcagaaaattgaaactggaccccttccttacaacatatacaaaaaatcatatataaaaaatcaactgaatatagattaaagacttaaatgtaaaattccaaaatgtagaaacgctggaagacaacgkatgcaataccataacgaacataggacctggcaaagatttcataacagttggcaaaagcaatcacaataaaagcaaaaattgacaaatgtgatctaattaaagagctctgtacagcaaaagcaactatcaacagagtaaatagacaacctacagaataggagaaaatatttgcaaactatgcacctgacaaaggtctaat

SEQ ID NO: 215 - DNA, 399 bp, Homo sapiens
gtacagcaaaagcaactatcaacagagtaaatagacaacctacagaataggagaaaatatttgcaaactatgcacctgacaaaggtctaatattcagcatctgtaagaaacttaaacaaattcacaagaaaaaaatgaatgacctcattaaaaagtaggcacaagacacgaacttttcaacagaatacatacatgtgacygataagcatattgaaaaaatgctcaacatcactgatcatagataaatgcaaatcaaaaccacaatgagataccatctcacaccagtcagaacagctggatattaaaaagccaaataataacaggtgttggtgagattgtgcagcaaaattaatgccgatgtatagttggcaggattataaattagtacaaccatttgga

SEQ ID NO: 216 - DNA, 399 bp, Homo sapiens
ttatatacaagtgagtacatgtgattaaattttcatctttttattctttatgtgttgaaacctaatacttgaaatttgaatgattgcccttgtaacaggcttgaggattcaagtcagaaggaacgaatgatctccttcccatctggaaattttgtggatagagcagttttcagattatcttacacctatattagattgtyactgtagaagattaaaaaggtatgggccactcacggtggctcacgcctgtaatcctagcactttgggaggcagaggcggacggatcacgaggtcaggagatcgagaccattcttgctgacacggtgaaacccatctctactaaaaatacaaaaaattagccgggtgtggcggtgggcgcctgtagtcccagctacttgg

SEQ ID NO: 217 - DNA, 399 bp, Homo sapiens
gagcaaaacctctcttatttgaatccatctaaaaatcagcttttactgagataccctagaattcacaatgatatgtcttttcattgagtatgatgagccaataaaccaaactttactcaggatgaagttggcctcatggtcttggataaatgagtatcaacatttggtatggtctgtctttttttcattttggatctacrgggtgaatatgcagtaaaattcagatgatttgaatttgcattttccctgtgactccatacactattgtaagtacactagtacatgcactaaatacacaatgactaaacacattacagtcactgtgattaaatattctacgactagtgcattttcctatggccatacatttcttggctattttcatttgtttacttccct

SEQ ID NO: 218 - DNA, 399 bp, Homo sapiens
aatatattttatattgagtcctttctcacatgtgtgtactgcaaatattgtcttctaagttgtaactctgtttttattctctcctatctaaataagataggagagaataaaatttcatgtttttgctacagatgtaacaaaatatgatttgcaagatattcaaccatctgacagatggtagaatcaagctttaacctttyatgtagctctagatccatcttgtatttatttgtttataacattgagaaagagtccatattttttccatgtgaatatcaagttagctaagcagattttactaaaagtacttactttccctcactaaaggatatcatgaacaaataactatgtatttgtggacataatttctatactttatattctgttccattggcctat

SEQ ID NO: 219 - DNA, 399 bp, Homo sapiens
tctataatgttttgcacatttagggtagaggccttaacacttctatcctcttaattgatttcaatgtgttcattgattgctattgtaaattgcacatttaattaaaggttactttttgtttccatattgttggttaaagaaatatattgtgctgttctttgtttatcttgtataaaataatttttataagttcacacttyaatagtgtatttgttgattattttgtatttaatttatatacaattttgtcatctgcaagtaaggatttttagtttgcttatccttattcttataatttttatatttctttgtaattttattttgctttggctaggaactttattaaaatattatatggaagtgatatgcccagatgaatggatagagaaaatgtgatat

SEQ ID NO: 220 - DNA, 399 bp, Homo sapiens
ataatggtacaaaatcttaattaggcaggaactttatttttcccttgtgatatattgcacagcatggtgaatatactaaataataatgtatatttcaaaatcattaagagtgaatttcaaatattttaactacaaaaagtaattactatttgagataatggatatgttcattggattgatgtgattatttggcactgtgytcataaatcataacatcacttgtaccccataaatatatataactttaatttattgatttaccattaaaactaaaaattaaagagaattataaaaggaaattttatgcataggaattttttgtcattcccagtatgaggaaaaaagctttttatatttcacctttgagcattgtatatgctatattttttaaaaatttta

SEQ ID NO: 221 - DNA, 399 bp, Homo sapiens
gttgatcccatagggtatcaaatgtgtccatgggcactcttatattttccagtctgtgggtatctatttgggatggatatacttagcatgtggaagtatgttcacatactggtttctgcattggacctttgtgctaaaaagttgtaaaagaaagaccctgaaactaccaatccttgctagtattaccaaaagcaaaacckcattctagaaagatttacaaagaaatcactaacatcagaaacgttaaagatgcagaaggtcttgtctccatcattgctctttttaatttactttctgaacctctgtggaaagtagaaaaatgctccattcttaatcattggatagaccaaaatcttggtatgtcaaatgttatatttttattgaaacagatcaatatag

SEQ ID NO: 222 - DNA, 399 bp, Homo sapiens
cggtgacgggtgcactaaaatagcagacttcaccattatacaattcattcatgtaacgaaaaactatttgtacccaaataaataaaaaataaaaaagataaatgcttagttgaatataaaattttttaaatattttaattctcacctttataatagcttaactagatcttcttttaagttgctatgtatcaaaatataayaaaattcactatttctgttctcattgacatatacattgagaaccttgatcagcaagtaagcattcaattttctataagttacaatacatatttttatctgagatataaatcctattatttttatgaaatcaccatggcatcatggtgataggtagatagatacatacatatacacatatacatacatatatacacactc

SEQ ID NO: 223 - DNA, 399 bp, Homo sapiens
tcattgacataatgcaacatttaacattatatatgtgtaatgataacataaataaaatattagaacatgcagctgtgttctggataatatcatgctgtttcacatagcaccattccctattcctttagctactggattactggaaaaaaatgtatctcaaaatctaatcaagtcatttgaaaatatgtcatttatattcytattttatctcgcaatcaacatttgttaaaacctcaggaagtaaattgatagaatgtgtttcaaacaaccaatattatgctttggtccttttacatcaacaaagtaataaaatatttattactctctactttatctcttctttatgatagatagatacatacatagatgatagattatttatttgtatagacatatatg

SEQ ID NO: 224 - DNA, 399 bp, Homo sapiens
attcattgggtgcaggtcatgcagtatatattttaatgatttgaagtgacaatgttaatggagtaattctactaacaagcccatcttgatctattcattctataaatagttgactagccctattaatcaagcttcgtgctagataaagccttatgtattggaaatcacagttctcaataattgaaaacctagatgaataytgaatgatagtgggttaaagttgaagaaaataagaaaagggaaggagatgtgagcatggctataatgtgtatttggaagatgagagtatttgctcaaaacatcttttacaatacttagctaagtcttaagctaaatcactctttaaactaggagggaataaacacaagttttatgtatgaatgcatttatattgttgtg

SEQ ID NO: 225 - DNA, 399 bp, Homo sapiens
acaaaacacgctagctgccatcaagttattttcctggttactacttgtaactatgcacatgttagatgtcatcacagaagcaagaatctaaggagttaaatacatgacttgttttttcttgtttgaaaactgtacttgatatgcatgatacaatgaacactgcattttcacttacatctttattcttaggttaagtttayagtttgatgagccttaaaaatatttaatagaaataaaagttgtgggtctgtactacatttaatattgagaactctaaatacatgcctgtttttattataccaataatattcttattaagaattgtttattctataaagattacccatcataaacattgagaaaataatctatacaagcacttattttaaaaaaaaatca

SEQ ID NO: 226 - DNA, 399 bp, Homo sapiens
acagaagcaagaatctaaggagttaaatacatgacttgttttttcttgtttgaaaactgtacttgatatgcatgatacaatgaacactgcattttcacttacatctttattcttaggttaagtttatagtttgatgagccttaaaaatatttaatagaaataaaagttgtgggtctgtactacatttaatattgagaacyctaaatacatgcctgtttttattataccaataatattcttattaagaattgtttattctataaagattacccatcataaacattgagaaaataatctatacaagcacttattttaaaaaaaaatcaaaaacagtgtttttttaaatttagcaatatcaaaagaagaaaaaaattattatgcatataaacatgtgtaaat

SEQ ID NO: 227 - DNA, 399 bp, Homo sapiens
gaagaaaaaaattattatgcatataaacatgtgtaaatatataaacaaaaagtaatcttatagcttttattttaaaaatttaacctgttccaggtataaaaataaaaaactcactaatgtattaaacaataactggatctcaattgtttttgtgcccaagtcaacaagatgtcctgtcaatatggttaaagcttttgacyagtatttctgaaaaagacttctaggattttttaatttgccttctgtagaatatcttttgattcacgttatcttttaaatgactctgcatagcaactaaagtatgcattccattgcttttcttccattttggaccctttcttttctaatgcacttcaccagtaagaagtttatctcggttaaaacttcaccactgtggcc

SEQ ID NO: 228 - DNA, 399 bp, Homo sapiens
atatatatatatttagttcatcagaattataataacctttcttggtagaagcatttgtcctaaaatatccaaattcattgaaccaaaaatattgagtaaggggggtgaaaaatagcacatatgggtattaccacggcaattaataaggagttttgttagccaagaaagggacatgctgacaaggactgtgctcagagaargcaaatctgagggaatcaatctgccactagcaagataatttattaccctggaagaatggtgtcttatcaagagctcaagtttgtctctgtagttgatggactggatattagctgtgtttaaagtgtaattgtatttgtttagataaaatatttatgaactcattccagtcactgtggccattttgtgcctgggcccaat

SEQ ID NO: 229 - DNA, 399 bp, Homo sapiens
atcagtgttagtcaagcttgaggtttagggaaagatttccagttcctatgactcattaaaatgtctttgtctacagctcaggaaaagtagggggaaaaagaactctgtgtcgaaaggaccttgtcttcaggaagagattaaattaacacagggactgacaaataaaggcctgtggctcagatctgacaacctgtgtttgyattgccccctagttaagaatgctttttttaaaaaatttaaaattattgaaaatttccaatgaggtctaattttttgtgacacataaaagttacatgaattcaacttctgtatgaatactactgctttgttagaaaataatcacacttatttatttacatattacacatggctgcttttgtattataatatctgaggtaa

SEQ ID NO: 230 - DNA, 399 bp, Homo sapiens
aaagactattataaatgagtctagtataactgacctcaataacgcaataatgacacaaaattagaatattaatcaactatgttaactatacagattattagcaataaaagtttattaaggtgaaaagctatgtaaatcacaaaattatttacatttctgaatatgtaaaagtaataatcataaacaagtaatgttgatamtgcatcacaaaattatttacatttctgaatatgtaaaagtaataatcataaacaagtaatgttgataatgctttattcatcttgtccatggttaaacaattaggtaccagtaaataatcttaaaatattgaatatcattgaatattcaaataaaatttgaatgtcatgtaattataaaaatcacatttaaagtacactg

SEQ ID NO: 231 - DNA, 399 bp, Homo sapiens
tggggaaagcagggggaagtgaacacaggactttgcttggtcccagacactgggcccaccacagtaaaactcagtaccaagctgaccccatggcccgatattccagaccagtacctgtggactaagactccagaaccgccaggtggagccatatagcccctggcttccggcttgcatgacagactcaatcaatctctcaygttttatgtgtctgaaaatgtctttatttaaactttgtctttcaaatatattttttgctgcataaggattttagtatgattgctttctttttatattttaaagatattaatcaatagtttcctattttgtgttatttctaaccagaaatctgctcttacatttaacttttttcatcttccttgaatgtgtttttctttc

SEQ ID NO: 232 - DNA, 399 bp, Homo sapiens
gctgcatcttcaagtcctctattcttttcctcttcaatgtcttttctaccatcattcgttcctgcatattttccatctgattgtcctattatagttttcatctctagaagttgagtttgagtggaactccatctcctctactctgagaaactgccaggatttttctagattttatctttgggctttggttattgatttgyagaatttttgtatattctttatataaattgttcgtcaggtaagcacattaaaaatacttttcccagattgtatcttacccttaaattttaatgtattttaagaaatcatgataaaacaataaatttaccatatgaacctcttttaagtgtacatttcagagttgttaagtatatcaataagcatattcatgtagttgtg

SEQ ID NO: 233 - DNA, 399 bp, Homo sapiens
acatggtcaagttactggaaaatctttgattgtggcaggattgtatcacaggtttgctaggcaggattccaacaacacaacagccttcagtttactaataattctgttccactgttgaggtaatactcttctgattatttacttgaagttcgttgtattgtgtatttattttcacctggcatggtaaaaatattctattyctgtgagagcgccaggagttgattcacctacttcatttgggtggctcctttcccggccttggcaatgttccttatacccatgtgctaattactactcagatagagattcatggggcatcctctgaaactctctacagaactttctcttacagctctgttatttgttctttgtctgtaatctctagacacctttgcctct

SEQ ID NO: 234 - DNA, 399 bp, Homo sapiens
caaacacatctagttacctataaaatgagtgttaaattatatattaaatttgctctttaaacataatacagttggatcttataaacgtttcttgaaaattattgtataatgaaaatttaaataaaaatgtaaccacttccacaatgtcagtcttcttatattttcaagtgccaagctgtgtttaaagatgttttgtgttyagttttatttcttgagaaagaaattgtactgtacccacaaatgagctccagttaagacaggaggaaatttgtttattaaagttggcactaaactagcataaattatttagaagttaatgttctcacctttaatcaagataaagacccatgtgcttttaaagttattttactaaggagttatatttcttcaaaaatatat

SEQ ID NO: 235 - DNA, 399 bp, Homo sapiens
aggaattctactgtgcctcctggcccctgggctttctgcaggttgacatcccattctctggatgacaggtgctctagaacttattgggtagtcttctgcaagactcaaacctgtagctatcatatcattcacataatgctcccagtgaatgctgtatatatcactcaaaacagccaggtcccccagccaccaactatggsagatagtgggacgatgtaagtacatctgaaggagtgcctgattcattgttgaccctccaaagtgagggcaaacatatcctggaagtttgggtctaagggtatgctaaagaaagcatttgctgaatcgggacagtatgcgaactacctaaccaagtagtcggcctttctaaaatttgagtcacatttgggacagcagctt

SEQ ID NO: 236 - DNA, 399 bp, Homo sapiens
tgcctcctggcccctgggctttctgcaggttgacatcccattctctggatgacaggtgctctagaacttattgggtagtcttctgcaagactcaaacctgtagctatcatatcattcacataatgctcccagtgaatgctgtatatatcactcaaaacagccaggtcccccagccaccaactatgggagatagtgggackatgtaagtacatctgaaggagtgcctgattcattgttgaccctccaaagtgagggcaaacatatcctggaagtttgggtctaagggtatgctaaagaaagcatttgctgaatcgggacagtatgcgaactacctaaccaagtagtcggcctttctaaaatttgagtcacatttgggacagcagcttgtatggcgaaggt

SEQ ID NO: 237 - DNA, 399 bp, Homo sapiens
ctgaatcgggacagtatgcgaactacctaaccaagtagtcggcctttctaaaatttgagtcacatttgggacagcagcttgtatggcgaaggtcatctcgtttagttgctggaaatcaactatcgtcctccaggtgccatcaggctttgttaccaaccatgcagtgatgctgtatgggctctgtgcaggatgcacaatgyccaccttctccagtttctgaatagtagcctctatctcagtgccctcctggaagacgttatatatacaccactagtccagaggagggtaacaccactggcttccatttaacttccctttggagcaagccttctgtcattctaacccagagatggaatttgcctactgcaaattgtttcaaaggaagctcccaggaaagta

SEQ ID NO: 238 - DNA, 399 bp, Homo sapiens
tttactttccctccctccctcctccctcccctcccctcctcccttcctccctccctcccttccttccttcctccattttttcttccttctttccttccctcctttttttttctgtttctccactgccagcaggtaggtgtggagttaggtttcaacatttgaattttggggggacacaaacaatagcatcaaacacaaamaatactaatcatttataattcttattaaagagctgcttgtaatttttaatttgtaaaggcaagtagattttccttgtttttgttaattatccaaggatatgatttaatattatctcccttattatgtagcttgcttcttgcttcatgaaccttgttacaaatcacaaatattcctaatattttattatgctcttactca

SEQ ID NO: 239 - DNA, 399 bp, Homo sapiens
cagtttcattaaaaggttctataataaatcagtattgcttttactttattaattggtactctaaaaaatgattacaaaatgaacaattgtttagattcttggaacacaatccaacctttgcactctaaaatttaaacaccataaacttccaaataatagtctagtacagataatcgctagaaacattacacactgactasctctaaaaatagcagtatttttcaagttttcatccaaaatgttggaaaatattggttacttgactacacactgctatattttaccctattaaattttcatgagctcacataatacaaagtgctgactacatgcatggccacacacttcctcttctcatagaaccaaatgtatatggcatttactaaacagattcaaaag

SEQ ID NO: 240 - DNA, 399 bp, Homo sapiens
acaaaatgccttatccaccttcatggtgttccatgtagcattgcctctgaccaaggcactcactttagctaaagaagtgtgtcagtgggctcatgctgatggaatttactggtcttcccatgttctccattcattctgaagcagctagattgatagaatgtggaatggccttttgaaatcacaattataacactaactargtgacaatactttgcagggttgggaaaaaaagttatccataaggctgtgtatgctctgaatcagtgtccaatatatggtactgtttctcccatagccaggattcacaggtcgaggaatcaaggtgtggtagtggagccagcatcactcactatcacccctagtgacccactagcaaaatttttgcttcctattttcaca

SEQ ID NO: 241 - DNA, 399 bp, Homo sapiens
ttctgctggcctagaggtcttagttccagagagagtagtgctgccaccaggagacacaacaacgattacattaaactgaaagttaagatttccactcagccattttgggctcctcctgcttcgaagtcaacaggctaagaagggagttacagtgttgcctgtggtgattgaaccagactatcaggaggcaatcagtataytacttcacaagggaggcaaggaggagtatgcatggaatacaggagatcttttaggccatcttttagtattgccatgccctgtgattaaggtcaatgggaaactacaatagcccaatccaggcaggaccacaaatggcccagacccttcaggcatgaaggcttgggtcacttcgccaggtaaaaaaccactacctgctga

SEQ ID NO: 242 - DNA, 399 bp, Homo sapiens
atctaaatgttcatcagtagaagatggcataatcatactaataaatcaacacaaatggaagcatatctactaatgtgtataccatcatacaatgtaatactgaagaaagaaagttttgctaagactcaataaattccaatttgtaatgatataggtatccacattcaggatagtaatacctgcaggggaatatgggaaamgacttagattgagggcttcaaatatatttagaacattatcttactgaaaatgtcatgaataacatgttataatatttaaaatctagtaaagcaggatggtagataacatcatcactcatactatttactaatgtttggtatgcttaagaatatctcagaatgaaataaataaatctataatcattgcctaataaaaatg

SEQ ID NO: 243 - DNA, 399 bp, Homo sapiens
tgttacatgggtatattgcatcatgctgaggttttagtacaagtgctcccatcacagaggtagtgagcatagtacccaataggttttcaaccccttctcccaccttcccttcccctctagtagtctccattgtctattgttgacatctctatgtgcatgagtacccaacttttaactccctcttaagtgagaacacttgstatttgaatttctgttcctgcattaattcgcttaagataatggcctccagatacatccatgttgctacataggacatgatttcattccttttatggctgcttgtattccatggtgtatatatcccattttctttatccaatccattgttgataagcacccaggttgattctatgtttttgctactgcgaatagggttgc

SEQ ID NO: 244 - DNA, 399 bp, Homo sapiens
gattcacatggctcccaggaaaggggcaaaggtattgatggttttcagagcacagctgctgggatccttgatcagttatcctccctgcagttggaggtctgcaagggacattctcttggcctcagtaaagaaaaatgggaacataatagagaacaactgaagtattcaaaaatcttttaataaaacgttccctacaccartaaaaaatgaaattttataatactgaagacaatgaaaagggcctaatgccagagatcaagaaggaggaaaaaaaatgtgtttgtatccaatgtacaggtttgtatccaatgtacattacaagaacaggcagtaggaaaaaattggaacaattattttaaaattctgaataaaactgtctcagaaactagatattaaaat

SEQ ID NO: 245 - DNA, 399 bp, Homo sapiens
ttaatagtcaaccaagggttttatttgcattgttataaattatattgtaagaaaagcaaaaaagaaacacttttttcccaaatatataatttaatttcattctttcaacaatacatgttcagacttcagagtaccgatcattgcacattaaaaaaataaataaatacaatttaaaaataccaatatgtattccttatgcrtcaagtatatgccattatctcaggtagtaggaactcagtggaaatcagtctcatattttactttcatagtgcttatggtgtaatgacagggagtgatttaactatgctgctatatcccttgtttatatttatttgtcctaaagaagacacacacacacacacacacacacacacacacacacacacacacgttctaagt

SEQ ID NO: 246 - DNA, 399 bp, Homo sapiens
taagaagttatcatccactttggatacagaattaaataatatcacagggaaataggaaaatccataatatttgatgcctaaaaggaaacttgcctgtttgctttaaaaatataaagtcactgaaaagaaaaacaaatgtgttaatattatattttaaaagaaataaagagacataacaacaatagccaatgaactattcyggattctaaatcctagtttgaaaaaaaaaactgccatgtgtaaaagccaaatgcatgcatttgattataataaatgatattagaaaattgttcttttcctttggtatgaaaatgataaagtggttattgatgtaaggcagcattccacaaactgtggcctggagcaagggaaagcatgctcactaccagttacaaaatt

SEQ ID NO: 247 - DNA, 399 bp, Homo sapiens
gtttctgtgtgttggagatgggagggtggttggaggtgggggatgtggtggataagtctcacagtatattttaaagttaacatctataattgtccttgttatacaatgtaaataaatagagccttttacttttactcattgacctgggctgcatgttgtaatcttgtttcagtagttaaattcttacctcttttctgtgygaatccatgttgtttgcaggtctgataccctgattctccagaatattaattcacttttgctctactcatatcttccttgataagtccatcttttccaataaaagtagtttctagatgtactccgcttgaagatttaaaaattttaacagataaaagtatgtatttagtgcacaatatgatgttttgacatatatctaca

SEQ ID NO: 248 - DNA, 399 bp, Homo sapiens
ctgataaacaaattaataaaaataaactctacaatatagcaaataaaaagaagaatgaggagtactaatcctgtgaaagaaaggtatataatgaacaagaacaaagccaagagtacagaaaaaattattgctgcttaatcatacataactgtgataaaacctcaagtgaatagaaaaataaatacgttaaaagagatggmggtggtaattagtataatatgaattataaccagtgatcagaattatatttgtagtagaaggtggaaataaaggggatgattcagaatattctgtgaacggtagaaaataaaacaaaaacaactaagaattaagtgaacaaatcttttttttttttacatgtacactaaaacttaaagtataataataacaaaatttttt

SEQ ID NO: 249 - DNA, 399 bp, Homo sapiens
ctcattgtgatttttttactatgtttttactttacaaatttacaaatgtttacttttcttgaatttgcttaccagtaaattagttcactgctggcacttctttgtagtctattgctatgggaagtaatatgtttatctgaaaattatgaagattcctagagtttctttacacttgttatattttaggggcaataaaaaawgtatatgcttaaacttgaattatgtcttatttttctttagtgcattataatttcacatctaaatactggtatgtttgtaccaaattagcaaagcaaaaatgcaaaatgttattaattgacattggtcgtttttttatttataccacatccccatatcctatttatttgactatagatgtccatctaatttagaaaatca

SEQ ID NO: 250 - DNA, 399 bp, Homo sapiens
tatgtcttatttttctttagtgcattataatttcacatctaaatactggtatgtttgtaccaaattagcaaagcaaaaatgcaaaatgttattaattgacattggtcgtttttttatttataccacatccccatatcctatttatttgactatagatgtccatctaatttagaaaatcattatctaacctgtttcatttwaccaaattgtcttttttaataatttaggttttgagtattttctcctaagcttttgaatccatgcttacacaattgcattgatattatttgagtcagagtgagttgttcaaagtctcatatttgaaatgagaggcttattttaaccaaacatattgacttttaatgctgttagcactcattttttcaatatatttttcta

SEQ ID NO: 251 - DNA, 399 bp, Homo sapiens
tattgaaaactgtttttgtcaaattcacaattttacatactagagtcacagttccacttaagttcctatatggaaaaaataaaagaaggaaaaaaaagatatccatcgttgataccaaaaactaggagcatcattttaatttaattattttctgtgttacttaaagcatatctgttttccttagagaaaaatctggtaaygtaaaaacacatacttgacgagcttgtgattttttggtagaaatatatatatgtgtgtgtgtgtgtatgcacatgtacatatagatgggtagatagatattcctgtgcttacaatctctaagttagtttaagtcttgtgtttaagtgtaagtattaagcattccataaaaacaagaactgttatgtttgatatgcactt

SEQ ID NO: 252 - DNA, 399 bp, Homo sapiens
ttgctgactcataaaatgacactggcattgattgctgaaacaactgcttgcttaccctcttgccaaaggaaaggaaaaaaaaaaaactgtctcccatttctttccctcccaacagaaaggagggggaaagggatgggtgagacagacgggctaaatgaacattctatcattttaagtttagcaactgcacggaacatagyctattatatttagataatgcaaaagataatgtgcattcatttttgaaagtcaggtgaaaaccatgatgataatgatcatttttccatagtcaagaaacaataaacatataatgagcaggtcatgtatagactgcctggcagtttaatttgaactgtgaccttttattattattattattattattattattattttgtc

SEQ ID NO: 253 - DNA, 399 bp, Homo sapiens
aaaatgttaacaacaaaaagccttactattatcaacagcaacaaaaccaaaaaataaaacaaaaccacacaagaaaggaaaagagaagcaagcgccttaagatttcagtcattgcaatcacttgaaggtgaatttctcttcttttgtcgtatgatttgtttgagaaatcttatttattattgttttcactattttttaargctaacctttatatgatcaagaaagccatataaaaataatcacttgagtggggatgaatagctcttatggcattctcaatacatgacacaaaatattttttactgtagtcatacaatcctagaagacaagtacttatagggctgattaaatcaactggggattaaatcatatagactaaatatctactttttatatatg

SEQ ID NO: 254 - DNA, 399 bp, Homo sapiens
aacaaagaaaccttccatgtcttatctttgcatagtttacactatccctactactgaatatttgtgtatctttataaaacaaggtgattttacgaacaaaccagtagagctggattttaaaaatgaatgaccttctttgttaatacaaccacacgtttatagttcatttttaattaagttttgtcaaattttggtgcccyatttttcaatttctgatgtccaatgagtaaaagtatttacctcaagttctttatatgagaaacaacacgaaatgaaggaatgctttatttagatattaacaagacaactagttaaaaggaacaaaaaaaaaaaagcacatgatggttttgtccttgttattttacatctgaagccacaaaaaataatttgatttatttg

SEQ ID NO: 255 - DNA, 399 bp, Homo sapiens
ctcggcctcccaaagtgctgggattgcaggcgtgagacaacacgcctggactattataccttttttactatgcagactactttggaaatgaaagattttctattgtatgctactgttctcactttcaaacacaccaccaccagtgtagacatattagaagtgaagtaatgacaacttttcaaagattacattattctgawtttgtgacgaacactgcagacttactttttctaacaaacttgcctggacatcattcataagtttatcaaggacaaattggatcgtgatttgacctgatattaagtattaacatttataagtgagtatataagaactgatcaattcatttggagacatgagaatttctatcaacgtagagctttttttgtttagtgaaca

SEQ ID NO: 256 - DNA, 399 bp, Homo sapiens
aaaatgctaggagttaattataggcttctatccctggcatgtcagcttgattaaatttggagttcggagatgaattggcccaaattcattagtgttccctgggtgcagatgttggtcaaggtcaagcgaagcacattgactgtaatgctagagaggaagggggaagggattccaaagaaggtagattcttaaaaggtctrgggttgcagcaagtaactttgatactttttaacttaataaatcttgacagcctaatcatggctaagcctttgcagtgttattggtacagatggcaaagctagacatatttaaagagatctcagaagctagtagcaagagagcactgaatccaaatgtagtgttgggctctaggagaaagtgaaagaaaggaggataaaa

SEQ ID NO: 257 - DNA, 399 bp, Homo sapiens
gcatcaataaaactcatctctgatttccaataacatacaaaacatgtttaaggaagtattaattttcaaaaataatggttgccataagtttccaaatccaattgttctcattgaagcttacttcaggattgctggagaagagcttcctagattactctaacgttgactgaaaggtctgtccgttttcttctggctatgcrtatgagatcatccctacaggttatgcatgaaagtgagacatgcccacaagaggaaacatagaatctttaaccttcttcctgacattattatgcctttcctctaatttattctgtgcaaaacagcatttgttttaggaaaatgaaagaagtagtaacttttacctggaaaaaagggcagatcagtgccgacattgccaca

SEQ ID NO: 258 - DNA, 399 bp, Homo sapiens
cctacaggttatgcatgaaagtgagacatgcccacaagaggaaacatagaatctttaaccttcttcctgacattattatgcctttcctctaatttattctgtgcaaaacagcatttgttttaggaaaatgaaagaagtagtaacttttacctggaaaaaagggcagatcagtgccgacattgccacaagtagtactaagraagataaagaaagactttaataattcaagtgtttaataagtagaaagcaccatgcagatagtactattagcttagttcaaagagatgctatgggtaaaggtgataagcaaaagcaataacattaagacttttgtttggtacacagatcagagacaatatgtagcatttagagtgtattgaaagtacacagacttttctg

SEQ ID NO: 259 - DNA, 399 bp, Homo sapiens
tattgcctcctggctgatttctttaacttcagccatgtttttttctttaattcatcttttgtccttataagatttatttctcgttcatatatctggactcatgcatgaagtgtttataagatgcctatttctttattctgtgttgggcaatgtcaaaatttctaccgaaagagaatagttttcaagattcaagacatatrccaatgaggacacatttttagaagcacacatggaacttgctttattggatttccattggagatttttagtttaaccaacaagaaacataaagttagcttttatcatcaaaccttatagttgactcataaccctatgactcaggtctctcactcaccttcacaagatttcattccaaatactttcagctgatcccagaca

SEQ ID NO: 260 - DNA, 399 bp, Homo sapiens
ttcatttattccaggaatagcaaaaagttatactaaaaaacagatttaatgatagtacattacttggctctgtagtgaataatatttgcataagtataataacttaaaccatgtctacttatttaactaaacatagttttatcaggaagacacagttttagaggataaagactaaattaataaaccaaagaaaacagtascactagcatatcacttaaaaatttgtatgtaattactgaaagaatcagataaaacaaagaagatgaaaataatggattgtactaggagcagagaacacaagaacaaagagctactgttttctatgatgagctttttattgctacttgatttttaactgtgtccatgtattacattgagaaacatacaagatggaaaata

SEQ ID NO: 261 - DNA, 399 bp, Homo sapiens
gttctacctctaatgtatatttcaaattgtcctcttttctctatctctgtgactaccttaattaaggccacaataatgttttatatgattaccataataatgtgtttcagcatccttctacctttaaaatgtcatcatatacttttctcttcctggatctccacagtccaccactactgacctattagctctttctagaycacatcagggtcttttctgcccctgaaactgtgtatttgttattctctttatgtgaaaaattcttcccatgcctcttgatgtgattagcctcttctctttcttcacacctctacttaaatattacatggtcaaagaggacctccccgggtattttatctaaaatatcccttccctattggactttctcttgatagccct

SEQ ID NO: 262 - DNA, 399 bp, Homo sapiens
tcagcaaaaaaataaaactccatggtgtcactgagaagctgtcgctgttattggcattaacgtgatgtagatgcaataaagataaccattgtttattgagcaactagtatatgttagccattttgctaagaatgtcacatacgttatgctatttaatttctgcgccaatcctgcaagttacataccattcacagagggckttgaaaatgtggctaaattggcatgacagtaaatatcagaggcaggatgctgaccaggtctgttggatagtaaagcctgtgttcttaaccacagcactttgcagtcttgttctaaatgagaatcaaacactcactctctactttgcctgtgaaagaaagacctatgtgttatatatctttttatctctaaggtcaagca

SEQ ID NO: 263 - DNA, 399 bp, Homo sapiens
ttgtttttaattatgatattatgtttattgaggagcttccctatgccaggatattatcaaattatctctaatccttaacaacacagaaatataaatattgttaaccttattttacaaaagcgggagctttagctcagtgaaatgttgttttcttttagaatcacatagtcaaaatcaggatttgcactccggattattayaaagtctatgatcttttttctttgcataagaaaactcttaacctgaggtgcaaggtccttgggcaaagattgtagatctgtattgggcaaaagaatagtagcagatacatgtatgacttcaggggtaaatctcttaaaattgtatgcagaataatacttatgtatggatactttctttcttgagggttcataataattt

SEQ ID NO: 264 - DNA, 399 bp, Homo sapiens
atccttaacaacacagaaatataaatattgttaaccttattttacaaaagcgggagctttagctcagtgaaatgttgttttcttttagaatcacatagtcaaaatcaggatttgcactccggattattacaaagtctatgatcttttttctttgcataagaaaactcttaacctgaggtgcaaggtccttgggcaaagaytgtagatctgtattgggcaaaagaatagtagcagatacatgtatgacttcaggggtaaatctcttaaaattgtatgcagaataatacttatgtatggatactttctttcttgagggttcataataattttaactagatcccaaagggttctgggactcaaaatattttaagaacccttgattttcacctcactacatcc

SEQ ID NO: 265 - DNA, 399 bp, Homo sapiens
tcaactcaaaggttttcaactttaggatggggttatcaaggcattaaatgcattttttatttctgatattttcaatttacaatgggttttctggaggtaactccattgtaagtcaaggagcatctgtaattaaaaaaaaagaaaaaaaaaagggtactggaaaatcatgagtactgtttgtgagaatttccagtaaggcyagcaaaaccctaatagaaatgctaggggatttcaactcattcacaattttataagtagtacgatgttaatgggtatagacctgcgataccaatttggcattttccaattaagattggaggaaaataaagatgcaccatcaaagtaaaactggcatttctatggtttgtgtgcaccccacaatcatgcatatgcattctt

SEQ ID NO: 266 - DNA, 399 bp, Homo sapiens
attaggaggggagggacaatttggagactggcaaagttatccagaccagaaaaaaagaatgctttatcttgatttaaacagagacgaagaaagaaaattctgcaaccagcttgctagtttcatttttgctgaagaaaaagctagtttaacaattgagcttctaactcaatggttaatgtacttaatataggaaagcgaaygactacatttattgaatgcctattctgcacccagcactgagttacagccctcattttacagatgtgaaatttaagaggaaaagaaacgtgcttaagataaaccagtcaatatgtgctgaattggatttgaatccagacttgattccaaaaccctcattttttccaccacagaaaccagtcctgatgactcttactttta

SEQ ID NO: 267 - DNA, 399 bp, Homo sapiens
cgggagagctaattctgaaagggaaagtggatcatgacacagccctgcttaagtcctctcgttgctctattgttttgaagataaaacccaaataccattgcataatacaaaagacccttcattacaggttctggttatgcctctggacctcatgttctgccacagaatgatttatggctttttacaccctcattgctgtytcttgctctactctatcagccaggttacctgcttcagttgttcaactacaagtaactctttaaaatccaagctcatatattgcctcctccagcaaagcattctcagtttcccatatctgtgttaggtgcatatcctgtatccctccatttcttcctccccttgcatctactcttgtgtccttttatacttttatatgtg

SEQ ID NO: 268 - DNA, 399 bp, Homo sapiens
atatagttaagtctccattcaatatgcatttcaaggtatatttaagcaatattcagaatgataccaggcgtaagaacaagcatatgaatatgttaaatatgcacttttctatttagacaaaaattgtaaaaaggaattatctacaaatttcctgatatagcaacagtttttaaagttcaaaagaatgtcgacacacattrtgtatagaagcaggcagaatatacatttttaaaaaacgagacaaccgtttcatgccaaagaaaaacaattcctttgccaaactacacattgttaacttaaaatgtgttccatgtggaaatacggagactgattttaaggaaagactagtgatcttaagtcagctggctccctgcctgtcaactatacgttttggcttct

SEQ ID NO: 269 - DNA, 399 bp, Homo sapiens
aaatgttctttgtaatctggcctctacaaacctctcctgcctcatttactccatttcccgactgtaggtccttcactccaggcacccagaactacatgtggatgtccaatgagccttgcccttatgcctctgtgttttaattccctctgcatgatatgtccttctcaaccttgtcaactcagcagactgattctggctamttcagacagttggtatttgtcctctgtactcaacaacagcctgtgcaaatttaacatttatcactctatttattaattaccaatcttattttcatctttcctactagagagtgaggtgcatgagagcagtgattgaatctcctgtgcccttagggttgaatgaccaacaatcgcatacttgggaataagaaaatgaata

SEQ ID NO: 270 - DNA, 399 bp, Homo sapiens
actaggtggcttaaacaacagaaatttatttctcacagttctggaggatgggaagttcaagataaaagtgcaaattgattttcttcctggtgagggctcttttcttcctggcttgcagatggccaccttctcactgtgacctcacatggcggagagcgacaaaaagagctctctcttcctcttctcgtaaagccactggygctatagaagtagagccccactcttataacctcatctaaacttaattacctcctaaaatcatgtctccaaatacagtcatattgggggagagggtctcaacatatgaatttgaggagccccaatccagtccataagatgcctgttctttgccctgaatctcactgctatagccaagggatgaaccaatatgaagacttc

SEQ ID NO: 271 - DNA, 399 bp, Homo sapiens
atttaaaatgtagtatacacatacactagaatattactgagccgtactaaggaaccaaattctgatacatgctacgttatggatgaactttgaagatatcatgctaagtgaaataagccagacacaaaaagacaaatattgtgtgattccacttatatgaggtacctagagtagtcaaattcatagagacggaaagtaarggagcagttaccaggggctgggggaagaggaaaataaggagttatgacttagtaattatggagtttcagtttgggaaaacgaaaaagttctgaagatggataatagtgatgtttgcacaacaatgtgaatatgcctaataccactgaattgtacacctaaaaattgttaaaatggcaaattttatattgtacattctac

SEQ ID NO: 272 - DNA, 399 bp, Homo sapiens
ctgagtagaatacaatccattgagtgaaaatgtctacatttatttatacctcatctaactgtaaacagacctgtgactaaaatcaaatggccagttcacaaaagaataatttagaaaaaattagaccattttaagtcattttattttcaagcaataccaaaatatcaaattgactcagttaaccatttattctggctacrtgatattaaaaagtttgactaaatttttcagagtttattaatattttcactgaatttccagatgttctgctttcccatattggtgtcactatatatctttattttctccttacactctgatttctatgtatagtttattgttgggagatagctgcagggcaggacagatattaaaactatatagcatctcataagatgt

SEQ ID NO: 273 - DNA, 399 bp, Homo sapiens
gatcttgttttgcccaaaagtccttaaaaattccagaaaaggtatcttgtcctttatactttgctttagaaacgtgtgttatagtcacaatttttccataatggaattttatttttcaaatagttcagataataataaagaacttgttttaaagaaatatccaagttttcacctctgtatctctatcatctgagtgggcwcactattttagtgagtctacttagttttcttgactaactactttttgatgttcaggaagagtttaaagtacataggaattataagccctttatagatttgatcaaatgcacatataagaccatctgagcctgtgtatatgtgagtgtgtccattttgtggaaagggactgctagtaaggtatataagtctttgactgtt

SEQ ID NO: 274 - DNA, 399 bp, Homo sapiens
atgcaatgttaaaatgggatcagtttgttccaaatgcagctgagagatcagaaaaacaaggactgaaatataccattgaacctggcaaggtgggagtctgcggtgatcttgtcaagagtagcatccaaagtagaggaaatgcaagcctgaccagacagttttgtggggagaagagaaggtaagtgaagacaagtcctgayagattttgttttaagacaaacagagaagtgaaactagatgataagaggagatttggagcaggtttctttttcttagctgagtgctgttagaacatgctgcattgttgcaattttataaaatcggtgagaaactgatgagacaggggagagaggagagtcaggcatgagtaccagaaacagggaggagccggtgcacaat

SEQ ID NO: 275 - DNA, 399 bp, Homo sapiens
ccattcttatttctaacattatttaattatacatatttttctttgatgagacttgccagaggattttccaactgcttagttttgcttctagttttgacttttttttgtctatttagtaaaagtttccagttttatgtaatgtctactttttacctgttttgtttcctctttcaaagtctttccttctcaaagggaaattktaaaatcacatgaaatcaaattataaatgatggaaaaccaaattataaaagtgaacagtatcccataatattaactttttaaaaatctcaagtgtaaattttttcaaaattagtaagtcgactttgtcacattgaatcatgttagccaattggtctgtgatcagtctatatggaggtgaccatatgatcttaaagagca

SEQ ID NO: 276 - DNA, 399 bp, Homo sapiens
tttcgtgagttgagaaaattgaaaaagatgtttgactgaggaaactttattaatagtggtggctaacactttcaaaacactgaccacatgccaaggagtagactaatgctctacgtgaattatttaatttaacttagacaaaaccatgaggaacacattgctatcaatcacatttggagatggaagaattgaagatctgsgaagttcagtaaactgcccaaagcagcacagccagtcaaatggaaaccatgatggaagcaaggtctattttcccccagagcaccacggtgtgcttcctctttccatttaaatcttgagggtcttgagtctgacaaaaacttccctccaacatttagtatttttaaaagtcagttctactgtatgataattaaaataata

SEQ ID NO: 277 - DNA, 399 bp, Homo sapiens
gaagtgagaaaatttagctttactgagcagaaagagaaacctggaaatactaagaatgcaaaatcctccccctgcctgacttccactccaatcattcatattatgttgcttcttaaattttctcagagcatagaattttgggttcaggtctatcttattctgctcttggggtgtaggaaggcctcaactgagatccagayaacattgtaattaaatatatgtttatcattacaaacaagatgagatagctacctaattgctgaccctaaaccctctaactggtagatgcagactggcagtcttttctaacaaagcatgaaattcaagtgtcagaagagacccaaagcttacctagttctgtctcccctttgatcctgaaattcctctaaaacttcccta

SEQ ID NO: 278 - DNA, 399 bp, Homo sapiens
atctggatagtttcagtctattgtatccagcttatcaaatccacagcctggtacttctggaacaaggctgccccagggatgacagttaaagatgaagatggcaaatataaggaattcaacatgtctgtgcagggcagtctgatgtctccatatgttctctaaaattccatattttgtcagagctgggagtgagagcaggrtgcttgcctgtttgggtcccactgctcctctgattctgctttgctgccttggaggagaacaggtttagatcctctagaggctggtggggccatgcccttggcagcttgctgggctaaccagtacttctatcttttgattttgggcctctcaaagtttaccagagacataggcaccctcacagtaccaagcccatttacc

SEQ ID NO: 279 - DNA, 399 bp, Homo sapiens
tgatccactcttctcagcctcccaaagtgctgggattacaggtgtgagccatcgtgtggatttcatgatccagtaaattaggtattcttcccagggtttcagcattcatgaattctaacatgctttcaagattttcatcctaacgggacaatgcaaatagggatgttttctagtaaggaatttttcaaattgatgctaayccgtatttttactgaccaaaaaaaagtaggaaaaataaagcttctagaatttagcaaatcacaaaggcattcccatgcgcaaggtggtcatctaaagactgcatagttgtaacattaggtagaattcaaatgcttcctagatgtaacctgatttagtttatgtcaactctttgtagcagactataaagatatcatcacc

SEQ ID NO: 280 - DNA, 399 bp, Homo sapiens
ctatatagacacacctattatgtgtctatataaacctataaacctatataaagttatacaagaaagagttcttgtatgccatttttttgattcaattatttataactgcccatatttgctagtaagttattctctttccctcaatagatgagagggtgggtgtatgtttctttgtaaaccattgagagcaagttgcagakgtagtgattttttttttcttttttttagatggagtctctctctgttgccaggctatagtacagtggcacaatcttggctcactgtagcctccaccttccggattcaagcaattctcctgcctcagcctcctgagtagctgggactacaggcgcgtgctgccacacccggctaatttttttgtatttttagtagagaggg

SEQ ID NO: 281 - DNA, 399 bp, Homo sapiens
gaacatttccccagactttatttgtcatatacaactttgacattttggaaagagtacaggccatggtgtttaaaaacgatagagagatgtatatgaaatgtaaatggctgtatatgggtatactctgcctttattcactgagaggtttacaagtaatggcacctccctagccatgtgcacacctgacatccagaacttgrtttctaaataccatttcccactaaaaggaatctgggttctctggagaaatggctgtttatggcactggagcttatattctgccagaagcaagaaaaaaataaaaaattattaaattatgcaagcaattatatattgtgagaggtgctataataaaatatagatgatatattaagggagagtccaacttttgttatggtg

SEQ ID NO: 282 - DNA, 399 bp, Homo sapiens
aaaataaattagaaagggtttgagaatggaagcagagagacctgataaaagacaatgatgaaagctcaggcaagaaataatggtggcctgcacaagggtggtggcagtagagataaaaatatgtggatgaattcagattacattttggactagtgttagattaaatgtgtgatgtggctgaggaaaaaggaaacttgaargaaaatgtccaggttagaatcttggcatcaagcttagagaagaaaagcaacacctccattttgttgattgagtgtgtttgaaacaagtttttgattggagtgtgttgatgggagtgtttgaaatgagttttagaaaccaaatgaaaatatattacatgaacaggaaaaatgtacaacaatttaaagttcctatgggata

SEQ ID NO: 283 - DNA, 399 bp, Homo sapiens
tccatctctctcagtctggggccatccttaaatctgcttctgttgcacgggccagggagaaggttgaagctctgcaacctgcccctagagacactcccaggaggatctggatacaccagggtgttccaagttaatattgtcagccagccagccagcatcttcttttctgcaggactataagtaaatgcattatcaagtarctgctaatatttagttacattttctttatacagagcaattcgtttgccatgagttggaaaatatatttatctatctaagacggtgtacttaattattttaattgtttgaaaactagtgcaatatatttcagaacctacatttttaggatcagacatatctaaggtatctaattcatcctgtccccaaactctatagcta

SEQ ID NO: 284 - DNA, 399 bp, Homo sapiens
tgttattcaggcattctaagaggcctactgaatggccttcaaaaggaaactaactacagaaagcaggtatatggatttgagtgttcaatgaaaatgctggcctattttttaaatgtgactactcataaaattaagatacaatggaattatttctatggttagtatttgtcattgactgtaacattactaagattataggyagatgaagtgaaatacaatagtctttaaaacaatcttgattttaaaaagccatgtcttcattttgtacccttcaaaaaattgccatattgtttcctttctagacattaaagatttctggggtcatggccaataaagcagatcttgcttatatgaagaaaatataaaatcatccagtttgctttacattatagatgaaga

SEQ ID NO: 285 - DNA, 399 bp, Homo sapiens
ttaaaaagccatgtcttcattttgtacccttcaaaaaattgccatattgtttcctttctagacattaaagatttctggggtcatggccaataaagcagatcttgcttatatgaagaaaatataaaatcatccagtttgctttacattatagatgaagatattgaagtacaaagagaggctaacccaaggacaaaaaagtrggtaatggcagaatagcactagaaatctcttctgagtttaactaatgaacataggtctctaatttttttgtgcatttatcagaacttagtaactgagtcacaaaggtaggatatatcagttatttgttctgttttgtcttagaccataagaacctagctttgagaaacattcccttctccatataatgttatactttct

SEQ ID NO: 286 - DNA, 399 bp, Homo sapiens
cattcattattctacccacatataatggaagccactacatttttttagaccgaaatttgaaaaatttaaaatatgaaaagtaaaatttaatcctagatcatacataacacacgaaagagttcaaagtttatttctgggtattattaattatgtaccagtttaggattttacaatctctgtaaatgttatttgtacaataktggttgaaaaatttaataaaatcatggcaactttaattaatttcagaaaattcaaaatagccaaatgtcatcaaacttcaactgtttgtttatatttaaaactaaaaatcattgaattttaattttttctcactccagaatgcaatattttatttttcttatctatttagaaacaaaagagtaaaagtagatagaaaaa

SEQ ID NO: 287 - DNA, 399 bp, Homo sapiens
catgtaaaatatacaatccaggagccagcacaaattatatgtgtagtataatgaatgatatagagaaagctactgataatcatgccactgatgaaatgataaaaaatataaagcagtggataatagagatcttaactgagataaaaaagaatgttaagaatcaaagcaggaactgataccatggctcaaaaataaatgcytgtgctacaaatactggggcaccatacaaaattgcaacaggtaaaagatgtctgccaagagcccttccacagacctctctccccagacactctgattcattctgagatgattcaaagccccaaatgtatggctctgactagatctatttttcctacgacagacctgtaacctagaattaactgctcctttctaatcaac

SEQ ID NO: 288 - DNA, 399 bp, Homo sapiens
atagaagcgattattgataaaaagaacagaaagttaggcactgaatcctatcttgagggtaaaaagcaataatttctctcaaagtatcataagtttataattggtctttaacaatggtgtgtaaatgcaacaaccacaactaaggaatatgctcttggaaagaaggacatcatcaataattcctattaatggtacagaamcacataagtcaaaatatcatactttcacatggaatacttggattccactaaacttgagcatcttttacaaacccattggtaaaaatcatgccactgagaatggtgaaagtctggacatcataccactgagacagagcctgaaaattagatctgtcacatccatcattctgacatctagcctgggttgtctaactctaga

SEQ ID NO: 289 - DNA, 399 bp, Homo sapiens
tcttgagggtaaaaagcaataatttctctcaaagtatcataagtttataattggtctttaacaatggtgtgtaaatgcaacaaccacaactaaggaatatgctcttggaaagaaggacatcatcaataattcctattaatggtacagaaacacataagtcaaaatatcatactttcacatggaatacttggattccactraacttgagcatcttttacaaacccattggtaaaaatcatgccactgagaatggtgaaagtctggacatcataccactgagacagagcctgaaaattagatctgtcacatccatcattctgacatctagcctgggttgtctaactctagatacatctactcttcttcagaaccaaatagtcaaagtcagctgactttggc

SEQ ID NO: 290 - DNA, 399 bp, Homo sapiens
ttttagttgttacaattcctgtgctgactgctctgggattgtaaaggtaaactgttagagataggaccacaattgcctgaaaggtgaaagcttgcaggaaaaatagggtgggtcatttagttcttgaaatgaaggagggtgcagattaggaatcattatggcttgccagaagttgctggtcatagaagtctgtttaagtrctcactgtcaacaaggaaatcatgggcagcacttgaagtggctcacctctgatttattcataaaccttacacgagcacttggctttgttcttactctagtaaggcggtctgatgccaataagaacaggaataaagagctccttgcatggtccaagactgaatagcactttacctcaaagcctgacctcttttctagaag

SEQ ID NO: 291 - DNA, 399 bp, Homo sapiens
cgatgtgactggaacttgggttctaacataacctaaaggttgccatgtttatgctaaatgttaaggctctccttttgagagagcttaaaagtttcacatttaatcatagtttggaaggaaactattgcctctttctaattgaagaatacaatgatctcaaagtggaattgtttttgataatcccttccccgactaaagtkaatgtaaagagatttagtaacataggaaatgaagggtttgagaataaaataggtgctaccctgtgataaagacaagcaaatcggttggcctgccaattggtaagccatattttctgagaagcttcatttgtgccacttcacaaattatgctctgctgcagatgcccatgttgaacggaagggacctttaagagacagtc

SEQ ID NO: 292 - DNA, 399 bp, Homo sapiens
gacacttgtatttggtagagtctaagagtattatatagtaagatgcacttggtagtgatttaaagaatttatgcatataactttcttgagtgaaactatttgaaatcatataaaattattgaaatcattgctcaagaaataggaatgtttgctggtgtacttgacttgtgattgattttatgtagataattatggtaggwttagcctgcaagaaatgattttttaaaaatatgtacctacgctattatacttagttatagtggttatgagatcatattggtagcaattgtgaaatagaaataattatacaattgttttttctttgaaatatttggttgtcagtagttcaataatcaatttcatatatgaatagacaaaggagaaaaaatatagacgcat

SEQ ID NO: 293 - DNA, 399 bp, Homo sapiens
gggttaggtagggcagtgccccttcttaagagctttcttcatttactcctgaacacacacacacacacacgaccaccaccaccaccgccacgtaccaccaccaccaccacaacaacaacacaccacacctcagaaacagagtcaatttggcacccccattcatgtcaactcctactttatgatttacattacattttttkgtgtaacttgtgttcattctatttcatgtgaagtgcaggtatgatttaatcaaaagagctaaattgctcatttatcacccaccctgaggtcatttaggtaatgcagacaaaggtgttctctcataattaatgtgctctccctgtgtgtttctgtggcttaaatgtaatagtccccgtcattggagcttgtttaaaattg

SEQ ID NO: 294 - DNA, 399 bp, Homo sapiens
atgtttgcaaaatccttgttttacctaacttctctcttgaattctacatcccccattttcatatggatgactcataagatctttatccctctctgtctgtgtgtctcatatctgtaagtctcactgatgttctgctctttagcttcttcatggatcatccagctactcctactgacttctagcagaacatcttctctccratttgctgagccttccacctggcatttttgttcttaaccaatcaattgccaaactttataattttgtatttaatatcttttcttaattatgccttttaaaaagtttttatattattgttttatttgtatttgtagtttttttgttgacaagatctcgctgtcctcaggccagagtgcagtggcacgatcacaactgact

SEQ ID NO: 295 - DNA, 399 bp, Homo sapiens
agatggaggtagtagttccaggaagaagtaaataggagatagtgaaagtagggggaaagagaaagatgagggcaacattagaataagcaaacacttaacaactaattagatgcctggagcagggaagagaaataaatctgagggggcacccatgtgtctgtcttgtatcatcaacagtaatgtgaaggcacagaggagcmgatgcaggactaaaaggacggatgatgaactcattatagacttggaggtttgaagaaaagaaggaggccccagaaggagataatttggggttgttagacatgcagtataggtttggagagaaaggtcattgttaggaatcttaatttatgagtgatctgcatccaggatattaactaaacaaagagagaaaatgaaata

SEQ ID NO: 296 - DNA, 399 bp, Homo sapiens
ttgcttttaaatgaagctgtctatcaaagtacaaagcatctgtataacctgtcaaattaattttctctgtaagcttatactcaagtcaggagtcagcttctggttactacccagtggttgtagaaaactaaggaaggaatgtaagaaagatgtgaactcatttgataaaccaaatgatatcagtagggaaaaattcttgyaataaggatgatgttttaataacctatgccatatcttttataagtcccttgctaatgctttttggtttagcagtttttattcattagaatggaaatttttattctaatttctttttagcagttggctcttatctagccttctcaagctctcttttggctaaatgccaaacaattctaaagacatgtagaactaaacatt

SEQ ID NO: 297 - DNA, 399 bp, Homo sapiens
agggcttataatcatggttgcaattttgtcatggcctcacgaaatggcatcattttcaaggatgtacataaatgatagtgtgaatcttataaagataattattactaagaacatcactttaacctggatcatcttccacagagtgctggaaaagggagaaaggcagtcttttatcaaaggcatgttttaatgaaagctcrtctgactttggagatgaacagcacttgacgtgttgttgcatgatgcgtttaaaataaaaataattttgctcggttgctttctgattttgtttctcctgaatattggtccttcatgatgcttccaaccatattttaattattaaaactgaaatgctaaccatttgaacatacacttttgaagaataacaaactccagtgt

SEQ ID NO: 298 - DNA, 399 bp, Homo sapiens
accccctcatttactccttctgaaggatgaaggaacttctctggctggtggatctggaacaactaggcatgcctagctctgtccttccttttttccttctctttaggatgtgcttgtctgaagatagcaagcactttggtctgtaaatgtgaatagcttcttatagagtttgaagttcacaatctgcccaacgagacacrgcgactctgggttcagaagttggggaaaggggtgtcaaattctggacacatccaaaactcagcattggtttggaacaactaaaagaccatgctttgtaaagcaaagatgttcctcaaaatttagtctaagaaaaagttctaaaacataatgtgactagctctaacattagatcttatttctaaaattcaaagacattag

(19) United States
(12) Patent Application Publication
(10) Pub. No.: US 2012/0122698 A1
(43) Pub. Date: May 17, 2012

(54) Genetic Variants Predictive of Cancer Risk in Humans

(75) Inventors: Simon Stacey, Kopavogur (IS); Patrick Sulem, Reykjavik (IS)

(73) Assignee: deCODE Genetics ehf., Reykjavik (IS)

(21) Appl. No.: 13/002,605

(22) PCT Filed: Jul. 3, 2009
(86) PCT No.: PCT/IS2009/000006

§ 371 Date: Jan. 4, 2011

(30) Foreign Application Priority Data
Jul. 7, 2008 (IS) 8745

(51) Int. Cl. C40B 20/00; G06F 19/00

(52) U.S. Cl. 506/2; 702/19

(57) ABSTRACT

The present invention discloses genetic variants that have been found to be predictive of risk of particular forms of cancer, in particular basal cell carcinoma and cutaneous melanoma. The invention provides methods of predicting risk of developing such cancers, and other methods pertaining to risk management of cancer utilizing such risk variants. The invention furthermore provides kits and computer systems for use in such methods.

Melanoma. Cutaneous Melanoma (CM) was once a rare cancer but has over the past 40 years shown rapidly increasing incidence rates. In the U.S.A. and Canada, CM incidence has increased at a faster rate than any other cancer except bronchogenic carcinoma in women. Until recently incidence rates increased at 5-7% a year, doubling the population risk every 10-15 years.

The current worldwide incidence is in excess of 130,000 new cases diagnosed each year [Parkin, et al., (2001), Int J Cancer, 94, 153-6.]. The incidence is highest in developed countries, particularly where fair-skinned people live in sunny areas. The highest incidence rates occur in Australia and New Zealand with approximately 36 cases per 100,000 per year. The U.S.A. has the second highest worldwide incidence rates with about 11 cases per 100,000. In Northern Europe rates of approximately 9-12 per 100,000 are typically observed, with the highest rates in the Nordic countries. Currently in the U.S.A., CM is the sixth most commonly diagnosed cancer (excluding non-melanoma skin cancers). In the year 2008 it is estimated that 62,480 new cases of invasive CM will have been diagnosed in the U.S.A. and 8,420 people will have died from metastatic melanoma. A further 54,020 cases of in-situ CM are expected to be diagnosed during the year.

Deaths from CM have also been on the increase although at lower rates than incidence. However, the death rate from CM continues to rise faster than for most cancers, except non-Hodgkin's lymphoma, testicular cancer and lung cancer in women [Lens and Dawes, (2004), Br J Dermatol, 150, 179-85.]. When identified early, CM is highly treatable by surgical excision, with 5 year survival rates over 90%. However, malignant melanoma has an exceptional ability to metastasize to almost every organ system in the body. Once it has done so, the prognosis is very poor. Median survival for disseminated (stage IV) disease is 7½ months, with no improvements in this figure for the past 22 years. Clearly, early detection is of paramount importance in melanoma control.

CM shows environmental and endogenous host risk factors, the latter including genetic factors. These factors interact with each other in complex ways. The major environmental risk factor is UV irradiation. Intense episodic exposures rather than total dose represent the major risk [Markovic, et al., (2007), Mayo Clin Proc, 82, 364-80].

It has long been recognized that pigmentation characteristics such as light or red hair, blue eyes, fair skin and a tendency to freckle predispose for CM, with relative risks typically 1.5-2.5. Numbers of nevi represent strong risk factors for CM. Relative risks as high as 46-fold have been reported for individuals with >50 nevi. Dysplastic or clinically atypical nevi are also important risk factors with odds ratios that can exceed 30-fold [Xu and Koo, (2006), Int J Dermatol, 45, 1275-83].

Basal Cell Carcinoma and Squamous Cell Carcinoma. Cutaneous basal cell carcinoma (BCC) is the most common cancer amongst whites and incidence rates show an increasing trend. The average lifetime risk for Caucasians to develop BCC is approximately 30% [Roewert-Huber, et al., (2007), Br J Dermatol, 157 Suppl 2, 47-51]. Although it is rarely invasive, BCC can cause considerable morbidity and 40-50% of patients will develop new primary lesions within 5 years [Lear, et al., (2005), Clin Exp Dermatol, 30, 49-55]. Indices of exposure to ultraviolet (UV) light are strongly associated with risk of BCC [Xu and Koo, (2006), Int J Dermatol, 45, 1275-83]. In particular, chronic sun exposure (rather than intense episodic sun exposures as in melanoma) appears to be the major risk factor [Roewert-Huber, et al., (2007), Br J Dermatol, 157 Suppl 2, 47-51]. Squamous cell carcinoma of the skin (SCC) shares these risk factors, as well as several genetic risk factors with BCC [Xu and Koo, (2006), Int J Dermatol, 45, 1275-83; Bastiaens, et al., (2001), Am J Hum Genet, 68, 884-94; Han, et al., (2006), Int J Epidemiol, 35, 1514-21]. Photochemotherapy for skin conditions such as psoriasis with psoralen and UV irradiation (PUVA) have been associated with increased risk of SCC and BCC. Immunosuppressive treatments increase the incidence of both SCC and BCC, with the incidence rate of BCC in transplant recipients being up to 100 times the population risk [Hartevelt, et al., (1990), Transplantation, 49, 506-9; Lindelof, et al., (2000), Br J Dermatol, 143, 513-9]. BCC's may be particularly aggressive in immunosuppressed individuals.

Genetic risk is conferred by subtle differences in the genome among individuals in a population. Variations in the human genome are most frequently due to single nucleotide polymorphisms (SNP), although other variations are also important. SNPs are located on average every 1000 base pairs in the human genome. Accordingly, a typical human gene containing 250,000 base pairs may contain 250 different SNPs. Only a minor number of SNPs are located in exons and alter the amino acid sequence of the protein encoded by the gene. Most SNPs may have little or no effect on gene function, while others may alter transcription, splicing, translation, or stability of the mRNA encoded by the gene. Additional genetic polymorphisms in the human genome are caused by insertions, deletions, translocations, or inversion of either short or long stretches of DNA. Genetic polymorphisms conferring disease risk may directly alter the amino acid sequence of proteins, may increase the amount of protein produced from the gene, or may decrease the amount of protein produced by the gene.

As genetic polymorphisms conferring risk of cancer, in particular CM, SCC and BCC, are uncovered, genetic testing for such risk factors is becoming increasingly important for clinical medicine. Current examples of clinically important variants include apolipoprotein E testing to identify genetic carriers of the apoE4 polymorphism in dementia patients for the differential diagnosis of Alzheimer's disease, and of Factor V Leiden testing for predisposition to deep venous thrombosis. More importantly, in the treatment of cancer, diagnosis of genetic variants in tumor cells is used for the selection of the most appropriate treatment regime for the individual patient. In breast cancer, genetic variation in estrogen receptor expression or heregulin type 2 (Her2) receptor tyrosine kinase expression determine if anti-estrogenic drugs (tamoxifen) or anti-Her2 antibody (Herceptin) will be incorporated into the treatment plan. In chronic myeloid leukemia (CML) diagnosis of the Philadelphia chromosome genetic translocation fusing the genes encoding the Bcr and Abl receptor tyrosine kinases indicates that Gleevec (STI571), a specific inhibitor of the Bcr-Abl kinase should be used for treatment of the cancer. For CML patients with such a genetic alteration, inhibition of the Bcr-Abl kinase leads to rapid elimination of the tumor cells and remission from leukemia. Furthermore, genetic testing services are now available, providing individuals with information about their disease risk based on the discovery that certain SNPs have been associated with risk of many of the common diseases.

There is an unmet clinical need to identify individuals who are at increased risk of melanoma. Such individuals might be offered regular skin examinations to identify incipient tumours, and they might be counseled to avoid excessive UV exposure. Chemoprevention either using sunscreens or pharmaceutical agents [Bowden, (2004), Nat Rev Cancer, 4, 23-35.] might be employed. For individuals who have been diagnosed with melanoma, knowledge of the underlying genetic predisposition may be useful in determining appropriate treatments and evaluating risks of recurrence and new primary tumours.

There is also an unmet clinical need to identify individuals who are at increased risk of BCC and/or SCC. Such individuals might be offered regular skin examinations to identify incipient tumours, and they might be counseled to avoid excessive UV exposure. Chemoprevention either using sunscreens or pharmaceutical agents [Bowden, (2004), Nat Rev Cancer, 4, 23-35.] might, be employed. For individuals who have been diagnosed with BCC or SCC, knowledge of the underlying genetic predisposition may be useful in determining appropriate treatments and evaluating risks of recurrence and new primary tumours. Screening for susceptibility to BCC or SCC might be important in planning the clinical management of transplant recipients and other immunosuppressed individuals.

### SUMMARY OF THE INVENTION

The present inventors have discovered that certain genetic variants are associated with risk of cancer, in particular cutaneous melanoma (CM), basal cell carcinoma (BCC) and squamous cell carcinoma (SCC). Certain genetic markers have been found to be predictive of risk of developing these cancers, and are thus useful in methods for determining whether particular individuals are at, risk of developing these cancers. Determination of the presence of a risk allele of such markers in a nucleic acid sequence of an individual is thus indicative of the individual being at risk of developing one or more of these cancers.

In a first aspect, the invention relates to a method for determining a susceptibility to a cancer selected from Cutaneous Melanoma (CM), Basal Cell Carcinoma (BCC) and Squamous Cell Carcinoma (SCC) in a human subject, comprising

determining whether at least one allele of at least one polymorphic marker is present in a nucleic acid sample obtained from the individual or in a genotype dataset derived from the individual,
wherein the at least one polymorphic marker is selected from the polymorphic markers set forth in any one of Table 1, Table 2, Table 3, and Table 4, and markers in linkage disequilibrium therewith, and
wherein determination of the presence of the at least one allele is indicative of a susceptibility to the cancer for the subject.

The nucleic acid sample can be any sample that contains nucleic acid from an individual, including a blood sample, a saliva sample, a buccal swab, a biopsy sample or other sample that contains nucleic acids, in particular genomic nucleic acid, as described further herein.

In certain embodiments, the cancer is basal cell carcinoma, and the at least one marker is selected from the group consisting of rs7538876, rs801114, and markers in linkage disequilibrium therewith. In certain embodiments, the at least one marker may further include rs10504624, and markers in linkage disequlibrium therewith.

In certain embodiments, the cancer is cutaneus melanoma. In one embodiment, the at least one marker is selected from the group consisting of rs4151060, rs7812812 and rs9585777, and markers in linkage disequilibrium therewith.

In another aspect, the invention relates to a method of determining a susceptibility to at least one cancer selected from Cutaneous Melanoma (CM), Basal Cell Carcinoma (BCC) and Squamous Cell Carcinoma (SCC) in a human individual, the method comprising:

obtaining nucleic acid sequence data about a human individual identifying at least one allele of at least one polymorphic marker selected from the markers set forth in any one of Table 1, Table 2, Table 3 and Table 4, and markers in linkage disequilibrium therewith, wherein different alleles of the at least one polymorphic marker are associated with different susceptibilities to the cancer in humans, and
determining a susceptibility to the cancer from the nucleic acid sequence data.

Certain embodiments relate to basal cell carcinoma, wherein the at least one marker is selected from the group consisting of rs7538876, rs801114, and markers in linkage disequilibrium therewith. In certain embodiments, the at least one marker may further include rs10504624, and markers in linkage disequlibrium therewith. Certain preferred embodiments relate to rs7538876. Certain other preferred embodiments relate to rs801114. Yet other preferred embodiments relate to rs10504624.

Certain other embodiments relate to cutaneous melanoma, wherein the at least one marker is selected from the group consisting of rs4151060, rs7812812 and rs9585777, and markers in linkage disequilibrium therewith. Preferred embodiments relate to any one of rs4151060, rs7812812 and rs9585777, or any combinations thereof.

The invention also relates to a method of determining a susceptibility to basal cell carcinoma in a human subject, wherein sequence data about at least one marker associated with the human RCC2 gene is obtained, and wherein different alleles of the at least one marker are associated with different susceptibilities to basal cell carcinoma in humans. Preferably, the at least one marker is selected from the group consisting of rs7538876, and markers in linkage disequilibrium therewith.

Another aspect relates to a method of determining a susceptibility to basal cell carcinoma in a human subject, wherein sequence data about at least one marker within the 1p36 LD block is obtained, and wherein different alleles of the at least one marker are associated with different susceptibilities to basal cell carcinoma in humans. Preferably, the at least one marker is selected from the group consisting of rs7538876, and markers in linkage disequilibrium therewith.

Another aspect relates to a method of determining a susceptibility to basal cell carcinoma in a human subject, wherein sequence data about at least one marker within the 1q42 LD block is obtained, and wherein different alleles of the at least one marker are associated with different susceptibilities to basal cell carcinoma in humans. Preferably, the at least one marker is selected from the group consisting of rs801114, and markers in linkage disequilibrium therewith.

In general, nucleic acid sequence data refers to a sequential string of nucleotides in the genome of the individual or subject. The nucleic acid sequence data is sequence data that provides information about the identity of at least one nucleotide at a particular position in the genome of the individual or subject. Thus, the sequence data relates to one or more nucleotides of the genome of the individual or subject.

In a general sense, genetic markers lead to alternate sequences at the nucleic acid level. If the nucleic acid marker changes the codon of a polypeptide encoded by the nucleic acid, then the marker will also result in alternate sequence at the amino acid level of the encoded polypeptide (polypeptide markers). Determination of the identity of particular alleles at polymorphic markers in a nucleic acid or particular alleles at polypeptide markers comprises whether particular alleles are present at a certain position in the sequence. Sequence data identifying a particular allele at a marker comprises sufficient sequence to detect the particular allele. For single nucleotide polymorphisms (SNPs) or amino acid polymorphisms described herein, sequence data can comprise sequence at a single position, i.e. the identity of a nucleotide or amino acid at a single position within a sequence.

In certain embodiments, it may be useful to determine the nucleic acid sequence for at least two polymorphic markers. In other embodiments, the nucleic acid sequence for at least three, at least four or at least five or more polymorphic markers is determined. Haplotype information can be derived from an analysis of two or more polymorphic markers. Thus, in certain embodiments, a further step is performed, whereby haplotype information is derived based on sequence data for at least two polymorphic markers.

The invention also provides a method of determining a susceptibility to at least one cancer selected from CM, BCC and SCC in a human individual, the method comprising obtaining nucleic acid sequence data about a human individual identifying both alleles of at least two polymorphic markers in the individual, determine the identity of at least one haplotype based on the sequence data, and determining a susceptibility to at least one cancer from the haplotype data.

In certain embodiments, determination of a susceptibility comprises comparing the nucleic acid sequence data to a database containing correlation data between polymorphic markers and susceptibility to the at least one cancer. In some embodiments, the database comprises at least one risk measure of susceptibility to the at least one cancer for the polymorphic markers of the invention, as described in more detail herein. The sequence database can for example be provided as a look-up table that contains data that indicates the susceptibility of the cancer (e.g., CM, BCC and/or SCC) for any one, or a plurality of, particular polymorphisms. The database may also contain data that indicates the susceptibility for a particular haplotype that comprises at least two polymorphic markers.

Obtaining nucleic acid sequence data can in certain embodiments comprise obtaining a biological sample from the human individual and analyzing sequence of the at least one polymorphic marker in nucleic acid in the sample. Analyzing sequence can comprise determining the presence or absence of at least one allele of the at least one polymorphic marker. Determination of the presence of a particular susceptibility allele (e.g., an at-risk allele) is indicative of susceptibility to the cancer in the human individual. Determination of the absence of a particular susceptibility allele is indicative that the particular susceptibility is not present in the individual.

In some embodiments, obtaining nucleic acid sequence data comprises obtaining nucleic acid sequence information from a preexisting record. The preexisting record can for example be a computer file or database containing sequence data, such as genotype data, for the human individual, for at least one polymorphic marker.

Susceptibility determined by the diagnostic methods of the invention can be reported to a particular entity. In some embodiments, the at least one entity is selected from the group consisting of the individual, a guardian of the individual, a genetic service provider, a physician, a medical organization, and a medical insurer.

In certain embodiments, the cancer is cutaneous melanoma, an wherein the at least one polymorphic marker is selected from the markers set forth in Table 1 and Table 2.

In certain other embodiments, the cancer is Squamous Cell Carcinoma, and wherein the at least one polymorphic marker is selected from the markers set forth in Table 4.

In yet other embodiments, the cancer is Cutaneous Basal Cell Carcinoma, and wherein the at least one marker is selected from the markers set forth in Table 3, and markers in linkage disequilibrium therewith. In certain such embodiments, the at least one marker is selected from rs7538876, rs801114, rs801119 and rs241337, and markers in linkage disequilibrium therewith. In particular, the at least one marker is in certain embodiments selected from rs7538876 and rs801114, and markers in linkage disequilibrium therewith. In certain embodiments, the marker is selected from the markers set forth in Table 6 and Table 7.

In certain embodiments of the invention, markers in linkage disequilibrium with rs7538876 are selected from the group consisting of the markers listed in Table 6.

In certain embodiments of the invention, markers in linkage disequilibrium with rs801114 are selected from the group consisting of the markers listed in Table 7.

In certain embodiments of the invention, markers in linkage disequilibrium with rs4151060 are selected from the group consisting of the markers listed in Table 14.

In certain embodiments of the invention, markers in linkage disequilibrium with rs7812812 are selected from the group consisting of the markers listed in Table 15.

In certain embodiments of the invention, markers in linkage disequilibrium with rs9585777 are selected from the group consisting of the markers listed in Table 16.

In certain embodiments of the invention, markers in linkage disequilibrium with rs10504624 are selected from the group consisting of the markers listed in Table 17.

In certain embodiments, at least two polymorphic markers are assessed. In such embodiments, a further step comprising assessing the frequency of at least one haplotype in the subject is contemplated.

In certain embodiments, the susceptibility conferred by the presence of the at least one allele or haplotype is increased susceptibility. In certain such embodiments, the presence of allele A in marker rs7538876, allele A in rs10504624 and/or allele G in marker rs801114 is indicative of increased susceptibility to basal cell carcinoma in the subject. In certain embodiments, determination of the presence of allele G of rs4151060, allele G of rs7812812 and/or allele A of rs9585777 is indicative of increased risk of cutaneous melanoma in the subject. In certain embodiments, the presence of the at least one allele or haplotype is indicative of increased susceptibility to cancer with a relative risk (RR) or odds ratio (OR) of at least 1.25. In certain other embodiments, the RR or OR is at least 1.20, at least 1.30, at least 1.35, at least 1.40, at least 1.50, at least 1.60, at least 1.70, at least 1.80, at least 1.90 or at least 2.0 or greater. Other numerical values of the OR bridging any of the above mentioned values are also contemplated, and within scope of the invention.

In certain other embodiments, the susceptibility conferred by the presence of the at least one allele or haplotype is decreased susceptibility.

The genetic risk variants described herein can be combined with other risk variants for the cancer to establish an overall risk of cancer, including cutaneous melanoma, basal cell carcinoma and squamous cell carcinoma. Thus in certain embodiments, a further step is contemplated, comprising analyzing non-genetic information to make risk assessment, diagnosis, or prognosis of the subject. The non-genetic information can be any such information that confers risk of developing the cancer, or is believed to increase the risk of an individual develops the cancer. In certain embodiments, the non-genetic information is selected from age, age at onset of the cancer, age at diagnosis, gender, ethnicity, socioeconomic status, previous disease diagnosis, medical history of subject, exposure to sunlight and/or ultraviolet light, family history of the cancer, biochemical measurements, and clinical measurements.

In certain embodiments, determination of the presence of allele A in rs7538876, or an allele in linkage disequilibrium therewith, is indicative of susceptibility to basal cell carcinoma with an early onset in the subject. In other embodiments, determination of the presence of allele A in rs7538876, or an allele in linkage disequilibrium therewith, is indicative of susceptibility to basal cell carcinoma with an early age at diagnosis in the subject.

The variants described herein may also be suitably combined with other genetic risk variants for one or more cancer selected from CM, BCC and SCC to establish overall risk. In one such embodiment, the method of the invention comprises obtaining nucleic acid sequence data about a human individual for at least one additional genetic susceptibility variant for the at least one cancer. In certain embodiments, the at least one additional genetic susceptibility variant is a variant associated with one or more of the ASIP, TYR and MC1R genes. In one particular embodiment, the at least one additional genetic susceptibility variant associated with the ASIP gene is selected from rs1015362 and rs4911414. In another particular embodiment, the at least one additional genetic susceptibility variant associated with the ASIP gene is the haplotype comprising allele G of rs1015362 and allele T of rs4911414.

In one embodiment, the at least one additional genetic susceptibility variant associated with the TYR gene is a variant encoding the R402Q variant. In another embodiment, the at least one additional genetic susceptibility variant associated with the MC1R gene is selected from variants encoding the D84E variant, the R151C variant, the R160W variant, and the D294H variant. The skilled person will appreciate that any combination of these risk variants are possible and useful for establishing overall risk of cancer, and such combinations are also contemplated.

The skilled person will also appreciate that any other genetic risk variant for a cancer selected from CM, BCC and SCC can be combined with the variants described herein to establish overall risk of the cancer, and any such combinations are also contemplated and within scope of the present invention.

The present invention also provides kits. In one aspect, the invention provides a kit for assessing susceptibility to a cancer selected from cutaneous melanoma (CM), basal cell carcinoma (BCC) and squamous cell carcinoma (SCC) in a human individual, the kit comprising reagents for selectively detecting at least one allele of at least one polymorphic marker in the genome of the individual, wherein the polymorphic marker is selected from the markers set forth in Tables 1-4, and markers in linkage disequilibrium therewith, and wherein the presence of the at least one allele is indicative of a susceptibility to the cancer.

In another aspect, the invention provides a kit for assessing susceptibility to basal cell carcinoma (BCC) in a human individual, the kit comprising (i) reagents for selectively detecting at least one allele of at least one polymorphic marker in the genome of the individual, wherein the polymorphic marker is selected from the group consisting of rs7538876, rs801114 and rs10504624, and markers in linkage disequilibrium therewith, and (ii) a collection of data comprising correlation data between the at least one polymorphism and susceptibility to basal cell carcinoma. The invention further provides a kit for assessing susceptibility to cutaneous melanoma (CM) in a human individual, wherein the polymorphic marker is selected from the group consisting of rs4151060, rs7812812 and rs9585777, and markers in linkage disequilibrium therewith.

In certain embodiments, the reagents comprise at least one contiguous oligonucleotide that hybridizes to a fragment of the genome of the individual comprising the at least one polymorphic marker, a buffer and a detectable label. In other embodiments, the reagents comprise at least one pair of oligonucleotides that hybridize to opposite strands of a genomic nucleic acid segment obtained from the subject, wherein each oligonucleotide primer pair is designed to selectively amplify a fragment of the genome of the individual that includes one polymorphic marker, and wherein the fragment is at least 30 base pairs in size. Preferably, the at least one oligonucleotide is completely complementary to the genome of the individual. In a preferred embodiment, the kit comprises:

a. a detection oligonucleotide probe that is from 5-100 nucleotides in length;
b. an enhancer oligonucleotide probe that is from 5-100 nucleotides in length; and
c. an endonuclease enzyme;
wherein the detection oligonucleotide probe specifically hybridizes to a first segment of a nucleic acid comprising the at least one polymorphic marker, and
wherein the detection oligonucleotide probe comprises a detectable label at its 3′ terminus and a quenching moiety at its 5′ terminus;
wherein the enhancer oligonucleotide is from 5-100 nucleotides in length and is complementary to a second segment of the nucleotide sequence that is 5′ relative to the oligonucleotide probe, such that the enhancer oligonucleotide is located 3′ relative to the detection oligonucleotide probe when both oligonucleotides are hybridized to the nucleic acid;
wherein a single base gap exists between the first segment and the second segment, such that when the oligonucleotide probe and the enhancer oligonucleotide probe are both hybridized to the nucleic acid, a single base gap exists between the oligonucleotides; and
wherein treating the nucleic acid with the endonuclease will cleave the detectable label from the 3′ terminus of the detection probe to release free detectable label when the detection probe is hybridized to the nucleic acid.

The invention also provides a method of genotyping a nucleic acid sample obtained from a human individual at risk for, or diagnosed with, basal cell carcinoma, comprising determining the presence or absence of at least one allele of at least one polymorphic marker in the sample, wherein the at least one marker is selected from the group consisting of the markers set forth in Table 3, and markers in linkage disequilibrium therewith, and wherein the presence or absence of the at least one allele of the at least one polymorphic marker is indicative of a susceptibility of basal cell carcinoma in the individual.

In one embodiment, genotyping comprises amplifying a segment of a nucleic acid that comprises the at least one polymorphic marker by Polymerase Chain Reaction (PCR), using a nucleotide primer pair flanking the at least one polymorphic marker. In preferred embodiments, genotyping is performed using a process selected from allele-specific probe hybridization, allele-specific primer extension, allele-specific amplification, nucleic acid sequencing, 5′-exonuclease digestion, molecular beacon assay, oligonucleotide ligation assay, size analysis, and single-stranded conformation analysis.

The invention also provides a method of assessing an individual for probability of response to a basal cell carcinoma therapeutic agent, comprising: determining the presence or absence of at least one allele of at least one polymorphic marker in a nucleic acid sample obtained from the individual, wherein the at least one polymorphic marker is selected from the markers rs7538876 and rs801114, and markers in linkage disequilibrium therewith, wherein determination of the presence of the at least one allele of the at least one marker is indicative of a probability of a positive response to the therapeutic agent.

Also provided is a method of predicting prognosis of an individual diagnosed with basal cell carcinoma, the method comprising determining the presence or absence of at least one allele of at least one polymorphic marker in a nucleic acid sample obtained from the individual, wherein the at least one polymorphic marker is selected from the group consisting of the markers rs7538876 and rs801114, and markers in linkage disequilibrium therewith, wherein determination of the presence of the at least one allele is indicative of prognosis of the basal cell carcinoma in the individual.

Additionally, the invention provides a method of monitoring progress of treatment of an individual undergoing treatment for basal cell carcinoma, the method comprising determining the presence or absence of at least one allele of at least one polymorphic marker in a nucleic acid sample obtained from the individual, wherein the at least one polymorphic marker is selected from the markers rs10504624, rs7538876 and rs801114, and markers in linkage disequilibrium therewith, wherein determination of the presence of the at least one allele is indicative of the treatment outcome of the individual.

The invention also provides use of an oligonucleotide probe in the manufacture of a reagent for diagnosing and/or assessing susceptibility to basal cell carcinoma in a human individual, wherein the probe hybridizes to a segment of a nucleic acid as set forth in SEQ ID NO:1 or SEQ ID NO:2 herein, optionally comprising at least one of the polymorphic markers set forth in Tables 6 and 7, and wherein the probe is 15-500 nucleotides in length.

The invention also provides computer-implemented aspects. In one such aspects, the invention provides a computer-readable medium having computer executable instructions for determining susceptibility to at least one cancer selected from basal cell carcinoma, squamous cell carcinoma and cutaneous melanoma in an individual, the computer readable medium comprising:

data representing at least one polymorphic marker; and
a routine stored on the computer readable medium and adapted to be executed by a processor to determine susceptibility to the at least one cancer in an individual based on the allelic status of at least one allele of said at least one polymorphic marker in the individual.

In certain embodiments, the cancer is basal cell carcinoma and the at least one polymorphic marker is selected from the group consisting of rs7538876, rs801114 and rs10504624 and markers in linkage disequilibrium therewith. In certain other embodiments, the cancer is cutaneous melanoma, and the at least one polymorphic marker is selected from the group consisting of rs4151060, rs7812812 and rs9585777 and markers in linkage disequilibrium therewith.

In one embodiment, said data representing at least one polymorphic marker comprises at least one parameter indicative of the susceptibility to the at least one cancer linked to said at least one polymorphic marker. In another embodiment, said data represents at least one polymorphic marker comprises data indicative of the allelic status of at least one allele of said at least one allelic marker in said individual. In another embodiment, said routine is adapted to receive input data indicative of the allelic status for at least one allele of said at least one allelic marker in said individual. In a preferred embodiment, the cancer is basal cell carcinoma, and wherein said at least one polymorphic marker is selected from the markers rs7538876 and rs801114, and markers in linkage disequilibrium therewith. In another preferred embodiment, the at least one polymorphic marker is selected from the markers set forth in Tables 6 and 7.

The invention further provides an apparatus for determining a genetic indicator for at least one cancer selected from basal cell carcinoma, squamous cell carcinoma and cutaneous melanoma in a human individual, comprising:

a processor,
a computer readable memory having computer executable instructions adapted to be executed on the processor to analyze marker and/or haplotype information for at least one human individual with respect to at least one polymorphic marker associated with the at least one cancer, and
generate an output based on the marker or haplotype information, wherein the output comprises a risk measure of the at least one marker or haplotype as a genetic indicator of the at least one cancer for the human individual. In one embodiment, the computer readable memory comprises data indicative of the frequency of at least one allele of at least one polymorphic marker or at least one haplotype in a plurality of individuals diagnosed with, or presenting symptoms associated with, the at least one cancer, and data indicative of the frequency of at the least one allele of at least one polymorphic marker or at least one haplotype in a plurality of reference individuals, and wherein a risk measure is based on a comparison of the at least one marker and/or haplotype status for the human individual to the data indicative of the frequency of the at least one marker and/or haplotype information for the plurality of individuals diagnosed with the at least one cancer. In one embodiment, the computer readable memory further comprises data indicative of a risk of developing the at least one cancer associated with at least one allele of at least one polymorphic marker or at least one haplotype, and wherein a risk measure for the human individual is based on a comparison of the at least one marker and/or haplotype status for the human individual to the risk associated with the at least one allele of the at least one polymorphic marker or the at least one haplotype. In another embodiment, the computer readable memory further comprises data indicative of the frequency of at least one allele of at least one polymorphic marker or at least one haplotype in a plurality of individuals diagnosed with, or at risk for, the at least one cancer, and data indicative of the frequency of at the least one allele of at least one polymorphic marker or at least one haplotype in a plurality of reference individuals, and wherein risk of developing the at least one cancer is based on a comparison of the frequency of the at least one allele or haplotype in individuals diagnosed with, or presenting symptoms associated with, the at least one cancer, and reference individuals. In a preferred embodiment, the cancer is basal cell carcinoma, and wherein said at least one polymorphic marker is selected from the markers rs10504624, rs7538876 and rs801114, and markers in linkage disequilibrium therewith. In another preferred embodiment, the at least one polymorphic marker is selected from the markers set forth in Tables 6 and 7.

The invention in another aspect provides a method of assessing a subject's risk for basal cell carcinoma and/or cutaneous melanoma, the method comprising (a) obtaining sequence information about the individual identifying at least one allele of at least one polymorphic marker in the genome of the individual, (b) representing the sequence information as digital genetic profile data, (c) electronically processing the digital genetic profile data to generate a risk assessment report for cutaneous melanoma; and (d) displaying the risk assessment report on an output device. Certain embodiments relate to basal cell carcinoma, wherein the at least one marker is selected from the group consisting of rs7538876, rs801114, and rs10504624, and markers in linkage disequilibrium therewith. Certain other embodiments relate to cutaneous melanoma, wherein the at least one marker is selected from the group consisting of rs4151060, rs7812812, and rs9585777, and markers in linkage disequilibrium therewith.

In certain embodiments of the invention, linkage disequilibrium is characterized by particular numerical values of the linkage disequilibrium measures r² and |D′|. In certain embodiments, linkage disequilibrium between genetic elements (e.g., markers) is defined as r²>0.1 (r² greater than 0.1). In some embodiments, linkage disequilibrium is defined as r²>0.2. Other embodiments can include other definitions of linkage disequilibrium, such as r²>0.25, r²>0.3, r²>0.35, r²>0.4, r²>0.45, r²>0.5, r²>0.55, r²>0.6, r²>0.65, r²>0.7, r²>0.75, r²>0.8, r²>0.85, r²>0.9, r²>0.95, r²>0.96, r²>0.97, r²>0.98, or r²>0.99. Linkage disequilibrium can in certain embodiments also be defined as |D′|>0.2, or as |D′|>0.3, |D′|>0.4, |D′|>0.5, |D′|>0.6, |D′|>0.7, |D′|>0.8, |D′|>0.9, |D′|>0.95, |D′|>0.98 or |D′|>0.99. In certain embodiments, linkage disequilibrium is defined as fulfilling two criteria of r² and |D′|, such as r²>0.2 and |D′|>0.8. Other combinations of values for r² and |D′| are also possible and within scope of the present invention, including but not limited to the values for these parameters set forth in the above.

Linkage disequilibrium is in one embodiment determined using a collection of samples from a single population, as described herein. One embodiment uses a collection of Caucasian sample, such as Icelandic samples, Caucasian samples from the CEPH collection as described by the HapMap project (http://www.hapmap.org). Other embodiments use sample collections from other populations, including, but not limited to African American population samples, African samples from the Yuroban population (YRI), or Asian samples from China (CHB) or Japan (JPT).

It should be understood that all combinations of features described herein are contemplated, even if the combination of feature is not specifically found in the same sentence or paragraph herein. This includes in particular the use of all markers disclosed herein, alone or in combination, for analysis individually or in haplotypes, in all aspects of the invention as described herein. This includes aspects that relate to any one cancer selected from CM, SCC and BCC, as well as any combinations thereof. Preferred embodiments relate to Basal Cell Carcinoma (BCC).

### BRIEF DESCRIPTION OF THE DRAWINGS

FIG. 1 shows the genomic structure in the 1p36 region. A) The pair-wise correlation LD structure in a 400 kb interval (17.3-17.7 Mb, NCBI Build 35) on chromosome 1. The upper plot shows pair-wise D′ for 415 common SNPs (with MAF>5%) from the HapMap (v21) CEU dataset. The lower plot shows the corresponding r2 values. B) Estimated recombination rates (saRR) in cM/Mb from the HapMap Phase II data. C) Location of known genes in the region. D) Schematic view of the association with BCC for all SNPs tested in the region.

FIG. 2 shows the genomic structure in the 1q42.13 region. Shown are markers on the Illumina HumanHap300 chip in the 226.93-227.19 Mb region on chromosome 1, as well as pairwise r2 from the HapMap CEU dataset in the region, recombination hotspots and recombination rates.

FIG. 3 shows effects of rs7538876 on expression levels of RCC2. A) Expression of RCC2 measured in whole blood from 745 individuals by means of a microarray for the three different genotypes of the risk variant rs7538876. The expression of RCC2 is shown as 10̂(average MLR) where MLR is the mean log expression ratio and the average is over individuals with a particular genotype. The vertical bars indicate the standard error of the mean (s.e.m.). Regressing the MRL values on the number of risk alleles A an individual carries, we find that the expression of RCC2 is increased by an estimated 2.9% with each A allele carried (P=9.6′10−5). The effects of age, sex and blood cell count are taken into account by including them as explanatory variables in the regression. B) Same as A) except for the expression of RCC2 measure in adipose tissue from 603 individuals by means of a microarray. Regressing the MRL values on the number of risk alleles of rs7538876 carried, we find that each A allele increases the expression by an estimated 4.6% (P=8.5′10−8). C) Same as B), except the expression of RCC2 in adipose tissue from 449 individuals is measured, relative to a housekeeping gene GUSB, using real-time PCR. Regressing the log-transformed expression values on the number of risk alleles of rs7538876 carried, yields an estimated 8.7% increase in the expression per A allele carried (P=0.0012). All P values presented have been adjusted for the relatedness of the individuals by means of simulations.

FIG. 4 shows a multigenic risk model for BCC based on susceptibility variants at 1p36, 1q42, ASIP, TYR and MC1R loci. Odds ratios (OR) were calculated for all 243 possible genotypes and expressed relative to the general population risk, assuming the multiplicative model of allelic and intergenic interactions. The genotypes were then ranked in order of increasing OR. The OR for each genotype is plotted on the Y axis. On the X axis is plotted the cumulative frequency of individuals who have an OR less than or equal to that of the given phenotype. The frequencies of rs7538876 (1p36) and rs801114 (1q42) are the artihmetic means of the control frequencies in the Icelandic and Eastern European samples and the Ors are 1.28 for each variant. ASIP, TYR and MC1R variants are as described (Gudbjartsson et al. 2008). The ASIP variant is the AH haplotype (G-rs1015362 T-rs4911414), which has an allelic OR of 1.35 and control frequency of 0.055 averaged over several European population samples. TYR is the R402Q variant, having an allelic OR of 1.14 and frequency of 0.25. MC1R is a variant for any strong red hair (D84E, R151C, R160W or D294H), which together have an or of 1.37 and a frequency of 0.15.

FIG. 5 provides a diagram illustrating a computer-implemented system utilizing risk variants as described herein.

### DETAILED DESCRIPTION

### Definitions

Unless otherwise indicated, nucleic acid sequences are written left to right in a 5′ to 3′ orientation. Numeric ranges recited within the specification are inclusive of the numbers defining the range and include each integer or any non-integer fraction within the defined range. Unless defined otherwise, all technical and scientific terms used herein have the same meaning as commonly understood by the ordinary person skilled in the art to which the invention pertains.

The following terms shall, in the present context, have the meaning as indicated:

A “polymorphic marker”, sometime referred to as a “marker”, as described herein, refers to a genomic polymorphic site. Each polymorphic marker has at least two sequence variations characteristic of particular alleles at the polymorphic site. Thus, genetic association to a polymorphic marker implies that there is association to at least one specific allele of that particular polymorphic marker. The marker can comprise any allele of any variant type found in the genome, including SNPs, mini- or microsatellites, translocations and copy number variations (insertions, deletions, duplications). Polymorphic markers can be of any measurable frequency in the population. For mapping of disease genes, polymorphic markers with population frequency higher than 5-10% are in general most useful. However, polymorphic markers may also have lower population frequencies, such as 1-5% frequency, or even lower frequency, in particular copy number variations (CNVs). The term shall, in the present context, be taken to include polymorphic markers with any population frequency.

An “allele” refers to the nucleotide sequence of a given locus (position) on a chromosome. A polymorphic marker allele thus refers to the composition (i.e., sequence) of the marker on a chromosome. Genomic DNA from an individual contains two alleles (e.g., allele-specific sequences) for any given polymorphic marker, representative of each copy of the marker on each chromosome. Sequence codes for nucleotides used herein are: A=1, C=2, G=3, T=4. For microsatellite alleles, the CEPH sample (Centre d'Etudes du Polymorphisme Humain, genomics repository, CEPH sample 1347-02) is used as a reference, the shorter allele of each microsatellite in this sample is set as 0 and all other alleles in other samples are numbered in relation to this reference. Thus, e.g., allele 1 is 1 bp longer than the shorter allele in the CEPH sample, allele 2 is 2 bp longer than the shorter allele in the CEPH sample, allele 3 is 3 bp longer than the lower allele in the CEPH sample, etc., and allele −1 is 1 bp shorter than the shorter allele in the CEPH sample, allele −2 is 2 bp shorter than the shorter allele in the CEPH sample, etc.

Sequence conucleotide ambiguity as described herein is as proposed by IUPAC-IUB. These codes are compatible with the codes used by the EMBL, GenBank, and PIR databases.

| IUB code | Meaning |
|---|---|
| A | Adenosine |
| C | Cytidine |
| G | Guanine |
| T | Thymidine |
| R | G or A |
| Y | T or C |
| K | G or T |
| M | A or C |
| S | G or C |
| W | A or T |
| B | C G or T |
| D | A G or T |
| H | A C or T |
| V | A C or G |
| N | A C G or T (Any base) |

A nucleotide position at which more than one sequence is possible in a population (either a natural population or a synthetic population, e.g., a library of synthetic molecules) is referred to herein as a “polymorphic site”.

A “Single Nucleotide Polymorphism” or “SNP” is a DNA sequence variation occurring when a single nucleotide at a specific location in the genome differs between members of a species or between paired chromosomes in an individual. Most SNP polymorphisms have two alleles. Each individual is in this instance either homozygous for one allele of the polymorphism (i.e. both chromosomal copies of the individual have the same nucleotide at the SNP location), or the individual is heterozygous (i.e. the two sister chromosomes of the individual contain different nucleotides). The SNP nomenclature as reported herein refers to the official Reference SNP (rs) ID identification tag as assigned to each unique SNP by the National Center for Biotechnological Information (NCBI).

A “variant”, as described herein, refers to a segment of DNA that differs from the reference DNA. A “marker” or a “polymorphic marker”, as defined herein, is a variant. Alleles that differ from the reference are referred to as “variant” alleles.

A “microsatellite” is a polymorphic marker that has multiple small repeats of bases that are 2-8 nucleotides in length (such as CA repeats) at a particular site, in which the number of repeat lengths varies in the general population. An “indel” is a common form of polymorphism comprising a small insertion or deletion that is typically only a few nucleotides long.

A “haplotype,” as described herein, refers to a segment of genomic DNA that is characterized by a specific combination of alleles arranged along the segment. For diploid organisms such as humans, a haplotype comprises one member of the pair of alleles for each polymorphic marker or locus along the segment. In a certain embodiment, the haplotype can comprise two or more alleles, three or more alleles, four or more alleles, or five or more alleles. Haplotypes are described herein in the context of the marker name and the allele of the marker in that haplotype, e.g., “1 rs7538876” refers to the 1 allele of marker rs7538876 being in the haplotype, and is equivalent to “rs7538876 allele 1”. Furthermore, allelic codes in haplotypes are as for individual markers, i.e. 1=A, 2=C, 3=G and 4=T.

The term “CM”, as described herein, refers to cutaneous melanoma, including all subphenotypes.

The term “SCC”, as described herein, refers to Squamous Cell Carcinoma.

The term “BCC”, as described herein, refers to Basal Cell Carcinoma, sometimes also called Cutaneous Basal Cell Carcinoma.

The term “susceptibility”, as described herein, refers to the proneness of an individual towards the development of a certain state (e.g., a certain trait, phenotype or disease), or towards being less able to resist a particular state than the average individual. The term encompasses both increased susceptibility and decreased susceptibility. Thus, particular alleles at polymorphic markers and/or haplotypes of the invention as described herein may be characteristic of increased susceptibility (i.e., increased risk) of a particular form of cancer, including CM, BCC and SCC, as characterized by a relative risk (RR) or odds ratio (OR) of greater than one for the particular allele or haplotype. Alternatively, the markers and/or haplotypes of the invention are characteristic of decreased susceptibility (i.e., decreased risk) of CM, BCC and/or SCC, as characterized by a relative risk of less than one.

The term “and/or” shall in the present context be understood to indicate that either or both of the items connected by it are involved. In other words, the term herein shall be taken to mean “one or the other or both”.

The term “look-up table”, as described herein, is a table that correlates one form of data to another form, or one or more forms of data to a predicted outcome to which the data is relevant, such as phenotype or trait. For example, a look-up table can comprise a correlation between allelic data for at least one polymorphic marker and a particular trait or phenotype, such as a particular disease diagnosis, that an individual who comprises the particular allelic data is likely to display, or is more likely to display than individuals who do not comprise the particular allelic data. Look-up tables can be multidimensional, i.e. they can contain information about multiple alleles for single markers simultaneously, or they can contain information about multiple markers, and they may also comprise other factors, such as particulars about diseases diagnoses, racial information, biomarkers, biochemical measurements, therapeutic methods or drugs, etc.

A “computer-readable medium”, is an information storage medium that can be accessed by a computer using a commercially available or custom-made interface. Exemplary computer-readable media include memory (e.g., RAM, ROM, flash memory, etc.), optical storage media (e.g., CD-ROM), magnetic storage media (e.g., computer hard drives, floppy disks, etc.), punch cards, or other commercially available media. Information may be transferred between a system of interest and a medium, between computers, or between computers and the computer-readable medium for storage or access of stored information. Such transmission can be electrical, or by other available methods, such as IR links, wireless connections, etc.

A “nucleic acid sample” as described herein, refers to a sample obtained from an individual that contains nucleic acid (DNA or RNA). In certain embodiments, i.e. the detection of specific polymorphic markers and/or haplotypes, the nucleic acid sample comprises genomic DNA. Such a nucleic acid sample can be obtained from any source that contains genomic DNA, including a blood sample, sample of amniotic fluid, sample of cerebrospinal fluid, or tissue sample from skin, muscle, buccal or conjunctival mucosa, placenta, gastrointestinal tract or other organs.

The term “cancer therapeutic agent” refers to an agent that can be used to ameliorate or prevent symptoms associated with a cancer.

The term “cancer-associated nucleic acid”, as described herein, refers to a nucleic acid that has been found to be associated to a cancer. This includes, but is not limited to, the markers and haplotypes described herein and markers and haplotypes in strong linkage disequilibrium (LD) therewith. In certain embodiment, the cancer-associated nucleic acid refers to a region or LD-block found to be associated with the cancer through at least one polymorphic marker located within the LD block. For example, in certain embodiments of the invention, the cancer-associated nucleic acid refers a marker or haplotype within the LD Block C01p36 and/or the LD Block C01q42, as defined herein and set forth in SEQ ID NO:1 and SEQ ID NO:2, respectively.

The term “1p36 LD Block”, as described herein, refers to the Linkage Disequilibrium (LD) block on Chromosome 1 between markers rs1635566 and rs6689677, corresponding to position 17,555,744-17,693,329 of NCBI (National Center for Biotechnology Information) Build 36 (Position 301 and 137,886 respectively in SEQ ID NO:1). The term “1q42 LD Block”, as described herein, refers to the Linkage Disequilibrium (LD) block on Chromosome 1 between markers rs10799489 and rs12078733, corresponding to position 227,006,493-227,108,497 of NCBI Build 36 (Position 301 and 102305 respectively in SEQ ID NO:2). LD blocks are suitably defined by the methods described in McVean, et al., (2004), Science, 304, 581-4.

In order to search widely for common sequence variants associated with predisposition to CM, BCC and/or SCC, we used Illumina Sentrix HumanHap300 and HumanCNV370-duo Bead Chip microarrays to genotype approximately 816 Icelandic cancer registry ascertained CM patients (including 522 invasive CM patients), 930 cancer registry ascertained, histopathologically confirmed Icelandic BCC patients, 339 histologically confirmed, cancer registry ascertained SCC patients, and 33,117 controls (a full description of the patient and control samples used in this study is in the Methods). After removing SNPs that failed quality checks (see Methods) a total of about 304,083 SNPs were tested for association. The results were adjusted for familial relatedness between individuals and for potential population stratification using the method of genomic control [Devlin and Roeder, (1999), Biometrics, 55, 997-1004]. We calculated the allelic odds ratio (OR) for each SNP assuming the multiplicative model and determined P values using a standard likelihood ratio χ² statistic. The association results that gave P values ≦2×10⁻⁴ for CM are shown in Table 1. The association results that gave P values ≦2×10⁻⁴ for invasive CM only are shown in Table 2. The association results that gave P values ≦2×10⁻⁴ for BCC are shown in Table 3. The association results that gave P values ≦10⁻⁴ for SCC are shown in Table 4. All the SNPs identified in these tables have potential diagnostic utility in the respective diseases.

For BCC, SNPs at two genomic locations produced substantial signals: The A-allele of rs7538876 at 1p36 showed an OR of 1.27 (P=1.9×10⁻⁶) and the G-allele of rs801114 at 1q42 showed an OR of 1.32 (P=5.0×10⁻⁸) (Table 5).

We confirmed the association with rs7538876 and rs801114, by typing the SNPs in a further set of 703 Icelanders with BCC and 2329 controls (designated Iceland BCC 2). We further typed a sample of 513 BCC patients and 515 controls from Hungary, Romania and Slovakia (the Eastern Europe BCC set) [Scherer, et al., (2007), Int J Cancer, 122, 1787-1793]. For both SNPs, nominally significant replication was observed in both replication samples (Table 5). Combining data from the Icelandic and Eastern Europe BCC sets gave OR of 1.28 and P values of 4.4×10⁻¹² for A-rs7538876 and 5.9×10⁻¹² for G-rs801114 (Table 5). Given that these P values were well below the Bonferroni threshold for genome-wide significance (P<1.6×10⁻⁷) and that the association replicated consistently, these results show that the 1p36 and 1q42 SNPs confer susceptibility to BCC.

For clarity, we herein refer to the SNP that originally gave the strongest signal at each locus in a genome-wide association screen as the “key SNP” for that locus. We refer to the genetic variant that is mechanistically responsible for the increase in risk at each locus as the “causative variant”. In a genome-wide association study, the key SNP and the causative variant are unlikely to be one and the same. More typically, key SNPs produce signals because they are correlated through LD with causative variants. Each SNP that was selected for inclusion on the Illumina chip were chosen in part because it acts as a surrogate for a large set of un-genotyped SNPs, i.e. any key SNP will be correlated (through LD) with a group of unobserved SNPs that are not on the chip. If they were tested individually, each of the un-genotyped SNPs in such a set would represent essentially the same association signal. If a SNP in the set is more closely correlated with the causative variant than the key SNP is, one would expect that SNP to confer a higher relative risk than the key SNP. Table 6 shows a list of HapMap SNPs in the 1p36 LD block that are correlated with rs7538876 by an r² value of 0.2 or higher. Any of these SNPs might be used to produce a signal that is as good or better than that provided by rs7538876. Table 7 shows a list of HapMap SNPs in the 1q42 LD block that are correlated with rs801114 by an r² value of 0.2 or higher. Any of these SNPs might in particular be used to produce a signal that is as good or better than that provided by rs801114.

One unifying theme might be that genes associated with fair pigmentation traits confer cross-risk of all three skin cancer types because of their roles in protection from the shared risk factor of UV light, whereas the more specifically associated variants may act through different pathways. To investigate this, we tested the 1p36 and 1q42 SNPs for association with eye colour, hair colour, propensity to freckle and skin sensitivity to sun (Fitzpatrick scale), using self reported pigmentation data from 4720 Icelanders who had been genotyped on the Illumina platform [Sulem, et al., (2007), Nat Genet, 39, 1443-52] (Sulem et al, 2008 in press). We saw no evidence of association between the 1p36 and 1q42 SNPs and the pigmentation traits eye colour, hair colour, propensity to freckle and skin sensitivity to sun (Fitzpatrick scale), using self reported pigmentation data from 4720 Icelanders who had been genotyped on the Illumine platform [Sulem, et al., (2007), Nat Genet, 39, 1443-52] (Sulem et al, 2008 in press) (Table 8). This would suggest that the 1p36 and 1q42 variants act through pathways other than those related to UV-susceptible pigmentation traits.

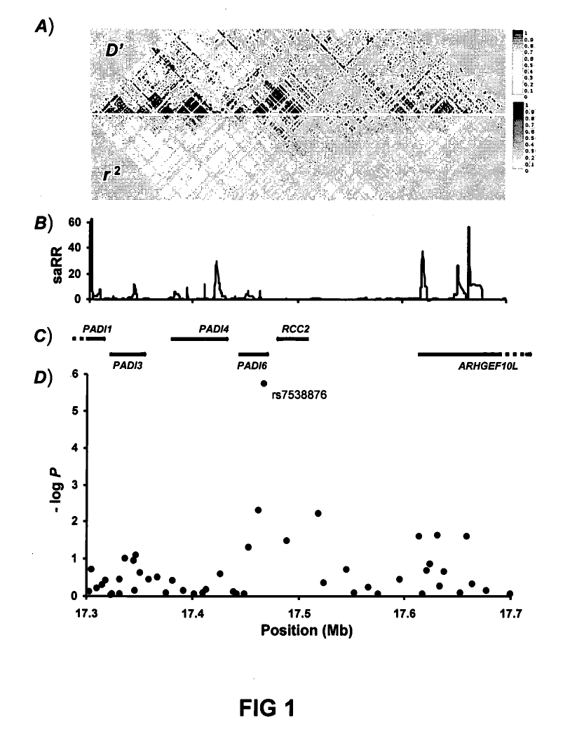

The 1p36 SNP rs7538876 is in the 13^{th} intron of the peptidylarginine deiminase 6 gene (PADI6) (FIG. 1). Peptidylarginine deiminases are involved in posttranslational modifications of arginine and methyl arginine residues, creating the derivative amino acid citrulline. Citrullination is involved in facilitating the assembly of higher order protein structures, particularly cytoskeletal structures [Gyorgy, et al., (2006), Int J Biochem Cell Biol, 38, 1662-77]. There are 5 PADI genes and all are located in a cluster on 1p36. PADI6 is the most proximal. PADI1-3 are expressed in epidermis and citrullination of cytokeratins and filaggrin are important in terminal differentiation of keratinocytes [Chavanas, et al., (2006), J Dermatol Sci, 44, 63-72]. However, PADI1-3 are separated from rs7538876 by a region of high recombination (FIG. 1). The 3″ end of PADI4 is within the linkage disequilibrium (LD) block containing rs7538876. PADI4 has been implicated in rheumatoid arthritis and in repression of histone methylation-mediated gene regulation [Suzuki, et al., (2007), Ann N Y Acad Sci, 1108, 323-39; Wysocka, et al., (2006), Front Biosci, 11, 344-55]. PADI6 itself is expressed only in germ cells, where it appears to play a role in cytoskeletal organization [Esposito, et al., (2007), Mol Cell Endocrinol, 273, 25-31].

Also in the LD block on 1p36 is the regulator of chromosome condensation 2 gene (RCC2) (FIG. 1), which is involved in mitotic spindle assembly [Mollinari, et al., (2003), Dev Cell, 5, 295-307]. The 5″ end of the longer transcript of the AHRGEF10L gene is also in the 1p36 LD block. It encodes GrinchGEF, a guanine nucleotide exchange factor involved in Rho GTPase activation [Winkler, et al., (2005), Biochem Biophys Res Commun, 335, 1280-6]. Both RCC2 and AHRGEF10L are plausible candidates for BCC susceptibility genes. No known common missense or nonsense mutations in these genes are strongly correlated with rs7538876.

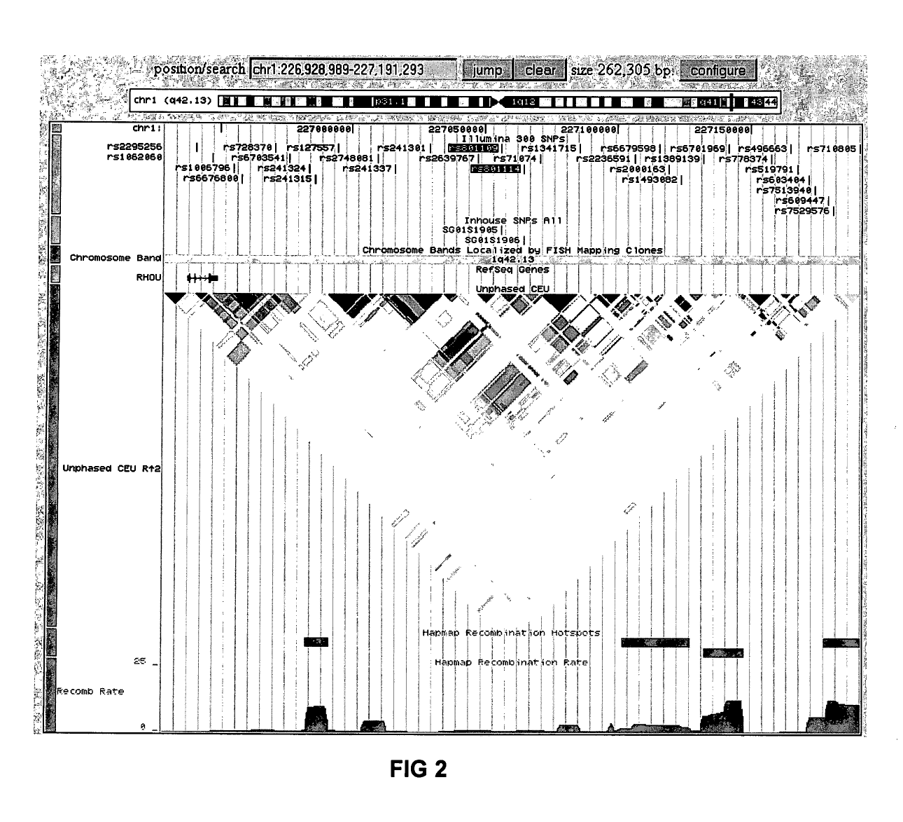

There is no RefSeq gene in the 1q42 LD block containing rs801114. The Ras homologue RHOU is the nearest gene, in the adjacent proximal LD block (FIG. 2). RHOU has been implicated in WNT1 signalling, regulation of the cytoskeleton and cell proliferation [Tao, et al., (2001), Genes Dev, 15, 1796-807]. The WNT pathway was previously implicated in BCC, as germline mutations in PTCH are found in patients with Nevoid Basal Cell Carcinoma (Gorlin's) Syndrome and somatic mutations in PTCH have been detected in sporadic BCC [Hahn, et al., (1996), Cell, 85, 841-51; Johnson, et al., (1996), Science, 272, 1668-71].

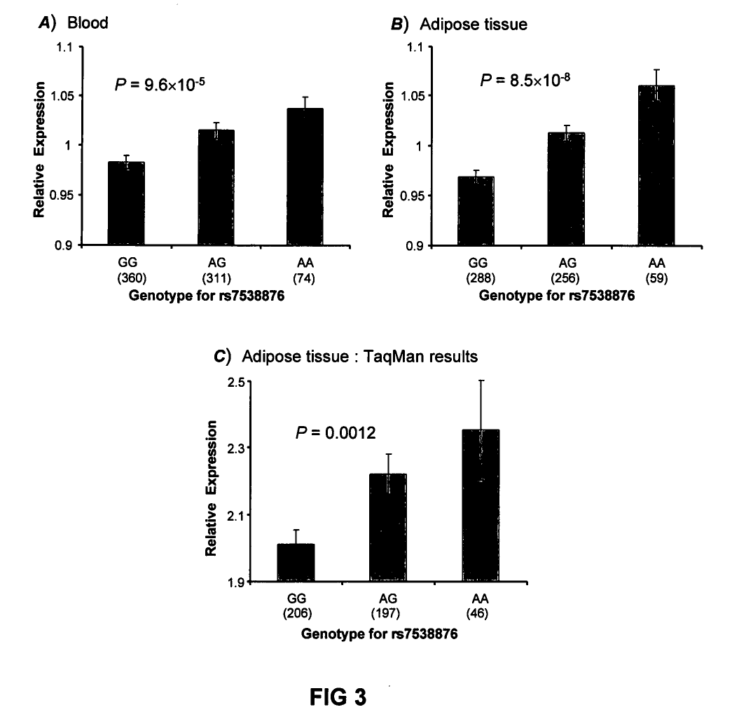

RCC2 was previously reported to be significantly up-regulated in BCC lesions relative to normal skin [O'Driscoll, et al., (2006), Mol Cancer, 5, 74]. We had previously correlated SNP genotypes to the expression of 23,720 transcripts measured-on Agilent microarrays, using RNA samples from adipose tissue and peripheral blood from 745 individuals [Emilsson, et al., (2008), Nature, 452, 423-8]. Allele A of rs7538876 is significantly associated with expression of RCC2 in blood, with an estimated 2.9% increase in expression for each copy of the risk allele carried (FIG. 3a). A similar association was observed for adipose-derived RNA, with an estimated 4.6% increase in expression per copy (FIG. 3b). We confirmed these observations in adipose RNA samples, as shown in FIG. 3c, with an estimated 8.7% increase in expression per copy of the A-rs7538876 risk allele. Although these samples are not derived from the target tissues for BCC, these data indicate that the oncogenic effect of rs7538876 may be mediated through an alteration in expression of RCC2.

Allele A-rs7538876 at 1p36 was associated with a younger age at diagnosis of BCC in both Icelandic and Eastern European samples (Table 9). Combining both sample sets resulted in an estimate of 1.39 years younger age at diagnosis for each A-rs7538876 allele carried (P=5.96×10⁻⁴).

### Assessment for Markers and Haplotypes

The genomic sequence within populations is not identical when individuals are compared.

Rather, the genome exhibits sequence variability between individuals at many locations in the genome. Such variations in sequence are commonly referred to as polymorphisms, and there are many such sites within each genome For example, the human genome exhibits sequence variations which occur on average every 500 base pairs. The most common sequence variant consists of base variations at a single base position in the genome, and such sequence variants, or polymorphisms, are commonly called Single Nucleotide Polymorphisms (“SNPs”). These SNPs are believed to have occurred in a single mutational event, and therefore there are usually two possible alleles possible at each SNPsite; the original allele and the mutated allele. Due to natural genetic drift and possibly also selective pressure, the original mutation has resulted in a polymorphism characterized by a particular frequency of its alleles in any given population.

Many other types of sequence variants are found in the human genome, including mini- and microsatellites, and insertions, deletions and inversions (also called copy number variations (CNVs)). A polymorphic microsatellite has multiple small repeats of bases (such as CA repeats, TG on the complimentary strand) at a particular site in which the number of repeat lengths varies in the general population. In general terms, each version of the sequence with respect to the polymorphic site represents a specific allele of the polymorphic site. These sequence variants can all be referred to as polymorphisms, occurring at specific polymorphic sites characteristic of the sequence variant in question. In general, polymorphisms can comprise any number of specific alleles within the population, although each human individual has two alleles at each polymorphic site—one maternal and one paternal allele Thus in one embodiment of the invention, the polymorphism is characterized by the presence of two or more alleles in any given population. In another embodiment, the polymorphism is characterized by the presence of three or more alleles in a population. In other embodiments, the polymorphism is characterized by four or more alleles, five or more alleles, six or more alleles, seven or more alleles, nine or more alleles, or ten or more alleles. All such polymorphisms can be utilized in the methods and kits of the present invention, and are thus within the scope of the invention.

Due to their abundance, SNPs account for a majority of sequence variation in the human genome. Over 6 million human SNPs have been validated to date (http://www.ncbi.nlm.nih.gov/projects/SNP/snp_summary.cgi). However, CNVs are receiving increased attention. These large-scale polymorphisms (typically 1 kb or larger) account for polymorphic variation affecting a substantial proportion of the assembled human genome; known CNVs covery over 15% of the human genome sequence (Estivill, X Armengol; L., PloS Genetics 3:1787-99 (2007); http://projects.tcag.ca/variation/). Most of these polymorphisms are however very rare, and on average affect only a fraction of the genomic sequence of each individual. CNVs are known to affect gene expression, phenotypic variation and adaptation by disrupting gene dosage, and are also known to cause disease (microdeletion and microduplication disorders) and confer risk of common complex diseases, including HIV-1 infection and glomerulonephritis (Redon, R., et al. Nature 23:444-454 (2006)). It is thus possible that either previously described or unknown CNVs represent causative variants in linkage disequilibrium with the disease-associated markers described herein. Methods for detecting CNVs include comparative genomic hybridization (CGH) and genotyping, including use of genotyping arrays, as described by Carter (Nature Genetics 39:516-S21 (2007)). The Database of Genomic Variants (http://projects.tcag.ca/variation/) contains updated information about the location, type and size of described CNVs. The database currently contains data for over 21,000 CNVs.

In some instances, reference is made to different alleles at a polymorphic site without choosing a reference allele. Alternatively, a reference sequence can be referred to for a particular polymorphic site. The reference allele is sometimes referred to as the “wild-type” allele and it usually is chosen as either the first sequenced allele or as the allele from a “non-affected” individual (e.g., an individual that does not display a trait or disease phenotype).

Alleles for SNP markers as referred to herein refer to the bases A, C, G or T as they occur at the polymorphic site. The allele codes for SNPs used herein are as follows: 1=A, 2=C, 3=G, 4=T. Since human DNA is double-stranded, the person skilled in the art will realise that by assaying or reading the opposite DNA strand, the complementary allele can in each case be measured. Thus, for a polymorphic site (polymorphic marker) characterized by an A/G polymorphism, the methodology employed to detect the marker may be designed to specifically detect the presence of one or both of the two bases possible, i.e. A and G. Alternatively, by designing an assay that is designed to detect the complimentary strand on the DNA template, the presence of the complementary bases T and C can be measured. Quantitatively (for example, in terms of risk estimates), identical results would be obtained from measurement of either DNA strand (+ strand or − strand).

Typically, a reference sequence is referred to for a particular sequence. Alleles that differ from the reference are sometimes referred to as “variant” alleles. A variant sequence, as used herein, refers to a sequence that differs from the reference sequence but is otherwise substantially similar. Alleles at the polymorphic genetic markers described herein are variants. Variants can include changes that affect a polypeptide. Sequence differences, when compared to a reference nucleotide sequence, can include the insertion or deletion of a single nucleotide, or of more than one nucleotide, resulting in a frame shift; the change of at least one nucleotide, resulting in a change in the encoded amino acid; the change of at least one nucleotide, resulting in the generation of a premature stop codon; the deletion of several nucleotides, resulting in a deletion of one or more amino acids encoded by the nucleotides; the insertion of one or several nucleotides, such as by unequal recombination or gene conversion, resulting in an interruption of the coding sequence of a reading frame; duplication of all or a part of a sequence; transposition; or a rearrangement of a nucleotide sequence. Such sequence changes can alter the polypeptide encoded by the nucleic acid. For example, if the change in the nucleic acid sequence causes a frame shift, the frame shift can result in a change in the encoded amino acids, and/or can result in the generation of a premature stop codon, causing generation of a truncated polypeptide. Alternatively, a polymorphism can be a synonymous change in one or more nucleotides (i.e., a change that does not result in a change in the amino acid sequence). Such a polymorphism can, for example, alter splice sites, affect the stability or transport of mRNA, or otherwise affect the transcription or translation of an encoded polypeptide. It can also alter DNA to increase the possibility that structural changes, such as amplifications or deletions, occur at the somatic level. The polypeptide encoded by the reference nucleotide sequence is the “reference” polypeptide with a particular reference amino acid sequence, and polypeptides encoded by variant alleles are referred to as “variant” polypeptides with variant amino acid sequences.

A haplotype refers to a single strand segment of DNA that is characterized by a specific combination of alleles arranged along the segment. For diploid organisms such as humans, a haplotype comprises one member of the pair of alleles for each polymorphic marker or locus. In a certain embodiment, the haplotype can comprise two or more alleles, three or more alleles, four or more alleles, or five or more alleles, each allele corresponding to a specific polymorphic marker along the segment. Haplotypes can comprise a combination of various polymorphic markers, e.g., SNPs and microsatellites, having particular alleles at the polymorphic sites. The haplotypes thus comprise a combination of alleles at various genetic markers.

Detecting specific polymorphic markers and/or haplotypes can be accomplished by methods known in the art for detecting sequences at polymorphic sites. For example, standard techniques for genotyping for the presence of SNPs and/or microsatellite markers can be used, such as fluorescence-based techniques (e.g., Chen, X. et al., Genome Res. 9(5): 492-98 (1999); Kutyavin et al., Nucleic Acid Res. 34:e128 (2006)), utilizing PCR, LCR, Nested PCR and other techniques for nucleic acid amplification. Specific commercial methodologies available for SNP genotyping include, but are not limited to, TaqMan genotyping assays and SNPlex platforms (Applied Biosystems), gel electrophoresis (Applied Biosystems), mass spectrometry (e.g., MassARRAY system from Sequenom), minisequencing methods, real-time PCR, Bio-Plex system (BioRad), CEQ and SNPstream systems (Beckman), array hybridization technology (e.g., Affymetrix GeneChip; Perlegen), BeadArray Technologies (e.g., Illumina GoldenGate and Infinium assays), array tag technology (e.g., Parallele), and endonuclease-based fluorescence hybridization technology (Invader; Third Wave). Some of the available array platforms, including Affymetrix SNP Array 6.0 and Illumina CNV370-Duo and 1M BeadChips, include SNPs that tag certain CNVs. This allows detection of CNVs via surrogate SNPs included in these platforms. Thus, by use of these or other methods available to the person skilled in the art, one or more alleles at polymorphic markers, including microsatellites, SNPs or other types of polymorphic markers, can be identified.

In certain embodiments, polymorphic markers are detected by sequencing technologies. Obtaining sequence information about an individual identifies particular nucleotides in the context of a sequence. For SNPs, sequence information about a single unique sequence site is sufficient to identify alleles at that particular SNP. For markers comprising more than one nucleotide, sequence information about the nucleotides of the individual that contain the polymorphic site identifies the alleles of the individual for the particular site. The sequence information can be obtained from a sample from the individual. In certain embodiments, the sample is a nucleic acid sample. In certain other embodiments, the sample is a protein sample.

Various methods for obtaining nucleic acid sequence are known to the skilled person, and all such methods are useful for practicing the invention. Sanger sequencing is a well-known method for generating nucleic acid sequence information. Recent methods for obtaining large amounts of sequence data have been developed, and such methods are also contemplated to be useful for obtaining sequence information. These include pyrosequencing technology (Ronaghi, M. et al. Anal Biochem 267:65-71 (1999); Ronaghi, et al. Biotechniques 25:876-878 (1998)), e.g. 454 pyrosequencing (Nyren, P., et al. Anal Biochem 208:171-175 (1993)), Illumina/Solexa sequencing technology (http://www.illumina.com; see also Strausberg, R L, et al Drug Disc Today 13:569-577 (2008)), and Supported Oligonucleotide Ligation and Detection Platform (SOLiD) technology (Applied Biosystems, http://www.appliedbiosystems.com); Strausberg, R L, et al Drug Disc Today 13:569-577 (2008).

It is possible to impute or predict genotypes for un-genotyped relatives of genotyped individuals. For every un-genotyped case, it is possible to calculate the probability of the genotypes of its relatives given its four possible phased genotypes. In practice it may be preferable to include only the genotypes of the case's parents, children, siblings, half-siblings (and the half-sibling's parents), grand-parents, grand-children (and the grand-children's parents) and spouses. It will be assumed that the individuals in the small sub-pedigrees created around each case are not related through any path not included in the pedigree. It is also assumed that alleles that are not transmitted to the case have the same frequency—the population allele frequency. Let us consider a SNP marker with the alleles A and G. The probability of the genotypes of the case's relatives can then be computed by:

$$Pr ( genotypes of relatives ; θ ) = {\sum }_{h ∈ \{ AA , AG , GA , GG \}} Pr ( h ; θ ) Pr ( genotypes of relatives \vert h ) ,$$

where θ denotes the A allele's frequency in the cases. Assuming the genotypes of each set of relatives are independent, this allows us to write down a likelihood function for θ:

$$L ( θ ) = {\prod }_{i} Pr ( genotypes of relativesof case i ; θ ) . \qquad (* )$$

This assumption of independence is usually not correct. Accounting for the dependence between individuals is a difficult and potentially prohibitively expensive computational task. The likelihood function in (*) may be thought of as a pseudolikelihood approximation of the full likelihood function for θ which properly accounts for all dependencies. In general, the genotyped cases and controls in a case-control association study are not independent and applying the case-control method to related cases and controls is an analogous approximation. The method of genomic control (Devlin, B. et al., Nat Genet 36, 1129-30; author reply 1131 (2004)) has proven to be successful at adjusting case-control test statistics for relatedness. We therefore apply the method of genomic control to account for the dependence between the terms in our pseudolikelihood and produce a valid test statistic.

Fisher's information can be used to estimate the effective sample size of the part of the pseudolikelihood due to un-genotyped cases. Breaking the total Fisher information, I, into the part due to genotyped cases, I_{g}, and the part due to ungenotyped cases, Iᵤ, I=I_{g}+Iᵤ, and denoting the number of genotyped cases with N, the effective sample size due to the un-genotyped cases is estimated by

$$\frac{{I}_{u}}{{I}_{g}} N .$$

In the present context, an individual who is at an increased susceptibility (i.e., increased risk) for a cancer selected from the group consisting of basal cell carcinoma, cutaneous melanoma and squamous cell carcinoma, is an individual in whom at least one specific allele at one or more polymorphic marker or haplotype conferring increased susceptibility for the cancer is identified (i.e., at-risk marker alleles or haplotypes). The at-risk marker or haplotype is one that confers a significant increased risk (or susceptibility) of the cancer (e.g., CM, BCC and/or SCC). In one embodiment, significance associated with a marker or haplotype is measured by a relative risk (RR). In another embodiment, significance associated with a marker or haplotye is measured by an odds ratio (OR). In a further embodiment, the significance is measured by a percentage. In one embodiment, a significant increased risk is measured as a risk (relative risk and/or odds ratio) of at least 1.1, including but not limited to: at least 1.2, at least 1.3, at least 1.4, at least 1.5, at least 1.6, at least 1.7, 1.8, at least 1.9, at least 2.0, at least 2.5, at least 3.0, at least 4.0, and at least 5.0. In a particular embodiment, a risk (relative risk and/or odds ratio) of at least 1.20 is significant. In another particular embodiment, a risk of at least 1.22 is significant. In yet another embodiment, a risk of at least 1.24 is significant. In a further embodiment, a relative risk of at least 1.25 is significant. In another further embodiment, a significant increase in risk is at least 1.26 is significant. However, other cutoffs are also contemplated, e.g., any non-integer number bridging any of the numbers above, e.g. at least 1.15, 1.16, 1.17, and so on, and such cutoffs are also within scope of the present invention. In other embodiments, a significant increase in risk is at least about 10%, including but not limited to about 20%, 25%, 30%, 35%, 40%, 45%, 50%, 55%, 60%, 65%, 70%, 75%, 80%, 85%, 90%, 95%, 100%, 150%, 200%, 300%, and 500%. In one particular embodiment, a significant increase in risk is at least 20%. In other embodiments, a significant increase in risk is at least 22%, at least 24%, at least 25%, at least 26%, at least 27%, at least 28%, at least 29% and at least 30%. Other cutoffs or ranges as deemed suitable by the person skilled in the art to characterize the invention are however also contemplated, and those are also within scope of the present invention. In certain embodiments, a significant increase in risk is characterized by a p-value, such as a p-value of less than 0.05, less than 0.01, less than 0.001, less than 0.0001, less than 0.00001, less than 0.000001, less than 0.0000001, less than 0.00000001, or less than 0.000000001.

An at-risk polymorphic marker or haplotype of the present invention is one where at least one allele of at least one marker or haplotype is more frequently present in an individual at risk for the disease or trait (affected), or diagnosed with the cancer (e.g., CM, SCC and/or BCC), compared to the frequency of its presence in a comparison group (control), such that the presence of the marker or haplotype is indicative of susceptibility to the cancer. The control group may in one embodiment be a population sample, i.e. a random sample from the general population. In another embodiment, the control group is represented by a group of individuals who are disease-free. Such disease-free control may in one embodiment be characterized by the absence of one or more specific disease-associated symptoms. In another embodiment, the disease-free control group is characterized by the absence of one or more disease-specific risk factors. Such risk factors are in one embodiment at least one environmental risk factor. Representative environmental factors are natural products, minerals or other chemicals which are known to affect, or contemplated to affect, the risk of developing the specific disease or trait. Other environmental risk factors are risk factors related to lifestyle, including but not limited to food and drink habits, geographical location of main habitat, and occupational risk factors. In another embodiment, the risk factors comprise at least one additional genetic risk factor.

As an example of a simple test for correlation would be a Fisher-exact test on a two by two table. Given a cohort of chromosomes, the two by two table is constructed out of the number of chromosomes that include both of the markers or haplotypes, one of the markers or haplotypes but not the other and neither of the markers or haplotypes. Other statistical tests of association known to the skilled person are also contemplated and are also within scope of the invention.

The person skilled in the art will appreciate that for markers with two alleles present in the population being studied (such as SNPs), and wherein one allele is found in increased frequency in a group of individuals with a trait or disease in the population, compared with controls, the other allele of the marker will be found in decreased frequency in the group of individuals with the trait or disease, compared with controls. In such a case, one allele of the marker (the one found in increased frequency in individuals with the trait or disease) will be the at-risk allele, while the other allele will be a protective allele.

Thus, in other embodiments of the invention, an individual who is at a decreased susceptibility (i.e., at a decreased risk) for a disease or trait is an individual in whom at least one specific allele at one or more polymorphic marker or haplotype conferring decreased susceptibility for the disease or trait is identified. The marker alleles and/or haplotypes conferring decreased risk are also said to be protective. In one aspect, the protective marker or haplotype is one that confers a significant decreased risk (or susceptibility) of the disease or trait. In one embodiment, significant: decreased risk is measured as a relative risk (or odds ratio) of less than 0.9, including but not limited to less than 0.9, less than 0.8, less than 0.7, less than 0.6, less than 0.5, less than 0.4, less than 0.3, less than 0.2 and less than 0.1. In one particular embodiment, significant decreased risk is less than 0.7. In another embodiment, significant decreased risk is less than 0.5. In yet another embodiment, significant decreased risk is less than 0.3. In another embodiment, the decrease in risk (or susceptibility) is at least 20%, including but not limited to at least 25%, at least 30%, at least 35%, at least 40%, at least 45%, at least 50%, at least 55%, at least 60%, at least 65%, at least 70%, at least 75%, at least 80%, at least 85%, at least 90%, at least 95% and at least 98%. In one particular embodiment, a significant decrease in risk is at least about 30%. In another embodiment, a significant decrease in risk is at least about 50%. In another embodiment, the decrease in risk is at least about 70%. Other cutoffs or ranges as deemed suitable by the person skilled in the art to characterize the invention are however also contemplated, and those are also within scope of the present invention.

A genetic variant associated with a cancer can be used alone to predict the risk of disease for a given genotype. For a biallelic marker, such as a SNP, there are 3 possible genotypes: homozygote for the at risk variant, heterozygote, and non carrier of the at risk variant. Risk associated with variants at multiple loci can be used to estimate overall risk. For multiple SNP variants, there are k possible genotypes k=3ⁿ×2^{p}; where n is the number autosomal loci and p the number of gonosomal (sex chromosomal) loci. Overall risk assessment calculations usually assume that the relative risks of different genetic variants multiply, i.e. the overall risk (e.g., RR or OR) associated with a particular genotype combination is the product of the risk values for the genotype at each locus. If the risk presented is the relative risk for a person, or a specific genotype for a person, compared to a reference population with matched gender and ethnicity, then the combined risk is the product of the locus specific risk values and also corresponds to an overall risk estimate compared with the population. If the risk for a person is based on a comparison to non-carriers of the at risk allele, then the combined risk corresponds to an estimate that compares the person with a given combination of genotypes at all loci to a group of individuals who do not carry risk variants at any of those loci. The group of non-carriers of any at risk variant has the lowest estimated risk and has a combined risk, compared with itself (i.e., non-carriers) of 1.0, but has an overall risk, compare with the population, of less than 1.0. It should be noted that the group of non-carriers can potentially be very small, especially for large number of loci, and in that case, its relevance is correspondingly small.

The multiplicative model is a parsimonious model that usually fits the data of complex traits reasonably well. Deviations from multiplicity have been rarely described in the context of common variants for common diseases, and if reported are usually only suggestive since very large sample sizes are usually required to be able to demonstrate statistical interactions between loci.

By way of an example, let us consider the three variants rs4151060, rs7812812 and rs9585777 shown herein to be associated with risk of cutaneous melanoma. The total number of possible combination for these three markers is 3³=27, and all of these should be considered for overall risk assessment. We can extend the case to include markers in the ASIP (rs1015362; rs4911414), TYR (R402Q) and MC1R (D84E, R151C, R160W, D294H) genes. The total number of theoretical genotypic combinations is then 3¹⁰=59049. Some of those genotypic classes are very rare, but are still possible, and should be considered for overall risk assessment. In a similar fashion, any other combinations of markers may be assessed to determine overall risk.

It is likely that the multiplicative model applied in the case of multiple genetic variant will also be valid in conjugation with non-genetic risk variants assuming that the genetic variant does not clearly correlate with the “environmental” factor. In other words, genetic and non-genetic at-risk variants can be assessed under the multiplicative model to estimate combined risk, assuming that the non-genetic and genetic risk factors do not interact.

Using the same quantitative approach, the combined or overall risk associated with a plurality of variants associated with CM, BCC and SCC, as described herein, may be assessed.

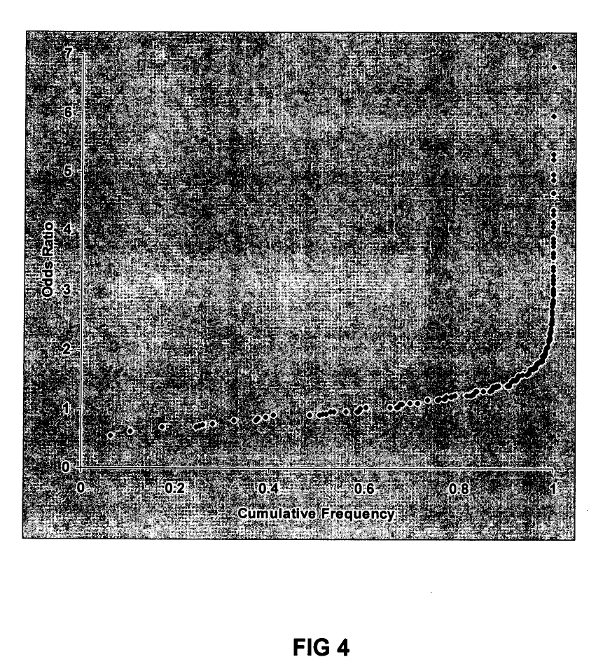

There is no evidence of interaction between the 1p36 and 1q43 loci (the r² between the 1p36 and 1q43 markers was <0.002 in both cases and controls) shown herein to be associated with risk of BCC. We recently reported that pigmentation trait-associated variants in the ASIP, TYR loci confer risk of BCC, in addition to the known effect of strong red hair colour variants of MC1R (Gudbjartsson et al., 40:1313-18 (2008)). Assuming a multiplicative mode of allelic and intergenic interactions, we can generate a risk model for BCC incorporating 1p36, 1q42, and these three pigmentation trait-associated loci (FIG. 4). The relative risks predicted by this model range up to 12.3-fold for individuals homozygous for all risk alleles, relative to those homozygous for all protective alleles. Five percent of the population has a predicted 1.67-fold or higher increased risk relative to the population average. Given that the incidence of BCC is so high, many individuals fall into these higher risk classes. A population attributable risk (PAR) of 17% each for rs7538876 and rs801114 can be estimated, and the joint PAR estimate for both variants together is 31%. Using previously published data (Gudbjartsson et al., 40:1313-18 (2008)) we also estimated BCC PARsii of MC1R strong red hair colour variants (10%), TYR R4029 (7%) and the ASIP AH haplotype (4%). The joint PAR for all 5 loci is 45%. Thus nearly half of all BCC diagnoses can be attributed to these genetic variants. Obviously, the skilled person will appreciate that additional variants can be added in a similar fashion to this model. Furthermore, any suitable combinations of these variants, or other variants found to confer susceptibility to CM, SCC or BCC can be assessed using comparable risk models, and the use of the variants disclosed herein in such combinations is also within scope of the present invention.

### Linkage Disequilibrium

The natural phenomenon of recombination, which occurs on average once for each chromosomal pair during each meiotic event, represents one way in which nature provides variations in sequence (and biological function by consequence). It has been discovered that recombination does not occur randomly in the genome; rather, there are large variations in the frequency of recombination rates, resulting in small regions of high recombination frequency (also called recombination hotspots) and larger regions of low recombination frequency, which are commonly referred to as Linkage Disequilibrium (LD) blocks (Myers, S. et al., Biochem Soc Trans 34:526-530 (2006); Jeffreys, A. J., et al., Nature Genet 29:217-222 (2001); May, C. A., et al., Nature Genet 31:272-275 (2002)).

Linkage Disequilibrium (LD) refers to a non-random assortment of two genetic elements. For example, if a particular genetic element (e.g., an allele of a polymorphic marker, or a haplotype) occurs in a population at a frequency of 0.50 (50%) and another element occurs at a frequency of 0.50 (50%), then the predicted occurrence of a person's having both elements is 0.25 (25%), assuming a random distribution of the elements. However, if it is discovered that the two elements occur together at a frequency higher than 0.25, then the elements are said to be in linkage disequilibrium, since they tend to be inherited together at a higher rate than what their, independent frequencies of occurrence (e.g., allele or haplotype frequencies) would predict. Roughly speaking, LD is generally correlated with the frequency of recombination events between the two elements. Allele or haplotype frequencies can be determined in a population by genotyping individuals in a population and determining the frequency of the occurence of each allele or haplotype in the population. For populations of diploids, e.g., human populations, individuals will typically have two alleles or allelic combinations for each genetic element (e.g., a marker, haplotype or gene).

Many different measures have been proposed for assessing the strength of linkage disequilibrium (LD; reviewed in Devlin, B. & Risch, N., Genomics 29:311-22 (1995))). Most capture the strength of association between pairs of biallelic sites. Two important pairwise measures of LD are r² (sometimes denoted Δ²) and |D′| (Lewontin, R., Genetics 49:49-67 (1964); Hill, W. G. & Robertson, A. Theor. Appl. Genet. 22:226-231 (1968)). Both measures range from 0 (no disequilibrium) to 1 (‘complete’ disequilibrium), but their interpretation is slightly different. |D′| is defined in such a way that it is equal to 1 if just two or three of the possible haplotypes for two markers are present, and it is <1 if all four possible haplotypes are present. Therefore, a value of |D′| that is <1 indicates that historical recombination may have occurred between two sites (recurrent mutation can also cause |D′| to be <1, but for single nucleotide polymorphisms (SNPs) this is usually regarded as being less likely than recombination). The measure r² represents the statistical correlation between two sites, and takes the value of 1 if only two haplotypes are present.

The r² measure is arguably the most relevant measure for association mapping, because there is a simple inverse relationship between r² and the sample size required to detect association between susceptibility loci and SNPs. These measures are defined for pairs of sites, but for some applications a determination of how strong LD is across an entire region that contains many polymorphic sites might be desirable (e.g., testing whether the strength of LD differs significantly among loci or across populations, or whether there is more or less LD in a region than predicted under a particular model). Roughly speaking, r measures how much recombination would be required under a particular population model to generate the LD that is seen in the data. This type of method can potentially also provide a statistically rigorous approach to the problem of determining whether LD data provide evidence for the presence of recombination hotspots. For the methods described herein, a significant r² value between markers indicative of the markers being in linkage disequilibrium can be at least 0.1, such as at least 0.15, 0.20, 0.25, 0.30, 0.35, 0.40, 0.45, 0.50, 0.55, 0.60, 0.65, 0.70, 0.75, 0.80, 0.85, 0.90, 0.91, 0.92, 0.93, 0.94, 0.95, 0.96, 0.97, 0.98, or at least 0.99. In one preferred embodiment, the significant r² value can be at least 0.2. Alternatively, markers in linkage disequilibrium are characterized by values of |D′| of at least 0.2, such as 0.3, 0.4, 0.5, 0.6, 0.7, 0.8, 0.85, 0.9, 0.95, 0.96, 0.97, 0.98, or at least 0.99. Thus, linkage disequilibrium represents a correlation between alleles of distinct markers. In certain embodiments, linkage disequilibrium is defined in terms of values for both the r² and |D′| measures. In one such embodiment, a significant linkage disequilibrium is defined as r²>0.1 and |D′|>0.8, and markers fulfilling these criteria are said to be in linkage disequilibrium. In another embodiment, a significant linkage disequilibrium is defined as r²>0.2 and |D′|>0.9. Other combinations and permutations of values of r² and |D′| for determining linkage disequilibrium are also contemplated, and are also within the scope of the invention. Linkage disequilibrium can be determined in a single human population, as defined herein, or it can be determined in a collection of samples comprising individuals from more than one human population. In one embodiment of the invention, LD is determined in a sample from one or more of the HapMap populations (Caucasian, African (Yuroban), Japanese, Chinese), as defined (http://www.hapmap.org). In one such embodiment, LD is determined in the CEU population of the HapMap samples (Utah residents with ancestry from northern and western Europe). In another embodiment, LD is determined in the YRI population of the HapMap samples (Yuroba in Ibadan, Nigeria). In another embodiment, LD is determined in the CHB population of the HapMap samples (Han Chinese from Beijing, China). In another embodiment, LD is determined in the JPT population of the HapMap samples (Japanese from Tokyo, Japan). In yet another embodiment, LD is determined in samples from the Icelandic population.

If all polymorphisms in the genome were independent at the population level (i.e., no LD), then every single one of them would need to be investigated in association studies, to assess all the different polymorphic states. However, due to linkage disequilibrium between polymorphisms, tightly linked polymorphisms are strongly correlated, which reduces the number of polymorphisms that need to be investigated in an association study to observe a significant association. Another consequence of LD is that many polymorphisms may give an association signal due to the fact that these polymorphisms are strongly correlated.

Genomic LD maps have been generated across the genome, and such LD maps have been proposed to serve as framework for mapping disease-genes (Risch, N. & Merkiangas, K, Science 273:1516-1517 (1996); Maniatis, N., et al., Proc Natl Acad Sci USA 99:2228-2233 (2002); Reich, D E et al, Nature 411:199-204 (2001)).

It is now established that many portions of the human genome can be broken into series of discrete haplotype blocks containing a few common haplotypes; for these blocks, linkage disequilibrium data provides little evidence indicating recombination (see, e.g., Wall., J. D. and Pritchard, J. K., Nature Reviews Genetics 4:587-597 (2003); Daly, M. et al., Nature Genet. 29:229-232 (2001); Gabriel, S. B. et al., Science 296:2225-2229 (2002); Patil, N. et al., Science 294:1719-1723 (2001); Dawson, E. et al., Nature 418:544-548 (2002); Phillips, M. S. et al., Nature Genet. 33:382-387 (2003)).

There are two main methods for defining these haplotype blocks: blocks can be defined as regions of DNA that have limited haplotype diversity (see, e.g., Daly, M. et al., Nature Genet. 29:229-232 (2001); Patil, N. et al., Science 294:1719-1723 (2001); Dawson, E. et al., Nature 418:544-548 (2002); Zhang, K. et al., Proc. Natl. Acad. Sci. USA 99:7335-7339 (2002)), or as regions between transition zones having extensive historical recombination, identified using linkage disequilibrium (see, e.g., Gabriel, S. B. et al., Science 296:2225-2229 (2002); Phillips, M. S. et al., Nature Genet. 33:382-387 (2003); Wang, N. et al., Am. J. Hum. Genet. 71:1227-1234 (2002); Stumpf, M. P., and Goldstein, D. B., Curr. Biol. 13:1-8 (2003)). More recently, a fine-scale map of recombination rates and corresponding hotspots across the human genome has been generated (Myers, S., et al., Science 310:321-32324 (2005); Myers, S. et al., Biochem Soc Trans 34:526530 (2006)). The map reveals the enormous variation in recombination across the genome, with recombination rates as high as 10-60 cM/Mb in hotspots, while closer to 0 in intervening regions, which thus represent regions of limited haplotype diversity and high LD. The map can therefore be used to define haplotype blocks/LD blocks as regions flanked by recombination hotspots. As used herein, the terms “haplotype block” or “LD block” includes blocks defined by any of the above described characteristics, or other alternative methods used by the person skilled in the art to define such regions.

Haplotype blocks (LD blocks) can be used to map associations between phenotype and haplotype status, using single markers or haplotypes comprising a plurality of markers. The main haplotypes can be identified in each haplotype block, and then a set of “tagging” SNPs or markers (the smallest set of SNPs or markers needed to distinguish among the haplotypes) can then be identified. These tagging SNPs or markers can then be used in assessment of samples from groups of individuals, in order to identify association between phenotype and haplotype. Markers shown herein to be associated with basal cell carcinoma, cutaneous melanoma and squamous cell carcinoma are such tagging markers. If desired, neighboring haplotype blocks can be assessed concurrently, as there may also exist linkage disequilibrium among the haplotype blocks.

It has thus become apparent that for any given observed association to a polymorphic marker in the genome, additional markers in the genome also show association. This is a natural consequence of the uneven distribution of LD across the genome, as observed by the large variation in recombination rates. The markers used to detect association thus in a sense represent “tags” for a genomic region (i.e., a haplotype block or LD block) that is associating with a given disease or trait, and as such are useful for use in the methods and kits of the present invention. One or more causative (functional) variants or mutations may reside within the region found to be associating to the disease or trait. The functional variant may be another SNP, a tandem repeat polymorphism (such as a minisatellite or a microsatellite), a transposable element, or a copy number variation, such as an inversion, deletion or insertion. Such variants in LD with the variants described herein may confer a higher relative risk (RR) or odds ratio (OR) than observed for the tagging markers used to detect the association. The present invention thus refers to the markers used for detecting association to the disease, as described herein, as well as markers in linkage disequilibrium with the markers. Thus, in certain embodiments of the invention, markers that are in LD with the markers originally used to detect an association may be used as surrogate markers. The surrogate markers have in one embodiment relative risk (RR) and/or odds ratio (OR) values smaller than originally detected. In other embodiments, the surrogate markers have RR or OR values greater than those initially determined for the markers initially found to be associating with the disease. An example of such an embodiment would be a rare, or relatively rare (such as <10% allelic population frequency) variant in LD with a more common variant (>10% population frequency) initially found to be associating with the disease. Identifying and using such surrogate markers for detecting the association can be performed by routine methods well known to the person skilled in the art, and are therefore within the scope of the present invention.

### Determination of Haplotype Frequency

The frequencies of haplotypes in patient and control groups can be estimated using an expectation-maximization algorithm (Dempster A. et al., J. R. Stat. Soc. 8, 39:1-38 (1977)). An implementation of this algorithm that can handle missing genotypes and uncertainty with the phase can be used. Under the null hypothesis, the patients and the controls are assumed to have identical frequencies. Using a likelihood approach, an alternative hypothesis is tested, where a candidate at-risk-haplotype, which can include the markers described herein, is allowed to have a higher frequency in patients than controls, while the ratios of the frequencies of other haplotypes are assumed to be the same in both groups. Likelihoods are maximized separately under both hypotheses and a corresponding 1-df likelihood ratio statistic is used to evaluate the statistical significance.

To look for at-risk and protective markers and haplotypes within a susceptibility region, for example within an LD block, association of all possible combinations of genotyped markers within the region is studied. The combined patient and control groups can be randomly divided into two sets, equal in size to the original group of patients and controls. The marker and haplotype analysis is then repeated and the most significant p-value registered is determined. This randomization scheme can be repeated, for example, over 100 times to construct an empirical distribution of p-values. In a preferred embodiment, a p-value of <0.05 is indicative of a significant marker and/or haplotype association.

### Haplotype Analysis

One general approach to haplotype analysis involves using likelihood-based inference applied to NEsted MOdels (Gretarsdottir S., et al., Nat. Genet. 35:131-38 (2003)). The method is implemented in the program NEMO, which allows for many polymorphic markers, SNPs and microsatellites. The method and software are specifically designed for case-control studies where the purpose is to identify haplotype groups that confer different risks. It is also a tool for studying LD structures. In NEMO, maximum likelihood estimates, likelihood ratios and p-values are calculated directly, with the aid of the EM algorithm, for the observed data treating it as a missing-data problem.

Even though likelihood ratio tests based on likelihoods computed directly for the observed data, which have captured the information loss due to uncertainty in phase and missing genotypes, can be relied on to give valid p-values, it would still be of interest to know how much information had been lost due to the information being incomplete. The information measure for haplotype analysis is described in Nicolae and Kong (Technical Report 537, Department of Statistics, University of Statistics, University of Chicago; Biometrics, 60(2):368-75 (2004)) as a natural extension of information measures defined for linkage analysis, and is implemented in NEMO.

### Association Analysis

For single marker association to a disease, the Fisher exact test can be used to calculate two-sided p-values for each individual allele. Correcting for relatedness among patients can be done by extending a variance adjustment procedure previously described (Risch, N. & Teng, J. Genome Res., 8:1273-1288 (1998)) for sibships so that it can be applied to general familial relationships. The method of genomic controls (Devlin, B. & Roeder, K. Biometrics 55:997 (1999)) can also be used to adjust for the relatedness of the individuals and possible stratification.

For both single-marker and haplotype analyses, relative risk (RR) and the population attributable risk (PAR) can be calculated assuming a multiplicative model (haplotype relative risk model) (Terwilliger, J. D. & Ott, J., Hum. Hered. 42:337-46 (1992) and Falk, C. T. & Rubinstein, P, Ann. Hum. Genet. 51 (Pt 3):227-33 (1987)), i.e., that the risks of the two alleles/haplotypes a person carries multiply. For example, if RR is the risk of A relative to a, then the risk of a person homozygote AA will be RR times that of a heterozygote Aa and RR² times that of a homozygote aa. The multiplicative model has a nice property that simplifies analysis and computaticns—haplotypes are independent, i.e., in Hardy-Weinberg equilibrium, within the affected population as well as within the control population. As a consequence, haplotype counts of the affecteds and controls each have multinomial distributions, but with different haplotype frequencies under the alternative hypothesis. Specifically, for two haplotypes, hᵢ and hⱼ, risk(hᵢ)/risk(hⱼ)=(fᵢ/pᵢ)/(fⱼ/pⱼ), where f and p denote, respectively, frequencies in the affected population and in the control population. While there is some power loss if the true model is not multiplicative, the loss tends to be mild except for extreme cases. Most importantly, p-values are always valid since they are computed with respect to null hypothesis.

An association signal detected in one association study may be replicated in a second cohort, ideally from a different population (e.g., different region of same country, or a different country) of the same or different ethnicity. The advantage of replication studies is that the number of tests performed in the replication study is usually quite small, and hence the less stringent the statistical measure that needs to be applied. For example, for a genome-wide search for susceptibility variants for a particular disease or trait using 300,000 SNPs, a correction for the 300,000 tests performed (one for each SNP) can be performed. Since many SNPs on the arrays typically used are correlated (i.e., in LD), they are not independent. Thus, the correction is conservative. Nevertheless, applying this correction factor requires an observed P-value of less than 0.05/300,000=1.7×10⁻⁷ for the signal to be considered significant applying this conservative test on results from a single study cohort. Obviously, signals found in a genome-wide association study with P-values less than this conservative threshold (i.e., more significant) are a measure of a true genetic effect, and replication in additional cohorts is not necessarily from a statistical point of view. Importantly, however, signals with P-values that are greater than this threshold may also be due to a true genetic effect. The sample size in the first study may not have been sufficiently large to provide an observed P-value that meets the conservative threshold for genome-wide significance, or the first study may not have reached genome-wide significance due to inherent fluctuations due to sampling. Since the correction factor depends on the number of statistical tests performed, if one signal (one SNP) from an initial study is replicated in a second case-control cohort, the appropriate statistical test for significance is that for a single statistical test, i.e., P-value less than 0.05. Replication studies in one or even several additional case-control cohorts have the added advantage of providing assessment of the association signal in additional populations, thus simultaneously confirming the initial finding and providing an assessment of the overall significance of the genetic variant(s) being tested in human populations in general.

The results from several case-control cohorts can also be combined to provide an overall assessment of the underlying effect. The methodology commonly used to combine results from multiple genetic association studies is the Mantel-Haenszel model (Mantel and Haenszel, J Natl Cancer Inst 22:719-48 (1959)). The model is designed to deal with the situation where association results from different populations, with each possibly having a different population frequency of the genetic variant, are combined. The model combines the results assuming that, the effect of the variant on the risk of the disease, a measured by the OR or RR, is the same in all populations, while the frequency of the variant may differ between the populations. Combining the results from several populations has the added advantage that the overall power to detect a real underlying association signal is increased, due to the increased statistical power provided by the combined cohorts. Furthermore, any deficiencies in individual studies, for example due to unequal matching of cases and controls or population stratification will tend to balance out when results from multiple cohorts are combined, again providing a better estimate of the true underlying genetic effect.

### Risk Assessment and Diagnostics

Within any given population, there is an absolute risk of developing a disease or trait, defined as the chance of a person developing the specific disease or trait over a specified time-period. For example, a woman's lifetime absolute risk of breast cancer is one in nine. That is to say, one woman in every nine will develop breast cancer at some point in their lives. Risk is typically measured by looking at very large numbers of people, rather than at a particular individual. Risk is often presented in terms of Absolute Risk (AR) and Relative Risk (RR). Relative Risk is used to compare risks associating with two variants or the risks of two different groups of people. For example, it can be used to compare a group of people with a certain genotype with another group having a different genotype. For a disease, a relative risk of 2 means that one group has twice the chance of developing a disease as the other group. The risk presented is usually the relative risk for a person, or a specific genotype of a person, compared to the population with matched gender and ethnicity. Risks of two individuals of the same gender and ethnicity could be compared in a simple manner. For example, if, compared to the population, the first individual has relative risk 1.5 and the second has relative risk 0.5, then the risk of the first individual compared to the second individual is 1.5/0.5=3.

### Risk Calculations

The creation of a model to calculate the overall genetic risk involves two steps: i) conversion of odds-ratios for a single genetic variant into relative risk and ii) combination of risk from multiple variants in different genetic loci into a single relative risk value.

Deriving Risk from Odds-Ratios

Most gene discovery studies for complex diseases that have been published to date in authoritative journals have employed a case-control design because of their retrospective setup. These studies sample and genotype a selected set of cases (people who have the specified disease condition) and control individuals. The interest is in genetic variants (alleles) which frequency in cases and controls differ significantly.

The results are typically reported in odds ratios, that is the ratio between the fraction (probability) with the risk variant (carriers) versus the non-risk variant (non-carriers) in the groups of affected versus the controls, i.e. expressed in terms of probabilities conditional on the affection status:

OR=(Pr(c|A)/Pr(nc|A))/(Pr(c|C)/Pr(nc|C))

Sometimes it is however the absolute risk for the disease that we are interested in, i.e. the fraction of those individuals carrying the risk variant who get the disease or in other words the probability of getting the disease. This number cannot be directly measured in case-control studies, in part, because the ratio of cases versus controls is typically not the same as that in the general population. However, under certain assumption, we can estimate the risk from the odds ratio.

It is well known that under the rare disease assumption, the relative risk of a disease can be approximated by the odds ratio. This assumption may however not hold for many common diseases. Still, it turns out that the risk of one genotype variant relative to another can be estimated from the odds ratio expressed above. The calculation is particularly simple under the assumption of random population controls where the controls are random samples from the same population as the cases, including affected people rather than being strictly unaffected individuals. To increase sample size and power, many of the large genome-wide association and replication studies use controls that were neither age-matched with the cases, nor were they carefully scrutinized to ensure that they did not have the disease at the time of the study. Hence, while not exactly, they often approximate a random sample from the general population.

It is noted that this assumption is rarely expected to be satisfied exactly, but the risk estimates are usually robust to moderate deviations from this assumption.

Calculations show that for the dominant and the recessive models, where we have a risk variant carrier, “c”, and a non-carrier, “nc”, the odds ratio of individuals is the same as the risk ratio between these variants:

OR=Pr(A|c)/Pr(A|nc)=r

And likewise for the multiplicative model, where the risk is the product of the risk associated with the two allele copies, the allelic odds ratio equals the risk factor:

OR=Pr(A|aa)/Pr(A|ab)=Pr(A|ab)/Pr(A|bb)=r

Here “a” denotes the risk allele and “b” the non-risk allele. The factor “r” is therefore the relative risk between the allele types.

For many of the studies published in the last few years, reporting common variants associated with complex diseases, the multiplicative model has been found to summarize the effect adequately and most often provide a fit to the data superior to alternative models such as the dominant and recessive models.

### The Risk Relative to the Average Population Risk

It is most convenient to represent the risk of a genetic variant relative to the average population since it makes it easier to communicate the lifetime risk for developing the disease compared with the baseline population risk. For example, in the multiplicative model we can calculate the relative population risk for variant “aa” as:

RR(aa)=Pr(A|aa)/Pr(A)=(Pr(A|aa)/Pr(A|bb))/(Pr(A)/Pr(A|bb))=r²/(Pr(aa)r²+Pr(ab)r+Pr(bb))=r²/(p²r²+2pqr+q²)=r²/R

Here “p” and “q” are the allele frequencies of “a” and “b” respectively. Likewise, we get that RR(ab)=r/R and RR(bb)=1/R. The allele frequency estimates may be obtained from the publications that report the odds-ratios and from the HapMap database. Note that in the case where we do not know the genotypes of an individual, the relative genetic risk for that test or marker is simply equal to one.

As an example, in basal cell carcinoma risk, allele A of marker rs7538876 on chromosome 1p36 has an allelic OR of 1.28 and a frequency (p) of around 0.41 in white populations. The genotype relative risk compared to genotype GG are estimated based on the multiplicative model.

For AA it is 1.28×1.28=1.64; for AG it is simply the OR 1.28, and for GG it is 1.0 by definition.

The frequency of allele G is q=1−p=1−0.41=0.59. Population frequency of each of the three possible genotypes at this marker is:

Pr(AA)=p²=0.17, Pr(AG)=2pq=0.48, and Pr(GG)=q²=0.35

The average population risk relative to genotype GG (which is defined to have a risk of one) is:

R=0.17×1.64+0.48×1.28+0.35×1=1.24

Therefore, the risk relative to the general population (RR) for individuals who have one of the following genotypes at this marker is:

RR(AA)=1.64/1.24=1.32, RR(AG)=1.28/1.24=1.03, RR(GG)=1/1.24=0.81.

Combining the Risk from Multiple Markers

When genotypes of many SNP variants are used to estimate the risk for an individual a multiplicative model for risk can generally be assumed. This means that the combined genetic risk relative to the population is calculated as the product of the corresponding estimates for individual markers, e.g. for two markers g1 and g2:

RR(g1,g2)=RR(g1)RR(g2)

The underlying assumption is that the risk factors occur and behave independently, i.e. that the joint conditional probabilities can be represented as products:

Pr(A|g1,g2)=Pr(A|g1)Pr(A|g2)/Pr(A) and Pr(g1,g2)=Pr(g1)Pr(g2)

Obvious violations to this assumption are markers that are closely spaced on the genome, i.e. in linkage disequilibrium, such that the concurrence of two or more risk alleles is correlated. In such cases, we can use so called haplotype modeling where the odds-ratios are defined for all allele combinations of the correlated SNPs.

As is in most situations where a statistical model is utilized, the model applied is not expected to be exactly true since it is not based on an underlying bio-physical model. However, the multiplicative model has so far been found to fit the data adequately, i.e. no significant deviations are detected for many common diseases for which many risk variants have been discovered.

As an example, an individual who has the following genotypes at 4 hypothetical markers associated with a particular disease along with the risk relative to the population at each marker:

| Marker | Genotype | Calculated risk |
|---|---|---|
| M1 | CC | 1.03 |
| M2 | GG | 1.30 |
| M3 | AG | 0.88 |
| M4 | TT | 1.54 |

Combined, the overall risk relative to the population for this individual is: 1.03×1.30×0.88×1.54=1.81.

### Adjusted Life-Time Risk

The lifetime risk of an individual is derived by multiplying the overall genetic risk relative to the population with the average life-time risk of the disease in the general population of the same ethnicity and gender and in the region of the individual's geographical origin. As there are usually several epidemiologic studies to choose from when defining the general population risk; we will pick studies that are well-powered for the disease definition that has been used for the genetic variants.

For example, for a particular disease, if the overall genetic risk relative to the population is 1.8 for a white male, and if the average life-time risk of the disease for individuals of his demographic is 20%, then the adjusted lifetime risk for him is 20%×1.8=36%.

Note that since the average RR for a population is one, this multiplication model provides the same average adjusted life-time risk of the disease. Furthermore, since the actual life-time risk cannot exceed 100%, there must be an upper limit to the genetic RR.

### Risk Assessment

As described herein, certain polymorphic markers and haplotypes comprising such markers are found to be useful for risk assessment of the cancers CM, BCC and SCC. Risk assessment can involve the use of the markers for diagnosing a susceptibility to the cancer. Particular alleles of certain polymorphic markers are found more frequently in individuals with a particular cancer, than in individuals without diagnosis of the cancer. Therefore, these marker alleles have predictive value for detecting the cancer, or a susceptibility to the cancer, in an individual. Tagging markers within haplotype blocks or LD blocks comprising at-risk markers, such as the markers of the present invention, can be used as surrogates for other markers and/or haplotypes within the haplotype block or LD block. Such surrogate markers can also sometimes be located outside the physical boundaries of such a haplotype block or LD block, either in close vicinity of the LD block/haplotype block, but possibly also located in a more distant genomic location.

Long-distance LD can for example arise if particular genomic regions (e.g., genes) are in a functional relationship. For example, if two genes encode proteins that play a role in a shared metabolic pathway, then particular variants in one gene may have a direct impact on observed variants for the other gene. Let us consider the case where a variant in one gene leads to increased expression of the gene product. To counteract this effect and preserve overall flux of the particular pathway, this variant may have led to selection of one (or more) variants at a second gene that confers decreased expression levels of that gene. These two genes may be located in different genomic locations, possibly on different chromosomes, but variants within the genes are in apparent LD, not because of their shared physical location within a region of high LD, but rather due to evolutionary forces. Such LD is also contemplated and within scope of the present invention. The skilled person will appreciate that many other scenarios of functional gene-gene interaction are possible, and the particular example discussed here represents only one such possible scenario.

Markers with values of r² equal to 1 are perfect surrogates for the at-risk variants (anchor variants), i.e. genotypes for one marker perfectly predicts genotypes for the other. Markers with smaller values of r² than 1 can also be surrogates for the at-risk variant, or alternatively represent variants with relative risk values as high as or possibly even higher than the at-risk variant. In certain preferred embodiments, markers with values of r² to the at-risk anchor variant are useful surrogate markers. The at-risk variant identified may not be the functional variant itself, but is in this instance in linkage disequilibrium with the true functional variant. The functional variant may be a SNP, but may also for example be a tandem repeat, such as a minisatellite or a microsatellite, a transposable element (e.g., an Alu element), or a structural alteration, such as a deletion, insertion or inversion (sometimes also called copy number variations, or CNVs). The present invention encompasses the assessment of such surrogate markers for the markers as disclosed herein. Such markers are annotated, mapped and listed in public databases, as well known to the skilled person, or can alternatively be readily identified by sequencing the region or a part of the region identified by the markers of the present invention in a group of individuals, and identify polymorphisms in the resulting group of sequences. As a consequence, the person skilled in the art can readily and without undue experimentation identify and genotype surrogate markers in linkage disequilibrium with the markers and/or haplotypes as described herein. The tagging or surrogate markers in LD with the at-risk variants detected, also have predictive value for detecting association to the disease (e.g., the markers as set forth in Tables 6 and 7 and 14-17 as surrogate markers useful for detecting risk of BCC and CM), or a susceptibility to the disease, in an individual.

The present invention can in certain embodiments be practiced by assessing a sample comprising genomic DNA from an individual for the presence of certain variants described herein to be associated with the cancers Cutaneous Melanoma (CM), Basal Cell Carcinoma (BCC) and Squamous Cell Carcinoma (SCC). Such assessment includes steps of detecting the presence or absence of at least one allele of at least one polymorphic marker, using methods well known to the skilled person and further described herein, and based on the outcome of such assessment, determine whether the individual from whom the sample is derived is at increased or decreased risk (i.e., increased or decreased susceptibility) of the cancer. Alternatively, the invention can be practiced utilizing a dataset comprising information about the genotype status of at least one polymorphic marker described herein to be associated with CM, BCC and/or SCC (or markers in linkage disequilibrium with at least one marker shown herein to be associated with CM, BCC and/or SCC). In other words, a dataset containing information about such genetic status, for example in the form of genotype counts at a certain polymorphic marker, or a plurality of markers (e.g., an indication of the presence or absence of certain at-risk alleles), or actual genotypes for one or more markers, can be queried for the presence or absence of certain at-risk alleles at certain polymorphic markers shown by the present inventors to be associated with CM, BCC and/or SCC. A positive result for a variant (e.g., marker allele) associated with the cancer, as shown herein, is indicative of the individual from which the dataset is derived is at increased susceptibility (increased risk) of the cancer.

In certain embodiments of the invention, a polymorphic marker is correlated to a disease by referencing genotype data for the polymorphic marker to a database, such as a look-up table, that comprises correlation data between at least one allele of the polymorphism and the disease. In some embodiments, the table comprises a correlation for one polymorphism. In other embodiments, the table comprises a correlation for a plurality of polymorphisms. In both scenarios, by referencing to a look-up table that gives an indication of a correlation between a marker and the disease, a risk for the disease, or a susceptibility to the disease, can be identified in the individual from whom the sample is derived. In some embodiments, the correlation is reported as a statistical measure. The statistical measure may be reported as a risk measure, such as a relative risk (RR), an absolute risk (AR) or an odds ratio (OR).

Risk markers may be useful for risk assessment and diagnostic purposes, either alone or in combination. Results of disease risk assessment based on the markers described herein can also be combined with data for other genetic markers or risk factors for the disease, to establish overall risk. Thus, even in cases where the increase in risk by individual markers is relatively modest, e.g. on the order of 10-30%, the association may have significant implications when combined with other risk markers. Thus, relatively common variants may have significant contribution to the overall risk (Population Attributable Risk is high), or combination of markers can be used to define groups of individual who, based on the combined risk of the markers, is at significant combined risk of developing the disease. One example of such combined risk assessment is provided by the risk model presented in FIG. 4 herein.

In certain embodiments of the invention, a plurality of variants (genetic markers, haplotypes and/or biomarkers) is used for overall risk assessment. These variants are in one embodiment selected from the variants as disclosed herein. Other embodiments include the use of the variants of the present invention in combination with other variants known to be useful for diagnosing a susceptibility to cancer (e.g., CM, SCC and/or BCC). In such embodiments, the genotype status of a plurality of markers and/or haplotypes is determined in an individual, and the status of the individual compared with the population frequency of the associated variants, or the frequency of the variants in clinically healthy subjects, such as age-matched and sex-matched subjects. Methods known in the art, such as multivariate analyses or joint risk analyses, such as those described herein, or other methods known to the person skilled in the art, may subsequently be used to determine the overall risk conferred based on the genotype status at the multiple loci. Assessment of risk based on such analysis may subsequently be used in the methods, uses and kits of the invention, as described herein.

### Study Population

In a general sense, the methods and kits described herein can be utilized from samples containing nucleic acid material (DNA or RNA) from any source and from any individual, or from genotype or sequence data derived from such samples. In preferred embodiments, the individual is a human individual. The individual can be an adult, child, or fetus. The nucleic acid source may be any sample comprising nucleic acid material, including biological samples, or a sample comprising nucleic acid material derived therefrom. The present invention also provides for assessing markers and/or haplotypes in individuals who are members of a target population. Such a target population is in one embodiment a population or group of individuals at risk of developing the disease, based on other genetic factors, biomarkers, biophysical parameters or other health and/or lifestyle parameters (e.g., history of the particular cancer, exposure to sunlight or other sources of ultraviolet radiation, etc.).

The invention provides for embodiments that include individuals from specific age subgroups, such as those over the age of 40, over age of 45, or over age of 50, 55, 60, 65, 70, 75, 80, or 85. Other embodiments of the invention pertain to other age groups, such as individuals aged less than 85, such as less than age 80, less than age 75, or less than age 70, 65, 60, 55, 50, 45, 40, 35, or age 30. Other embodiments relate to individuals with age at onset of the disease in any of the age ranges described in the above. It is also contemplated that a range of ages may be relevant in certain embodiments, such as age at onset at more than age 45 but less than age 60. Other age ranges are however also contemplated, including all age ranges bracketed by the age values listed in the above. The invention furthermore relates to individuals of either gender, males or females.

The Icelandic population is a Caucasian population of Northern European ancestry. A large number of studies reporting results of genetic linkage and association in the Icelandic population have been published in the last few years. Many of those studies show replication of variants, originally identified in the Icelandic population as being associating with a particular disease, in other populations (Sulem, P., et al. Nat Genet May 17, 2009 (Epub ahead of print); Rafnar, T., et al. Nat Genet 41:221-7 (2009); Gretarsdottir, S., et al. Ann Neurol 64:402-9 (2008); Stacey, S. N., et al. Nat Genet 40:1313-18 (2008); Gudbjartsson, D. F., et al. Nat Genet 40:886-91 (2008); Styrkarsdottir, U., et al. N Engl J Med 358:2355-65 (2008); Thorgeirsson, T., et al. Nature 452:638-42 (2008); Gudmundsson, J., et al. Nat Genet. 40:281-3 (2008); Stacey, S. N., et al., Nat Genet. 39:865-69 (2007); Helgadottir, A., et al., Science 316:1491-93 (2007); Steinthorsdottir, V., et al., Nat Genet. 39:770-75 (2007); Gudmundsson, J., et al., Nat Genet. 39:631-37 (2007); Frayling, T M, Nature Reviews Genet 8:657-662 (2007); Amundadottir, et al., Nat Genet. 38:652-58 (2006); Grant, S. F., et al., Nat Genet. 38:320-23 (2006)). Thus, genetic findings in the Icelandic population have in general been replicated in other populations, including populations from Africa and Asia.

It is thus believed that the markers described herein to be associated with particular cancers (CM, BCC and/or SCC) will show similar association in other human populations. Particular embodiments comprising individual human populations are thus also contemplated and within the scope of the invention. Such embodiments relate to human subjects that are from one or more human population including, but not limited to, Caucasian populations, European populations, American populations, Eurasian populations, Asian populations, Central/South Asian populations, East Asian populations, Middle Eastern populations, African populations, Hispanic populations, and Oceanian populations. European populations include, but are not limited to, Swedish, Norwegian, Finnish, Russian, Danish, Icelandic, Irish, Kelt, English, Scottish, Dutch, Belgian, French, German, Spanish, Portugues, Italian, Polish, Bulgarian, Slavic, Serbian, Bosnian, Czech, Greek and Turkish populations. In certain embodiments, the invention relates to individuals of Caucasian origin.

The racial contribution in individual subjects may also be determined by genetic analysis. Genetic analysis of ancestry may be carried out using unlinked microsatellite markers such as those set out in Smith et al. (Am J Hum Genet 74, 1001-13 (2004)).

In certain embodiments, the invention relates to markers and/or haplotypes identified in specific populations, as described in the above. The person skilled in the art will appreciate that measures of linkage disequilibrium (LD) may give different results when applied to different populations. This is due to different population history of different human populations as well as differential selective pressures that may have led to differences in LD in specific genomic regions. It is also well known to the person skilled in the art that certain markers, e.g. SNP markers, haye different population frequency in different populations, or are polymorphic in one population but not in another. The person skilled in the art will however apply the methods available and as thought herein to practice the present invention in any given human population. This may include assessment of polymorphic markers in the LD region of the present invention, so as to identify those markers that give strongest association within the specific population. Thus, the at-risk variants of the present invention may reside on different haplotype background and in different frequencies in various human populations. However, utilizing methods known in the art and the markers of the present invention, the invention can be practiced in any given human population.

### Utility of Genetic Testing

The person skilled in the art will appreciate and understand that the variants described herein in general do not, by themselves, provide an absolute identification of individuals who will develop a particular form of cancer. The variants described herein do however indicate increased and/or decreased likelihood that individuals carrying the at-risk or protective variants of the invention will develop a cancer such as CM, BCC and/or SCC. This information is however extremely valuable in itself, as outlined in more detail in the below, as it can be used to, for example, initiate preventive measures at an early stage, perform regular physical and/or mental exams to monitor the progress and/or appearance of symptoms, or to schedule exams at a regular interval to identify early symptoms, so as to be able to apply treatment at an early stage.

The knowledge about a genetic variant that confers a risk of developing a particular disease offers the opportunity to apply a genetic test to distinguish between individuals with increased risk of developing the disease (i.e. carriers of the at-risk variant) and those with decreased risk of developing the disease (i.e. carriers of the protective variant). The core values cf genetic testing, for individuals belonging to both of the above mentioned groups, are the possibilities of being able to diagnose a susceptibility or predisposition to a disease at an early stage and provide information to the clinician about prognosis/aggressiveness of disease in order to be able to apply the most appropriate treatment.

Individuals with a family history of CM, BCC and/or SCC and carriers of at-risk variants may benefit from genetic testing since the knowledge of the presence of a genetic risk factor, or evidence for increased risk of being a carrier of one or more risk factors, may provide increased incentive for implementing a healthier lifestyle, by avoiding or minimizing known environmental, risk factors for the cancer. Genetic testing of CM, BCC and/or SCC patients may furthermore give valuable information about the primary cause of the disease and can aid the clinician in selecting the best treatment options and medication for each individual.

Genetic Testing for Melanoma. Relatives of melanoma patients are themselves at increased risk of melanoma, suggesting an inherited predisposition [Amundadottir, et al., (2004), PLoS Med, 1, e65. Epub 2004 Dec. 28.]. A series of linkage based studies implicated CDKN2a on 9p21 as a major CM susceptibility gene [Bataille, (2003), Eur J Cancer, 39, 1341-7.]. CDK4 was identified as a pathway candidate shortly afterwards, however mutations have only been observed in a few families worldwide [Zuo, et al., (1996), Nat Genet, 12, 97-9.]. CDKN2a encodes the cyclin dependent kinase inhibitor p16 which inhibits CDK4 and CDK6, preventing G1-S cell cycle transit. An alternate transcript of CKDN2a produces p14ARF, encoding a cell cycle inhibitor that acts through the MDM2-p53 pathway. It is likely that CDKN2a mutant melanocytes are deficient in cell cycle control or the establishment of senescence, either as a developmental state or in response to DNA damage. Overall penetrance of CDKN2a mutations in familial CM cases is 67% by age 80. However penetrance is increased in areas of high melanoma prevalence [Bishop, et al., (2002), J Natl Cancer Inst, 94, 894-903].

Individual who are at increased risk of melanoma might be offered regular skin examinations to identify incipient tumours, and they might be counselled to avoid excessive UV exposure. Chemoprevention either using sunscreens or pharmaceutical agents [Bowden, (2004), Nat Rev. Cancer, 4, 23-35.] might be employed. For individuals who have been diagnosed with melanoma, knowledge of the underlying genetic predisposition may be useful in determining appropriate treatments and evaluating risks of recurrence and new primary tumours.

Endogenous host risk factors for CM are in part under genetic control. It follows that a proportion of the genetic risk for CM resides in the genes that underpin variation in pigmentation and nevi. The Melanocortin 1 Receptor (MC1R) is a G-protein coupled receptor involved in promoting the switch from pheomelanin to eumelanini synthesis. Numerous, well characterized variants of the MC1R gene have been implicated in red haired, pale skinned and freckle prone phenotypes. We and others have demonstrated the MC1R variants confer risk of melanoma (Gudbjartsson et. al. Nature Genetics 40:886-91 (2008)). Other pigmentation trait-associated variants, in the ASIP, TYR and TYRP1 genes have also been implicated in melanoma risk (Gudbjartsson et. al., Nature Genetics, 40:886-91 (2008)). ASIP encodes the agouti signaling protein, a negative regulator of the melanocortin 1 receptor. TYR and TYRP1 are enzymes involved in melanin synthesis and are regulated by the MC1R pathway. Individuals at risk for BCC and/or SCC might be offered regular skin examinations to identify incipient tumours, and they might be counseled to avoid excessive UV exposure. Chemoprevention either using sunscreens or pharmaceutical agents [Bowden, (2004), Nat Rev Cancer, 4, 23-35.] might, be employed. For individuals who have been diagnosed with BCC or SCC, knowledge of the underlying genetic predisposition may be useful ip determining appropriate treatments and evaluating risks of recurrence and new primary tumours. Screening for susceptibility to BCC or SCC might be important in planning the clinical management of transplant recipients and other immunosuppressed individuals.

Genetic Testing for Basal Cell Carcinoma and Squamous Cell Carcinoma. A positive family history is a risk factor for SCC and BCC [Hemminki, et al., (2003), Arch Dermatol, 139, 885-9; Vitasa, et al., (1990), Cancer, 65, 2811-7] suggesting an inherited component to the risk of BCC and/or SCC. Several rare genetic conditions have been associated with increased risks of BCC and/or SCC, including Nevoid Basal Cell Syndrome (Gorlin's Syndrome), Xeroderma Pigmentosum (XP), and Bazex's Syndrome. XP is underpinned by mutations in a variety of XP complementation group genes. Gorlin's Syndrome results from mutations in the PTCH1 gene. In addition, variants in the CYP2D6 and GSTT1 genes have been associated with BCC [Wong, et al., (2003), BMJ, 327, 794-8]. Polymorphisms in numerous genes have been associated with SCC risk.

Fair pigmentation traits are known risk factors for BCC and/or SCC and are thought act, at least in part, through a reduced protection from UV irradiation. Thus, genes underlying these fair pigmentation traits have been associated with risk. MC1R, ASIP, and TYR have been shown to confer risk for SCC and/or BCC (Gudbjartsson et. al., Nature Genetics, 40:886-91) [Bastiaens, et al., (2001), Am J Hum Genet, 68, 884-94; Han, et al., (2006), Int J Epidemiol, 35, 1514-21]. However, pigmentation characteristics do not completely account for the effects of MC1R, ASIP, and TYR variants. This may be because self-reported pigmentation traits do not adequately reflect those aspects of pigmentation status that relate best to skin cancer risk. It may also indicate that MC1R, ASIP and TYR have risk-associated functions that are not directly related to easily observable pigmentation traits (Gudbjartsson et. al., Nature Genetics, 40:886-91 (2008))[Rees, (2006), J Invest Dermatol, 126, 1691-2]. This indicates that genetic testing for pigmentation trait associated variants may have increased utility in BCC and/or SCC screening over and above what can be obtained from observing patients' pigmentation phenotypes.

### Methods

Methods for risk assessment and risk management of cancer selected from CM, BCC and SCC are described herein and are encompassed by the invention. The invention also encompasses methods of assessing an individual for probability of response to a therapeutic agent for these cancers, methods for predicting the effectiveness of a therapeutic agent for cancer, nucleic acids, polypeptides and antibodies and computer-implemented functions. Kits for assaying a sample from a subject to detect susceptibility to cancer are also encompassed by the invention.

### Diagnostic and Screening Methods

In certain embodiments, the present invention pertains to methods of diagnosing, or aiding in the diagnosis of, a cancer selected from CM, BCC and SCC, or a susceptibility to the cancer, by detecting particular alleles at genetic markers that appear more frequently in cancer subjects or subjects who are susceptible to cancer. In particular embodiments, the invention is a method of determining a susceptibility to cancer by detecting at least one allele of at least one polymorphic marker (e.g., the markers described herein). In other embodiments, the invention relates to a method of diagnosing a susceptibility to cancer by detecting at least one allele of at least one polymorphic marker. The present invention describes methods whereby detection of particular alleles of particular markers or haplotypes is indicative of a susceptibility to cancer. Such prognostic or predictive assays can also be used to determine prophylactic treatment of a subject prior to the onset of symptoms of the cancer, or prior to development of a malignant form of the cancer.

The present invention pertains in some embodiments to methods of clinical applications of diagnosis, e.g., diagnosis performed by a medical professional. In other embodiments, the invention pertains to methods of diagnosis or determination of a susceptibility performed by a layman. The layman can be the customer of a genotyping service. The layman may also be a genotype service provider, who performs genotype analysis on a DNA sample from an individual, in order to provide service related to genetic risk factors for particular traits or diseases, based on the genotype status of the individual (i.e., the customer). Recent technological advances genotyping technologies, including high-throughput genotyping of SNP markers, such as Molecular Inversion Probe array technology (e.g., Affymetrix GeneChip), and BeadArray Technologies (e.g., Illumine GoldenGate and Infinium assays) have made it possible for individuals to have their own genome assessed for up to one million SNPs simultaneously, at relatively little cost. The resulting genotype information, which can be made available to the individual, can be compared to information about disease or trait risk associated with various SNPs, including information from public literature and scientific publications. The diagnostic application of disease-associated alleles as described herein, can thus for example be performed by the individual, through analysis of his/her genotype data, by a health professional based on results of a clinical test, or by a third party, including the genotype service provider. The third party may also be service provider who interprets genotype information from the customer to provide service related to specific genetic risk factors, including the genetic markers described herein. In other words, the diagnosis or determination of a susceptibility of genetic risk can be made by health professionals, genetic counselors, third parties providing genotyping service, third parties providing risk assessment service or by the layman (e.g., the individual), based on information about the genotype status of an individual and knowledge about the risk conferred by particular genetic risk factors (e.g., particular SNPs). In the present context, the term “diagnosing”, “diagnose a susceptibility” and “determine a susceptibility” is meant to refer to any available diagnostic method, including those mentioned above.

In certain embodiments, a sample containing genomic DNA from an individual is collected. Such sample can for example be a buccal swab, a saliva sample, a blood sample, or other suitable samples containing genomic DNA, as described further herein. The genomic DNA is then analyzed using any common technique available to the skilled person, such as high-throughput array technologies. Results from such genotyping are stored in a convenient data storage unit, such as a data carrier, including computer databases, data storage disks, or by other convenient data storage means. In certain embodiments, the computer database is an object database, a relational database or a post-relational database. The genotype data is subsequently analyzed for the presence of certain variants known to be susceptibility variants for a particular human conditions, such as the genetic variants described herein. Genotype data can be retrieved from the data storage unit using any convenient data query method. Calculating risk conferred by a particular genotype for the individual can be based on comparing the genotype of the individual to previously determined risk (expressed as a relative risk (RR) or and odds ratio (OR), for example) for the genotype, for example for an heterozygous carrier of an at-risk variant for a particular cancer (CM, BCC and/or SCC). The calculated risk for the individual can be the relative risk for a person, or for a specific genotype of a person, compared to the average population with matched gender and ethnicity. The average population risk can be expressed as a weighted average of the risks of different genotypes, using results from a reference population, and the appropriate calculations to calculate the risk of a genotype group relative to the population can then be performed. Alternatively, the risk for an individual is based on a comparison of particular genotypes, for example heterozygous carriers of an at-risk allele of a marker compared with non-carriers of the at-risk allele. Using the population average may in certain embodiments be more convenient, since it provides a measure which is easy to interpret for the user, i.e. a measure that gives the risk for the individual, based on his/her genotype, compared with the average in the population. The calculated risk estimated can be made available to the customer via a website, preferably a secure website.

In certain embodiments, a service provider will include in the provided service all of the steps of isolating genomic DNA from a sample provided by the customer, performing genotyping of the isolated DNA, calculating genetic risk based on the genotype data, and report the risk to the customer. In some other embodiments, the service provider will include in the service the interpretation of genotype data for the individual, i.e., risk estimates for particular genetic variants based on the genotype data for the individual. In some other embodiments, the service provider may include service that includes genotyping service and interpretation of the genotype data, starting from a sample of isolated DNA from the individual (the customer).

Overall risk for multiple risk variants can be performed using standard methodology. For example, assuming a multiplicative model, i.e. assuming that the risk of individual risk variants multiply to establish the overall effect, allows for a straight-forward calculation of the overall risk for multiple markers.

In addition, in certain other embodiments, the present invention pertains to methods of diagnosing, or aiding in the diagnosis of, a decreased susceptibility to particular cancers (SCC, CM and/or BCC) by detecting particular genetic marker alleles or haplotypes that appear less frequently in patients with these forms of cancers than in individual not diagnosed with the cancers or in the general population.

As described and exemplified herein, particular marker alleles or haplotypes (e.g. the markers and haplotypes as listed in Table 1-17, and markers in linkage disequilibrium therewith) are associated with risk of cancer, in particular CM and BCC. In one embodiment, the marker allele or haplotype is one that confers a significant risk or susceptibility to the cancer. In another embodiment, the invention relates to a method of diagnosing a susceptibility to the cancer in a human individual, the method comprising determining the presence or absence of at least one allele of at least one polymorphic marker in a nucleic acid sample obtained from the individual. In another embodiment, the invention pertains to methods of diagnosing a susceptibility to the cancer in a human individual, by screening for at least one marker allele or haplotype as listed herein. In another embodiment, the marker allele or haplotype is more frequently present in subject having, or who is susceptible to, the cancer (affected), as compared to the frequency of its presence in a healthy subject (control, such as population controls). In certain embodiments, the significance of association of the at least one marker allele or haplotype is characterized by a p value <0.05. In other embodiments, the significance of association is characterized by smaller p-values, such as <0.01, <0.001, <0.0001, <0.00001, <0.000001, <0.0000001, <0.00000001 or <0.000000001.

In these embodiments, determination of the presence of the at least one marker allele or haplotype is indicative of a susceptibility to the cancer. These diagnostic methods involve detecting the presence or absence of at least one marker allele or haplotype that is associated with cancer. The detection of the particular genetic marker alleles that make up particular haplotypes can be performed by a variety of methods described herein and/or known in the art. For example, genetic markers can be detected at the nucleic acid level (e.g., by direct nucleotide sequencing or by other means known to the skilled in the art) or at the amino acid level if the genetic marker affects the coding sequence of a protein encoded by a cancer-associated nucleic acid (e.g., by protein sequencing or by immunoassays using antibodies that recognize such a protein). The marker alleles or haplotypes correspond to fragments of a genomic DNA sequence associated with cancer. Such fragments encompass the DNA sequence of the polymorphic marker or haplotype in question, but may also include DNA segments in strong LD (linkage disequilibrium) with the marker or haplotype. In one embodiment, such segments comprises segments in LD with the marker or haplotype as determined by a value of r² greater than 0.1 and/or |D′|>0.8).

In one embodiment, diagnosis of a susceptibility to cancer selected from BCC, SCC and CM can be accomplished using hybridization methods. (see Current Protocols in Molecular Biology, Ausubel, F. et al., eds., John Wiley & Sons, including all supplements). The presence of a specific marker allele can be indicated by sequence-specific hybridization of a nucleic acid probe specific for the particular allele. The presence of more than one specific marker allele or a specific haplotype can be indicated by using several sequence-specific nucleic acid probes, each being specific for a particular allele. In one embodiment, a haplotype can be indicated by a single nucleic acid probe that is specific for the specific haplotype (i.e., hybridizes specifically to a DNA strand comprising the specific marker alleles characteristic of the haplotype). A sequence-specific probe can be directed to hybridize to genomic DNA, RNA, or cDNA. A “nucleic acid probe”, as used herein, can be a DNA probe or an RNA probe that hybridizes to a complementary sequence. One of skill in the art would know how to design such a probe so that sequence specific hybridization will occur only if a particular allele is present in a genomic sequence from a test sample. The invention can also be reduced to practice using any convenient genotyping method, including commercially available technologies and methods for genotyping particular polymorphic markers.

To diagnose a susceptibility to the cancer, a hybridization sample can be formed by contacting the test sample, such as a genomic DNA sample, with at least one nucleic acid probe. A non-limiting example of a probe for detecting mRNA or genomic DNA is a labeled nucleic acid probe that is capable of hybridizing to mRNA or genomic DNA sequences described herein. The nucleic acid probe can be, for example, a full-length nucleic acid molecule, or a portion thereof, such as an oligonucleotide of at least 15, 30, 50, 100, 250 or 500 nucleotides in length that is sufficient to specifically hybridize under stringent conditions to appropriate mRNA or genomic DNA. In certain embodiments, the oligonucleotide is from about 15 to about 100 nucleotides in length. In certain other embodiments, the oligonucleotide is from about 20 to about 50 nucleotides in length. The nucleic acid probe can comprise all or a portion of the nucleotide sequence of the 1p36 LD Block (SEQ ID NO:1) or the 1q42 LD Block (SEQ ID NO:2), as described herein, optionally comprising at least one allele of a marker described herein, or at least one haplotype described herein, or the probe can be the complementary sequence of such a sequence. In a particular embodiment, the nucleic acid probe is a portion of the nucleotide sequence of the 1p36 LD Block (SEQ ID NO:1) or the 1q42 LD Block (SEQ ID NO:2), as described herein, optionally comprising at least one allele of a marker described herein, or at least one allele of one polymorphic marker or haplotype comprising at least one polymorphic marker described herein, or the probe can be the complementary sequence of such a sequence. Other suitable probes for use in the diagnostic assays of the invention are described herein. Hybridization can be performed by methods well known to the person skilled in the art (see, e.g., Current Protocols in Molecular Biology, Ausubel, F. et al., eds., John Wiley & Sons, including all supplements). In one embodiment, hybridization refers to specific hybridization, i.e., hybridization with no mismatches (exact hybridization). In one embodiment, the hybridization conditions for specific hybridization are high stringency.

Specific hybridization, if present, is detected using standard methods. If specific hybridization occurs between the nucleic acid probe and the nucleic acid in the test sample, then the sample contains the allele that is complementary to the nucleotide that is present in the nucleic acid probe. The process can be repeated for any markers of the present invention, or markers that make up a haplotype of the present invention, or multiple probes can be used concurrently to detect more than one marker alleles at a time. It is also possible to design a single probe containing more than one marker alleles of a particular haplotype (e.g., a probe containing alleles complementary to 2, 3, 4, 5 or all of the markers that make up a particular haplotype). Detection of the particular markers of the haplotype in the sample is indicative that the source of the sample has the particular haplotype (e.g., a haplotype) and therefore is susceptible to the cancer.

In one preferred embodiment, a method utilizing a detection oligonucleotide probe comprising a fluorescent moiety or group at its 3′ terminus and a quencher at its 5′ terminus, and an enhancer oligonucleotide, is employed, as described by Kutyavin et al. (Nucleic Acid Res. 34:e128 (2006)). The fluorescent moiety can be Gig Harbor Green or Yakima Yellow, or other suitable fluorescent moieties. The detection probe is designed to hybridize to a short nucleotide sequence that includes the SNP polymorphism to be detected. Preferably, the SNP is anywhere from the terminal residue to −6 residues from the 3′ end of the detection probe. The enhancer is a short oligonucleotide probe which hybridizes to the DNA template 3′ relative to the detection probe. The probes are designed such that a single nucleotide gap exists between the detection probe and the enhancer nucleotide probe when both are bound to the template. The gap creates a synthetic abasic site that is recognized by an endonuclease, such as Endonuclease IV. The enzyme cleaves the dye off the fully complementary detection probe, but cannot cleave a detection probe containing a mismatch. Thus, by measuring the fluorescence of the released fluorescent moiety, assessment of the presence of a particular allele defined by nucleotide sequence of the detection probe can be performed.

The detection probe can be of any suitable size, although preferably the probe is relatively short. In one embodiment, the probe is from 5-100 nucleotides in length. In another embodiment, the probe is from 10-50 nucleotides in length, and in another embodiment, the probe is from 12-30 nucleotides in length. Other lengths of the probe are possible and within scope of the skill of the average person skilled in the art.

In a preferred embodiment, the DNA template containing the SNP polymorphism is amplified by Polymerase Chain Reaction (PCR) prior to detection. In such an embodiment, the amplified DNA serves as the template for the detection probe and the enhancer probe.

Certain embodiments of the detection probe, the enhancer probe, and/or the primers used for amplification of the template by PCR include the use of modified bases, including modified A and modified G. The use of modified bases can be useful for adjusting the melting temperature of the nucleotide molecule (probe and/or primer) to the template DNA, for example for increasing the melting temperature in regions containing a low percentage of G or C bases, in which modified A with the capability of forming three hydrogen bonds to its complementary T can be used, or for decreasing the melting temperature in regions containing a high percentage of G or C bases, for example by using modified G bases that form only two hydrogen bonds to their complementary C base in a double stranded DNA molecule. In a preferred embodiment, modified bases are used in the design of the detection nucleotide probe. Any modified base known to the skilled person can be selected in these methods, and the selection of suitable bases is well within the scope of the skilled person based on the teachings herein and known bases available from commercial sources as known to the skilled person.

Additionally, or alternatively, a peptide nucleic acid (PNA) probe can be used in addition to, or instead of, a nucleic acid probe in the hybridization methods described herein. A PNA is a DNA mimic having a peptide-like, inorganic backbone, such as N-(2-aminoethyl)glycine units, with an organic base (A, G, C, T or U) attached to the glycine nitrogen via a methylene carbonyl linker (see, for example, Nielsen, P., et al., Bioconjug. Chem. 5:3-7 (1994)). The PNA probe can be designed to specifically hybridize to a molecule in a sample suspected of containing one or more of the marker alleles or haplotypes that are associated with cancer.

In one embodiment of the invention, a test sample containing genomic DNA obtained from the subject is collected and the polymerase chain reaction (PCR) is used to amplify a fragment comprising one or more markers or haplotypes of the present invention. As described herein, identification of a particular marker allele or haplotype associated with a cancer can be accomplished using a variety of methods (e.g., sequence analysis, analysis by restriction digestion, specific hybridization, single stranded conformation polymorphism assays (SSCP), electrophoretic analysis, etc.). In another embodiment, diagnosis is accomplished by expression analysis, for example by using quantitative PCR (kinetic thermal cycling). This technique can, for example, utilize commercially available technologies, such as TaqMan® (Applied Biosystems, Foster City, Calif.). The technique can assess the presence of an alteration in the expression or composition of a polypeptide or splicing variant(s) that is encoded by a nucleic acid associated with cancer. Further, the expression of the variant(s) can be quantified as physically or functionally different.

In another embodiment of the methods of the invention, analysis by restriction digestion can be used to detect a particular allele if the allele results in the creation or elimination of a restriction site relative to a reference sequence. Restriction fragment length polymorphism (RFLP) analysis can be conducted, e.g., as described in Current Protocols in Molecular Biology, supra. The digestion pattern of the relevant DNA fragment indicates the presence or absence of the particular allele in the sample.

Sequence analysis can also be used to detect specific alleles or haplotypes associated with a cancer. Therefore, in one embodiment, determination of the presence or absence of a particular marker alleles or haplotypes comprises sequence analysis of a test sample of DNA or RNA obtained from a subject or individual. PCR or other appropriate methods can be used to amplify a portion of a nucleic acid associated with the cancer, and the presence of a specific allele can then be detected directly by sequencing the polymorphic site (or multiple polymorphic sites in a haplotype) of the genomic DNA in the sample.

In another embodiment, arrays of oligonucleotide probes that are complementary to target nucleic acid sequence segments from a subject, can be used to identify polymorphisms in a nucleic acid associated with a cancer. For example, an oligonucleotide array can be used. Oligonucleotide arrays typically comprise a plurality of different oligonucleotide probes that are coupled to a surface of a substrate in different known locations. These arrays can generally be produced using mechanical synthesis methods or light directed synthesis methods that incorporate a combination of photolithographic methods and solid phase oligonucleotide synthesis methods, or by other methods known to the person skilled in the art (see, e.g., Bier, F. F., et al. Adv Biochem Eng Biotechnol 109:433-53 (2008); Hoheisel, J. D., Nat Rev Genet 7:200-10 (2006); Fan, J. B., et al. Methods Enzymol 410:57-73 (2006); Raqoussis, J. & Elvidge, G., Expert Rev Mol Diagn 6:145-52 (2006); Mockler, T. C., et al Genomics 85:1-15 (2005), and references cited therein, the entire teachings of each of which are incorporated by reference herein). Many additional descriptions of the preparation and use of oligonucleotide arrays for detection of polymorphisms can be found, for example, in U.S. Pat. No. 6,858,394, U.S. Pat. No. 6,429,027, U.S. Pat. No. 5,445,934, U.S. Pat. No. 5,700,637, U.S. Pat. No. 5,744,305, U.S. Pat. No. 5,945,334, U.S. Pat. No. 6,054,270, U.S. Pat. No. 6,300,063, U.S. Pat. No. 6,733,977, U.S. Pat. No. 7,364,858, EP 619 321, and EP 373 203, the entire teachings of which are incorporated by reference herein.

Other methods of nucleic acid analysis that are available to those skilled in the art can be used to detect a particular allele at a polymorphic site. Representative methods include, for example, direct manual sequencing (Church and Gilbert, Proc. Natl. Acad. Sci. USA, 81: 1991-1995 (1988); Sanger, F., et al., Proc. Natl. Acad. Sci. USA, 74:5463-5467 (1977); Beavis, et al., U.S. Pat. No. 5,288,644); automated fluorescent sequencing; single-stranded conformation polymorphism assays (SSCP); clamped denaturing gel electrophoresis (CDGE); denaturing gradient gel electrophoresis (DGGE) (Sheffield, V., et al., Proc. Natl. Acad. Sci. USA, 86:232-236 (1989)), mobility shift analysis (Orita, M., et al., Proc. Natl. Acad. Sci. USA, 86:2766-2770 (1989)), restriction enzyme analysis (Flavell, R., et al., Cell, 15:25-41 (1978); Geever, R., et al., Proc. Natl. Acad. Sci. USA, 78:5081-5085 (1981)); heteroduplex analysis; chemical mismatch cleavage (CMC) (Cotton, R., et al., Proc. Natl. Acad. Sci. USA, 85:4397-4401 (1985)); RNase protection assays (Myers, R., et al., Science, 230:1242-1246 (1985); use of polypeptides that recognize nucleotide mismatches, such as E. coli mutS protein; and allele-specific PCR.

In another embodiment of the invention, determination of a susceptibility to a cancer can be made by examining expression and/or composition of a polypeptide encoded by a nucleic acid associated with the cancer in those instances where the genetic marker(s) or haplotype(s) of the present invention result in a change in the composition or expression of the polypeptide. Thus, diagnosis of a susceptibility to a cancer can be made by examining expression and/or composition of one of these polypeptides, or another polypeptide encoded by a nucleic acid associated with the cancer, in those instances where the genetic marker or haplotype of the present invention results in a change in the composition or expression of the polypeptide. The markers described herein may also affect the expression of nearby genes. Thus, in another embodiment, the variants (markers or haplotypes) of the invention showing association to cancer affect the expression of a nearby gene, such as one or more of the PADI1, PADI2, PADI3, PADI4, PADI6, AHRGEF10L, RCC2 and RHOU genes. It is well known that regulatory element affecting gene expression may be located far away, even as far as tenths or hundreds of kilobases away, from the promoter region of a gene. By assaying for the presence or absence of at least one allele of at least one polymorphic marker of the present invention, it is thus possible to assess the expression level of such nearby genes. Possible mechanisms affecting these genes include, e.g., effects on transcription, effects on RNA splicing, alterations in relative amounts of alternative splice forms of mRNA, effects on RNA stability, effects on transport from the nucleus to cytoplasm, and effects on the efficiency and accuracy of translation.

A variety of methods can be used for detecting protein expression levels, including enzyme linked immunosorbent assays (ELISA), Western blots, immunoprecipitations and immunofluorescence. A test sample from a subject is assessed for the presence of an alteration in the expression and/or an alteration in composition of the polypeptide encoded by a nucleic acid associated with CM, BCC and/or SCC. An alteration in expression of a polypeptide encoded by such a nucleic acid can be, for example, an alteration in the quantitative polypeptide expression (i.e., the amount of polypeptide produced). An alteration in the composition of a polypeptide encoded by a nucleic acid associated with a cancer is an alteration in the qualitative polypeptide expression (e.g., expression of a mutant polypeptide or of a different splicing variant). In one embodiment, diagnosis of a susceptibility to a cancer selected from CM, BCC and SCC is made by detecting a particular splicing variant encoded by a nucleic acid associated with the cancer, or a particular pattern of splicing variants.

Both such alterations (quantitative and qualitative) can also be present. An “alteration” in the polypeptide expression or composition, as used herein, refers to an alteration in expression or composition in a test sample, as compared to the expression or composition of the polypeptide in a control sample. A control sample is a sample that corresponds to the test sample (e.g., is from the same type of cells), and is from a subject who is not affected by, and/or who does not have a susceptibility to the cancer. In one embodiment, the control sample is from a subject that does not possess a marker allele or haplotype associated with a cancer selected from CM, BCC and/or SCC, as described herein. Similarly, the presence of one or more different splicing variants in the test sample, or the presence of significantly different amounts of different splicing variants in the test sample, as compared with the control sample, can be indicative of a susceptibility to one of these cancers. An alteration in the expression or composition of the polypeptide in the test sample, as compared with the control sample, can be indicative of a specific allele in the instance where the allele alters a splice site relative to the reference in the control sample. Various means of examining expression or composition of a polypeptide encoded by a nucleic acid are known to the person skilled in the art and can be used, including spectroscopy, colorimetry, electrophoresis, isoelectric focusing, and immunoassays (e.g., David et al., U.S. Pat. No. 4,376,110) such as immunoblotting (see, e.g., Current Protocols in Molecular Biology, particularly chapter 10, supra).

For example, in one embodiment, an antibody (e.g., an antibody with a detectable label) that is capable of binding to a polypeptide encoded by a nucleic acid associated with a cancer selected from CM, BCC and SCC can be used. Antibodies can be polyclonal or monoclonal. An intact antibody, or a fragment thereof (e.g., Fv, Fab, Fab′, F(ab′)₂) can be used. The term “labeled”, with regard to the probe or antibody, is intended to encompass direct labeling of the probe or antibody by coupling (i.e., physically linking) a detectable substance to the probe or antibody, as well as indirect labeling of the probe or antibody by reactivity with another reagent that is directly labeled. Examples of indirect labeling include detection of a primary antibody using a labeled secondary antibody (e.g., a fluorescently-labeled secondary antibody) and end-labeling of a DNA probe with biotin such that it can be detected with fluorescently-labeled streptavidin.

In one embodiment of this method, the level or amount of polypeptide encoded by a nucleic acid associated with a cancer in a test sample is compared with the level or amount of the polypeptide in a control sample. A level or amount of the polypeptide in the test sample that is higher or lower than the level or amount of the polypeptide in the control sample, such that the difference is statistically significant, is indicative of an alteration in the expression of the polypeptide encoded by the nucleic acid, and is diagnostic for a particular allele or haplotype responsible for causing the difference in expression. Alternatively, the composition of the polypeptide in a test sample is compared with the composition of the polypeptide in a control sample. In another embodiment, both the level or amount and the composition of the polypeptide can be assessed in the test sample and in the control sample.

In another embodiment, the diagnosis of a susceptibility to a cancer selected from CM, BCC and SCC is made by detecting at least one marker as disclosed and claimed herein, in combination with an additional protein-based, RNA-based or DNA-based assay.

### Kits

Kits useful in the methods of the invention comprise components useful in any of the methods described herein, including for example, primers for nucleic acid amplification, hybridization probes, restriction enzymes (e.g., for RFLP analysis), allele-specific oligonucleotides, antibodies that bind to an altered polypeptide encoded by a nucleic acid of the invention as described herein (e.g., a genomic segment comprising at least one polymorphic marker and/or haplotype of the present invention) or to a non-altered (native) polypeptide encoded by a nucleic acid of the invention as described herein, means for amplification of a nucleic acid associated with a cancer selected from CM, BCC and SCC, means for analyzing the nucleic acid sequence of a nucleic acid associated with the cancer, means for analyzing the amino acid sequence of a polypeptide encoded by a nucleic acid associated with the cancer (e.g., a protein encoded by a cancer-associated gene), etc. The kits can for example include necessary buffers, nucleic acid primers for amplifying nucleic acids of the invention (e.g., a nucleic acid segment comprising one or more of the polymorphic markers as described herein), and reagents for allele-specific detection of the fragments amplified using such primers and necessary enzymes (e.g., DNA polymerase). Additionally, kits can provide reagents for assays to be used in combination with the methods of the present invention, e.g., reagents for use with other diagnostic assays for the cancer.

In one embodiment, the invention pertains to a kit for assaying a sample from a subject to detect a susceptibility to a cancer selected from CM, BCC and SCC in a subject, wherein the kit comprises reagents necessary for selectively detecting at least one allele of at least one polymorphism of the present invention in the genome of the individual. Optionally, the kit may further include a collection of data comprising correlation data between the at least one polymorphism and susceptibility to the cancer. The collection of data may be provided in any suitable format or medium. In one embodiment, the collection of data is provided on a computer-readable medium. In certain embodiments, the polymorphism is selectd from the group consisting of rs7538876, rs801114, rs10504624, rs4151060, rs7812812, and rs9585777, and polymorphic markers in linkage disequilibrium therewith In a particular embodiment, the reagents comprise at least one contiguous oligonucleotide that hybridizes to a fragment of the genome of the individual comprising at least one polymorphism of the present invention. In another embodiment, the reagents comprise at least one pair of oligonucleotides that hybridize to opposite strands of a genomic segment obtained from a subject, wherein each oligonucleotide primer pair is designed to selectively amplify a fragment of the genome of the individual that includes at least one polymorphism, wherein the polymorphism is selected from the group consisting of the polymorphisms rs7538876, rs801114, rs10504624, rs4151060, rs7812812, and rs9585777, and polymorphic markers in linkage disequilibrium therewith. In yet another embodiment the fragment is at least 20 base pairs in size. Such oligonucleotides or nucleic acids (e.g., oligonucleotide primers) can be designed using portions of the nucleic acid sequence flanking polymorphisms (e.g., SNPs or microsatellites) that are indicative of the cancer. In another embodiment, the kit comprises one or more labeled nucleic acids capable of allele-specific detection of one or more specific polymorphic markers or haplotypes associated with the cancer, and reagents for detection of the label. Suitable labels include, e.g., a radioisotope, a fluorescent label, an enzyme label, an enzyme co-factor label, a magnetic label, a spin label, an epitope label.

In particular embodiments, the polymorphic marker or haplotype to be detected by the reagents of the kit comprises one or more markers, two or more markers, three or more markers, four or more markers or five or more markers selected from the group consisting of the markers set forth in any one of Tables 1-17 herein. In another embodiment, the marker or haplotype to be detected comprises at least one of the markers rs7538876, rs801114, rs10504624, rs4151060, rs7812812, and rs9585777. In another embodiment, the marker or haplotype to be detected comprises at least one marker from the group of markers in linkage disequilibrium, as defined by values of r² greater than 0.2, to at least one marker selected from the group consisting of rs7538876, rs801114, rs10504624, rs4151060, rs7812812, and rs9585777. In another embodiment, the marker to be detected is selected from the group consisting of rs7538876, rs801114, rs10504624, rs4151060, rs7812812, and rs9585777.

In a preferred embodiment, the DNA template containing the SNP polymorphism is amplified by Polymerase Chain Reaction (PCR) prior to detection, and primers for such amplification are included in the reagent kit. In such an embodiment, the amplified DNA serves as the template for the detection probe and the enhancer probe.

In one embodiment, the DNA template is amplified by means of Whole Genome Amplification (WGA) methods, prior to assessment for the presence of specific polymorphic markers as described herein. Standard methods well known to the skilled person for performing WGA may be utilized, and are within scope of the invention. In one such embodiment, reagents for performing WGA are included in the reagent kit.

In certain embodiments, determination of the presence of a particular marker allele or haplotype is indicative of a susceptibility (increased susceptibility or decreased susceptibility) to a cancer selected from CM, BCC and SCC. In another embodiment, determination of the presence of the marker allele or haplotype is indicative of response to a therapeutic agent for a cancer selected from CM, BCC and SCC. In another embodiment, the presence of the marker allele or haplotype is indicative of prognosis of a cancer selected from CM, BCC and SCC. In yet another embodiment, the presence of the marker allele or haplotype is indicative of progress of treatment of a cancer selected from CM, BCC and SCC. Such treatment may include intervention by surgery, medication or by other means (e.g., lifestyle changes).

In a further aspect of the present invention, a pharmaceutical pack (kit) is provided, the pack comprising a therapeutic agent and a set of instructions for administration of the therapeutic agent to humans diagnostically tested for one or more variants of the present invention, as disclosed herein. The therapeutic agent can be a small molecule drug, an antibody, a peptide, an antisense or RNAi molecule, or other therapeutic molecules. In one embodiment, an individual identified as a carrier of at least one variant of the present invention is instructed to take a prescribed dose of the therapeutic agent. In one such embodiment, an individual identified as a homozygous carrier of at least one variant of the present invention is instructed to take a prescribed dose of the therapeutic agent. In another embodiment, an individual identified as a non-carrier of at least one variant of the present invention is instructed to take a prescribed dose of the therapeutic agent.

In certain embodiments, the kit further comprises a set of instructions for using the reagents comprising the kit.

### Therapeutic Agents

Variants of the present invention can be used to identify novel therapeutic targets for a cancer selected from CM, BCC and SCC. For example, genes containing, or in linkage disequilibrium with, variants (markers and/or haplotypes) associated with one or more of the cancers, or their products (e.g., one or more of the PADI1, PADI2, PADI3, PADI4, PADI6, AHRGEF10L, RCC2 and RHOU genes), as well as genes or their products that are directly or indirectly regulated by or interact with these variant genes or their products, can be targeted for the development of therapeutic agents to treat cancer, or prevent or delay onset of symptoms associated with the cancer. Therapeutic agents may comprise one or more of, for example, small non-protein and non-nucleic acid molecules, proteins, peptides, protein fragments, nucleic acids (DNA, RNA), PNA (peptide nucleic acids), or their derivatives or mimetics which can modulate the function and/or levels of the target genes or their gene products.

The nucleic acids and/or variants described herein, or nucleic acids comprising their complementary sequence, may be used as antisense constructs to control gene expression in cells, tissues or organs. The methodology associated with antisense techniques is well known to the skilled artisan, and is for example described and reviewed in AntisenseDrug Technology: Principles, Strategies, and Applications, Crooke, ed., Marcel Dekker Inc., New York (2001). In general, antisense agents (antisense oligonucleotides) are comprised of single stranded oligonucleotides (RNA or DNA) that are capable of binding to a complimentary nucleotide segment. By binding the appropriate target sequence, an RNA-RNA, DNA-DNA or RNA-DNA duplex is formed. The antisense oligonucleotides are complementary to the sense or coding strand of a gene. It is also possible to form a triple helix, where the antisense oligonucleotide binds to duplex DNA.

Several classes of antisense oligonucleotide are known to those skilled in the art, including cleavers and blockers. The former bind to target RNA sites, activate intracellular nucleases (e.g., RnaseH or Rnase L), that cleave the target RNA. Blockers bind to target RNA, inhibit protein translation by steric hindrance of the ribosomes. Examples of blockers include nucleic acids, morpholino compounds, locked nucleic acids and methylphosphonates (Thompson, Drug Discovery Today, 7:912-917 (2002)). Antisense oligonucleotides are useful directly as therapeutic agents, and are also useful for determining and validating gene function, for example by gene knock-out or gene knock-down experiments. Antisense technology is further described in Layery et al., Curr. Opin. Drug Discov. Devel. 6:561-569 (2003), Stephens et al., Curr. Opin. Mol. Ther. 5:118-122 (2003), Kurreck, Eur. J. Biochem. 270:1628-44 (2003), Dias et al., Mol. Cancer Ter. 1:347-55 (2002), Chen, Methods Mol. Med. 75:621-636 (2003), Wang et al., Curr. Cancer Drug Targets 1:177-96 (2001), and Bennett, Antisense Nucleic Acid Drug. Dev. 12:215-24 (2002).

In certain embodiments, the antisense agent is an oligonucleotide that is capable of binding to a particular nucleotide segment. In certain embodiments, the nucleotide segment comprises a portion of a gene selected from the group consisting of the PADI1, PADI2, PADI3, PADI4, PADI6, AHRGEF10L, RCC2 and RHOU genes. In certain other embodiments, the antisense nucleotide is capable of binding to a nucleotide segment of as set forth in SEQ ID NO:1 and SEQ ID NO:2. In certain other embodiments, the antisense nucleotide is capable of binding to a nucleotide segment of as set forth in any one of SEQ ID NO:3-298. Antisense nucleotides can be from 5-500 nucleotides in length, including 5-200 nucleotides, 5-100 nucleotides, 10-50 nucleotides, and 10-30 nucleotides. In certain preferred embodiments, the antisense nucleotides is from 14-50 nucleotides in length, including 14-40 nucleotides and 14-30 nucleotides.

The variants described herein can also be used for the selection and design of antisense reagents that are specific for particular variants. Using information about the variants described herein, antisense oligonucleotides or other antisense molecules that specifically target mRNA molecule that contain one or more variants of the invention can be designed. In this manner, expression of mRNA molecules that contain one or more variant of the present invention (i.e. certain marker alleles and/or haplotypes) can be inhibited or blocked. In one embodiment, the antisense molecules are designed to specifically bind a particular allelic form (i.e., one or several variants (alleles and/or haplotypes)) of the target nucleic acid, thereby inhibiting translation of a product originating from this specific allele or haplotype, but which do not bind other or alternate variants at the specific polymorphic sites of the target nucleic acid molecule. As antisense molecules can be used to inactivate mRNA so as to inhibit gene expression, and thus protein expression, the molecules can be used for disease treatment. The methodology can involve cleavage by means of ribozymes containing nucleotide sequences complementary to one or more regions in the mRNA that attenuate the ability of the mRNA to be translated. Such mRNA regions include, for example, protein-coding regions, in particular protein-coding regions corresponding to catalytic activity, substrate and/or ligand binding sites, or other functional domains of a protein.

The phenomenon of RNA interference (RNAi) has been actively studied for the last decade, since its original discovery in C. elegans (Fire et al., Nature 391:806-11 (1998)), and in recent years its potential use in treatment of human disease has been actively pursued (reviewed in Kim & Rossi, Nature Rev. Genet. 8:173-204 (2007)). RNA interference (RNAi), also called gene silencing, is based on using double-stranded RNA molecules (dsRNA) to turn off specific genes. In the cytoplasmic double-stranded RNA molecules (dsRNA) are processed by cellular complexes into small interfering RNA (siRNA). The siRNA guide the targeting of a protein-RNA complex to specific sites on a target mRNA, leading to cleavage of the mRNA (Thompson, Drug Discovery Today, 7:912-917 (2002)). The siRNA molecules are typically about 20, 21, 22 or 23 nucleotides in length. Thus, one aspect of the invention relates to isolated nucleic acid molecules, and the use of those molecules for RNA interference, i.e. as small interfering RNA molecules (siRNA). In one embodiment, the isolated nucleic acid molecules are 18-26 nucleotides in length, preferably 19-25 nucleotides in length, more preferably 20-24 nucleotides in length, and more preferably 21, 22 or 23 nucleotides in length.

Another pathway for RNAi-mediated gene silencing originates in endogenously encoded primary microRNA (pri-miRNA) transcripts, which are processed in the cell to generate precursor miRNA (pre-miRNA). These miRNA molecules are exported from the nucleus to the cytoplasm, where they undergo processing to generate mature miRNA molecules (miRNA), which direct translational inhibition by recognizing target sites in the 3′ untranslated regions of mRNAs, and subsequent mRNA degradation by processing P-bodies (reviewed in Kim & Rossi, Nature Rev. Genet. 8:173-204 (2007)).

Clinical applications of RNAi include the incorporation of synthetic siRNA duplexes, which preferably are approximately 20-23 nucleotides in size, and preferably have 3′ overlaps of 2 nucleotides. Knockdown of gene expression is established by sequence-specific design for the target mRNA. Several commercial sites for optimal design and synthesis of such molecules are known to those skilled in the art.

Other applications provide longer siRNA molecules (typically 25-30 nucleotides in length, preferably about 27 nucleotides), as well as small hairpin RNAs (shRNAs; typically about 29 nucleotides in length). The latter are naturally expressed, as described in Amarzguioui et al. (FEBS Lett. 579:5974-81 (2005)). Chemically synthetic siRNAs and shRNAs are substrates for In vivo processing, and in some cases provide more potent gene-silencing than shorter designs (Kim et al., Nature Biotechnol. 23:222-226 (2005); Siolas et al., Nature Biotechnol. 23:227-231 (2005)). In general siRNAs provide for transient silencing of gene expression, because their intracellular concentration is diluted by subsequent cell divisions. By contrast, expressed shRNAs mediate long-term, stable knockdown of target transcripts, for as long as transcription of the shRNA takes place (Marques et al., Nature Biotechnol. 23:559-565 (2006); Brummelkampiii et al., Science 296: 550-553 (2002)).

Since RNAi molecules, including siRNA, miRNA and shRNA, act in a sequence-dependent manner, the variants presented herein can be used to design RNAi reagents that recognize specific nucleic acid molecules comprising specific alleles and/or haplotypes (e.g., the alleles and/or haplotype of the present invention), while not recognizing nucleic acid molecules comprising other alleles or haplotypes. These RNAi reagents can thus recognize and destroy the target nucleic acid molecules. As with antisense reagents, RNAi reagents can be useful as therapeutic agents (i.e.; for turning off disease-associated genes or disease-associated gene variants), but may also be useful for characterizing and validating gene function (e.g., by gene knock-out or gene knock-down experiments).

Delivery of RNAi may be performed by a range of methodologies known to those skilled in the art. Methods utilizing non-viral delivery include cholesterol, stable nucleic acid-lipid particle (SNALP), heavy-chain antibody fragment (Fab), aptamers and nanoparticles. Viral delivery methods include use of lentivirus, adenovirus and adeno-associated virus. The siRNA molecules are in some embodiments chemically modified to increase their stability. This can include modifications at the 2′ position of the ribose, including 2′-O-methylpurines and 2′-fluoropyrimidines, which provide resistance to Rnase activity. Other chemical modifications are possible and known to those skilled in the art.

The following references provide a further summary of RNAi, and possibilities for targeting specific genes using RNAi: Kim & Rossi, Nat. Rev. Genet. 8:173-184 (2007), Chen & Rajewsky, Nat. Rev. Genet. 8: 93-103 (2007), Reynolds, et al., Nat. Biotechnol. 22:326-330 (2004), Chi et al., Proc. Natl. Acad. Sci. USA 100:6343-6346 (2003), Vickers et al., J. Biol. Chem. 278:7108-7118 (2003), Agami, Curr. Opin. Chem. Biol. 6:829-834 (2002), Layery, et al., Curr. Opin. Drug Discov. Devel. 6:561-569 (2003), Shi, Trends Genet. 19:9-12 (2003), Shuey et al., Drug Discov. Today 7:1040-46 (2002), McManus et al., Nat. Rev. Genet. 3:737-747 (2002), Xia et al., Nat. Biotechnol. 20:1006-10 (2002), Plasterk et al., curr. Opin. Genet. Dev. 10:562-7 (2000), Bosher et al., Nat. Cell Biol. 2:E31-6 (2000), and Hunter, Curr. Biol. 9:R440-442 (1999).

A genetic defect leading to increased predisposition or risk for development of a cancer, or a defect causing the cancer, may be corrected permanently by administering to a subject carrying the defect a nucleic acid fragment that incorporates a repair sequence that supplies the normal/wild-type nucleotide(s) at the site of the genetic defect. Such site-specific repair sequence may concompass an RNA/DNA oligonucleotide that operates to promote endogenous repair of a subject's genomic DNA. The administration of the repair sequence may be performed by an appropriate vehicle, such as a complex with polyethelenimine, encapsulated in anionic liposomes, a viral vector such as an adenovirus vector, or other pharmaceutical compositions suitable for promoting intracellular uptake of the adminstered nucleic acid. The genetic defect may then be overcome, since the chimeric oligonucleotides induce the incorporation of the normal sequence into the genome of the subject, leading to expression of the normal/wild-type gene product. The replacement is propagated, thus rendering a permanent repair and alleviation of the symptoms associated with the disease or condition.

The present invention provides methods for identifying compounds or agents that can be used to treat a cancer selected from CM, BCC and SCC. Thus, the variants of the invention are useful as targets for the identification and/or development of therapeutic agents. In certain embodiments, such methods include assaying the ability of an agent or compound to modulate the activity and/or expression of a nucleic acid that includes at least one of the variants (markers and/or haplotypes) of the present invention, or the encoded product of the nucleic acid. This includes nucleic acids that include one or more of the PADI1, PADI2, PADI3, PADI4, PADI6, AHRGEF10L, RCC2 and RHOU genes, and also the nucleic acids as set forth in SEQ ID NO:1 and SEQ ID NO:2 herein. This in turn can be used to identify agents or compounds that inhibit or alter the undesired activity or expression of the encoded nucleic acid product. Assays for performing such experiments can be performed in cell-based systems or in cell-free systems, as known to the skilled person. Cell-based systems include cells naturally expressing the nucleic acid molecules of interest, or recombinant cells that have been genetically modified so as to express a certain desired nucleic acid molecule.

Variant gene expression in a patient can be assessed by expression of a variant-containing nucleic acid sequence (for example, a gene containing at least one variant of the present invention, which can be transcribed into RNA containing the at least one variant, and in turn translated into protein), or by altered expression of a normal/wild-type nucleic acid sequence due to variants affecting the level or pattern of expression of the normal transcripts, for example variants in the regulatory or control region of the gene. Assays for gene expression include direct nucleic acid assays (mRNA), assays for expressed protein levels, or assays of collateral compounds involved in a pathway, for example a signal pathway. Furthermore, the expression of genes that are up- or down-regulated in response to the signal pathway can also be assayed. One embodiment includes operably linking a reporter gene, such as luciferase, to the regulatory region of the gene(s) of interest.

Modulators of gene expression can in one embodiment be identified when a cell is contacted with a candidate compound or agent, and the expression of mRNA is determined. The expression level of mRNA in the presence of the candidate compound or agent is compared to the expression level in the absence of the compound or agent. Based on this comparison, candidate compounds or agents for treating a cancer selected from SCC, BCC and CM can be identified as those modulating the gene expression of the variant gene (e.g., one or more of the PADI1, PADI2, PADI3, PADI4, PADI6, AHRGEF10L, RCC2 and RHOU genes). When expression of mRNA or the encoded protein is statistically significantly greater in the presence of the candidate compound or agent than in its absence, then the candidate compound or agent is identified as a stimulator or up-regulator of expression of the nucleic acid. When nucleic acid expression or protein level is statistically significantly less in the presence of the candidate compound or agent than in its absence, then the candidate compound is identified as an inhibitor or down-regulator of the nucleic acid expression.

The invention further provides methods of treatment using a compound identified through drug (compound and/or agent) screening as a gene modulator (i.e. stimulator and/or inhibitor of gene expression).

### Methods of Assessing Probability of Response to Therapeutic Agents, Methods of Monitoring Progress of Treatment and Methods of Treatment

As is known in the art, individuals can have differential responses to a particular therapy (e.g., a therapeutic agent or therapeutic method). Pharmacogenomics addresses the issue of how genetic variations (e.g., the variants (markers and/or haplotypes) of the present invention) affect drug response, due to altered drug disposition and/or abnormal or altered action of the drug. Thus, the basis of the differential response may be genetically determined in part. Clinical outcomes due to genetic variations affecting drug response may result in toxicity of the drug in certain individuals (e.g., carriers or non-carriers of the genetic variants of the present invention), or therapeutic failure of the drug. Therefore, the variants of the present invention may determine the manner in which a therapeutic agent and/or method acts on the body, or the way in which the body metabolizes the therapeutic agent.

Accordingly, in one embodiment, the presence of a particular allele at a polymorphic site or haplotype is indicative of a different response, e.g. a different response rate, to a particular treatment modality. This means that a patient diagnosed with a cancer selected from CM, BCC′ and SCC, and carrying a certain allele at a polymorphic marker of the present invention, or haplotypes comprising such markers would respond better to, or worse to, a specific therapeutic, drug and/or other therapy used to treat the cancer. Therefore, the presence or absence of the marker allele or haplotype could aid in deciding what treatment should be used for a the patient. For example, for a newly diagnosed patient, the presence of a marker or haplotype of the present invention may be assessed (e.g., through testing DNA derived from a blood sample, as-described herein). If the patient is positive for a marker allele or haplotype (that is, at least one specific allele of the marker, or haplotype, is present), then the physician recommends one particular therapy, while if the patient is negative for the at least one allele of a marker, or a haplotype, then a different course of therapy may be recommended (which may include recommending that no immediate therapy, other than serial monitoring for progression of the disease, be performed). Thus, the patient's carrier status could be used to help determine whether a particular treatment modality should be administered. The value lies in particular within the possibilities of being able to diagnose the cancer at an early stage, to select the most appropriate treatment and minimize risk of a fatal outcome, and provide information to the clinician about prognosis/aggressiveness of the cancer in order to be able to apply the most appropriate treatment.

The present invention also relates to methods of monitoring progress or effectiveness of a treatment for a cancer selected from CM, BCC and SCC. This can be done based on the genotype and/or haplotype status of the markers and haplotypes of the present invention, i.e., by assessing the absence or presence of at least one allele of at least one polymorphic marker as disclosed herein, or by monitoring expression of genes that are associated with the variants (markers and haplotypes) of the present invention (e.g., one or more of the PADI1, PADI2, PADI3, PADI4, PADI6, AHRGEF10L, RCC2 and RHOU genes). The risk gene mRNA or the encoded polypeptide can be measured in a tissue sample (e.g., a peripheral blood sample, or a biopsy sample). Expression levels and/or mRNA levels can thus be determined before and during treatment to monitor its effectiveness. Alternatively, or concomitantly, the genotype and/or haplotype status of at least one risk variant for the cancer as presented herein is determined before and during treatment to monitor its effectiveness.

Alternatively, biological networks or metabolic pathways related to the markers and haplotypes of the present invention can be monitored by determining mRNA and/or polypeptide levels. This can be done for example, by monitoring expression levels or polypeptides for several genes belonging to the network and/or pathway, in samples taken before and during treatment. Alternatively, metabolites belonging to the biological network or metabolic pathway can be determined before and during treatment. Effectiveness of the treatment is determined by comparing observed changes in expression levels/metabolite levels during treatment to corresponding data from healthy subjects.

In a further aspect, the markers of the present invention can be used to increase power and effectiveness of clinical trials. Thus, individuals who are carriers of at least one at-risk variant of the present invention, i.e. individuals who are carriers of at least one allele of at least one polymorphic marker conferring increased risk of developing a cancer selected from CM, BCC and SCC may be more likely to respond to a particular treatment modality. In one embodiment, individuals who carry at-risk variants for gene(s) in a pathway and/or metabolic network for which a particular treatment (e.g., small molecule drug) is targeting, are more likely to be responders to the treatment. In another embodiment, individuals who carry at-risk variants for a gene, which expression and/or function is altered by the at-risk variant, are more likely to be responders to a treatment modality targeting that gene, its expression or its gene product. This application can improve the safety of clinical trials, but can also enhance the chance that a clinical trial will demonstrate statistically significant efficacy, which may be limited to a certain sub-group of the population. Thus, one possible outcome of such a trial is that carriers of certain genetic variants, e.g., the markers and haplotypes of the present invention, are statistically significantly likely to show positive response to the therapeutic agent, i.e. experience alleviation of symptoms associated with the cancer when taking the therapeutic agent or drug as prescribed.

In a further aspect, the markers and haplotypes of the present invention can be used for targeting the selection of pharmaceutical agents for specific individuals. Personalized selection of treatment modalities, lifestyle changes or combination of the two, can be realized by the utilization of the at-risk variants of the present invention. Thus, the knowledge of an individual's status for particular markers of the present invention, can be useful for selection of treatment options that target genes or gene products affected by the at-risk variants of the invention. Certain combinations of variants may be suitable for one selection of treatment options, while other gene variant combinations may target other treatment options. Such combination of variant may include one variant, two variants, three variants, or four or more variants, as needed to determine with clinically reliable accuracy the selection of treatment module.

### Computer-Implemented Aspects

As understood by those of ordinary skill in the art, the methods and information described herein may be implemented, in all or in part, as computer executable instructions on known computer readable media. For example, the methods described herein may be implemented in hardware. Alternatively, the method may be implemented in software stored in, for example, one or more memories or other computer readable medium and implemented on one or more processors. As is known, the processors may be associated with one or more controllers, calculation units and/or other units of a computer system, or implanted in firmware as desired. If implemented in software, the routines may be stored in any computer readable memory such as in RAM, ROM, flash memory, a magnetic disk, a laser disk, or other storage medium, as is also known. Likewise, this software may be delivered to a computing device via any known delivery method including, for example, over a communication channel such as a telephone line, the Internet, a wireless connection, etc., or via a transportable medium, such as a computer readable disk, flash drive, etc.

More generally, and as understood by those of ordinary skill in the art, the various steps described above may be implemented as various blocks, operations, tools, modules and techniques which, in turn, may be implemented in hardware, firmware, software, or any combination of hardware, firmware, and/or software. When implemented in hardware, some or all of the blocks, operations, techniques, etc. may be implemented in, for example, a custom integrated circuit (IC), an application specific integrated circuit (ASIC), a field programmable logic array (FPGA), a programmable logic array (PLA), etc.

When implemented in software, the software may be stored in any known computer readable medium such as on a magnetic disk, an optical disk, or other storage medium, in a RAM or ROM or flash memory of a computer, processor, hard disk drive, optical disk drive, tape drive, etc. Likewise, the software may be delivered to a user or a computing system via any known delivery method including, for example, on a computer readable disk or other transportable computer storage mechanism.

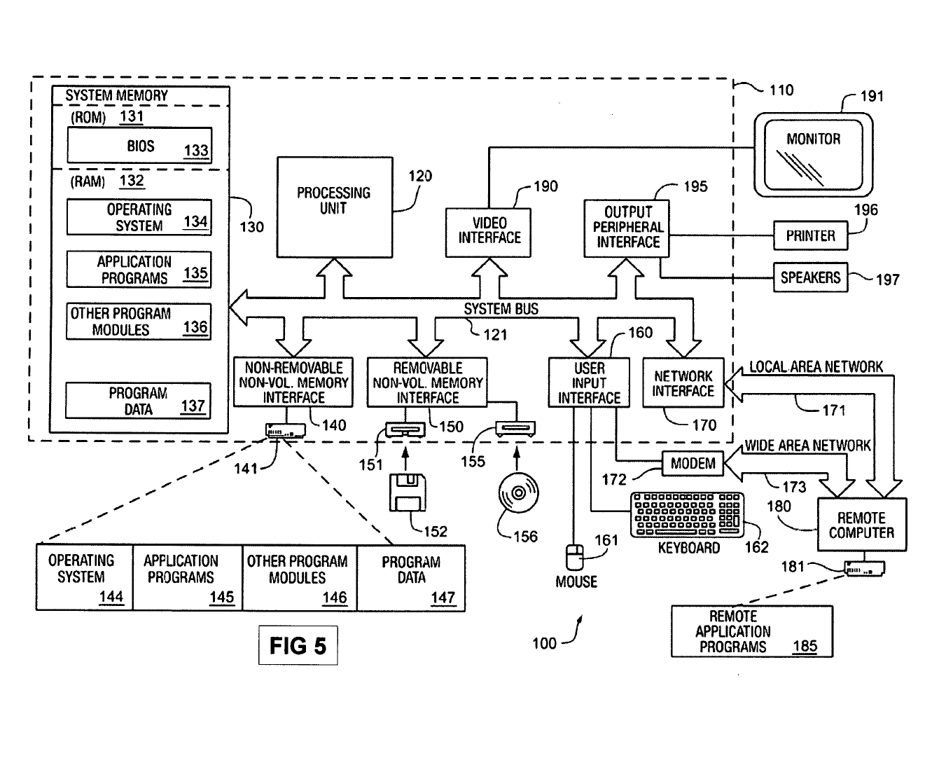

FIG. 5 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method or apparatus of the claims. Neither should the computing environment 100 be interpreted as having any dependency or requirement relating to any one or combination of components illustrated in the exemplary operating environment 100.

The steps of the claimed method and system are operational with numerous other general purpose or special purpose computing system environments or configurations. Examples of well known computing systems, environments, and/or configurations that may be suitable for use with the methods or system of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and system may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In both integrated and distributed computing environments, program modules may be located in both local and remote computer storage media including memory storage devices.

With reference to FIG. 5, an exemplary system for implementing the steps of the claimed method and system includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 5 illustrates operating system 134, application programs 135, other program modules 136, and program data 137.

The computer 110 may also include other removable/non-removable, volatile/nonvolatile computer storage media. By way of example only, FIG. 5 illustrates a hard disk drive 140 that reads from or writes to non-removable, nonvolatile magnetic media, a magnetic disk drive 151, that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 5, provide storage of computer readable instructions, data structures, program modules and other data for the computer 110. In FIG. 5, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 5. The logical connections depicted in FIG. 5 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 5 illustrates remote application programs 185 as residing on memory device 181. It will be appreciated that the network connections shown are exemplary and other means of establishing a communications link between the computers may be used.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

While the risk evaluation system and method, and other elements, have been described as preferably being implemented in software, they may be implemented in hardware, firmware, etc., and may be implemented by any other processor. Thus, the elements described herein may be implemented in a standard multi-purpose CPU or on specifically designed hardware or firmware such as an application-specific integrated circuit (ASIC) or other hard-wired device as desired, including, but not limited to, the computer 110 of FIG. 5. When implemented in software, the software routine may be stored in any computer readable memory such as on a magnetic disk, a laser disk, or other storage medium, in a RAM or ROM of a computer or processor, in any database, etc. Likewise, this software may be delivered to a user or a diagnostic system via any known or desired delivery method including, for example, on a computer readable disk or other transportable computer storage mechanism or over a communication channel such as a telephone line, the internet, wireless communication, etc. (which are viewed as being the same as or interchangeable with providing such software via a transportable storage medium).

Thus, many modifications and variations may be made in the techniques and structures described and illustrated herein without departing from the spirit and scope of the present invention. Thus, it should be understood that the methods and apparatus described herein are illustrative only and are not limiting upon the scope of the invention.

Accordingly, the invention relates to computer-implemented applications using the polymorphic markers and haplotypes described herein, and genotype and/or disease-association data derived therefrom. Such applications can be useful for storing, manipulating or otherwise analyzing genotype data that is useful in the methods of the invention. One example pertains to storing genotype information derived from an individual on readable media, so as to be able to provide the genotype information to a third party (e.g., the individual, a guardian of the individual, a health care provider or genetic analysis service provider), or for deriving information from the genotype data, e.g., by comparing the genotype data to information about genetic risk factors contributing to increased susceptibility to the disease, and reporting results based on such comparison.

In general terms, computer-readable media has capabilities of storing (i) identifier information for at least one polymorphic marker or a haplotype, as described herein; (ii) an indicator of the frequency of at least one allele of said at least one marker, or the frequency of a haplotype, in individuals with the disease; and an indicator of the frequency of at least one allele of said at least one marker, or the frequency of a haplotype, in a reference population. The reference population can be a disease-free population of individuals. Alternatively, the reference population is a random sample from the general population, and is thus representative of the population at large. The frequency indicator may be a calculated frequency, a count of alleles and/or haplotype copies, or normalized or otherwise manipulated values of the actual frequencies that are suitable for the particular medium.

The markers and haplotypes described herein to be associated with increased susceptibility (increased risk) of a cancer selected from SCC, BCC and CM, are in certain embodiments useful in the interpretation and/or analysis of genotype data. Thus in certain embodiments, determination of the presence of an at-risk allele for the cancer, as shown herein, or determination of the presence of an allele at a polymorphic marker in LD with any such risk allele, is indicative of the individual from whom the genotype data originates is at increased risk of cancer selected from SCC, BCC and CM. In one such embodiment, genotype data is generated for at least one polymorphic marker shown herein to be associated with the cancer, or a marker in linkage disequilibrium therewith. The genotype data is subsequently made available to a third party, such as the individual from whom the data originates, his/her guardian or representative, a physician or health care worker, genetic counsellor, or insurance agent, for example via a user interface accessible over the Internet, together with an interpretation of the genotype data, e.g., in the form of a risk measure (such as an absolute risk (AR), risk ratio (RR) or odds ratio (OR)) for the disease. In another embodiment, at-risk markers identified in a genotype dataset derived from an individual are assessed and results from the assessment of the risk conferred by the presence of such at-risk variants in the dataset are made available to the third party, for example via a secure web interface, or by other communication means. The results of such risk assessment can be reported in numeric form (e.g., by risk values, such as absolute risk, relative risk, and/or an odds ratio, or by a percentage increase in risk compared with a reference), by graphical means, or by other means suitable to illustrate the risk to the individual from whom the genotype data is derived.

### Nucleic Acids and Polypeptides

The nucleic acids and polypeptides described herein can be used in methods and kits of the present invention. An “isolated” nucleic acid molecule, as used herein, is one that is separated from nucleic acids that normally flank the gene or nucleotide sequence (as in genomic sequences) and/or has been completely or partially purified from other transcribed sequences (e.g., as in an RNA library). For example, an isolated nucleic acid of the invention can be substantially isolated with respect to the complex cellular milieu in which it naturally occurs, or culture medium when produced by recombinant techniques, or chemical precursors or other chemicals when chemically synthesized. In some instances, the isolated material will form part of a composition (for example, a crude extract containing other substances), buffer system or reagent mix. In other circumstances, the material can be purified to essential homogeneity, for example as determined by polyacrylamide gel electrophoresis (PAGE) or column chromatography (e.g., HPLC). An isolated nucleic acid molecule of the invention can comprise at least about 50%, at least about 80% or at least about 90% (on a molar basis) of all macromolecular species present. With regard to genomic DNA, the term “isolated” also can refer to nucleic acid molecules that are separated from the chromosome with which the genomic DNA is naturally associated. For example, the isolated nucleic acid molecule can contain less than about 250 kb, 200 kb, 150 kb, 100 kb, 75 kb, 50 kb, 25 kb, 10 kb, 5 kb, 4 kb, 3 kb, 2 kb, 1 kb, 0.5 kb or 0.1 kb of the nucleotides that flank the nucleic acid molecule in the genomic DNA of the cell from which the nucleic acid molecule is derived.

The nucleic acid molecule can be fused to other coding or regulatory sequences and still be considered isolated. Thus, recombinant DNA contained in a vector is included in the definition of “isolated” as used herein. Also, isolated nucleic acid molecules include recombinant DNA molecules in heterologous host cells or heterologous organisms, as well as partially or substantially purified DNA molecules in solution. “Isolated” nucleic acid molecules also encompass in vivo and in vitro RNA transcripts of the DNA molecules of the present invention. An isolated nucleic acid molecule or nucleotide sequence can include a nucleic acid molecule or nucleotide sequence that is synthesized chemically or by recombinant means. Such isolated nucleotide sequences are useful, for example, in the manufacture of the encoded polypeptide, as probes for isolating homologous sequences (e.g., from other mammalian species), for gene mapping (e.g., by in situ hybridization with chromosomes), or for detecting expression of the gene in tissue (e.g., human tissue), such as by Northern blot analysis or other hybridization techniques.

The invention also pertains to nucleic acid molecules that hybridize under high stringency hybridization conditions, such as for selective hybridization, to a nucleotide sequence described herein (e.g., nucleic acid molecules that specifically hybridize to a nucleotide sequence containing a polymorphic marker described herein; e.g. any of the markers set forth in Tables 1-9 herein). Such nucleic acid molecules can be detected and/or isolated by allele- or sequence-specific hybridization (e.g., under high stringency conditions). Stringency conditions and methods for nucleic acid hybridizations are well known to the skilled person (see, e.g., Current Protocols in Molecular Biology, Ausubel, F. et al, John Wiley & Sons, (1998), and Kraus, M. and Aaronson, S., Methods Enzymol., 200:546-556 (1991), the entire teachings of which are incorporated by reference herein.

The percent identity of two nucleotide or amino acid sequences can be determined by aligning the sequences for optimal comparison purposes (e.g., gaps can be introduced in the sequence of a first sequence). The nucleotides or amino acids at corresponding positions are then compared, and the percent identity between the two sequences is a function of the number of identical positions shared by the sequences (i.e., % identity=# of identical positions/total # of positions×100). In certain embodiments, the length of a sequence aligned for comparison purposes is at least 30%, at least 40%, at least 50%, at least 60%, at least 70%, at least 80%, at least 90%, or at least 95%, of the length of the reference sequence. The actual comparison of the two sequences can be accomplished by well-known methods, for example, using a mathematical algorithm. A non-limiting example of such a mathematical algorithm is described in Karlin, S. and Altschul, S., Proc. Natl. Acad. Sci. USA, 90:5873-5877 (1993). Such an algorithm is incorporated into the NBLAST and XBLAST programs (version 2.0), as described in Altschul, S. et al., Nucleic Acids Res., 25:3389-3402 (1997). When utilizing BLAST and Gapped BLAST programs, the default parameters of the respective programs (e.g., NBLAST) can be used. See the website on the world wide web at ncbi.nlm.nih.gov. In one embodiment, parameters for sequence comparison can be set at score=100, wordlength=12, or can be varied (e.g., W=5 or W=20). Another example of an algorithm is BLAT (Kent, W. J. Genome Res. 12:656-64 (2002).

Other examples include the algorithm of Myers and Miller, CABIOS (1989), ADVANCE and ADAM as described in Torellis, A. and Robotti, C., Comput. Appl. Biosci. 10:3-5 (1994); and FASTA described in Pearson, W. and Lipman, D., Proc. Natl. Acad. Sci. USA, 85:2444-48 (1988).

In another embodiment, the percent identity between two amino acid sequences can be accomplished using the GAP program in the GCG software package (Accelrys, Cambridge, UK).

The present invention also provides isolated nucleic acid molecules that contain a fragment or portion that hybridizes under highly stringent conditions to a nucleic acid that comprises, or consists of, the nucleotide sequence of the 1p36 LD Block (SEQ ID NO:1) or the 1q42 LD Block (SEQ ID NO:2), or a nucleotide sequence comprising, or consisting of, the complement of the nucleotide sequence of the 1p36 LD Block (SEQ ID NO:1) or the 1q42 LD Block (SEQ ID NO:2), wherein the nucleotide sequence comprises at least one polymorphic allele contained in the markers and haplotypes described herein. The invention also provides isolated nucleic acid molecules that contain a fragment or portion that hybridizes under highly stringent conditions to a nucleic acid that comprises, or consists of, the nucleotide sequence of any one of SEQ ID NO:3-298. The nucleic acid fragments of the invention are at least about 15, at least about 18, 20, 23 or 25 nucleotides, and can be 30, 40, 50, 100, 200, 400, 500, 1000, 10,000 or more nucleotides in length.

The nucleic acid fragments of the invention are used as probes or primers in assays such as those described herein. “Probes” or “primers” are oligonucleotides that hybridize in a base-specific manner to a complementary strand of a nucleic acid molecule. In addition to DNA and RNA, such probes and primers include polypeptide nucleic acids (PNA), as described in Nielsen, P. et al., Science 254:1497-1500 (1991). A probe or primer comprises a region of nucleotide sequence that hybridizes to at least about 15, typically about 20-25, and in certain embodiments about 40, 50 or 75, consecutive nucleotides of a nucleic acid molecule. In one embodiment, the probe or primer comprises at least one allele of at least one polymorphic marker or at least one haplotype described herein, or the complement thereof. In particular embodiments, a probe or primer can comprise 100 or fewer nucleotides; for example, in certain embodiments from 6 to 50 nucleotides, or, for example, from 12 to 30 nucleotides. In other embodiments, the probe or primer is at least 70% identical, at least 80% identical, at least 85% identical, at least 90% identical, or at least 95% identical, to the contiguous nucleotide sequence or to the complement of the contiguous nucleotide sequence. In another embodiment, the probe or primer is capable of selectively hybridizing to the contiguous nucleotide sequence or to the complement of the contiguous nucleotide sequence. Often, the probe or primer further comprises a label, e.g., a radioisotope, a fluorescent label, an enzyme label, an enzyme co-factor label, a magnetic label, a spin label, an epitope label.

The nucleic acid molecules of the invention, such as those described above, can be identified and isolated using standard molecular biology techniques well known to the skilled person. The amplified DNA can be labeled (e.g., radiolabeled, fluorescently labeled) and used as a probe for screening a cDNA library derived from human cells. The cDNA can be derived from mRNA and contained in a suitable vector. Corresponding clones can be isolated, DNA obtained following in vivo excision, and the cloned insert can be sequenced in either or both orientations by art-recognized methods to identify the correct reading frame encoding a polypeptide of the appropriate molecular weight. Using these or similar methods, the polypeptide and the DNA encoding the polypeptide can be isolated, sequenced and further characterized.

### Antibodies

The invention also provides antibodies which bind to an epitope comprising either a variant amino acid sequence (e.g., comprising an amino acid substitution) encoded by a variant allele or the reference amino acid sequence encoded by the corresponding non-variant or wild-type allele. The term “antibody” as used herein refers to immunoglobulin molecules and immunologically active portions of immunoglobulin molecules, i.e., molecules that contain antigen-binding sites that specifically bind an antigen. A molecule that specifically binds to a polypeptide of the invention is a molecule that binds to that polypeptide or a fragment thereof, but does not substantially bind other molecules in a sample, e.g., a biological sample, which naturally contains the polypeptide. Examples of immunologically active portions of immunoglobulin molecules include F(ab) and F(ab′)₂ fragments which can be generated by treating the antibody with an enzyme such as pepsin. The invention provides polyclonal and monoclonal antibodies that bind to a polypeptide of the invention. The term “monoclonal antibody” or “monoclonal antibody composition”, as used herein, refers to a population of antibody molecules that contain only one species of an antigen binding site capable of immunoreacting with a particular epitope of a polypeptide of the invention. A monoclonal antibody composition thus typically displays a single binding affinity for a particular polypeptide of the invention with which it immunoreacts.

Polyclonal antibodies can be prepared as described above by immunizing a suitable subject with a desired immunogen, e.g., polypeptide of the invention or a fragment thereof. The antibody titer in the immunized subject can be monitored over time by standard techniques, such as with an enzyme linked immunosorbent assay (ELISA) using immobilized polypeptide. If desired, the antibody molecules directed against the polypeptide can be isolated from the mammal (e.g., from the blood) and further purified by well-known techniques, such as protein A chromatography to obtain the IgG fraction. At an appropriate time after immunization, e.g., when the antibody titers are highest, antibody-producing cells can be obtained from the subject and used to prepare monoclonal antibodies by standard techniques, such as the hybridoma technique originally described by Kohler and Milstein, Nature 256:495-497 (1975), the human B cell hybridoma technique (Kozbor et al., Immunol. Today 4: 72 (1983)), the EBV-hybridoma technique (Cole et al., Monoclonal Antibodies and Cancer Therapy, Alan R. Liss, 1985, Inc., pp. 77-96) or trioma techniques. The technology for producing hybridomas is well known (see generally Current Protocols in Immunology (1994) Coligan et al., (eds.) John Wiley & Sons, Inc., New York, N.Y.). Briefly, an immortal cell line (typically a myeloma) is fused to lymphocytes (typically splenocytes) from a mammal immunized with an immunogen as described above, and the culture supernatants of the resulting hybridoma cells are screened to identify a hybridoma producing a monoclonal antibody that binds a polypeptide of the invention.

Any of the many well known protocols used for fusing lymphocytes and immortalized cell lines can be applied for the purpose of generating a monoclonal antibody to a polypeptide of the invention (see, e.g., Current Protocols in Immunology, supra; Galfre et al., Nature 266:55052 (1977); R. H. Kenneth, in Monoclonal Antibodies: A New Dimension In Biological Analyses, Plenum Publishing Corp., New York, N.Y. (1980); and Lerner, Yale J. Biol. Med. 54:387-402 (1981)). Moreover, the ordinarily skilled worker will appreciate that there are many variations of such methods that also would be useful.

Alternative to preparing monoclonal antibody-secreting hybridomas, a monoclonal antibody to a polypeptide of the invention can be identified and isolated by screening a recombinant combinatorial immunoglobulin library (e.g., an antibody phage display library) with the polypeptide to thereby isolate immunoglobulin library members that bind the polypeptide. Kits for generating and screening phage display libraries are commercially available (e.g., the Pharmacia Recombinant Phage Antibody System, Catalog No. 27-9400-01; and the Stratagene SurfZAP™ Phage Display Kit, Catalog No. 240612). Additionally, examples of methods and reagents particularly amenable for use in generating and screening antibody display library can be found in, for example, U.S. Pat. No. 5,223,409; PCT Publication No. WO 92/18619; PCT Publication No. WO 91/17271; PCT Publication No. WO 92/20791; PCT Publication No. WO 92/15679; PCT Publication No. WO 93/01288; PCT Publication No. WO 92/01047; PCI Publication No. WO 92/09690; PCT Publication No. WO 90/02809; Fuchs et al., Bio/Technology 9: 1370-1372 (1991); Hay et al., Hum. Antibod. Hybridomas 3:81-85 (1992); Huse et al., Science 246: 1275-1281 (1989); and Griffiths et al., EMBO J. 12:725-734 (1993).

Additionally, recombinant antibodies, such as chimeric and humanized monoclonal antibodies, comprising both human and non-human portions, which can be made using standard recombinant DNA techniques, are within the scope of the invention. Such chimeric and humanized monoclonal antibodies can be produced by recombinant DNA techniques known in the art.

In general, antibodies of the invention (e.g., a monoclonal antibody) can be used to isolate a polypeptide of the invention by standard techniques, such as affinity chromatography or immunoprecipitation. A polypeptide-specific antibody can facilitate the purification of natural polypeptide from cells and of recombinantly produced polypeptide expressed in host cells. Moreover, an antibody specific for a polypeptide of the invention can be used to detect the polypeptide (e.g., in a cellular lysate, cell supernatant, or tissue sample) in order to evaluate the abundance and pattern of expression of the polypeptide. Antibodies can be used diagnostically to monitor protein levels in tissue as part of a clinical testing procedure, e.g., to, for example, determine the efficacy of a given treatment regimen. The antibody can be coupled to a detectable substance to facilitate its detection. Examples of detectable substances include various enzymes, prosthetic groups, fluorescent materials, luminescent materials, bioluminescent materials, and radioactive materials. Examples of suitable enzymes include horseradish peroxidase, alkaline phosphatase, beta-galactosidase, or acetylcholinesterase; examples of suitable prosthetic group complexes include streptavidin/biotin and avidin/biotin; examples of suitable fluorescent materials include umbelliferone, fluorescein, fluorescein isothiocyanate, rhodamine, dichlorotriazinylamine fluorescein, dansyl chloride or phycoerythrin; an example of a luminescent material includes luminol; examples of bioluminescent materials include luciferase, luciferin, and aequorin, and examples of suitable radioactive material include ¹²⁵I, ¹³¹I, ³⁵S or ³H.

Antibodies may also be useful in pharmacogenomic analysis. In such embodiments, antibodies against, variant proteins encoded by nucleic acids according to the invention, such as variant proteins that are encoded by nucleic acids that contain at least one polymorpic marker of the invention, can be used to identify individuals that require modified treatment modalities.

Antibodies can furthermore be useful for assessing expression of variant proteins in disease states, such as in active stages of a disease, or in an individual with a predisposition to a disease related to the function of the protein, in particular a cancer selected from SCC, BCC and CM, in particular BCC. Antibodies specific for a variant protein of the present invention that is encoded by a nucleic acid that comprises at least one polymorphic marker or haplotype as described herein can be used to screen for the presence of the variant protein, for example to screen for a predisposition to the cancer as indicated by the presence of the variant protein.

Antibodies can be used in other methods. Thus, antibodies are useful as diagnostic tools for evaluating proteins, such as variant proteins encoded by the nucleic acids described herein (e.g. one or more of the PADI1, PADI2, PADI3, PADI4, PADI6, AHRGEF10L, RCC2 and RHOU proteins), in conjunction with analysis by electrophoretic mobility, isoelectric point, tryptic or other protease digest, or for use in other physical assays known to those skilled in the art. Antibodies may also be used in tissue typing. In one such embodiment, a specific variant protein has been correlated with expression in a specific tissue type, and antibodies specific for the variant protein can then be used to identify the specific tissue type.

Subcellular localization of proteins, including variant proteins, can also be determined using antibodies, and can be applied to assess aberrant subcellular localization of the protein in cells in various tissues. Such use can be applied in genetic testing, but also in monitoring a particular treatment modality. In the case where treatment is aimed at correcting the expression level or presence of the variant protein or aberrant tissue distribution or developmental expression of the variant protein, antibodies specific for the variant protein or fragments thereof can be used to monitor therapeutic efficacy.

Antibodies are further useful for inhibiting variant protein function, for example by blocking the binding of a variant protein to a binding molecule or partner. Such uses can also be applied in a therapeutic context in which treatment involves inhibiting a variant protein's function. An antibody can be for example be used to block or competitively inhibit binding, thereby modulating (i.e., agonizing or antagonizing) the activity of the protein. Antibodies can be prepared against specific protein fragments containing sites required for specific function or against an intact protein that is associated with a cell or cell membrane. For administration in vivo, an antibody may be linked with an additional therapeutic payload, such as radionuclide, an enzyme, an immunogenic epitope, or a cytotoxic agent, including bacterial toxins (diphtheria or plant toxins, such as ricin). The in vivo half-life of an antibody or a fragment thereof may be increased by pegylation through conjugation to polyethylene glycol.

The present invention further relates to kits for using antibodies in the methods described herein. This includes, but is not limited to, kits for detecting the presence of a variant protein in a test sample. One preferred embodiment comprises antibodies such as a labeled or labelable antibody and a compound or agent for detecting variant proteins in a biological sample, means for determining the amount or the presence and/or absence of variant protein in the sample, and means for comparing the amount of variant protein in the sample with a standard, as well as instructions for use of the kit.

The invention will now be illustrated by the following non-limiting example.

### EXEMPLIFICATION

### Genome Wide SNP Association Scan for CM, BCC, and SCC

In order to search widely for common sequence variants associated with predisposition to CM, BCC and/or SCC, we used Illumina Sentrix HumanHap300 and HumanCNV370-duo Bead Chip microarrays to genotype approximately 816 Icelandic cancer registry ascertained CM patients (including 522 invasive CM patients), 930 cancer registry ascertained, histopathologically confirmed Icelandic BCC patients, 339 histologically confirmed, cancer registry ascertained SCC patients, and 33,117 controls (a full description of the patient and control samples used in this study is in the Methods). After removing SNPs that failed quality checks (see Methods) a total of about 304,083 SNPs were tested for association. The results were adjusted for familial relatedness between individuals and for potential population stratification using the method of genomic control [Devlin and Roeder, (1999), Biometrics, 55, 997-1004]. We calculated the allelic odds ratio (OR) for each SNP assuming the multiplicative model and determined P values using a standard likelihood ratio χ² statistic. The association results that gave P values ≦2×10⁻⁴ for CM are shown in Table 1. The association results that gave P values ≦2×10⁻⁴ for invasive CM only are shown in Table 2. The association results that gave P values ≦2×10⁻⁴ for BCC are shown in Table 3. The association results that gave P values ≦10⁻⁴ for SCC are shown in Table 4. All the SNPs identified in these tables have potential diagnostic utility in the respective diseases.

### Replication of Association Results

BCC 1p36 & 1q42: For BCC, SNPs at two genomic locations produced substantial signals: The A-allele of rs7538876 at 1p36 showed an OR of 1.27 (P=1.9×10⁻⁶) and the G-allele of rs801114 at 1q42 showed an OR of 1.32 (P=5.0×10⁻⁸)(Table 5). Signals were also detected from two SNPs that are in strong LD with rs801114. SNP rs801109 (D′=1.00, r²=0.64 with rs801114 in the HapMap CEU population sample) revealed an OR of 1.32 (P=1.8×10⁻⁷) for its T allele and rs241337 (D′=0.95, r²=0.63) gave an OR of 1.30 (P=3.7×10⁻⁷) for the C allele. Both T-rs801109 and C-rs241337 are rarer than allele G of rs801114 and are almost completely contained on the G-rs801114 background. In a multivariate analysis, the signal from G-rs801114 remained significant after adjustment for the effects of T-rs801109 (residual P=0.0468) or C-rs241337 (residual P=0.0257) whereas the T-rs801109 and C-rs241337 signals did not survive adjustment for the effect of G-rs801114 (residual P=0.291 and 0.526 respectively). We considered that these three SNPs are detecting essentially the same signal which is captured best by rs801114. So in subsequent analyses we studied only rs801114 at 1q42.

For clarity, we herein refer to the SNP that originally gave the strongest signal at each locus in a genome-wide association screen as the “key SNP” for that locus. We refer to the genetic variant that is mechanistically responsible for the increase in risk at each locus as the “causative variant”. In a genome-wide association study, the key SNP and the causative variant are unlikely to be one and the same. More typically, key SNPs produce signals because they are correlated through LD with causative variants. Each SNP that was selected for inclusion on the Illumina chip were chosen in part because it acts as a surrogate for a large set of un-genotyped SNPs, i.e. any key SNP will be correlated (through LD) with a group of unobserved SNPs that are not on the chip. If they were tested individually, each of the un-genotyped SNPs in such a set would represent essentially the same association signal. If a SNP in the set is more closely correlated with the causative variant than the key SNP is, one would expect that SNP to confer a higher relative risk than the key SNP. Table 6 shows a list of HapMap SNPs in the 1p36 LD block that are correlated with rs7538876 by an r² value of 0.2 or higher. Any of these SNPs might be used to produce a signal that is as good or better than that provided by rs7538876. Table 7 shows a list of HapMap SNPs in the 1q42 LD block that are correlated with rs801114 by an r² value of 0.2 or higher. Any of these SNPs might in particular be used to produce a signal that is as good or better than that provided by rs801114.

To confirm the findings of association with rs7538876 and rs801114, we generated single-track Centaurus [Kutyavin, et al., (2006), Nucleic Acids Res, 34, e128] assays for the two SNPs. We typed the 1p36 and 1q42 SNPs in a further set of 703 Icelanders with BCC and 2329 controls (designated Iceland BCC 2). We further typed a sample of 513 BCC patients and 515 controls from Hungary, Romania and Slovakia (the Eastern Europe BCC set) [Scherer, et al., (2007), Int Cancer, 122, 1787-1793]. For both SNPs, nominally significant replication was observed in both replication samples (Table 5). There was no evidence of heterogeneity in the association data between the Icelandic and Eastern European samples. Data from the Icelandic and Eastern Europe BCC sets were combined using the Mantel-Haenszel model to produce a joint estimate of the OR and significance. The SNPs each gave OR of 1.28 and P values of 4.4×10⁻¹² for A-rs7538876 and 5.9×10⁻¹² for G-rs801114 (Table 5). Given that these P values were well below the Bonferroni threshold for genome-wide significance (P<1.6×10⁻⁷) and that the association replicated consistently, we conclude that the 1p36 and 1q42 SNPs confer susceptibility to BCC.

UV exposure indices and immunosuppression are strongly associated with risk of BCC [Roewert-Huber, et al., (2007), Br J Dermatol, 157 Suppl 2, 47-51; Lear, et al., (2005), Clin Exp Dermatol, 30, 49-55]. Squamous cell carcinoma of the skin (SCC) shares these risk factors, as well as several genetic risk factors with BCC [Xu and Koo, (2006), Int J Dermatol, 45, 1275-83; Bastiaens, et al., (2001), Am J Hum Genet, 68, 884-94; Han, et al., (2006), Int J Epidemiol, 35, 1514-21]. We tested a sample of 413 histopathologically confirmed, Icelandic SCC patients (who did not have diagnoses of BCC recorded in the cancer registry) for association with the 1p36 and 1q42 SNPs. As shown in Table 5, there was no evidence in support of an SCC risk associated with either locus.

Low penetrance variants in the MC1R, ASIP and TYR genes were previously shown to confer risks for both BCC and cutaneous melanoma (CM) [Bastiaens, et al., (2001), Am J Hum Genet, 68, 884-94; Han, et al., (2006), Int J Cancer, 119, 1976-84] (Gudbjartsson et al., 2008)[Scherer, et al., (2007), Int J Cancer, 122, 1787-1793]. This is thought to be due, at least in part, to the association of these variants with fair pigmentation traits that provide poor protection against UV irradiation [Sulem, et al., (2007), Nat Genet, 39, 1443-52] (Sulem et al, 2008 in press), which is also a risk factor for CM [Markovic, et al., (2007), Mayo Clin Proc, 82, 364-80]. We examined whether the 1p36 and 1q42 SNPs confer risk of CM in a set of 2,081 cases and over 40,000 controls from Iceland, Sweden and Spain (the majority of the controls were the same Icelandic controls used to determine the BCC association). Neither BCC-associated variant conferred a demonstrable risk of CM (Table 5). Thus the emerging picture of low penetrance variants in skin cancer is mixed, with some variants conferring risk of all three skin cancer types, while others have more type-specific associations.

One unifying theme might be that genes associated with fair pigmentation traits confer cross-risk of all three skin cancer types because of their roles in protection from the shared risk factor of UV light, whereas the more specifically associated variants may act through different pathways. To investigate this, we tested the 1p36 and 1q42 SNPs for association with eye colour, hair colour, propensity to freckle and skin sensitivity to sun (Fitzpatrick scale), using self reported pigmentation data from 4720 Icelanders who had been genotyped on the Illumina platform [Sulem, et al., (2007), Nat Genet, 39, 1443-52] (Sulem et al, 2008 in press). We saw no evidence of association between the 1p36 and 1q42 SNPs and any of the pigmentation traits tested (Table 8). This would suggest that the 1p36 and 1q42 variants act through pathways other than those related to UV-susceptible pigmentation traits.

The 1p36 SNP rs7538876 is in the 13^{th} intron of the peptidylarginine deiminase 6 gene (PADI6) (FIG. 1). Peptidylarginine deiminases are involved in posttranslational modifications of arginine and methyl arginine residues, creating the derivative amino acid citrulline. Citrullination is involved in facilitating the assembly of higher order protein structures, particularly cytoskeletal structures [Gyorgy, et al., (2006), Int J Biochem Cell Biol, 38, 1662-77]. There are 5 PADI gene and all are located in a cluster on 1p36. PADI6 is the most proximal. PADI1-3 are expressed in epidermis and citrullination of cytokeratins and filaggrin are important in terminal differentiation of keratinocytes [Chavanas, et al., (2006), J Dermatol Sci, 44, 63-72]. However, PADI1-3 are separated from rs7538876 by a region of high recombination (FIG. 1). The 3′ end of PADI4 is within the linkage disequilibrium (LD) block containing rs7538876. PADI4 has been implicated in rheumatoid arthritis and in repression of histone methylation-mediated gene regulation [Suzuki, et al., (2007), Ann N Y Acad Sci, 1108, 323-39; Wysocka, et al., (2006), Front Biosci, 11, 344-55]. PADI6 itself is expressed only in germ cells, where it appears to play a role in cytoskeletal organization [Esposito, et al., (2007), Mol Cell Endocrinol, 273, 25-31].

Also in the 1p36 LD block is the regulator of chromosome condensation 2 gene (RCC2) (FIG. 1), which is involved in mitotic spindle assembly [Mollinari, et al., (2003), Dev Cell, 5, 295-307]. The 5″ end of the longer transcript of the AHRGEF10L gene is also in the 1p36 LD block. It encodes GrinchGEF, a guanine nucleotide exchange factor involved in Rho GTPase activation [Winkler, et al., (2005), Biochem Biophys Res Commun, 335, 1280-6]. Both RCC2 and AHRGEF10L are plausible candidates for BCC susceptibility genes. No known common missense or nonsense mutations in these genes are strongly correlated with rs7538876.

There is no RefSeq gene in the 1q42 LD block containing rs801114. The Ras homologue RHOU is the nearest gene, in the adjacent proximal LD block (FIG. 2). RHOU has been implicated in WNT1 signalling, regulation of the cytoskeleton and cell proliferation [Tao, et al., (2001), Gene Dev, 15, 1796-807]. The WNT pathway was previously implicated in BCC, as germline mutations in PTCH are found in patients with Nevoid Basal Cell Carcinoma (Gorlin's) Syndrome and somatic mutations in PTCH have been detected in sporadic BCC [Hahn, et al., (1996), Cell, 85, 841-514, Johnson, et al., (1996), Science, 272, 1668-71].

RCC2 was previously reported to be significantly up-regulated in BCC lesions relative to normal: skin [O'Driscoll, et al., (2006), Mol Cancer, 5, 74]. We had previously correlated SNP genotypes to the expression of 23,720 transcripts measured on Agilent microarrays, using RNA samples from adipose tissue and peripheral blood from 745 individuals [Emilsson, et al., (2008), Nature, 452, 423-8]. Allele A of rs7538876 is significantly associated with expression of RCC2 in blood, with an estimated 2.9% increase in expression for each copy of the risk allele carried (FIG. 3a). A similar association was observed for adipose-derived RNA, with an estimated 4.6% increase in expression per copy (FIG. 3b). In order to confirm these observations, we generated a TaqMan assay targeted on a different region of the RCC2 transcript (the exon 2̂3 splice junction) and re-tested the adipose RNA samples. As shown in FIG. 4c, a significant association between A-rs7538876 and increased expression of RCC2 was also observed using this method with an estimated 8.7% increase in expression per copy of the risk allele. Althoughthese samples are not derived from the target tissues for BCC, these data indicate that the oncogenic effect of rs7538876 may be mediated through an alteration in expression of RCC2.

Allele A-rs7538876 at 1p36 was associated with a younger age at diagnosis of BCC in both Icelandic and Eastern European samples (Table 9). Combining both sample sets resulted in an estimate of 1.39 years younger age at diagnosis for each A-rs7538876 allele carried (P=5.96×10⁻⁴). The 1q42 variant rs801114 was not associated with age at diagnosis.

To investigate the mode of inheritance, we computed the genotype-specific OR for the SNPs at each locus. Neither variant showed a significant deviation from a multiplicative (codominant) model of inheritance. There was no evidence of interaction between the two loci (the r² between the 1p36 and 1q43 markers was <0.002 in both cases and controls). We recently reported that pigmentation trait-associated variants in the ASIP, TYR loci confer risk of BCC, in addition to the known effect of strong red hair color variants of MC1R (Gudbjartsson et al., 2008, in press). Assuming a multiplicative mode of allelic and intergenic interactions, we generated a risk model incorporating 1p36, 1q42, and these three pigmentation trait-associated loci (FIG. 4). The relative risks predicted by this model range up to 12.3-fold for individuals homozygous for all risk alleles, relative to those homozygous for all protective alleles. Five percent of the population has a predicted 1.67-fold or higher increased risk relative to the population average. Given that the incidence of BCC is so high, many individuals fall into these higher risk classes. We estimated a population attributable risk (PAR) of 17% each for rs7538876 and rs801114 and the joint PAR estimate for both variants together was 31%. Using our published data (Gudbjartsson et al., 2008, in press) we also estimated BCC PARs of MC1R strong red hair colour variants (10%), TYR R402Q (7%) and the ASIP AH haplotype (4%). The joint PAR for all 5 loci is 45%. Thus nearly half of all BCC diagnoses can be attributed to these genetic variants.

### Methods:

### Patients and Control Selection

Iceland: Approval for the study was granted by the Icelandic National Bioethics Committee and the Icelandic Data Protection Authority. The Icelandic Cancer Registry (ICR) has maintained records of BCC diagnoses since 1981. The records contain all incidences of histologically verified BCC, sourced from all the pathology laboratories in the country that deal with such lesions. Diagnoses of BCC made up to the end of 2007 were included and were identified by ICD10 code C44 with a SNOMED morphology code indicating BCC. The ICR has recorded histologically confirmed diagnoses of squamous cell carcinoma (SCC) of the skin since 1955. SCC diagnoses made up to the end of 2007 were included and were identified by ICD10 code C44 with a SNOMED morphology code indicating SCC. Records of invasive cutaneous melanoma (invasive CM) diagnoses, all histologically confirmed, from the years 1955-2007 were obtained from the ICR. Invasive CM was identified through ICD10 code C43. The ICR records also included diagnoses of melanoma in situ (in situ CM) from 1980-2007, identified by ICD10 code D03. Metastatic melanoma (where the primary lesion had not been identified) was identified by a SNOMED morphology code indicating melanoma with a/6 suffix, regardless of the ICD10 code. Ocular melanoma (OM) and melanomas arising at mucosal sites were not included. All patients identified through the ICR were invited to a study recruitment center where they signed an informed consent form and provided a blood sample.

The Icelandic controls consisted of individuals selected from other ongoing association studies at deCODE. Individuals with at diagnosis of BCC, SCC or CM as well as their first degree relatives, identified from the Icelandic Genealogical Database, were excluded from the respective control groups. Approximately 4900 of the cases and controls answered a questionnaire with the aid of a study nurse. The questionnaire included questions about natural hair and eye color, freckling amount (none, few, moderate, many), and tanning responses using the Fitzpatrick scale. There were no significant differences between genders in the frequencies of the SNPs studied and no association with age amongst controls. All subjects were of European ethnicity.

Eastern Europe: Details of this case: control set have been published previously [Scherer, et al., (2007), Int J Cancer, 122, 1787-1793]. Briefly, BCC cases were recruited from all general hospitals in three study areas in Hungary, two in Romania and one in Slovakia. Patients were identified on the basis of histopatholgical examinations by pathologists. The median age at diagnosis was 67 years (range 30-85). Controls were recruited from the same hospitals. Individuals with malignant disease, cardiovascular disease and diabetes were excluded. Local ethical boards approved of the study.

Sweden: The Swedish sample was composed of 1062 consecutive patients attending care for CM at the Karolinska University Hospital in Solna during 1993 to 2007. The clinical characteristics of the subjects were obtained from medical records. The median age at diagnosis was 60 years (range 17-91). The controls were blood donors recruited on a voluntary basis from the Karolinska University Hospital, Stockholm. The study was conducted in accordance with the Declaration of Helsinki. Ethical approval for the study from the local ethics committee and written informed consent from all study participants were obtained.

Spain: 184 of the Spanish CM patients were recruited from the Department of Dermatology, Valencia Institute of Oncology. All diagnoses were confirmed by histopathology. Median age at diagnosis was 54 years (range 15-85). 93 of the Spanish CM patients were recruited from the Oncology Department of Zaragoza Hospital. Patients with histologically-proven invasive cutaneous melanoma or metastatic melanoma were eligible to participate in the study. The median age at diagnosis was 58 years (range 23-90). The 1292 Spanish controls had attended the University Hospital in Zaragoza for diseases other than cancer. Controls were questioned to rule out prior cancers before drawing the blood sample. Ethical approval for the Spanish part of the study was given by the local ethics committees and written informed consent from all study participants were obtained. All subjects were of European ethnicity.

### Genotyping

Approximately 930 Icelandic BCC patients, 565 Icelandic CM patients and all Icelandic controls were genotyped on Illumina HumanHap300 or HumanCNV370-duo chips. These chips provide about 75% genomic coverage in the Utah CEPH (CEU) HapMap samples for common SNPs at r²≧0.8 (Barett & Cardon, 2006). SNP data were discarded if they were monomorphic (that is, the minor allele frequency in the combined case and control was <0.001) or had less than 95% yield or showed a very significant distortion from Hardy-Weinberg equilibrium in the controls (P<1×10⁻¹⁰).) Any chips with a call rate below 98% of the SNPs were excluded from the genome-wide association analysis.

Other SNP genotyping was carried out using Nanogen Centaurus assay [Kutyavin, et al., (2006), Nucleic Acids Res, 34, e128]. Centaurus assays were produced for rs7538876 and rs801114. Primer sequences are available on request. Centaurus SNP assays were validated by genotyping the HapMap CEU samples and comparing genotypes to published data. Assays were rejected if they showed >1.5% mismatches with the HapMap data. Approximately 10% of the Icelandic case samples that were genotyped on the Illumina platform were also genotyped using the Centaurus assays and the observed mismatch rate was lower than 0.5%. All genotyping was carried out at the deCODE Genetics facility.

### Expression Analysis

Samples of RNA from human adipose and peripheral blood were hybridized to Agilent Technologies Human 25k microarrays as described in [Emilsson, et al., (2008), Nature, 452, 423-8]. Expression changes between two samples were quantified as the mean logarithm (log₁₀) expression ratio (MLR) compared to a reference pool RNA sample. The array probe for RCC2 was in the 3′ untranslated region of the gene.

For RT-PCR analysis, total RNA, the same samples as were used for the microarray analyses, was converted to cDNA using the High Capacity cDNA Archive Kit (Applied Biosystems), primed with random hexamers. A TaqMan assay for the analysis of RCC2 was purchased as an off-the shelf Assay from Applied Biosystems (Assay #: Hs00603046_m1). Real time PCR was carried out according to the manufacturer's instructions on an ABI Prism 7900HT Sequence Detection System. Quantification was performed using the ΔΔCt method (User Bulletin no. 2 Applied Biosystems 2001) using Human GUS for normalizing input cDNA

### Statistical Analysis

We calculated the OR for each SNP allele or haplotype assuming the multiplicative model; i.e. assuming that the relative risk of the two alleles that a person carries multiplies. Allelic frequencies and OR are presented for the markers. The associated P values were calculated with the standard likelihood ratio x2 statistic as implemented in the NEMO software package (Gretarsdottir et al, 2003). Confidence intervals were calculated assuming that the estimate of OR has a log-normal distribution. For SNPs that were in strong LD, whenever the genotype of one SNP was missing for an individual, the genotype of the correlated SNPs were used to impute genotypes through a likelihood approach as previously described (Gretarsdottir et al, 2003). This ensured that results presented for different SNPs were based on the same number of individuals, allowing meaningful comparisons of OR and P-values. Some of the Icelandic patients and controls are related to each other, both within and between groups, causing the χ2 statistic to have a mean >1. We estimated the inflation factor by simulating genotypes through the Icelandic genealogy and corrected the χ2 statistics for Icelandic OR's accordingly. The estimated inflation factor was NNN

Joint analyses of multiple case-control replication groups were carried out using a Mantel-Haenszel model in which the groups were allowed to have different population frequencies for alleles or genotypes but were assumed to have common relative risks. The tests of heterogeneity were performed by assuming that the allele frequencies were the same in all groups under the null hypothesis, but each group had a different allele frequency under the alternative hypothesis. The same Mantel-Haenszel model was used to combine the results from Eastern Europe which came from 5 strata: Hungarians living in Hungary, Hungarians living in Romania, Hungarians living in Slovakia, Romanians living in Romania, and Slovaks living in Slovakia.

We calculated genotype specific ORs, by estimating the genotype frequencies in the population assuming Hardy-Weinberg equilibrium. No significant deviations from multiplicity were observed for the SNPs showing association with BCC. Potential interactions between loci were examined using correlation tests of allele counts amongst cases. No significant interactions were observed. For the multigenic risk model, the general population risk was determined as the frequency-weighted average of all genotypes expressed relative to the multiple non-risk homozygote. The risk for each genotype was then expressed relative to the population risk. Allele frequencies used in the calculations were the arithmetic means of the frequencies in the Icelandic and Eastern European samples for 1p36 and 1q42, and in the European sample sets described in (Gudbjartsson et al, 2008) for the ASIP, TYR and MC1R variants.

All P values are reported as two-sided.

TABLE 1
Association results from Genome Wide SNP scan using Illumina Sentrix HumanHap300 and
HumanCNV370-duo Bead Chip for Cutaneous Melanoma (CM). P values ≦2 × 10⁻⁴ for CM are shown

| | | | Case | Case | Control | Control | | | Pos in |
|---|---|---|---|---|---|---|---|---|---|
| SNP | p-value | OR | number | freq. | number | freq. | All | Chr | Build 36 |
| rs7757317 | 1.35E−06 | 1.6004 | 816 | 0.938725 | 32210 | 0.905418 | 2 | 6 | 119795555 |
| rs4833467 | 1.81E−06 | 1.2867 | 815 | 0.674847 | 32210 | 0.617308 | 3 | 4 | 115886636 |
| rs742962 | 3.29E−06 | 1.5627 | 811 | 0.935882 | 32174 | 0.903291 | 3 | 6 | 119755445 |
| rs4723562 | 3.32E−06 | 1.3248 | 816 | 0.237132 | 32217 | 0.190039 | 1 | 7 | 36723652 |
| rs4723563 | 3.49E−06 | 1.3188 | 816 | 0.246324 | 32207 | 0.198606 | 2 | 7 | 36723988 |
| rs165185 | 4.40E−06 | 1.261 | 816 | 0.579044 | 32096 | 0.521716 | 3 | 5 | 139124950 |
| rs9793010 | 0.00001042 | 1.3238 | 816 | 0.822304 | 32217 | 0.777571 | 2 | 1 | 230362158 |
| rs9585777 | 0.00001431 | 1.306 | 816 | 0.804534 | 32190 | 0.759133 | 1 | 13 | 85863400 |
| rs1938350 | 0.00001441 | 1.3477 | 816 | 0.171569 | 32206 | 0.133205 | 4 | 1 | 102405523 |
| rs1887419 | 0.00001529 | 1.3273 | 815 | 0.193252 | 32188 | 0.152883 | 4 | 6 | 2278706 |
| rs3742384 | 0.00001808 | 1.3235 | 815 | 0.834356 | 32201 | 0.791916 | 2 | 14 | 99869856 |
| rs9585170 | 0.00001864 | 1.3015 | 814 | 0.804054 | 32197 | 0.759201 | 3 | 13 | 85842380 |
| rs7619556 | 0.00002357 | 1.2421 | 814 | 0.619165 | 32080 | 0.566895 | 1 | 3 | 191035065 |
| rs1510646 | 0.00002624 | 1.3664 | 803 | 0.146326 | 32149 | 0.111465 | 4 | 4 | 35716180 |
| rs4833119 | 0.00002696 | 1.4274 | 813 | 0.108241 | 32173 | 0.078373 | 4 | 4 | 35809737 |
| rs1873465 | 0.00002698 | 1.4106 | 816 | 0.115809 | 32214 | 0.084963 | 2 | 10 | 77859965 |
| rs12416600 | 0.0000284 | 1.4258 | 816 | 0.107843 | 32218 | 0.078155 | 4 | 10 | 49605884 |
| rs6561621 | 0.00002933 | 1.2533 | 816 | 0.702819 | 32215 | 0.653609 | 4 | 13 | 50680975 |
| rs1051922 | 0.00003005 | 1.2503 | 815 | 0.690798 | 32212 | 0.641174 | 2 | 9 | 21067716 |
| rs10511695 | 0.00003015 | 1.2441 | 812 | 0.656404 | 32093 | 0.605615 | 3 | 9 | 21035062 |
| rs1450425 | 0.00003206 | 1.2716 | 816 | 0.267157 | 32212 | 0.222805 | 1 | 18 | 42363031 |
| rs1946116 | 0.00003397 | 1.5821 | 813 | 0.95326 | 32151 | 0.928012 | 4 | 7 | 126180375 |
| rs2201848 | 0.00003656 | 1.235 | 816 | 0.41973 | 32199 | 0.369359 | 4 | 1 | 76997764 |
| rs634681 | 0.00003667 | 1.2847 | 815 | 0.795706 | 32212 | 0.751971 | 2 | 11 | 60378237 |
| rs10186788 | 0.00003891 | 1.2395 | 816 | 0.655637 | 32207 | 0.605676 | 3 | 2 | 62566799 |
| rs17586724 | 0.00004238 | 1.3325 | 792 | 0.169192 | 31979 | 0.132571 | 2 | 4 | 117112694 |
| rs1567144 | 0.00004247 | 1.2474 | 814 | 0.700246 | 32208 | 0.651903 | 2 | 16 | 8070325 |
| rs7910468 | 0.00004762 | 1.2553 | 816 | 0.73652 | 32207 | 0.690098 | 3 | 10 | 87056915 |
| rs736711 | 0.00004815 | 1.411 | 814 | 0.912776 | 32184 | 0.881183 | 3 | 2 | 84919756 |
| rs631922 | 0.00004853 | 1.415 | 773 | 0.909444 | 31555 | 0.876501 | 1 | 2 | 224351635 |
| rs4242090 | 0.0000528 | 1.2768 | 811 | 0.237361 | 32206 | 0.195988 | 2 | 5 | 3418033 |
| rs7997435 | 0.00005327 | 1.2466 | 816 | 0.31924 | 32215 | 0.273351 | 2 | 13 | 36009150 |
| rs11201526 | 0.00005335 | 1.2535 | 815 | 0.736196 | 32211 | 0.690044 | 4 | 10 | 87011383 |
| rs4298501 | 0.0000575 | 1.2297 | 816 | 0.626838 | 32208 | 0.577341 | 4 | 8 | 19484349 |
| rs2880005 | 0.00005817 | 1.2322 | 816 | 0.646446 | 32209 | 0.597411 | 3 | 13 | 86006618 |
| rs1233708 | 0.00005912 | 1.246 | 814 | 0.316339 | 32212 | 0.2708 | 1 | 6 | 28281198 |
| rs894004 | 0.00006533 | 1.2593 | 815 | 0.267485 | 32202 | 0.224784 | 4 | 3 | 138248549 |
| rs2153823 | 0.00006534 | 1.5032 | 815 | 0.943558 | 32193 | 0.917498 | 2 | 6 | 119836460 |
| rs203877 | 0.00006658 | 1.2474 | 798 | 0.31391 | 31624 | 0.268356 | 2 | 6 | 28156603 |
| rs2957618 | 0.00006826 | 1.2509 | 815 | 0.740491 | 32214 | 0.695226 | 2 | 8 | 19540564 |
| rs9393879 | 0.00007013 | 1.434 | 815 | 0.093252 | 32159 | 0.066918 | 1 | 6 | 28126923 |
| rs1614702 | 0.00007399 | 1.2491 | 814 | 0.291769 | 32146 | 0.248009 | 1 | 7 | 97464097 |
| rs4280315 | 0.00007405 | 1.2647 | 816 | 0.780637 | 32217 | 0.737794 | 3 | 17 | 188593 |
| rs3778566 | 0.00007507 | 1.3067 | 816 | 0.177696 | 32205 | 0.141903 | 2 | 6 | 2158784 |
| rs149951 | 0.00007942 | 1.2408 | 816 | 0.316176 | 32212 | 0.271467 | 2 | 6 | 28141066 |
| rs4786212 | 0.00008178 | 1.2269 | 816 | 0.645833 | 32208 | 0.597786 | 2 | 16 | 8100555 |
| rs10242648 | 0.00008375 | 1.4825 | 815 | 0.076074 | 32195 | 0.052617 | 1 | 7 | 31171980 |
| rs7988749 | 0.00008476 | 1.9263 | 816 | 0.981618 | 32211 | 0.965183 | 4 | 13 | 60592950 |
| rs4315878 | 0.00008898 | 1.3197 | 813 | 0.159902 | 32174 | 0.126049 | 1 | 5 | 60598408 |
| rs4865879 | 0.00009314 | 1.2255 | 814 | 0.384521 | 32196 | 0.337651 | 2 | 5 | 54196102 |
| rs4773460 | 0.00009335 | 1.2818 | 813 | 0.207257 | 32153 | 0.169409 | 4 | 13 | 86040858 |
| rs12575532 | 0.00009538 | 2.0493 | 816 | 0.985294 | 32212 | 0.970322 | 4 | 11 | 73033777 |
| rs854391 | 0.00009688 | 1.2248 | 815 | 0.384049 | 32216 | 0.337332 | 3 | 14 | 24361815 |
| rs477461 | 0.00010291 | 1.3231 | 816 | 0.152574 | 32201 | 0.119779 | 3 | 10 | 8160149 |
| rs1033470 | 0.00010447 | 1.2647 | 815 | 0.234356 | 32212 | 0.194865 | 3 | 20 | 9673697 |
| rs1501399 | 0.00010602 | 1.3049 | 813 | 0.171587 | 32131 | 0.136986 | 4 | 15 | 52876531 |
| rs2035027 | 0.00010662 | 1.2666 | 816 | 0.229167 | 32215 | 0.190098 | 3 | 15 | 77893590 |
| rs6994092 | 0.00010739 | 1.2328 | 814 | 0.700246 | 32097 | 0.654563 | 2 | 8 | 76581700 |
| rs12648438 | 0.00010791 | 1.2721 | 815 | 0.218405 | 32213 | 0.180098 | 1 | 4 | 188865648 |
| rs9430161 | 0.00011235 | 1.3011 | 816 | 0.85049 | 32212 | 0.813858 | 3 | 1 | 10969442 |
| rs6679425 | 0.00011267 | 1.5702 | 816 | 0.05576 | 32170 | 0.036245 | 2 | 1 | 154817592 |
| rs1871276 | 0.00011387 | 1.2177 | 816 | 0.609681 | 32199 | 0.561927 | 4 | 17 | 20909606 |
| rs1512715 | 0.00011482 | 1.2829 | 816 | 0.827819 | 32212 | 0.789364 | 1 | 9 | 2555685 |
| rs656414 | 0.00011552 | 1.3062 | 800 | 0.853125 | 31530 | 0.816413 | 1 | 9 | 2525695 |
| rs4971226 | 0.00011582 | 1.2144 | 816 | 0.466299 | 32199 | 0.418414 | 4 | 1 | 201523423 |
| rs10432671 | 0.0001191 | 1.2689 | 814 | 0.22113 | 32204 | 0.182834 | 1 | 2 | 50974385 |
| rs122362 | 0.00011935 | 1.2322 | 809 | 0.701483 | 32163 | 0.656018 | 1 | 7 | 28243420 |
| rs4907105 | 0.00011951 | 1.2177 | 816 | 0.415441 | 32216 | 0.368544 | 2 | 1 | 85112593 |
| rs1265256 | 0.00012067 | 1.2355 | 815 | 0.719632 | 32208 | 0.675065 | 1 | 6 | 4429854 |
| rs2018041 | 0.00012083 | 1.213 | 816 | 0.487745 | 32214 | 0.439762 | 1 | 8 | 97712941 |
| rs2121875 | 0.00012188 | 1.2197 | 814 | 0.39742 | 32197 | 0.350964 | 3 | 5 | 44401302 |
| rs6471504 | 0.00012455 | 1.2203 | 816 | 0.387255 | 32209 | 0.341193 | 1 | 8 | 96060736 |
| rs2373177 | 0.00012554 | 1.2322 | 816 | 0.320466 | 32212 | 0.276791 | 2 | 7 | 147045332 |
| rs1011814 | 0.00012853 | 1.2187 | 815 | 0.396933 | 32211 | 0.350672 | 1 | 5 | 44371577 |
| rs6984390 | 0.00012865 | 1.2326 | 816 | 0.713235 | 32204 | 0.668628 | 1 | 8 | 19648218 |
| rs1466956 | 0.00013027 | 1.2554 | 813 | 0.246617 | 32168 | 0.20682 | 3 | 4 | 188827597 |
| rs11748833 | 0.00013055 | 1.5546 | 816 | 0.957108 | 32213 | 0.934871 | 3 | 5 | 154623799 |
| rs408042 | 0.00013113 | 1.2132 | 814 | 0.460074 | 32089 | 0.412587 | 1 | 5 | 14599241 |
| rs17098985 | 0.00013212 | 1.2785 | 816 | 0.825368 | 32215 | 0.787087 | 2 | 14 | 61162498 |
| rs3934418 | 0.00013584 | 1.2142 | 811 | 0.590629 | 31750 | 0.543008 | 4 | 1 | 245827769 |
| rs1860394 | 0.00013934 | 1.2136 | 815 | 0.43681 | 32209 | 0.389907 | 1 | 12 | 3309312 |
| rs7801689 | 0.0001397 | 1.3371 | 816 | 0.134191 | 32212 | 0.103874 | 4 | 7 | 36716066 |
| rs11182517 | 0.00014491 | 1.546 | 816 | 0.956495 | 32215 | 0.934301 | 2 | 12 | 43185479 |
| rs485310 | 0.00014567 | 1.2623 | 815 | 0.800613 | 32198 | 0.760824 | 3 | 11 | 60450391 |
| rs1434915 | 0.0001463 | 1.2266 | 816 | 0.696078 | 32214 | 0.651223 | 1 | 14 | 65688807 |
| rs6869332 | 0.00014697 | 1.2729 | 814 | 0.206388 | 32105 | 0.169646 | 1 | 5 | 60165118 |
| rs4381653 | 0.00014877 | 1.2183 | 816 | 0.381127 | 32184 | 0.335757 | 4 | 17 | 20805605 |
| rs4296418 | 0.00015207 | 1.2172 | 816 | 0.644608 | 32193 | 0.598406 | 3 | 2 | 228226510 |
| rs4971712 | 0.0001527 | 1.2396 | 814 | 0.281941 | 32152 | 0.24056 | 2 | 2 | 51045197 |
| rs10461566 | 0.00015767 | 1.3674 | 816 | 0.907475 | 32204 | 0.877639 | 4 | 5 | 53144967 |
| rs6752599 | 0.00015829 | 1.267 | 816 | 0.8125 | 32218 | 0.77376 | 2 | 2 | 109140121 |
| rs149971 | 0.00015885 | 1.2181 | 816 | 0.375613 | 32216 | 0.330597 | 1 | 6 | 28090131 |
| rs628632 | 0.00016056 | 1.2605 | 814 | 0.800369 | 32193 | 0.760802 | 2 | 11 | 60449795 |
| rs7971903 | 0.00016063 | 1.5081 | 816 | 0.95098 | 32198 | 0.927868 | 1 | 12 | 2015768 |
| rs9889988 | 0.00016503 | 1.208 | 816 | 0.501838 | 32208 | 0.454716 | 2 | 17 | 66522718 |
| rs2859867 | 0.00016514 | 1.2325 | 816 | 0.728554 | 32209 | 0.685305 | 3 | 1 | 245848401 |
| rs1836911 | 0.00017155 | 1.2077 | 815 | 0.493252 | 32164 | 0.446275 | 1 | 8 | 97712913 |
| rs750341 | 0.00017372 | 1.2075 | 815 | 0.493252 | 32216 | 0.446315 | 3 | 8 | 97712388 |
| rs2704255 | 0.00017546 | 1.2074 | 815 | 0.493252 | 32216 | 0.446347 | 3 | 8 | 97713959 |
| rs8046811 | 0.0001783 | 1.2622 | 814 | 0.218673 | 32199 | 0.181496 | 3 | 16 | 8385232 |
| rs3814211 | 0.0001824 | 1.5126 | 815 | 0.061963 | 32215 | 0.041844 | 3 | 10 | 85981764 |
| rs2716644 | 0.00018358 | 1.2933 | 816 | 0.16973 | 32215 | 0.136489 | 4 | 2 | 12035905 |
| rs9403288 | 0.00018423 | 1.2149 | 815 | 0.648466 | 32176 | 0.602918 | 4 | 6 | 141714594 |
| rs726976 | 0.00018438 | 1.2146 | 816 | 0.383578 | 32205 | 0.338767 | 4 | 14 | 21409967 |
| rs370603 | 0.00018779 | 1.2448 | 815 | 0.255215 | 32132 | 0.21586 | 3 | 16 | 8324476 |
| rs17645840 | 0.00018808 | 1.2396 | 816 | 0.758578 | 32215 | 0.717104 | 4 | 14 | 43020401 |
| rs1321991 | 0.00018933 | 1.6718 | 816 | 0.971201 | 32213 | 0.952768 | 1 | 1 | 183892594 |
| rs838705 | 0.0001902 | 1.2134 | 795 | 0.615094 | 32010 | 0.568416 | 1 | 2 | 233937981 |
| rs620879 | 0.00019033 | 1.284 | 813 | 0.842558 | 31922 | 0.806497 | 4 | 9 | 2530325 |
| rs11581576 | 0.00019358 | 1.2415 | 816 | 0.262255 | 32217 | 0.2226 | 2 | 1 | 48742578 |
| rs1370923 | 0.0001964 | 1.2515 | 813 | 0.237392 | 31973 | 0.199184 | 1 | 2 | 222708084 |
| rs2922991 | 0.00019767 | 1.3021 | 815 | 0.864417 | 32198 | 0.830409 | 1 | 5 | 3065553 |
| rs10493978 | 0.0001989 | 1.2254 | 816 | 0.316176 | 32212 | 0.273951 | 1 | 1 | 102351895 |

TABLE 2
Association results from Genome Wide SNP scan using Illumina Sentrix HumanHap300 and
HumanCNV370-duo Bead Chip for invasive CM (CMM). P values ≦2 × 10⁻⁴ for CMM are shown.

| | | | Case | Case | Control | Control | | | Pos in |
|---|---|---|---|---|---|---|---|---|---|
| SNP | p-value | OR | number | freq. | number | freq. | All | Chr | Build 36 |
| rs7619556 | 3.32E−06 | 1.3483 | 520 | 0.638462 | 32374 | 0.56706 | 1 | 3 | 191035065 |
| rs946067 | 0.00001477 | 1.4178 | 520 | 0.832692 | 32276 | 0.778287 | 2 | 14 | 55002303 |
| rs900543 | 0.00001872 | 2.366 | 522 | 0.981801 | 32500 | 0.957985 | 3 | 15 | 69884515 |
| rs13097806 | 0.00001946 | 1.4795 | 522 | 0.881226 | 32504 | 0.833744 | 2 | 3 | 181751055 |
| rs2035725 | 0.00002287 | 1.5837 | 521 | 0.921305 | 32483 | 0.880845 | 1 | 1 | 79184352 |
| rs10432671 | 0.00002558 | 1.3763 | 520 | 0.235577 | 32498 | 0.18295 | 1 | 2 | 50974385 |
| rs2224101 | 0.00002591 | 1.3073 | 521 | 0.425144 | 32280 | 0.361323 | 4 | 1 | 75816780 |
| rs11224294 | 0.00002732 | 1.7889 | 522 | 0.955939 | 32505 | 0.923827 | 4 | 11 | 99954372 |
| rs4151060 | 0.00002747 | 1.954 | 522 | 0.968391 | 32507 | 0.940044 | 3 | 10 | 103288089 |
| rs3781180 | 0.00002752 | 1.7983 | 522 | 0.956897 | 32508 | 0.925065 | 2 | 10 | 79412623 |
| rs17180090 | 0.00003037 | 1.5262 | 522 | 0.907088 | 32509 | 0.864807 | 2 | 14 | 64260666 |
| rs10186788 | 0.00003235 | 1.312 | 522 | 0.668582 | 32501 | 0.60592 | 3 | 2 | 62566799 |
| rs7799577 | 0.00003312 | 1.2997 | 510 | 0.52451 | 31784 | 0.459083 | 4 | 7 | 97461330 |
| rs4487603 | 0.00003532 | 1.2947 | 522 | 0.534483 | 32504 | 0.470004 | 4 | 6 | 129211602 |
| rs10518834 | 0.00003556 | 1.3276 | 522 | 0.726054 | 32506 | 0.666262 | 1 | 15 | 54132358 |
| rs4723563 | 0.00003706 | 1.3559 | 522 | 0.251916 | 32501 | 0.198948 | 2 | 7 | 36723988 |
| rs4443522 | 0.00003905 | 1.2928 | 522 | 0.533525 | 32508 | 0.469408 | 3 | 6 | 129211626 |
| rs4723562 | 0.00003975 | 1.3602 | 522 | 0.242337 | 32511 | 0.190382 | 1 | 7 | 36723652 |
| rs4702781 | 0.00004014 | 1.3347 | 522 | 0.749042 | 32490 | 0.690997 | 2 | 5 | 11055126 |
| rs1265256 | 0.0000408 | 1.3283 | 521 | 0.734165 | 32502 | 0.675235 | 1 | 6 | 4429854 |
| rs870470 | 0.00004564 | 1.3292 | 521 | 0.741843 | 32502 | 0.683743 | 2 | 18 | 55537580 |
| rs1946116 | 0.00004629 | 1.7911 | 519 | 0.958574 | 32445 | 0.928155 | 4 | 7 | 126180375 |
| rs10797094 | 0.0000467 | 1.2933 | 519 | 0.454721 | 32499 | 0.392027 | 3 | 1 | 159449296 |
| rs6670304 | 0.00004868 | 1.2914 | 520 | 0.464423 | 32406 | 0.401731 | 4 | 1 | 75795938 |
| rs1321991 | 0.00005133 | 2.1035 | 522 | 0.977011 | 32507 | 0.952841 | 1 | 1 | 183892594 |
| rs6549523 | 0.00005364 | 1.2873 | 522 | 0.550766 | 32498 | 0.487799 | 3 | 3 | 73416725 |
| rs4865879 | 0.00005402 | 1.2972 | 521 | 0.398273 | 32489 | 0.337853 | 2 | 5 | 54196102 |
| rs10105819 | 0.00006084 | 1.6275 | 522 | 0.082375 | 32462 | 0.052277 | 2 | 8 | 19272477 |
| rs8056021 | 0.00006538 | 1.2923 | 522 | 0.403257 | 32408 | 0.343372 | 1 | 16 | 83133103 |
| rs33429 | 0.00006798 | 1.2996 | 521 | 0.363724 | 32472 | 0.305494 | 2 | 19 | 35631200 |
| rs12829758 | 0.00006806 | 1.3431 | 521 | 0.24952 | 32471 | 0.198423 | 1 | 12 | 81581920 |
| rs7812812 | 0.00006887 | 2.1082 | 514 | 0.977626 | 32449 | 0.953974 | 3 | 8 | 116971648 |
| rs7417070 | 0.00007257 | 1.8479 | 519 | 0.965318 | 32446 | 0.937743 | 1 | 1 | 239936490 |
| rs229660 | 0.00007307 | 1.494 | 522 | 0.90613 | 32509 | 0.865976 | 1 | 14 | 64244339 |
| rs2037129 | 0.00008389 | 1.2986 | 522 | 0.690613 | 32492 | 0.632202 | 4 | 3 | 191031486 |
| rs9369677 | 0.00008964 | 1.6171 | 521 | 0.080614 | 32479 | 0.051433 | 2 | 6 | 47431213 |
| rs12575532 | 0.00009383 | 2.6227 | 522 | 0.988506 | 32506 | 0.970405 | 4 | 11 | 73033777 |
| rs9810322 | 0.00009547 | 1.2964 | 521 | 0.690979 | 32496 | 0.633001 | 2 | 3 | 191026668 |
| rs4242090 | 0.00009735 | 1.3375 | 518 | 0.246139 | 32499 | 0.196221 | 2 | 5 | 3418033 |
| rs11993275 | 0.00009863 | 1.4939 | 522 | 0.909962 | 32494 | 0.871222 | 1 | 8 | 118959325 |
| rs6112615 | 0.00010107 | 1.5976 | 522 | 0.083333 | 32495 | 0.053839 | 1 | 20 | 19777867 |
| rs4841366 | 0.00010281 | 1.337 | 522 | 0.792146 | 32504 | 0.740294 | 1 | 8 | 10426159 |
| rs10825299 | 0.00010699 | 1.3569 | 520 | 0.2125 | 32274 | 0.165877 | 1 | 10 | 55732323 |
| rs6471504 | 0.00010727 | 1.2829 | 522 | 0.399425 | 32503 | 0.341415 | 1 | 8 | 96060736 |
| rs12548703 | 0.00011029 | 1.4899 | 522 | 0.909962 | 32507 | 0.87152 | 3 | 8 | 118954823 |
| rs7099843 | 0.00011495 | 1.2774 | 522 | 0.429119 | 32502 | 0.370454 | 1 | 10 | 132604208 |
| rs10146962 | 0.00011626 | 1.2855 | 522 | 0.662835 | 32507 | 0.604639 | 4 | 14 | 100240293 |
| rs310441 | 0.00012009 | 1.6576 | 522 | 0.949234 | 32493 | 0.918567 | 1 | 19 | 60867327 |
| rs9585777 | 0.00012072 | 1.3448 | 522 | 0.809387 | 32484 | 0.759466 | 1 | 13 | 85863400 |
| rs1403956 | 0.00012788 | 1.2701 | 522 | 0.524904 | 32503 | 0.465203 | 2 | 1 | 85706226 |
| rs6134717 | 0.00012878 | 1.7073 | 521 | 0.955854 | 32475 | 0.926913 | 3 | 20 | 12838206 |
| rs6060043 | 0.00013045 | 1.3552 | 521 | 0.207294 | 32504 | 0.161749 | 2 | 20 | 32828245 |
| rs1527837 | 0.00013133 | 1.2888 | 522 | 0.349617 | 32489 | 0.29433 | 1 | 7 | 48598016 |
| rs2076211 | 0.00013514 | 1.3504 | 522 | 0.211686 | 32508 | 0.165867 | 1 | 22 | 42660411 |
| rs11182517 | 0.00013586 | 1.7616 | 522 | 0.961686 | 32509 | 0.934418 | 2 | 12 | 43185479 |
| rs1114769 | 0.00013615 | 1.2703 | 522 | 0.568008 | 32481 | 0.50862 | 1 | 2 | 105153390 |
| rs1369256 | 0.00013654 | 1.9551 | 522 | 0.974138 | 32497 | 0.950657 | 2 | 2 | 153702054 |
| rs10490982 | 0.00013677 | 1.3166 | 522 | 0.267241 | 32489 | 0.21692 | 2 | 10 | 55686137 |
| rs7692784 | 0.00014143 | 1.2778 | 521 | 0.641075 | 32478 | 0.582948 | 1 | 4 | 145349546 |
| rs2165894 | 0.00014609 | 1.3567 | 522 | 0.201149 | 32499 | 0.156543 | 3 | 17 | 19430388 |
| rs2300370 | 0.00015048 | 1.274 | 521 | 0.415547 | 32340 | 0.358194 | 1 | 21 | 33526427 |
| rs2236758 | 0.00015057 | 1.2739 | 522 | 0.413793 | 32506 | 0.35655 | 1 | 21 | 33547283 |
| rs11666579 | 0.00015107 | 1.2696 | 522 | 0.587165 | 32496 | 0.528357 | 4 | 19 | 17451281 |
| rs10093611 | 0.00015393 | 1.5328 | 520 | 0.926923 | 32217 | 0.892184 | 4 | 8 | 52493571 |
| rs4436099 | 0.00015488 | 1.4954 | 497 | 0.911469 | 32193 | 0.873171 | 4 | 8 | 107515857 |
| rs9585170 | 0.00016033 | 1.338 | 520 | 0.808654 | 32491 | 0.759533 | 3 | 13 | 85842380 |
| rs10829844 | 0.00016382 | 1.2904 | 520 | 0.327885 | 32479 | 0.274331 | 1 | 10 | 132611589 |
| rs12139487 | 0.00017175 | 1.3754 | 516 | 0.850775 | 32412 | 0.805643 | 4 | 1 | 11639887 |
| rs159667 | 0.00017188 | 1.266 | 522 | 0.572797 | 32506 | 0.514351 | 3 | 19 | 63340171 |
| rs1873465 | 0.00017277 | 1.4608 | 522 | 0.119732 | 32508 | 0.085179 | 2 | 10 | 77859965 |
| rs2252639 | 0.00017635 | 1.2704 | 522 | 0.415709 | 32509 | 0.358993 | 1 | 21 | 33539599 |
| rs12438895 | 0.00017762 | 2.1927 | 521 | 0.982726 | 32509 | 0.962887 | 3 | 15 | 94027130 |
| rs999988 | 0.00018113 | 1.3514 | 522 | 0.83046 | 32508 | 0.783761 | 3 | 9 | 37625299 |
| rs9357155 | 0.00018126 | 1.3975 | 522 | 0.15613 | 32461 | 0.11691 | 1 | 6 | 32917826 |
| rs1666559 | 0.00018262 | 1.2639 | 519 | 0.524085 | 32498 | 0.465598 | 2 | 3 | 105289309 |
| rs40297 | 0.00018606 | 1.277 | 521 | 0.370441 | 32497 | 0.315429 | 4 | 5 | 14596201 |
| rs11934681 | 0.00018827 | 1.3627 | 515 | 0.18932 | 32450 | 0.146302 | 3 | 4 | 180358838 |
| rs2891328 | 0.00019115 | 1.3288 | 522 | 0.802682 | 32465 | 0.753781 | 1 | 9 | 29416335 |
| rs648216 | 0.00019648 | 1.2839 | 521 | 0.335893 | 32345 | 0.282609 | 1 | 1 | 85687645 |
| rs11265558 | 0.0001982 | 1.2682 | 521 | 0.621881 | 32462 | 0.564629 | 1 | 1 | 159373805 |
| rs10492305 | 0.00019828 | 1.2921 | 522 | 0.728927 | 32387 | 0.675441 | 4 | 12 | 67115499 |
| rs6060034 | 0.00019877 | 1.3442 | 522 | 0.205939 | 32508 | 0.161729 | 4 | 20 | 32815525 |
| rs284662 | 0.00019937 | 1.2698 | 517 | 0.626692 | 32397 | 0.569343 | 3 | 19 | 46624115 |

TABLE 3
Association results from Genome Wide SNP scan using Illumine Sentrix HumanHap300 and
HumanCNV370-duo Bead Chip for Basal Cell Carcinoma (BCC).
P values ≦2 × 10⁻⁴ for CMM are shown.

| | | | Case | Case | Control | Control | | | Pos in |
|---|---|---|---|---|---|---|---|---|---|
| SNP | p-value | OR | number | freq. | number | freq. | All | Chr | Build 36 |
| rs801114 | 4.39E−09 | 1.3296 | 933 | 0.397642 | 32095 | 0.331765 | 3 | 1 | 227064458 |
| rs7538876 | 9.38E−08 | 1.2929 | 933 | 0.413183 | 32064 | 0.352576 | 1 | 1 | 17594950 |
| rs801109 | 1.40E−07 | 1.3079 | 933 | 0.325831 | 32094 | 0.269817 | 4 | 1 | 227055824 |
| rs738814 | 4.94E−07 | 1.2702 | 933 | 0.597535 | 32088 | 0.538924 | 1 | 22 | 23232606 |
| rs241337 | 6.44E−07 | 1.2783 | 932 | 0.368026 | 32099 | 0.312985 | 2 | 1 | 227016231 |
| rs991792 | 1.78E−06 | 1.5632 | 933 | 0.077706 | 32097 | 0.051142 | 3 | 9 | 21541647 |
| rs1008931 | 1.80E−06 | 1.2594 | 933 | 0.635048 | 32089 | 0.580121 | 4 | 22 | 23185541 |
| rs738813 | 1.96E−06 | 1.2586 | 932 | 0.635193 | 32077 | 0.580431 | 3 | 22 | 23192738 |
| rs2345968 | 2.43E−06 | 2.4482 | 930 | 0.98871 | 32026 | 0.972803 | 4 | 6 | 167491901 |
| rs11777052 | 2.67E−06 | 1.3603 | 922 | 0.16757 | 31837 | 0.128907 | 4 | 8 | 76114776 |
| rs2297470 | 2.79E−06 | 2.1751 | 933 | 0.984459 | 32065 | 0.966802 | 1 | 6 | 167499667 |
| rs9459893 | 2.94E−06 | 2.1716 | 933 | 0.984459 | 32100 | 0.966854 | 1 | 6 | 167486676 |
| rs5751838 | 4.84E−06 | 1.2401 | 932 | 0.543991 | 32089 | 0.490308 | 2 | 22 | 23011579 |
| rs71074 | 5.20E−06 | 1.2507 | 933 | 0.372454 | 32077 | 0.321819 | 2 | 1 | 227070362 |
| rs241301 | 6.29E−06 | 1.2377 | 933 | 0.469453 | 32096 | 0.41689 | 3 | 1 | 227029050 |
| rs3788372 | 6.30E−06 | 1.2415 | 933 | 0.614684 | 32078 | 0.562364 | 1 | 22 | 23224856 |
| rs242975 | 8.68E−06 | 1.3063 | 933 | 0.202572 | 32085 | 0.162802 | 2 | 10 | 119254582 |
| rs7955747 | 1.14E−05 | 1.2398 | 933 | 0.37567 | 32097 | 0.326744 | 4 | 12 | 120409487 |
| rs5935829 | 1.3E−05 | 1.2279 | 933 | 0.551983 | 32034 | 0.500843 | 2 | X | 14878948 |
| rs2104880 | 1.38E−05 | 1.4823 | 933 | 0.081994 | 32094 | 0.056833 | 4 | 9 | 21409723 |
| rs3093003 | 1.47E−05 | 2.609 | 933 | 0.991961 | 32094 | 0.979295 | 3 | 6 | 167473464 |
| rs998626 | 1.92E−05 | 1.5415 | 933 | 0.06538 | 32100 | 0.043411 | 1 | 18 | 31511118 |
| rs10498611 | 1.93E−05 | 1.2942 | 931 | 0.826531 | 32022 | 0.786397 | 4 | 14 | 86598814 |
| rs6519519 | 1.95E−05 | 1.2441 | 931 | 0.319549 | 32004 | 0.274028 | 4 | 22 | 23321863 |
| rs3737384 | 1.95E−05 | 1.5409 | 933 | 0.06538 | 32088 | 0.043427 | 3 | 18 | 31526394 |
| rs7240151 | 1.95E−05 | 1.5408 | 933 | 0.06538 | 32098 | 0.043429 | 3 | 18 | 31476543 |
| rs867958 | 1.95E−05 | 1.3844 | 930 | 0.117742 | 32010 | 0.087926 | 4 | 16 | 84622014 |
| rs10504624 | 1.97E−05 | 1.6139 | 933 | 0.960879 | 32089 | 0.938343 | 1 | 8 | 77612552 |
| rs580539 | 2.13E−05 | 1.223 | 933 | 0.453912 | 32098 | 0.404636 | 1 | 4 | 56834998 |
| rs4455343 | 2.22E−05 | 1.2205 | 933 | 0.525188 | 32083 | 0.475408 | 3 | 3 | 172507216 |
| rs17518769 | 2.42E−05 | 1.6108 | 933 | 0.961415 | 32098 | 0.93928 | 3 | 1 | 167718714 |
| rs209994 | 2.54E−05 | 1.2365 | 929 | 0.694295 | 32064 | 0.647486 | 1 | X | 129055134 |
| rs7188879 | 3.03E−05 | 1.9409 | 933 | 0.982315 | 32077 | 0.966237 | 4 | 16 | 78364890 |
| rs10871717 | 3.14E−05 | 1.2392 | 933 | 0.720257 | 32096 | 0.675084 | 2 | 18 | 69242535 |
| rs261796 | 3.24E−05 | 1.3246 | 930 | 0.152688 | 32013 | 0.119748 | 2 | 1 | 239176803 |
| rs4493370 | 3.35E−05 | 1.4047 | 933 | 0.100214 | 32071 | 0.073462 | 3 | 3 | 195727220 |
| rs6573206 | 3.53E−05 | 1.2679 | 933 | 0.800643 | 32085 | 0.760044 | 4 | 14 | 58131807 |
| rs36570 | 3.58E−05 | 1.2205 | 932 | 0.627682 | 32085 | 0.580053 | 1 | 14 | 70396968 |
| rs916816 | 3.83E−05 | 1.2191 | 898 | 0.468263 | 31243 | 0.419406 | 3 | 17 | 52547487 |
| rs11676494 | 4.03E−05 | 1.3542 | 932 | 0.895923 | 32042 | 0.864069 | 1 | 2 | 127326300 |
| rs4790911 | 0.000048 | 1.3619 | 933 | 0.117363 | 32092 | 0.088947 | 1 | 17 | 61841377 |
| rs1549349 | 5.35E−05 | 1.248 | 933 | 0.256163 | 32092 | 0.216269 | 1 | 12 | 120435038 |
| rs11020015 | 5.48E−05 | 1.2088 | 933 | 0.497856 | 32087 | 0.450603 | 1 | 11 | 91955514 |
| rs13147065 | 5.55E−05 | 1.3541 | 933 | 0.900322 | 32096 | 0.869625 | 1 | 4 | 128888256 |
| rs4717626 | 5.89E−05 | 1.2132 | 932 | 0.622318 | 32092 | 0.575938 | 4 | 7 | 71171836 |
| rs4806878 | 5.96E−05 | 1.2162 | 933 | 0.649518 | 32069 | 0.603761 | 3 | 19 | 2797782 |
| rs8005231 | 6.15E−05 | 1.2503 | 931 | 0.781955 | 32093 | 0.741486 | 4 | 14 | 58071025 |
| rs2159561 | 6.27E−05 | 1.3147 | 932 | 0.873927 | 32090 | 0.840573 | 3 | 19 | 2778300 |
| rs31489 | 6.36E−05 | 1.2121 | 933 | 0.623258 | 32087 | 0.577134 | 2 | 5 | 1395714 |
| rs867169 | 6.45E−05 | 1.3154 | 933 | 0.875134 | 32100 | 0.841978 | 2 | 19 | 2784864 |
| rs867168 | 6.55E−05 | 1.315 | 933 | 0.875134 | 32094 | 0.842011 | 4 | 19 | 2784802 |
| rs13022344 | 6.82E−05 | 1.2115 | 933 | 0.405145 | 32096 | 0.359874 | 2 | 2 | 201972401 |
| rs4855305 | 7.13E−05 | 1.2064 | 923 | 0.52546 | 31489 | 0.47858 | 2 | 3 | 69430232 |
| rs960678 | 7.13E−05 | 1.3422 | 933 | 0.89657 | 32093 | 0.865921 | 1 | 4 | 143455608 |
| rs12679591 | 7.87E−05 | 1.3898 | 932 | 0.921674 | 32021 | 0.894366 | 4 | 8 | 10421620 |
| rs9956188 | 8.3E−05 | 1.2318 | 929 | 0.743272 | 32049 | 0.70152 | 3 | 18 | 69245992 |
| rs4823778 | 8.31E−05 | 1.2776 | 931 | 0.83942 | 32084 | 0.803594 | 4 | 22 | 47224290 |
| rs8094859 | 8.38E−05 | 1.2033 | 932 | 0.492489 | 32086 | 0.446425 | 4 | 18 | 20991332 |
| rs1791554 | 8.55E−05 | 1.2027 | 933 | 0.503751 | 32093 | 0.457701 | 4 | 11 | 91941298 |
| rs7311196 | 8.63E−05 | 1.3204 | 933 | 0.136656 | 32099 | 0.107044 | 1 | 12 | 50005946 |
| rs2082733 | 9.25E−05 | 1.2327 | 933 | 0.752947 | 32098 | 0.712023 | 3 | 22 | 23075498 |
| rs10947859 | 9.51E−05 | 1.2118 | 932 | 0.366953 | 32076 | 0.323575 | 4 | 6 | 40238063 |
| rs1341715 | 9.67E−05 | 1.2072 | 932 | 0.400751 | 32093 | 0.356495 | 3 | 1 | 227085539 |
| rs6727797 | 9.94E−05 | 1.246 | 933 | 0.235263 | 32097 | 0.198009 | 2 | 2 | 65879935 |
| rs8137007 | 0.000102 | 1.2741 | 933 | 0.8403 | 32074 | 0.80506 | 3 | 22 | 47227761 |
| rs1645761 | 0.000102 | 1.3408 | 933 | 0.900857 | 32096 | 0.871417 | 1 | 5 | 52332999 |
| rs2240260 | 0.000103 | 1.771 | 932 | 0.978541 | 32045 | 0.962615 | 4 | 17 | 53756583 |
| rs2603148 | 0.000104 | 1.2003 | 933 | 0.540729 | 32089 | 0.49517 | 4 | 2 | 3750213 |
| rs378437 | 0.000105 | 1.2302 | 933 | 0.275991 | 32092 | 0.23657 | 1 | 1 | 55782058 |
| rs2914441 | 0.000106 | 1.2088 | 933 | 0.37567 | 32088 | 0.332352 | 1 | 19 | 52912535 |
| rs9869419 | 0.000108 | 1.4182 | 933 | 0.081458 | 32098 | 0.058851 | 3 | 3 | 82196582 |
| rs11127758 | 0.000109 | 1.4179 | 933 | 0.081458 | 32100 | 0.058863 | 2 | 3 | 82127494 |
| rs7206751 | 0.000111 | 1.3511 | 929 | 0.907427 | 32025 | 0.87886 | 4 | 16 | 531587 |
| rs9883163 | 0.000114 | 1.4264 | 933 | 0.078242 | 32091 | 0.056168 | 4 | 3 | 82176342 |
| rs4408410 | 0.000116 | 1.2028 | 932 | 0.418455 | 32064 | 0.374314 | 1 | 13 | 109299546 |
| rs1442927 | 0.000119 | 1.4864 | 933 | 0.951768 | 31986 | 0.929954 | 4 | 11 | 27197527 |
| rs11127757 | 0.00012 | 1.4246 | 933 | 0.078242 | 32099 | 0.056232 | 3 | 3 | 82125752 |
| rs8099615 | 0.000121 | 1.1983 | 930 | 0.512903 | 32004 | 0.467723 | 3 | 18 | 20942454 |
| rs3828051 | 0.000121 | 1.2099 | 932 | 0.673283 | 32098 | 0.63007 | 4 | 1 | 30970386 |
| rs4975616 | 0.000127 | 1.2023 | 933 | 0.620579 | 32090 | 0.576348 | 1 | 5 | 1368660 |
| rs12454733 | 0.000128 | 1.1979 | 931 | 0.551557 | 32074 | 0.506594 | 4 | 18 | 66259208 |
| rs9457507 | 0.000128 | 1.246 | 933 | 0.800107 | 32098 | 0.762602 | 4 | 6 | 159236418 |
| rs7312857 | 0.000129 | 1.3049 | 933 | 0.142015 | 32097 | 0.112565 | 4 | 12 | 49993893 |
| rs6628850 | 0.000132 | 1.2492 | 930 | 0.806452 | 31931 | 0.769346 | 4 | X | 34408426 |
| rs4328452 | 0.000132 | 1.4049 | 933 | 0.932476 | 32071 | 0.907658 | 2 | 16 | 76964072 |
| rs6991180 | 0.000135 | 2.0213 | 933 | 0.987138 | 32093 | 0.97434 | 4 | 8 | 67492686 |
| rs4524008 | 0.00014 | 1.1975 | 930 | 0.462366 | 32073 | 0.417984 | 4 | 18 | 20935704 |
| rs10878450 | 0.000144 | 1.3487 | 931 | 0.909774 | 32071 | 0.882027 | 2 | 12 | 65231390 |
| rs4745464 | 0.000146 | 1.1954 | 933 | 0.524116 | 32091 | 0.479527 | 3 | 9 | 77701839 |
| rs6872579 | 0.000146 | 1.2527 | 933 | 0.20686 | 32088 | 0.172323 | 3 | 5 | 139756023 |
| rs6770142 | 0.000148 | 1.2065 | 933 | 0.357985 | 32095 | 0.316077 | 1 | 3 | 185706148 |
| rs1403478 | 0.000155 | 1.257 | 932 | 0.82618 | 32094 | 0.790849 | 3 | 3 | 183948426 |
| rs247052 | 0.000157 | 1.2193 | 933 | 0.735798 | 32101 | 0.695508 | 3 | 16 | 56524719 |
| rs4888984 | 0.000158 | 1.2808 | 932 | 0.858906 | 32098 | 0.826173 | 4 | 16 | 78066835 |
| rs9963024 | 0.000158 | 1.2072 | 933 | 0.347267 | 32096 | 0.305895 | 2 | 18 | 66244572 |
| rs10212532 | 0.000159 | 1.2067 | 933 | 0.678457 | 32090 | 0.636179 | 3 | 3 | 137154224 |
| rs2244438 | 0.00016 | 1.2007 | 933 | 0.392283 | 32092 | 0.349635 | 1 | 2 | 201960784 |
| rs500813 | 0.000161 | 1.1979 | 931 | 0.423201 | 32056 | 0.379851 | 1 | 13 | 32846936 |
| rs157935 | 0.000164 | 1.214 | 931 | 0.716434 | 32075 | 0.675448 | 4 | 7 | 130236093 |
| rs1053817 | 0.000166 | 1.3696 | 931 | 0.095596 | 32087 | 0.071649 | 1 | 19 | 60781031 |
| rs1261256 | 0.000167 | 1.1938 | 933 | 0.485531 | 32095 | 0.441502 | 3 | 5 | 22490853 |
| rs12119724 | 0.000167 | 1.2232 | 931 | 0.75188 | 32084 | 0.712427 | 2 | 1 | 112270337 |
| rs401681 | 0.000168 | 1.1959 | 933 | 0.590568 | 32092 | 0.546725 | 2 | 5 | 1375087 |
| rs10497867 | 0.000174 | 1.1942 | 933 | 0.458199 | 32097 | 0.414571 | 4 | 2 | 201993112 |
| rs11844675 | 0.000176 | 1.5997 | 933 | 0.968917 | 32030 | 0.951186 | 3 | 14 | 36213752 |
| rs980159 | 0.000179 | 1.3282 | 933 | 0.117363 | 32087 | 0.091003 | 4 | 11 | 6949653 |
| rs2575414 | 0.000183 | 1.201 | 931 | 0.375403 | 32014 | 0.333526 | 2 | 15 | 94057624 |
| rs3094441 | 0.000184 | 1.2781 | 933 | 0.161844 | 32096 | 0.131247 | 4 | 17 | 52555329 |
| rs10735934 | 0.000185 | 1.1922 | 933 | 0.53269 | 32084 | 0.488795 | 1 | 12 | 39019167 |
| rs242965 | 0.000189 | 1.2039 | 933 | 0.351018 | 32081 | 0.309997 | 3 | 10 | 119240201 |
| rs4760169 | 0.000191 | 1.2542 | 933 | 0.19507 | 32078 | 0.161933 | 2 | 12 | 56405114 |
| rs9677255 | 0.000192 | 1.198 | 932 | 0.635193 | 32086 | 0.592408 | 3 | 2 | 162652596 |
| rs3733697 | 0.000192 | 1.2597 | 932 | 0.186159 | 32099 | 0.153681 | 1 | 5 | 140482528 |
| rs11715034 | 0.000195 | 1.197 | 933 | 0.629153 | 32086 | 0.586315 | 4 | 3 | 51384640 |
| rs6855687 | 0.000198 | 1.2157 | 932 | 0.735515 | 32044 | 0.695824 | 3 | 4 | 189649974 |
| rs1384731 | 0.000198 | 1.2703 | 931 | 0.170247 | 32047 | 0.139061 | 4 | 5 | 10660797 |
| rs2567446 | 0.0002 | 1.193 | 930 | 0.449462 | 31970 | 0.406287 | 4 | 15 | 94064986 |
| rs3733698 | 0.000201 | 1.2587 | 933 | 0.185959 | 32095 | 0.153606 | 1 | 5 | 140482527 |

TABLE 4
Association results from Genome Wide SNP scan using Illumina Sentrix HumanHap300 and
HumanCNV370-duo Bead Chip for Squamous Cell Carcinoma (SCC).
P values ≦2 × 10⁻⁴ for SCC are shown.

| | | | Case | Case | Control | Control | | | Pos in |
|---|---|---|---|---|---|---|---|---|---|
| SNP | p-value | OR | number | freq. | number | freq. | All | Chr | Build 36 |
| rs3131755 | 1.02E−05 | 1.44 | 338 | 0.688 | 36,520 | 0.604 | 3 | 1 | 57,916,798 |
| rs13301218 | 1.93E−05 | 1.47 | 338 | 0.283 | 36,729 | 0.211 | 3 | 9 | 19,660,630 |
| rs198222 | 2.21E−05 | 1.42 | 338 | 0.66 | 36,735 | 0.578 | 2 | 14 | 56,306,814 |
| rs12540995 | 3.22E−05 | 1.46 | 335 | 0.279 | 36,425 | 0.21 | 4 | 8 | 29,253,448 |
| rs258634 | 3.40E−05 | 1.39 | 337 | 0.469 | 36,585 | 0.388 | 2 | 5 | 11,338,548 |
| rs7308811 | 3.98E−05 | 1.53 | 339 | 0.201 | 36,701 | 0.141 | 1 | 12 | 8,911,756 |
| rs7779378 | 4.01E−05 | 1.44 | 338 | 0.297 | 36,636 | 0.227 | 1 | 7 | 22,375,908 |
| rs2828035 | 4.26E−05 | 1.39 | 338 | 0.422 | 36,595 | 0.344 | 1 | 21 | 23,599,931 |
| rs10822288 | 4.72E−05 | 1.39 | 338 | 0.614 | 36,701 | 0.534 | 2 | 10 | 52,569,271 |
| rs2200537 | 5.78E−05 | 1.42 | 339 | 0.31 | 36,751 | 0.24 | 4 | 16 | 53,769,135 |
| rs6744347 | 6.17E−05 | 1.47 | 339 | 0.804 | 36,716 | 0.737 | 1 | 2 | 239,585,571 |
| rs7097894 | 6.63E−05 | 1.39 | 338 | 0.67 | 36,749 | 0.594 | 3 | 10 | 52,387,891 |
| rs10496196 | 6.83E−05 | 1.5 | 339 | 0.201 | 36,752 | 0.143 | 1 | 2 | 74,974,033 |
| rs7028514 | 7.52E−05 | 1.39 | 337 | 0.383 | 36,666 | 0.309 | 2 | 9 | 19,692,068 |
| rs857680 | 7.67E−05 | 1.37 | 339 | 0.497 | 36,632 | 0.42 | 1 | 1 | 156,902,476 |
| rs6727113 | 8.15E−05 | 1.49 | 336 | 0.832 | 36,720 | 0.769 | 1 | 2 | 105,527,331 |
| rs5927579 | 8.32E−05 | 1.43 | 268 | 0.409 | 28,872 | 0.326 | 1 | X | 30,571,096 |
| rs934755 | 8.42E−05 | 2.01 | 337 | 0.958 | 36,669 | 0.92 | 1 | 2 | 118,986,661 |
| rs12478989 | 8.60E−05 | 1.46 | 337 | 0.807 | 36,725 | 0.741 | 2 | 2 | 105,554,591 |
| rs391070 | 8.92E−05 | 1.41 | 337 | 0.743 | 36,541 | 0.672 | 2 | 2 | 21,378,334 |
| rs9943826 | 9.48E−05 | 1.55 | 338 | 0.874 | 36,719 | 0.818 | 3 | 12 | 83,469,170 |
| rs819005 | 9.51E−05 | 1.39 | 333 | 0.686 | 36,230 | 0.612 | 2 | 7 | 16,805,668 |
| rs1972974 | 9.56E−05 | 1.4 | 339 | 0.724 | 36,744 | 0.652 | 2 | 2 | 38,346,091 |

TABLE 5
Association results for key SNP markers rs 7538876 and rs 801114 showing that the 1p36 and 1q42 SNPs confer susceptibility to
BCC.

| | | | | | Number | | Frequency | | | |
|---|---|---|---|---|---|---|---|---|---|---|
| SNP | Allele | Chrom | pos B36 | Sample Set | Cases | Controls | Cases | Controls | OR (95% CI) | P-value |
| rs | A | 1p36 | 17,594,950 | Iceland BCC GWA | 930 | 33078 | 0.409 | 0.352 | 1.27 (1.15, 1.41) | 1.90E−06 |
| 7538876 | | | | Iceland BCC2 | 699 | 2328 | 0.410 | 0.361 | 1.23 (1.08, 1.40) | 1.60E−03 |
| | | | | Iceland BCC | 1629 | 35406 | 0.409 | 0.353 | 1.27 (1.18, 1.37) | 5.10E−10 |
| | | | | Combined | | | | | | |
| | | | | Eastern Europe BCC | 508 | 515 | 0.436 | 0.368 | 1.33 (1.11, 1.59) | 2.10E−03 |
| | | | | BCC Combined | 2137 | 35921 | | | 1.28 (1.19, 1.37) | 4.40E−12 |
| | | | | Iceland SCC | 412 | 33191 | 0.348 | 0.353 | 0.98 (0.85, 1.14) | 7.88E−01 |
| | | | | CM Combined¹ | 2075 | 40018 | | | 0.95 (0.88, 1.01) | 1.20E−01 |
| rs 801114 | G | 1q42 | 227,064,458 | Iceland BCC GWA | 930 | 33117 | 0.396 | 0.332 | 1.32 (1.20, 1.46) | 5.00E−08 |
| | | | | Iceland BCC2 | 703 | 2329 | 0.381 | 0.333 | 1.23 (1.08, 1.41) | 1.70E−03 |
| | | | | Iceland BCC | 1633 | 35446 | 0.390 | 0.332 | 1.29 (1.19, 1.39) | 1.20E−10 |
| | | | | Combined | | | | | | |
| | | | | Eastern Europe BCC | 512 | 515 | 0.416 | 0.362 | 1.25 (1.04, 1.50) | 1.50E−02 |
| | | | | BCC Combined | 2145 | 35961 | | | 1.28 (1.19, 1.37) | 5.90E−12 |
| | | | | Iceland SCC | 411 | 33225 | 0.342 | 0.332 | 1.05 (0.38, 2.67) | 5.44E−01 |
| | | | | CM Combined¹ | 2081 | 40080 | | | 1.02 (0.95, 1.10) | 5.80E−01 |

BCC, basal cell carcinoma of the skin
SCC, squamous cell carcinoma of the skin
CM, cutaneous melanoma (malignant or in-situ)
¹Cohorts from Iceland (565 cases, 32061 controls), Sweden (1062 cases, 538 controls) and Spain (277 cases, 1292 controls)

TABLE 6
Polymorphic SNP markers within the 1p36 LD block on chromosome 1 that are correlated
with rs7538876 by an r² value of 0.2 or higher.

| | | | | Position in | Pos in Seq ID |
|---|---|---|---|---|---|
| Marker | D′ | r² | p-value | Build 36 | No 1 |
| rs1635566 | 0.541972 | 0.210585 | 5.56E−06 | 17555744 | 301 |
| rs1635564 | 0.541972 | 0.210585 | 5.56E−06 | 17556113 | 670 |
| rs1204892 | 1 | 0.20817 | 4.73E−09 | 17566298 | 10855 |
| rs1204890 | 1 | 0.20817 | 4.73E−09 | 17567288 | 11845 |
| rs1204876 | 1 | 0.200401 | 1.45E−08 | 17570896 | 15453 |
| rs1204871 | 1 | 0.20817 | 4.73E−09 | 17571821 | 16378 |
| rs1204869 | 1 | 0.201521 | 1.38E−08 | 17572050 | 16607 |
| rs1204898 | 1 | 0.275532 | 2.41E−11 | 17580326 | 24883 |
| rs2181867 | 1 | 0.21217 | 3.71E−09 | 17580682 | 25239 |
| rs1535876 | 1 | 0.425947 | 2.91E−16 | 17585236 | 29793 |
| rs1535875 | 1 | 1 | 3.26E−33 | 17585289 | 29846 |
| rs2762893 | 1 | 0.214011 | 4.34E−09 | 17587225 | 31782 |
| rs2762894 | 1 | 0.20817 | 4.73E−09 | 17587297 | 31854 |
| rs2526842 | 1 | 0.20817 | 4.73E−09 | 17587668 | 32225 |
| rs1544068 | 1 | 0.207266 | 6.23E−09 | 17588276 | 32833 |
| rs1544067 | 1 | 0.207266 | 6.23E−09 | 17588375 | 32932 |
| rs2762895 | 1 | 0.20817 | 4.73E−09 | 17588435 | 32992 |
| rs2762896 | 1 | 0.20817 | 4.73E−09 | 17588981 | 33538 |
| rs12124893 | 1 | 0.653837 | 7.81E−23 | 17589749 | 34306 |
| rs2526839 | 1 | 0.21472 | 4.59E−09 | 17589899 | 34456 |
| rs2489606 | 1 | 0.20817 | 4.73E−09 | 17590221 | 34778 |
| rs12127405 | 1 | 0.965077 | 3.71E−34 | 17590711 | 35268 |
| rs2526836 | 1 | 0.20817 | 6.02E−09 | 17590955 | 35512 |
| rs2800691 | 1 | 0.20817 | 4.73E−09 | 17591592 | 36149 |
| rs7529038 | 1 | 0.420066 | 5.26E−16 | 17591727 | 36284 |
| rs7545226 | 1 | 0.425947 | 2.91E−16 | 17591771 | 36328 |
| rs7545237 | 1 | 0.425947 | 2.91E−16 | 17591806 | 36363 |
| rs6695097 | 1 | 0.420066 | 2.97E−15 | 17592250 | 36807 |
| rs6695214 | 1 | 0.425947 | 2.91E−16 | 17592430 | 36987 |
| rs6678027 | 1 | 0.437673 | 5.55E−15 | 17592519 | 37076 |
| rs6678121 | 1 | 0.425947 | 2.91E−16 | 17592573 | 37130 |
| rs6678127 | 1 | 0.44645 | 5.51E−16 | 17592584 | 37141 |
| rs6695531 | 1 | 0.93185 | 2.30E−30 | 17592675 | 37232 |
| rs6678552 | 1 | 1 | 1.05E−37 | 17592978 | 37535 |
| rs6695849 | 1 | 0.388753 | 1.64E−14 | 17593026 | 37583 |
| rs10458537 | 1 | 0.420066 | 5.26E−16 | 17593202 | 37759 |
| rs4920602 | 1 | 0.425947 | 2.91E−16 | 17593681 | 38238 |
| rs6691485 | 1 | 0.425947 | 2.91E−16 | 17593975 | 38532 |
| rs7538876 | 1 | 1 | | 17594950 | 39507 |
| rs2526833 | 1 | 0.441752 | 9.03E−17 | 17595713 | 40270 |
| rs7545115 | 1 | 1 | 1.05E−37 | 17596918 | 41475 |
| rs4920603 | 1 | 1 | 1.05E−37 | 17599966 | 44523 |
| rs2526830 | 1 | 0.427291 | 4.37E−16 | 17600706 | 45263 |
| rs2762890 | 1 | 0.425947 | 2.91E−16 | 17609165 | 53722 |
| rs942458 | 1 | 0.425947 | 2.91E−16 | 17611900 | 56457 |
| rs942457 | 1 | 0.961304 | 2.29E−32 | 17612173 | 56730 |
| rs1075535 | 1 | 0.398141 | 4.46E−14 | 17612407 | 56964 |
| rs6586538 | 0.945459 | 0.394879 | 7.99E−13 | 17616200 | 60757 |
| rs6678862 | 0.945459 | 0.394879 | 7.99E−13 | 17617439 | 61996 |
| rs1535874 | 0.945459 | 0.394879 | 7.99E−13 | 17620614 | 65171 |
| rs730153 | 1 | 0.871251 | 1.91E−30 | 17622091 | 66648 |
| rs2762891 | 0.944925 | 0.389037 | 1.41E−12 | 17623139 | 67696 |
| rs1324367 | 1 | 0.872442 | 5.64E−31 | 17625038 | 69595 |
| rs6688886 | 1 | 0.872442 | 5.64E−31 | 17626226 | 70783 |
| rs11577822 | 1 | 0.87013 | 1.29E−30 | 17627195 | 71752 |
| rs1408420 | 1 | 0.902965 | 2.73E−32 | 17627402 | 71959 |
| rs2489611 | 0.944925 | 0.389037 | 1.41E−12 | 17631832 | 76389 |
| rs2800686 | 0.945459 | 0.394879 | 7.99E−13 | 17635899 | 80456 |
| rs2800687 | 0.945459 | 0.394879 | 7.99E−13 | 17636104 | 80661 |
| rs6586542 | 1 | 0.902965 | 2.73E−32 | 17636153 | 80710 |
| rs2526822 | 0.789962 | 0.457986 | 2.67E−13 | 17651158 | 95715 |
| rs2996655 | 0.782107 | 0.416377 | 3.89E−12 | 17653851 | 98408 |
| rs2428740 | 0.906246 | 0.499886 | 8.58E−15 | 17658323 | 102880 |
| rs12078935 | 0.689259 | 0.386668 | 3.57E−11 | 17664469 | 109026 |
| rs12077703 | 0.780555 | 0.414726 | 7.61E−12 | 17664528 | 109085 |
| rs12035179 | 0.690912 | 0.407752 | 2.97E−10 | 17665701 | 110258 |
| rs4284283 | 0.716766 | 0.405271 | 4.03E−11 | 17669298 | 113855 |
| rs11203404 | 0.650734 | 0.358613 | 9.18E−10 | 17680029 | 124586 |
| rs11203405 | 0.655118 | 0.361698 | 6.33E−10 | 17680124 | 124681 |
| rs6674891 | 0.689057 | 0.386442 | 7.23E−11 | 17682433 | 126990 |
| rs4387213 | 0.685057 | 0.383624 | 1.05E−10 | 17688020 | 132577 |
| rs7534298 | 0.585797 | 0.281882 | 2.92E−07 | 17691166 | 135723 |
| rs12569045 | 0.593407 | 0.286602 | 2.38E−07 | 17692808 | 137365 |
| rs 6691937 | 0.593407 | 0.286602 | 2.38E−07 | 17693206 | 137763 |

The SNP surrogate markers were selected using the Caucasian HapMap CEU dataset (see http://www.hapmap.org).
Shown are marker names correlated to the key marker, and values of D′, r² and P-value for the correlation between the correlated marker and the anchor marker, position of the surrogate marker in NCBI Build 36, and position of that marker in Sequence ID No 1 of the sequence listing.

TABLE 7
Polymorphic SNP markers within the 1q42 LD block on chromosome 1 that are correlated
with rs801114 by an r² value of 0.2 or higher.

| | | | | Position in | Pos in Seq ID |
|---|---|---|---|---|---|
| Marker | D′ | r² | p-value | Build 36 | No 2 |
| rs10799489 | 0.508695 | 0.234383 | 1.80E−06 | 227006493 | 301 |
| rs2748081 | 0.612906 | 0.348997 | 1.53E−09 | 227009706 | 3514 |
| rs2748084 | 0.94479 | 0.578629 | 2.03E−15 | 227010367 | 4175 |
| rs17353018 | 0.950684 | 0.603778 | 7.90E−18 | 227010426 | 4234 |
| rs241327 | 0.914293 | 0.583544 | 7.45E−18 | 227011797 | 5605 |
| rs761667 | 0.910048 | 0.580135 | 3.67E−17 | 227012628 | 6436 |
| rs241328 | 0.911201 | 0.584257 | 1.45E−17 | 227012858 | 6666 |
| rs241329 | 0.909353 | 0.576088 | 1.09E−16 | 227013143 | 6951 |
| rs241333 | 0.914293 | 0.583544 | 7.45E−18 | 227014334 | 8142 |
| rs241337 | 0.95226 | 0.632663 | 9.53E−19 | 227016231 | 10039 |
| rs241342 | 0.95793 | 0.663609 | 9.50E−21 | 227021749 | 15557 |
| rs241301 | 0.873975 | 0.573573 | 3.86E−17 | 227029050 | 22858 |
| rs2639760 | 0.875272 | 0.572771 | 3.85E−17 | 227033244 | 27052 |
| rs2639759 | 0.841571 | 0.588079 | 3.06E−17 | 227034280 | 28088 |
| rs2639743 | 0.957239 | 0.640121 | 4.58E−20 | 227038905 | 32713 |
| rs2639767 | 1 | 0.231824 | 2.75E−08 | 227047269 | 41077 |
| rs801109 | 1 | 0.639344 | 1.27E−20 | 227055824 | 49632 |
| rs714349 | 1 | 0.927439 | 4.11E−31 | 227061842 | 55650 |
| rs801114 | 1 | 1 | | 227064458 | 58266 |
| rs10799492 | 1 | 0.961065 | 6.42E−32 | 227064762 | 58570 |
| rs71074 | 0.607602 | 0.302928 | 2.48E−08 | 227070362 | 64170 |
| rs16849105 | 0.632649 | 0.302883 | 1.70E−08 | 227072253 | 66061 |
| rs1341715 | 0.867728 | 0.50995 | 4.74E−15 | 227085539 | 79347 |
| rs10799493 | 0.865982 | 0.509821 | 9.40E−15 | 227090860 | 84668 |
| rs6426523 | 0.866764 | 0.510737 | 4.73E−15 | 227091121 | 84929 |
| rs12076818 | 0.822558 | 0.494468 | 8.26E−14 | 227092217 | 86025 |
| rs6426525 | 0.782255 | 0.463569 | 1.20E−12 | 227094061 | 87869 |
| rs11804896 | 0.823555 | 0.495652 | 4.18E−14 | 227096704 | 90512 |
| rs986056 | 0.824926 | 0.478883 | 6.83E−14 | 227098365 | 92173 |
| rs1891201 | 0.867728 | 0.50995 | 4.74E−15 | 227100745 | 94553 |
| rs7525743 | 0.578175 | 0.260082 | 1.32E−06 | 227104426 | 98234 |
| rs2236591 | 0.569818 | 0.282331 | 7.34E−08 | 227106093 | 99901 |
| rs6669628 | 0.575338 | 0.295277 | 7.59E−08 | 227106499 | 100307 |
| rs6663006 | 0.552448 | 0.281384 | 9.51E−08 | 227107212 | 101020 |
| rs12078733 | 0.542226 | 0.260802 | 2.16E−07 | 227108497 | 102305 |

The SNP surrogate markers were selected using the Caucasian HapMap CEU dataset (see http://www.hapmap.org).
Shown are marker names correlated to the key marker, and values of D′, r² and P-value for the correlation between the correlated marker and the anchor marker, position of the surrogate marker in NCBI Build 36, and position of that marker in Sequence ID No 2 of the sequence listing.

TABLE 8
Association of 1p36 and 1q42 SNPs with eye color, hair color, propensity to freckle and skin sensitivity to sun.

| | | | | | | Pheno 1 | Pheno 1 | Pheno 2 | Pheno 2 |
|---|---|---|---|---|---|---|---|---|---|
| SNP | Allele | Locus | Phenotype comparison | p-value | OR | Number | Freq | Number | Freq |
| rs7538876 | A | 1p36 | Blue versus brown eyes | 0.345 | 1.077 | 3699 | 0.353 | 509 | 0.336 |
| | | | Blue versus green eyes | 0.259 | 1.072 | 3699 | 0.353 | 788 | 0.337 |
| | | | Freckles (positive versus negative) | 0.771 | 0.987 | 2563 | 0.346 | 2323 | 0.349 |
| | | | Red versus non-red hair | 0.351 | 1.083 | 368 | 0.365 | 4580 | 0.347 |
| | | | Blond versus brown hair | 0.436 | 1.061 | 725 | 0.347 | 1350 | 0.334 |
| | | | Skin sensitivity to sun | 0.765 | 1.014 | 1791 | 0.351 | 2971 | 0.347 |
| | | | (Fitzpatrick 1 or 2 verus 3 or 4) | | | | | | |
| rs801114 | G | 1q42 | Blue versus brown eyes | 0.046 | 1.174 | 3701 | 0.332 | 510 | 0.297 |
| | | | Blue versus green eyes | 0.872 | 1.01 | 3701 | 0.332 | 788 | 0.329 |
| | | | Freckles (positive versus negative) | 0.648 | 0.979 | 2566 | 0.326 | 2324 | 0.331 |
| | | | Red versus non-red hair | 0.874 | 0.987 | 368 | 0.323 | 4584 | 0.326 |
| | | | Blond versus brown hair | 0.653 | 1.035 | 725 | 0.331 | 1354 | 0.323 |
| | | | Skin sensitivity to sun | 0.471 | 0.966 | 1793 | 0.323 | 2973 | 0.33 |
| | | | (Fitzpatrick 1 or 2 verus 3 or 4) | | | | | | |

TABLE 9
Effect of age of diagnosis of BCC for risk alleles of rs7538876 and rs801114

| | | | | Number | Age at Diagnosis | | | Regression | |
|---|---|---|---|---|---|---|---|---|---|
| SNP | Allele | Locus | Sample Set | of Cases | Median | Min | Max | Coefficient | P-value |
| rs7538876 | A | 1p36 | Iceland BCC | 1627 | 68 | 17 | 101 | −1.39 | 0.005 |
| | | | DKFZ BCC | 508 | 67 | 30 | 85 | −1.33 | 0.035 |
| | | | Combined | | | | | −1.39 | 5.96E−04 |
| rs801114 | G | 1q42 | Iceland BCC | 1623 | 68 | 17 | 101 | −0.11 | 0.833 |
| | | | DKFZ BCC | 512 | 67 | 30 | 85 | −1.00 | 0.134 |
| | | | Combined | | | | | −0.36 | 0.400 |

TABLE 10
Replication results of marker rs4151060 on Chromosome 10 for Cutaneous Melanoma (CM)

| Sample | | | | | Cases | Cases | Controls | Controls | | |
|---|---|---|---|---|---|---|---|---|---|---|
| Group | SNP | Allele | Pvalue | OR | Num | Freq | Num | Freq | 95% CI | Phet |
| Iceland | rs4151060 | 3 | 2.00E− | 1.76 | 587 | 0.965 | 34925 | 0.940 | | |
| Austria | rs4151060 | 3 | 6.44E− | 0.84 | 152 | 0.964 | 376 | 0.969 | | |
| Holland | rs4151060 | 3 | 4.13E− | 1.13 | 745 | 0.960 | 1829 | 0.955 | | |
| Italy | rs4151060 | 3 | 4.27E− | 1.98 | 561 | 0.971 | 363 | 0.944 | | |
| Spain | rs4151060 | 3 | 8.60E− | 1.28 | 816 | 0.960 | 1675 | 0.949 | | |
| Sweden | rs4151060 | 3 | 7.34E− | 0.96 | 1063 | 0.955 | 2634 | 0.957 | | |
| ALL | rs4151060 | 3 | 8.30E− | 1.25 | ND | ND | ND | ND | (1.10, 1.43) | 0.011 |

TABLE 11
Replication results of marker rs7812812 Chromosome 8 for Cutaneous Melanoma (CM)

| Sample | | | P- | | Cases | Cases | Controls | Controls | | |
|---|---|---|---|---|---|---|---|---|---|---|
| Group | SNP | Allele | value | OR | Num | Freq | Num | Freq | 95% CI | Phet |
| Iceland | rs7812812 | 3 | 1.30E− | 1.75 | 580 | 0.973 | 34819 | 0.954 | | |
| Austria | rs7812812 | 3 | 7.19E− | 1.13 | 152 | 0.957 | 376 | 0.952 | | |
| Holland | rs7812812 | 3 | 2.90E− | 0.86 | 745 | 0.945 | 1817 | 0.952 | | |
| Italy | rs7812812 | 3 | 4.24E− | 0.87 | 557 | 0.916 | 358 | 0.926 | | |
| Spain | rs7812812 | 3 | 1.26E− | 1.35 | 813 | 0.939 | 1681 | 0.920 | | |
| Sweden | rs7812812 | 3 | 9.37E− | 1.21 | 1040 | 0.951 | 2675 | 0.941 | | |
| ALL | rs7812812 | 3 | 9.10E− | 1.17 | ND | ND | ND | ND | (1.04, 1.32) | 0.013 |

TABLE 12
Replication results of marker rs9585777 Chromosome 13 for Cutaneous Melanoma (CM)

| Sample | | | P- | | Cases | Cases | Controls | Controls | | |
|---|---|---|---|---|---|---|---|---|---|---|
| Group | SNP | Allele | value | OR | Num | Freq | Num | Freq | 95% CI | Phet |
| Iceland | rs9585777 | 1 | 1.80E− | 1.32 | 586 | 0.806 | 34888 | 0.759 | | |
| Austria | rs9585777 | 1 | 6.93E− | 1.07 | 150 | 0.777 | 375 | 0.765 | | |
| Holland | rs9585777 | 1 | 8.75E− | 0.99 | 741 | 0.796 | 1832 | 0.797 | | |
| Italy | rs9585777 | 1 | 2.45E− | 1.14 | 555 | 0.770 | 365 | 0.747 | | |
| Spain | rs9585777 | 1 | 2.75E− | 1.17 | 809 | 0.792 | 1695 | 0.765 | | |
| Sweden | rs9585777 | 1 | 4.64E− | 1.05 | 1026 | 0.812 | 2684 | 0.804 | | |
| ALL | rs9585777 | 1 | 6.00E− | 1.12 | ND | ND | ND | ND | (1.05, 1.20) | 0.1 |

TABLE 13
Replication results of rs10504624 Chromosome 8 for Basal Cell Carcinoma (BCC)

| Sample | | | P- | | Cases | Cases | Controls | Controls | | |
|---|---|---|---|---|---|---|---|---|---|---|
| Group | SNP | Allele | value | OR | Num | Freq | Num | Freq | 95% CI | Phet |
| Iceland | rs10504624 | 1 | 1.50E−06 | 1.53 | 1830 | 0.959 | 34908 | 0.938 | | |
| Eastern | rs10504624 | 1 | 1.49E−01 | 1.33 | 526 | 0.953 | 531 | 0.939 | | |
| Europe | | | | | | | | | | |
| ALL | rs10504624 | 1 | 6.30E−07 | 1.49 | ND | ND | ND | ND | (1.28, 1.75) | 0.54 |

TABLE 14
Polymorphic SNP markers in LD with rs4151060 on Chromosome 10 by an r²
value of 0.1 or higher. The SNP surrogate markers were selected using the
Caucasian HapMap CEU dataset (see http://www.hapmap.org). Shown are marker
names, position of the surrogate marker in NCBI Build 36, identity of the allele that is
associated with allele G of rs4151060, and values of D′, r² and P-value
for the correlation between the correlated marker and the anchor marker, and finally
Sequence ID No.

| SNP | POS_B36 | Allele | D′ | R2 | P-value | Seq ID No: |
|---|---|---|---|---|---|---|
| rs2078059 | 103014631 | 4 | 0.673726 | 0.251595 | 0.000148 | 3 |
| rs12569599 | 103023116 | 3 | 0.646811 | 0.129582 | 0.001566 | 4 |
| rs590945 | 103057677 | 2 | 1 | 0.223962 | 1.56E−06 | 5 |
| rs3802727 | 103061399 | 2 | 1 | 0.123894 | 0.000055 | 6 |
| rs734423 | 103075893 | 4 | 1 | 0.247788 | 7.86E−07 | 7 |
| rs2025106 | 103091494 | 4 | 1 | 0.133675 | 3.62E−05 | 8 |
| rs11594460 | 103115532 | 1 | 1 | 0.106999 | 0.000119 | 9 |
| rs17760544 | 103125500 | 1 | 1 | 0.108359 | 0.000112 | 10 |
| rs11591788 | 103163786 | 3 | 1 | 0.106999 | 0.000119 | 11 |
| rs4917940 | 103177172 | 2 | 1 | 0.110928 | 9.89E−05 | 12 |
| rs4919545 | 103181114 | 3 | 1 | 0.106999 | 0.000119 | 13 |
| rs4451650 | 103195262 | 1 | 1 | 0.113737 | 8.71E−05 | 14 |
| rs12416466 | 103217301 | 3 | 1 | 0.114595 | 8.7E−05 | 15 |
| rs11597599 | 103238567 | 3 | 1 | 0.110928 | 9.89E−05 | 16 |
| rs12774622 | 103262211 | 2 | 1 | 1 | 2.77E−13 | 17 |
| rs12769629 | 103264602 | 2 | 1 | 0.110928 | 9.89E−05 | 18 |
| rs11599636 | 103270372 | 3 | 1 | 0.110928 | 9.89E−05 | 19 |
| rs4151060 | 103288089 | 3 | 1 | 1 | | 20 |
| rs4244346 | 103301618 | 3 | 1 | 0.110928 | 9.89E−05 | 21 |
| rs12784408 | 103346401 | 2 | 1 | 0.110928 | 9.89E−05 | 22 |
| rs3915773 | 103356827 | 4 | 1 | 0.144543 | 2.33E−05 | 23 |
| rs12767066 | 103495326 | 3 | 1 | 0.135654 | 0.0158 | 24 |
| rs10786648 | 103511315 | 2 | 1 | 0.115044 | 8.17E−05 | 25 |
| rs17777943 | 103736494 | 3 | 0.84127 | 0.394578 | 4.72E−07 | 26 |

TABLE 15
Polymorphic SNP markers in LD with rs7812812 on Chromosome 8 by an r² value
of 0.1 or higher. The SNP surrogate markers were selected using the Caucasian
HapMap CEU dataset (see http://www.hapmap.org). Shown are marker names,
position of the surrogate marker in NCBI Build 36, identity of the allele that is
associated with allele G of rs7812812, values of D′, r² and P-value for
the correlation between the correlated marker and the anchor marker, and finally
Sequence ID No.

| SNP | POS_B36 | Allele | D′ | R2 | P-value | Seq ID No: |
|---|---|---|---|---|---|---|
| rs10097735 | 116971686 | 3 | 1 | 0.224138 | 6.98E−07 | 27 |
| rs2721953 | 116717264 | 3 | 1 | 0.170507 | 5.27E−06 | 28 |
| rs2737229 | 116717740 | 1 | 1 | 0.160232 | 7.16E−06 | 29 |
| rs2737231 | 116719394 | 1 | 1 | 0.149798 | 1.18E−05 | 30 |
| rs727582 | 116719643 | 4 | 1 | 0.132653 | 2.35E−05 | 31 |
| rs727581 | 116719666 | 1 | 1 | 0.132653 | 2.35E−05 | 32 |
| rs2178950 | 116722193 | 3 | 1 | 0.132653 | 2.35E−05 | 33 |
| rs2721956 | 116722831 | 3 | 1 | 0.131175 | 2.53E−05 | 34 |
| rs2721960 | 116725904 | 3 | 1 | 0.131175 | 2.53E−05 | 35 |
| rs2737242 | 116726902 | 4 | 1 | 0.131579 | 2.52E−05 | 36 |
| rs2737244 | 116727405 | 1 | 1 | 0.132653 | 2.35E−05 | 37 |
| rs2721962 | 116727725 | 4 | 1 | 0.132653 | 2.35E−05 | 38 |
| rs2737245 | 116727757 | 3 | 0.79881 | 0.115287 | 0.002121 | 39 |
| rs2142333 | 116728632 | 2 | 1 | 0.137631 | 1.88E−05 | 40 |
| rs2178951 | 116728708 | 1 | 1 | 0.137631 | 1.88E−05 | 41 |
| rs2737246 | 116728752 | 3 | 1 | 0.177215 | 3.72E−06 | 42 |
| rs2737247 | 116729539 | 1 | 1 | 0.137631 | 1.88E−05 | 43 |
| rs2737249 | 116730219 | 4 | 1 | 0.142857 | 1.49E−05 | 44 |
| rs2049870 | 116730690 | 2 | 1 | 0.14346 | 1.92E−05 | 45 |
| rs2737250 | 116731048 | 1 | 1 | 0.137631 | 1.88E−05 | 46 |
| rs2721965 | 116731212 | 1 | 1 | 0.142857 | 1.49E−05 | 47 |
| rs2737252 | 116733072 | 3 | 0.80254 | 0.121287 | 0.001677 | 48 |
| rs2737253 | 116733096 | 3 | 1 | 0.142857 | 1.49E−05 | 49 |
| rs2049874 | 116734112 | 3 | 1 | 0.137631 | 1.88E−05 | 50 |
| rs179442 | 116738943 | 2 | 1 | 0.142857 | 1.49E−05 | 51 |
| rs3808477 | 116739521 | 2 | 0.80254 | 0.121287 | 0.001677 | 52 |
| rs3808478 | 116747451 | 4 | 1 | 0.127907 | 2.93E−05 | 53 |
| rs9297543 | 116774154 | 4 | 0.79881 | 0.115287 | 0.002121 | 54 |
| rs800572 | 116787611 | 2 | 0.76367 | 0.109699 | 0.008592 | 55 |
| rs800536 | 116789579 | 4 | 0.79092 | 0.10426 | 0.003312 | 56 |
| rs800538 | 116792163 | 3 | 0.79034 | 0.127614 | 0.004398 | 57 |
| rs2694034 | 116809997 | 3 | 0.79092 | 0.10426 | 0.003312 | 58 |
| rs1405297 | 116816675 | 1 | 0.79881 | 0.115287 | 0.002121 | 59 |
| rs2960157 | 116864717 | 2 | 0.80254 | 0.121287 | 0.001677 | 60 |
| rs800509 | 116866706 | 2 | 0.80614 | 0.127653 | 0.001316 | 61 |
| rs2736207 | 116878831 | 4 | 0.80254 | 0.121287 | 0.001677 | 62 |
| rs800586 | 116883081 | 4 | 0.80569 | 0.126817 | 0.001394 | 63 |
| rs800551 | 116888444 | 2 | 0.80614 | 0.127653 | 0.001316 | 64 |
| rs800548 | 116889064 | 1 | 0.80254 | 0.121287 | 0.001677 | 65 |
| rs800546 | 116890363 | 4 | 0.80614 | 0.127653 | 0.001316 | 66 |
| rs800545 | 116891823 | 2 | 0.80614 | 0.127653 | 0.001316 | 67 |
| rs1040333 | 116894526 | 2 | 0.80614 | 0.127653 | 0.001316 | 68 |
| rs11992787 | 116906662 | 1 | 1 | 0.117647 | 0.018605 | 69 |
| rs7813338 | 116908572 | 1 | 1 | 0.134615 | 0.015952 | 70 |
| rs7814162 | 116908838 | 3 | 1 | 0.117647 | 0.018605 | 71 |
| rs16887811 | 116916900 | 2 | 1 | 0.117647 | 0.018605 | 72 |
| rs12547177 | 116919340 | 3 | 1 | 0.117647 | 0.018605 | 73 |
| rs12549829 | 116919704 | 4 | 1 | 0.117647 | 0.018605 | 74 |
| rs6651216 | 116944130 | 1 | 1 | 1 | 1.76E−14 | 75 |
| rs4876620 | 116948608 | 2 | 1 | 1 | 1.76E−14 | 76 |
| rs4876621 | 116948684 | 2 | 1 | 1 | 1.76E−14 | 77 |
| rs7006188 | 116951723 | 1 | 1 | 1 | 1.76E−14 | 78 |
| rs800543 | 116951826 | 2 | 1 | 0.142857 | 1.49E−05 | 79 |
| rs12545387 | 116953040 | 4 | 1 | 1 | 1.76E−14 | 80 |
| rs10505271 | 116955359 | 4 | 1 | 1 | 1.76E−14 | 81 |
| rs7814661 | 116957904 | 2 | 1 | 0.224138 | 6.98E−07 | 82 |
| rs7834667 | 116958261 | 1 | 1 | 1 | 1.76E−14 | 83 |
| rs7005878 | 116958505 | 3 | 1 | 1 | 1.76E−14 | 84 |
| rs12541724 | 116964298 | 1 | 1 | 1 | 1.76E−14 | 85 |
| rs975771 | 116968079 | 1 | 1 | 1 | 1.76E−14 | 86 |
| rs976304 | 116969950 | 3 | 1 | 1 | 1.76E−14 | 87 |
| rs7812812 | 116971648 | 3 | 1 | 1 | | 88 |
| rs17717583 | 116972819 | 3 | 1 | 1 | 1.76E−14 | 89 |
| rs10955760 | 116973267 | 1 | 1 | 1 | 2.34E−14 | 90 |
| rs6469609 | 116974220 | 3 | 1 | 1 | 1.76E−14 | 91 |
| rs7832162 | 116975508 | 3 | 1 | 1 | 1.76E−14 | 92 |
| rs2205259 | 116977400 | 3 | 1 | 1 | 1.76E−14 | 93 |
| rs2358066 | 116977822 | 2 | 1 | 1 | 1.76E−14 | 94 |
| rs12676086 | 116978400 | 2 | 1 | 1 | 1.76E−14 | 95 |
| rs2049836 | 116978799 | 3 | 1 | 1 | 1.76E−14 | 96 |
| rs2049837 | 116979125 | 4 | 1 | 1 | 1.76E−14 | 97 |
| rs16887889 | 116980208 | 2 | 1 | 1 | 1.76E−14 | 98 |
| rs6469610 | 116980756 | 2 | 1 | 1 | 1.76E−14 | 99 |
| rs7836109 | 116981974 | 2 | 1 | 1 | 1.76E−14 | 100 |
| rs7839312 | 116982039 | 1 | 1 | 1 | 1.76E−14 | 101 |
| rs7814835 | 116984146 | 1 | 1 | 1 | 1.76E−14 | 102 |
| rs12545683 | 116987709 | 2 | 1 | 1 | 1.76E−14 | 103 |
| rs7000536 | 116987847 | 4 | 1 | 0.224138 | 6.98E−07 | 104 |
| rs7006245 | 116988902 | 3 | 1 | 1 | 1.76E−14 | 105 |
| rs7006105 | 116988938 | 2 | 1 | 1 | 1.76E−14 | 106 |
| rs12707864 | 116989089 | 4 | 1 | 0.230769 | 5.73E−07 | 107 |
| rs12547292 | 116991567 | 4 | 1 | 1 | 1.76E−14 | 108 |
| rs4876346 | 116995878 | 4 | 1 | 0.154135 | 9.21E−06 | 109 |
| rs6982767 | 116996878 | 3 | 1 | 1 | 1.76E−14 | 110 |
| rs6986858 | 116997237 | 2 | 1 | 1 | 1.76E−14 | 111 |
| rs4598283 | 116998278 | 4 | 1 | 1 | 1.76E−14 | 112 |
| rs6993628 | 116998980 | 3 | 1 | 1 | 1.76E−14 | |
| rs12547878 | 117001019 | 3 | 1 | 1 | 1.76E−14 | 114 |
| rs7817477 | 117002822 | 1 | 1 | 1 | 1.76E−14 | 115 |
| rs11786434 | 117004409 | 4 | 1 | 0.224138 | 6.98E−07 | 116 |
| rs926135 | 117007809 | 4 | 1 | 1 | 1.76E−14 | 117 |
| rs10505272 | 117009086 | 3 | 1 | 1 | 1.76E−14 | 118 |
| rs7009453 | 117015664 | 4 | 1 | 0.848485 | 1.01E−10 | 119 |
| rs7825602 | 117016845 | 2 | 0.86607 | 0.75008 | 1.29E−10 | 120 |
| rs909255 | 117018100 | 2 | 1 | 0.224138 | 6.98E−07 | 121 |
| rs7827717 | 117022023 | 1 | 0.86607 | 0.75008 | 1.29E−10 | 122 |
| rs4140856 | 117023997 | 3 | 1 | 0.200969 | 1.63E−06 | 123 |
| rs5021979 | 117025988 | 4 | 1 | 0.212411 | 1.04E−06 | 124 |
| rs11993108 | 117049574 | 2 | 0.72966 | 0.467509 | 1.84E−07 | 125 |

TABLE 16
Polymorphic SNP markers in LD with rs9585777 on Chromosome 13 by an r²
value of 0.1 or higher. The SNP surrogate markers were selected using the
Caucasian HapMap CEU dataset (see http://www.hapmap.org). Shown are marker
names, position of the surrogate marker in NCBI Build 36, identity of the allele that is
associated with allele A of rs9585777, and values of D′, r² and P-value
for the correlation between the correlated marker and the anchor marker, and finally
Sequence ID No.

| SNP | POS_B36 | Allele | D′ | R2 | P-value | Seq ID No: |
|---|---|---|---|---|---|---|
| rs10775027 | 85843828 | 2 | 1 | 0.2513 | 2.84E−10 | 126 |
| rs1334161 | 85565804 | 2 | 0.490696 | 0.10027 | 0.001891 | 127 |
| rs9515510 | 85736005 | 2 | 0.76806 | 0.117571 | 0.003072 | 128 |
| rs9589542 | 85770172 | 3 | 0.656686 | 0.307191 | 5.80E−07 | 129 |
| rs9589593 | 85771687 | 2 | 0.737505 | 0.316437 | 1.54E−06 | 130 |
| rs9589644 | 85774450 | 4 | 0.691854 | 0.294768 | 8.81E−07 | 131 |
| rs9589681 | 85777479 | 2 | 0.691854 | 0.294768 | 8.81E−07 | 132 |
| rs9584094 | 85778238 | 3 | 0.901801 | 0.384709 | 2.13E−08 | 133 |
| rs9517751 | 85840780 | 3 | 1 | 0.130785 | 1.42E−06 | 134 |
| rs12868432 | 85841118 | 2 | 1 | 0.936846 | 2.07E−22 | 135 |
| rs12861280 | 85842327 | 3 | 1 | 1 | 1.53E−28 | 136 |
| rs9585170 | 85842380 | 3 | 1 | 1 | 3.13E−28 | 137 |
| rs9284187 | 85846529 | 2 | 1 | 1 | 1.53E−28 | 138 |
| rs12866987 | 85847281 | 3 | 1 | 0.906433 | 2.03E−25 | 139 |
| rs17612602 | 85848127 | 4 | 1 | 1 | 1.53E−28 | 140 |
| rs12874621 | 85848386 | 4 | 1 | 1 | 1.53E−28 | 141 |
| rs9518034 | 85848403 | 4 | 1 | 0.2513 | 2.84E−10 | 142 |
| rs13378986 | 85850349 | 2 | 1 | 1 | 1.53E−28 | 143 |
| rs12867674 | 85850908 | 4 | 1 | 1 | 1.53E−28 | 144 |
| rs12854454 | 85851559 | 2 | 1 | 1 | 1.53E−28 | 145 |
| rs9518143 | 85852708 | 4 | 1 | 0.249465 | 4.63E−10 | 146 |
| rs9585487 | 85852922 | 3 | 1 | 1 | 1.94E−28 | 147 |
| rs9585491 | 85853073 | 3 | 0.94734 | 0.895863 | 3.44E−21 | 148 |
| rs9300634 | 85854844 | 2 | 1 | 1 | 1.53E−28 | 149 |
| rs9554746 | 85855517 | 1 | 1 | 0.241343 | 5.97E−10 | 150 |
| rs9585650 | 85857660 | 3 | 1 | 1 | 1.53E−28 | 151 |
| rs9585651 | 85857718 | 4 | 1 | 1 | 1.53E−28 | 152 |
| rs9582464 | 85857823 | 3 | 1 | 1 | 1.53E−28 | 153 |
| rs12877888 | 85858284 | 3 | 1 | 1 | 1.53E−28 | 154 |
| rs9585656 | 85858468 | 1 | 1 | 1 | 1.53E−28 | 155 |
| rs7328224 | 85858487 | 2 | 1 | 1 | 1.53E−28 | 156 |
| rs9554765 | 85858537 | 1 | 1 | 0.248009 | 3.63E−10 | 157 |
| rs9300659 | 85858778 | 3 | 1 | 1 | 1.53E−28 | 158 |
| rs9652123 | 85859582 | 4 | 1 | 1 | 1.53E−28 | 159 |
| rs9518386 | 85859838 | 4 | 1 | 0.123071 | 2.56E−06 | 160 |
| rs1604478 | 85860890 | 4 | 1 | 1 | 1.53E−28 | 161 |
| rs9513910 | 85861019 | 2 | 1 | 0.2513 | 2.84E−10 | 162 |
| rs9585777 | 85863400 | 1 | 1 | 1 | | 163 |
| rs7336573 | 85864615 | 4 | 0.904282 | 0.23764 | 2.64E−06 | 164 |
| rs9518594 | 85864710 | 2 | 0.887229 | 0.153659 | 1.61E−05 | 165 |
| rs1566656 | 85871130 | 4 | 0.84177 | 0.10091 | 0.001023 | 166 |
| rs4772188 | 85871398 | 4 | 0.929086 | 0.379447 | 1.98E−10 | 167 |
| rs9518826 | 85873221 | 2 | 0.84177 | 0.10091 | 0.001023 | 168 |
| rs1502057 | 85875434 | 1 | 1 | 0.13587 | 9.52E−07 | 169 |
| rs7491565 | 85876591 | 2 | 0.850376 | 0.104645 | 0.000694 | 170 |
| rs9514117 | 85878968 | 2 | 1 | 0.101629 | 1.64E−05 | 171 |
| rs9514185 | 85883711 | 3 | 0.84177 | 0.10091 | 0.001023 | 172 |
| rs7336050 | 85886561 | 1 | 0.930736 | 0.376639 | 1.98E−10 | 173 |
| rs9558361 | 85891876 | 4 | 0.930736 | 0.376639 | 1.98E−10 | 174 |
| rs11069582 | 85896564 | 2 | 0.838486 | 0.102295 | 0.001251 | 175 |
| rs9519627 | 85897841 | 3 | 0.84177 | 0.10091 | 0.001023 | 176 |
| rs9558531 | 85898951 | 4 | 0.929086 | 0.379447 | 1.98E−10 | 177 |
| rs9555176 | 85900773 | 1 | 0.929086 | 0.379447 | 1.98E−10 | 178 |
| rs4772487 | 85903906 | 3 | 0.92516 | 0.370027 | 1.50E−09 | 179 |
| rs4772490 | 85904086 | 3 | 1 | 0.100184 | 1.91E−05 | 180 |
| rs9519886 | 85905785 | 3 | 1 | 0.104364 | 1.23E−05 | 181 |
| rs1502069 | 85908326 | 3 | 1 | 0.104364 | 1.23E−05 | 182 |
| rs2341344 | 85910423 | 2 | 0.8664 | 0.374975 | 6.79E−10 | 183 |
| rs9558778 | 85910823 | 2 | 0.848525 | 0.109229 | 0.000683 | 184 |
| rs9558790 | 85911660 | 4 | 0.927617 | 0.414257 | 2.62E−10 | 185 |
| rs2168983 | 85912718 | 4 | 0.857493 | 0.116286 | 0.000365 | 186 |
| rs1393272 | 85914480 | 3 | 0.852886 | 0.111342 | 0.000497 | 187 |
| rs9514604 | 85916033 | 2 | 1 | 0.145579 | 4.49E−07 | 188 |
| rs9558952 | 85917041 | 4 | 0.927617 | 0.414257 | 2.62E−10 | 189 |
| rs9514623 | 85917210 | 2 | 0.848525 | 0.109229 | 0.000683 | 190 |
| rs7323967 | 85920634 | 4 | 0.931536 | 0.409806 | 4.10E−11 | 191 |
| rs2134261 | 85924810 | 1 | 0.931536 | 0.409806 | 4.10E−11 | 192 |
| rs2134260 | 85924918 | 1 | 0.931536 | 0.409806 | 4.10E−11 | 193 |
| rs9559192 | 85925160 | 2 | 0.931536 | 0.409806 | 4.10E−11 | 194 |
| rs9559201 | 85925627 | 2 | 0.928349 | 0.407736 | 3.29E−10 | 195 |
| rs9555467 | 85929436 | 2 | 0.931536 | 0.409806 | 4.10E−11 | 196 |
| rs9559343 | 85930138 | 4 | 0.92977 | 0.401963 | 8.13E−11 | 197 |
| rs9559345 | 85930215 | 1 | 0.931536 | 0.409806 | 4.10E−11 | 198 |
| rs9559346 | 85930231 | 3 | 0.929519 | 0.387162 | 4.33E−10 | 199 |
| rs9559367 | 85931413 | 1 | 0.908697 | 0.351861 | 7.57E−08 | 200 |
| rs1502055 | 85934331 | 4 | 0.848406 | 0.114198 | 0.000671 | 201 |
| rs12430190 | 85934435 | 4 | 0.923978 | 0.531558 | 3.65E−10 | 202 |
| rs7994659 | 85935687 | 3 | 0.913575 | 0.278414 | 1.75E−07 | 203 |
| rs9555560 | 85937052 | 4 | 0.913575 | 0.278414 | 1.75E−07 | 204 |
| rs9555564 | 85937583 | 1 | 0.928194 | 0.454109 | 3.05E−10 | 205 |
| rs4772788 | 85942476 | 4 | 0.930742 | 0.409117 | 8.22E−11 | 206 |
| rs9555661 | 85945778 | 2 | 0.931536 | 0.409806 | 4.10E−11 | 207 |
| rs4772830 | 85947812 | 1 | 0.913575 | 0.278414 | 1.75E−07 | 208 |
| rs9559828 | 85950706 | 3 | 0.75972 | 0.133918 | 0.002132 | 209 |
| rs9559996 | 85957110 | 1 | 0.832578 | 0.244126 | 4.70E−06 | 210 |
| rs7986423 | 85961260 | 3 | 0.832597 | 0.248123 | 3.81E−06 | 211 |
| rs4608205 | 85969056 | 3 | 0.533727 | 0.218437 | 2.17E−05 | 212 |
| rs9560187 | 85969361 | 4 | 0.526061 | 0.203315 | 4.25E−05 | 213 |
| rs7999625 | 85972057 | 3 | 0.533727 | 0.218437 | 2.17E−05 | 214 |
| rs7991919 | 85972365 | 4 | 0.517767 | 0.206097 | 4.01E−05 | 215 |
| rs7318503 | 85977296 | 4 | 0.751462 | 0.120199 | 0.001077 | 216 |
| rs7334995 | 85979870 | 3 | 0.820187 | 0.237914 | 2.41E−06 | 217 |
| rs7323006 | 85980335 | 2 | 0.832221 | 0.22842 | 1.41E−06 | 218 |
| rs9522408 | 85981033 | 2 | 0.738018 | 0.116662 | 0.001802 | 219 |
| rs6492394 | 85981658 | 4 | 0.820562 | 0.196163 | 6.11E−06 | 220 |
| rs1410763 | 85983380 | 3 | 0.832221 | 0.22842 | 1.41E−06 | 221 |
| rs4771728 | 85989050 | 2 | 0.822962 | 0.221618 | 3.60E−06 | 222 |
| rs1360052 | 85990096 | 2 | 0.751462 | 0.120199 | 0.001077 | 223 |
| rs9301538 | 85990748 | 4 | 0.832221 | 0.22842 | 1.41E−06 | 224 |
| rs7331581 | 85998051 | 2 | 0.751462 | 0.120199 | 0.001077 | 225 |
| rs7331629 | 85998124 | 2 | 0.751462 | 0.120199 | 0.001077 | 226 |
| rs7325418 | 85998485 | 2 | 0.751462 | 0.120199 | 0.001077 | 227 |
| rs2880005 | 86006618 | 3 | 0.832116 | 0.236286 | 1.59E−06 | 228 |
| rs7983601 | 86013930 | 4 | 1 | 0.21217 | 3.71E−09 | 229 |
| rs9284259 | 86014585 | 2 | 1 | 0.13369 | 1.11E−06 | 230 |
| rs8000086 | 86017648 | 2 | 1 | 0.21217 | 3.71E−09 | 231 |
| rs9560294 | 86018342 | 4 | 1 | 0.135087 | 1.05E−06 | 232 |
| rs4773434 | 86021894 | 2 | 1 | 0.21217 | 3.71E−09 | 233 |
| rs9301571 | 86025992 | 2 | 0.879363 | 0.176004 | 5.96E−05 | 234 |
| rs7992637 | 86027318 | 2 | 1 | 0.218363 | 2.86E−09 | 235 |
| rs9555892 | 86027331 | 4 | 1 | 0.116771 | 5.33E−06 | 236 |
| rs7993088 | 86027637 | 4 | 1 | 0.158419 | 2.24E−07 | 237 |
| rs7997004 | 86028559 | 2 | 1 | 0.213572 | 3.71E−09 | 238 |
| rs4773442 | 86029950 | 3 | 1 | 0.21472 | 3.20E−09 | 239 |
| rs9588622 | 86033399 | 3 | 1 | 0.229167 | 1.66E−09 | 240 |
| rs1592331 | 86033803 | 2 | 1 | 0.13369 | 1.11E−06 | 241 |
| rs7324406 | 86061074 | 2 | 1 | 0.13369 | 1.11E−06 | 242 |
| rs1343559 | 86062408 | 3 | 0.585573 | 0.23127 | 1.90E−06 | 243 |
| rs1418128 | 86063740 | 1 | 0.719957 | 0.174781 | 0.000397 | 244 |
| rs3904912 | 86081153 | 3 | 0.447485 | 0.160893 | 9.43E−05 | 245 |
| rs3015528 | 86179358 | 4 | 0.443244 | 0.101403 | 0.004541 | 246 |
| rs12876431 | 86292508 | 4 | 0.769235 | 0.221818 | 4.58E−06 | 247 |

TABLE 17
Polymorphic SNP markers in LD with rs10504624 on Chromosome 8 by an r²
value of 0.1 or higher. The SNP surrogate markers were selected using the
Caucasian HapMap CEU dataset (see http://www.hapmap.org). Shown are marker
names, position of the surrogate marker in NCBI Build 36, identity of the allele that is
associated with allele A of rs10504624, values of D′, r² and P-value for
the correlation between the correlated marker and the anchor marker, and finally
Sequence ID No.

| SNP | POS_B36 | Allele | D′ | R2 | P-value | Seq ID No: |
|---|---|---|---|---|---|---|
| rs17332334 | 77236765 | 1 | 0.534043 | 0.218833 | 0.000275 | 248 |
| rs16939289 | 77599593 | 4 | 1 | 1 | 1.29E−15 | 249 |
| rs10504623 | 77599813 | 1 | 1 | 1 | 1.29E−15 | 250 |
| rs16939291 | 77603021 | 2 | 1 | 1 | 1.29E−15 | 251 |
| rs17346090 | 77605168 | 4 | 1 | 0.103641 | 0.021477 | 252 |
| rs2312420 | 77605732 | 1 | 1 | 0.145192 | 8.55E−06 | 253 |
| rs10085982 | 77607787 | 2 | 1 | 0.80344 | 2.58E−13 | 254 |
| rs16939296 | 77609243 | 1 | 1 | 1 | 1.29E−15 | 255 |
| rs12156031 | 77610089 | 1 | 1 | 0.891008 | 3.79E−14 | 256 |
| rs10504624 | 77612552 | 1 | 1 | 1 | | 257 |
| rs9298282 | 77612764 | 3 | 1 | 0.145192 | 8.55E−06 | 258 |
| rs10105786 | 77614631 | 3 | 1 | 1 | 1.29E−15 | 259 |
| rs961527 | 77616314 | 3 | 1 | 0.80344 | 2.58E−13 | 260 |
| rs4735733 | 77622260 | 2 | 1 | 0.145192 | 8.55E−06 | 261 |
| rs17431544 | 77630043 | 3 | 1 | 1 | 1.29E−15 | 262 |
| rs17431641 | 77631233 | 4 | 1 | 1 | 1.29E−15 | 263 |
| rs17431648 | 77631303 | 2 | 1 | 1 | 1.29E−15 | 264 |
| rs17431718 | 77633897 | 2 | 1 | 1 | 1.29E−15 | 265 |
| rs10216564 | 77637685 | 2 | 0.877582 | 0.613648 | 3.73E−10 | 266 |
| rs10101497 | 77639054 | 2 | 1 | 0.254427 | 1.21E−07 | 267 |
| rs4144726 | 77655362 | 1 | 0.842683 | 0.138455 | 9.18E−05 | 268 |
| rs13257282 | 77666920 | 1 | 0.61165 | 0.183787 | 0.000124 | 269 |
| rs10808812 | 77667863 | 2 | 0.566943 | 0.1142 | 0.003166 | 270 |
| rs7846606 | 77670168 | 3 | 0.578947 | 0.103272 | 0.001801 | 271 |
| rs13279286 | 77670985 | 3 | 0.844961 | 0.146424 | 6.56E−05 | 272 |
| rs17348126 | 77673218 | 4 | 0.611658 | 0.225572 | 0.000133 | 273 |
| rs17348154 | 77674091 | 2 | 0.714566 | 0.292098 | 9.98E−06 | 274 |
| rs17432923 | 77674979 | 3 | 0.622382 | 0.236409 | 3.01E−05 | 275 |
| rs17432986 | 77676458 | 2 | 0.617518 | 0.232721 | 6.01E−05 | 276 |
| rs13278854 | 77677274 | 2 | 0.622642 | 0.237998 | 2.86E−05 | 277 |
| rs10957809 | 77677950 | 1 | 0.622642 | 0.237998 | 2.86E−05 | 278 |
| rs17348372 | 77679863 | 4 | 0.519362 | 0.268563 | 3.65E−05 | 279 |
| rs16939323 | 77682792 | 4 | 0.481652 | 0.113119 | 0.002137 | 280 |
| rs10448038 | 77683860 | 3 | 0.481091 | 0.112007 | 0.002229 | 281 |
| rs17348470 | 77684641 | 1 | 0.514747 | 0.233976 | 8.09E−05 | 282 |
| rs10957812 | 77687776 | 3 | 0.496467 | 0.150318 | 0.000681 | 283 |
| rs10504632 | 77701636 | 4 | 0.515152 | 0.236691 | 7.41E−05 | 284 |
| rs17348969 | 77701877 | 1 | 0.514747 | 0.233976 | 8.09E−05 | 285 |
| rs17349004 | 77702519 | 3 | 0.514539 | 0.2326 | 8.45E−05 | 286 |
| rs6996667 | 77729036 | 2 | 0.496855 | 0.15155 | 0.000653 | 287 |
| rs17434334 | 77734921 | 2 | 0.436028 | 0.124025 | 0.014219 | 288 |
| rs17434383 | 77734971 | 3 | 0.457014 | 0.136226 | 0.003446 | 289 |
| rs10504633 | 77768643 | 1 | 0.382239 | 0.111627 | 0.006279 | 290 |
| rs1034483 | 77769151 | 4 | 0.377432 | 0.11005 | 0.006617 | 291 |
| rs10504635 | 77771836 | 1 | 0.382239 | 0.111627 | 0.006279 | 292 |
| rs17435394 | 77788825 | 3 | 0.379845 | 0.110842 | 0.006445 | 293 |
| rs16939351 | 77823103 | 1 | 0.379845 | 0.110842 | 0.006445 | 294 |
| rs17364641 | 77843421 | 2 | 0.379845 | 0.110842 | 0.006445 | 295 |
| rs10504641 | 77855244 | 2 | 0.382239 | 0.111627 | 0.006279 | 296 |
| rs16939360 | 77858064 | 1 | 0.379845 | 0.110842 | 0.006445 | 297 |
| rs13267538 | 77961760 | 3 | 0.72973 | 0.226468 | 0.000476 | 298 |

TABLE 18
Flanking sequence for markers associated with
risk of BCC

>rs7538876
AGTGCCTGCTATAAACTGTTCCGAGAGAAACAGAAGGAAGGCTATGGCGA
CGCTCTTCTGTTTGATGAGCTTAGAGCAGATCAGCTCCTGTCTAATGGTA
AGGGAACTCCCTTTCCACAGAACAGAACTGGGGTCTTCCTTTTTCCAGGG
GTCCTTTCTACATAGCCATTCTGTCACGCTTGGCGTAAAGGATGCCAGGG
AAGCACAGAAGCTGTTGGAATTGCCATATTAGAACGTCTTATTTCTGGGC
TGCTCTAGTGGTACTACAACACAAGTAGACCAGATGTTCTGGGATGGCCT
[A/G]
GAGGCTGTTTGGATGTATTTGAAGGGGGACTCACTTAGTACATAGGTGG
CCCCAAGTGGGGGGAAAACGGGTGTTAACAATGCTAGTGCCTGGATTTAT
TCAGGGCATGTTGGATTAAGTATCTAGGGACTGGGACTTTGTGGGTCTCC
TGGTTACATTAAGGAAACACACAGGTGGACAAGCAGAGGTGGTGTGGCTG
GTGCCATTGCACTTCTGATCTAAAGGCTGTGGGAGTGGGCTGGGCATGGT
GGCTCACACCTGTAACCCCAGCACTTTGGGAGGCTGAGGCGGGCAGATCA
C
>rs801114
TCCTAGCACAACAGCTCCAATCACTGCTATTAGAACAGATCCAAGGGGCA
GGCTGGGAGGGTGTTAGGTTCAAAAAGGAGCACTATGTAGAAGCAAGAAA
AGAGATGAAAGTTTTGCTCCTATCTGCATCTGGCCAGAGAGCAGACTTTG
ATTTGCAACACCGTGTGGTCTCTGCAGGATTACGAAAGGGAAGAGGGGGT
GGGCGGAAGGCTCTCCTCCCCAGTGCATCATTTTCAGTTTTGTCTTTTAC
TTTCAAAGAAAGCTGTCTTTCTGACACTGCATTCTGCCCTTTCTGACCCA
[G/T]
GTCCCATATTTAAAGGCTTCACATAGACTATATAATCCAAGTTATCCCT
CTGTGGAGAAAGTGGCTATGAGAATTAGAGAGACAAAGGGTGTGCTTGTG
GGAATGGGATGTAACGTCAGAGCAGGTTCAACCTTACAGCTGTGCAGTCC
AGTTAGTCAAATATTAATGAGTCAATTTAATTAAAGATTAGGTCCTCTGT
TGCACTAGCCATCCTGCAAAGTCACATGTGGCGAGTGTTTTCATACTGGA
TAGCACCACAGAAAGTTCTGTTGGGCATCATTGCCACTTGGACCAAGGGA
T
>rs801119
AGTAGAGACGGGGTTTCCCCATGTTGCCCAGGATGGTCTCGAACTCCTGG
CCTCAGGTGATTGACCCGCCTCAGCCTCCCAAAATGCTGAGATTACATGG
GTGAGCCACCACGCCTGGCCATAATGTATGTATATTTCAAAGCAATATGT
TGCACACAGTAAATACATCTAATCTAATTTTATCTGTCAATTAAAAACAT
TTTAAAATGGTCATACTAATTTCCCAGTAGAAATATATAAATATTTCTGT
TTTCTCACTTCTAATTTTCATATGAGCAGATTTGTTAAGCTTGGGGAGAA
[A/G]
TAACATCTAATATGCATATTCTGGATTATTAGCAAGATTGTATCTCATT
TATCTCATTATCATTCCCCTCTCTTTTGTCACACTAAGCTGTTCCTTCTT
CCATGTAATTCATCTCAGTGATGATACCACTATCCTTCCAGATGCTCAGG
TCAGAAGTCTGGGGGTTATCTCTGAGTTCCCATCCCTCCTCCCCCACATC
CACCCTCCAAATCCCTTTGTTTCTTATCCACAACATTATAATGACCTCCT
AACTAGTCTCCTCCCTCCAGCCTACTCTCCCTCCAGTTGATTCTGTTCAC
T
>rs241337
CAGAGCATCAAGAATTTTAATGTCGCTGTTATGCTATTTAAGGAAACACA
GTGTATTTTTTCATCTTTTTATCTATATATGCCATTGTTTAAAAACATAC
GATAAGTGTTTATGTTAATTTGTTGTTAGGTGAATTTATCTCTTTCTTAT
TATTAGCAAAACCGTAAAACAACATAGCAGGAAGTTTGGAAAATAAAAAA
AAGCTCTCACAATTCTGCCACCCTATTACAACTGATAGATGATCGATTTA
TTTAGGATAGAGAAAATCTGGGGTTTTTCATGCATTTTTTATTTAGTATT
[A/C]
AAATGTCTTGAGACATGAACAGTGACACAGTTAGGTCTTTAAATATTCA
AGTCCATCCAATCCTCAGATTCTCTTGCATGTGGTCAGTGCTATTCTGTT
ATTTTATTATTCTCTTGTATGAAGTGCCACTTAAAACTATTTTTGCCAGT
TGAACGTTCTGTTGCCAGTGAAGTCATAAAATTGTGATTGCTTTTGTAGT
TTTCTCATCTCAGGCTCCATGTTTCTTTAGATGTGCAGGCTCATTAGTAT
AGGAGCCTAGCCTGTATCAGAGCCCAAAGTTCACAAAGGCACAATCATAA
C

1. A method for determining a susceptibility to Basal Cell Carcinoma (BCC) in a human subject, comprising
determining whether at least one allele of at least one polymorphic marker is present in a nucleic acid sample obtained from the subject,
wherein the at least one polymorphic marker is selected from the group consisting of rs7538876, rs801114 and rs10504624, and markers in linkage disequilibrium therewith, wherein the linkage disequilibrium is characterized by a value for r² of at least 0.2, and
determining a susceptibility to BCC in the subject from the presence or absence of the at least one allele, wherein determination of the presence of the at least one allele is indicative of a susceptibility to Basal Cell Carcinoma for the subject.

2-8. (canceled)

9. A method for determining a susceptibility to cutaneous melanoma (CM) in a human subject, comprising
determining whether at least one allele of at least one polymorphic marker is present in a nucleic acid sample obtained from the subject, wherein the at least one polymorphic marker is selected from the group consisting of rs4151060, rs7812812 and rs9585777, and markers in linkage disequilibrium therewith, wherein the linkage disequilibrium is characterized by a value for r² of at least 0.2, and
determining a susceptibility to CM from whether the at least one allele is present in the sample, wherein the presence of the at least one allele is indicative of a susceptibility to cutaneous melanoma for the subject.

10-17. (canceled)

18. A method of determining a susceptibility to Basal Cell Carcinoma (BCC) in a human individual, the method comprising:
obtaining nucleic acid sequence data about a human individual identifying at least one allele of at least one polymorphic marker, from a biological sample comprising nucleic acid from the individual, wherein different alleles of the at least one polymorphic marker are associated with different susceptibilities to basal cell carcinoma in humans, and
determining a susceptibility to basal cell carcinoma from the nucleic acid sequence data,
wherein the at least one polymorphic marker is selected from the group consisting of rs7538876, rs801114 and rs10504624, and markers in linkage disequilibrium therewith.

19. The method of claim 18, wherein markers in linkage with rs7538876 are selected from the group consisting of the markers set forth in Table 6.

20. The method of claim 18, wherein markers in linkage disequilibrium with rs801114 are selected from the group consisting of the markers set forth in Table 7.

21. The method of claim 18, wherein markers in linkage disequilibrium with rs10504624 are selected from the group consisting of the markers set forth in Table 17.

22. A method of determining a susceptibility to Cutaneous Melanoma (CM) in a human individual, the method comprising:
obtaining nucleic acid sequence data about a human individual identifying at least one allele of at least one polymorphic marker, from a biological sample comprising nucleic acid from the individual, wherein different alleles of the at least one polymorphic marker are associated with different susceptibilities to cutaneous melanoma in humans, and
determining a susceptibility to cutaneous melanoma from the nucleic acid sequence data,
wherein the at least one polymorphic marker is selected from the group consisting of rs4151060, rs7812812 and rs9585777, and markers in linkage disequilibrium therewith.

23. The method of claim 22, wherein markers in linkage disequilibrium with rs4151060 are selected from the group consisting of the markers set forth in Table 14.

24. The method of claim 22, wherein markers in linkage disequilibrium with rs7812812 are selected from the group consisting of the markers set forth in Table 15.

25. The method of claim 22, wherein markers in linkage disequlibrium with rs9585777 are selected from the group consisting of the markers set forth in Table 16.

26. The method of claim 18 or claim 22, comprising obtaining nucleic acid sequence data about at least two polymorphic markers.

27. The method of claim 18 or 22, wherein determination of a susceptibility comprises comparing the nucleic acid sequence data to a database containing correlation data between the polymorphic markers and basal cell carcinoma and/or cutaneous melanoma.

28.-29. (canceled)

30. The method of claim 18 or 22, further comprising obtaining the biological sample containing genomic DNA from the human individual.

31.-32. (canceled)

33. The method of claim 1, further comprising reporting the susceptibility to at least one entity selected from the group consisting of the individual, a guardian of the individual, a genetic service provider, a physician, a medical organization, and a medical insurer.

34. The method of claim 1, further comprising obtaining nucleic acid sequence data about a human individual for at leas one additional genetic susceptibility variant for basal cell carcinoma and/or cutaneous melanoma.

35. The method of claim 34, wherein the at least one additional genetic susceptibility variant is a variant associated with one or more of the ASIP, TYR and MC1R genes.

36. The method of claim 35, wherein the at least one additional genetic susceptibility variant associated with the ASIP gene is selected from rs1015362 and rs4911414.

37. The method of claim 35, wherein the at least one additional genetic susceptibility variant associated with the ASIP gene is the haplotype comprising allele G of rs1015362 and allele T of rs4911414.

38. The method of claim 35, wherein the at least one additional genetic susceptibility variant associated with the TYR gene is a variant encoding the R402Q variant.

39. The method of claim 35, wherein the at least one additional genetic susceptibility variant associated with the MC1R gene is selected from variants encoding the D84E variant, the R151C variant, the R160W variant, and the D294H variant.

40.-50. (canceled)

51. A computer-readable medium having computer executable instructions for determining susceptibility to basal cell carcinoma in an individual, the computer readable medium comprising:
data indicative of at least one polymorphic marker; and
a routine stored on the computer readable medium and adapted to be executed by a processor to determine risk of basal cell carcinoma for the at least one polymorphic marker;
wherein the at least one polymorphic marker is selected from the group consisting of the markers rs7538876, rs801114 and rs10504624, and markers in linkage disequilibrium therewith.

52. A computer-readable medium having computer executable instructions for determining susceptibility to cutaneous melanoma in an individual, the computer readable medium comprising:
data indicative of at least one polymorphic marker; and
a routine stored on the computer readable medium and adapted to be executed by a processor to determine risk of cutaneous melanoma for the at least one polymorphic marker;
wherein the polymorphic marker is selected from the group consisting of rs4151060, rs7812812 and rs9585777, and markers in linkage disequilibrium therewith.

53. The computer-readable medium of claim 51 or claim 52, wherein the medium contains data indicative of at least two polymorphic markers.

54. The computer-readable medium of claim 51 or claim 52, wherein the data indicative of the at least one polymorphic marker comprises sequence data identifying at least one allele of the at least one polymorphic marker.

55. An apparatus for determining a genetic indicator for basal cell carcinoma in a human individual, comprising:
a processor,
a computer readable memory having computer executable instructions adapted to be executed on the processor to analyze marker information for at least one human individual with respect to at least one polymorphic marker selected from the group consisting of the markers rs7538876, rs801114 and rs10504624, and markers in linkage disequilibrium therewith, and generate an output based on the marker information, wherein the output comprises a risk measure of the at least one marker as a genetic indicator of basal cell carcinoma for the human individual.

56. An apparatus for determining a genetic indicator for cutaneous melanoma in a human individual, comprising:
a processor,
a computer readable memory having computer executable instructions adapted to be executed on the processor to analyze marker information for at least one human individual with respect to at least one polymorphic marker selected from the group consisting of the markers rs4151060, rs7812812 and rs9585777, and markers in linkage disequilibrium therewith, and generate an output based on the marker information, wherein the output comprises a risk measure of the at least one marker as a genetic indicator of cutaneous melanoma for the human individual.

57. The apparatus of claim 55 or claim 56, wherein the computer readable memory further comprises data indicative of a risk of developing basal cell carcinoma and/or cutaneous melanoma associated with the at least one allele of the at least one polymorphic marker, and wherein a risk measure for the human individual is based on a comparison of the at least one marker and/or haplotype status for the human individual to the risk associated with the at least one allele of the at least one polymorphic marker.

58. The apparatus of claim 57, wherein the computer readable memory further comprises data indicative of the frequency of at least one allele of the at least one polymorphic marker in a plurality of individuals diagnosed with basal cell carcinoma and/or cutaneous melanoma, and data indicative of the frequency of at the least one allele of at least one polymorphic marker in a plurality of reference individuals, and wherein risk of developing basal cell carcinoma and/or cutaneous melanoma is based on a comparison of the frequency of the at least one allele in individuals diagnosed with basal cell carcinoma and/or cutaneous melanoma, and reference individuals.

59. A method of assessing a subject's risk for basal cell carcinoma, the method comprising:
a) obtaining sequence information about the individual identifying at least one allele of at least one polymorphic marker selected from the group consisting of rs7538876, rs801114 and rs10504624, and markers in linkage disequilibrium therewith, in the genome of the individual;
b) representing the sequence information as digital genetic profile data;
c) electronically processing the digital genetic profile data to generate a risk assessment report for basal cell carcinoma; and
d) displaying the risk assessment report on an output device.

60. A method of assessing a subject's risk for cutaneous melanoma, the method comprising:
a) obtaining sequence information about the individual identifying at least one allele of at least one polymorphic marker selected from the group consisting of rs4151060, rs7812812 and rs9585777, and markers in linkage disequilibrium therewith, in the genome of the individual;
b) representing the sequence information as digital genetic profile data;
c) electronically processing the digital genetic profile data to generate a risk assessment report for cutaneous melanoma; and
d) displaying the risk assessment report on art output device.

61.-63. (canceled)
